(19) United States
(12) Patent Application Publication
(10) Pub. No.: US 2009/0228282 A1
(43) Pub. Date: Sep. 10, 2009

(54) Gaming Machine and Gaming System with Interactive Feature, Playing Method of Gaming Machine, and Control Method of Gaming System

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/390,245

(22) Filed: Feb. 20, 2009

Related U.S. Application Data
(60) Provisional application No. 61/034,733, filed on Mar. 7, 2008.
(60) Provisional application No. 61/034,749, filed on Mar. 7, 2008.
(60) Provisional application No. 61/034,759, filed on Mar. 7, 2008.
(60) Provisional application No. 61/034,769, filed on Mar. 7, 2008.

(51) Int. Cl. G10L 21/00; A63F 9/24; A63F 13/00

(52) U.S. Cl. 704/277; 463/25; 463/42; 463/30; 704/E21.001

(57) ABSTRACT

A gaming machine and a gaming system include an engine for interactively advancing a game by a conversation with a player using sounds and texts as media.

### CROSS REFERENCE TO RELATED APPLICATIONS

This application claims priority to co-pending U.S. provisional patent application Ser. Nos. 61/034,733, 61/034,749, 61/034,759 and 61/034,769, filed on Mar. 7, 2008, and which are incorporated by reference herein for all purposes.

### BACKGROUND OF THE INVENTION

1. Field of the Invention

The present invention relates to a gaming machine and a gaming system including an engine for interactively advancing a game by a conversation with a player using sounds and texts as media, a playing method of the gaming machine, and a control method of the gaming system.

2. Description of Related Art

US Patent Application Publication No. 2007/0094004, US Patent Application Publication No. 2007/0094005, US Patent Application Publication No. 2007/0094007, and US Patent Application Publication No. 2007/0094008 disclose conversation controllers. The conversation controllers disclosed in these specifications are configured to recognize contents of topics of a speaker which are inputted to a microphone or the like, and to output, from the speaker or the like, response voices corresponding to the recognized contents of the topics.

Meanwhile, U.S. Pat. No. 5,820,459, U.S. Pat. No. 6,695,697, US Patent Application Publication No. 2003/0069073, European Patent Application Publication No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, European Patent Application Publication No. 0631798, German Patent Application Publication No. 4137010, GB No. 2326830A, German Patent Application Publication No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533 U.S. Pat. No. 5,836,817, U.S. Pat. No. 6,932,704, U.S. Pat. No. 6,932,707, U.S. Pat. No. 4,837,728, European Patent Application Publication No. 1302914, U.S. Pat. No. 4,624,459, U.S. Pat. No. 5,564,700, International Patent Application WO 03/083795, German Patent Application Publication No. 3242890, European Patent Application Publication No. 0840264, German Patent Application Publication No. 10049444, International Patent Application WO 04/095383, European Patent Application Publication No. 1544811, U.S. Pat. No. 5,890,963, European Patent Application Publication No. 1477947, and European Patent Application Publication No. 1351180 disclose slot machines which are a type of gaming machines. The gaming machines such as the slot machines disclosed in these specifications are configured to allow players to make bets by use of coins, credits or the like in order to play games offered by those gaming machines. Accordingly, in terms of these gaming machines, it is essential to exchange information between players and the gaming machines.

United States patent application publication 2005/0059474, 2005/0282618 or 2005/0218590 discloses a gaming machine in which a player can participate in a game displayed on a communal display by operating a gaming terminal connected to the communal display via a network.

In such a gaming machine, the player operating the gaming terminal is accepted to participate in a game in synchronized timing with game procedures displayed on the communal display.

### SUMMARY OF THE INVENTION

An object of the present invention is to provide a gaming machine and a playing method thereof, which are capable of offering an advanced service to a player.

Another object of the present invention is to provide a gaming system and a control method thereof, which can provide a new entertaining feature by making it easier for players using various languages to participate in a game.

A first aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a display configured to display a menu screen showing a menu of an item orderable by the player through the gaming machine; a memory configured to store menu data indicating a content of the menu in each of a plurality of language types usable for play on the gaming machine; and a controller configured to (a) cause the conversation engine to create data on the conversation sentence to inquire a language type to be used for play on the gaming machine, (b) judge whether or not the language type to be used for play on the gaming machine is designated in the response sentence of the data analyzed by the conversation engine, (c) upon the language type to be used for play on the gaming machine being designated in the response sentence of the data analyzed by the conversation engine, then judge whether or not the response sentence using the designated language type and having the data analyzed by the conversation engine includes a request to display the menu on the display, (d) upon the response sentence using the designated language type and having the data analyzed by the conversation engine including the request to display the menu on the display, then display the menu screen showing the menu of the designated language type on the display by using the menu data of the designated language type, and (e) output order data to a server at an order destination connected through a communication line, the order data representing, in a predetermined language type, a content of an order of the item expressed in the designated language type, the order having been placed by the player while the menu screen in the designated language type is displayed on the display.

A second aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a display configured to display a menu screen showing a menu of an item orderable by the player through the gaming machine; a memory configured to store menu data indicating a content of the menu in each of a plurality of language types usable for play on the gaming machine; and a controller configured to (a) cause the conversation engine to create data on the conversation sentence to inquire a language type to be used for play on the gaming machine; (b) judge whether or not the language type to be used for play on the gaming machine is designated in the response sentence of the data analyzed by the conversation engine, (c) upon the language type to be used for play on the gaming machine being designated in the response sentence of the data analyzed by the conversation engine, then judge whether or not the response sentence using the designated language type and having the data analyzed by the conversation engine includes a request to display the menu on the display, (d) upon the response sentence using the designated language type and having the data analyzed by the conversation engine including the request to display the menu on the display, then display the menu screen showing the menu of the designated language type on the display by using the menu data of the designated language type, and (e) output order data to a server at an order destination connected through a communication line, the order data representing, in a predetermined language type, a content of an order of the item expressed in the designated language type, the order having been placed by the player through an operation of the menu screen in the designated language type.

A third aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a first display configured to display a menu screen showing a menu of an item orderable by the player through the gaming machine; a memory configured to store menu data indicating a content of the menu in each of a plurality of language types usable for play on the gaming machine; and a controller configured to (a) cause the conversation engine to create data on the conversation sentence to inquire a language type to be used for play on the gaming machine, (b) judge whether or not the language type to be used for play on the gaming machine is designated in the response sentence of the data analyzed by the conversation engine, (c) upon the language type to be used for play on the gaming machine being designated in the response sentence of the data analyzed by the conversation engine, then judge whether or not the response sentence using the designated language type and having the data analyzed by the conversation engine includes a request to display the menu on the first display, (d) upon the response sentence using the designated language type and having the data analyzed by the conversation engine including the request to display the menu on the first display, then display the menu screen showing the menu of the designated language type on the first display by using the menu data of the designated language type, and (e) display a content of an order of the item expressed in the designated language type on a second display at an order destination connected through a communication line by using a predetermined language type, the order having been placed by the player through an operation of the menu screen in the designated language type.

A fourth aspect of the present invention is a method of playing a gaming machine comprising: (a) causing a conversation engine to create data on a conversation sentence to inquire a language type to be used for play on the gaming machine; (b) outputting the conversation sentence to inquire the language type to be used for play on the gaming machine from an output unit by using the data created by the conversation engine; (c) enabling a player to input, to an input unit, a response sentence to designate the language type to be used for play on the gaming machine; (d) causing the conversation engine to analyze data on the response sentence having been inputted to the input unit by the player and outputted from the output unit to respond the conversation sentence; (e) judging whether or not the language type to be used for play on the gaming machine is designated in the response sentence of the data analyzed by the conversation engine; (f) upon the language type to be used for play on the gaming machine being designated in the response sentence of the data analyzed by the conversation engine, then judging whether or not the response sentence using the designated language type and having the data analyzed by the conversation engine includes a request to display a menu of an item orderable by the player through the gaming machine on the display; (g) upon the response sentence using the designated language type and having the data analyzed by the conversation engine including the request to display the menu on the display, then displaying a menu screen showing the menu of the designated language type on the display by using menu data indicating a content of the menu stored in a memory in each of a plurality of language types usable for play on the gaming machine; (h) enabling the player to order the item in the designated language while the menu screen in the designated language type is displayed on the display, and (i) outputting order data to a server at an order destination connected through a communication line, the order data representing, in a predetermined language type, a content of an order of the item expressed in the designated language type, the order having been placed by the player while the menu screen in the designated language type is displayed on the display.

A fifth aspect of the present invention is a method of playing a gaming machine comprising: (a) causing a conversation engine to create data on a conversation sentence to inquire about a language type to be used for play on the gaming machine; (b) outputting the conversation sentence to inquire the language type to be used for play on the gaming machine from an output unit by using the data created by the conversation engine; (c) enabling a player to input to an input unit a response sentence to designate the language type to be used for play on the gaming machine; (d) causing the conversation engine to analyze data on the response sentence having been inputted to the input unit by the player and outputted from the output unit to respond the conversation sentence; (e) judging whether or not the language type to be used for play on the gaming machine is designated in the response sentence of the data analyzed by the conversation engine; (c) upon the language type to be used for play on the gaming machine being designated in the response sentence of the data analyzed by the conversation engine, then judging whether or not the response sentence using the designated language type and having the data analyzed by the conversation engine includes a request to display, on a first display, a menu of an item orderable by the player through the gaming machine; (g) upon the response sentence using the designated language type and having the data analyzed by the conversation engine including the request to display the menu on a first display, then displaying a menu screen showing the menu of the designated language type on the first display by using menu data indicating a content of the menu stored in a memory in each of a plurality language types usable for play on the gaming machine; (h) enabling the player to order the item in the designated language through an operation on the menu screen in the designated language type, and (i) displaying a content of an order of the item expressed in the designated language type on a second display at an order destination connected through a communication line by using a predetermined language type, the order having been placed by the player through an operation of the menu screen in the designated language type.

A sixth aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a memory configured to store menu data indicating a plurality of items orderable by the player through the gaming machine and classifications of the items in a hierarchical structure in each of a plurality of language types usable for play on the gaming machine; and a controller configured to: (a) cause the conversation engine to create data on a conversation sentence inquiring a language type to be used for play on the gaming machine; (b) upon the language type to be used for play on the gaming machine being designated in the response sentence having the data analyzed by the conversation engine, then judge whether or not the response sentence using the designated language type and having the data analyzed by the conversation engine includes a request to order the item; (c) upon the response sentence using the designated language type and having the data analyzed by the conversation engine including the request to order the item, specify the classification designated by the requested order of the item; (d) cause the conversation engine to create data on a conversation sentence presenting one or more classifications or items at a lower rank than the first specified classification by using the designated language type, by using the menu data of the designated language type; (e) upon the response sentence using the designated language type and having the data analyzed by the conversation engine designating any of the classifications at the lower rank than the first specified classification, cause the conversation engine to create data on the conversation sentence presenting one or more classifications or items at a lower rank than the second specified classification by using the designated language type; and (f) upon the response sentence using the designated language type and having the data analyzed by the conversation engine designating the item, output order data representing the designated item of the designated language type in a predetermined language type, to a server at an order destination connected through a communication line.

A seventh aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a display configured to display a menu screen presenting a plurality of items orderable by the player through the gaming machine or one or more classifications of the items in a hierarchical structure and to accept an operation by the player; a memory configured to store menu data indicating the items and the classifications of the items in the hierarchical structure in each of a plurality of language types usable for play on the gaming machine; and a controller configured to: (a) cause the conversation engine to create data on a conversation sentence inquiring a language type to be used for play on the gaming machine; (b) upon the language type to be used for play on the gaming machine being designated in the response sentence having the data analyzed by the conversation engine, then judge whether or not the response sentence using the designated language type and having the data analyzed by the conversation engine includes a request to order the item; (c) upon the response sentence using the designated language type and having the data analyzed by the conversation engine including the request to order the item, specify the classification designated by the requested order of the item; (d) cause the display to display the menu screen presenting one or more classifications or items at a lower rank than the first specified classification by using the designated language type, by using the menu data of the designated language type; (e) upon any of the classifications at the lower rank than the first specified classification being designated by an operation on the menu screen in the designated language type by the player, cause the display to display the menu screen presenting one or more classifications or items at a lower rank than the second specified classification, by using the menu data of the designated language type; and (f) upon any of the items being designated by an operation on the menu screen in the designated language type by the player, output order data representing the designated item of the designated language type in a predetermined language type, to a server at an order destination connected through a communication line.

An eighth aspect of the present invention is a gaming machine comprising: an output unit configured to output a conversation sentence to a player; an input unit configured to enable the player to input a response sentence to the conversation sentence outputted from the output unit; a conversation engine configured to create data on the conversation sentence to be outputted from the output unit and to analyze data on the response sentence inputted to the input unit; a first display configured to display a menu screen presenting a plurality of items orderable by the player through the gaming machine or at least one classification of the items in a hierarchical structure and to accept an operation by the player; a memory configured to store menu data indicating the items and the classifications of the items in the hierarchical structure in each of a plurality of language types usable for play on the gaming machine; and a controller configured to: (a) cause the conversation engine to create data on a conversation sentence inquiring a language type to be used for play on the gaming machine; (b) upon the language type to be used for play on the gaming machine being designated in the response sentence having the data analyzed by the conversation engine, then judge whether or not the response sentence using the designated language type and having the data analyzed by the conversation engine includes a request to order the item; (c) upon the response sentence using the designated language type and having the data analyzed by the conversation engine including the request to order the item, specify the classification designated by the requested order of the item; (d) cause the first display to display the menu screen presenting one or more classifications or items at a lower rank than the first specified classification by using the designated language type, by using the menu data of the designated language type; (e) upon any of the classifications at the lower rank than the first specified classification being designated by an operation on the menu screen in the designated language type by the player, cause the first display to display the menu screen presenting one or more classifications or items at a lower rank than the second specified classification, by using the menu data of the designated language type; (f) upon any of the items being designated by an operation on the menu screen in the designated language by the player, cause a second display at an order destination connected through a communication line to display the designated item of the designated language type in a predetermined language type.

A ninth aspect of the present invention is a method of playing a gaming machine comprising: (a) causing a conversation engine to create data on a conversation sentence inquiring a language type to be used for play on the gaming machine; (b) outputting the conversation sentence inquiring the language type to be used for play on the gaming machine from an output unit by using the data created by the conversation engine; (c) enabling a player to input a response sentence designating a language type to be used for play on the gaming machine to an input unit; (d) causing the conversation engine to analyze data on the response sentence designating the language type to be used for play on the gaming machine, the response sentence being inputted to the input unit by the player; (e) judging whether or not the language type to be used for play on the gaming machine is designated in the response sentence having the data analyzed by the conversation engine; (f) upon the language type to be used for play on the gaming machine being designated in the response sentence having the data analyzed by the conversation engine, then judging whether or not the response sentence using the designated language type and having the data analyzed by the conversation engine includes a request for an order of any of the items; (g) upon the response sentence using the designated language type and having the data analyzed by the conversation engine including the request for the order of the item, specifying the classification designated by the requested order of the item; (h) causing the conversation engine to create data on a conversation sentence presenting one or more classifications or items at a lower rank than the first specified classification by using the designated language type, by using menu data indicating a content of a menu stored in a memory in each of a plurality of language types usable for play on the gaming machine; and (i) outputting the conversation sentence presenting the one or more classifications or items at the lower rank than the first specified classification by using the designated language type, from the output unit by using the data created by the conversation engine; (j) enabling the player to input to the input unit a response sentence designating any of the classifications or item at the lower rank than the first specified classification by using the designated language type; (k) causing the conversation engine to analyze data on the response sentence using the designated language type and being inputted to the input unit by the player; (l) upon any of the classifications at the lower rank than the first specified classification being specified in the response sentence using the designated language type and having the data analyzed by the conversation engine, causing the conversation engine to create data on a conversation sentence presenting one or more classifications or items at a rank lower than the second specified classification by using the designated language type; (m) outputting the conversation sentence presenting the one or more classifications or items at the rank lower than the second specified classification by using the designated language type, from the output unit by using the data created by the conversation engine; and (n) upon any of the items being designated in the response sentence using the designated language type and having the data analyzed by the conversation engine, outputting order data representing the designated item of the designated language type in a predetermined language type, to a server at an order destination connected through a communication line.

A tenth aspect of the present invention is a method of playing a gaming machine comprising: (a) causing a conversation engine to create data on a conversation sentence inquiring a language type to be used for play on the gaming machine; (b) outputting the conversation sentence inquiring the language type to be used for play on the gaming machine from an output unit by using the data created by the conversation engine; (c) enabling a player to input a response sentence designating a language type to be used for play on the gaming machine to an input unit; (d) causing the conversation engine to analyze data on the response sentence designating the language type to be used for play on the gaming machine inputted to the input unit by the player; (e) judging whether or not the language type to be used for play on the gaming machine is designated in the response sentence having the data analyzed by the conversation engine; (f) upon the language type to be used for play on the gaming machine being designated in the response sentence having the data analyzed by the conversation engine, then judging whether or not the response sentence using the designated language type and having the data analyzed by the conversation engine includes a request for an order of any of the items; (g) upon the response sentence using the designated language type and having the data analyzed by the conversation engine including the request for the order of the item, specifying the classification designated by the requested order of the item; (h) displaying on a display a menu screen presenting one or more classifications or items at a lower rank than the first specified classification by using the designated language type, by using menu data indicating the items and classifications of the items in a hierarchical structure, the menu data being stored in a memory in each of a plurality of language types usable for play on the gaming machine; (i) enabling the player to designate any of the classifications and the items at the lower rank than the first specified classification by an operation on the menu screen in the designated language type; (j) upon any of the classifications at the lower rank than the first specified classification being designated by the operation on the menu screen in the designated language type by the player, displaying on the display, by using the menu data, a menu screen presenting one or more classifications or items at a lower rank than the first specified classification by using the designated language type; and (k) upon any of the items being designated by the operation on the menu screen in the designated language type by the player, outputting order data representing the designated item of the designated language type in a predetermined language type, to a server at an order destination connected through a communication line.

An eleventh aspect of the present invention is a method of playing a gaming machine comprising: (a) causing a conversation engine to create data on a conversation sentence inquiring a language type to be used for play on the gaming machine; (b) outputting the conversation sentence inquiring the language type to be used for play on the gaming machine from an output unit by using the data created by the conversation engine; (c) enabling a player to input a response sentence designating a language type to be used for play on the gaming machine to an input unit; (d) causing the conversation engine to analyze data on the response sentence designating the language type to be used for play on the gaming machine inputted to the input unit by the player; (e) judging whether or not the language type to be used for play on the gaming machine is designated in the response sentence having the data analyzed by the conversation engine; (f) upon the language type to be used for play on the gaming machine being designated in the response sentence having the data analyzed by the conversation engine, then judging whether or not the response sentence using the designated language type and having the data analyzed by the conversation engine includes a request for an order of any of the items; (g) upon the response sentence using the designated language type and having the data analyzed by the conversation engine including the request for the order of the item, specifying the classification designated by the requested order of the item; (h) displaying on a first display a menu screen presenting one or more classifications or items at a lower rank than the first specified classification by using the designated language type, by using menu data indicating the items and classifications of the items in a hierarchical structure, the menu data being stored in a memory in each of a plurality of language types usable for play on the gaming machine; (i) enabling the player to designate any of the classifications and the items at the lower rank than the first specified classification by an operation on the menu screen in the designated language type; (j) upon any of the classifications at the lower rank than the first specified classification being designated by the operation on the menu screen in the designated language type by the player, displaying on the first display, by using the menu data, a menu screen to present one or more classifications or items at a lower rank than the first specified classification in the designated language type; and (k) upon any of the item being designated by the operation on the menu screen in the designated language type by the player, displaying the designated item of the designated language type on a second display at an order destination connected through a communication line in a predetermined language type.

A twelfth aspect of the present invention provides a gaming system that includes a host server and plural gaming terminals connected to the host server via a network. The host server is provided with a conversation database of plural languages, plural translating programs between each of the plural language and a reference language, and a server controller operable to determine the gaming terminals to which the message is to be sent based on an input message and player's history information. Each of the gaming terminals includes a display for displaying information on a game executed repeatedly, a microphone for being input an utterance by a player, a conversation engine for generating a reply to the input utterance by analyzing the utterance input into the microphone, a speaker for outputting the reply generated by the conversation engine, a history information readout unit for reading out the player's history information, and a terminal controller. The terminal controller is operable to (A) get the conversation engine to specify a player's language based on a manual operation by the player or the input utterance, (B) execute a game according to a conversation with the player using the conversation engine corresponding to the player's language, (C) send the player's history information to the host server, and (D) translate the message sent form the host server into the player's language to notify the translated message to the player.

A thirteenth aspect of the present invention provides a gaming system that includes a host server and plural gaming terminals connected to the host server via a network. The host server is provided with a conversation database of plural languages, plural translating programs between each of the plural language and a reference language, and a server controller operable to determine the gaming terminals to which the message is to be sent based on an input message and player's history information. Each of the gaming terminals includes a display for displaying information on a game executed repeatedly, a storing unit for storing conversation data stored in the conversation database and the translating programs, a microphone for being input an utterance by a player, a conversation engine for generating a reply to the input utterance by analyzing the utterance input into the microphone, a speaker for outputting the reply generated by the conversation engine, a history information readout unit for reading out the player's history information, and a terminal controller. The terminal controller is operable to (A) get the conversation engine to specify a player's language based on a manual operation by the player or the input utterance, (B) read out conversation data and a translating program corresponding to the player's language from the host server and store the conversation data and the translating program in the storing unit, (C) execute a game according to a conversation with the player using the conversation engine, (D) send the player's history information to the host server, and (E) translate the message sent form the host server into the player's language to notify the translated message to the player.

A fourteenth aspect of the present invention provides a control method of a gaming system that includes: specifying a player's language based on a manual operation or an input of an utterance into a microphone by a player; getting player's history information; translating a message relating to the player's history information into the player's language among messages had been input; and specifying the translated message to the player.

A fifteenth aspect of the present invention provides a gaming system that includes a host server and plural gaming terminals connected to the host server via a network. Each of the gaming terminals includes a display for displaying information on a game executed repeatedly, a microphone for being input an utterance by a player, a conversation engine for generating a reply to the input utterance by analyzing the utterance input into the microphone, a speaker for outputting the reply generated by the conversation engine, and a controller. The controller is operable to (A) get the conversation engine to specify a language used by the player based on a manual operation by the player or the utterance, (B) display a character image corresponding to the language on the display, and (C) execute a game according to a conversation with the player using the conversation engine corresponding to the language.

A sixteenth aspect of the present invention provides a gaming system that includes a host server and plural gaming terminals connected to the host server via a network. The host server is provided with a conversation database of plural languages and storing unit for storing each playing history of the gaming terminals. Each of the gaming terminals includes a display for displaying information on a game executed repeatedly, a microphone for being input an utterance by a player, a conversation engine for generating a reply to the input utterance by analyzing the utterance input into the microphone with reference to the conversation database and the playing history, a speaker for outputting the reply generated by the conversation engine, and a controller. The controller is operable to (A) get the conversation engine to specify a language used by the player based on a manual operation by the player or the utterance, (B) display a character image corresponding to the language on the display, and (C) execute a game according to a conversation with the player using the conversation engine corresponding to the language.

A seventeenth aspect of the present invention provides a gaming system that includes a host server and plural gaming terminals connected to the host server via a network. The host server is provided with a conversation database of plural languages and storing unit for storing each playing history of the gaming terminals. Each of the gaming terminals includes a display for displaying information on a game executed repeatedly, a microphone for being input an utterance by a player, a conversation engine for generating a reply to the input utterance by analyzing the utterance input into the microphone with reference to the conversation database and the playing history, a speaker for outputting the reply generated by the conversation engine, and a controller. The controller is operable to (A) get the conversation engine to specify a language used by the player based on a manual operation by the player or the utterance, (B) display a character image corresponding to the language on the display, (C) execute a game according to a conversation with the player using the conversation engine corresponding to the language, (D) convert a reply to the player into a text string, and (E) display the converted reply on the display together with the character image.

A eighteenth aspect of the present invention provides a control method of a gaming system that includes: analyzing an utterance by a player to generate a replay to the utterance and advancing a game with a sound output of the reply; specifying a language used by a player based on a manual operation by the player or the utterance; and displaying a character image corresponding to the language on a display.

### BRIEF DESCRIPTION OF THE DRAWINGS

FIG. 1 is a schematic flow chart showing a playing method of a gaming machine according to a first embodiment of the present invention.

FIG. 2 is a diagram showing a perspective view of a gaming terminal according to a first embodiment of the present invention.

FIG. 3 is a diagram showing a perspective view of an outward appearance of a schematic configuration of a roulette game machine according to a first embodiment of the present embodiment.

FIG. 4 is a diagram showing a plan view of a roulette device according to a first embodiment of the present embodiment.

FIG. 5 is a diagram showing one example of an image to be displayed on a display of the gaming terminal shown in FIG. 2.

FIG. 6 is a block diagram showing an internal configuration of a roulette game machine according to a first embodiment of the present embodiment.

FIG. 7 is a block diagram showing an internal configuration of a roulette device according to a first embodiment of the present embodiment.

FIG. 8 is a block diagram showing an internal configuration of a gaming terminal according to a first embodiment of the present embodiment.

FIG. 9 is a block diagram of a conversation controller available as a conversation engine installed in a gaming terminal according to a first embodiment of the present invention.

FIG. 10 is a block diagram of a speech recognition unit according to a first embodiment of the present invention.

FIG. 11 is a timing chart of a process of a word hypothesis refinement unit according to a first embodiment of the present invention.

FIG. 12 is a flow chart of an operation of the speech recognition unit according to a first embodiment of the present invention.

FIG. 13 is a partly enlarged block diagram of the conversation controller according to a first embodiment of the present invention.

FIG. 14 is a diagram illustrating a relation between a character string and morphemes extracted from the character string according to a first embodiment of the present invention.

FIG. 15 is a diagram illustrating types of uttered sentences, plural two letters in the alphabet which represent the types of the uttered sentences, and examples of the uttered sentences according to a first embodiment of the present invention.

FIG. 16 is a diagram illustrating details of dictionaries stored in an utterance type database according to a first embodiment of the present invention.

FIG. 17 is a diagram illustrating details of a hierarchical structure built in a conversation database according to a first embodiment of the present invention.

FIG. 18 is a diagram illustrating a refinement of topic identification information in the hierarchical structure built in the conversation database according to a first embodiment of the present invention.

FIG. 19 is a diagram illustrating contents of topic titles formed in the conversation database according to a first embodiment of the present invention.

FIG. 20 is a diagram illustrating types of reply sentences associated with the topic titles formed in the conversation database according to a first embodiment of the present invention.

FIG. 21 is a diagram illustrating contents of the topic titles, the reply sentences and next plan designation information associated with the topic identification information according to a first embodiment of the present invention.

FIG. 22 is a diagram illustrating a plan space according to a first embodiment of the present invention.

FIG. 23 is a diagram illustrating one example a plan transition according to a first embodiment of the present invention.

FIG. 24 is a diagram illustrating another example of the plan transition according to a first embodiment of the present invention.

FIG. 25 is a diagram illustrating details of a plan conversation control process according to a first embodiment of the present invention.

FIG. 26 is a flow chart of a main process in a conversation control unit according to a first embodiment of the present invention.

FIG. 27 is a flow chart of a part of a plan conversation control process according to a first embodiment of the present invention.

FIG. 28 is a flow chart of the rest of the plan conversation control process according to a first embodiment of the present invention.

FIG. 29 is a transition diagram of a basic control state according to a first embodiment of the present invention.

FIG. 30 is a flow chart of a discourse space conversation control process according to a first embodiment of the present invention.

FIG. 31 is a flow chart showing gaming processings of a server and a roulette device of a roulette game machine according to a first embodiment of the present embodiment.

FIG. 32 is a flow chart showing gaming processings of the server and the roulette device of the roulette game machine according to a first embodiment of the present embodiment.

FIG. 33 is a flow chart showing gaming processings of a gaming terminal of the roulette game machine according to a first embodiment of the present embodiment.

FIG. 34 is a flow chart showing a used language confirmation processing shown in FIG. 33.

FIG. 35 is a flow chart showing a betting period confirmation processing shown in FIG. 33.

FIG. 36 is a flow chart showing a bet accepting processing shown in FIG. 33.

FIG. 37 is a flowchart showing order processing in FIG. 33.

FIG. 38 is a view showing an example of a menu screen to be displayed on a display.

FIG. 39 is a view showing another example of the menu screen to be displayed on the display.

FIG. 40 is a view showing still another example of the menu screen to be displayed on the display.

FIG. 41 is a view showing an example of an image to be displayed on the display.

FIG. 42 is a view showing an example of another image to be displayed on the display

FIGS. 43A and 43B are flowcharts showing another example of the order processing in FIG. 33.

FIG. 44 is a view showing another example of the menu screen to be displayed on the display.

FIG. 45 is a view showing still another example of the menu screen to be displayed on the display.

FIG. 46 is a schematic flow chart showing a playing method of a gaming machine according to a second embodiment of the present invention.

FIG. 47 is a diagram showing a perspective view of a gaming terminal according to a second embodiment of the present invention.

FIG. 48 is a diagram showing a perspective view of an outward appearance of a schematic configuration of a roulette game machine according to a second embodiment of the present embodiment.

FIG. 49 is a diagram showing a plan view of a roulette device according to a second embodiment of the present embodiment.

FIG. 50 is a diagram showing one example of an image to be displayed on a display of the gaming terminal shown in FIG. 47.

FIG. 51 is a block diagram showing an internal configuration of a roulette game machine according to a second embodiment of the present embodiment.

FIG. 52 is a block diagram showing an internal configuration of a roulette device according to a second embodiment of the present embodiment.

FIG. 53 is a block diagram showing an internal configuration of a gaming terminal according to a second embodiment of the present embodiment.

FIG. 54 is a block diagram of a conversation controller available as a conversation engine installed in a gaming terminal according to a second embodiment of the present invention.

FIG. 55 is a block diagram of a speech recognition unit according to a second embodiment of the present invention.

FIG. 56 is a timing chart of a process of a word hypothesis refinement unit according to a second embodiment of the present invention.

FIG. 57 is a flow chart of an operation of the speech recognition unit according to a second embodiment of the present invention.

FIG. 58 is a partly enlarged block diagram of the conversation controller according to a second embodiment of the present invention.

FIG. 59 is a diagram illustrating a relation between a character string and morphemes extracted from the character string according to a second embodiment of the present invention.

FIG. 60 is a diagram illustrating types of uttered sentences, plural two letters in the alphabet which represent the types of the uttered sentences, and examples of the uttered sentences according to a second embodiment of the present invention.

FIG. 61 is a diagram illustrating details of dictionaries stored in an utterance type database according to a second embodiment of the present invention.

FIG. 62 is a diagram illustrating details of a hierarchical structure built in a conversation database according to a second embodiment of the present invention.

FIG. 63 is a diagram illustrating a refinement of topic identification information in the hierarchical structure built in the conversation database according to a second embodiment of the present invention.

FIG. 64 is a diagram illustrating contents of topic titles formed in the conversation database according to a second embodiment of the present invention.

FIG. 65 is a diagram illustrating types of reply sentences associated with the topic titles formed in the conversation database according to a second embodiment of the present invention.

FIG. 66 is a diagram illustrating contents of the topic titles, the reply sentences and next plan designation information associated with the topic identification information according to a second embodiment of the present invention.

FIG. 67 is a diagram illustrating a plan space according to a second embodiment of the present invention.

FIG. 68 is a diagram illustrating one example a plan transition according to a second embodiment of the present invention.

FIG. 69 is a diagram illustrating another example of the plan transition according to a second embodiment of the present invention.

FIG. 70 is a diagram illustrating details of a plan conversation control process according to a second embodiment of the present invention.

FIG. 71 is a flow chart of a main process in a conversation control unit according to a second embodiment of the present invention.

FIG. 72 is a flow chart of a part of a plan conversation control process according to a second embodiment of the present invention.

FIG. 73 is a flow chart of the rest of the plan conversation control process according to a second embodiment of the present invention.

FIG. 74 is a transition diagram of a basic control state according to a second embodiment of the present invention.

FIG. 75 is a flow chart of a discourse space conversation control process according to a second embodiment of the present invention.

FIG. 76 is a flow chart showing gaming processings of a server and a roulette device of a roulette game machine according to a second embodiment of the present embodiment.

FIG. 77 is a flow chart showing gaming processings of the server and the roulette device of the roulette game machine according to a second embodiment of the present embodiment.

FIG. 78 is a flow chart showing gaming processings of a gaming terminal of the roulette game machine according to a second embodiment of the present embodiment.

FIG. 79 is a flow chart showing a used language confirmation processing shown in FIG. 78.

FIG. 80 is a flow chart showing a betting period confirmation processing shown in FIG. 78.

FIG. 81 is a flow chart showing a bet accepting processing shown in FIG. 78.

FIGS. 82A and 82B are flowcharts showing order processing in FIG. 78.

FIGS. 83A and 83B are flowcharts showing other examples of the order processing in FIG. 78.

FIG. 84 is a view showing an example of a menu screen to be displayed on a display.

FIG. 85 is a view showing another example of the menu screen to be displayed on the display.

FIG. 86 is a view showing another example of the menu screen to be displayed on the display.

FIG. 87 is a view showing another example of the menu screen to be displayed on the display.

FIG. 88 is a view showing another example of the menu screen to be displayed on the display.

FIG. 89 is a view showing another example of the menu screen to be displayed on the display.

FIG. 90 is a view showing another example of the menu screen to be displayed on the display.

FIG. 91 is a view showing another example of the menu screen to be displayed on the display.

FIG. 92 is a view showing another example of the menu screen to be displayed on the display.

FIG. 93 is a view showing an example of an image to be displayed on the display.

FIG. 94 is a view showing an example of another image to be displayed on the display.

FIGS. 95A, 95B, and 95C are flowcharts showing another example of the order processing in FIG. 78.

FIGS. 96A, 96B, and 96C are flowcharts showing another example of the order processing in FIG. 78.

FIG. 97 is an example of the menu screen to be displayed on the display.

FIG. 98 is a view showing another example of the menu screen to be displayed on the display.

FIG. 99 is a view showing an example of an image to be displayed on the display.

FIG. 100 is a view showing an example of another image to be displayed on the display.

FIG. 101 is a flow chart showing a general process flow of game execution processing in a gaming system according to third and fourth embodiments of the present invention.

FIG. 102 is a perspective view showing a gaming terminal according to third and fourth embodiments of the present invention.

FIG. 103 is an apparent perspective view showing a general configuration of a roulette game machine according to third and fourth embodiments of the present invention.

FIG. 104 is a plan view of a roulette unit according to third and fourth embodiments of the present invention.

FIG. 105 is a screen image example displayed on a display of the gaming terminal shown in FIG. 102.

FIG. 106 is a block diagram showing an internal configuration of the roulette game machine according to third and fourth embodiments of the present invention.

FIG. 107 is a block diagram showing an internal configuration of the roulette unit according to third and fourth embodiments of the present invention.

FIG. 108 is a block diagram showing an internal configuration of the gaming terminal according to third and fourth embodiments of the present invention.

FIG. 109 is a functional block diagram showing a conversation controller according to third and fourth embodiments of the present invention.

FIG. 110 is a functional block diagram showing a speech recognition unit.

FIG. 111 is a timing chart showing processes of a word hypothesis refinement portion.

FIG. 112 is a flow chart showing process operations of the speech recognition unit.

FIG. 113 is a partly enlarged block diagram of the conversation controller.

FIG. 114 is a diagram showing a relation between a character string and morphemes extracted from the character string.

FIG. 115 is a table showing uttered sentence types, two-alphabet codes representing the uttered sentence types, and uttered sentence examples corresponding to the uttered sentence types.

FIG. 116 is a diagram showing details of dictionaries stored in an utterance type database.

FIG. 117 is a diagram showing details of a hierarchical structure built in a conversation database.

FIG. 118 is a diagram showing a refinement of topic identification information in the hierarchical structure built in the conversation database.

FIG. 119 is a diagram showing data configuration examples of topic titles (also referred as “second morpheme information”).

FIG. 120 is a diagram showing types of reply sentences associated with the topic titles formed in the conversation database.

FIG. 121 is a diagram showing contents of the topic titles, the reply sentences and next plan designation information associated with the topic identification information.

FIG. 122 is a diagram showing a plan space.

FIG. 123 is a diagram showing one example a plan transition.

FIG. 124 is a diagram showing another example of the plan transition.

FIG. 125 is a diagram showing details of a plan conversation control process.

FIG. 126 is a flow chart showing an example of a main process by a conversation control unit.

FIG. 127 is a flow chart showing a plan conversation control process.

FIG. 128 is a flow chart, continued from FIG. 127, showing the rest of the plan conversation control process.

FIG. 129 is a transition diagram of a basic control state.

FIG. 130 is a flow chart showing a discourse space conversation control process.

FIG. 131 is a flow chart showing gaming processings of a sever and the roulette unit in the roulette game machine of a third embodiment according to the present invention.

FIG. 132 is a flow chart showing gaming processings of a sever and the roulette unit in the roulette game machine of the third embodiment according to the present invention.

FIG. 133 is a flow chart showing game execution processing of the gaming terminal in the roulette game machine of the third embodiment according to the present invention.

FIG. 134 is a flow chart showing language confirmation processing shown in FIG. 133.

FIG. 135 is a flow chart showing betting period confirmation processing shown in FIG. 133.

FIG. 136 is a flow chart showing bet accepting processing shown in FIG. 133.

FIG. 137 is a screen image example displayed on the display of the gaming terminal.

FIG. 138 is a screen image example displayed on the display of the gaming terminal.

FIG. 139 is a screen image example displayed on the display of the gaming terminal.

FIG. 140 is a flow chart showing conversation database setting processing shown in FIG. 133.

FIG. 141 is a flow chart showing conversation translating program setting processing shown in FIG. 133.

FIG. 142 is a flow chart showing history storing processing for storing history information in a smart card.

FIG. 143 is a flow chart showing message sending processing in message output processing shown in FIG. 133.

FIG. 144 is a flow chart showing message notifying processing in the message output processing shown in FIG. 133.

FIG. 145 is a flow chart showing a modified example of the message notifying processing in the message output processing shown in FIG. 133.

FIG. 146 is an explanatory diagram showing message classifications and destination gaming terminals.

FIG. 147 is a screen image example shown on an LCD of the server.

FIG. 148 is another screen image example shown on the LCD of the server.

FIG. 149 is a screen image example shown on the display of the gaming terminal.

FIG. 150 is another screen image example shown on the display of the gaming terminal.

FIG. 151 is yet another screen image example shown on the display of the gaming terminal.

FIG. 152 is a flow chart showing game execution processing of a gaming terminal in the roulette game machine of a fourth embodiment according to the present invention.

FIG. 153 is a flow chart showing conversation data download processing shown in FIG. 152.

FIG. 154 is a flow chart showing translating program download processing shown in FIG. 152.

FIG. 155 is a flow chart showing a general process flow of game execution processing in a gaming system according to fifth and sixth embodiments of the present invention.

FIG. 156 is a perspective view showing a gaming terminal according to fifth and sixth embodiments of the present invention.

FIG. 157 is an apparent perspective view showing a general configuration of a roulette game machine according to fifth and sixth embodiments of the present invention.

FIG. 158 is a plan view of a roulette unit according to fifth and sixth embodiments of the present invention.

FIG. 159 is a screen image example displayed on a display of the gaming terminal.

FIG. 160 is a block diagram showing an internal configuration of the roulette game machine according to fifth and sixth embodiments of the present invention.

FIG. 161 is a block diagram showing an internal configuration of the roulette unit according to fifth and sixth embodiments of the present invention.

FIG. 162 is a block diagram showing an internal configuration of the gaming terminal according to fifth and sixth embodiments of the present invention.

FIG. 163 is a functional block diagram showing a conversation controller according to fifth and sixth embodiments of the present invention.

FIG. 164 is a functional block diagram showing a speech recognition unit.

FIG. 165 is a timing chart showing processes of a word hypothesis refinement portion.

FIG. 166 is a flow chart showing process operations of the speech recognition unit.

FIG. 167 is a partly enlarged block diagram of the conversation controller.

FIG. 168 is a diagram showing a relation between a character string and morphemes extracted from the character string.

FIG. 169 is a table showing uttered sentence types, two-alphabet codes representing the uttered sentence types, and uttered sentence examples corresponding to the uttered sentence types.

FIG. 170 is a diagram showing details of dictionaries stored in an utterance type database.

FIG. 171 is a diagram showing details of a hierarchical structure built in a conversation database.

FIG. 172 is a diagram showing a refinement of topic identification information in the hierarchical structure built in the conversation database.

FIG. 173 is a diagram showing data configuration examples of topic titles (also referred as “second morpheme information”).

FIG. 174 is a diagram showing types of reply sentences associated with the topic titles formed in the conversation database.

FIG. 175 is a diagram showing contents of the topic titles, the reply sentences and next plan designation information associated with the topic identification information.

FIG. 176 is a diagram showing a plan space.

FIG. 177 is a diagram showing one example a plan transition.

FIG. 178 is a diagram showing another example of the plan transition.

FIG. 179 is a diagram showing details of a plan conversation control process.

FIG. 180 is a flow chart showing an example of a main process by a conversation control unit.

FIG. 181 is a flow chart showing a plan conversation control process.

FIG. 182 is a flow chart, continued from FIG. 181, showing the rest of the plan conversation control process.

FIG. 183 is a transition diagram of a basic control state.

FIG. 184 is a flow chart showing a discourse space conversation control process.

FIG. 185 is a flow chart showing gaming processings of a sever and the roulette unit in the roulette game machine according to fifth and sixth embodiments of the present invention.

FIG. 186 is a flow chart showing gaming processings of a sever and the roulette unit in the roulette game machine according to fifth and sixth embodiments of the present invention.

FIG. 187 is a flow chart showing game execution processing of the gaming terminal in the roulette game machine according to a fifth embodiment of the present invention.

FIG. 188 is a flow chart showing language confirmation processing shown in FIG. 187.

FIG. 189 is a flow chart showing betting period confirmation processing shown in FIG. 187.

FIG. 190 is a flow chart showing bet accepting processing shown in FIG. 187.

FIG. 191 is a screen image example displayed on the display.

FIG. 192 is a screen image example displayed on the display.

FIG. 193 is a screen image example displayed on the display.

FIG. 194 is a flow chart showing conversation database setting processing shown in FIG. 187.

FIG. 195 is a flow chart showing conversation translating program setting processing shown in FIG. 187.

FIG. 196 is a flow chart showing conversation processing shown in FIG. 187.

FIG. 197 is a flow chart showing game execution processing of a gaming terminal in the roulette game machine according to a sixth embodiment of the present invention.

FIG. 198 is a flow chart showing conversation data download processing shown in FIG. 197.

FIG. 199 is a flow chart showing translating program download processing shown in FIG. 197.

FIG. 200 is a screen image example shown on a display.

FIG. 201 is a screen image example shown on the display.

FIG. 202 is a screen image example shown on the display.

FIG. 203 is a screen image example shown on the display.

FIG. 204 is a screen image example shown on the display.

FIG. 205 is a screen image example shown on the display.

### DETAILED DESCRIPTION OF THE EMBODIMENT

### First Embodiment

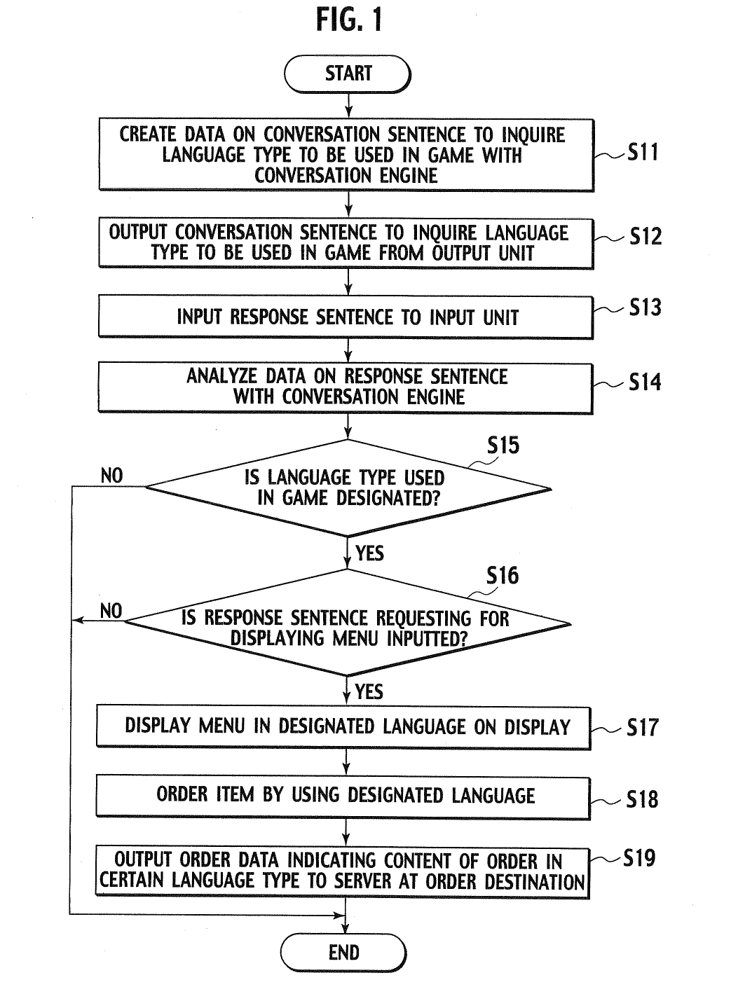

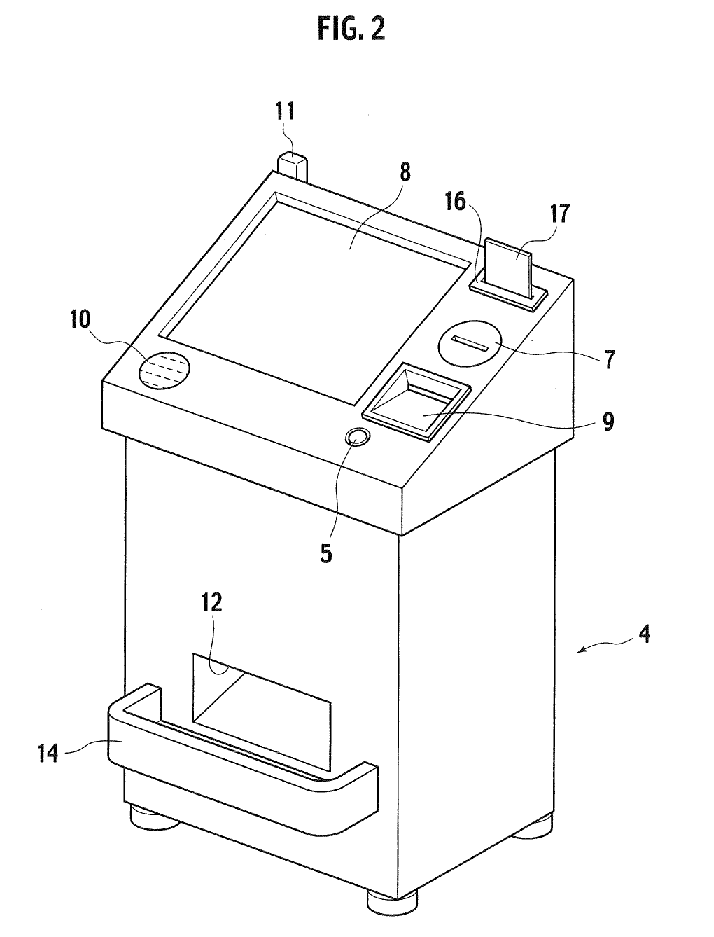

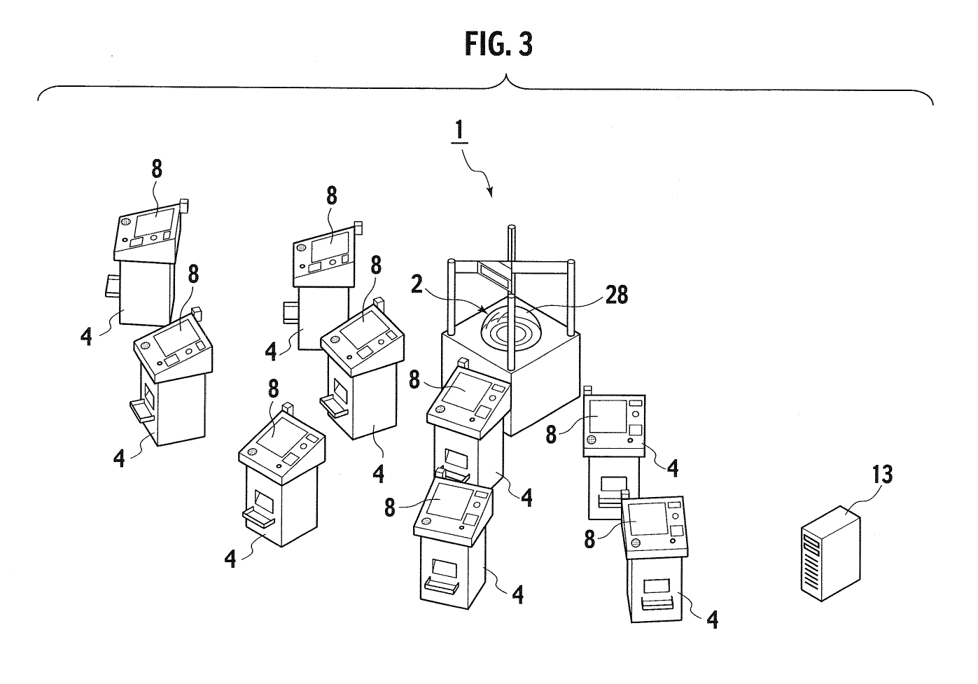

Now, operations of a gaming terminal representing an example of a gaming machine according to a first embodiment of the present invention and outlines of a playing method thereof will be described below with reference to a flow chart shown in FIG. 1, a perspective view of a gaming machine shown in FIG. 2, and an outward perspective view of a roulette game machine shown in FIG. 3.

First, in a gaming terminal 4 according to the first embodiment of the present invention shown in FIG. 2, a player can participate in a roulette game executed in a roulette device 2 by betting credits through a BET screen displayed on a display 8.

Then, data on a conversation sentence to inquire of a player about a language type to be used for playing a roulette game are created by use of a conversation engine of the gaming terminal 4 shown in FIG. 2 (step S11). Next, the conversation sentence to inquire the language type to be used for playing the roulette game is outputted from an output unit of the gaming terminal 4 by using the data created by the conversation engine (step S12).

Subsequently, the player inputs a response sentence to designate the language type to be used for playing the roulette game to an input unit of the gaming terminal 4 in response to the conversation sentence outputted from the output unit (step S13). Then, data on the response sentence inputted to the input unit by the player are analyzed by the conversation engine of the gaming terminal 4 (step S14).

Next, a judgment is made as to whether or not the language type to be used for playing the roulette game is designated in the data on the conversation sentence analyzed by the conversation engine of the gaming terminal 4 (step S15). Then, when the language type to be used for playing the roulette game is designated (YES in step S15), a judgment is made as to whether or not a response sentence (such as a phrase meaning “I would like something to eat or drink”) to request for displaying a menu of items orderable through the gaming terminal 4 onto the display 8 is inputted to the input unit by the player (step S16).

Thereafter, if the response sentence to request for displaying the menu is inputted (YES in step S16), the menu in the language type designated in step S15 is displayed on the display 8 (step S17).

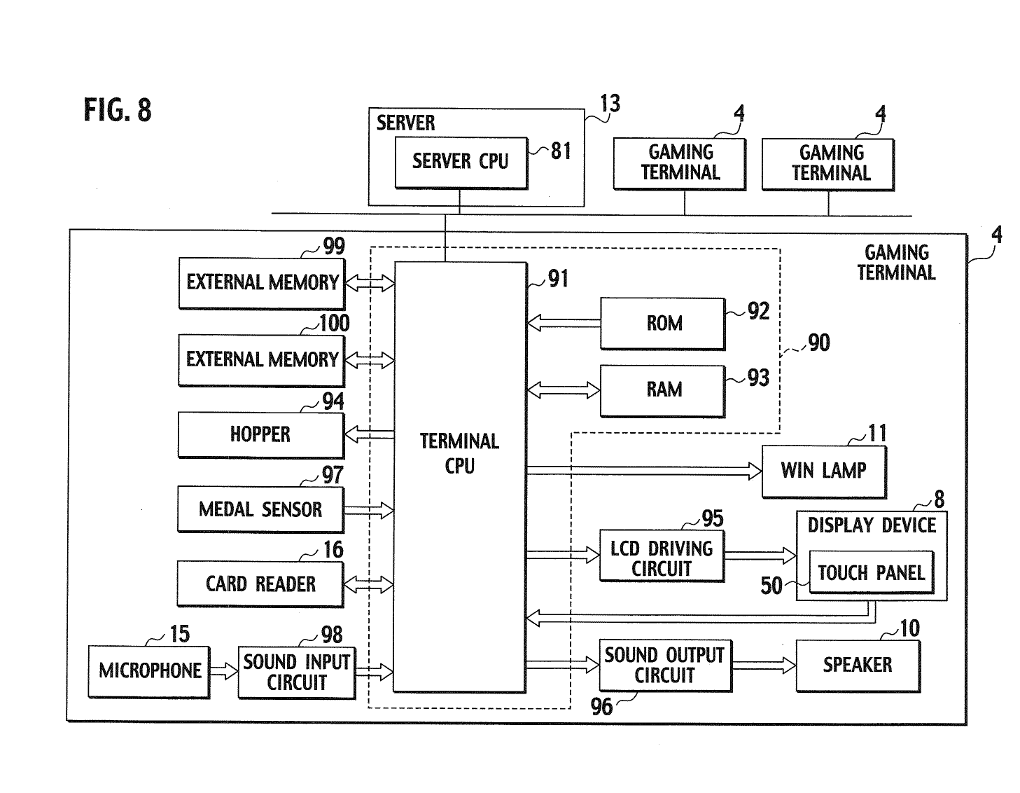

The menu in the language type designated in step S15 can be displayed on the display 8 by use of menu data stored in an external memory 100 of the gaming terminal 4 (see FIG. 8; a memory). Here, the menu data indicate contents of the menu in multiple language types usable for playing the roulette game.

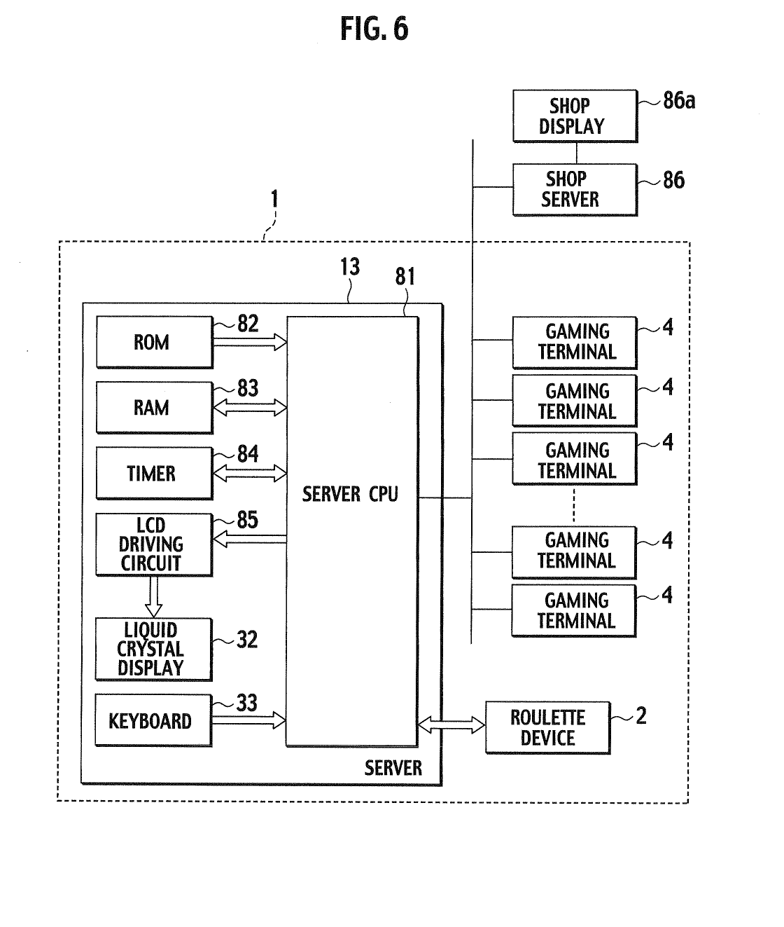

Subsequently, the player orders an item in the menu displayed on the display 8 by using the designated language type (step S18), and order data on the content of the ordered item expressed after conversion from the designated language type into a predetermined language type are outputted to a shop server 86 (see FIG. 6; a server) which is an order destination connected through a communication line (step S19).

According to the gaming terminal 4 and the playing method of the same of the embodiment of the present invention, once the player inputs the response sentence to designate the language type to be used for playing the roulette game with the gaming terminal into the input unit in response to the conversation sentence outputted from the output unit of the gaming terminal 4, the menu in the designated language type is displayed thereafter on the display 8 upon the request for the display of the menu from the player. Then, when the player places an order for the item in the menu by using the designated language type, the content of the item ordered by the player is transmitted to the order destination by using the predetermined language type, here, the order destination has the server configured to output the order data indicating the content of the ordered item, by using the predetermined language type.

As a result, it is possible to allow the player to place the order of the item in the designated language type through the gaming terminal 4 by designating the language type to be used in the game through interactive communication between the player and the gaming terminal 4. In this way, it is possible to offer advanced service to the player.

Next, the gaming terminal according to the embodiment of the present invention will be described together with a roulette game device having the gaming terminal with reference to FIG. 2 to FIG. 42.

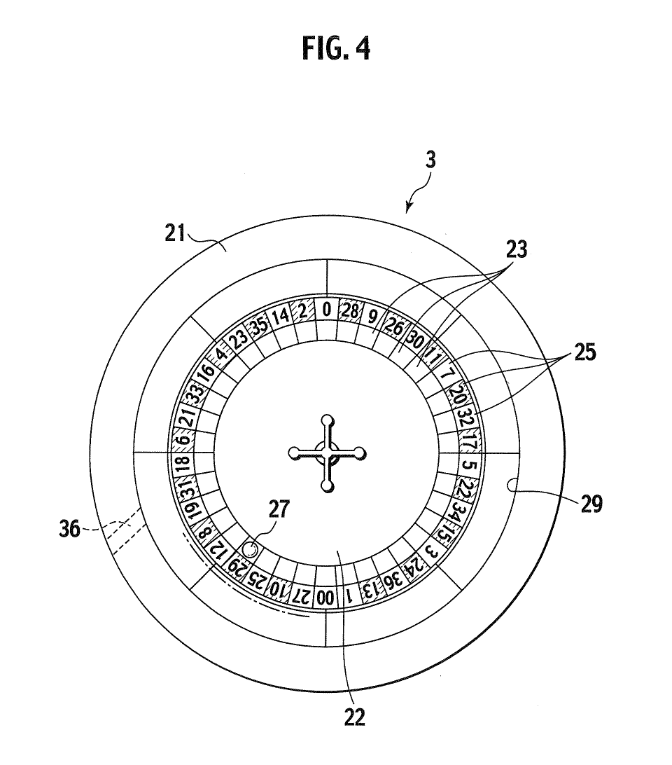

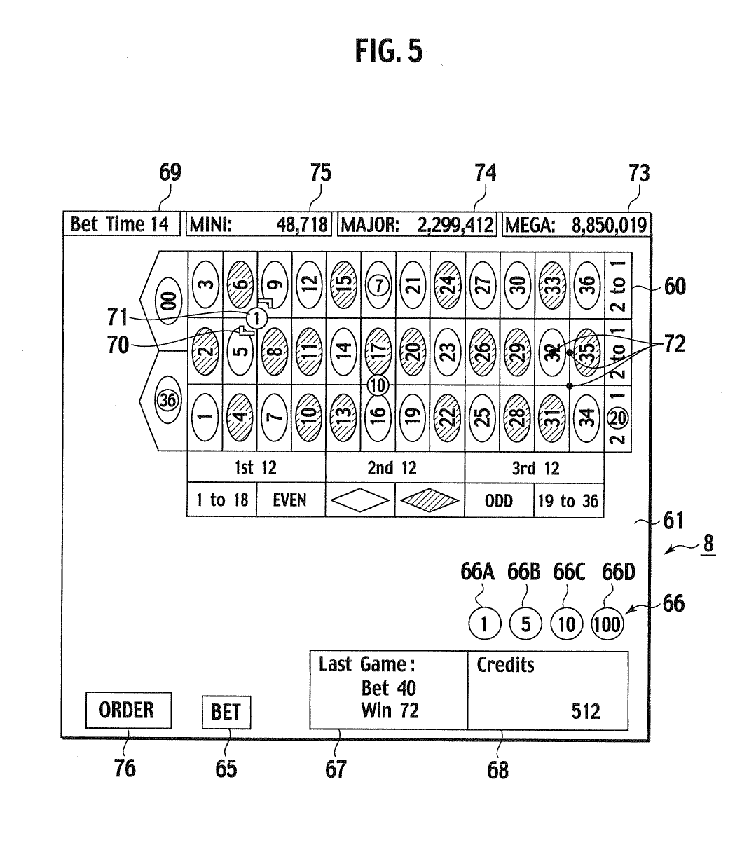

FIG. 2 is a perspective view of the gaming terminal according to the embodiment of the present invention. FIG. 3 is an external perspective view of the roulette game device according to the embodiment of the present invention, which includes the gaming terminal shown in FIG. 2. FIG. 4 is a plan view of a roulette device 2 provided on the roulette game device shown in FIG. 3. FIG. 5 is a view showing an example of an image to be displayed on a display provided on the gaming terminal shown in FIG. 2. FIG. 6 is a block diagram showing an internal configuration of the roulette game device.

A roulette game device 1 shown in FIG. 3 includes multiple gaming terminals 4 (a gaming machine) according to the embodiment of the present invention shown in FIG. 2. Besides, the roulette game device 1 includes a roulette device 2 and a server 13. For example, the roulette game device 1 is disposed in a casino area in a casino hotel as appropriate. Each of the gaming terminals 4 and the roulette device 2 can be connected to the server 13 through a local area network (communication lines) or the like.

Moreover, a shop server 86 (see FIG. 6; a server) is connected to this local area network. This shop server 86 is located in a shop area which is away from the casino area in the casino hotel. This shop server 86 is configured to manage orders of items placed by players through the respective gaming terminals 4. The shop server 86 includes a shop display 86a (a second display) for displaying the ordered items.

At the roulette device 2, the roulette game will be executed under the control of the server 13, and the game will be displayed to the players. The players use a plurality of gaming terminals 4 that are arranged around the roulette device 2, in order to participate in the roulette game displayed by the roulette device 2. In the present embodiment, the roulette game machine 1 has nine gaming terminals 4. Consequently, at most nine players can participate in the communal roulette game simultaneously.

The roulette games to be displayed on the roulette device 2 are repeatedly executed at a cycle of a predetermined time period under control by the server 13. Accordingly, each of the players can make bets on a current roulette game by use of one of the gaming terminals 4. To make bets on the current roulette game, each of the gaming terminals 4 is provided with a display 8 (a display, a first display). A BET screen 61 (see FIG. 5) corresponding to the roulette game is displayed on this display 8. Display contents of this BET screen 61 will be described later in detail.

FIG. 4 is a plan view of a roulette device provided in a roulette game machine of FIG. 3.

As shown in FIG. 4, the roulette device 2 has a frame 21, and a roulette wheel 22 which is accommodated and supported rotatably inside the frame 21. On an upper surface of the roulette wheel 22, a plurality (38 in total in the present embodiment) of number pockets 23 is formed. In addition, on an upper surface of the roulette wheel 22 on an outer side of the number pockets 23, number plates 25 are provided for displaying numbers “0”, “00”, “1” to “36” in correspondence to the respective number pockets 23.

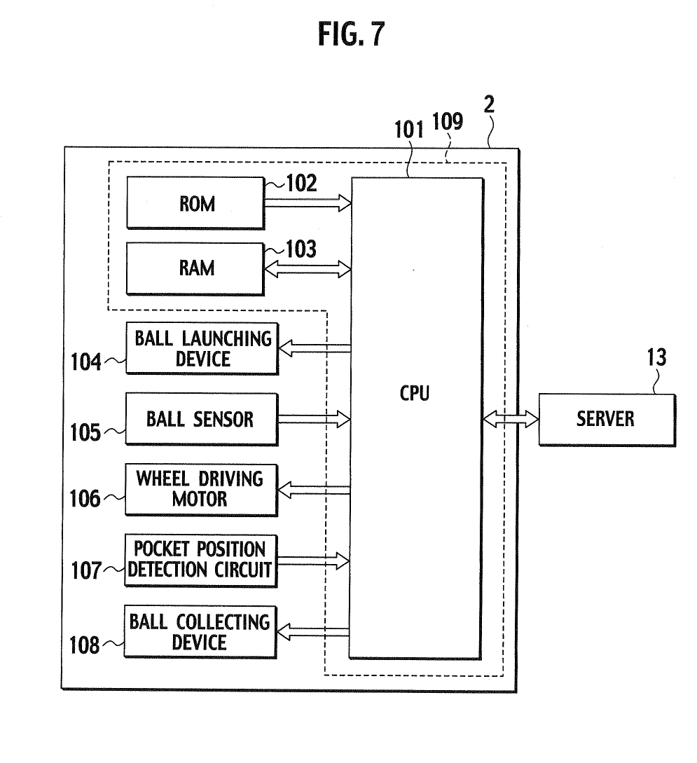

A ball launching hole 36 is opened on the inner periphery of the frame 21. The ball launching hole 36 is connected to a ball launching device 104 (see FIG. 7). In conjunction with the activation of the ball launching device 104, a ball 27 will be entered onto the roulette wheel 22 from the ball launching hole 36. Also, a hemispherical transparent acrylic cover 28 covers over the roulette device 2 (see FIG. 3).

A wheel driving motor 106 (see FIG. 7) is provided on a lower side of the roulette wheel 22. In conjunction with the activation of the wheel driving motor 106, the roulette wheel 22 will be rotated. Metal plates (not shown) are attached at prescribed intervals on a lower surface of the roulette wheel 22. As a proximity sensor of a pocket position detection circuit 107 (see FIG. 7) detects these metal plates, a position of the number pocket 23 is detected.

The frame 21 is gently inclined toward an inner side, and a guide wall 29 is formed on its middle section. The entered ball 27 is rolled by being guided by the guide wall 29 due to its centrifugal force. The ball 27 rolls down the slope of the frame 21 toward the inner side as the rotational speed decreases and the centrifugal force becomes weaker, and reaches to the rotating roulette wheel 22. Then, the ball 27 that reached to the roulette wheel 22 further falls into one of the number pockets 23 by passing over the number plates 25 on an outer side of the rotating roulette wheel 22. As a result, the number on the number plate 25 of the number pocket 23 into which the ball fell is judged by a ball sensor 105, and this number will become a winning number.

Next, the configuration of the gaming terminal 4 will be described.

As shown in FIG. 2, the gaming terminal 4 has a medal insertion slot 7 for inserting game media (currency value: such as cash, a chip, a medal, etc.) and a above-mentioned display 8 for displaying images related to the game on its upper face. The gaming terminal 4 accepts the betting operation by the player by using the medal insertion slot 7 and the display 8. The player can play the game by operating the touch panel 50 (see FIG. 7) or the like that is provided on a front face of the display 8 while watching the images displayed on the display 8. Note that, in the following description, the game media may be referred as their representative “medals”.

Also, besides the medal insertion slot 7 and the display 8 described above, a payout button 5, a ticket printer 6, a bill insertion slot 9, a speaker 10, a microphone 15, and a card reader 16 are provided on an upper face of the gaming terminal 4. A medal payout opening 12 and a medal tray 14 are provided in a front face of the gaming terminal 4.

The payout button 5 is a button for inputting a command for paying out credited medals from the medal payout opening 12 to the medal tray 14. The ticket printer 6 prints out as the bar code ticket including the data such as the credits, the date, and the identification number of the gaming terminal 4. The player can use the bar code ticket at another gaming terminal 4 and the player can bet to the game at that gaming terminal 4. Or the player can exchange the bar code ticket to bills or the like at a prescribed location (a cashier in the casino, for example) in the gaming facility.

The bill insertion slot 9 is configured to validate the appropriateness of bills and to accept authentic bills. Here, the bill insertion slot 9 may also be configured to be capable of reading a bar-coded ticket 39. The speaker 10 is used to output music, sound effects, speech messages (conversation sentences) to the player, and the like. The microphone 15 is used to input a speech message (a response sentence) uttered by the player.

The card reader 16, in which a smart card 17 (a portable memory) can be inserted, reads data out of the inserted smart card 17 and writes data into the smart card 17. The smart card, owned by the player, includes member card unique to the player, a credit card.

The data concerning the gaming history executed by the player (game history information) are stored in the smart card 17 together with data for identifying the player. The gaming history information includes game type information concerning games ever played by the player, points awarded in the games played in the past, and a language type used by the player in the course of the games. The smart card 17 may further store data corresponding to coins, bills or credits. Concerning a method of writing and reading the data in and out of this smart card 17, any of a contact method and a non-contact method (a radio-frequency identification or RFID method) is applicable. Alternatively, a magnetic stripe card is also applicable, instead of the smart card 17.

On an upper side of the display 8 of each gaming terminal 4, a WIN lamp 11 is provided respectively. In the case where the number (“0”, “00” and “1” to “36” in the present embodiment) bet at the gaming terminal 4 in the game becomes the winning number, the WIN lamp 11 of the winning gaming terminal 4 will be turned on. Also, in the jackpot (referred hereafter also as JP) bonus game for obtaining JP, the WIN lamp 11 of the gaming terminal 4 that obtained JP will be turned on similarly. Note that this WIN lamp 11 provided at a position that is visible from all of the arranged gaming terminals 4 (9 sets in the present embodiment), such that the other players who are playing at the same roulette game machine 1 can always check which WIN lamp 11 is turned on.

Inside the medal insertion slot 7, a medal sensor (not shown) is provided, and it identifies the currency values such as medals that are inserted at the medal insertion slot 7, and counts the inserted medals. Also, a hopper (not shown) is provided inside the medal payout opening 12 and it pays a prescribed number of medals from the medal payout opening 12.

FIG. 5 is the diagram showing one example of an image to be displayed on the display.

The BET screen 61 as shown in FIG. 5 is displayed on the display 8 of each of the gaming terminals 4. The BET screen 61 includes a table-type betting board 60. The player can make bets on a roulette game by using his or her chips credited in the gaming terminal 4 in the form of electronic information and by operating a touch panel 50 (see FIG. 7) provided on a front face of the display 8.

To be more precise, the player indicates with a cursor 70 a BET area 72 (on a number and a grid of a mark of the number or on a line forming the grid) which is a target for making bets of chips. Then, the player indicates with unit BET buttons 66 the number of chips to be bet and confirms the number of bet chips with a BET confirmation button 65. The above described operations can be executed with the player directly pressing, with fingers, the sections where the BET area 72, the unit BET buttons 66, and the BET confirmation button 65 are displayed on the display 8.

Here, four types of the unit BET buttons 66, namely, a 1 BET button 66A, a 5 BET button 66B, a 10 BET button 66C, and a 100 BET button 66D are provided corresponding to the number of chips that can be bet in one operation.

The number of chips bet in the previous game by the player and the number of payout credits are displayed on a payout result display unit 67 of the display 8. Meanwhile, the number of credits currently owned by the player is displayed on a credit number display unit 68 of the display 8. Moreover, remaining time for which the player can make bets is displayed on a BET time display unit 69 of the display 8.

Note that when the ball 27 entered on the roulette wheel 22 is housed in any of the number pockets 23, the winning number is confirmed and the current roulette game is finished, the next roulette game is started.

A MEGA counter 73 displaying the number of credits accumulated for a “MEGA” JP, a MAJOR counter 74 displaying the number of credits accumulated for a “MAJOR” JP, and a MINI counter 75 displaying the number of credits accumulated for a “MINI” JP are provided at the right side of the bet time display unit 69. In the case where any one of the JPs is won in the JP bonus game, a JP payout is provided according to the winning credits of the one of the JPs displayed on the respective counters 73 to 75. An initial value (200 credits for “MINI,” 5000 credits for “Major” and 50000 credits for “MEGA”) is displayed on the one of the counters 73 to 75 after the JP payout.

An order button 76 is displayed on the left of the BET confirmation button 65 on the BET screen 61. The player can display the menu of orderable items such as beverages or snacks on the display 8 by touching the order button 76 through an operation of the touch panel 50.

FIG. 6 is a block diagram showing an internal configuration of the roulette game machine according to the present embodiment.

As shown in FIG. 6, the roulette game machine 1 has the server 13, the roulette device 2 and a plurality (9 sets in the present embodiment) of the gaming terminals 4. The roulette device 2 and the gaming terminals 4 are connected to the server 13. Note that an internal configuration of the roulette device 2 and an internal configuration of the gaming terminal 4 will be described below in detail.

The server 13 has a server CPU 81 for executing the overall control of the server 13, a ROM 82, a RAM 83, a timer 84, a LCD (Liquid Crystal Display) 32 connected through a LCD driving circuit 85, and a keyboard 33.

The server CPU 81 carries out various processings according to input signals supplied from each gaming terminals 4, and data & programs stored in the ROM 82 & the RAM 83. Also, the server CPU 81 transmits command signals to the gaming terminals 4 according to the processing results, to control each gaming terminal 4 by its initiative. Also, the server CPU 81 transmits control signals to the roulette device 2, to control the shooting of the ball 27 and the rotation of the roulette wheel 22.

The ROM 82 is formed by a semiconductor memory or the like and stores programs that implement basic functions of the roulette game machine 1, programs that execute the notification of the maintenance time and the setting & management of the notification condition, the payout rate data for the roulette game (the payout credits with respect to the win per one chip), programs for controlling each gaming terminal 4 initiatively, etc.

On the other hand, the RAM 83 temporarily stores the betting information supplied from each gaming terminal 4, the winning number of the roulette device 2 detected by the sensors, the accumulated JP credits, the data regarding the result of the processing executed by the server CPU 81, etc.

In addition, the timer 84 is connected to the server CPU 81. The time information of the timer 84 is transmitted to the server CPU 81. The server CPU 81 executes the control of the rotation of the roulette wheel 22 and the shooting of the ball 27 based on the time information of the timer 84.

FIG. 7 is a block diagram showing an internal configuration of the roulette device according to the present embodiment.

As shown in FIG. 7, the roulette device 2 has a controller 109, the pocket position detection circuit 107, the ball launching device 104, the ball sensor 105, the wheel driving motor 106, and a ball collecting device 108. The controller 109 corresponds to the controller of the present invention.

The controller 109 has a CPU 101, a ROM 102, and a RAM 103. The CPU 101 controls the shooting of the ball 27 and the rotation of the roulette wheel 22 according to the control signals supplied from the server 13, and data & programs stored in the ROM 102 & the RAM 103.

The pocket position detection circuit 107 has a proximity sensor. It detects the rotation position of the roulette wheel 22 by detecting metal plates attached to the roulette wheel 22.

The ball launching device 104 is for launching the ball 27 onto the roulette wheel 22 from the ball launching hole 36 (see FIG. 4). The ball launching device 104 shoots the ball 27 at an initial speed and at a timing set in the control data.

The ball sensor 105 is a device for detecting the number pocket 23 into which the ball 27 fell. The wheel driving motor 106 is for rotating the roulette wheel 22. The wheel driving motor 106 stops the activation after the motor driving time that is set in the control data has elapsed since the start of the activation. The ball collecting device 108 is for collecting the ball 27 on the roulette wheel 22 after the game is over.

FIG. 8 is a block diagram showing an internal configuration of the gaming terminal according to the present embodiment. Note that 9 sets of the gaming terminals 4 have basically the same configuration, and an example of one gaming terminal 4 will be described in the following.

As shown in FIG. 8, the gaming terminal 4 has a terminal controller 90 formed by a terminal CPU 91, a ROM 92 and a RAM 93. The ROM 92 is formed by a semiconductor memory or the like and stores programs that implement basic functions of the gaming terminal 4, and various programs, data table, etc., that are necessary for controlling the gaming terminal 4. Also, the RAM 93 is a memory for temporarily storing various data calculated by the terminal CPU 91, the owned credits by the player (deposited at the gaming terminal 4), the state of betting by the player, a flag F for indicating that it is under the betting period or not, etc.

To the terminal CPU 91, a payout button 5 is connected.

The payout button 5 is a button to be pressed by the player usually when the game is over. When the payout button 5 is pressed by the player, the medals according to the credits acquired in the game by the player will be paid from the medal payout opening 12 (usually one medal for one credit).

The terminal CPU 91 executes various corresponding operations according to the operation signals outputted by the payout button 5 as a result of pressing of the payout button 5. More specifically, the terminal CPU 91 executes various processings when signals associated with the pressing of the bet confirmation button 65 is inputted, according to the input signals and data & programs stored in the ROM 92 & the RAM 93. The terminal CPU 91 transmits their processing results to the server CPU 81.

Also, the terminal CPU 91 receives command signals from the sever CPU 81 and controls peripheral devices constituting the gaming terminal 4, so as to proceed with the game. Also, the terminal CPU 91 executes various processings according to the above described input signals and data & programs stored in the ROM 92 & the RAM 93, depending on the processing contents. The terminal CPU 91 controls the peripheral devices constituting the gaming terminal 4 according to the processing results, so as to proceed with the game.

Also, a hopper 94 is connected to the terminal CPU 91. The hopper 94 pays a prescribed number of medals from the medal payout opening 12 (see FIG. 2) according to a command signal from the terminal CPU 91.

In addition, the display 8 is connected to the terminal CPU 91 through a LCD driving circuit 95. The LCD driving circuit 95 has a program ROM, an image ROM, an image control CPU, a work RAM, VDP (Video Display Processor), and a video RAM. The program ROM stores an image controlling program and various selection tables regarding the display at the display 8. The image ROM stores dot data for forming an image to be displayed at the display 8, for example. The image control CPU makes the determination of an image to be displayed at the display 8 from the dot data in the image ROM, according to the image control program in the program ROM, based on parameters set up by the terminal CPU 91. The work RAM is provided as a temporary memory device at a time of executing the image control program at the image control CPU. The VDP forms a display image determined by the image control CPU and outputs it to the display 8. Note that the video RAM is provided as a temporary memory device at a time of forming an image by the VDP.

Also, the touch panel 50 is attached on the front surface of the display 8. The operation information of the touch panel 50 is transmitted to the terminal CPU 91. At the touch panel 50, the betting operation by the player is carried out on the bet screen 61. More specifically, the operation of the touch panel 50 is carried out for the selection of the bet area 72 and the input via the bet buttons 66 and the bet confirmation button 65, etc. When the touch panel 50 is operated, its operation information is transmitted to the terminal CPU 91. Then, according to that information, the betting information (the bet area and the number of bets specified on the bet screen 61) is stored into the RAM 93. In addition, this betting information is transmitted to the server CPU 81, and stored in the betting information memory area of the RAM 83.

Moreover, a round output circuit 96 and the speaker 10 are connected to the terminal CPU 91. The speaker 10 generates, based on output signals from the sound output circuit 96, various sound effects for executing various effects and dialog message sounds to the player for interactive gaming.

Meanwhile, a sound input circuit 98 and the microphone 15 are connected to the terminal CPU 91. The microphone 15 is used to input through the sound input circuit 98, into the terminal CPU 91, response message sounds in the player's voice to the dialog message sounds outputted from the speaker 10.

Also, a medal sensor 97 is connected to the terminal CPU 91. The medal sensor 97 detects medals inserted from the medal insertion slot 7 (see FIG. 2). At the same time, the medal sensor 97 counts the inserted medals, and transmits its result to the terminal CPU 91. The terminal CPU 91 increases the amount of credits of the player that is stored in the RAM 93 according to the transmitted signal.

Also, a WIN lamp 11 is connected to the terminal CPU 91. The terminal CPU 91 turns on the WIN lamp 11 in a prescribed color, when the bet on the bet screen 61 won or when the JP is won.

Moreover, external memories 99 and 100 are connected to the terminal CPU 91. Each of the external memories 99 and 100 is formed of a hard disk device. The terminal CPU 91 writes and reads data in and out of the external memories 99 and 100 if necessary. Of these external memories 99 and 100, menu data indicating contents of a menu orderable through this gaming terminal are stored in the external memory 100 (the memory) in each multiple language type usable for playing the roulette game.

Moreover, the gaming terminal 4 provided with the above-described terminal controller 90 includes a conversation engine. By using this conversation engine, at least part of the roulette games on the gaming terminal 4 are interactively executed in a dialog style with the player by using the display 8, the speaker 10, and the microphone 15 as interfaces. Accordingly, in a certain scene, as the roulette game proceeds, the message sound is outputted from the speaker 10 to the player through the sound output circuit 96 and the contents of the message sounds of the player inputted through the microphone 15 and the sound input circuit 98 are analyzed.

Such a conversation engine can be achieved by using any of the conversation controllers disclosed in US Patent Application Publication No. 2007/0094007, US Patent Application Publication No. 2007/0094008, US Patent Application Publication No. 2007/0094005, and US Patent Application Publication No. 2007/0094004, for example. As will be described later, such a conversation controller can be achieved by use of the display 8 and the speaker 10, the microphone 15, the terminal controller 90, and the external memory 99 of the gaming terminal 4.

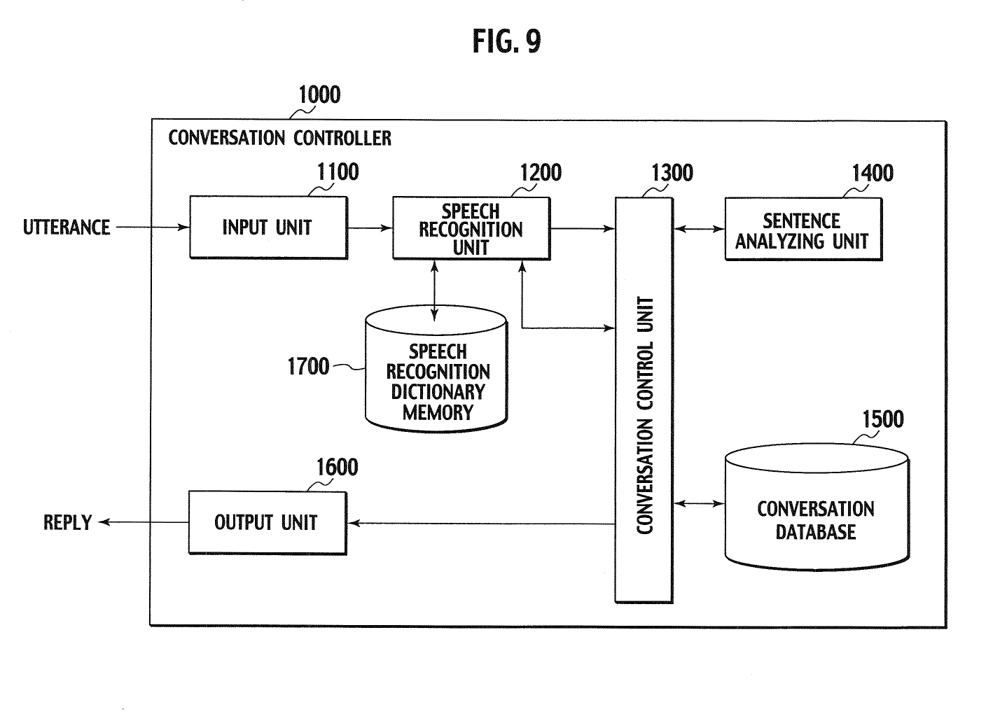

Here, a configuration of the conversation controller disclosed in US Patent Application Publication No. 2007/0094007, which is available as the conversation engine to be installed on the gaming terminal 4 of this embodiment, will be described with reference to FIG. 9 to FIG. 30. FIG. 9 is a functional block diagram showing a configuration example of a conversation controller.

As shown in FIG. 9, a conversation controller 1000 includes an input unit 1100, a speech recognition unit 1200, a conversation control unit 1300, a sentence analyzing unit 1400, a conversation database 1500, an output unit 1600, and a speech recognition dictionary memory 1700.

### [Input Unit]

The input unit 1100 receives input information (user's utterance) input by a user. The input unit 1100 outputs a speech corresponding to contents of the received utterance as a voice signal to the speech recognition unit 1200. Note that the input unit 1100 may be a character input unit such as a keyboard and a touchscreen (touch panel). In this case, the after-mentioned speech recognition unit 1200 doesn't need to be provided.

### [Speech Recognition Unit]

The speech recognition unit 1200 specifies a character string corresponding to the uttered contents based on the uttered contents obtained via the input unit 1100. Specifically, the speech recognition unit 1200 that has received the voice signal from the input unit 1100 compares the received voice signal with the conversation database 1500 and dictionaries stored in the speech recognition dictionary memory 1700 based on the voice signal to output a speech recognition result estimated based on the voice signal to the conversation control unit 1300. In a configuration example shown in FIG. 9, the speech recognition unit 1200 requests acquisition of memory contents of the conversation database 1500 to the conversation control unit 1300 and then receives the memory contents of the conversation database 1500 which the conversation control unit 1300 retrieves according to the request from the speech recognition unit 1200. However the speech recognition unit 1200 may directly retrieves the memory contents of the conversation database 1500 for comparing with the voice signal.

### Configuration Example of Speech Recognition Unit

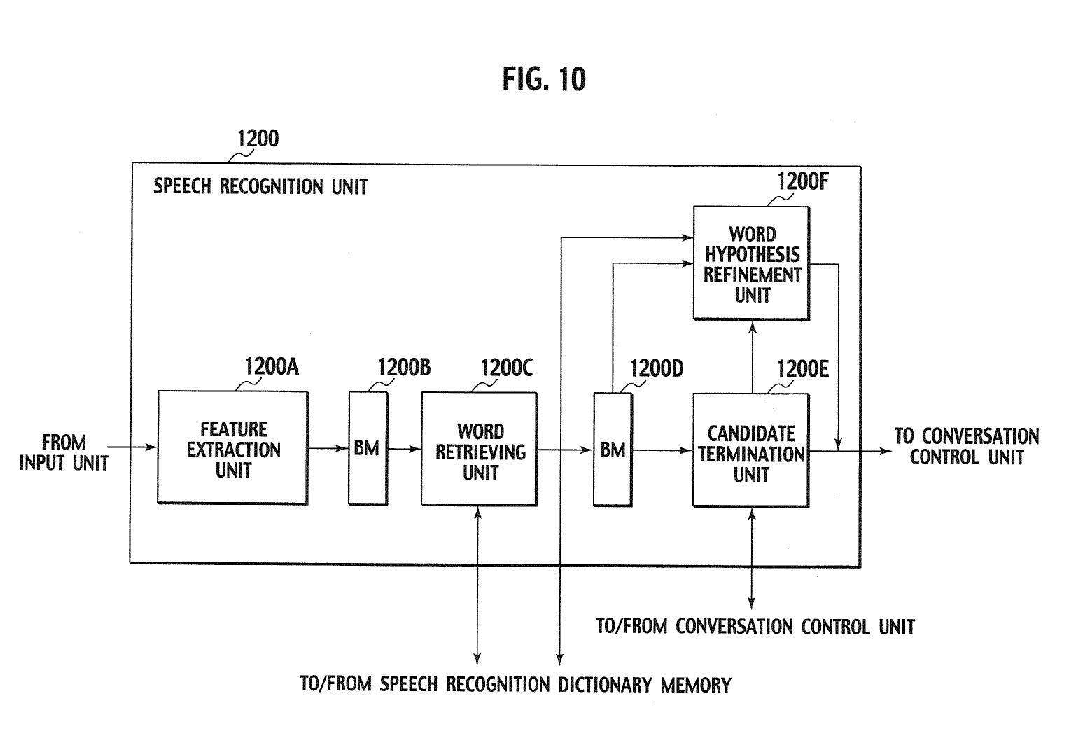

FIG. 10 is a functional block diagram showing a configuration example of the speech recognition unit 1200. The speech recognition unit 1200 includes a feature extraction unit 1200A, a buffer memory (BM) 1200B, a word retrieving unit 1200C, a buffer memory (BM) 1200D, a candidate determination unit 1200E and a word hypothesis refinement unit 1200F. The word retrieving unit 1200C and the word hypothesis refinement unit 1200F are connected to the speech recognition dictionary memory 1700. In addition, the candidate determination unit 1200E is connected to the conversation database 1500 via the conversation control unit 1300.

The speech recognition dictionary memory 1700 connected to the word retrieving unit 1200C stores a phoneme hidden markov model (hereinafter, the hidden markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700 connected to the word retrieving unit 1200C further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A. The feature extraction unit 1200A converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C via the buffer memory (BM) 1200B.

The word retrieving unit 1200C retrieves word hypotheses with a one-pass Viterbi decoding method based on the feature parameters input from the feature extraction unit 1200A via the buffer memory (BM) 1200B by using the phoneme HMM and the word dictionary stored in the speech recognition dictionary memory 1700, and then calculates likelihoods. Here, the word retrieving unit 1200C calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C may reduce grid hypotheses of the lower likelihoods among all of the calculated likelihoods based on the phoneme HMM and the word dictionary in order to reduce a computing throughput. The word retrieving unit 1200C outputs information on the retrieved word hypotheses and the likelihoods of the retrieved word hypotheses together with time information regarding an elapsed time from the speech start time (e.g. frame number) to the candidate determination unit 1200E and the word hypothesis refinement unit 1200F via the buffer memory (BM) 1200D.

The candidate determination unit 1200E compares the retrieved word hypotheses with topic specification information in a prescribed discourse space with reference to the conversation control unit 1300, and then determines whether or not exists a coincident word hypothesis with the topic specification information in the prescribed discourse space among the retrieved word hypotheses. If the coincident word hypothesis exists, the candidate determination unit 1200E outputs the coincident word hypothesis as a recognition result. On the other hand, if the coincident word hypothesis doesn't exist, the candidate determination unit 1200E requires the word hypothesis refinement unit 1200F to refine the retrieved word hypotheses.

An operation of the candidate determination unit 1200E will be described. Here, it is assumed that the word retrieving unit 1200C outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

The candidate determination unit 1200E compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F operates to output the recognition result in response to the request from the candidate determination unit 1200E to refine the retrieved word hypotheses. The word hypothesis refinement unit 1200F refines the retrieved word hypotheses for the same words having the same speech termination time and different speech start time per each initial phonetic environment of the same words with reference to a statistical language model stored in the speech recognition dictionary memory 1700 based on the plural retrieved word hypotheses output from the word retrieving unit 1200C via the buffer memory (BM) 1200D so that one word hypothesis with the highest likelihood may be selected as a representative among all of the likelihoods calculated between the speech start and the utterance termination of the word. And then, the word hypothesis refinement unit 1200F outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

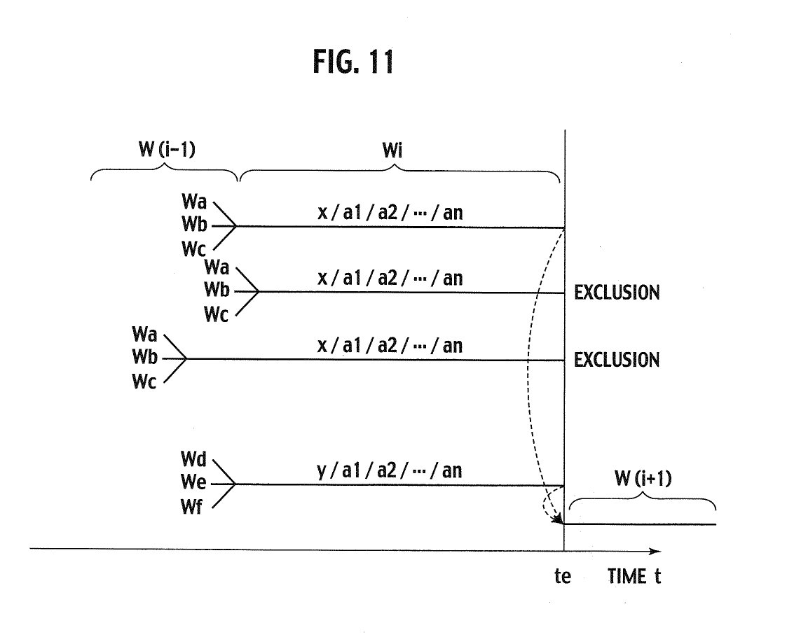

A word refinement process executed by the word hypothesis refinement unit 1200F will be described with reference to FIG. 11.

For example, it is assumed that the (i)th word Wi, which consists of a phonemic string a1, a2, . . . and an, follows the (i−1)th word W(i−1) and six hypotheses Wa, Wb, Wc, Wd, We and Wf exist as a word hypothesis of the (i−1)th word W(i−1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A, the word retrieving unit 1200C, the candidate determination unit 1200E and the word hypothesis refinement unit 1200F are composed of a computer such as a microcomputer. The buffer memories (BMs) 200B and 200D and the speech recognition dictionary memory 1700 are composed of a memory unit such as a hard disk storage.

In the above-mentioned embodiment, the speech recognition is executed by using the word retrieving unit 1200C and the word hypothesis refinement unit 1200F. However, the present invention is not limited to this. The speech recognition unit 1200 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200 is explained as a part of the conversation controller 1000. However, a independent speech recognition apparatus configured by the speech recognition unit 1200, the conversation database 1500 and the speech recognition dictionary memory 1700 may be possibly employed.

### Operating Example of Speech Recognition Unit

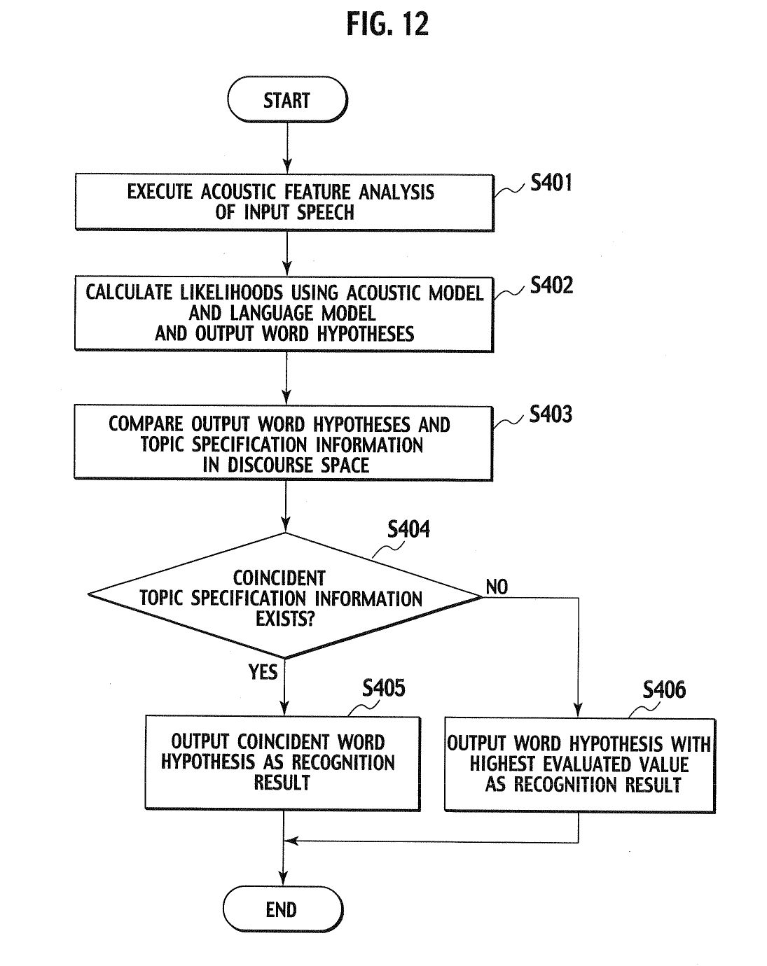

Next, operations of the speech recognition unit 1200 will be described with reference to FIG. 12. FIG. 12 is a flow-chart showing process operations of the speech recognition unit 1200.

The speech recognition unit 1200 executes a feature analysis of the input speech to generate feature parameters on receiving the voice signal from the input unit 1100 (step S401). Next, the feature parameters is compared with the phoneme HMM and the language model stored in the speech recognition dictionary memory 1700, and then a certain number of word hypotheses and the likelihoods of the word hypotheses are obtained (step S402). Next, the speech recognition unit 1200 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403 and S404). If the coincident word hypothesis exists, the speech recognition unit 1200 outputs the coincident word hypothesis as the recognition result (step S405). On the other hand, if no coincident word hypothesis exists, the speech recognition unit 1200 outputs the word hypothesis with the highest likelihood as the recognition result according to the obtained likelihoods of the word hypotheses (step S406).

### [Speech Recognition Dictionary Memory]

The configuration example of the conversation controller 1000 is further described with referring back to FIG. 9 again.

The speech recognition dictionary memory 1700 stores character strings corresponding to standard voice signals. The speech recognition unit 1200, which has executed the comparison, specifies a word hypothesis for a character string corresponding to the received voice signal, and then outputs the specified word hypothesis as a character string signal to the conversation control unit 1300.

### [Sentence Analyzing Unit]

Next, a configuration example of the sentence analyzing unit 1400 will be described with reference to FIG. 13. FIG. 13 is a partly enlarged block diagram of the conversation controller 1000 and also a block diagram showing a concrete configuration example of the conversation control unit 1300 and the sentence analyzing unit 1400. Note that only the conversation control unit 1300, the sentence analyzing unit 1400 and the conversation database 1500 are shown in FIG. 13 and the other components are omitted to be shown.

The sentence analyzing unit 1400 analyses a character string specified at the input unit 1100 or the speech recognition unit 1200. In the present embodiment as shown in FIG. 13, the sentence analyzing unit 1400 includes a character string specifying unit 1410, a morpheme extracting unit 1420, a morpheme database 1430, an input type determining unit 1440 and an utterance type database 1450. The character string specifying unit 1410 segments a series of character strings specified by the input unit 1100 or the speech recognition unit 1200 into segments. Each segment is a minimum segmented sentence which is segmented in the extent to keep a grammatical meaning. Specifically, if the series of the character strings have a time interval more than a certain interval, the character string specifying unit 1410 segments the character strings there. The character string specifying unit 1410 outputs the segmented character strings to the morpheme extracting unit 1420 and the input type determining unit 1440. Note that a “character string” to be described below means one segmented character string.

### [Morpheme Extracting Unit]

The morpheme extracting unit 1420 extracts morphemes constituting minimum units of the character string as first morpheme information from each of the segmented character strings based on each of the segmented character strings segmented by the character string specifying unit 1410. In the present embodiment, a morpheme means a minimum unit of a word structure shown in a character string. For example, each minimum unit of a word structure may be a word class such as a noun, an adjective and a verb.

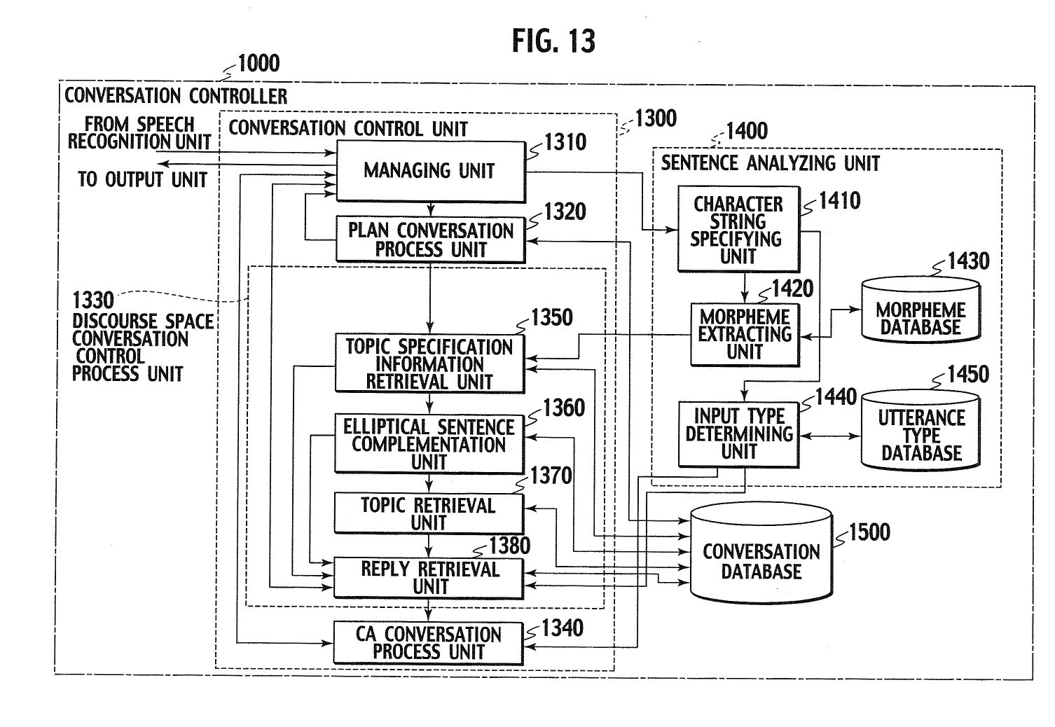

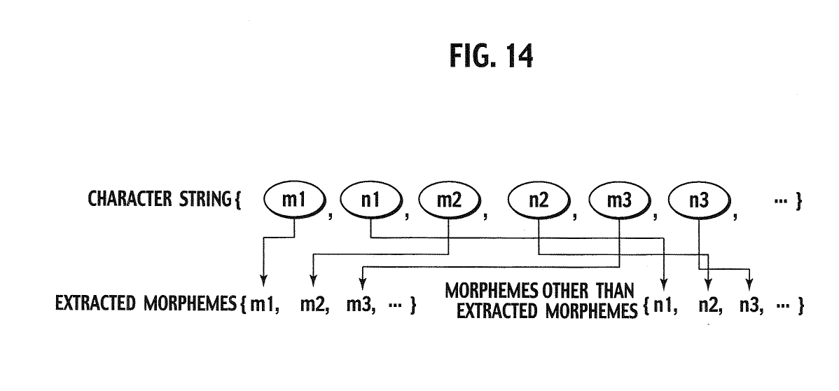

In the present embodiment as shown in FIG. 14, the morphemes are indicated as m1, m2, m3, . . . . FIG. 14. is a diagram showing a relation between a character string and morphemes extracted from the character string. The morpheme extracting unit 1420, which has received the character strings from the character string specifying unit 1410, compares the received character strings and morpheme groups previously stored in the morpheme database 1430 (each of the morpheme group is prepared as a morpheme dictionary in which a direction word, a reading, a word class and infected forms are described for each morpheme belonging to each word-class classification) as shown in FIG. 14. The morpheme extracting unit 1420, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420 outputs the extracted morphemes to a topic specification information retrieval unit 1350 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

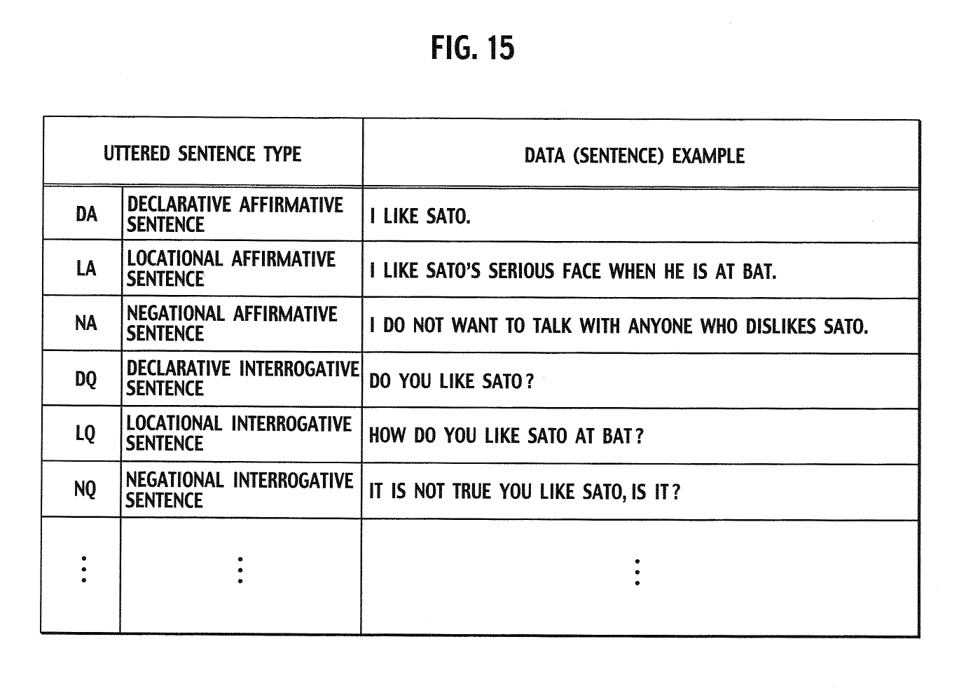

The input type determining unit 1440 determines an uttered contents type (utterance type) based on the character strings specified by the character string specifying unit 1410. In the present embodiment, the utterance type is information for specifying the uttered contents type and, for example, corresponds to “uttered sentence type” shown in FIG. 15. FIG. 15 is a table showing the “uttered sentence types”, two-alphabet codes representing the uttered sentence types, and uttered sentence examples corresponding to the uttered sentence types.

Here in the present embodiment as shown in FIG. 15, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 15. A “locational sentence” means a sentence involving a location concept. A “time sentence” means a sentence involving a time concept. A “negational sentence” means a sentence to deny a declarative sentence. Sentence examples of the “uttered sentence types” are shown in FIG. 15.

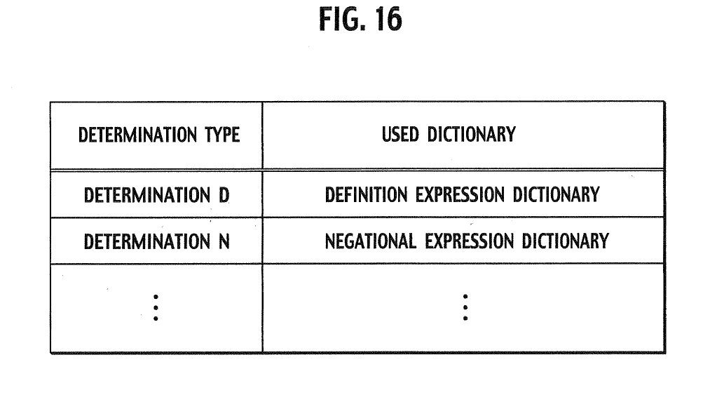

In the present embodiment as shown in FIG. 16, the input type determining unit 1440 uses a declarative expression dictionary for determination of a declarative sentence, a negational expression dictionary for determination of a negational sentence and so on in order to determine the “uttered sentence type”. Specifically, the input type determining unit 1440, which has received the character strings from the character string specifying unit 1410, compares the received character strings and the dictionaries stored in the utterance type database 1450 based on the received character string. The input type determining unit 1440, which has executed the comparison, extracts elements relevant to the dictionaries among the character strings.

The input type determining unit 1440 determines the “uttered sentence type” based on the extracted elements. For example, if the character string includes elements declaring an event, the input type determining unit 1440 determines that the character string including the elements is a declarative sentence. The input type determining unit 1440 outputs the determined “uttered sentence type” to a reply retrieval unit 1380.

### [Conversation Database]

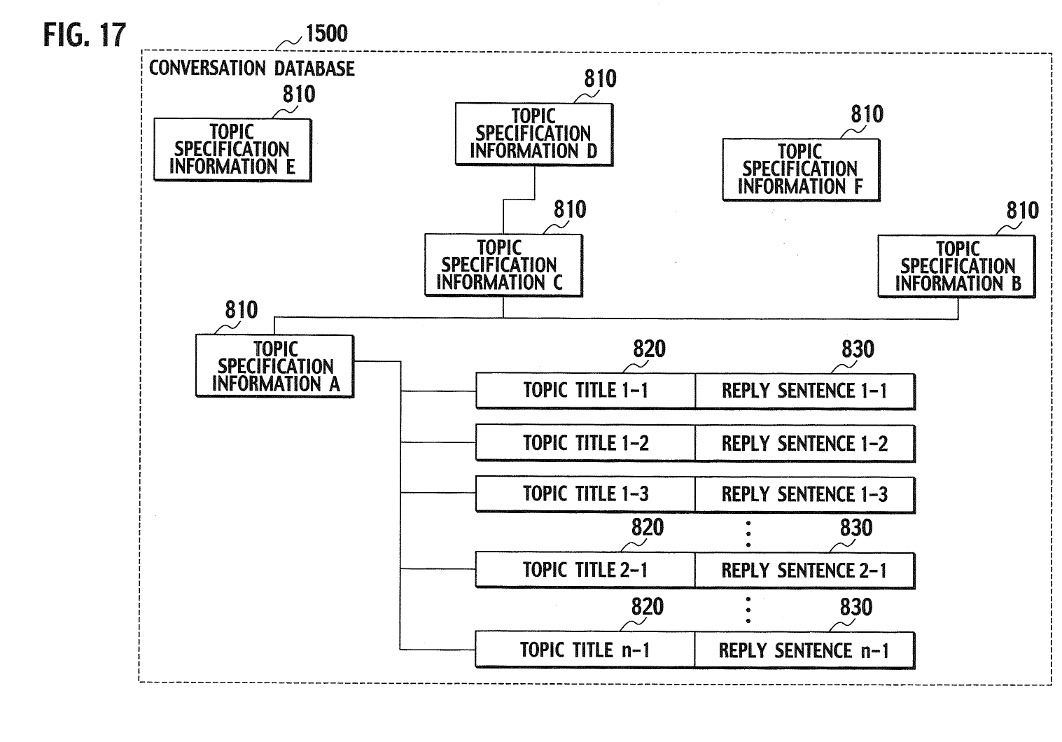

A configuration example of data structure stored in the conversation database 1500 will be described with reference to FIG. 17. FIG. 17 is a conceptual diagram showing the configuration example of data stored in the conversation database 1500.

As shown in FIG. 17, the conversation database 1500 stores a plurality of topic specification information 810 for specifying a conversation topic. In addition, topic specification information 810 can be associated with other topic specification information 810. For example, if topic specification information C (810) is specified, three of topic specification information A (810), B (810) and D (810) associated with the topic specification information C (810) are also specified.

Specifically in the present embodiment, topic specification information 810 means “keywords” which are relevant to input contents expected to be input from users or relevant to reply sentences to users.

The topic specification information 810 is associated with one or more topic titles 820. Each of the topic titles 820 is configured with a morpheme composed of one character, plural character strings or a combination thereof. A reply sentence 830 to be output to users is stored in association with each of the topic titles 820. Response types indicate types of the reply sentences 830 and are associated with the reply sentences 830, respectively.

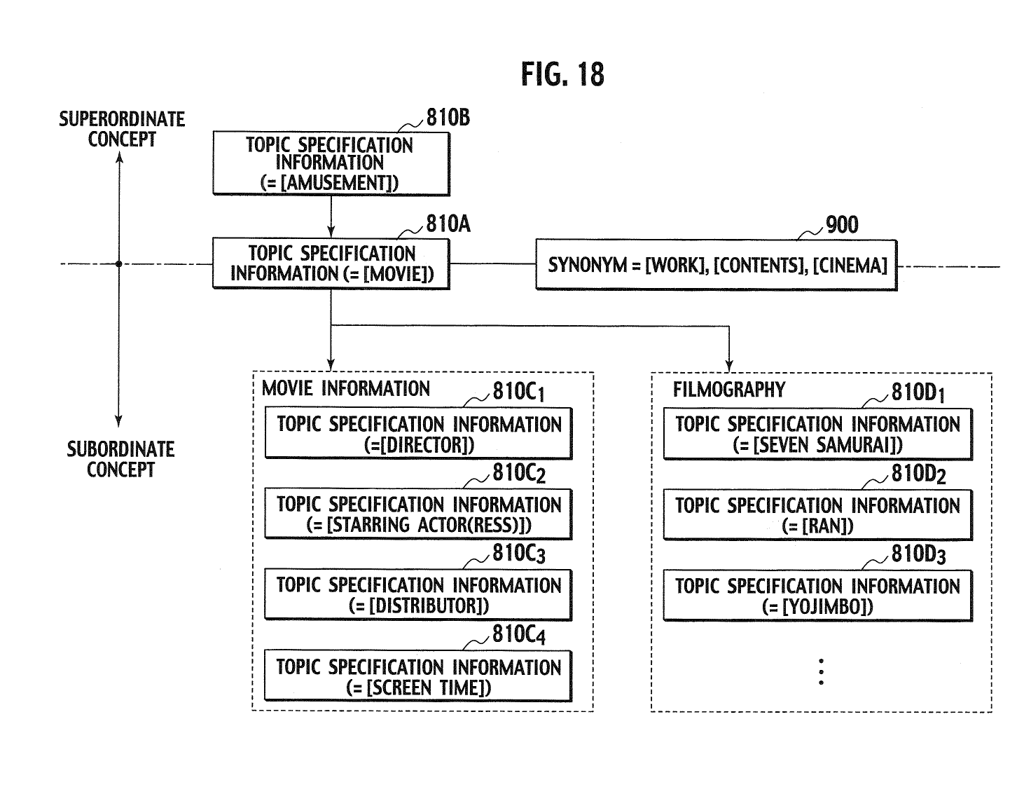

Next, an association between the topic specification information 810 and the other topic specification information 810 will be described. FIG. 18 is a diagram showing the association between certain topic specification information 810A and the other topic specification information 810B, 810C₁-810C₄ and 810D₁-810D₃ . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 18, the topic specification information can be stored in association with the other topic specification information with respect to a superordinate concept, a subordinate concept, a synonym or an antonym (not shown in FIG. 18). For example as shown in FIG. 18, the topic specification information 810B (amusement) is stored in association with the topic specification information 810A (movie) as a superordinate concept and stored in a higher level than the topic specification information 810B (amusement).

In addition, subordinate concepts of the topic specification information 810A (movie), the topic specification information 810C₁ (director), 810C₂ (starring actor[ress]), 810C₃ (distributor), 810C₄ (screen time), 810D₁ (“Seven Samurai”), 810D₂ (“Ran”), 810D₃ (“Yojimbo”), . . . , are stored in association with the topic specification information 810A.

In addition, synonyms 900 are associated with the topic specification information 810A. In this example, “work”, “contents” and “cinema” are stored as synonyms of “movie” which is a keyword of the topic specification information 810A. By defining these synonyms in this manner, the topic specification information 810A can be treated as included in an uttered sentence even though the uttered sentence doesn't include the keyword “movie” but includes “work”, “contents” or “cinema”.

In the conversation controller 1000 according to the present embodiment, when certain topic specification information 810 has been specified with reference to contents stored in the conversation database 1500, other topic specification information 810 and the topic titles 820 or the reply sentences 830 of the other topic specification information 810, which are stored in association with the certain topic specification information 810, can be retrieved and extracted rapidly.

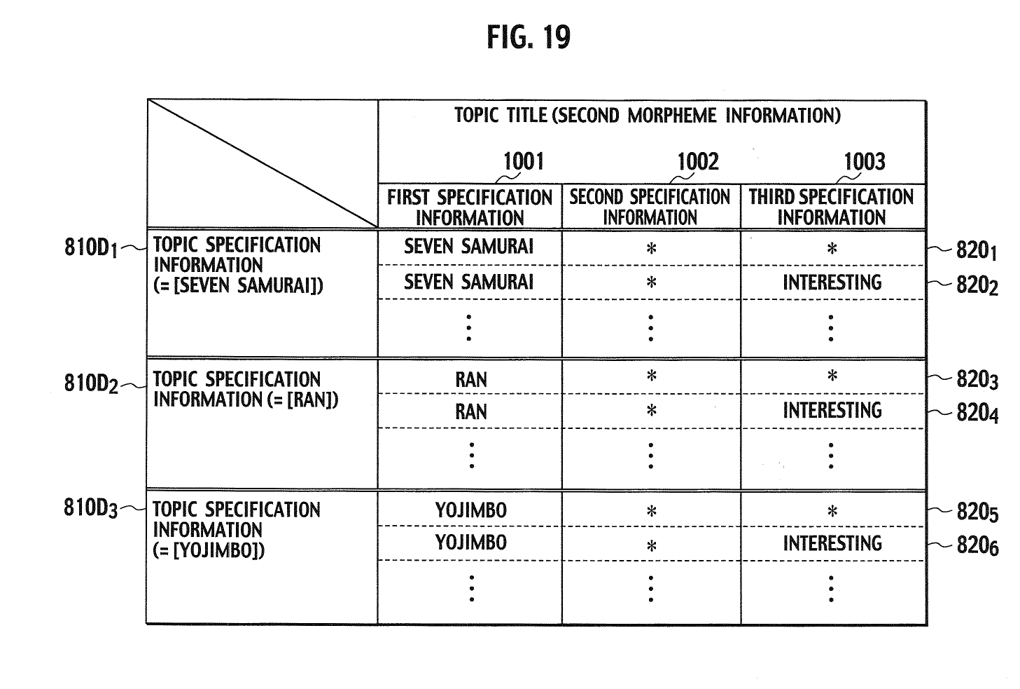

Next, data configuration examples of topic titles 820 (also referred as “second morpheme information”) will be described with reference to FIG. 19. FIG. 19 is a diagram showing the data configuration examples of the topic titles 820.

The topic specification information 810D₁, 810D₂, 810D₃, . . . , include the topic titles 820₁, 820₂, . . . , the topic titles 820₃, 820₄, . . . , the topic titles 820₅, 820₆, . . . , respectively. In the present embodiment as shown in FIG. 19, each of the topic titles 820 is information composed of first specification information 1001, second specification information 1002 and third specification information 1003. Here, the first specification information 1001 is a main morpheme constituting a topic. For example, the first specification information 1001 may be a Subject of a sentence. In addition, the second specification information 1002 is a morpheme closely relevant to the first specification information 1001. For example, the second specification information 1002 may be an Object. Furthermore, the third specification information 1003 in the present embodiment is a morpheme showing a movement of a certain subject, a morpheme of a noun modifier and so on. For example, the third specification information 1003 may be a verb, an adverb or an adjective. Note that the first specification information 1001, the second specification information 1002 and the third specification information 1003 are not limited to the above meanings. The present embodiment can be effected in case where contents of a sentence can be understood based on the first specification information 1001, the second specification information 1002 and the third specification information 1003 even though they are give other meanings (other ward classes).

For example as shown in FIG. 19, if the Subject is “Seven Samurai” and the adjective is “interesting”, the topic title 820₂ (second morpheme information) consists of the morpheme “Seven Samurai” included in the first specification information 1001 and the morpheme “interesting” included in the third specification information 1003. Note that the second specification information 1002 of this topic title 820₂ includes no morpheme and a symbol “*” is stored in the second specification information 1002 for indicating no morpheme included.

Note that this topic title 820₂ (Seven Samurai; *; interesting) has the meaning of “Seven Samurai is interesting.” Hereinafter, parenthetic contents for a topic title 820₂ indicate the specification information 1001, the second specification information 1002 and the third specification information 1003 from the left. In addition, when no morpheme is included in any of the first to third specification information, “*” is indicated therein.

Note that the specification information constituting the topic titles 820 is not limited to three and other specification information (fourth specification information and more) may be included.

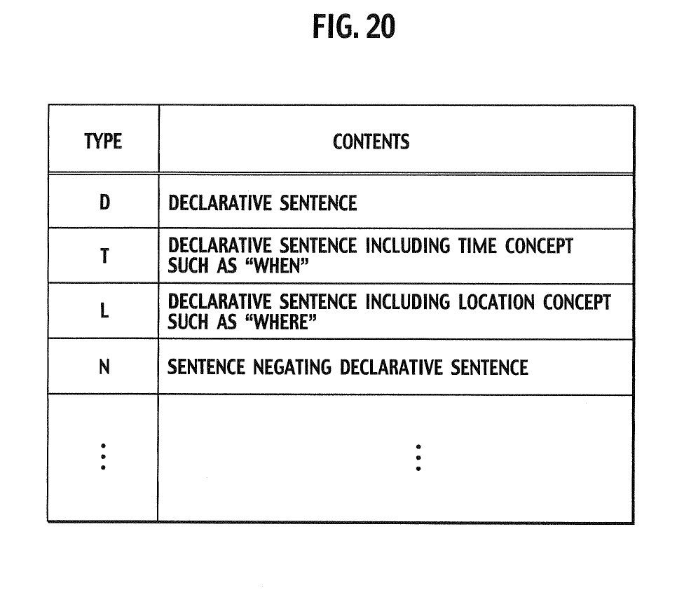

The reply sentences 830 will be described with reference to FIG. 20. In the present embodiment as shown in FIG. 20, the reply sentences 830 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

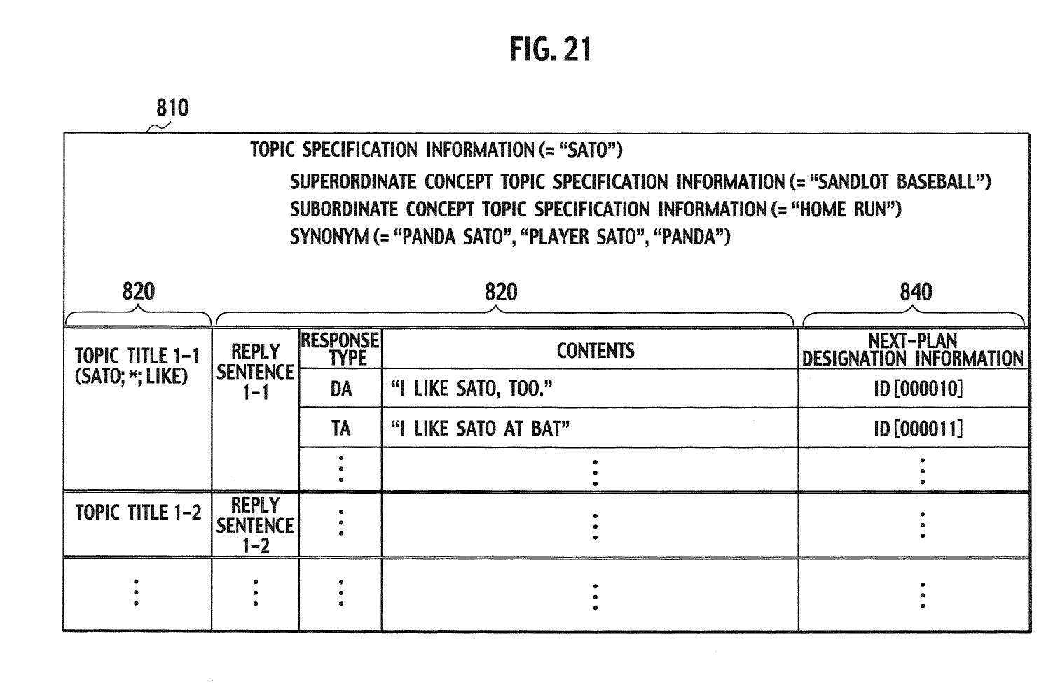

A configuration example of data structure of the topic specification information 810 will be described with reference to FIG. 21. FIG. 21 shows a concrete example of the topic titles 820 and the reply sentences 830 associated with the topic specification information 810 “Sato”.

The topic specification information 810 “Sato” is associated with plural topic titles (820) 1-1, 1-2, . . . . Each of the topic titles (820) 1-1, 1-2, . . . is associated with reply sentences (830) 1-1, 1-2, . . . . The reply sentence 830 is prepared per each of the response types 840.

For example, when the topic title (820) 1-1 is (Sato; *; like) [these are extracted morphemes included in “I like Sato”], the reply sentences (830) 1-1 associated with the topic title (820) 1-1 include (DA: a declarative affirmative sentence “I like Sato, too.”) and (TA: a time affirmative sentence “I like Sato at bat.”). The after-mentioned reply retrieval unit 1380 retrieves one reply sentence 830 associated with the topic title 820 with reference to an output from the input type determining unit 1440.

Next-plan designation information 840 is allocated to each of the reply sentences 830. The next-plan designation information 840 is information for designating a reply sentence to be preferentially output against a user's utterance in association with the each of the reply sentences (referred as a “next-reply sentence”). The next-plan designation information 840 may be any information even if a next-reply sentence can be specified by the information. For example, the information may be a reply sentence ID, by which at least one reply sentence can be specified among all reply sentences stored in the conversation database 1500.

In the present embodiment, the next-plan designation information 840 is described as information for specifying one next-reply sentence per one reply sentence (for example, a reply sentence ID). However, the next-plan designation information 840 may be information for specifying next-reply sentences per topic specification information 810 or per one topic title 820. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300 is further described with referring back to FIG. 13.

The conversation control unit 1300 functions to control data transmitting between configuration components in the conversation controller 1000 (the speech recognition unit 1200, the sentence analyzing unit 1400, the conversation database 1500, the output unit 1600 and the speech recognition dictionary memory 1700), and determine and output a reply sentence in response to a user's utterance.

In the present embodiment shown in FIG. 13, the conversation control unit 1300 includes a managing unit 1310, a plan conversation process unit 1320, a discourse space conversation control process unit 1330 and a CA conversation process unit 1340. Hereinafter, these configuration components will be described.

### [Managing Unit]

The managing unit 1310 functions to store discourse histories and update, if needed, the discourse histories. The managing unit 1310 further functions to transmit some or entire of the stored discourse histories to a part or a whole of the discourse histories to a topic specification information retrieval unit 1350, an elliptical sentence complementation unit 1360, a topic retrieval unit 1370 or a reply retrieval unit 1380 in response to a request therefrom.

### [Plan Conversation Process Unit]

The plan conversation process unit 1320 functions to execute plans and establish conversations between a user and the conversation controller 1000 according to the plans. A “plan” means providing a predetermined reply to a user in a predetermined order.

The plan conversation process unit 1320 functions to output the predetermined reply in the predetermined order in response to a user's utterance.

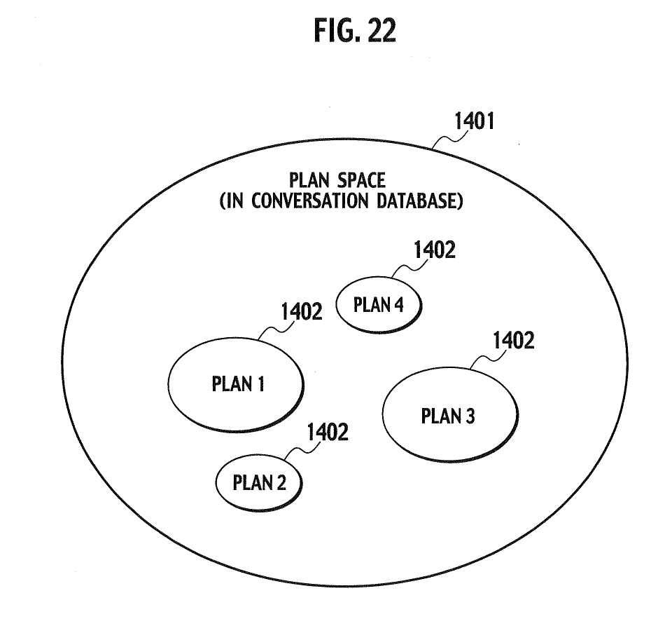

FIG. 22 is a conceptual diagram to describe plans. As shown in FIG. 22, various plans 1402 such as plural plans 1, 2, 3 and 4 are prepared in a plan space 1401. The plan space 1401 is a set of the plural plans 1402 stored in the conversation database 1500. The conversation controller 1000 selects a preset plan 1402 for a start-up on an activation or a conversation start or arbitrarily selects one of the plans 1402 in the plan space 1401 in response to a user's utterance contents in order to output a reply sentence against the user's utterance by using the selected plan 1402.

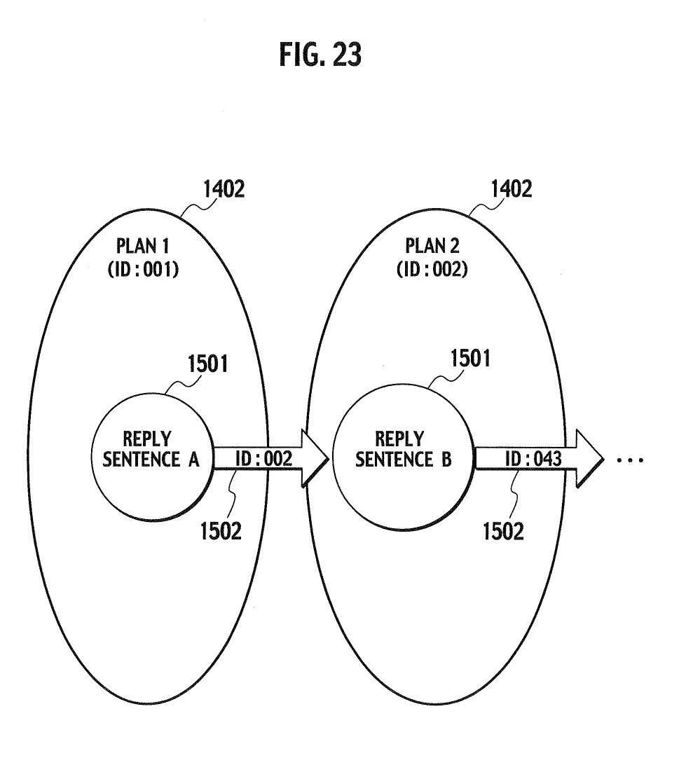

FIG. 23 shows a configuration example of plans 1402. Each plan 1402 includes a reply sentence 1501 and next-plan designation information 1502 associated therewith. The next-plan designation information 1502 is information for specifying, in response to a certain reply sentence 1501 in a plan 1402, another plan 1402 including a reply sentence to be output to a user (referred as a “next-reply candidate sentence”). In this example, the plan 1 includes a reply sentence A (1501) to be output at an execution of the plan 1 by the conversation controller 1000 and next-plan designation information 1502 associated with the reply sentence A (1501). The next-plan designation information 1502 is information [ID: 002] for specifying a plan 2 including a reply sentence B (1501) to be a next-reply candidate sentence to the reply sentence A (1501). Similarly, since the reply sentence B (1501) is also associated with next-plan designation information 1502, another plan 1402 [ID: 043] including the next-reply candidate sentence will be designated when the reply sentence B (1501) has output. In this manner, plans 1402 are chained via next-plan designation information 1502 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501 included in a plan 1402 designated by next-plan designation information 1502 is not needed to be output to a user immediately after an output of the user's utterance in response to an output of a previous reply sentence. The reply sentence 1501 included in the plan 1402 designated by the next-plan designation information 1502 may be output after an intervening conversation on a different topic from a topic in the plan between the conversation controller 1000 and the user.

Note that the reply sentence 1501 shown in FIG. 23 corresponds to a sentence string of one of the reply sentences 830 shown in FIG. 21. In addition, the next-plan designation information 1502 shown in FIG. 23 corresponds to the next-plan designation information 840 shown in FIG. 21.

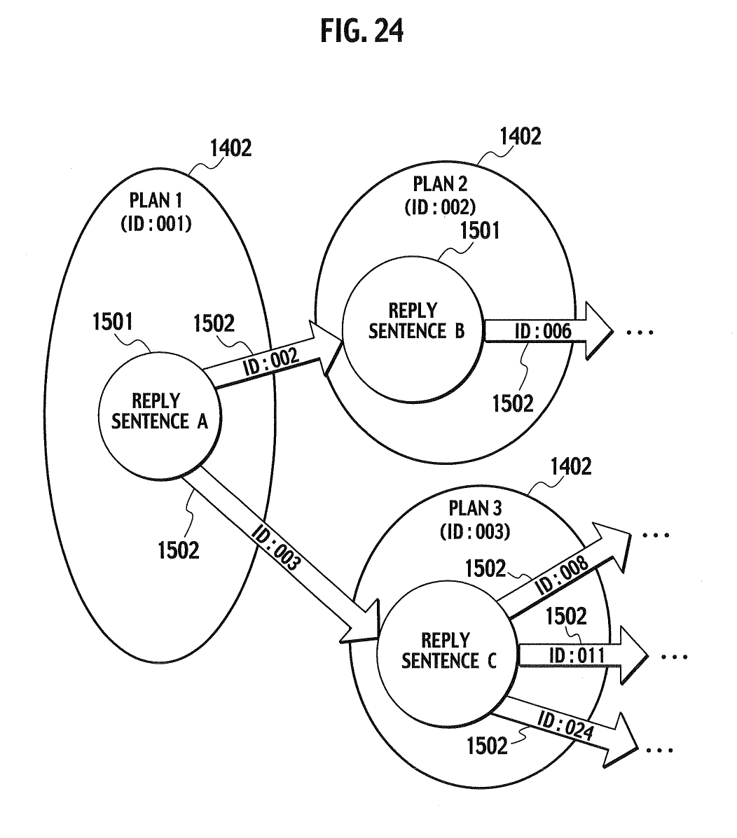

Note that linkages between the plans 1402 are not limited to form a one-dimensional geometry shown in FIG. 23. FIG. 24 shows an example of plans 1402 with another linkage geometry. In the example shown in FIG. 24, a plan 1 (1402) includes two of next-plan designation information 1502 to designate two reply sentences as next replay candidate sentences, in other words, to designate two plans 1402. The two of next-plan designation information 1502 are prepared in order that the plan 2 (1402) including a reply sentence B (1501) and the plan 3 (1402) including a reply sentence C (1501) are to be designated as plans each including a next-reply candidate sentence. Note that the reply sentences are selective and alternative, so that, when one has been output, another is not output and then the plan 1 (1501) is terminated. In this manner, the linkages between the plans 1402 is not limited to forming a one-dimensional geometry and may form a tree-diagram-like geometry or a cancellous geometry.

Note that it is not limited that how many next-reply candidate sentences each plan 1402 includes. In addition, no next-plan designation information 1502 may be included in a plan 1402 which terminates a conversation.

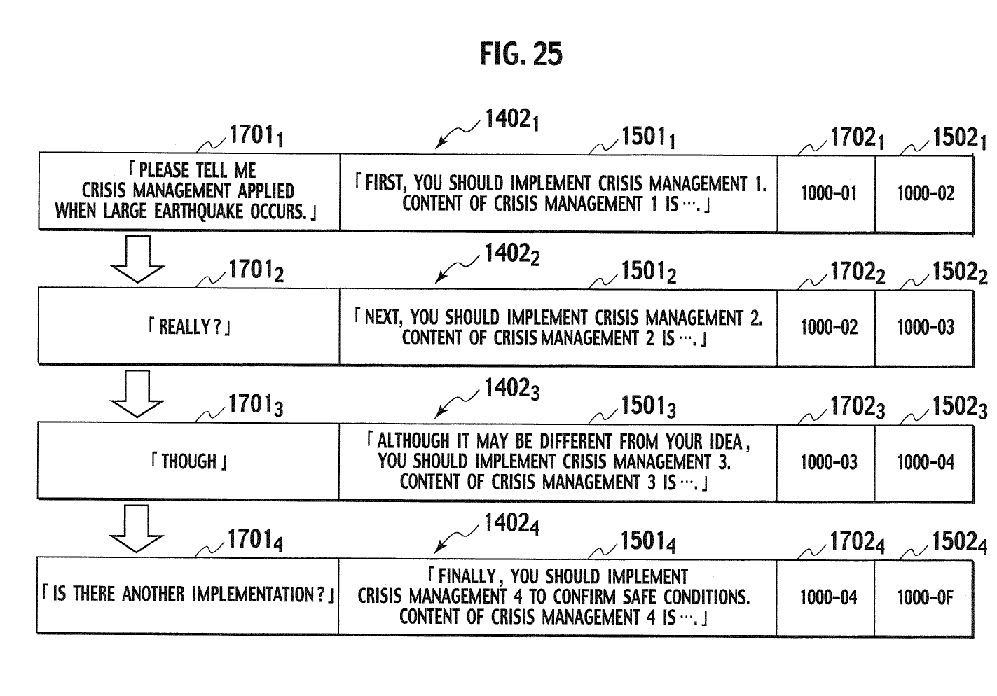

FIG. 25 shows an example of a certain series of plans 1402. As shown in FIG. 25, this series of plans 1402₁ to 1402₄ are associated with reply sentences 1501₁ to 1501₄ which notify crisis management information to a user. The reply sentences 1501₁ to 1501₄ constitute one coherent topic as a whole. Each of the plans 1402₁ to 1402₄ includes ID data 1702₁ to 1702₄ for indicating itself such as “1000-01, 1000-02”, “1000-03” and “1000-04”, respectively. In addition, each of the plans 1402₁ to 1402₄ further includes ID data 1502₁ to 1502₄ as the next-plan designation information such as “1000-02, 1000-03”, “1000-04” and “1000-0F”, respectively. Note that each value after a hyphen in the ID data is information indicating an output order. Especially, “0F” is information indicating the final plan (the last in the order).

In this example, the plan conversation process unit 1320 starts to execute this series of plans when a user has uttered 's utterance has been “Please tell me a crisis management applied when a large earthquake occurs.” Specifically, the plan conversation process unit 1320 searches in the plan space 1401 and checks whether or not a plan 1402 including a reply sentence 1501₁ associated with the user's utterance “Please tell me a crisis management applied when a large earthquake occurs,” when the plan conversation process unit 1320 has received the user's utterance “Please tell me a crisis management applied when a large earthquake occurs.” In this example, a user's utterance character string 1701₁ associated with the user's utterance “Please tell me a crisis management applied when a large earthquake occurs,” is associated with a plan 1402₁.

The plan conversation process unit 1320 retrieves the reply sentence 1501₁ included in the plan 1402₁ on discovering the plan 1402₁ and outputs the reply sentence 1501₁ to the user as a reply sentence in response to the user's utterance. And then, the plan conversation process unit 1320 specifies the next-reply candidate sentence with reference to the next-plan designation information 1502₁.

Next, the plan conversation process unit 1320 executes the plan 1402₂ on receiving another user's utterance via the input unit 1100, a speech recognition unit 1200 or the like after an output of the reply sentence 1501₁. Specifically, the plan conversation process unit 1320 judges whether or not to execute the plan 1402₂ designated by the next-plan designation information 1502₁, in other words, whether or not to output the second reply sentence 1501₂. More specifically, the plan conversation process unit 1320 compares a user's utterance character string (also referred as an illustrative sentence) 1701₂ associated with the reply sentence 1501₂ and the received user's utterance, or compares a topic title 820 (not shown in FIG. 25) associated with the reply sentence 1501₂ and the received user's utterance. And then, the plan conversation process unit 1320 determines whether or not the two are related to each other. If the two are related to each other, the plan conversation process unit 1320 outputs the second reply sentence 1501₂. In addition, since the plan 1402₂ including the second reply sentence 1501₂ also includes the next-plan designation information 1502₂, the next-reply candidate sentence is specified.

Similarly, according to ongoing user's utterances, the plan conversation process unit 1320 transit into the plans 1402₃ and 1402₄ in turn and can output the third and fourth reply sentences 1501₃ and 1501₄. Note that, since the fourth reply sentence 1501₄ is the final reply sentence, the plan conversation process unit 1320 terminates plan-executions when the fourth reply sentence 1501₄ has been output.

In this manner, the plan conversation process unit 1320 can provide previously prepared conversation contents to the user in a predetermined order by sequentially executing the plans 1402₁ to 1402₄.

### [Discourse Space Conversation Control Process Unit]

The configuration example of the conversation control unit 1300 is further described with referring back to FIG. 13.

The discourse space conversation control process unit 1330 includes the topic specification information retrieval unit 1350, the elliptical sentence complementation unit 1360, the topic retrieval unit 1370 and the reply retrieval unit 1380. The managing unit 1310 totally controls the conversation control unit 1300.

A “discourse history” is information for specifying a conversation topic or theme between a user and the conversation controller 1000 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330 will be described.

### [Topic Specification Information Retrieval Unit]

The topic specification information retrieval unit 1350 compares the first morpheme information extracted by the morpheme extracting unit 1420 and the topic specification information, and then retrieves the topic specification information corresponding to a morpheme in the first morpheme information among the topic specification information. Specifically, when the first morpheme information received from the morpheme extracting unit 1420 is two morphemes “Sato” and “like”, the topic specification information retrieval unit 1350 compares the received first morpheme information and the topic specification information group.

If a focused topic title 820focus (indicated as 820focus to be differentiated from previously retrieved topic titles or other topic titles) includes a morpheme (for example, “Sato”) in the first morpheme information, the topic specification information retrieval unit 1350 outputs the focused topic title 820focus to the reply retrieval unit 1380. On the other hand, if no focused topic title 820focus includes the morpheme in the first morpheme information, the topic specification information retrieval unit 1350 determines user input sentence topic specification information based on the received first morpheme information, and then outputs the first morpheme information and the user input sentence topic specification information to the elliptical sentence complementation unit 1360. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360 generates various complemented first morpheme information by complementing the first morpheme information with the previously retrieved topic specification information 810 (hereinafter referred as the “focused topic specification information”) and the topic specification information 810 included in the final reply sentence (hereinafter referred as the “reply sentence topic specification information”). For example, if a user's utterance is “like”, the elliptical sentence complementation unit 1360 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W”.

In this manner, in case where, for example, a sentence constituted with the first morpheme information is an elliptical sentence which is unclear as a language, the elliptical sentence complementation unit 1360 can include, by using the set “D”, an element(s) (for example, “Sato”) in the set “D” into the first morpheme information “W”. As a result, the elliptical sentence complementation unit 1360 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360 can complement the elliptical sentence by using the set “D”. As a result, even when a sentence constituted with the first morpheme information is an elliptical sentence, the elliptical sentence complementation unit 1360 can complement the sentence into an appropriate sentence as a language.

In addition, the elliptical sentence complementation unit 1360 retrieves the topic title 820 related to the complemented first morpheme information based on the set “D”. If the topic title 820 related to the complemented first morpheme information has been found, the elliptical sentence complementation unit 1360 outputs the topic title 820 to the reply retrieval unit 1380. The reply retrieval unit 1380 can output a reply sentence 830 best-suited for the user's utterance contents based on the appropriate topic title 820 found by the elliptical sentence complementation unit 1360.

Note that the elliptical sentence complementation unit 1360 is not limited to including an element(s) in the set “D” into the first morpheme information. The elliptical sentence complementation unit 1360 may include, based on a focused topic title, a morpheme(s) included in any of the first, second and third specification information in the topic title, into the extracted first morpheme information.

### [Topic Retrieval Unit]

The topic retrieval unit 1370 compares the first morpheme information and topic titles 820 associated with the user input sentence topic specification information to retrieve a topic title 820 best-suited for the first morpheme information among the topic titles 820 when the topic title 820 has not been determined by the elliptical sentence complementation unit 1360.

Specifically, the topic retrieval unit 1370, which has received a retrieval command signal from the elliptical sentence complementation unit 1360, retrieves the topic title 820 best-suited for the first morpheme information among the topic titles associated with the user input sentence topic specification information based on the user input sentence topic specification information and the first morpheme information which are included in the received retrieval command signal. The topic retrieval unit 1370 outputs the retrieved topic title 820 as a retrieval result signal to the reply retrieval unit 1380.

Above-mentioned FIG. 21 shows the concrete example of the topic titles 820 and the reply sentences 830 associated with the topic specification information 810 (=“Sato”). For example as shown in FIG. 21, since topic specification information 810 (=“Sato”) is included in the received first morpheme information “Sato, like”, the topic retrieval unit 1370 specifies the topic specification information 810 (=“Sato”) and then compares the topic titles (820) 1-1, 1-2, . . . associated with the topic specification information 810 (=“Sato”) and the received first morpheme information “Sato, like”.

The topic retrieval unit 1370 retrieves the topic title (820) 1-1 (Sato; *; like) related to the received first morpheme information “Sato, like” among the topic titles (820) 1-1, 1-2, . . . based on the comparison result. The topic retrieval unit 1370 outputs the retrieved topic title (820) 1-1 (Sato; *; like) as a retrieval result signal to the reply retrieval unit 1380.

### [Reply Retrieval Unit]

The reply retrieval unit 1380 retrieves, based on the topic title 820 retrieved by the elliptical sentence complementation unit 1360 or the topic retrieval unit 1370, a reply sentence associated with the topic title 820. In addition, the reply retrieval unit 1380 compares, based on the topic title 820 retrieved by the topic retrieval unit 1370, the response types associated with the topic title 820 and the utterance type determined by the input type determining unit 1440. The reply retrieval unit 1380, which has executed the comparison, retrieves one response type related to the determined utterance type among the response types.

In the example shown in FIG. 21, when the topic title retrieved by the topic retrieval unit 1370 is the topic title 1-1 (Sato; *; like), the reply retrieval unit 1380 specifies the response type (for example, DA) coincident with the “uttered sentence type” (DA) determined by the input type determining unit 1440 among the reply sentences 1-1 (DA, TA and so on) associated with the topic title 1-1. The reply retrieval unit 1380, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380 outputs the retrieved reply sentence 830 as a reply sentence signal to the managing unit 1310. The managing unit 1310, which has received the reply sentence signal from the reply retrieval unit 1380, outputs the received reply sentence signal to the output unit 1600.

### [CA Conversation Process Unit]

When a reply sentence in response to a user's utterance has not been determined by the plan conversation process unit 1320 or the discourse space conversation control process unit 1330, the CA conversation process unit 1340 functions to output a reply sentence for continuing a conversation with a user according to contents of the user's utterance.

The configuration example of the conversation controller 1000 is further described with referring back to FIG. 9.

### [Output Unit]

The output unit 1600 outputs the reply sentence retrieved by the reply retrieval unit 1380. The output unit 1600 may be a speaker or a display, for example. Specifically, the output unit 1600, which has received the reply sentence from the reply retrieval unit 1380, outputs voice sounds of the received reply sentence (for example, “I like Sato, too,”) based on the received reply sentence. With that, describing the configuration example of the conversation controller 1000 has ended.

### [Conversation Control Method]

The conversation controller 100 with the above-mentioned configuration puts a conversation control method in execution by operating as described hereinbelow.

Next, operations of the conversation controller 1000, more specifically the conversation control unit 1300, according to the present embodiment will be described.

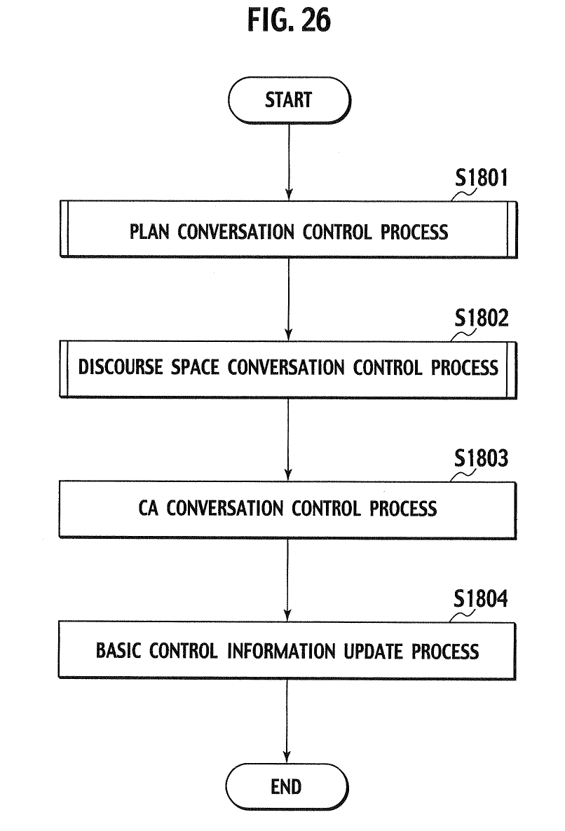

FIG. 26 is a flow-chart showing an example of a main process executed by conversation control unit 1300. This main process is a process executed each time when the conversation control unit 1300 receives a user's utterance. A reply sentence in response to the user's utterance is output due to an execution of this main process, so that a conversation (an interlocution) between a user and the conversation controller 100 is established.

Upon executing the main process, the conversation controller 100, more specifically the plan conversation process unit 1320 firstly executes a plan conversation control process (S1801). The plan conversation control process is a process for executing a plan(s).

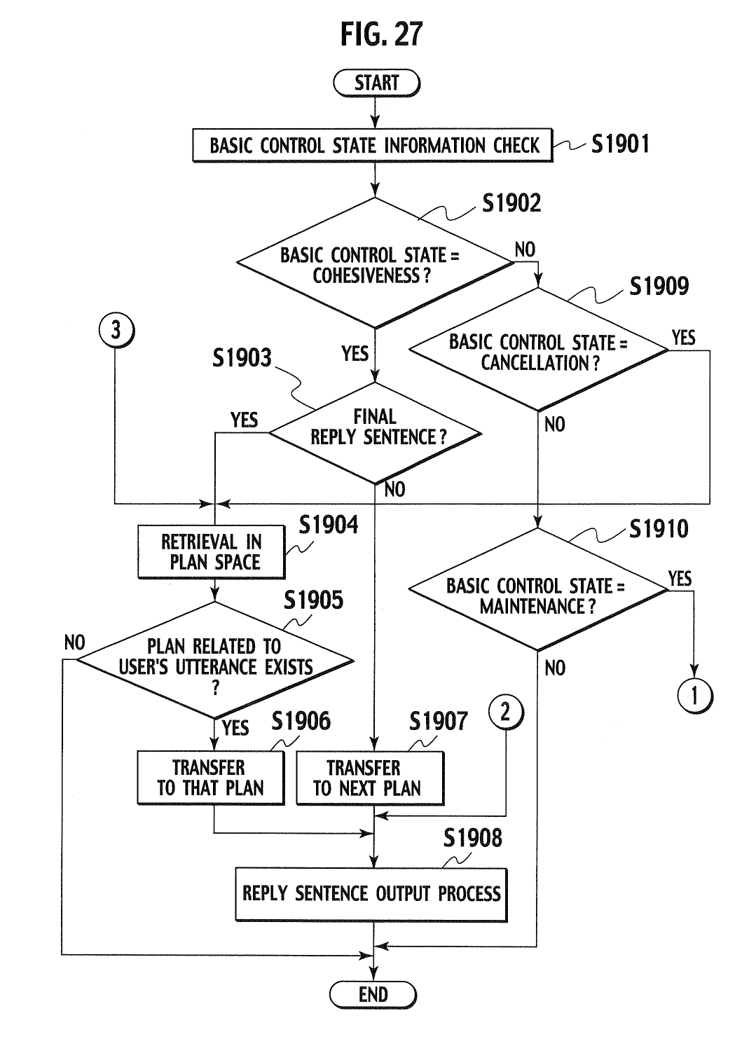

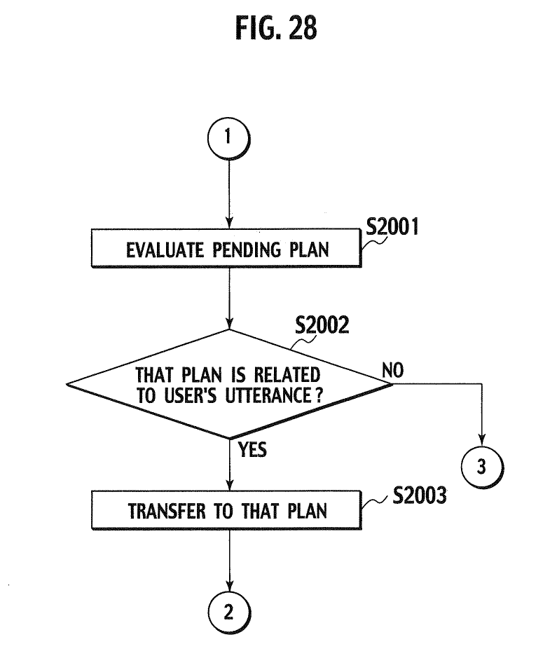

FIGS. 27 and 28 are flow-charts showing an example of the plan conversation control process. Hereinbelow, the example of the plan conversation control process will be described with reference to FIGS. 27 and 28.

Upon executing the plan conversation control process, the plan conversation process unit 1320 firstly executes a basic control state information check (S1901). The basic control state information is information on whether or not an execution(s) of a plan(s) has been completed and is stored in a predetermined memory area.

The basic control state information serves to indicate a basic control state of a plan.

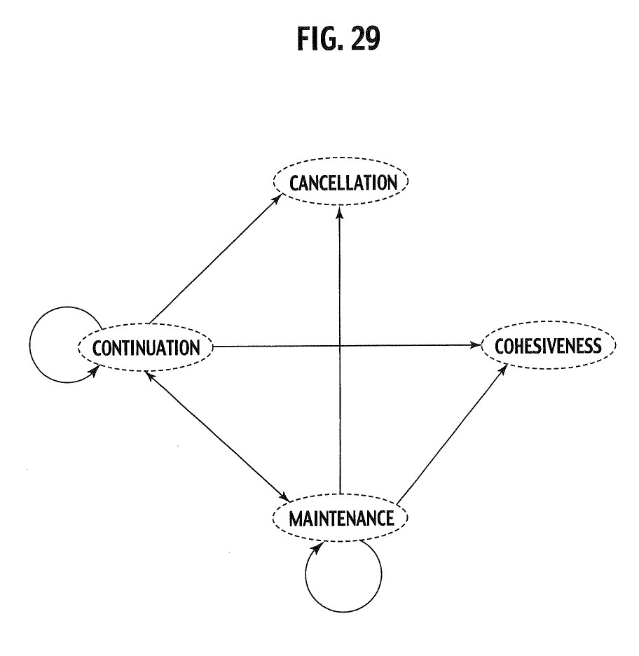

FIG. 29 is a diagram showing four basic control states which are possibly established due to a so-called scenario-type plan.

### (1) Cohesiveness

This basic control state corresponds to a case where a user's utterance is coincident with the currently executed plan 1402, more specifically the topic title 820 or the example sentence 1701 associated with the plan 1402. In this case, the plan conversation process unit 1320 terminates the plan 1402 and then transfers to another plan 1402 corresponding to the reply sentence 1501 designated by the next-plan designation information 1502.

### (2) Cancellation

This basic control state is a basic control state which is set in a case where it is determined that user's utterance contents require a completion of a plan 1402 or that a user's interest has changed to another matter than the currently executed plan. When the basic control state indicates the cancellation, the plan conversation process unit 1320 retrieves another plan 1402 associated with the user's utterance than the plan 1402 targeted as the cancellation. If the other plan 1402 exists, the plan conversation process unit 1320 start to execute the other plan 1402. If the other plan 1402 does not exist, the plan conversation process unit 1320 terminates a execution(s) of a plan(s).

### (3) Maintenance

This basic control state is a basic control state which is set in a case where a user's utterance is not coincident with the topic title 820 (see FIG. 21) or the example sentence 1701 (see FIG. 25) associated with the currently executed plan 1402 and also the user's utterance does not correspond to the basic control state “cancellation”.

In the case of this basic control state, the plan conversation process unit 1320 firstly determines whether or not to resume a pending or pausing plan 1402 on receiving the user's utterance. If the user's utterance is not adapted for resuming the plan 1402, for example, in case where the user's utterance is not related to a topic title 820 or an example sentence 1701 associated with the plan 1402, the plan conversation process unit 1320 starts to execute another plan 1402, an after-mentioned discourse space conversation control process (S1802) and so on. If the user's utterance is adapted for resuming the plan 1402, the plan conversation process unit 1320 outputs a reply sentence 1501 based on the stored next-plan designation information 1502.

In case where the basic control state is the “maintenance”, the plan conversation process unit 1320 retrieves other plans 1402 in order to enable outputting another reply sentence than the reply sentence 1501 associated with the currently executed plan 1402, or executes the discourse space conversation control process. However, if the user's utterance is adapted for resuming the plan 1402, the plan conversation process unit 1320 resumes the plan 1402.

### (4) Continuation

This state is a basic control state which is set in a case where a user's utterance is not related to reply sentences 1501 included in the currently executed plan 1402, contents of the user's utterance do not correspond to the basic control sate “cancellation” and use's intention construed from the user's utterance is not clear.

In case where the basic control state is the “continuation”, the plan conversation process unit 1320 firstly determines whether or not to resume a pending or pausing plan 1402 on receiving the user's utterance. If the user's utterance is not adapted for resuming the plan 1402, the plan conversation process unit 1320 executes an after-mentioned CA conversation control process in order to enable outputting a reply sentence for getting out a further user's utterance.

The plan conversation control process is further described with referring back to FIG. 27.

The plan conversation process unit 1320, which has referred to the basic control state, determines whether or not the basic control state indicated by the basic control state information is the “cohesiveness” (step S1902). If it has been determined that the basic control state is the “cohesiveness” (YES in step S1902), the plan conversation process unit 1320 determines whether or not the reply sentence 1501 is the final reply sentence in the currently executed plan 1402 (step S1903).

If it has been determined that the final reply sentence 1501 has been output already (YES in step S1903), the plan conversation process unit 1320 retrieves another plan 1402 related to the use's utterance in the plan space in order to determine whether or not to execute the other plan 1402 (step S1904) because the plan conversation process unit 1320 has provided all contents to be replied to the user already. If the other plan 1402 related to the user's utterance has not been found due to this retrieval (NO in step S1905), the plan conversation process unit 1320 terminates the plan conversation control process because no plan 1402 to be provided to the user exists.

On the other hand, if the other plan 1402 related to the user's utterance has been found due to this retrieval (YES in step S1905), the plan conversation process unit 1320 transfers into the other plan 1402 (step S1906). Since the other plan 1402 to be provided to the user still remains, an execution of the other plan 1402 (an output of the reply sentence 1501 included in the other plan 1402) is started.

Next, the plan conversation process unit 1320 outputs the reply sentence 1501 included in that plan 1402 (step S1908). The reply sentence 1501 is output as a reply to the user's utterance, so that the plan conversation process unit 1320 provides information to be supplied to the user.

The plan conversation process unit 1320 terminates the plan conversation control process after the reply sentence output process (step S1908).

On the other hand, if the previously output reply sentence 1501 is not determined as the final reply sentence in the determination whether or not the previously output reply sentence 1501 is the final reply sentence (step S1903), the plan conversation process unit 1320 transfers into a plan 1402 associated with the reply sentence 1501 following the previously output reply sentence 1501, i.e. the specified reply sentence 1501 by the next-plan designation information 1502 (step S1907).

Subsequently, the plan conversation process unit 1320 outputs the reply sentence 1501 included in that plan 1402 to provide a reply to the user's utterance (step 1908). The reply sentence 1501 is output as the reply to the user's utterance, so that the plan conversation process unit 1320 provides information to be supplied to the user. The plan conversation process unit 1320 terminates the plan conversation control process after the reply sentence output process (step S1908).

Here, if the basic control state is not the “cohesiveness” in the determination process in step S1902 (NO in step S1902), the plan conversation process unit 1320 determines whether or not the basic control state indicated by the basic control state information is the “cancellation” (step S1909). If it has been determined that the basic control state is the “cancellation” (YES in step S1909), the plan conversation process unit 1320 retrieves another plan 1402 related to the use's utterance in the plan space 1401 in order to determine whether or not the other plan 1402 to be started newly exists (step S1904) because a plan 1402 to be successively executed does not exist. Subsequently, the plan conversation process unit 1320 executes the processes of steps S1905 to S1908 as well as the processes in case of the above-mentioned step S1903 (YES).

On the other hand, if the basic control state is not the “cancellation” in the determination process in step S1902 (NO in step S1902) in the determination whether or not the basic control state indicated by the basic control state information is the “cancellation” (step S1909), the plan conversation process unit 1320 further determines whether or not the basic control state indicated by the basic control state information is the “maintenance” (step S1910).

If the basic control state indicated by the basic control state information is the “maintenance” (YES in step S1910), the plan conversation process unit 1320 determined whether or not the user presents the interest on the pending or pausing plan 1402 again and then resumes the pending or pausing plan 1402 in case where the interest is presented (step S2001 in FIG. 28). In other words, the plan conversation process unit 1320 evaluates the pending or pausing plan 1402 (step S2001 in FIG. 28) and then determines whether or not the user's utterance is related to the pending or pausing plan 1402 (step S2002).

If it has been determined that the user's utterance is related to that plan 1402 (YES in step S2002), the plan conversation process unit 1320 transfers into the plan 1402 related to the user's utterance (step S2003) and then executes the reply sentence output process (step S1908 in FIG. 27) to output the reply sentence 1501 included in the plan 1402. Operating in this manner, the plan conversation process unit 1320 can resume the pending or pausing plan 1402 according to the user's utterance, so that all contents included in the previously prepared plan 1402 can be provided to the user.

On the other hand, if it has been determined that the user's utterance is not related to that plan 1402 (NO in step S2002) in the above-mentioned S2002 (see FIG. 28), the plan conversation process unit 1320 retrieves another plan 1402 related to the use's utterance in the plan space 1401 in order to determine whether or not the other plan 1402 to be started newly exists (step S1904 in FIG. 27). Subsequently, the plan conversation process unit 1320 executes the processes of steps S1905 to S1908 as well as the processes in case of the above-mentioned step S1903 (YES).

If it is determined that the basic control state indicated by the basic control state information is not the “maintenance” (NO in step S1910) in the determination in step S1910, it means that the basic control state indicated by the basic control state information is the “continuation”. In this case, the plan conversation process unit 1320 terminates the plan conversation control process without outputting a reply sentence. With that, describing the plan control process has ended.

The main process is further described with referring back to FIG. 26.

The conversation control unit 1300 executes the discourse space conversation control process (step S1802) after the plan conversation control process (step S1801) has been completed. Note that, if the reply sentence has been output in the plan conversation control process (step S1801), the conversation control unit 1300 executes a basic control information update process (step S1804) without executing the discourse space conversation control process (step S1802) and the after-mentioned CA conversation control process (step S1803) and then terminates the main process.

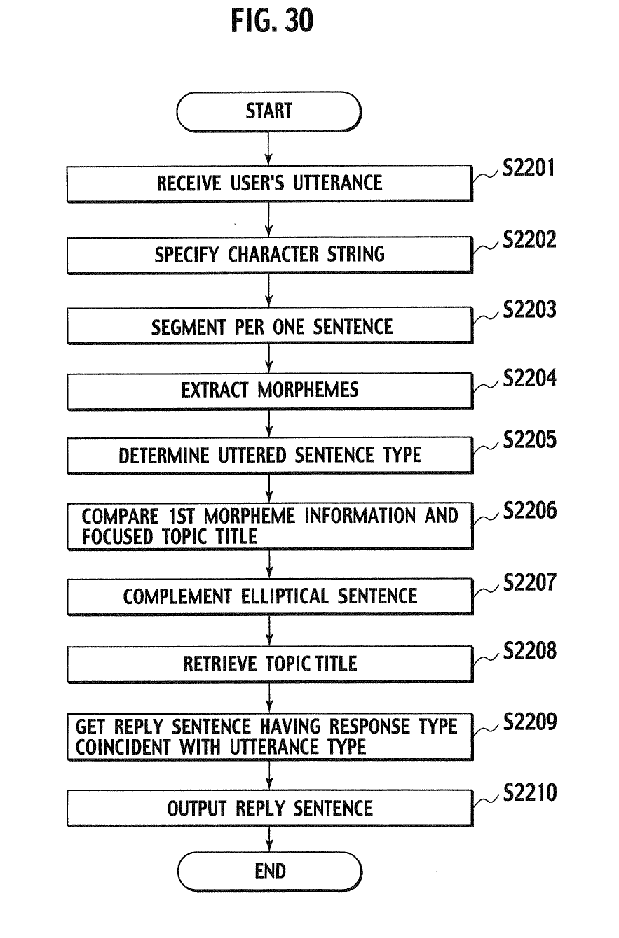

FIG. 30 is a flow-chart showing an example of a discourse space conversation control process according to the present embodiment.

The input unit 1100 firstly executes a step for receiving a user's utterance (step S2201). Specifically, the input unit 1100 receives voice sounds of the user's utterance. The input unit 1100 outputs the received voice sounds to the speech recognition unit 1200 as a voice signal. Note that the input unit 1100 may receive a character string input by a user (for example, text data input in a text format) instead of the voice sounds. In this case, the input unit 1100 may be a text input device such as a keyboard or a touchscreen.

Next, the speech recognition unit 1200 executes a step for specifying a character string corresponding to the uttered contents based on the uttered contents retrieved by the input unit 1100 (step S2202). Specifically, the speech recognition unit 1200, which has received the voice signal from the input unit 1100, specifies a word hypothesis (candidate) corresponding to the voice signal based on the received voice signal. The speech recognition unit 1200 retrieves a character string corresponding to the specified word hypothesis and outputs the retrieved character string to the conversation control unit 1300, more specifically the discourse space conversation control process unit 1330, as a character string signal.

And then, the character string specifying unit 1410 segments a series of the character strings specified by the speech recognition unit 1200 into segments (step S2203). Specifically, if the series of the character strings have a time interval more than a certain interval, the character string specifying unit 1410, which has received the character string signal or a morpheme signal from the managing unit 1310, segments the character strings there. The character string specifying unit 1410 outputs the segmented character strings to the morpheme extracting unit 1420 and the input type determining unit 1440. Note that it is preferred that the character string specifying unit 1410 segments a character string at a punctuation, a space and so on in a case where the character string has been input from a keyboard.

Subsequently, the morpheme extracting unit 1420 executes a step for extracting morphemes constituting minimum units of the character string as first morpheme information based on the character string specified by the character string specifying unit 1410 (step S2204). Specifically, the morpheme extracting unit 1420, which has received the character strings from the character string specifying unit 1410, compares the received character strings and morpheme groups previously stored in the morpheme database 1430. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420, which has executed the comparison, extracts coincident morphemes (m1, m2, . . . ) with the morphemes included in the previously stored morpheme groups from the received character string. The morpheme extracting unit 1420 outputs the extracted morphemes to the topic specification information retrieval unit 1350 as the first morpheme information.

Next, the input type determining unit 1440 executes a step for determining the “uttered sentence type” based on the morphemes which constitute one sentence and are specified by the character string specifying unit 1410 (step S2205). Specifically, the input type determining unit 1440, which has received the character strings from the character string specifying unit 1410, compares the received character strings and the dictionaries stored in the utterance type database 1450 based on the received character strings and extracts elements relevant to the dictionaries among the character strings. The input type determining unit 1440, which has extracted the elements, determines to which “uttered sentence type” the extracted element(s) belongs based on the extracted element(s). The input type determining unit 1440 outputs the determined “uttered sentence type” (utterance type) to the reply retrieval unit 1380.

And then, the topic specification information retrieval unit 1350 executes a step for comparing the first morpheme information extracted by the morpheme extracting unit 1420 and the focused topic title 820focus (step S2206).

If a morpheme in the first morpheme information is related to the focused topic title 820focus, the topic specification information retrieval unit 1350 outputs the focused topic title 820focus to the reply retrieval unit 1380. On the other hand, if no morpheme in the first morpheme information is related to the focused topic title 820focus, the topic specification information retrieval unit 1350 outputs the received first morpheme information and the user input sentence topic specification information to the elliptical sentence complementation unit 1360 as the retrieval command signal.

Subsequently, the elliptical sentence complementation unit 1360 executes a step for including the focused topic specification information and the reply sentence topic specification information into the received first morpheme information based on the first morpheme information received from the topic specification information retrieval unit 1350 (step S2207). Specifically, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W” and compares the complemented first morpheme information and all the topic titles 820 to retrieve the topic title 820 related to the complemented first morpheme information. If the topic title 820 related to the complemented first morpheme information has been found, the elliptical sentence complementation unit 1360 outputs the topic title 820 to the reply retrieval unit 1380. On the other hand, if no topic title 820 related to the complemented first morpheme information has been found, the elliptical sentence complementation unit 1360 outputs the first morpheme information and the user input sentence topic specification information to the topic retrieval unit 1370.

Next, the topic retrieval unit 1370 executes a step for comparing the first morpheme information and the user input sentence topic specification information and retrieves the topic title 820 best-suited for the first morpheme information among the topic titles 820 (step S2208). Specifically, the topic retrieval unit 1370, which has received the retrieval command signal from the elliptical sentence complementation unit 1360, retrieves the topic title 820 best-suited for the first morpheme information among topic titles 820 associated with the user input sentence topic specification information based on the user input sentence topic specification information and the first morpheme information included in the received retrieval command signal. The topic retrieval unit 1370 outputs the retrieved topic title 820 to the reply retrieval unit 1380 as the retrieval result signal.

Next, the reply retrieval unit 1380 compares, in order to select the reply sentence 830, the user's utterance type determined by the sentence analyzing unit 1400 and the response type associated with the retrieved topic title 820 based on the retrieved topic title 820 by the topic specification information retrieval unit 1350, the elliptical sentence complementation unit 1360 or the topic retrieval unit 1370 (step S2209).

The reply sentence 830 is selected in particular as explained hereinbelow. Specifically, based on the “topic title” associated with the received retrieval result signal and the received “uttered sentence type”, the reply retrieval unit 1380, which has received the retrieval result signal from the topic retrieval unit 1370 and the “uttered sentence type” from the input type determining unit 1440, specifies one response type coincident with the “uttered sentence type” (for example, DA) among the response types associated with the “topic title”.

Consequently, the reply retrieval unit 1380 outputs the reply sentence 830 retrieved in step S2209 to the output unit 1600 via the managing unit 1310 (S2210). The output unit 1600, which has received the reply sentence 830 from the managing unit 1310, outputs the received reply sentence 830.

With that, describing the discourse space conversation control process has ended and the main process is further described with referring back to FIG. 26.

The conversation control unit 1300 executes the CA conversation control process (step S1803) after the discourse space conversation control process has been completed. Note that, if the reply sentence has been output in the plan conversation control process (step S1801) or the discourse space conversation control (S1802), the conversation control unit 1300 executes the basic control information update process (step S1804) without executing the CA conversation control process (step S1803) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result.

By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300 executes the basic control information update process (step S1804). In this process, the conversation control unit 1300, more specifically the managing unit 1310, sets the basic control information to the “cohesiveness” when the plan conversation process unit 1320 has output a reply sentence, sets the basic control information to the “cancellation” when the plan conversation process unit 1320 has cancelled an output of a reply sentence, sets the basic control information to the “maintenance” when the discourse space conversation control process unit 1330 has output a reply sentence, or sets the basic control information to the “continuation” when the CA conversation process unit 1340 has output a reply sentence.

The basic control information set in this basic control information update process is referred in the above-mentioned plan conversation control process (step S1801) to be employed for continuation or resumption of a plan.

As described the above, the conversation controller 1000 can executes a previously prepared plan(s) or can adequately respond to a topic(s) which is not included in a plan(s) according to a user's utterance by executing the main process each time when receiving the user's utterance.

In the gaming terminal 4 of this embodiment, the above-described input unit 1100 of the conversation controller 1000 can be formed of the display 8 (the touch panel 50 fitted thereto) and the microphone 15. Meanwhile, the output unit 1600 can be formed of the display 8 and the speaker 10. Further, the speech recognition unit 1200, the conversation control unit 1300, and the character string specifying unit 1410, the morpheme extracting unit 1420 and the input type determining unit 1440 each of which is in the sentence analyzing unit 1400 can be formed of the terminal controller 90. Meanwhile, both of the morpheme database 1430 and the utterance type database 1450 in the sentence analyzing unit 1400, the conversation database 1500, and the speech recognition dictionary memory 1700 can be formed of the external memory 99.

Moreover, in this embodiment, it is possible to determine the language used in the course of the roulette games through the dialog with the player by using the conversation engine, which utilize the conversation controller 1000 achieved in the gaming terminal 4 with the above-described configuration.

Accordingly, in order to recognize the type of the language used in the speech message of the player inputted from the microphone 15, the speech recognition dictionary memory 1700 of the conversation controller 1000 formed of the external memory 99 includes word dictionaries in several languages. Meanwhile, the morpheme database 1430 of the conversation controller 1000 formed of the external memory 99 includes morpheme groups (morpheme dictionaries) in several languages. Further, the utterance type database 1450 of the conversation controller 1000 formed of the external memory 99 also includes dictionaries for the respective utterance types in several languages.

Meanwhile, in order to output the speech messages from the speaker 10 to the player in the language selected by the player and to display the messages on the display 8 in the language selected by the player, the conversation database 1500 formed by the terminal controller 90 also stores data of “sentences” in several languages. The “sentences” includes a message for requesting to input a specific word or a specific sentence (either orally or by means of an operation using the display 8) in the language desired to be used in the roulette games, a message for asking the player to confirm that the language used for inputting the specific work or the specific sentence is also used to execute the roulette games.

Here, instead of providing the speech recognition dictionary memory 1700, the morpheme database 1430, and the utterance type database 1450 of the conversation controller 1000 with the word dictionaries in multiple languages or storing the “sentence” data in multiple languages in the conversation database 1500, it is also possible to provide the single gaming terminal 4 with several conversation controllers 1000 depending on the respective language types that the gaming terminal 4 can deal with.

Operations of the above-mentioned conversation controller 1000 in the gaming terminal 4 of this embodiment will be described later.

Subsequently, contents of the gaming processes to be respectively executed by the server 13, the roulette device 2, and the gaming terminal 4 of the roulette game machine 1 according to this embodiment will be described below.

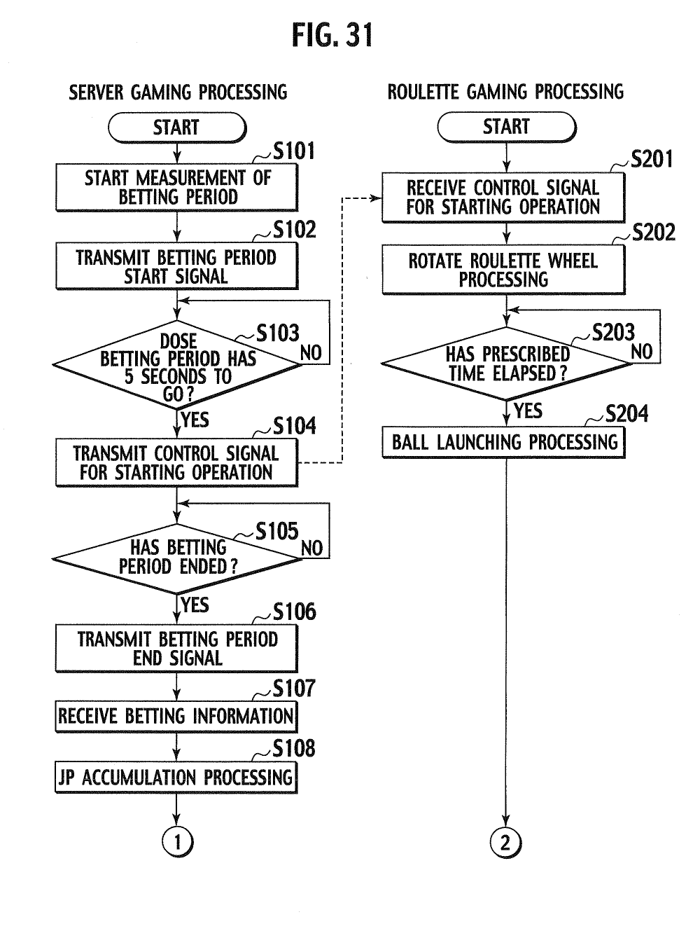

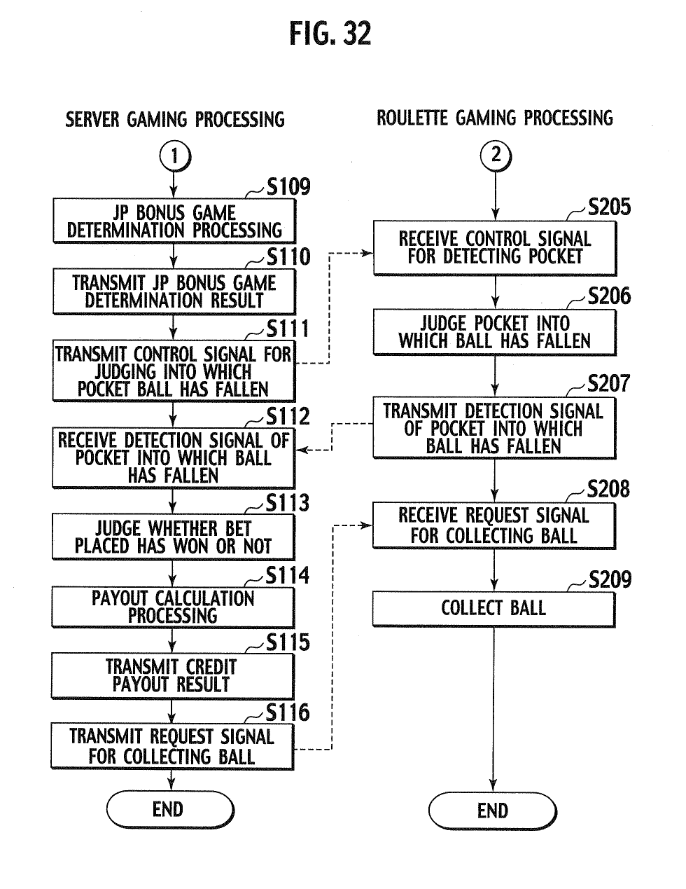

With reference to FIGS. 31 and 32, descriptions will be provided for a server gaming processing and a roulette gaming processing. Here, the server gaming processing is executed by the server CPU 81 of the server 13 in accordance with programs stored in the ROM 82, and the roulette gaming processing is executed by the CPU 101 of the roulette device 2 in accordance with programs stored in the ROM 102. FIGS. 31 and 32 are flow charts showing the gaming processings of the server 13 and the roulette device 2 in the roulette game machine 1 according to the present embodiment.

Firstly, the gaming processing of the server 13 will be described referring to FIGS. 31 and 32.

As shown in FIG. 31, the server CPU 81 starts the measurement of the betting period first (step S101). The betting period is a period when the bet can be placed. The player participating in the game can place a bet on the bet area 72 predicted by himself, by operating the touch panel 50 during the betting period. When the measurement of the betting period is started, the server CPU 81 transmits a betting period start signal to the terminal CPU 91 (step S102).

Next, the server CPU 81 judges whether the remaining betting period has become 5 seconds or less (step S103). The remaining betting period is displayed on the bet time display unit 69 of the display 8 at each of the gaming terminals 4 (see FIG. 5). In the case where it is judged that it has not reached the last 5 seconds, the processing will be returned to the step S103. On the other hand, in the case where it is judged that it has reached the last 5 seconds, the processing will move to the step S104.

The server CPU 81 transmits the control signal for starting the operation of the roulette device 2 to the CPU 101 (step S104). After that, the server CPU 81 judges whether the betting period of the roulette game has ended or not (step S105). In the case where it is judged that the betting period has not ended, the server CPU 81 suspends the processing until the betting period ends. On the other hand, in the case where it is judged that the betting period of the roulette game has ended, the server CPU 81 transmits a betting period end signal to the terminal CPU 91 (step S106).

Subsequently, the server CPU 81 receives the betting information (the specified bet area 72, the number of bet chips, and the type of betting) at each gaming terminal 4 from the terminal CPU 91, and stores it into the betting information memory area 83A of the RAM 83 (step S107).

After that, the server CPU 81 executes a JP accumulation processing (step S108). In this JP accumulation processing, 0.30% of the total credits which have been bet at all the gaming terminals 4 that are received at the step S107 are accumulatively added to the JP credits stored in the “MINI” JP accumulated memory area 83C in the RAM 83. Moreover, in the JP accumulation processing, 0.20% of the total credits are accumulatively added to the JP credits stored in the “MAJOR” JP credit memory area 83D in the RAM 83. In addition, in the JP accumulation processing, 0.15% of the total credits are accumulatively added to the JP credits stored in the “MEGA” JP credit memory area 83E in the RAM 83. Furthermore, in the JP accumulation processing, the displays on the JP amount display 15, the MEGA counter 73, the MAJOR counter 74 and the MINI counter 75 are updated according to the JP credits thus accumulatively added.

Next, as shown in FIG. 32, the server CPU 81 executes a JP bonus game determination processing (step S109). In this processing, the server CPU 81 determines whether to execute the JP bonus game at each gaming terminal 4 or not, by using a random number value sampled by a sampling circuit or the like. In addition, the server CPU 81 determines which gaming terminal 4 is to win the JP (or all the gaming terminals 4 are to lose) in the case where it is determined to execute the JP bonus game. Also, the server CPU 81 determines which JP (“MEGA”, “MAJOR” or “MINI”) is to be won in the case of having the JP won.

Next, the server CPU 81 transmits the JP bonus game determination result to each gaming terminal 4, according to the processing of the step S109 (step S110). After that, the server CPU 81 transmits a control signal to the CPU 101 of the roulette device 2, and thereby causes the CPU 101 to judge into which number pocket 23 the ball 27 has fallen (step S111). Then, the server CPU 81 receives a detection signal of the number pocket 23 into which the ball 27 has fallen from the CPU 101 (step S112).

Thereafter, the server CPU 81 judges whether the bet placed at each gaming terminal 4 has won or not, based on the betting information of each gaming terminal 4 received at the step S107 and the detection signal of the number pocket 23 received at the step S112 (step S113).

After that, the server CPU 81 executes the payout calculation processing (step S114). In the payout calculation processing, the server CPU 81 firstly recognizes the number of winning bets on the winning number for each gaming terminal 4. Then, the server CPU 81 calculates the total payout credits for each gaming terminal 4 by using the payout rate (credits to be paid per one bet) that is stored in the payout memory area 82A of the ROM 82.

Next, the server CPU 81 executes the transmission processing of the credit payout result according to the payout calculation processing of the step S113 and the JP payout result according to the JP bonus game determination processing of the step S109 (step S115). More specifically, the server CPU 81 outputs the credit data corresponding to the payout credits for the game to the terminal CPU 91 of the winning gaming terminal 4. Moreover, the server CPU 81 additionally outputs the credit data corresponding to the accumulated JP credits in the case where the JP has been won. After that, the server CPU 81 transmits a request signal for collecting the ball 27 on the roulette wheel 22 to the CPU 101 of the roulette device 2 (step S116). The server CPU 81 finishes the subroutine after the step S116.

Hereinafter, the gaming processing of the roulette device 2 will be described with references to FIGS. 31 and 32.

Firstly, as shown in FIG. 31, the CPU 101 receives the control signal for starting the operation of the roulette device 2 from the server CPU 81 of the server 13 (step S201).

Next, the CPU 101 drives the wheel driving motor 106 and rotates the roulette wheel 22 (step S202).

Then, the CPU 101 detects the detection signal from the pocket position detection circuit 107 when a prescribed time (20 seconds, for example) elapses after the rotation of the roulette wheel 22 is started (step S203: YES). The CPU 101 enters the ball 27 (step S204) when the delay time elapses after the detection signal is detected.

Then, as shown in FIG. 32, the CPU 101 receives the control signal for detecting the pocket from the server CPU 81 of the server 13 (step S205). Thereafter, the CPU 101 judges which number pocket 23 into which the ball 27 has fallen by activating the ball sensor 105 (step S206). After that, the CPU 101 transmits the detection signal indicating the number pocket 23 into which the ball 27 has fallen to the server CPU 81 of the server 13 (step S207).

Subsequently, the CPU 101 receives the request signal for collecting the ball 27 from the server CPU 81 of the server 13 (step S208). Then, the CPU 101 collects the ball 27 on the roulette wheel 22 by activating the ball collecting device 108 provided beneath the roulette wheel 22 (step S209). The collected ball 27 will be entered onto the roulette wheel 22 again by the ball launching device 104 in the subsequent games. The CPU 101 finishes the subroutine after the step S209.

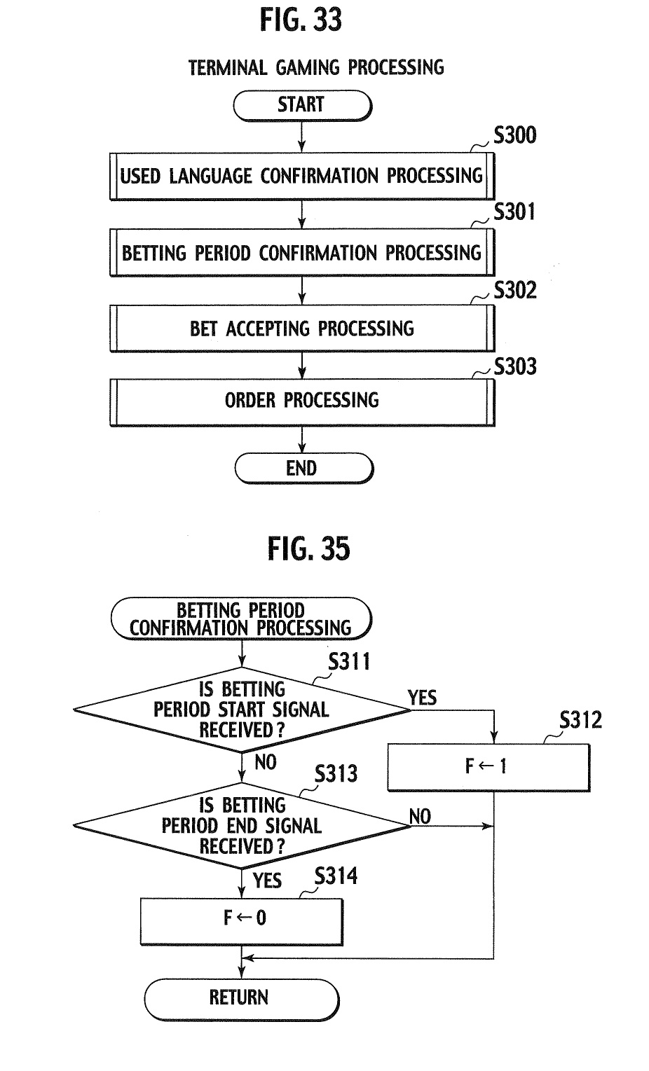

Hereinbelow, the processing executed by the terminal CPU 91 of each gaming terminal 4 of the roulette game machine 1 according to the present embodiment will be described with reference to FIGS. 33 to 37. The terminal CPU 91 executes the processing in accordance with the programs stored in the ROM 92. FIGS. 33 to 37 are flow charts each showing the gaming processing of the gaming terminal of the roulette game machine according to the present embodiment.

Here, the flag F in the RAM 93 is assumed to be set to be default, “1”, which is a value indicating the betting period. Moreover, the default BET screen 61 as shown in FIG. 5 is assumed to be displayed on the display 8 of the gaming terminal 4. With this state, as shown in FIG. 33, the terminal CPU 91 firstly performs used language confirmation processing in step S300, then performs betting period confirmation processing in step S301, then performs bet accepting processing in step S302, and lastly performs order processing in step S303.

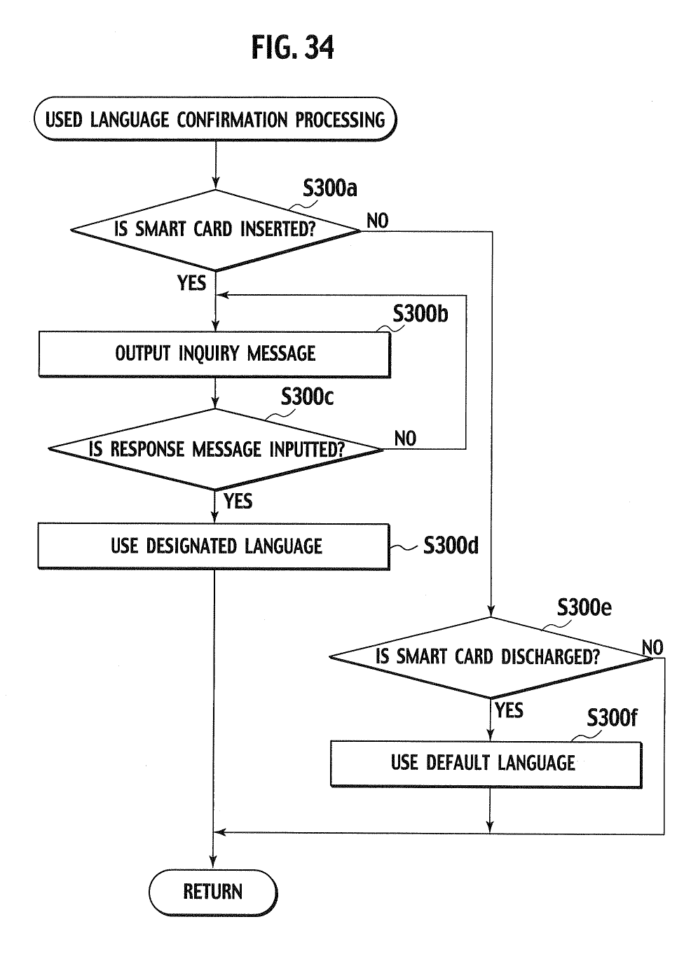

Then, in the used language confirmation processing in step S300, the terminal CPU 91 judges whether or not a new smart card 17 is inserted to the card reader 16 in step S300a as shown in FIG. 34. If the smart card 17 is not inserted (NO in step S300a), the terminal CPU 91 proceeds to step S300e to be described later. When the smart card 17 is inserted (YES in step S300a), the terminal CPU 91 outputs the message (the conversation sentence) to inquire of the player about the language type to be used in the roulette game (step S300b).

This message may be outputted in the form of a sound from the speaker 10 through the sound input circuit 98 or outputted in the form of display of characters or the like on the display 8 through the LCD driving circuit 95.

For example, when outputting the message in the form of the sound, the terminal CPU 91 outputs the sound for requesting for selection of the language to be used in the game from the speaker 10 by using a default language type. When the default language type is English, for instance, the terminal CPU 91 outputs the sound stating “What language do you want to use?” from the speaker 10.

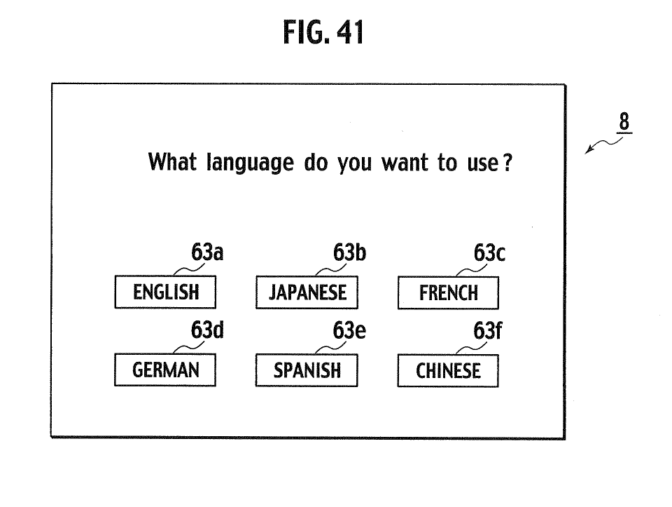

Meanwhile, when outputting the message in the form of display, the terminal CPU 91 displays characters, buttons, and the like on the display 8 in order to promote selection of the language to be used in the game by using the default language type. For example, when the default language type is English, the terminal CPU 91 displays characters stating “What language do you want to use?” together with buttons 63a, 63b, 63c, 63d, 63e, and 63f representing language options of “English”, “Japanese”, “French”, “German”, “Spanish”, and “Chinese” as shown in FIG. 41.

Thereafter, the terminal CPU 91 judges whether or not a response message (a response sentence) to the message outputted in step S300b is inputted (step S300c).

Here, when the message outputted in step S300b is in the sound, the presence of the input of the message in response to the outputted message can be confirmed by judging whether or not there is the input to the input unit 1100 of the conversation controller 1000 after outputting the message in step S300b. Meanwhile, when the outputted message in step S300b is displayed on the display 8, the presence of the input of the message in response to the outputted message can be confirmed by judging whether or not an operation of any of language selection buttons displayed on the display 8 (the buttons 63a, 63b, 63c, 63d, 63e, and 63f stating “English”, “Japanese”, “French”, “German”, “Spanish”, and “Chinese” shown in FIG. 41) respectively by the player is detected with the touch panel 50.

Then, if no response message to the message outputted in step S300b is inputted (NO in step S300c), the terminal CPU 91 repeats step S300c until there is the input. When the response message is inputted (YES in step S300c), the terminal CPU 91 changes the language of the BET screen 61 to be displayed on the display 8 during the betting period of the roulette game in the language indicated by the message inputted in step S300c (step S300d). Thereafter, the terminal CPU 91 terminates the used language confirmation processing.

Here, when the message inputted in step S300c is in the sound, the language indicated in the inputted message can be specified by analyzing the contents of the message inputted in the voice from the microphone 15 in accordance with the previously explained operations of the conversation controller 1000. Meanwhile, when the inputted message in step S300c is displayed on the display 8, the language indicated in the inputted message can be confirmed by allowing the terminal CPU 91 to identify contents of an operation of any of the buttons for language selection displayed on the display 8 by the player through the touch panel 50.

In step S300e, the terminal CPU 91 checks whether or not the smart card 17 is discharged from the card reader 16. If the smart card 17 is not discharged (NO in step S300e), the terminal CPU 91 terminates the used language confirmation processing. When the smart card 17 is discharged (YES in step S300e), the terminal CPU 91 displays the BET screen 61 on the display 8 in the default language during the betting period of the roulette game (step S300f). Thereafter, the terminal CPU 91 terminates the used language confirmation processing. Here, the default language type may be defined as English, for example.

In the betting period confirmation processing (step S301), as shown in FIG. 35, the terminal CPU 91 confirms whether the betting period start signal has been received from the server CPU 81 or not (step S311). In the case where the betting period start signal has been received (step S311: YES), the terminal CPU 91 sets the flag F in the RAM 93 which indicates that it is under the betting period to “1” (step S312), and then terminates the betting period confirmation processing.

On the other hand, in the case where the betting time start signal has not been received yet (step S311: NO), the terminal CPU 91 confirms whether the betting period end signal has been received from the server CPU 81 or not (step S313). In the case where the betting period end signal has been received (step S313: YES), the terminal CPU 91 sets the flag F in the RAM 93 which indicates that it is under the betting period to “0” (step S314), and then terminates the betting period confirmation processing. In the case where the betting period end signal has not been received yet (step S313: NO), the terminal CPU 91 terminates the betting period confirmation processing.

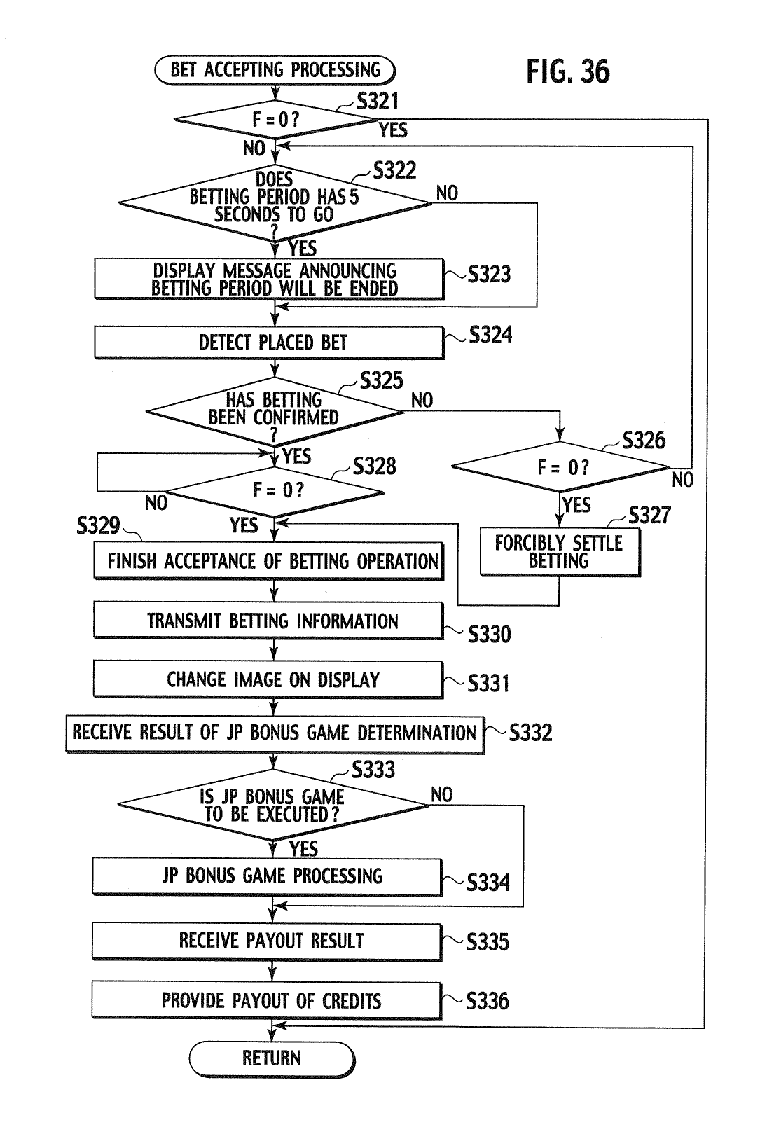

Then, in the bet accepting processing (step S302 in FIG. 33), as shown in FIG. 36, the terminal CPU 91 judges whether the flag F in the RAM 93 is set to “0” or not (step S321). In the case where the flag F is set to “0” (step S321: YES), the terminal CPU 91 terminates the bet accepting processing.

On the other hand, in the case where the flag F is not set to “0” (step S321: NO), the terminal CPU 91 judges whether the remaining betting time has reached the last 5 seconds (“5” or a smaller number is displayed on the bet time display unit 69) or not (step S322). In the case where the remaining time has reached the last 5 seconds (step S322: YES), the terminal CPU 91 displays a message announcing that the betting time will be ended on the bet screen 61 (step S323), and shifts the processing to the step S324. On the other hand, in the case where the remaining time has not reached the last 5 seconds (step S322: NO), the terminal CPU 91 shifts the processing to the step S324.

Here, when the BET screen 61 displayed on the display 8 is written in English as shown in FIG. 5, the message of the advance notice for the end of the betting period is shown in the contents such as “HURRY UP! THE BET TIME ENDING SOON.” as shown in FIG. 42, for example.

The terminal CPU 91 detects the bet placed by the player (step S324). The betting is detected by detecting the player's touches on the bet area 72 in the table-type betting board 60 and on the bet buttons 66 via the touch panel 50. When the betting is detected, the chip mark 71 is displayed on the specified bet area 72 on the display 8 according to the number of bet chips.

After that, the terminal CPU 91 judges whether the player has confirmed the betting or not (step S325). The betting is confirmed when the player's touch on the bet confirmation button 65 on the display 8 is detected via the touch panel 50.

In the case where it is judged that the betting has not been confirmed (step S325: NO), the terminal CPU 91 judges whether the flag F in the RAM 93 is set to “0” or not (step S326). In the case where the flag F is not set to “0” (step S326: NO), the terminal CPU 91 returns the processing to the step S322.

On the contrary, when the flag F is set to “0” (YES in step S326), the terminal CPU 91 forcibly settles the bet of chips by the player (step S327) and then shifts the processing to step S329 to be described later.

Meanwhile, when the bet of chips by the player is confirmed to be settled in step S325 (YES), the terminal CPU 91 judges whether or not the flag F of the RAM 93 is set to “0” in step S328. When the flag F is not set to “0” (NO in step S328), the terminal CPU 91 repeats step S326. On the contrary, when the flag F of the RAM 93 is set to “0” ‘YES in step S328), the terminal CPU 91 shifts the processing to step S329.

In the step S328, the terminal CPU 91 finishes accepting betting operations via the touch panel 50 (step S329). Thereafter, the terminal CPU 91 transmits the betting information of the player (the specified bet area 72, the number of bet chips and the types of betting) to the server CPU 81 (step S330).

Next, the terminal CPU 91 changes the image on the display 8 (step S331). To be more precise, the terminal CPU 91 firstly switches the image on the display 8 to the bet screen 61 including the image indicating that the betting period has ended.

Thereafter, the terminal CPU 91 receives the result of the JP bonus game determination processing from the server CPU 81 (step S332). The result of the JP bonus game determination includes the information which indicates: whether to execute the JP bonus game at any gaming terminal 4 or not; which gaming terminal 4 is to win the JP (or all the gaming terminals 4 are to lose) in the case where it is determined to execute the JP bonus game; and which JP (“MEGA”, “MAJOR” or “MINI”) is to be won in the case of having the JP won.

After that, the terminal CPU 91 determines whether to execute the JP bonus game or not, according to the result of the JP bonus game determination processing received at the step S332 (step S333). In the case where it is determined to execute the JP bonus game at its own gaming terminal 4, the terminal CPU 91 executes a prescribed selection-type JP bonus game. And then, the terminal CPU 91 displays the bonus game result (whether the JP has been won or not) in the bet screen 61 on the display 8 (step S334), according to the determination result received at the step S332.

In the case where it is determined not to execute the JP bonus game at its own gaming terminal 4 at the step S333, or after the step S334, the terminal CPU 91 receives the payout result from the server CPU 81 (step S335). Note that the payout result includes the payout for the roulette game and the payout for the JP bonus game.

Subsequently, the terminal CPU 91 provides a payout according to the payout result received at the step S335 (step S336). Specifically, the terminal CPU 91 stores the credit data of the payout for the roulette game in the RAM 93. And the terminal CPU 91 also stores the accumulated JP credits in the RAM 93 if the JP has been won. Then, when the payout button 5 is touched, the number of medals corresponding to the credits stored in the RAM 93 (usually, one medal per one credit) are paid from the medal payout opening 12. Thereafter, the terminal CPU 91 terminates the bet accepting processing.

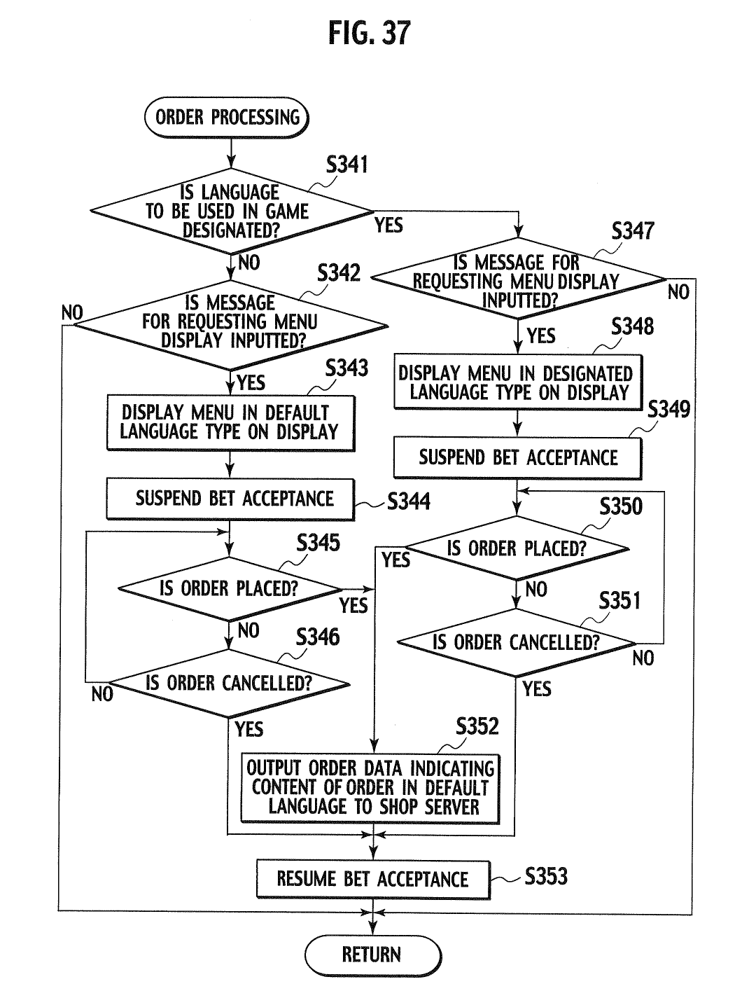

Next, as shown in FIG. 37, in the order processing in step S303 of FIG. 33, the terminal CPU 91 judges whether or not the language type to be used in the game is designated by the message (the response sentence) inputted in step S300c in the used language confirmation processing shown in FIG. 34 (step S341). If the language type is not designated (NO in step S341), the terminal CPU 91 terminates the order processing. When the language type is designated (YES in step S341), the terminal CPU 91 proceeds to step S347 to be described later.

Meanwhile, when the language type to be used in the game is not designated (NO in step S341), the terminal CPU 91 checks whether or not a message (a response sentence) to request for display of the menu on the display 8 is inputted (step S342).

Here, when the message is formed of the sound, the presence of the input of the message to request for display of the menu on the display 8 can be confirmed by checking whether or not there is an input of a voice message in the language type designated in the step 341 (such as a phrase meaning “I would like something to eat or drink”) that requests for display of the menu to the input unit 1100 of the conversation controller 1000 formed of the microphone 15. On the other hand, when the message to request for display of the menu on the display 8 is in the form of display of the display 8, the presence of the input of the message can be confirmed by checking whether or not the touch panel 50 detects an operation of the order button 76 (see FIG. 5) displayed on the BET screen 61 on the display 8 by the player.

Then, if the message to request for display of the menu on the display 8 is not inputted (NO in step S342), the terminal CPU 91 terminates the order processing. On the other hand, when the message to request for display of the menu on the display 8 is inputted (YES in step S342), the terminal CPU 91 displays the menu of snacks and beverages written in the default language type on the display 8 instead of the BET screen 61 (step S343).

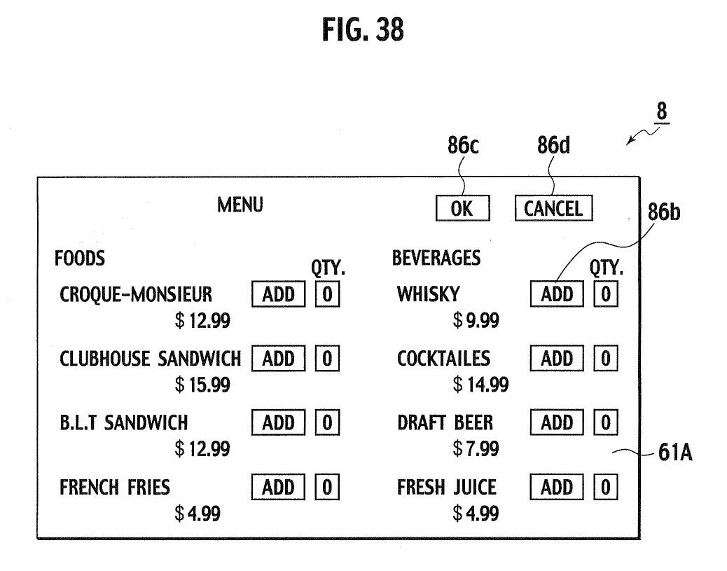

Here, when the default language type is English, the terminal CPU 91 displays a menu screen 61A (a menu screen in the claims) indicating items of snacks and beverages as well as prices thereof in English on the display 8 as shown in FIG. 38. This menu screen 61A is created by use of menu data stored in the external memory 100. Moreover, the menu screen 61A includes: “ADD” buttons 86b provided for the respective items and supposed to be operated by the player in the number of times corresponding to ordered quantity; an “OK” button 86c to be operated for confirming the order by the player; and a “CANCEL” button 86d to be operated for cancelling the order by the player.

Then, as the display on the display 8 is switched from the BET screen 61 to the menu screen 61A in step S343, the terminal CPU 91 suspends acceptance of credits bet on the roulette game by the player by means of the operation on the BET screen 61 (step S344).

Next, the terminal CPU 91 checks whether or not the player orders a certain item (step S345). Here, when an item is ordered by way of the display on the menu screen 61A on the display 8, the terminal CPU 91 can confirm the order by checking whether or not the touch panel 50 detects that the order of an item designated by operating the “ADD” buttons 86b displayed on the menu screen 61A on the display 8 is confirmed through the operation of the “OK” button 86c.

On the other hand, when the player orders a certain item by way of the sound, the terminal CPU 91 can confirm the order by checking whether or not the input unit 1100, which can be formed of the microphone 15, of the conversation controller 1000 receives inputs of two kinds of sound messages in the default language type (in English, for example): one is for designating each item name and its quantity to be ordered; and the other is for confirming the order. Accordingly, when the item is ordered in the form of the sound, the menu screen 61A does not have to include the “ADD” buttons 86b and the “OK” button 86c.

When some item is ordered (YES in step S345), the terminal CPU 91 proceeds to step S352 to be described later. On the other hand, when no item is ordered (NO in step S345), the terminal CPU 91 checks whether or not the order is cancelled (step S346).

Here, when the order of an item is cancelled by way of the display on the menu screen 61A on the display 8, the terminal CPU 91 can confirm the cancellation of the order by checking whether or not the touch panel 50 detects an operation of the “CANCEL” button 86d displayed on the menu screen 61A on the display 8 prior to the operation of the “OK” button 86c.

On the other hand, when the order of an item is cancelled by way of the sound, the terminal CPU 91 can confirm the cancellation of the order by checking whether or not the input unit 1100, which can be formed of the microphone 15, of the conversation controller 1000 receives an input of a sound message in the default language type (in English, for example) for cancelling the order of the item and its quantity designated so far. Accordingly, when the order of items is cancelled in the form of the sound, the menu screen 61A does not have to include the “CANCEL” button 86d.

The terminal CPU 91 proceeds to step S345 when the order of an item is not cancelled (NO in step S346). On the other hand, the terminal CPU 91 proceeds to step S353 to be described later when the order of an item is cancelled (YES in step S346).

In step S347, the terminal CPU 91 checks whether or not the message (the response sentence) to request for display of the menu on the display 8 is inputted as similar to step S342.

Then, if the message to request for display of the menu on the display 8 is not inputted (NO in step S347), the terminal CPU 91 terminates the order processing. On the other hand, when the message to request for display of the menu on the display 8 is inputted (YES in step S347), the terminal CPU 91 displays the menu of snacks and beverages written in the language type designated in step S341 on the display 8 instead of the BET screen 61 (step S348).

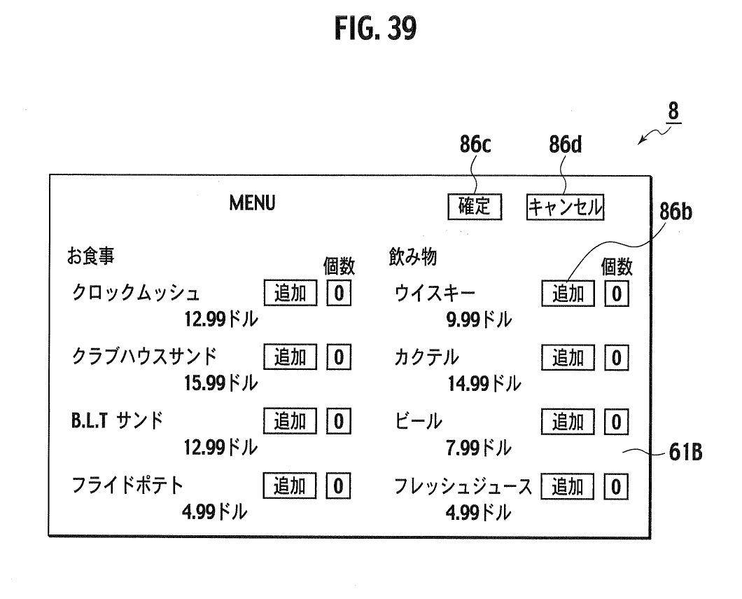

Here, the terminal CPU 91 displays a menu screen indicating the items of snacks and beverages as well as the prices thereof in the language type designated in the step S341 on the display 8 corresponding to the menu screen 61A shown in FIG. 38. When the language type designated in step S341 is Japanese, for example, the terminal CPU 91 displays a menu screen 61B (a menu screen) indicating the items of snacks and beverages as well as the prices thereof in Japanese as shown in FIG. 39. This menu screen 61B is created by use of the menu data stored in the external memory 100. Moreover, the menu screen 61B includes: “TSUIKA” (ADD) buttons 86b provided for the respective items and supposed to be operated by the player in the number of times corresponding to ordered quantity; a “KAKUTEI” (OK) button 86c to be operated for confirming the order by the player; and a “KYANSERU” (CANCEL) button 86d to be operated for cancelling the order by the player. Here, it is noted that “TSUIKA”, “KAKUTEI” and “KYANSERU” respectively represent Japanese language terms meaning “ADD”, “OK” and “CANCEL” phonetically, for illustrative purposes.

Then, as the display on the display 8 is switched from the BET screen 61 to the menu screen 61B in step S348, the terminal CPU 91 suspends acceptance of credits bet on the roulette game by the player by means of the operation on the BET screen 61 (step S349).

Next, the terminal CPU 91 checks whether or not the player orders a certain item (step S350). Here, when an item is ordered by way of the display on the menu screen 61B on the display 8 and the language type designated in step 341 is Japanese, the terminal CPU 91 can confirm the order by checking whether or not the touch panel 50 detects that the order of an item designated by operating the “TSUIKA” (ADD) buttons 86b displayed in Japanese on the menu screen 61B on the display 8 is confirmed through the operation of the “KAKUTEI” (OK) button 86c.

On the other hand, when the player orders a certain item by way of the sound, the terminal CPU 91 can confirm the order by checking whether or not the input unit 1100, which can be formed of the microphone 15, of the conversation controller 1000 receives inputs of two kinds of sound messages in the language type designated in step S341 (in Japanese, for example): one is for designating each item name and its quantity to be ordered; and the other is for confirming the order. Accordingly, when the item is ordered in the form of the sound, the menu screen 61A does not have to include the “TSUIKA” (ADD) buttons 86b, the “KAKUTEI” (OK) button 86c, and a “KYANSERU” (CANCEL) button 86d on the menu screen 61B.

When some item is ordered (YES in step S350), the terminal CPU 91 proceeds to step S352 to be described later. On the other hand, when no item is ordered (NO in step S350), the terminal CPU 91 checks whether or not the order is cancelled (step S351).

Here, when the order of an item is cancelled by way of the display on the menu screen 61B on the display 8, and the language type designated in step 341 is Japanese, the terminal CPU 91 can confirm the cancellation of the order by checking whether or not the touch panel 50 detects an operation of the “KYANSERU” (CANCEL) button 86d displayed on the menu screen 61B on the display 8 prior to the operation of the “KAKUTEI” (OK) button 86c.

On the other hand, when the order of an item is cancelled by way of the sound, the terminal CPU 91 can confirm the cancellation of the order by checking whether or not the input unit 1100, which can be formed of the microphone 15, of the conversation controller 1000 receives an input of a sound message in the language type designated in step S341 (in Japanese, for example) for cancelling the order of the item and its quantity designated so far. Accordingly, when the order of items is cancelled in the form of the sound, the menu screen 61B does not have to include the “KYANSERU” (CANCEL) button 86d.

The terminal CPU 91 proceeds to step S350 when the order of any items is not cancelled (NO in step S351). On the other hand, the terminal CPU 91 proceeds to step S353 when the order of any items is cancelled (YES in step S351).

In step S352, the terminal CPU 91 creates order data in the default language type (in English, for example) which represent the contents of the item or items ordered in step S345 in the default language type (in English, for example), or the contents of the item or items ordered in step S350 in the language type designated in Step S341 (in Japanese, for example), and outputs the order data to the shop server 86 connected through the local area network. Thereafter, the terminal CPU 91 proceeds to step S353.

In step S353, the terminal CPU 91 resumes acceptance of credits bet on the roulette game by the player, which has been suspended in step S344 or in step S349, by changing the display on the display 8 from the menu screen 61A or 61B to the BET screen 61. Thereafter, the terminal CPU 91 terminates the order processing.

Here, when the message to request for the display of the menu on the display 8 inputted in step S342 or step S347 is a phrase meaning “I would like something to eat”, for example, the contents of the menu screen 61A or 61B to be displayed on the display 8 in step S343 or step S348 as shown in FIG. 38 or FIG. 39 can be limited to the snack items. Meanwhile, when the message to request for the display of the menu on the display 8 inputted in step S342 or step S347 is a phrase meaning “I would like something to drink”, for example, the contents of the menu screen 61A or 61B to be displayed on the display 8 in step S343 or step S348 as shown in FIG. 38 or FIG. 39 can be limited to the beverage items.

Incidentally, when the shop server 86 receives the order data outputted in step S352 which represent the contents of the ordered item or items in the default language type (in English, for example), the shop server 86 displays the contents of the ordered item or items represented by the order data on a shop display 86a in the default language type (in English, for example).

As apparent from the foregoing description, in the roulette game machine 1 of this embodiment, the controller of the present invention is formed of the terminal CPU 91.

As described above, the gaming terminal 4 of the roulette game device 1 according to the embodiment of the present invention outputs the message (the conversation sentence) to inquire the language type that the player wishes to use in the roulette game in the forms of sounds and (or) characters from the speaker 10 and the display 8 by use of the conversation controller 1000 compatible with the multiple language types or by use of the multiple conversation controllers 1000 respectively compatible with the language types.

In response to this output, the player inputs the message (the response sentence) for designating the language type the player wishes to use in the roulette game either in the form of the sound by using the microphone 15 or in the form of the characters by operating the touch panel 50 on the display 8.

After the input of the message by the player for designating the language type to be used in the roulette game in the forms of the sounds or the characters, the gaming terminal 4 exchanges the conversations in the forms of the sounds or the characters with the player in the language type designated by the player.

Therefore, in the roulette game device 1 according to the embodiment of the present invention, the language type to be used in the roulette game is set to the language type corresponding to the request by the player by performing the conversations between the gaming terminal 4 and the player in the forms of the sounds or the characters. Thereafter, the information in the conversation mode is exchanged between the gaming terminal 4 and the player in the language type thus set up. Accordingly, it is possible to achieve interactive gaming.

Moreover, the roulette game device 1 according to the embodiment of the present invention is configured to analyze the sound message in the language type designated by the player to request for display of the menu of the items orderable through the gaming terminal 4 on the display 8 by use of the conversation controller 1000. In this way, it is possible to display the requested menu screen 61B on the display 8 in designated language type.

Therefore, the gaming terminal 4 of the roulette game device 1 according to the embodiment of the present invention allows the player to order the item through the gaming terminal 4 by using the menu screen 61B displayed in the designated language type on the display 8.

Moreover, according to the roulette game device 1 of the embodiment of the present invention, the ordered item is displayed on the shop display 86a of the shop server 86 in the default language type regardless of which language type the player uses for ordering the item on the menu screen 61A or 61B of the gaming terminal 4. As a result, even when the player orders the item in the language type other than the default language type, staff in the shop area who receives the order can grasp the contents of the ordered item by means of display on the shop display 86a using the default language type recognizable to the staff. In this way, it is possible to establish communication for placing the order between each staff in the shop area and each player by using mutually different language types.

When displaying the menu screen 61A or 61B on the display 8 in step S343 or step S348 in the order processing in FIG. 37, the contents therein may be limited to the items affordable by the number of credits previously accumulated in the gaming terminal 4 and displayed on the credit number display unit 68 on the BET screen 61.

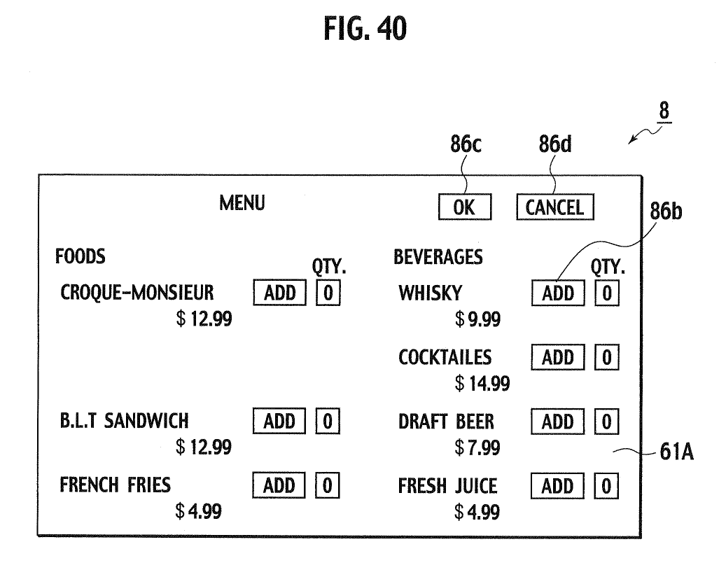

For example, if the language type to be used in the game is not designated by the player, the number of remaining credits displayed on the credit number display unit 68 is denominated in US dollars (USD), and the value is equal to “15”, the menu screen 61A having the contents as shown in FIG. 40 is displayed on the display 8 in step S343 in the order processing in FIG. 37.

In the menu screen 61A shown in FIG. 40, the item having the unit price higher than 15 US dollars, displayed on the displayed number display unit 68, is deleted from the items of the menu previously displayed on the menu screen 61A in FIG. 38 (for example, clubhouse sandwich). The menu screen 61A as shown in FIG. 40 can be displayed on the display 8 by comparing the number of remaining credits displayed on the credit number display unit 68 with the prices of the respective items in the menu data stored in the external memory 100.

Alternatively, the order processing in FIG. 37 may be configured by excluding the processing for suspending the acceptance of credits bet on the roulette game while the menu screen 61A or 61B is displayed on the display 8 to allow the player to order an item, that is, the processing performed with a combination of steps S344 and S349 with step S353.

Moreover, it is also possible to allow the player to make a bet of credits on the roulette game even in the course of display of the menu screen 61A or 61B on the display 8 of the gaming terminal 4 by displaying the BET screen 61 on the display 8 at the same time.

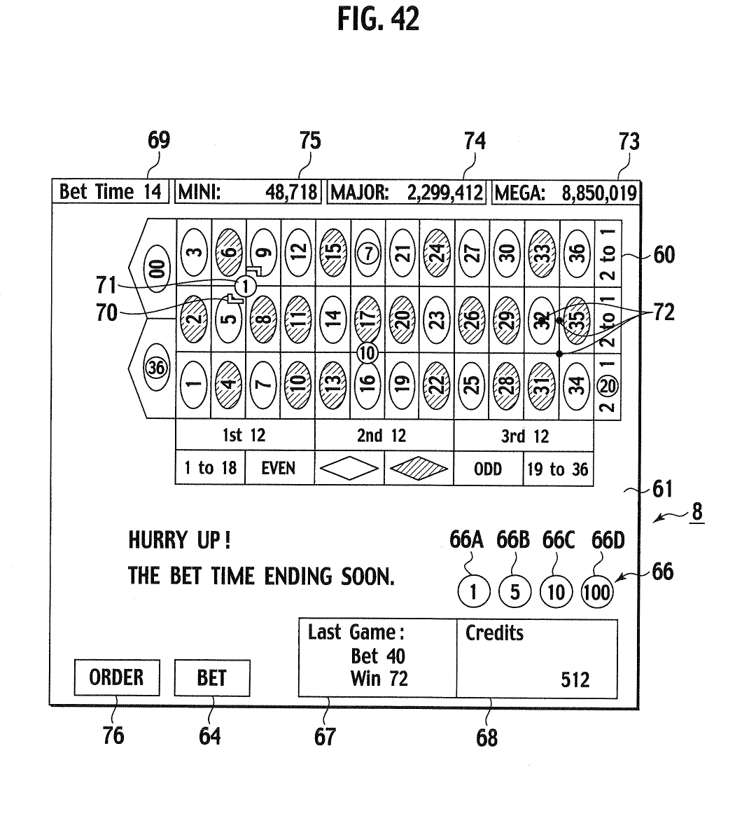

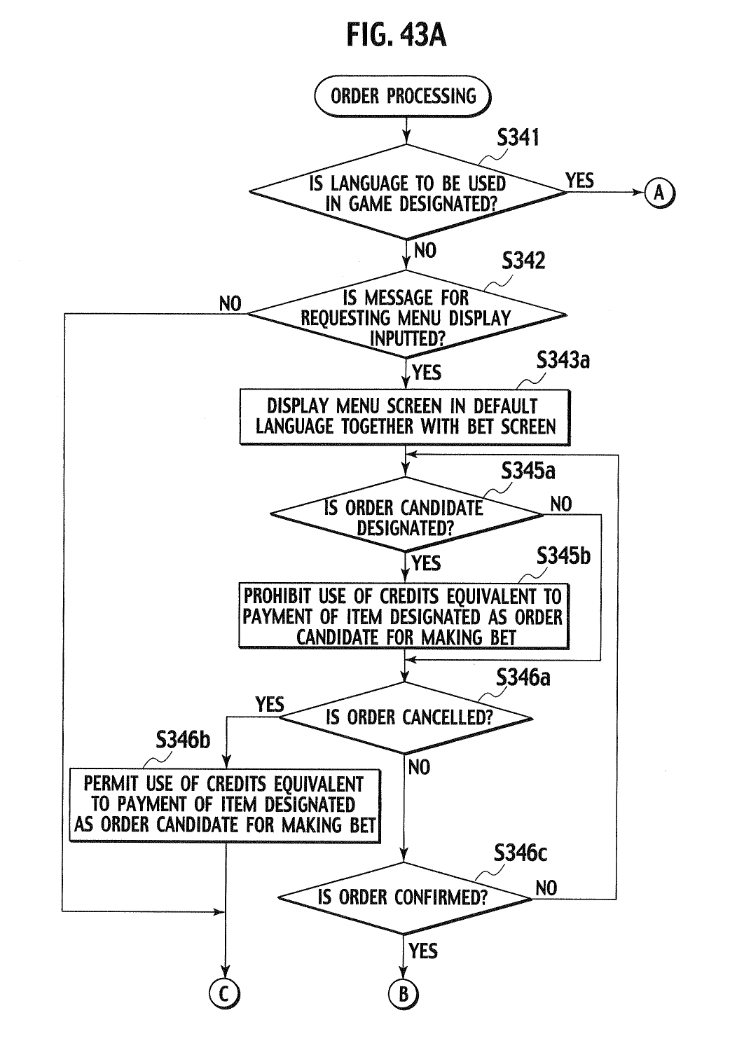

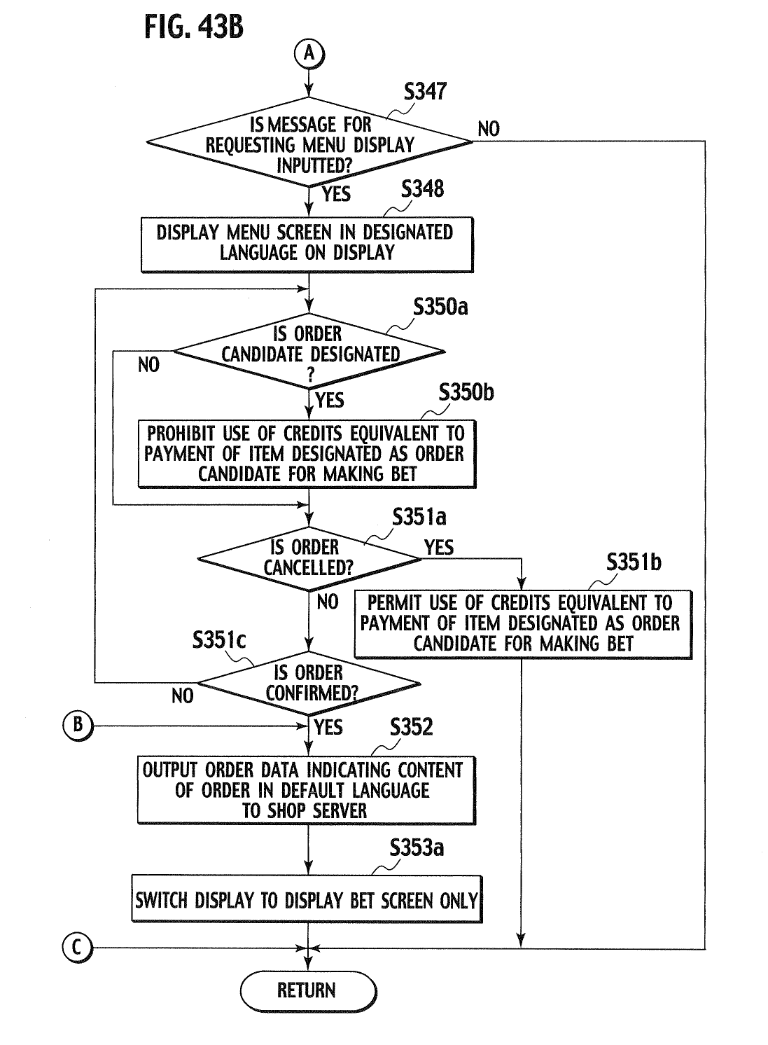

Concrete contents of the order processing in step S303 in FIG. 33 applying this configuration will be described with reference to flowcharts in FIGS. 43A and 43B.

First, as shown in FIG. 43A, the terminal CPU 91 judges whether or not the language type to be used in the game is designated by the message (the response sentence) inputted in step S300c in the used language confirmation processing shown in FIG. 34 (step S341). When the language type is designated (YES in step S341), the terminal CPU 91 proceeds to step S347 to be described later.

On the other hand, when the language type to be used in the game is not designated (NO in step S341), the terminal CPU 91 checks whether or not the message (the response sentence) to request for display of the menu on the display 8 is inputted (step S342).

Then, the terminal CPU 91 terminates the order processing when the message to request for display of the menu on the display 8 is not inputted (NO in step S342). On the other hand, when the message to request for display of the menu on the display 8 is inputted (YES in step S342), the terminal CPU 91 displays the menu of snacks and beverages in the default language type on the display 8 together with the BET screen 61 (step S343a).

Here, when the default language type is English, the terminal CPU 91 displays the BET screen 61 shown in FIG. 5 as well as the menu screen 61A (a menu screen) shown in FIG. 38 which indicates the items of snacks and beverages together with prices thereof in English on the display 8 by allocating half areas of the display 8 to the respective screens.

Next, the terminal CPU 91 judges whether or not there is designation of an item as an order candidate by the player (step S345a). Here, when an item is ordered by way of the display on the menu screen 61A on the display 8, the presence of designation of the order candidate can be judged by checking whether or not the touch panel 50 detects designation of the item as the order candidate by operating any of the “ADD” buttons 86b displayed on the menu screen 61A on the display 8.

On the other hand, when the player orders a certain item by way of the sound, the presence of designation of any items as the order candidates can be judged by checking whether or not there is an input of a sound message in the default language type (in English, for example) for designating any items and quantity to be ordered to the input unit 1100 of the conversation controller 1000 which is formed of the microphone 15. Accordingly, when the item is ordered in the form of the sound, the menu screen 61A does not have to include the “ADD” buttons 86b on the menu screen 61A.

Meanwhile, the terminal CPU 91 proceeds to step S346a to be described later when there is not designation of the item as the order candidate (NO in step S345a). When there is designation of the item as the order candidate (YES in step S345a), the terminal CPU 91 prohibits use of the credits equivalent to a payment for the item designated as the order candidate to make a bet on the roulette game (step S345b). Thereafter, the terminal CPU 91 proceeds to step S346a to be described later.

Here, prohibition of the credits equivalent to the payment for the item designated as the order candidate to make a bet on the roulette game can be achieved by updating the display of the number of remaining credits on the credit number display unit 68 on the BET screen 61 with the number of credits after subtracting the number equivalent to the payment for the item designated as the order candidate.

In step S346a, the terminal CPU 91 judges whether or not the order of the item is cancelled. Here, when the order of an item is cancelled by way of the display on the menu screen 61A on the display 8, the terminal CPU 91 can confirm the cancellation of the order by checking whether or not the touch panel 50 detects an operation of the “CANCEL” button 86d displayed on the menu screen 61A on the display 8 prior to the operation of the “OK” button 86c.

On the other hand, when the order of an item is cancelled by way of the sound, the terminal CPU 91 can confirm the cancellation of the order by checking whether or not the input unit 1100, which can be formed of the microphone 15, of the conversation controller 1000 receives an input of a sound message in the default language type (in English, for example) for cancelling the order of the item. Accordingly, when the order of items is cancelled in the form of the sound, the menu screen 61A does not have to include the “CANCEL” button 86d

The terminal CPU 91 proceeds to step S346c when the order of the item is not cancelled (NO in step S346a). When the order of the item is cancelled (YES in step S346a), the terminal CPU 91 renders the credits, which correspond to the payment for the item designated as the order candidate so far, usable for making a bet on the roulette game again (step S346b). Thereafter, the terminal CPU 91 terminates the order processing.

Here, the action to render the credits equivalent to the payment for the item designated as the order candidate so far usable for making a bet on the roulette game again can be achieved by updating the display of the number of remaining credits on the credit number display unit 68 on the BET screen 61 with the display of the number of credits after adding the number equivalent to the payment for the item designated as the order candidate so far.

In step S346c, the terminal CPU 91 checks whether or not the order of the item designated as the order candidate by using the default language type (in English, for example) in step S345a is confirmed.

Here, when confirmation of the order of the item designated as the order candidate is carried out by way of the display on the menu screen 61A on the display 8, the presence of confirmation of the order can be judged by checking whether or not the touch panel 50 detects confirmation of the order by operating the “OK” buttons 86c displayed on the menu screen 61A on the display 8 prior to the operation of the “CANCEL” button 86d.

On the other hand, when confirmation of the order of the item is carried out by way of the sound, the presence of confirmation of the order can be judged by checking whether or not there is an input of a sound message in the default language type (in English, for example) for confirming the order to the input unit 1100 of the conversation controller 1000 which is formed of the microphone 15. Accordingly, when confirmation of the order of the item is made in the form of the sound, the menu screen 61A does not have to include the “OK” button 86c on the menu screen 61A.

Then, the terminal CPU 91 proceeds to step S345a when the order of the item is not confirmed (NO in step S346c). On the other hand, the terminal CPU 91 proceeds to step S352 to be described later (see FIG. 43B) when the order of the item is confirmed (YES in step S346c).

Meanwhile, as shown in FIG. 43B, in step S347, the terminal CPU 91 judges whether or not the message (the response sentence) to request for display of the menu on the display 8 is inputted as similar to step S342.

Then, if the message to request for display of the menu on the display 8 is not inputted (NO in step S347), the terminal CPU 91 terminates the order processing. On the other hand, when the message to request for display of the menu on the display 8 is inputted (YES in step S347), the terminal CPU 91 displays the menu of snacks and beverages written in the language type designated in step S341 on the display 8 together with the BET screen 61 (step S348a).

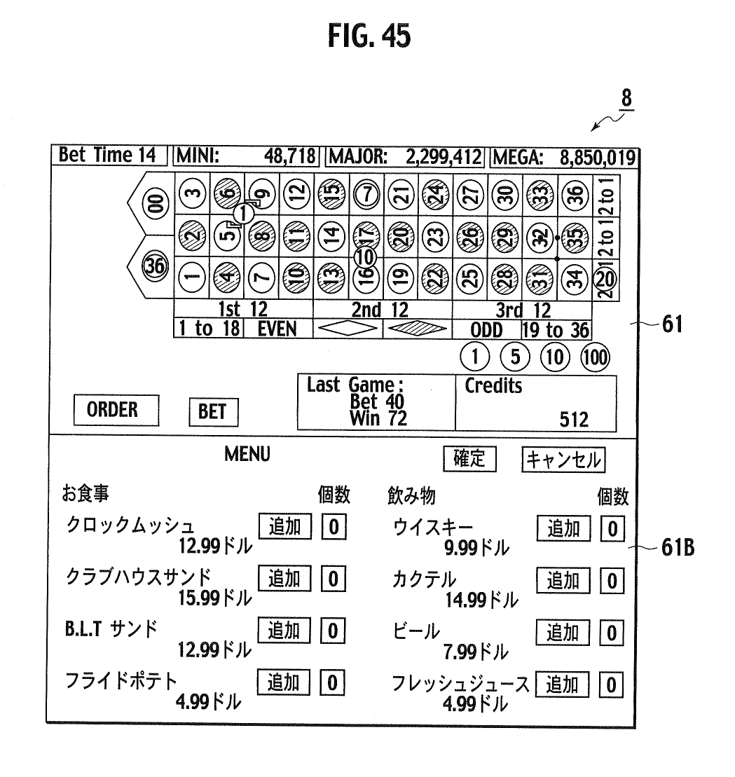

Here, the terminal CPU 91 displays a menu screen indicating the items of snacks and beverages as well as the prices thereof in the language type designated in step S341, which corresponds to the menu screen 61A shown in FIG. 38, together with the BET screen shown in FIG. 5 on the display 8. When the language type designated in step S341 is Japanese, for example, the terminal CPU 91 displays the menu screen 61B (a menu screen) indicating the items of snacks and beverages as well as the prices thereof in Japanese shown in FIG. 39 together with the BET screen 61 shown in FIG. 5 by allocating half areas of the display 8 to the respective screens as shown in FIG. 45.

Next, the terminal CPU 91 judges whether or not there is designation of an item as an order candidate by the player (step S350a). Here, when an item is ordered by way of the display on the menu screen 61B on the display 8, on the assumption that the language type designated in step S341 is Japanese, the presence of designation of the order candidate can be judged by checking whether or not the touch panel 50 detects designation of the item as the order candidate by operating the “TSUIKA” (ADD) button 86b displayed in Japanese on the menu screen 61B on the display 8.

On the other hand, when an item is ordered by way of the sound, the presence of designation of the item as the order candidate can be confirmed by checking whether or not there is an input of a sound message in the language type designated in step S341 (in Japanese, for example) for designating any items and quantity to be ordered to the input unit 1100 of the conversation controller 1000 which is formed of the microphone 15. Accordingly, when the order of items is made in the form of the sound, the menu screen 61B does not have to include the “TSUIKA” (ADD) buttons 86b.

Meanwhile, the terminal CPU 91 proceeds to step S351a to be described later when there is not designation of the item as the order candidate (NO in step S350a). When there is designation of the item as the order candidate (YES in step S350a), the terminal CPU 91 prohibits use of the credits equivalent to the payment for the item designated as the order candidate to make a bet on the roulette game (step S350b) as similar to step S345b. Thereafter, the terminal CPU 91 proceeds to step S351a to be described later.

In step S351a, the terminal CPU 91 checks whether or not the order of the item is cancelled. Here, when the order of an item is cancelled by way of the display on the menu screen 61B on the display 8 and the language type designated in step 341 is Japanese, the terminal CPU 91 can confirm the cancellation of the order by checking whether or not the touch panel 50 detects an operation of the “KYANSERU” (CANCEL) button 86d displayed on the menu screen 61B on the display 8 prior to the operation of the “KAKUTEI” (OK) button 86c.

On the other hand, when the order of an item is cancelled by way of the sound, the terminal CPU 91 can confirm the cancellation of the order by checking whether or not the input unit 1100, which can be formed of the microphone 15, of the conversation controller 1000 receives an input of a sound message in the language type designated in step S341 (in Japanese, for example) for cancelling the order of the item. Accordingly, when the order of items is cancelled in the form of the sound, the menu screen 61B does not have to include the “KYANSERU” (CANCEL) button 86d.

The terminal CPU 91 proceeds to step S351c when the order of the item is not cancelled (NO in step S351a). When the order of the item is cancelled (YES in step S351a), the terminal CPU 91 renders the credits, which correspond to the item designated as the order candidate so far, usable for making a bet on the roulette game again (step S351b) as similar to step S346b. Thereafter, the terminal CPU 91 terminates the order processing.

In step S351c, the terminal CPU 91 checks whether or not the order of the item designated as the order candidate by using the language type designated in step S341 (in Japanese, for example) in step S350a is confirmed.

Here, when confirmation of the order of the item designated as the order candidate is carried out by way of the display on the menu screen 61B on the display 8, the presence of confirmation of the order can be confirmed by checking whether or not the touch panel 50 detects confirmation of the order by operating the “KAKUTEI” (OK) buttons 86c displayed on the menu screen 61B on the display 8 prior to the operation of the “KYANSERU” (CANCEL) button 86d.

On the other hand, when confirmation of the order of the item is carried out by way of the sound, the presence of confirmation of the order can be checked by checking whether or not there is an input of a sound message in the language type designated in step S341 (in Japanese, for example) for confirming the order to the input unit 1100 of the conversation controller 1000 which is formed of the microphone 15. Accordingly, when confirmation of the order of the item is made in the form of the sound, the menu screen 61B does not have to include the “KAKUTEI” (OK) button 86c Then, the terminal CPU 91 proceeds to step S350a when the order of the item is not confirmed (NO in step S351c). On the other hand, the terminal CPU 91 proceeds to step S352 when the order of the item is confirmed (YES in step S351c).

In step S352, the terminal CPU 91 creates the order data in the default language type (in English, for example) which represent the contents of the item or items ordered in the default language type (in English, for example) in step S345a or in the language type designated in Step S341 (in Japanese, for example) in step S350a, and outputs the order data to the shop server 86 connected through the local area network. Thereafter, the terminal CPU 91 proceeds to step S353a.

In step S353a, the terminal CPU 91 changes the display on the display unit 8 from the state of simultaneously displaying the BET screen 61 and any one of the menu screen 61A and the menu screen 61B to the state of displaying the BET screen 61 only. Thereafter, the terminal CPU 91 terminates the order processing.

In this configuration, it is possible to allow the player to make a bet of credits on the roulette game on the BET screen 61 even in the course of placing the order of the item on the menu screen 61A or 61B. Moreover, the credits equivalent to the payment for the item designated as the order candidate cannot be used as resources for making a bet on the roulette game unless the order is cancelled. Therefore, it is possible to secure the credits equivalent to the payment for the item when the order is confirmed.

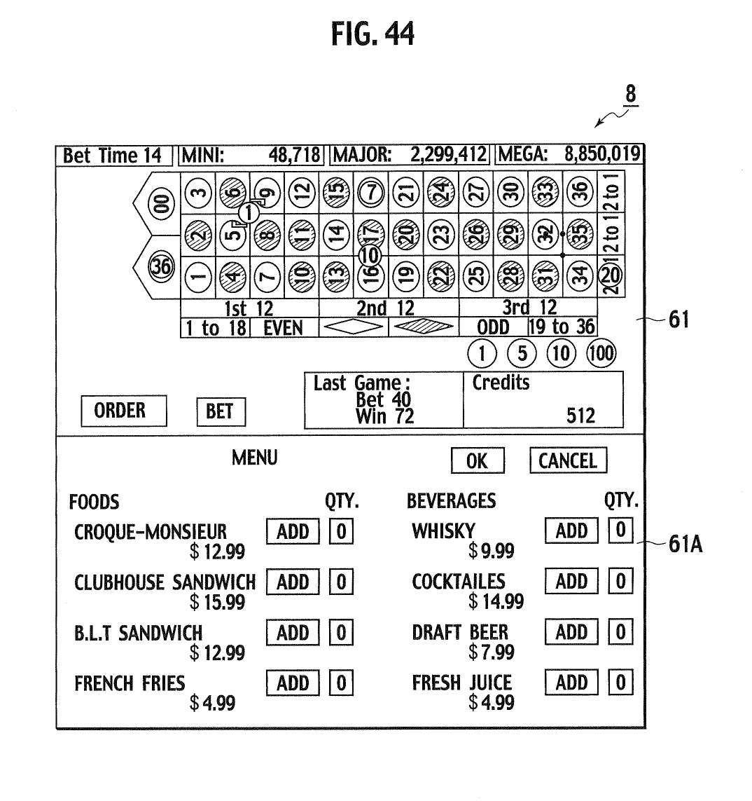

Here, as shown in FIGS. 44 and 45, instead of using the half areas on the display 8 respectively for displaying the BET screen 61 shown in FIG. 5 and any of the menu screens 61A and 61B shown in FIG. 38 and FIG. 39 at the same time, it is also possible to switch the display on the display 8 between the BET screen 61 shown in FIG. 5 and any of the menu screens 61A and 61B shown in FIG. 38 and FIG. 39 at anytime by an instruction of the player.

Moreover, it is not always necessary to use the order data outputted in step S352 in the order processing shown in FIG. 37 or FIG. 43B of the above-described embodiments solely for the purpose of display in the default language (in English, for example) on the shop display 86a of the shop server 86. For example, it is also possible to use the data, as it is, on the shop server 86 for other purposes including management of the ordered items.

### Second Embodiment

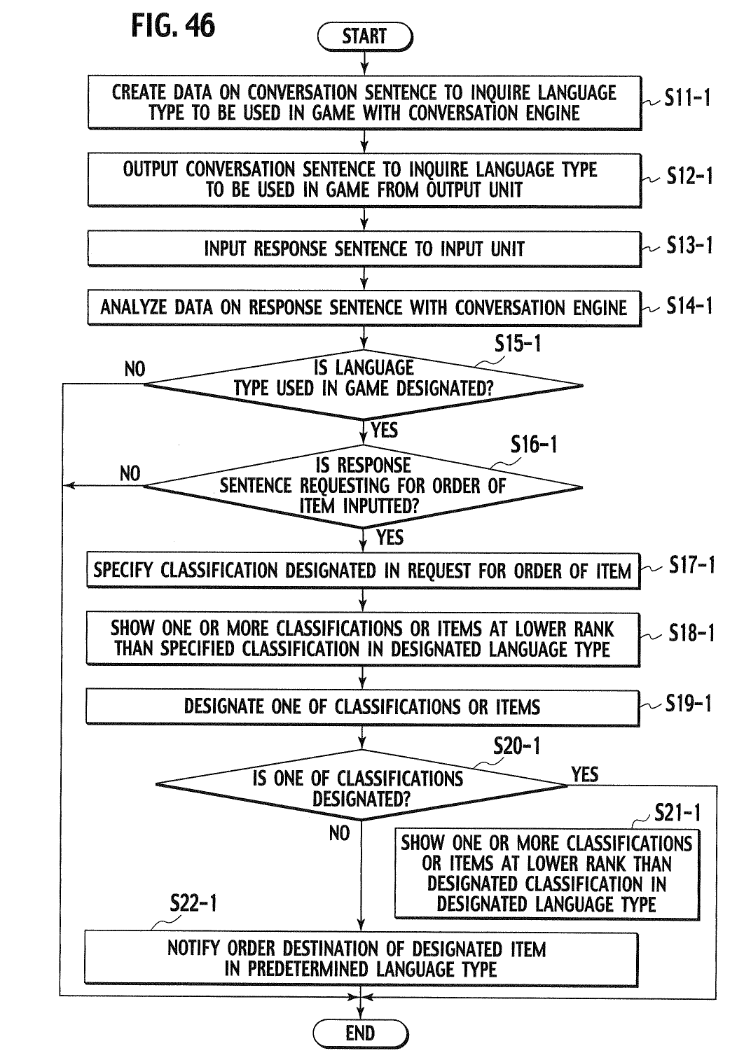

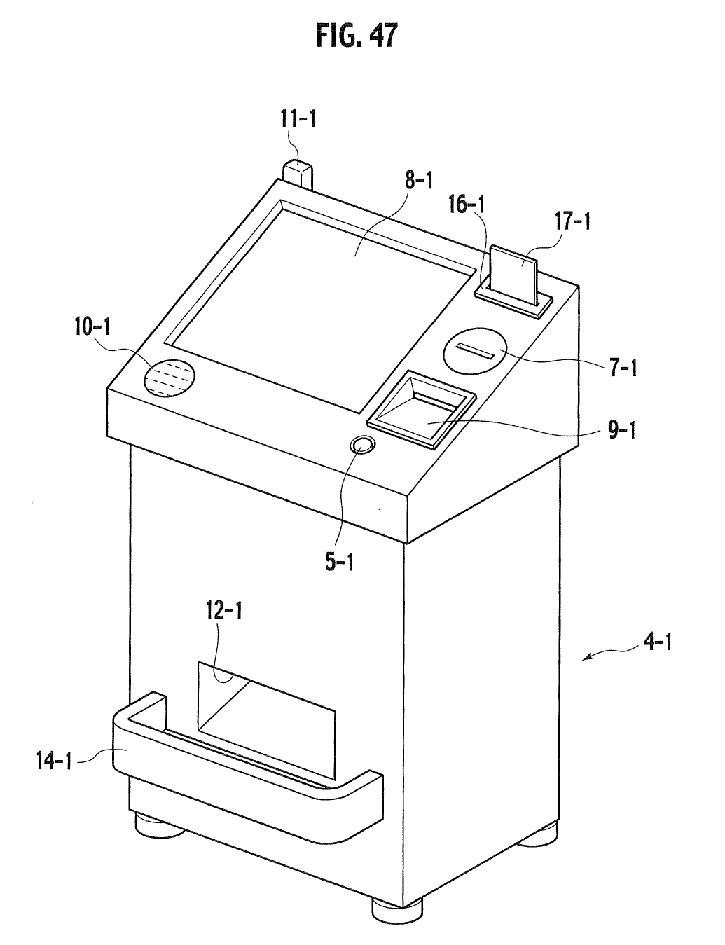

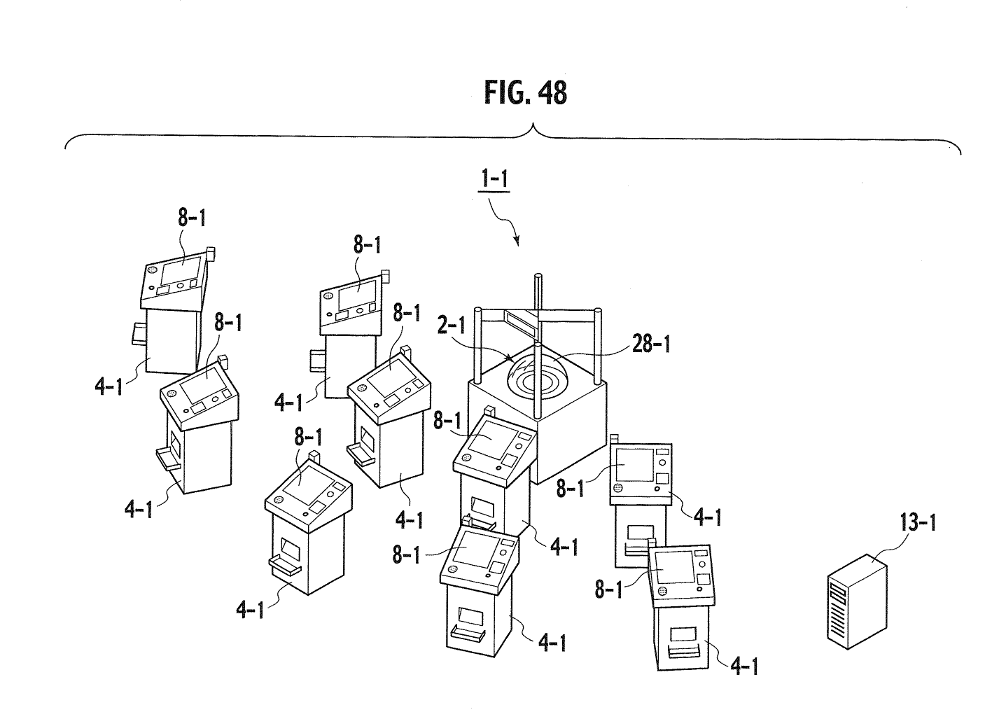

Now, operations of a gaming terminal representing an example of a gaming machine according to a second embodiment of the present invention and outlines of a playing method thereof will be described below with reference to a flow chart shown in FIG. 46, a perspective view of a gaming machine shown in FIG. 47, and an outward perspective view of a roulette game machine shown in FIG. 48.

First, in a gaming terminal 4-1 according to the second embodiment of the present invention shown in FIG. 47, a player can participate in a roulette game executed in a roulette device 2-1 by betting credits through a BET screen displayed on a display 8-1.

Then, data on a conversation sentence to inquire to a player of a language type to be used for playing a roulette game are created by use of a conversation engine of the gaming terminal 4-1 shown in FIG. 47 (step S11-1). Next, the conversation sentence to inquire the language type to be used for playing the roulette game is outputted from an output unit of the gaming terminal 4-1 by using the data created by the conversation engine (step S12-1).

Subsequently, the player inputs a response sentence to designate the language type to be used for playing the roulette game to an input unit of the gaming terminal 4-1 in response to the conversation sentence outputted from the output unit (step S13-1). Then, data on the response sentence inputted to the input unit by the player are analyzed by the conversation engine of the gaming terminal 4-1 (step S14-1).

Next, a judgment is made as to whether or not the language type to be used for playing the roulette game is designated in the response sentence having the data analyzed by the conversation engine of the gaming terminal 4-1 (step S15-1). Then, when the language type to be used for playing the roulette game is designated (YES in step S15-1), a judgment is made as to whether or not a response sentence (such as a phrase meaning “I would like some food and beverage”) to request an order of an item orderable through the gaming terminal 4-1 is inputted to the input unit in the designated language type by the player (step S16-1).

Thereafter, when the response sentence to request the order of the item is inputted in the designated language type (YES in step S16-1), a classification designated by the request for the order of the item is specified (step S17-1). Then, one or more classifications at a lower rank than the specified classification are outputted to be presented in the designated language type. Here, if the specified classification is at the lowest rank, then one or more items belonging to the classification are outputted (step S18-1). This output can be in the form of a conversation sentence from the output unit of the gaming terminal 4-1 by using data created by the conversation engine of the gaming terminal 4-1. Alternatively, this output can also be in the form of display of a menu screen on a display 8-1 (see FIG. 47) of the gaming terminal 4-1.

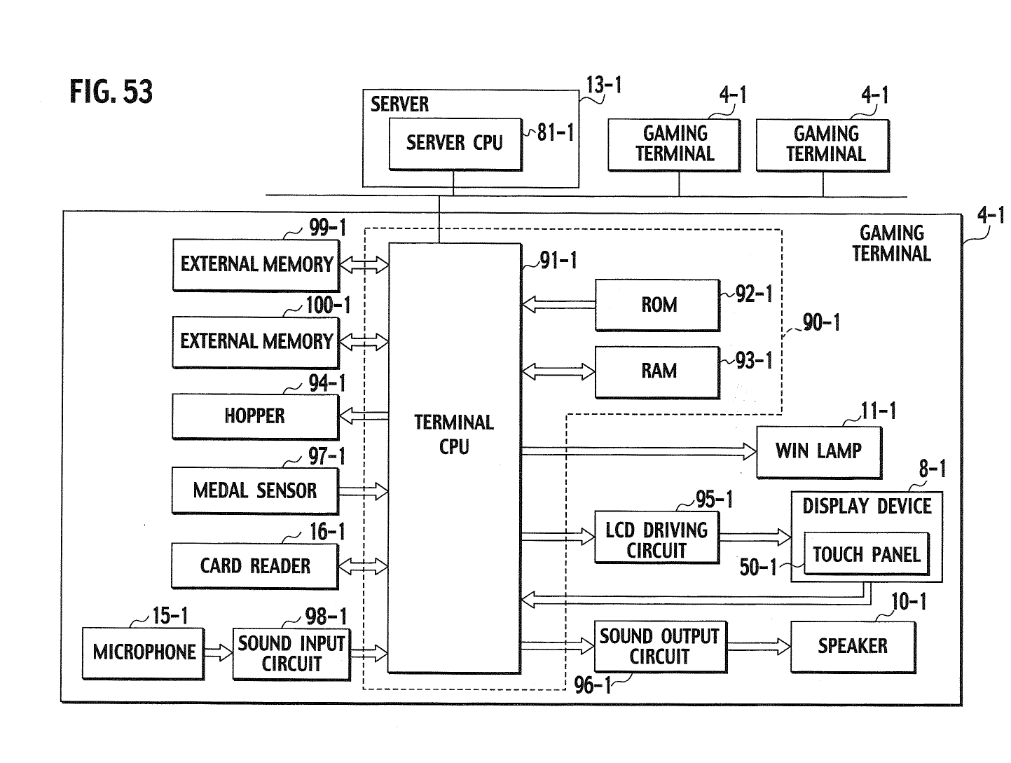

In step S18-1, the classifications and the items can be outputted in the language type designated in the step S15-1 using menu data stored in an external memory 100-1 (see FIG. 53; a memory) of the gaming terminal 4-1. The menu data indicate the multiple items orderable by the player through the gaming machine and the classifications of these items in a hierarchical structure in multiple language types usable for playing the roulette game.

Subsequently, the player designates one of the one or more classifications at lower ranks presented by the output in step S18-1 or designates one of the one or more items belonging to the lowest presented rank (step S19-1). This designation can be inputted to the input unit in the form of a response sentence using the designated language type. Alternatively, this designation can be inputted by operating the menu screen on the display 8-1 in the designated language type.

Next, a judgment is made as to whether or not one of the presented classifications is designated by way of the response sentence in the designated language type inputted from the input unit and analyzed by the conversation engine or by way of the menu screen in the designated language type operated by the player (step S20-1).

Then, when one of the presented classifications is designated (YES in step S20-1), one or more classifications at a lower rank than the specified classification are outputted to be presented in the designated language type. Here, if the specified classification is at the lowest rank, then one or more items belonging to the classification are outputted (step S21-1). This output can be performed in a similar manner to the output in step S18-1.

On the other hand, when one of the items presented in the designated language type is designated (NO in step S20-1), the item designated in the designated language type is notified to an order destination in a predetermined language type (step S22-1). This notification can be performed by outputting order data representing the content of the designated item in the predetermined language to a server at the order destination. Alternatively, this notification can also be performed by displaying the designated item on a second display at the order destination in the designated language type.

According to the gaming terminal 4-1 and the playing method of the same of the embodiment of the present invention, the player inputs the response sentence, into the input unit, to designate the language type to be used for playing the roulette game with the gaming terminal, in response to the conversation sentence outputted from the output unit of the gaming terminal 4-1. Then, as the player requests for the order of the item, one or more classifications or items at a lower rank than the classification designated by the request are outputted from the output unit or displayed on the menu screen on the display 8-1.

Then, as the player designated the classification at the lower rank, in the designated language type, by means of the input from the input unit or by means of operating the menu screen on the display 8-1, one or more classifications or items at a lower rank than the classification outputted right before from the output unit or on the menu screen on the display 8-1 are outputted from the output unit or displayed on the menu screen on the display 8-1.

Moreover, as the player designates the item, in the designated language type, by means of the input from the input unit or by means of the operation on the menu screen on the display 8-1, the content of the item ordered by the player is transmitted to the order destination, which is provided with the server configured to receive the output of the order data indicating the content of the order of the item, in the designated language type.

As a result, it is possible to place the order of the item in the designated language type through the gaming terminal 4-1 by designating the language type to be used in the game through interactive communication between the player and the gaming terminal 4-1. Moreover, it is possible to narrow down and specify the item to be ordered by the interactive communication between the player and the gaming terminal 4-1 in the designated language type. In this way, it is possible to offer advanced service to the player.

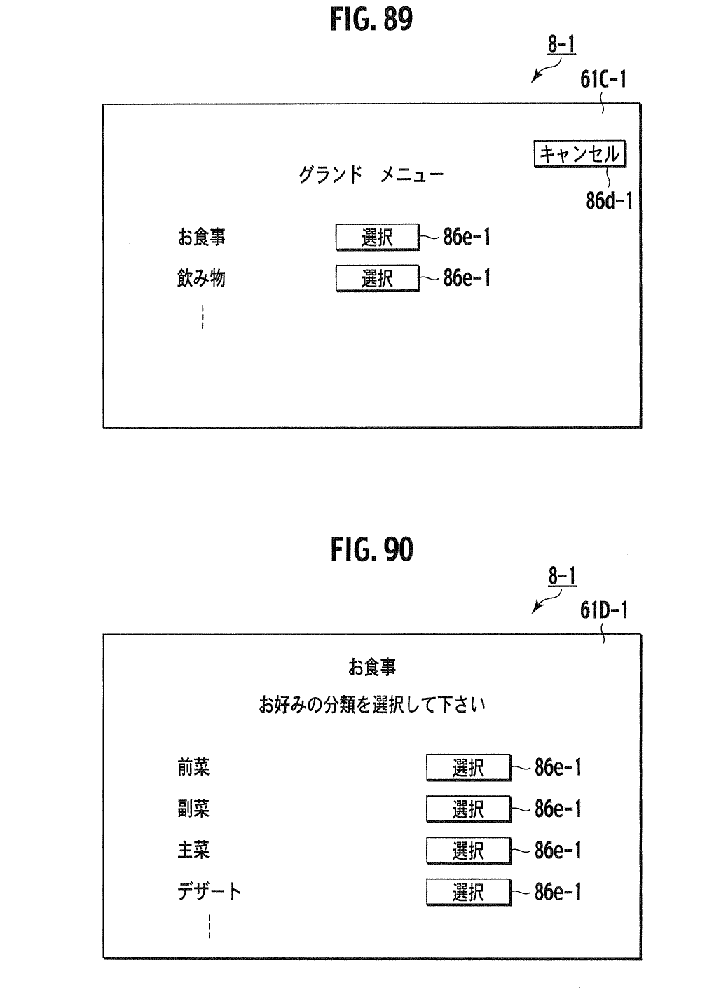

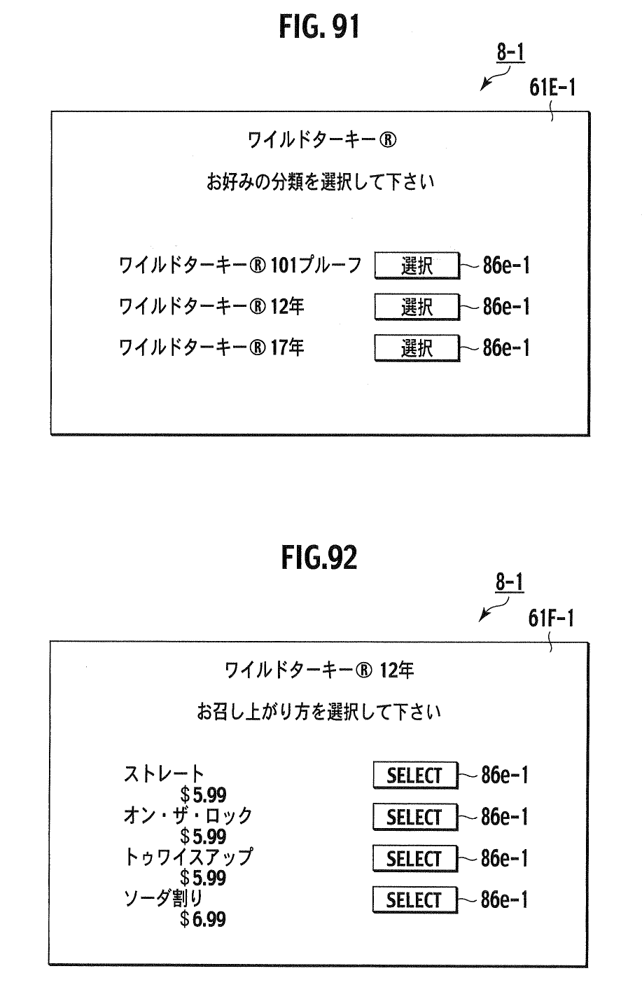

Next, the gaming terminal according to the embodiment of the present invention will be described together with a roulette game device including the gaming terminal with reference to FIG. 47 to FIG. 94.

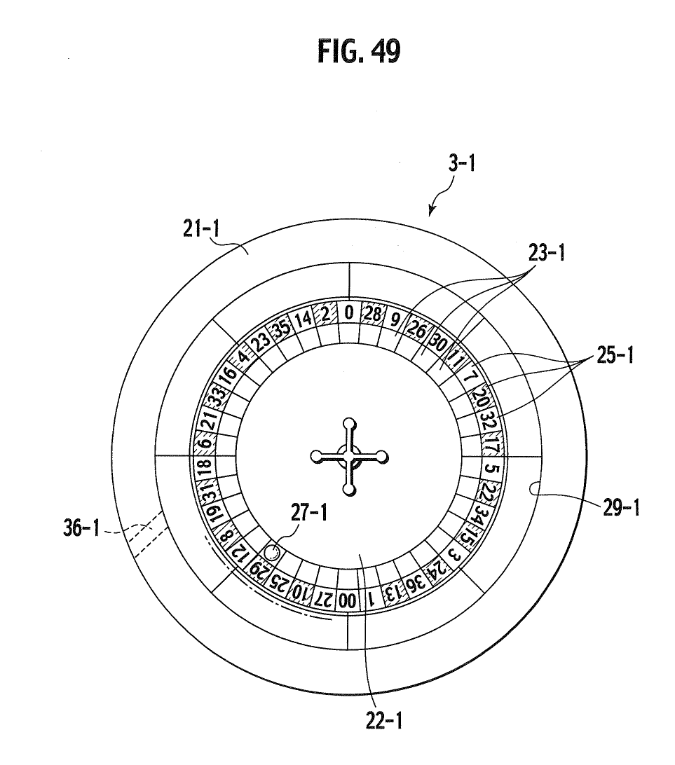

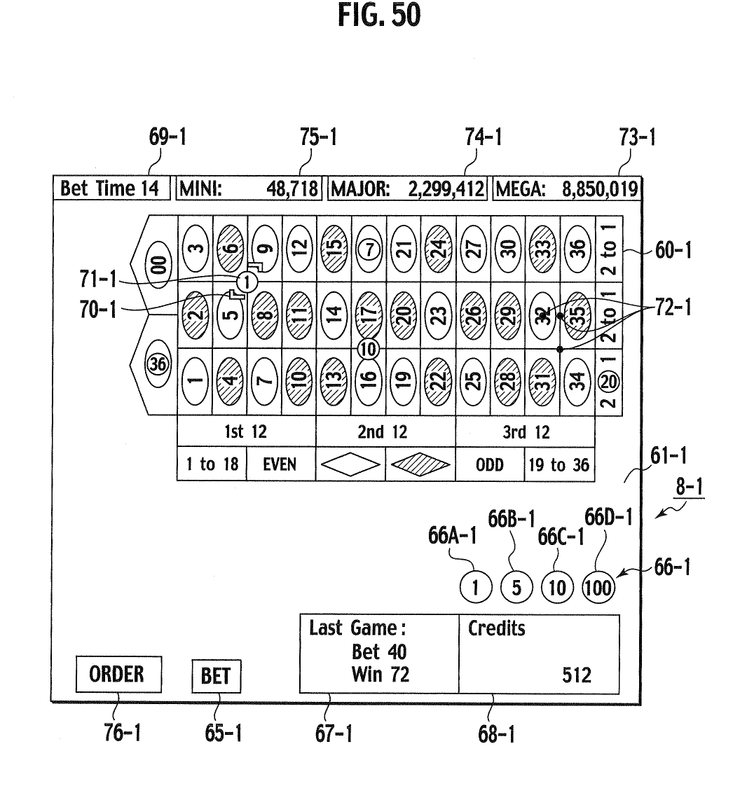

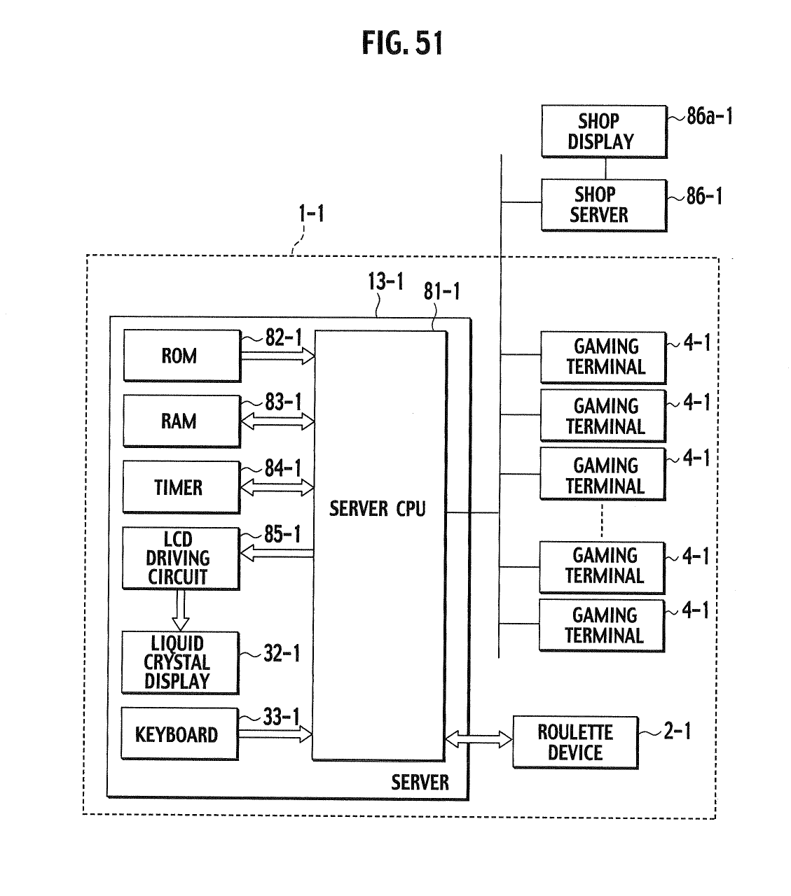

FIG. 47 is a perspective view of the gaming terminal according to the embodiment of the present invention. FIG. 48 is an external perspective view showing a schematic configuration of the roulette game device according to the embodiment of the present invention, which includes the gaming terminal shown in FIG. 47. FIG. 49 is a plan view of a roulette device 2-1 provided on the roulette game device shown in FIG. 48. FIG. 50 is a view showing an example of an image to be displayed on a display provided on the gaming terminal shown in FIG. 47. FIG. 51 is a block diagram showing an internal configuration of the roulette game device.

A roulette game device 1-1 shown in FIG. 48 includes multiple gaming terminals 4-1 (a gaming machine) according to the embodiment of the present invention shown in FIG. 47. Besides, the roulette game device 1-1 includes a roulette device 2-1 and a server 13-1. The roulette game device 1-1 is disposed, for example, in a casino area in a casino hotel as appropriate. The respective gaming terminals 4-1, the roulette device 2-1, and the server 13-1 can be connected to one another through a local area network (communication lines) or the like.

Moreover, a shop server 86-1 (see FIG. 51; a server) is connected to this local area network. This shop server 86-1 is located in a shop area which is away from the casino area in the casino hotel. This shop server 86-1 is configured to manage orders of items placed by players through the respective gaming terminals 4-1. The shop server 86-1 includes a shop display 86a-1 (a second display) for displaying the ordered items.

At the roulette device 2-1, the roulette game will be executed under the control of the server 13-1, and the game will be displayed to the players. The players use a plurality of gaming terminals 4-1 that are arranged around the roulette device 2-1, in order to participate in the roulette game displayed by the roulette device 2-1. In the present embodiment, the roulette game machine 1-1 has nine gaming terminals 4-1. Consequently, at most nine players can participate in the communal roulette game simultaneously.

The roulette games to be displayed on the roulette device 2-1 are repeatedly executed at a cycle of a predetermined time period under control by the server 13-1. Accordingly, each of the players can make bets on a current roulette game by use of one of the gaming terminals 4-1. To make bets on the current roulette game, each of the gaming terminals 4-1 is provided with a display 8-1 (a display, a first display). A BET screen 61-1 (see FIG. 50) corresponding to the roulette game is displayed on this display 8-1. Display contents of this BET screen 61-1 will be described later in detail.

FIG. 49 is a plan view of a roulette device provided in a roulette game machine of FIG. 48.

As shown in FIG. 49, the roulette device 2-1 has a frame 21-1, and a roulette wheel 22-1 which is accommodated and supported rotatably inside the frame 21-1. On an upper surface of the roulette wheel 22-1, a plurality (38 in total in the present embodiment) of number pockets 23-1 is formed. In addition, on an upper surface of the roulette wheel 22-1 on an outer side of the number pockets 23-1, number plates 25-1 are provided for displaying numbers “0”, “00”, “1” to “36” in correspondence to the respective number pockets 23-1.

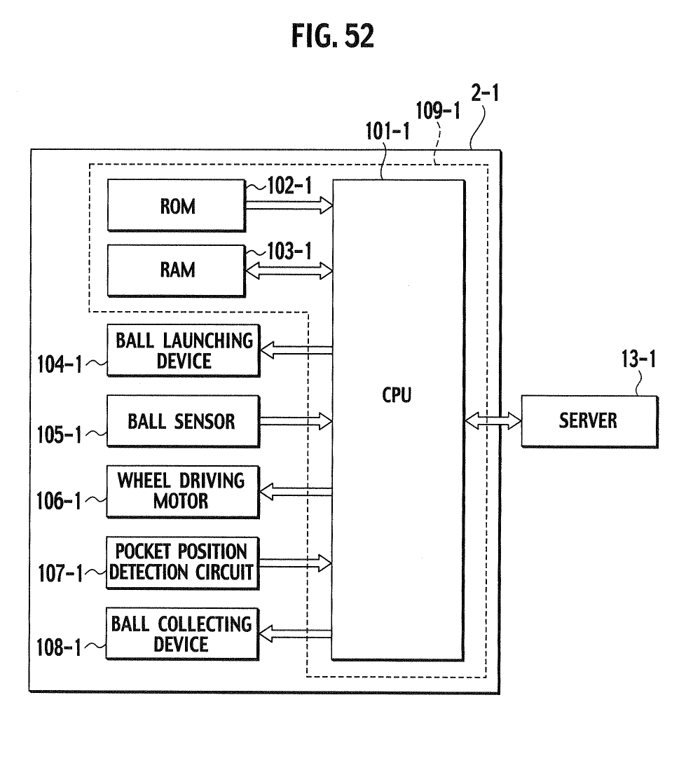

A ball launching hole 36-1 is opened on the inner periphery of the frame 21-1. The ball launching hole 36-1 is connected to a ball launching device 104-1 (see FIG. 52). In conjunction with the activation of the ball launching device 104-1, a ball 27-1 will be entered onto the roulette wheel 22-1 from the ball launching hole 36-1. Also, a hemispherical transparent acrylic cover 28-1 covers over the roulette device 2-1 (see FIG. 48).

A wheel driving motor 106-1 (see FIG. 52) is provided on a lower side of the roulette wheel 22-1. In conjunction with the activation of the wheel driving motor 106-1, the roulette wheel 22-1 will be rotated. Metal plates (not shown) are attached at prescribed intervals on a lower surface of the roulette wheel 22-1. As a proximity sensor of a pocket position detection circuit 107-1 (see FIG. 52) detects these metal plates, a position of the number pocket 23-1 is detected.

The frame 21-1 is gently inclined toward an inner side, and a guide wall 29-1 is formed on its middle section. The entered ball 27-1 is rolled by being guided by the guide wall 29-1 due to its centrifugal force. The ball 27-1 rolls down the slope of the frame 21-1 toward the inner side as the rotational speed decreases and the centrifugal force becomes weaker, and reaches to the rotating roulette wheel 22-1. Then, the ball 27-1 that reached to the roulette wheel 22-1 further falls into one of the number pockets 23-1 by passing over the number plates 25-1 on an outer side of the rotating roulette wheel 22-1. As a result, the number on the number plate 25-1 of the number pocket 23-1 into which the ball fell is judged by a ball sensor 105-1, and this number will become a winning number.

Next, the configuration of the gaming terminal 4-1 will be described.

As shown in FIG. 47, the gaming terminal 4-1 has a medal insertion slot 7-1 for inserting game media (currency value: such as cash, a chip, a medal, etc.) and a above-mentioned display 8-1 for displaying images related to the game on its upper face. The gaming terminal 4-1 accepts the betting operation by the player by using the medal insertion slot 7-1 and the display 8-1. The player can play the game by operating the touch panel 50-1 (see FIG. 52) or the like that is provided on a front face of the display 8-1 while watching the images displayed on the display 8-1. Note that, in the following description, the game media may be referred as their representative “medals”.

Also, besides the medal insertion slot 7-1 and the display 8-1 described above, a payout button 5-1, a ticket printer 6-1, a bill insertion slot 9-1, a speaker 10-1, a microphone 15-1, and a card reader 16-1 are provided on an upper face of the gaming terminal 4-1. A medal payout opening 12-1 and a medal tray 14-1 are provided in a front face of the gaming terminal 4-1.

The payout button 5-1 is a button for inputting a command for paying out credited medals from the medal payout opening 12-1 to the medal tray 14-1. The ticket printer 6-1 prints out as the bar code ticket including the data such as the credits, the date, and the identification number of the gaming terminal 4-1. The player can use the bar code ticket at another gaming terminal 4-1 and the player can bet to the game at that gaming terminal 4-1. Or the player can exchange the bar code ticket to bills or the like at a prescribed location (a cashier in the casino, for example) in the gaming facility.

The bill insertion slot 9-1 is configured to validate the appropriateness of bills and to accept authentic bills. Here, the bill insertion slot 9-1 may also be configured to be capable of reading a bar-coded ticket 39-1. The speaker 10-1 is used to output music, sound effects, speech messages (conversation sentences) to the player, and the like. The microphone 15-1 is used to input a speech message (a response sentence) uttered by the player.

The card reader 16-1, in which a smart card 17-1 (a portable memory) can be inserted, reads data out of the inserted smart card 17-1 and writes data into the smart card 17-1. The smart card, owned by the player, includes member card unique to the player, a credit card.

The data concerning the gaming history executed by the player (game history information) are stored in the smart card 17-1 together with data for identifying the player. The gaming history information includes game type information concerning games ever played by the player, points awarded in the games played in the past, and a language type used by the player in the course of the games. The smart card 17-1 may further store data corresponding to coins, bills or credits. Concerning a method of writing and reading the data in and out of this smart card 17-1, any of a contact method and a non-contact method (a radio-frequency identification or RFID method) is applicable. Alternatively, a magnetic stripe card is also applicable, instead of the smart card 17-1.

On an upper side of the display 8-1 of each gaming terminal 4-1, a WIN lamp 11-1 is provided respectively. In the case where the number (“0”, “00” and “1” to “36” in the present embodiment) bet at the gaming terminal 4-1 in the game becomes the winning number, the WIN lamp 11-1 of the winning gaming terminal 4-1 will be turned on. Also, in the jackpot (referred hereafter also as JP) bonus game for obtaining JP, the WIN lamp 11-1 of the gaming terminal 4-1 that obtained JP will be turned on similarly. Note that this WIN lamp 11-1 provided at a position that is visible from all of the arranged gaming terminals 4-1 (9 sets in the present embodiment), such that the other players who are playing at the same roulette game machine 1-1 can always check which WIN lamp 11-1 is turned on.

Inside the medal insertion slot 7-1, a medal sensor (not shown) is provided, and it identifies the currency values such as medals that are inserted at the medal insertion slot 7-1, and counts the inserted medals. Also, a hopper (not shown) is provided inside the medal payout opening 12-1 and it pays a prescribed number of medals from the medal payout opening 12-1.

FIG. 50 is the diagram showing one example of an image to be displayed on the display.

The BET screen 61-1 as shown in FIG. 50 is displayed on the display 8-1 of each of the gaming terminals 4-1. The BET screen 61-1 includes a table-type betting board 60-1. The player can make bets on a roulette game by using his or her chips credited in the gaming terminal 4-1 in the form of electronic information and by operating a touch panel 50-1 (see FIG. 52) provided on a front face of the display 8-1.

To be more precise, the player indicates with a cursor 70-1 a BET area 72-1 (on a number and a grid of a mark of the number or on a line forming the grid) which is a target for making bets of chips. Then, the player indicates with unit BET buttons 66-1 the number of chips to be bet and confirms the number of bet chips with a BET confirmation button 65-1. The above described operations can be executed with the player directly pressing, with fingers, the sections where the BET area 72-1, the unit BET buttons 66-1, and the BET confirmation button 65-1 are displayed on the display 8-1.

Here, four types of the unit BET buttons 66-1, namely, a 1 BET button 66A-1, a 5 BET button 66B-1, a 10 BET button 66C-1, and a 100 BET button 66D-1 are provided corresponding to the number of chips that can be bet in one operation.

The number of chips bet in the previous game by the player and the number of payout credits are displayed on a payout result display unit 67-1 of the display 8-1. Meanwhile, the number of credits currently owned by the player is displayed on a credit number display unit 68-1 of the display 8-1. Moreover, remaining time for which the player can make bets is displayed on a BET time display unit 69-1 of the display 8-1.

Note that when the ball 27-1 entered on the roulette wheel 22-1 is housed in any of the number pockets 23-1, the winning number is confirmed and the current roulette game is finished, the next roulette game is started.

A MEGA counter 73-1 displaying the number of credits accumulated for a “MEGA” JP, a MAJOR counter 74-1 displaying the number of credits accumulated for a “MAJOR” JP, and a MINI counter 75-1 displaying the number of credits accumulated for a “MINI” JP are provided at the right side of the bet time display unit 69-1. In the case where any one of the JPs is won in the JP bonus game, a JP payout is provided according to the winning credits of the one of the JPs displayed on the respective counters 73-1 to 75-1. An initial value (200 credits for “MINI,” 5000 credits for “Major” and 50000 credits for “MEGA”) is displayed on the one of the counters 73-1 to 75-1 after the JP payout.

An order button 76-1 is displayed on the left of the BET confirmation button 65-1 on the BET screen 61-1. The player can display the menu of orderable items such as beverages or snacks on the display 8-1 by touching the order button 76-1 through an operation of the touch panel 50-1.

FIG. 51 is a block diagram showing an internal configuration of the roulette game machine according to the present embodiment.

As shown in FIG. 51, the roulette game machine 1-1 has the server 13-1, the roulette device 2-1 and a plurality (9 sets in the present embodiment) of the gaming terminals 4-1. The roulette device 2-1 and the gaming terminals 4-1 are connected to the server 13-1. Note that an internal configuration of the roulette device 2-1 and an internal configuration of the gaming terminal 4-1 will be described below in detail.

The server 13-1 has a server CPU 81-1 for executing the overall control of the server 13-1, a ROM 82-1, a RAM 83-1, a timer 84-1, a LCD (Liquid Crystal Display) 32-1 connected through a LCD driving circuit 85-1, and a keyboard 33-1.

The server CPU 81-1 carries out various processings according to input signals supplied from each gaming terminals 4-1, and data & programs stored in the ROM 82-1 & the RAM 83-1. Also, the server CPU 81-1 transmits command signals to the gaming terminals 4-1 according to the processing results, to control each gaming terminal 4-1 by its initiative. Also, the server CPU 81-1 transmits control signals to the roulette device 2-1, to control the shooting of the ball 27-1 and the rotation of the roulette wheel 22-1.

The ROM 82-1 is formed by a semiconductor memory or the like and stores programs that implement basic functions of the roulette game machine 1-1, programs that execute the notification of the maintenance time and the setting & management of the notification condition, the payout rate data for the roulette game (the payout credits with respect to the win per one chip), programs for controlling each gaming terminal 4-1 initiatively, etc.

On the other hand, the RAM 83-1 temporarily stores the betting information supplied from each gaming terminal 4-1, the winning number of the roulette device 2-1 detected by the sensors, the accumulated JP credits, the data regarding the result of the processing executed by the server CPU 81-1, etc.

In addition, the timer 84-1 is connected to the server CPU 81-1. The time information of the timer 84-1 is transmitted to the server CPU 81-1. The server CPU 81-1 executes the control of the rotation of the roulette wheel 22-1 and the shooting of the ball 27-1 based on the time information of the timer 84-1.

FIG. 52 is a block diagram showing an internal configuration of the roulette device according to the present embodiment.

As shown in FIG. 52, the roulette device 2-1 has a controller 109-1, the pocket position detection circuit 107-1, the ball launching device 104-1, the ball sensor 105-1, the wheel driving motor 106-1, and a ball collecting device 108-1. The controller 109-1 corresponds to the controller of the present invention.

The controller 109-1 has a CPU 101-1, a ROM 102-1, and a RAM 103-1. The CPU 101-1 controls the shooting of the ball 27-1 and the rotation of the roulette wheel 22-1 according to the control signals supplied from the server 13-1, and data & programs stored in the ROM 102-1 & the RAM 103-1.

The pocket position detection circuit 107-1 has a proximity sensor. It detects the rotation position of the roulette wheel 22-1 by detecting metal plates attached to the roulette wheel 22-1.

The ball launching device 104-1 is for launching the ball 27-1 onto the roulette wheel 22-1 from the ball launching hole 36-1 (see FIG. 49). The ball launching device 104-1 shoots the ball 27-1 at an initial speed and at a timing set in the control data.

The ball sensor 105-1 is a device for detecting the number pocket 23-1 into which the ball 27-1 fell. The wheel driving motor 106-1 is for rotating the roulette wheel 22-1. The wheel driving motor 106-1 stops the activation after the motor driving time that is set in the control data has elapsed since the start of the activation. The ball collecting device 108-1 is for collecting the ball 27-1 on the roulette wheel 22-1 after the game is over.

FIG. 53 is a block diagram showing an internal configuration of the gaming terminal according to the present embodiment. Note that 9 sets of the gaming terminals 4-1 have basically the same configuration, and an example of one gaming terminal 4-1 will be described in the following.

As shown in FIG. 53, the gaming terminal 4-1 has a terminal controller 90-1 formed by a terminal CPU 91-1, a ROM 92-1 and a RAM 93-1. The ROM 92-1 is formed by a semiconductor memory or the like and stores programs that implement basic functions of the gaming terminal 4-1, and various programs, data table, etc., that are necessary for controlling the gaming terminal 4-1. Also, the RAM 93-1 is a memory for temporarily storing various data calculated by the terminal CPU 91-1, the owned credits by the player (deposited at the gaming terminal 4-1), the state of betting by the player, a flag F for indicating that it is under the betting period or not, etc.

To the terminal CPU 91-1, a payout button 5-1 is connected.

The payout button 5-1 is a button to be pressed by the player usually when the game is over. When the payout button 5-1 is pressed by the player, the medals according to the credits acquired in the game by the player will be paid from the medal payout opening 12-1 (usually one medal for one credit).

The terminal CPU 91-1 executes various corresponding operations according to the operation signals outputted by the payout button 5-1 as a result of pressing of the payout button 5-1. More specifically, the terminal CPU 91-1 executes various processings when signals associated with the pressing of the bet confirmation button 65-1 is inputted, according to the input signals and data & programs stored in the ROM 92-1 & the RAM 93-1. The terminal CPU 91-1 transmits their processing results to the server CPU 81-1.

Also, the terminal CPU 91-1 receives command signals from the sever CPU 81-1 and controls peripheral devices constituting the gaming terminal 4-1, so as to proceed with the game. Also, the terminal CPU 91-1 executes various processings according to the above described input signals and data & programs stored in the ROM 92-1 & the RAM 93-1, depending on the processing contents. The terminal CPU 91-1 controls the peripheral devices constituting the gaming terminal 4-1 according to the processing results, so as to proceed with the game.

Also, a hopper 94-1 is connected to the terminal CPU 91-1. The hopper 94-1 pays a prescribed number of medals from the medal payout opening 12-1 (see FIG. 47) according to a command signal from the terminal CPU 91-1.

In addition, the display 8-1 is connected to the terminal CPU 91-1 through a LCD driving circuit 95-1. The LCD driving circuit 95-1 has a program ROM, an image ROM, an image control CPU, a work RAM, VDP (Video Display Processor), and a video RAM. The program ROM stores an image controlling program and various selection tables regarding the display at the display 8-1. The image ROM stores dot data for forming an image to be displayed at the display 8-1, for example. The image control CPU makes the determination of an image to be displayed at the display 8-1 from the dot data in the image ROM, according to the image control program in the program ROM, based on parameters set up by the terminal CPU 91-1. The work RAM is provided as a temporary memory device at a time of executing the image control program at the image control CPU. The VDP forms a display image determined by the image control CPU and outputs it to the display 8-1. Note that the video RAM is provided as a temporary memory device at a time of forming an image by the VDP.

Also, the touch panel 50-1 is attached on the front surface of the display 8-1. The operation information of the touch panel 50-1 is transmitted to the terminal CPU 91-1. At the touch panel 50-1, the betting operation by the player is carried out on the bet screen 61-1. More specifically, the operation of the touch panel 50-1 is carried out for the selection of the bet area 72-1 and the input via the bet buttons 66-1 and the bet confirmation button 65-1, etc. When the touch panel 50-1 is operated, its operation information is transmitted to the terminal CPU 91-1. Then, according to that information, the betting information (the bet area and the number of bets specified on the bet screen 61-1) is stored into the RAM 93-1. In addition, this betting information is transmitted to the server CPU 81-1, and stored in the betting information memory area of the RAM 83-1.

Moreover, a round output circuit 96-1 and the speaker 10-1 are connected to the terminal CPU 91-1. The speaker 10-1 generates, based on output signals from the sound output circuit 96-1, various sound effects for executing various effects and dialog message sounds to the player for interactive gaming.

Meanwhile, a sound input circuit 98-1 and the microphone 15-1 are connected to the terminal CPU 91-1. The microphone 15-1 is used to input through the sound input circuit 98-1, into the terminal CPU 91-1, response message sounds in the player's voice to the dialog message sounds outputted from the speaker 10-1.

Also, a medal sensor 97-1 is connected to the terminal CPU 91-1. The medal sensor 97-1 detects medals inserted from the medal insertion slot 7-1 (see FIG. 47). At the same time, the medal sensor 97-1 counts the inserted medals, and transmits its result to the terminal CPU 91-1. The terminal CPU 91-1 increases the amount of credits of the player that is stored in the RAM 93-1 according to the transmitted signal.

Also, a WIN lamp 11-1 is connected to the terminal CPU 91-1. The terminal CPU 91-1 turns on the WIN lamp 11-1 in a prescribed color, when the bet on the bet screen 61-1 won or when the JP is won.

Moreover, external memories 99-1 and 100-1 are connected to the terminal CPU 91-1. Each of the external memories is formed of a hard disk device. The terminal CPU 91-1 writes and reads data in and out of the external memories 99-1 and 100-1 as needed. Of these external memories 99-1 and 100-1, in the external memory 100-1 (a memory), menu data indicating multiple items orderable through this gaming terminal 4-1 and classifications of these items in a hierarchical structure are stored in multiple language types usable for playing the roulette game.

Moreover, the gaming terminal 4-1 provided with the above-described terminal controller 90-1 includes a conversation engine. By using this conversation engine, at least part of the roulette games on the gaming terminal 4-1 are interactively executed in a dialog style with the player by using the display 8-1, the speaker 10-1, and the microphone 15-1 as interfaces. Accordingly, in a certain scene, as the roulette game proceeds, the message sound is outputted from the speaker 10-1 to the player through the sound output circuit 96-1 and the contents of the message sounds of the player inputted through the microphone 15-1 and the sound input circuit 98-1 are analyzed.

Such a conversation engine can be achieved by using any of the conversation controllers disclosed in US Patent Application Publication No. 2007/0094007, US Patent Application Publication No. 2007/0094008, US Patent Application Publication No. 2007/0094005, and US Patent Application Publication No. 2007/0094004, for example. As will be described later, such a conversation controller can be achieved by use of the display 8-1 and the speaker 10-1, the microphone 15-1, the terminal controller 90-1, and the external memory 99-1 of the gaming terminal 4-1.

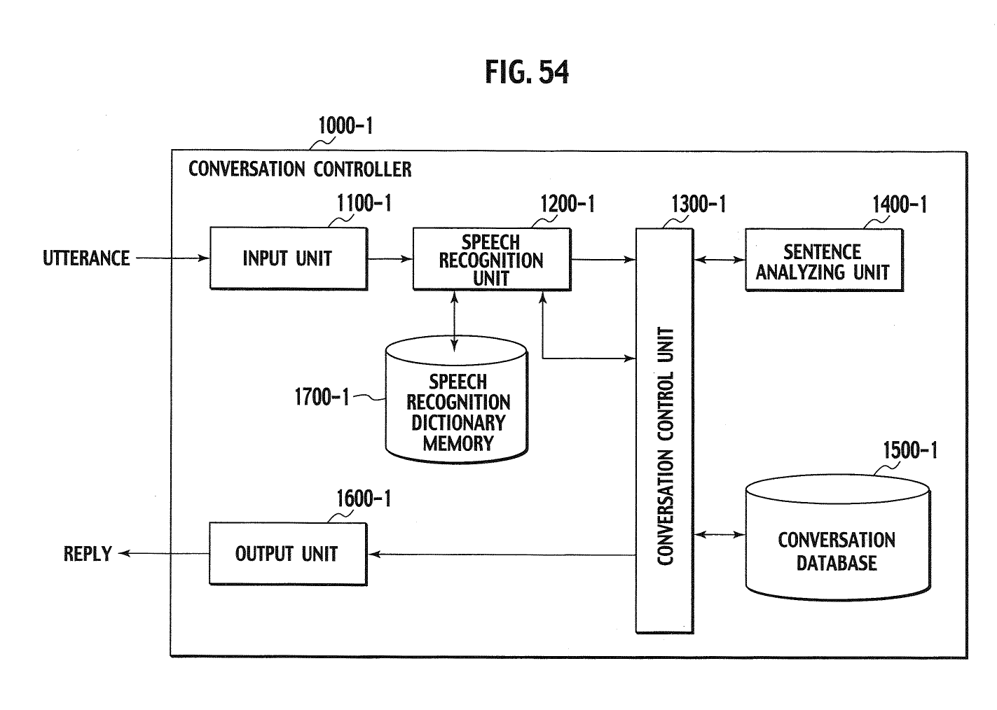

Here, a configuration of the conversation controller disclosed in US Patent Application Publication No. 2007/0094007, which is available as the conversation engine to be installed on the gaming terminal 4-1 of this embodiment, will be described with reference to FIG. 54 to FIG. 75. FIG. 54 is a functional block diagram showing a configuration example of a conversation controller.

As shown in FIG. 54, a conversation controller 1000-1 includes an input unit 1100-1, a speech recognition unit 1200-1, a conversation control unit 1300-1, a sentence analyzing unit 1400-1, a conversation database 1500-1, an output unit 1600-1, and a speech recognition dictionary memory 1700-1.

### [Input Unit]

The input unit 1100-1 receives input information (user's utterance) input by a user. The input unit 1100-1 outputs a speech corresponding to contents of the received utterance as a voice signal to the speech recognition unit 1200-1. Note that the input unit 1100-1 may be a character input unit such as a keyboard and a touchscreen (touch panel). In this case, the after-mentioned speech recognition unit 1200-1 doesn't need to be provided.

### [Speech Recognition Unit]

The speech recognition unit 1200-1 specifies a character string corresponding to the uttered contents based on the uttered contents obtained via the input unit 1100-1. Specifically, the speech recognition unit 1200-1 that has received the voice signal from the input unit 1100-1 compares the received voice signal with the conversation database 1500-1 and dictionaries stored in the speech recognition dictionary memory 1700-1 based on the voice signal to output a speech recognition result estimated based on the voice signal to the conversation control unit 1300-1. In a configuration example shown in FIG. 54, the speech recognition unit 1200-1 requests acquisition of memory contents of the conversation database 1500-1 to the conversation control unit 1300-1 and then receives the memory contents of the conversation database 1500-1 which the conversation control unit 1300-1 retrieves according to the request from the speech recognition unit 1200-1. However the speech recognition unit 1200-1 may directly retrieves the memory contents of the conversation database 1500-1 for comparing with the voice signal.

### Configuration Example of Speech Recognition Unit

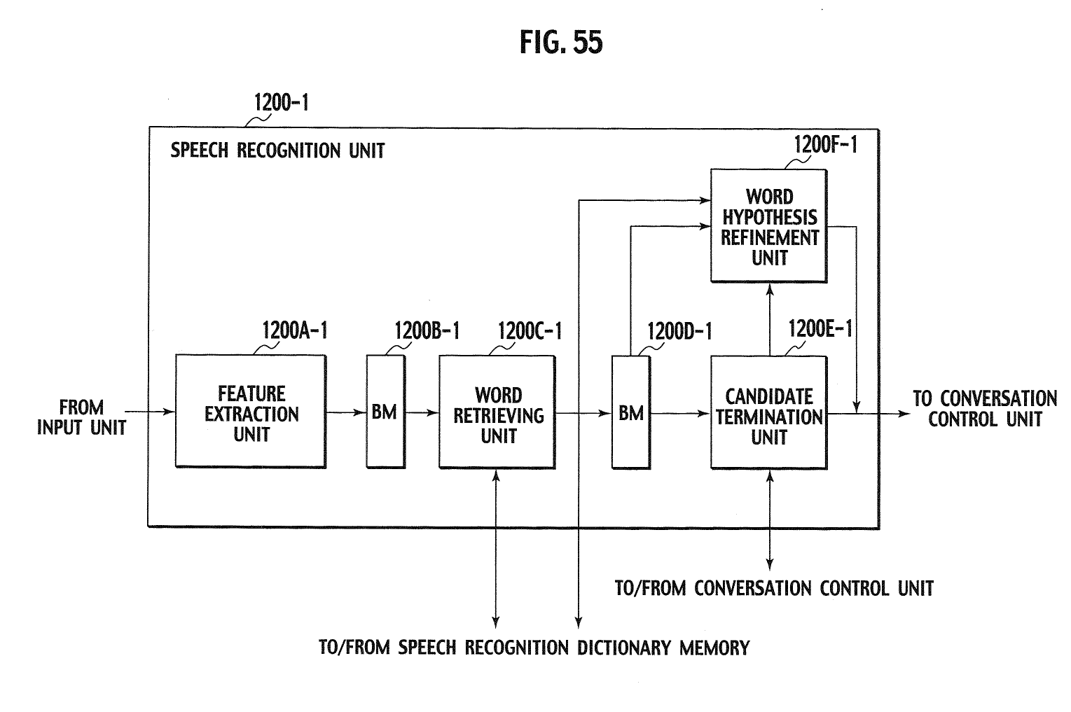

FIG. 55 is a functional block diagram showing a configuration example of the speech recognition unit 1200-1. The speech recognition unit 1200-1 includes a feature extraction unit 1200A-1, a buffer memory (BM) 1200B-1, a word retrieving unit 1200C-1, a buffer memory (BM) 1200D-1, a candidate determination unit 1200E-1 and a word hypothesis refinement unit 1200F-1. The word retrieving unit 1200C-1 and the word hypothesis refinement unit 1200F-1 are connected to the speech recognition dictionary memory 1700-1. In addition, the candidate determination unit 1200E-1 is connected to the conversation database 1500-1 via the conversation control unit 1300-1.

The speech recognition dictionary memory 1700-1 connected to the word retrieving unit 1200C-1 stores a phoneme hidden markov model (hereinafter, the hidden markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700-1 connected to the word retrieving unit 1200C-1 further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A-1. The feature extraction unit 1200A-1 converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C-1 via the buffer memory (BM) 1200B-1.

The word retrieving unit 1200C-1 retrieves word hypotheses with a one-pass Viterbi decoding method based on the feature parameters input from the feature extraction unit 1200A-1 via the buffer memory (BM) 1200B-1 by using the phoneme HMM and the word dictionary stored in the speech recognition dictionary memory 1700-1, and then calculates likelihoods. Here, the word retrieving unit 1200C-1 calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C-1 may reduce grid hypotheses of the lower likelihoods among all of the calculated likelihoods based on the phoneme HMM and the word dictionary in order to reduce a computing throughput. The word retrieving unit 1200C-1 outputs information on the retrieved word hypotheses and the likelihoods of the retrieved word hypotheses together with time information regarding an elapsed time from the speech start time (e.g. frame number) to the candidate determination unit 1200E-1 and the word hypothesis refinement unit 1200F-1 via the buffer memory (BM) 1200D-1.

The candidate determination unit 1200E-1 compares the retrieved word hypotheses with topic specification information in a prescribed discourse space with reference to the conversation control unit 1300-1, and then determines whether or not exists a coincident word hypothesis with the topic specification information in the prescribed discourse space among the retrieved word hypotheses. If the coincident word hypothesis exists, the candidate determination unit 1200E-1 outputs the coincident word hypothesis as a recognition result. On the other hand, if the coincident word hypothesis doesn't exist, the candidate determination unit 1200E-1 requires the word hypothesis refinement unit 1200F-1 to refine the retrieved word hypotheses.

An operation of the candidate determination unit 1200E-1 will be described. Here, it is assumed that the word retrieving unit 1200C-1 outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

The candidate determination unit 1200E-1 compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300-1 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F-1 operates to output the recognition result in response to the request from the candidate determination unit 1200E-1 to refine the retrieved word hypotheses. The word hypothesis refinement unit 1200F-1 refines the retrieved word hypotheses for the same words having the same speech termination time and different speech start time per each initial phonetic environment of the same words with reference to a statistical language model stored in the speech recognition dictionary memory 1700-1 based on the plural retrieved word hypotheses output from the word retrieving unit 1200C-1 via the buffer memory (BM) 1200D-1 so that one word hypothesis with the highest likelihood may be selected as a representative among all of the likelihoods calculated between the speech start and the utterance termination of the word. And then, the word hypothesis refinement unit 1200F-1 outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

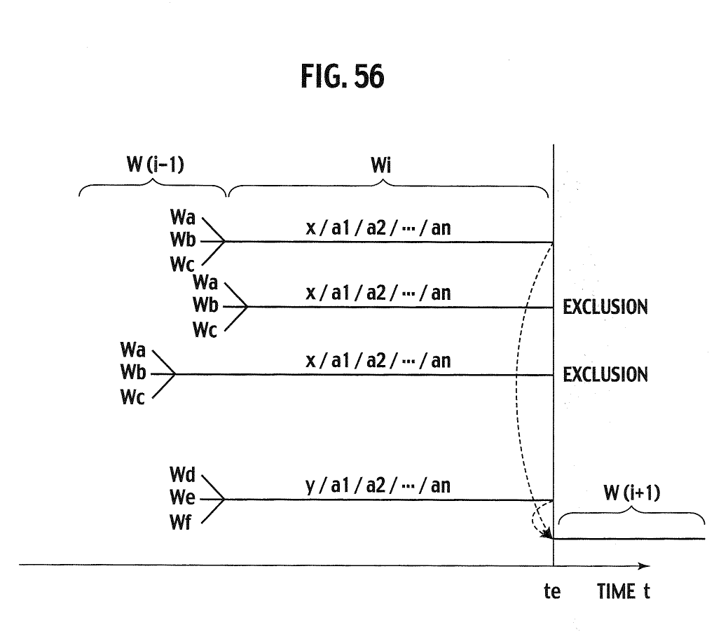

A word refinement process executed by the word hypothesis refinement unit 1200F-1 will be described with reference to FIG. 56.

For example, it is assumed that the (i)th word Wi, which consists of a phonemic string a1, a2, . . . and an, follows the (i−1)th word W(i−1) and six hypotheses Wa, Wb, We, Wd, We and Wf exist as a word hypothesis of the (i−1)th word W(i−1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F-1 is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A-1, the word retrieving unit 1200C-1, the candidate determination unit 1200E-1 and the word hypothesis refinement unit 1200F-1 are composed of a computer such as a microcomputer. The buffer memories (BMs) 200B-1 and 200D-1 and the speech recognition dictionary memory 1700-1 are composed of a memory unit such as a hard disk storage.

In the above-mentioned embodiment, the speech recognition is executed by using the word retrieving unit 1200C-1 and the word hypothesis refinement unit 1200F-1. However, the present invention is not limited to this. The speech recognition unit 1200-1 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200-1 is explained as a part of the conversation controller 1000-1. However, a independent speech recognition apparatus configured by the speech recognition unit 1200-1, the conversation database 1500-1 and the speech recognition dictionary memory 1700-1 may be possibly employed.

### Operating Example of Speech Recognition Unit

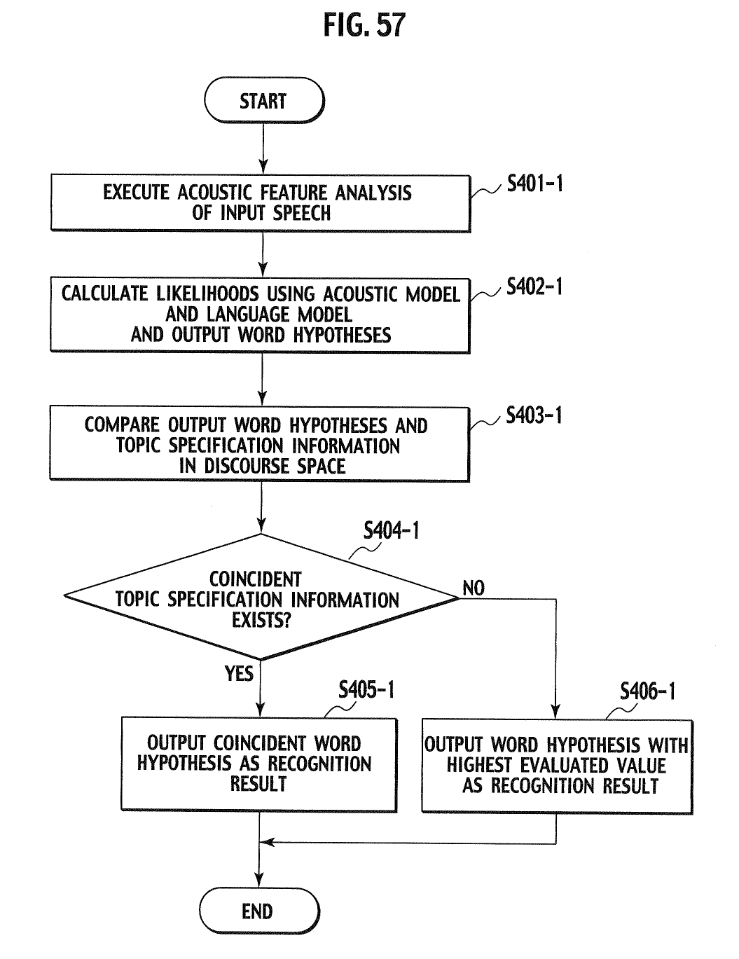

Next, operations of the speech recognition unit 1200-1 will be described with reference to FIG. 57. FIG. 57 is a flow-chart showing process operations of the speech recognition unit 1200-1.

The speech recognition unit 1200-1 executes a feature analysis of the input speech to generate feature parameters on receiving the voice signal from the input unit 1100-1 (step S401-1). Next, the feature parameters is compared with the phoneme HMM and the language model stored in the speech recognition dictionary memory 1700-1, and then a certain number of word hypotheses and the likelihoods of the word hypotheses are obtained (step S402-1). Next, the speech recognition unit 1200-1 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403-1 and S404-1). If the coincident word hypothesis exists, the speech recognition unit 1200-1 outputs the coincident word hypothesis as the recognition result (step S405-1). On the other hand, if no coincident word hypothesis exists, the speech recognition unit 1200-1 outputs the word hypothesis with the highest likelihood as the recognition result according to the obtained likelihoods of the word hypotheses (step S406-1).

### [Speech Recognition Dictionary Memory]

The configuration example of the conversation controller 1000-1 is further described with referring back to FIG. 54 again.

The speech recognition dictionary memory 1700-1 stores character strings corresponding to standard voice signals. The speech recognition unit 1200-1, which has executed the comparison, specifies a word hypothesis for a character string corresponding to the received voice signal, and then outputs the specified word hypothesis as a character string signal to the conversation control unit 1300-1.

### [Sentence Analyzing Unit]

Next, a configuration example of the sentence analyzing unit 1400-1 will be described with reference to FIG. 58. FIG. 58 is a partly enlarged block diagram of the conversation controller 1000-1 and also a block diagram showing a concrete configuration example of the conversation control unit 1300-1 and the sentence analyzing unit 1400-1. Note that only the conversation control unit 1300-1, the sentence analyzing unit 1400-1 and the conversation database 1500-1 are shown in FIG. 58 and the other components are omitted to be shown.

The sentence analyzing unit 1400-1 analyses a character string specified at the input unit 1100-1 or the speech recognition unit 1200-1. In the present embodiment as shown in FIG. 58, the sentence analyzing unit 1400-1 includes a character string specifying unit 1410-1, a morpheme extracting unit 1420-1, a morpheme database 1430-1, an input type determining unit 1440-1 and an utterance type database 1450-1. The character string specifying unit 1410-1 segments a series of character strings specified by the input unit 1100-1 or the speech recognition unit 1200-1 into segments. Each segment is a minimum segmented sentence which is segmented in the extent to keep a grammatical meaning. Specifically, if the series of the character strings have a time interval more than a certain interval, the character string specifying unit 1410-1 segments the character strings there. The character string specifying unit 1410-1 outputs the segmented character strings to the morpheme extracting unit 1420-1 and the input type determining unit 1440-1. Note that a “character string” to be described below means one segmented character string.

### [Morpheme Extracting Unit]

The morpheme extracting unit 1420-1 extracts morphemes constituting minimum units of the character string as first morpheme information from each of the segmented character strings based on each of the segmented character strings segmented by the character string specifying unit 1410-1. In the present embodiment, a morpheme means a minimum unit of a word structure shown in a character string. For example, each minimum unit of a word structure may be a word class such as a noun, an adjective and a verb.

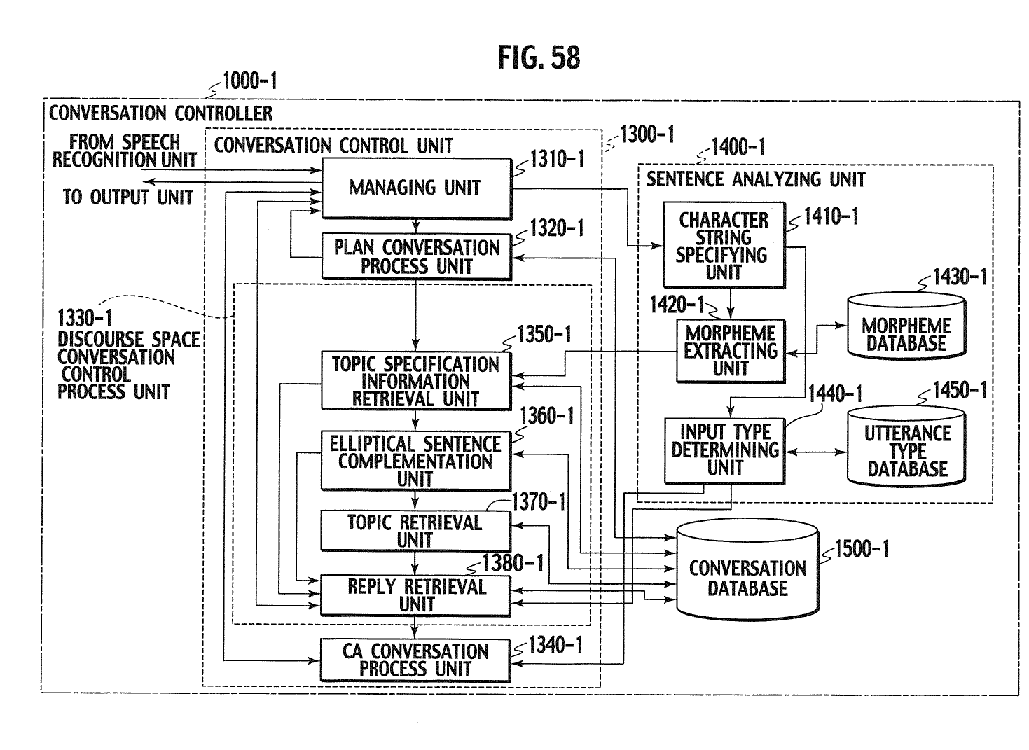

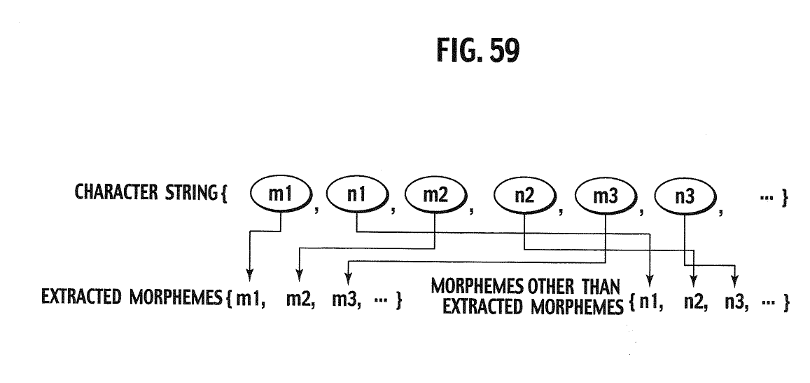

In the present embodiment as shown in FIG. 59, the morphemes are indicated as m1, m2, m3, . . . . FIG. 59. is a diagram showing a relation between a character string and morphemes extracted from the character string. The morpheme extracting unit 1420-1, which has received the character strings from the character string specifying unit 1410-1, compares the received character strings and morpheme groups previously stored in the morpheme database 1430-1 (each of the morpheme group is prepared as a morpheme dictionary in which a direction word, a reading, a word class and infected forms are described for each morpheme belonging to each word-class classification) as shown in FIG. 59. The morpheme extracting unit 1420-1, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420-1 outputs the extracted morphemes to a topic specification information retrieval unit 1350-1 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

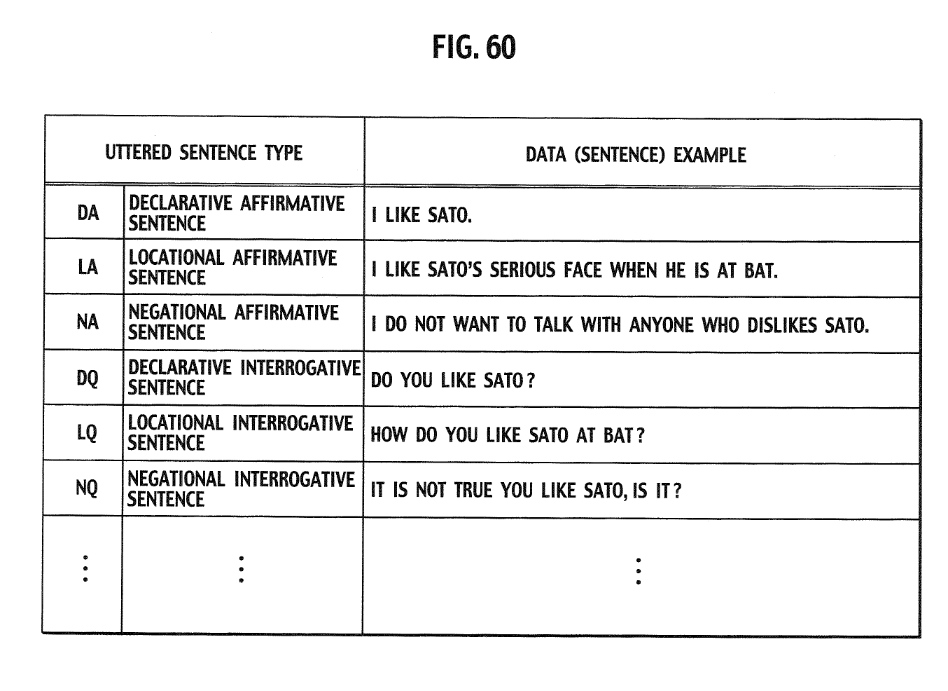

The input type determining unit 1440-1 determines an uttered contents type (utterance type) based on the character strings specified by the character string specifying unit 1410-1. In the present embodiment, the utterance type is information for specifying the uttered contents type and, for example, corresponds to “uttered sentence type” shown in FIG. 60. FIG. 60 is a table showing the “uttered sentence types”, two-alphabet codes representing the uttered sentence types, and uttered sentence examples corresponding to the uttered sentence types.

Here in the present embodiment as shown in FIG. 60, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 60. A “locational sentence” means a sentence involving a location concept. A “time sentence” means a sentence involving a time concept. A “negational sentence” means a sentence to deny a declarative sentence. Sentence examples of the “uttered sentence types” are shown in FIG. 60.

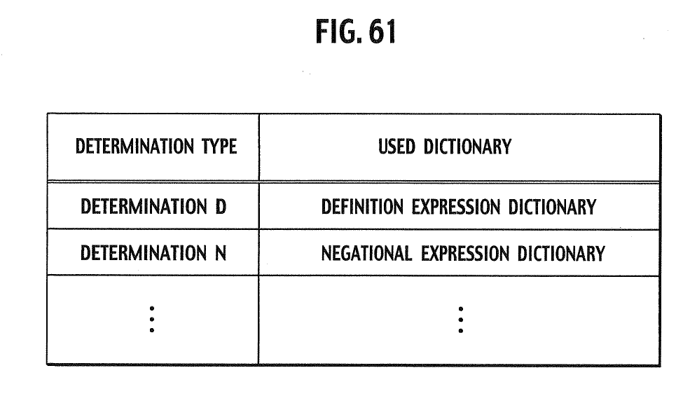

In the present embodiment as shown in FIG. 61, the input type determining unit 1440-1 uses a declarative expression dictionary for determination of a declarative sentence, a negational expression dictionary for determination of a negational sentence and so on in order to determine the “uttered sentence type”. Specifically, the input type determining unit 1440-1, which has received the character strings from the character string specifying unit 1410-1, compares the received character strings and the dictionaries stored in the utterance type database 1450-1 based on the received character string. The input type determining unit 1440-1, which has executed the comparison, extracts elements relevant to the dictionaries among the character strings.

The input type determining unit 1440-1 determines the “uttered sentence type” based on the extracted elements. For example, if the character string includes elements declaring an event, the input type determining unit 1440-1 determines that the character string including the elements is a declarative sentence. The input type determining unit 1440-1 outputs the determined “uttered sentence type” to a reply retrieval unit 1380-1.

### [Conversation Database]

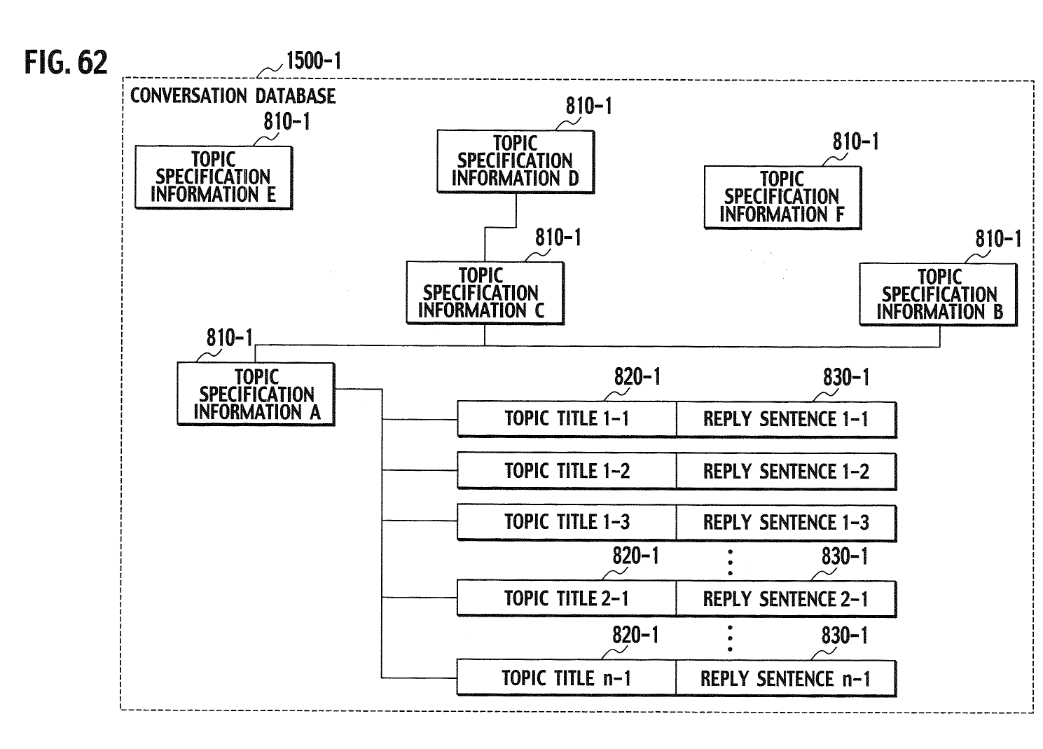

A configuration example of data structure stored in the conversation database 1500-1 will be described with reference to FIG. 62. FIG. 62 is a conceptual diagram showing the configuration example of data stored in the conversation database 1500-1.

As shown in FIG. 62, the conversation database 1500-1 stores a plurality of topic specification information 810-1 for specifying a conversation topic. In addition, topic specification information 810-1 can be associated with other topic specification information 810-1. For example, if topic specification information C (810-1) is specified, three of topic specification information A (810-1), B (810-1) and D (810-1) associated with the topic specification information C (810-1) are also specified.

Specifically in the present embodiment, topic specification information 810-1 means “keywords” which are relevant to input contents expected to be input from users or relevant to reply sentences to users.

The topic specification information 810-1 is associated with one or more topic titles 820-1. Each of the topic titles 820-1 is configured with a morpheme composed of one character, plural character strings or a combination thereof. A reply sentence 830-1 to be output to users is stored in association with each of the topic titles 820-1. Response types indicate types of the reply sentences 830-1 and are associated with the reply sentences 830-1, respectively.

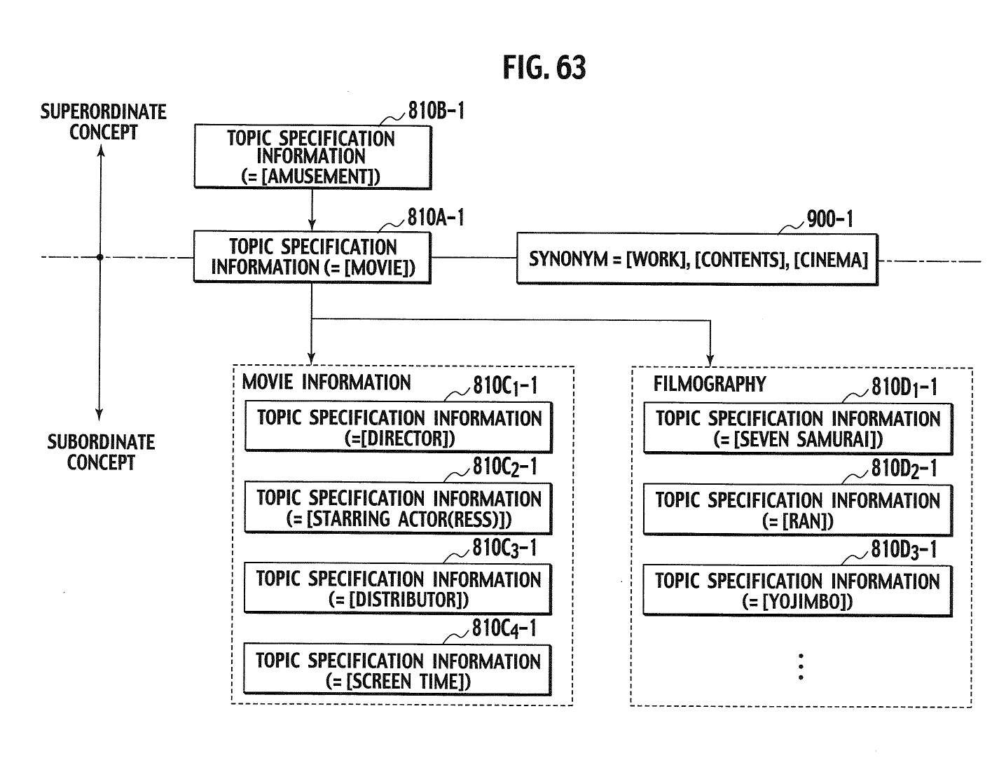

Next, an association between the topic specification information 810-1 and the other topic specification information 810-1 will be described. FIG. 63 is a diagram showing the association between certain topic specification information 810A-1 and the other topic specification information 810B-1, 810C₁-1-810C₄-1 and 810D₁-1-810D₃-1 . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 63, the topic specification information can be stored in association with the other topic specification information with respect to a superordinate concept, a subordinate concept, a synonym or an antonym (not shown in FIG. 63). For example as shown in FIG. 63, the topic specification information 810B-1 (amusement) is stored in association with the topic specification information 810A-1 (movie) as a superordinate concept and stored in a higher level than the topic specification information 810B-1 (amusement).

In addition, subordinate concepts of the topic specification information 810A-1 (movie), the topic specification information 810C₁-1 (director), 810C₂-1 (starring actor[ress]), 810C₃-1 (distributor), 810C₄-1 (screen time), 810D₁-1 (“Seven Samurai”), 810D₂-1 (“Ran”), 810D₃-1 (“Yojimbo”), . . . , are stored in association with the topic specification information 810A-1.

In addition, synonyms 900-1 are associated with the topic specification information 810A-1. In this example, “work”, “contents” and “cinema” are stored as synonyms of “movie” which is a keyword of the topic specification information 810A-1. By defining these synonyms in this manner, the topic specification information 810A-1 can be treated as included in an uttered sentence even though the uttered sentence doesn't include the keyword “movie” but includes “work”, “contents” or “cinema”.

In the conversation controller 1000-1 according to the present embodiment, when certain topic specification information 810-1 has been specified with reference to contents stored in the conversation database 1500-1, other topic specification information 810-1 and the topic titles 820-1 or the reply sentences 830-1 of the other topic specification information 810-1, which are stored in association with the certain topic specification information 810-1, can be retrieved and extracted rapidly.

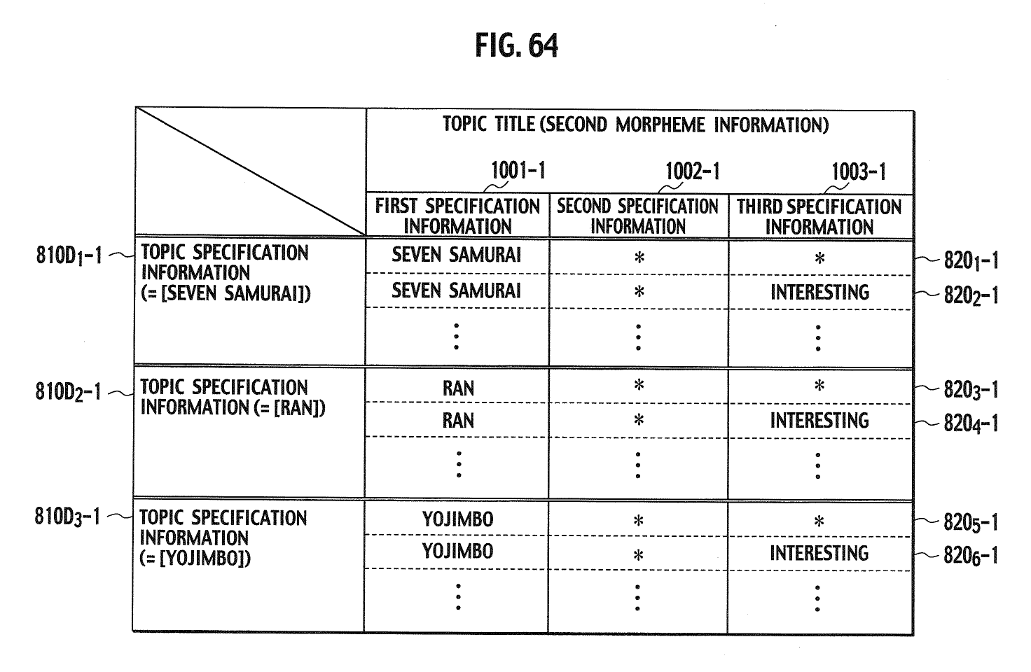

Next, data configuration examples of topic titles 820-1 (also referred as “second morpheme information”) will be described with reference to FIG. 64. FIG. 64 is a diagram showing the data configuration examples of the topic titles 820-1.

The topic specification information 810D₁-1, 810D₂-1, 810D₃-1, . . . , include the topic titles 820₁-1, 820₂-1, . . . , the topic titles 820₃-1, 820₄-1, . . . , the topic titles 820₅-1, 820₆-1, . . . , respectively. In the present embodiment as shown in FIG. 64, each of the topic titles 820-1 is information composed of first specification information 1001-1, second specification information 1002-1 and third specification information 1003-1. Here, the first specification information 1001-1 is a main morpheme constituting a topic. For example, the first specification information 1001-1 may be a Subject of a sentence. In addition, the second specification information 1002-1 is a morpheme closely relevant to the first specification information 1001-1. For example, the second specification information 1002-1 may be an Object. Furthermore, the third specification information 1003-1 in the present embodiment is a morpheme showing a movement of a certain subject, a morpheme of a noun modifier and so on. For example, the third specification information 1003-1 may be a verb, an adverb or an adjective. Note that the first specification information 1001-1, the second specification information 1002-1 and the third specification information 1003-1 are not limited to the above meanings. The present embodiment can be effected in case where contents of a sentence can be understood based on the first specification information 1001-1, the second specification information 1002-1 and the third specification information 1003-1 even though they are give other meanings (other ward classes).

For example as shown in FIG. 64, if the Subject is “Seven Samurai” and the adjective is “interesting”, the topic title 820₂-1 (second morpheme information) consists of the morpheme “Seven Samurai” included in the first specification information 1001-1 and the morpheme “interesting” included in the third specification information 1003-1. Note that the second specification information 1002-1 of this topic title 820₂-1 includes no morpheme and a symbol “*” is stored in the second specification information 1002-1 for indicating no morpheme included.

Note that this topic title 820₂-1 (Seven Samurai; *; interesting) has the meaning of “Seven Samurai is interesting.” Hereinafter, parenthetic contents for a topic title 820₂-1 indicate the specification information 1001-1, the second specification information 1002-1 and the third specification information 1003-1 from the left. In addition, when no morpheme is included in any of the first to third specification information, “*” is indicated therein.

Note that the specification information constituting the topic titles 820-1 is not limited to three and other specification information (fourth specification information and more) may be included.

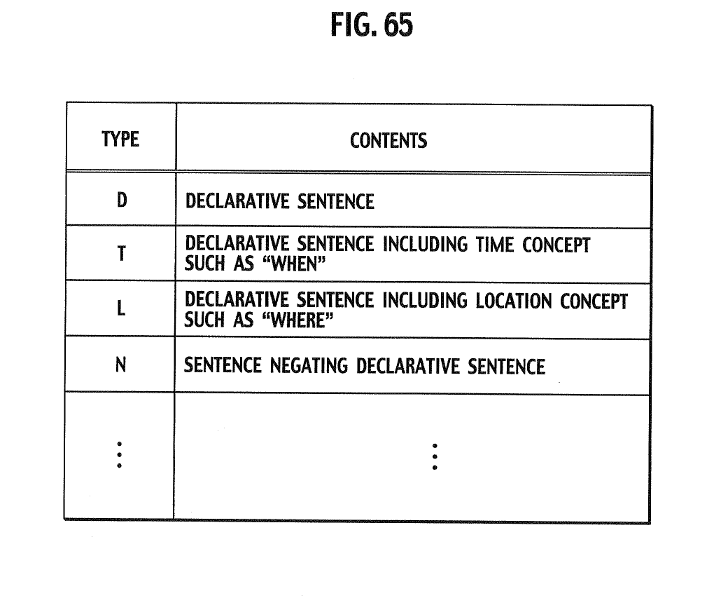

The reply sentences 830-1 will be described with reference to FIG. 65. In the present embodiment as shown in FIG. 65, the reply sentences 830-1 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

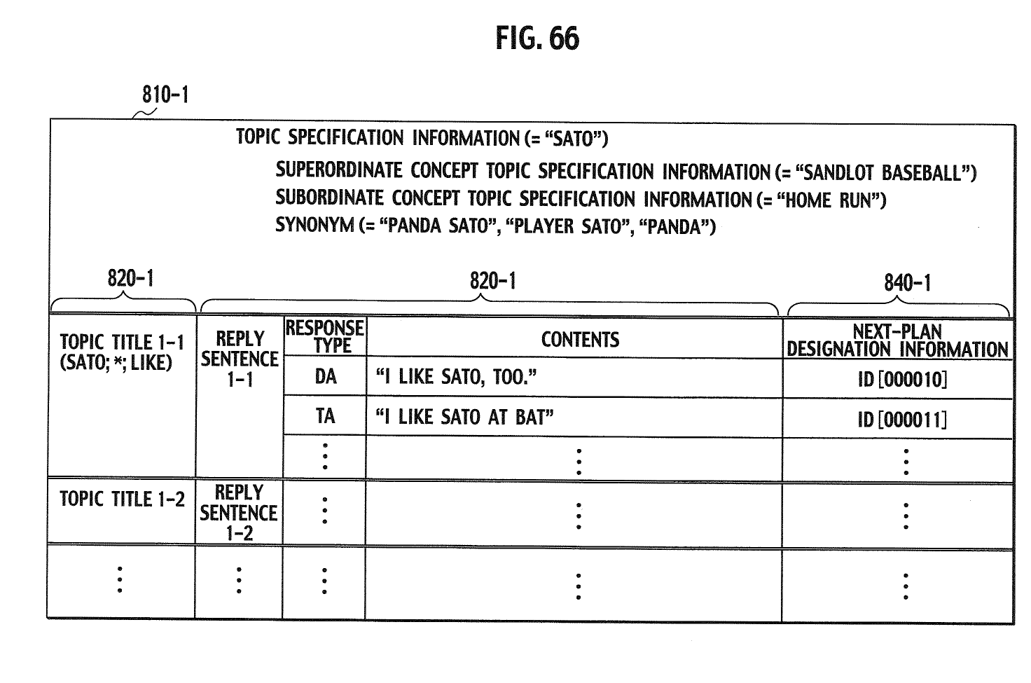

A configuration example of data structure of the topic specification information 810-1 will be described with reference to FIG. 66. FIG. 66 shows a concrete example of the topic titles 820-1 and the reply sentences 830-1 associated with the topic specification information 810-1 “Sato”.

The topic specification information 810-1 “Sato” is associated with plural topic titles (820-1) 1-1, 1-2, . . . . Each of the topic titles (820-1) 1-1, 1-2, . . . is associated with reply sentences (830-1) 1-1, 1-2, . . . . The reply sentence 830-1 is prepared per each of the response types 840-1.

For example, when the topic title (820-1) 1-1 is (Sato; *; like) [these are extracted morphemes included in “I like Sato”], the reply sentences (830-1) 1-1 associated with the topic title (820-1) 1-1 include (DA: a declarative affirmative sentence “I like Sato, too.”) and (TA: a time affirmative sentence “I like Sato at bat.”). The after-mentioned reply retrieval unit 1380-1 retrieves one reply sentence 830-1 associated with the topic title 820-1 with reference to an output from the input type determining unit 1440-1.

Next-plan designation information 840-1 is allocated to each of the reply sentences 830-1. The next-plan designation information 840-1 is information for designating a reply sentence to be preferentially output against a user's utterance in association with the each of the reply sentences (referred as a “next-reply sentence”). The next-plan designation information 840-1 may be any information even if a next-reply sentence can be specified by the information. For example, the information may be a reply sentence ID, by which at least one reply sentence can be specified among all reply sentences stored in the conversation database 1500-1.

In the present embodiment, the next-plan designation information 840-1 is described as information for specifying one next-reply sentence per one reply sentence (for example, a reply sentence ID). However, the next-plan designation information 840-1 may be information for specifying next-reply sentences per topic specification information 810-1 or per one topic title 820-1. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300-1 is further described with referring back to FIG. 58.

The conversation control unit 1300-1 functions to control data transmitting between configuration components in the conversation controller 1000-1 (the speech recognition unit 1200-1, the sentence analyzing unit 1400-1, the conversation database 1500-1, the output unit 1600-1 and the speech recognition dictionary memory 1700-1), and determine and output a reply sentence in response to a user's utterance.

In the present embodiment shown in FIG. 58, the conversation control unit 1300-1 includes a managing unit 1310-1, a plan conversation process unit 1320-1, a discourse space conversation control process unit 1330-1 and a CA conversation process unit 1340-1. Hereinafter, these configuration components will be described.

### [Managing Unit]

The managing unit 1310-1 functions to store discourse histories and update, if needed, the discourse histories. The managing unit 1310-1 further functions to transmit some or entire of the stored discourse histories to a part or a whole of the discourse histories to a topic specification information retrieval unit 1350-1, an elliptical sentence complementation unit 1360-1, a topic retrieval unit 1370-1 or a reply retrieval unit 1380-1 in response to a request therefrom.

### [Plan Conversation Process Unit]

The plan conversation process unit 1320-1 functions to execute plans and establish conversations between a user and the conversation controller 1000-1 according to the plans. A “plan” means providing a predetermined reply to a user in a predetermined order.

The plan conversation process unit 1320-1 functions to output the predetermined reply in the predetermined order in response to a user's utterance.

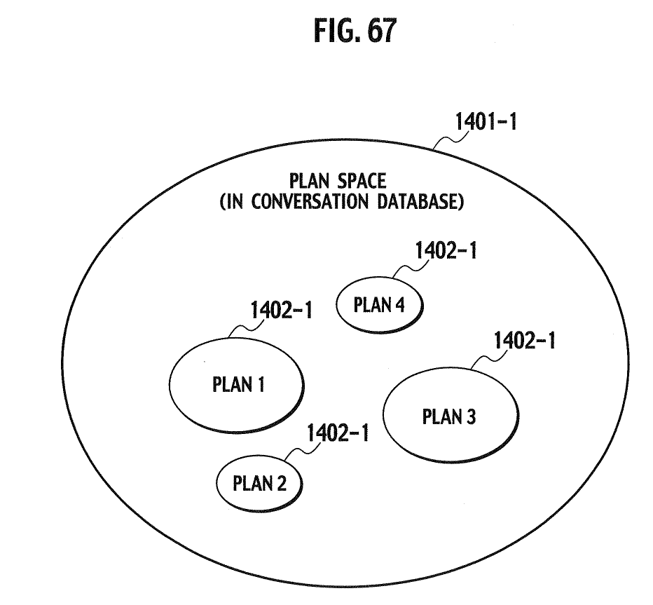

FIG. 67 is a conceptual diagram to describe plans. As shown in FIG. 67, various plans 1402-1 such as plural plans 1, 2, 3 and 4 are prepared in a plan space 1401-1. The plan space 1401-1 is a set of the plural plans 1402-1 stored in the conversation database 1500-1. The conversation controller 1000-1 selects a preset plan 1402-1 for a start-up on an activation or a conversation start or arbitrarily selects one of the plans 1402-1 in the plan space 1401-1 in response to a user's utterance contents in order to output a reply sentence against the user's utterance by using the selected plan 1402-1.

FIG. 68 shows a configuration example of plans 1402-1. Each plan 1402-1 includes a reply sentence 1501-1 and next-plan designation information 1502-1 associated therewith. The next-plan designation information 1502-1 is information for specifying, in response to a certain reply sentence 1501-1 in a plan 1402-1, another plan 1402-1 including a reply sentence to be output to a user (referred as a “next-reply candidate sentence”). In this example, the plan 1 includes a reply sentence A (1501-1) to be output at an execution of the plan 1 by the conversation controller 1000-1 and next-plan designation information 1502-1 associated with the reply sentence A (1501-1). The next-plan designation information 1502-1 is information [ID: 002] for specifying a plan 2 including a reply sentence B (1501-1) to be a next-reply candidate sentence to the reply sentence A (1501-1). Similarly, since the reply sentence B (1501-1) is also associated with next-plan designation information 1502-1, another plan 1402-1 [ID: 043] including the next-reply candidate sentence will be designated when the reply sentence B (1501-1) has output. In this manner, plans 1402-1 are chained via next-plan designation information 1502-1 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501-1 included in a plan 1402-1 designated by next-plan designation information 1502-1 is not needed to be output to a user immediately after an output of the user's utterance in response to an output of a previous reply sentence. The reply sentence 1501-1 included in the plan 1402-1 designated by the next-plan designation information 1502-1 may be output after an intervening conversation on a different topic from a topic in the plan between the conversation controller 1000-1 and the user.

Note that the reply sentence 1501-1 shown in FIG. 68 corresponds to a sentence string of one of the reply sentences 830-1 shown in FIG. 66. In addition, the next-plan designation information 1502-1 shown in FIG. 68 corresponds to the next-plan designation information 840-1 shown in FIG. 66.

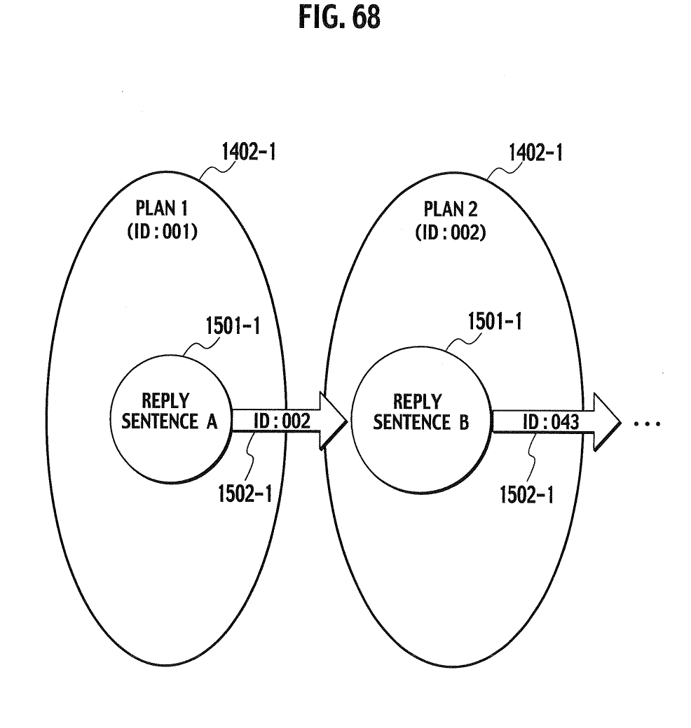

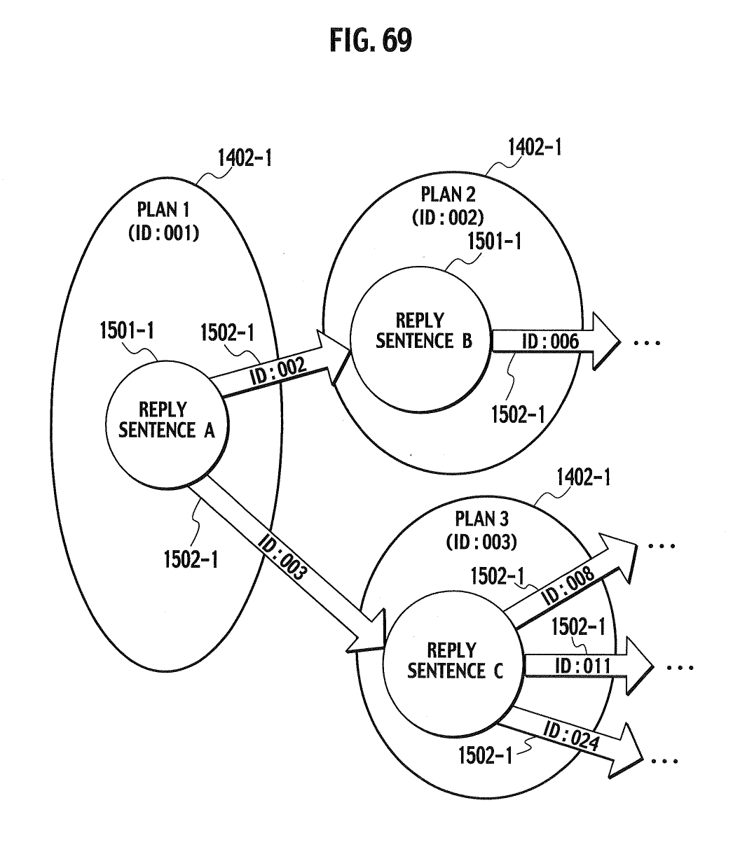

Note that linkages between the plans 1402-1 are not limited to form a one-dimensional geometry shown in FIG. 68. FIG. 69 shows an example of plans 1402-1 with another linkage geometry. In the example shown in FIG. 69, a plan 1 (1402-1) includes two of next-plan designation information 1502-1 to designate two reply sentences as next replay candidate sentences, in other words, to designate two plans 1402-1. The two of next-plan designation information 1502-1 are prepared in order that the plan 2 (1402-1) including a reply sentence B (1501-1) and the plan 3 (1402-1) including a reply sentence C (1501-1) are to be designated as plans each including a next-reply candidate sentence. Note that the reply sentences are selective and alternative, so that, when one has been output, another is not output and then the plan 1 (1501-1) is terminated. In this manner, the linkages between the plans 1402-1 is not limited to forming a one-dimensional geometry and may form a tree-diagram-like geometry or a cancellous geometry.

Note that it is not limited that how many next-reply candidate sentences each plan 1402-1 includes. In addition, no next-plan designation information 1502-1 may be included in a plan 1402-1 which terminates a conversation.

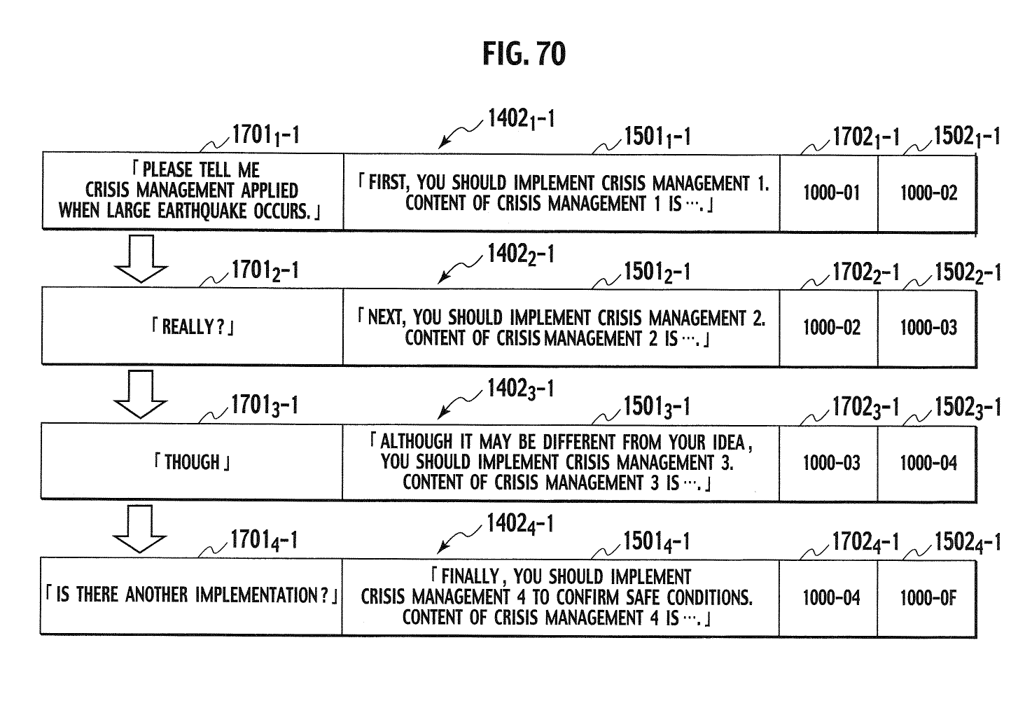

FIG. 70 shows an example of a certain series of plans 1402-1. As shown in FIG. 70, this series of plans 1402₁-1 to 1402₄-1 are associated with reply sentences 1501₁-1 to 1501₄-1 which notify crisis management information to a user. The reply sentences 1501₁-1 to 1501₄-1 constitute one coherent topic as a whole. Each of the plans 1402₁-1 to 1402₄-1 includes ID data 1702₁-1 to 1702₄-1 for indicating itself such as “1000-01, 1000-02”, “1000-03” and “1000-04”, respectively. In addition, each of the plans 1402₁-1 to 1402₄-1 further includes ID data 1502₁-1 to 1502₄-1 as the next-plan designation information such as “1000-02, 1000-03”, “1000-04” and “1000-0F”, respectively. Note that each value after a hyphen in the ID data is information indicating an output order. Especially, “0F” is information indicating the final plan (the last in the order).

In this example, the plan conversation process unit 1320-1 starts to execute this series of plans when a user has uttered 's utterance has been “Please tell me a crisis management applied when a large earthquake occurs.” Specifically, the plan conversation process unit 1320-1 searches in the plan space 1401-1 and checks whether or not a plan 1402-1 including a reply sentence 1501₁-1 associated with the user's utterance “Please tell me a crisis management applied when a large earthquake occurs,” when the plan conversation process unit 1320-1 has received the user's utterance “Please tell me a crisis management applied when a large earthquake occurs.” In this example, a user's utterance character string 1701₁-1 associated with the user's utterance “Please tell me a crisis management applied when a large earthquake occurs,” is associated with a plan 1402₁-1.

The plan conversation process unit 1320-1 retrieves the reply sentence 1501₁-1 included in the plan 1402₁-1 on discovering the plan 1402₁-1 and outputs the reply sentence 1501₁-1 to the user as a reply sentence in response to the user's utterance. And then, the plan conversation process unit 1320-1 specifies the next-reply candidate sentence with reference to the next-plan designation information 1502₁-1.

Next, the plan conversation process unit 1320-1 executes the plan 1402₂-1 on receiving another user's utterance via the input unit 1100-1, a speech recognition unit 1200-1 or the like after an output of the reply sentence 1501₁-1. Specifically, the plan conversation process unit 1320-1 judges whether or not to execute the plan 1402₂-1 designated by the next-plan designation information 1502₁-1, in other words, whether or not to output the second reply sentence 1501₂-1. More specifically, the plan conversation process unit 1320-1 compares a user's utterance character string (also referred as an illustrative sentence) 1701₂-1 associated with the reply sentence 1501₂-1 and the received user's utterance, or compares a topic title 820-1 (not shown in FIG. 70) associated with the reply sentence 1501₂-1 and the received user's utterance. And then, the plan conversation process unit 1320-1 determines whether or not the two are related to each other. If the two are related to each other, the plan conversation process unit 1320-1 outputs the second reply sentence 1501₂-1. In addition, since the plan 1402₂-1 including the second reply sentence 1501₂-1 also includes the next-plan designation information 1502₂-1, the next-reply candidate sentence is specified.

Similarly, according to ongoing user's utterances, the plan conversation process unit 1320-1 transit into the plans 1402₃-1 and 1402₄-1 in turn and can output the third and fourth reply sentences 1501₃-1 and 1501₄-1. Note that, since the fourth reply sentence 1501₄-1 is the final reply sentence, the plan conversation process unit 1320-1 terminates plan-executions when the fourth reply sentence 1501₄-1 has been output.

In this manner, the plan conversation process unit 1320-1 can provide previously prepared conversation contents to the user in a predetermined order by sequentially executing the plans 1402₁-1 to 1402₄-1.

### [Discourse Space Conversation Control Process Unit]

The configuration example of the conversation control unit 1300-1 is further described with referring back to FIG. 58.

The discourse space conversation control process unit 1330-1 includes the topic specification information retrieval unit 1350-1, the elliptical sentence complementation unit 1360-1, the topic retrieval unit 1370-1 and the reply retrieval unit 1380-1. The managing unit 1310-1 totally controls the conversation control unit 1300-1.

A “discourse history” is information for specifying a conversation topic or theme between a user and the conversation controller 1000-1 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330-1 will be described.

### [Topic Specification Information Retrieval Unit]

The topic specification information retrieval unit 1350-1 compares the first morpheme information extracted by the morpheme extracting unit 1420-1 and the topic specification information, and then retrieves the topic specification information corresponding to a morpheme in the first morpheme information among the topic specification information. Specifically, when the first morpheme information received from the morpheme extracting unit 1420-1 is two morphemes “Sato” and “like”, the topic specification information retrieval unit 1350-1 compares the received first morpheme information and the topic specification information group.

If a focused topic title 820-1focus (indicated as 820-1focus to be differentiated from previously retrieved topic titles or other topic titles) includes a morpheme (for example, “Sato”) in the first morpheme information, the topic specification information retrieval unit 1350-1 outputs the focused topic title 820-1focus to the reply retrieval unit 1380-1. On the other hand, if no focused topic title 820-1focus includes the morpheme in the first morpheme information, the topic specification information retrieval unit 1350-1 determines user input sentence topic specification information based on the received first morpheme information, and then outputs the first morpheme information and the user input sentence topic specification information to the elliptical sentence complementation unit 1360-1. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360-1 generates various complemented first morpheme information by complementing the first morpheme information with the previously retrieved topic specification information 810-1 (hereinafter referred as the “focused topic specification information”) and the topic specification information 810-1 included in the final reply sentence (hereinafter referred as the “reply sentence topic specification information”). For example, if a user's utterance is “like”, the elliptical sentence complementation unit 1360-1 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360-1 generates the complemented first morpheme information by including an element(s) in the set “D” into the first morpheme information “W”.

In this manner, in case where, for example, a sentence constituted with the first morpheme information is an elliptical sentence which is unclear as a language, the elliptical sentence complementation unit 1360-1 can include, by using the set “D”, an element(s) (for example, “Sato”) in the set “D” into the first morpheme information “W”. As a result, the elliptical sentence complementation unit 1360-1 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360-1 can complement the elliptical sentence by using the set “D”. As a result, even when a sentence constituted with the first morpheme information is an elliptical sentence, the elliptical sentence complementation unit 1360-1 can complement the sentence into an appropriate sentence as a language.

In addition, the elliptical sentence complementation unit 1360-1 retrieves the topic title 820-1 related to the complemented first morpheme information based on the set “D”. If the topic title 820-1 related to the complemented first morpheme information has been found, the elliptical sentence complementation unit 1360-1 outputs the topic title 820-1 to the reply retrieval unit 1380-1. The reply retrieval unit 1380-1 can output a reply sentence 830-1 best-suited for the user's utterance contents based on the appropriate topic title 820-1 found by the elliptical sentence complementation unit 1360-1.

Note that the elliptical sentence complementation unit 1360-1 is not limited to including an element(s) in the set “D” into the first morpheme information. The elliptical sentence complementation unit 1360-1 may include, based on a focused topic title, a morpheme(s) included in any of the first, second and third specification information in the topic title, into the extracted first morpheme information.

### [Topic Retrieval Unit]

The topic retrieval unit 1370-1 compares the first morpheme information and topic titles 820-1 associated with the user input sentence topic specification information to retrieve a topic title 820-1 best-suited for the first morpheme information among the topic titles 820-1 when the topic title 820-1 has not been determined by the elliptical sentence complementation unit 1360-1.

Specifically, the topic retrieval unit 1370-1, which has received a retrieval command signal from the elliptical sentence complementation unit 1360-1, retrieves the topic title 820-1 best-suited for the first morpheme information among the topic titles associated with the user input sentence topic specification information based on the user input sentence topic specification information and the first morpheme information which are included in the received retrieval command signal. The topic retrieval unit 1370-1 outputs the retrieved topic title 820-1 as a retrieval result signal to the reply retrieval unit 1380-1.

Above-mentioned FIG. 66 shows the concrete example of the topic titles 820-1 and the reply sentences 830-1 associated with the topic specification information 810-1 (=“Sato”). For example as shown in FIG. 66, since topic specification information 810-1 (=“Sato”) is included in the received first morpheme information “Sato, like”, the topic retrieval unit 1370-1 specifies the topic specification information 810-1 (=“Sato”) and then compares the topic titles (820-1) 1-1, 1-2, . . . associated with the topic specification information 810-1 (=“Sato”) and the received first morpheme information “Sato, like”.

The topic retrieval unit 1370-1 retrieves the topic title (820-1) 1-1 (Sato; *; like) related to the received first morpheme information “Sato, like” among the topic titles (820-1) 1-1, 1-2, . . . based on the comparison result. The topic retrieval unit 1370-1 outputs the retrieved topic title (820-1) 1-1 (Sato; *; like) as a retrieval result signal to the reply retrieval unit 1380-1.

### [Reply Retrieval Unit]

The reply retrieval unit 1380-1 retrieves, based on the topic title 820-1 retrieved by the elliptical sentence complementation unit 1360-1 or the topic retrieval unit 1370-1, a reply sentence associated with the topic title 820-1. In addition, the reply retrieval unit 1380-1 compares, based on the topic title 820-1 retrieved by the topic retrieval unit 1370-1, the response types associated with the topic title 820-1 and the utterance type determined by the input type determining unit 1440-1. The reply retrieval unit 1380-1, which has executed the comparison, retrieves one response type related to the determined utterance type among the response types.

In the example shown in FIG. 66, when the topic title retrieved by the topic retrieval unit 1370-1 is the topic title 1-1 (Sato; *; like), the reply retrieval unit 1380-1 specifies the response type (for example, DA) coincident with the “uttered sentence type” (DA) determined by the input type determining unit 1440-1 among the reply sentences 1-1 (DA, TA and so on) associated with the topic title 1-1. The reply retrieval unit 1380-1, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380-1 outputs the retrieved reply sentence 830-1 as a reply sentence signal to the managing unit 1310-1. The managing unit 1310-1, which has received the reply sentence signal from the reply retrieval unit 1380-1, outputs the received reply sentence signal to the output unit 1600-1.

### [CA Conversation Process Unit]

When a reply sentence in response to a user's utterance has not been determined by the plan conversation process unit 1320-1 or the discourse space conversation control process unit 1330-1, the CA conversation process unit 1340-1 functions to output a reply sentence for continuing a conversation with a user according to contents of the user's utterance.

The configuration example of the conversation controller 1000-1 is further described with referring back to FIG. 54.

### [Output Unit]

The output unit 1600-1 outputs the reply sentence retrieved by the reply retrieval unit 1380-1. The output unit 1600-1 may be a speaker or a display, for example. Specifically, the output unit 1600-1, which has received the reply sentence from the reply retrieval unit 1380-1, outputs voice sounds of the received reply sentence (for example, “I like Sato, too,”) based on the received reply sentence. With that, describing the configuration example of the conversation controller 1000-1 has ended.

### [Conversation Control Method]

The conversation controller 100-1 with the above-mentioned configuration puts a conversation control method in execution by operating as described hereinbelow.

Next, operations of the conversation controller 1000-1, more specifically the conversation control unit 1300-1, according to the present embodiment will be described.

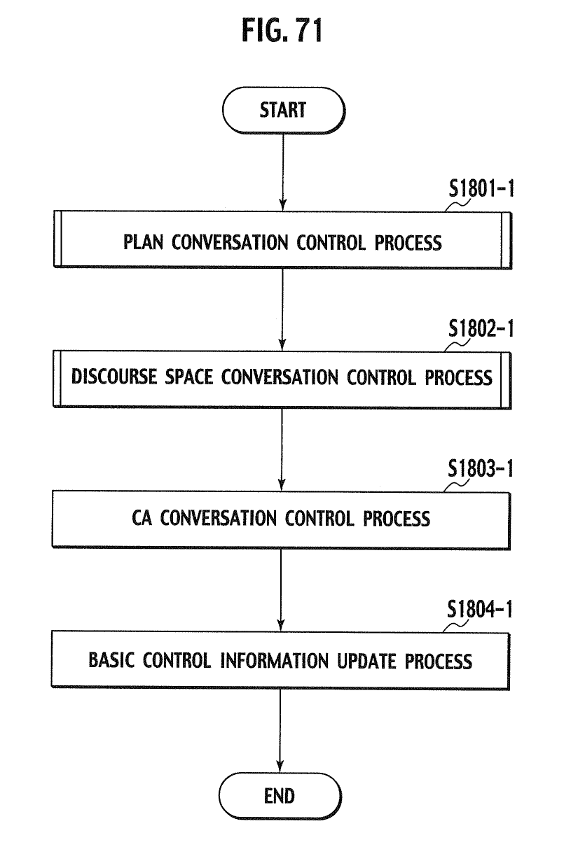

FIG. 71 is a flow-chart showing an example of a main process executed by conversation control unit 1300-1. This main process is a process executed each time when the conversation control unit 1300-1 receives a user's utterance. A reply sentence in response to the user's utterance is output due to an execution of this main process, so that a conversation (an interlocution) between a user and the conversation controller 100-1 is established.

Upon executing the main process, the conversation controller 100-1, more specifically the plan conversation process unit 1320-1 firstly executes a plan conversation control process (S1801-1). The plan conversation control process is a process for executing a plan(s).

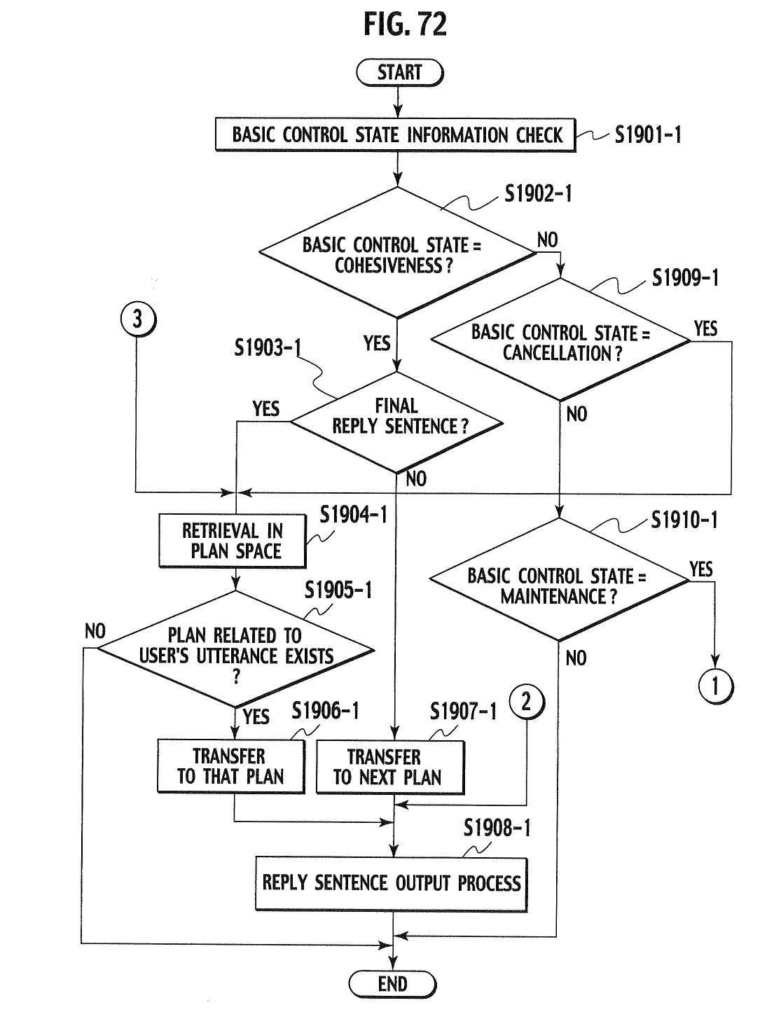

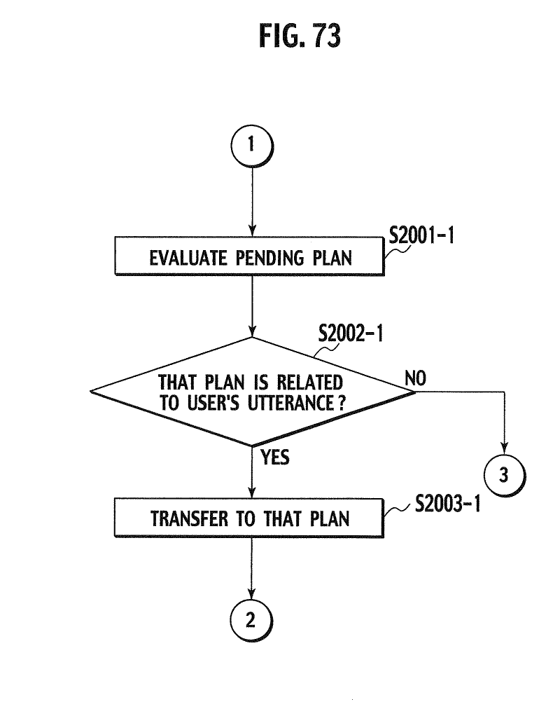

FIGS. 72 and 73 are flow-charts showing an example of the plan conversation control process. Hereinbelow, the example of the plan conversation control process will be described with reference to FIGS. 72 and 73.

Upon executing the plan conversation control process, the plan conversation process unit 1320-1 firstly executes a basic control state information check (S1901-1). The basic control state information is information on whether or not an execution(s) of a plan(s) has been completed and is stored in a predetermined memory area.

The basic control state information serves to indicate a basic control state of a plan.

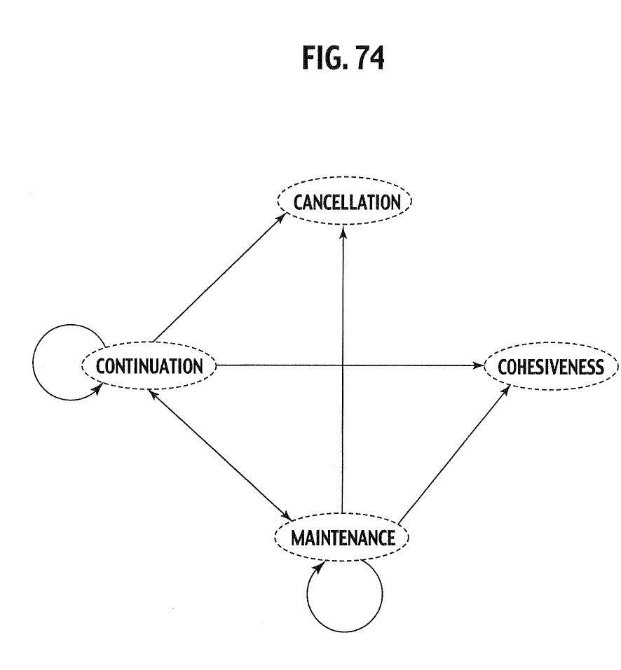

FIG. 74 is a diagram showing four basic control states which are possibly established due to a so-called scenario-type plan.

### (1) Cohesiveness

This basic control state corresponds to a case where a user's utterance is coincident with the currently executed plan 1402-1, more specifically the topic title 820-1 or the example sentence 1701-1 associated with the plan 1402-1. In this case, the plan conversation process unit 1320-1 terminates the plan 1402-1 and then transfers to another plan 1402-1 corresponding to the reply sentence 1501-1 designated by the next-plan designation information 1502-1.

### (2) Cancellation

This basic control state is a basic control state which is set in a case where it is determined that user's utterance contents require a completion of a plan 1402-1 or that a user's interest has changed to another matter than the currently executed plan. When the basic control state indicates the cancellation, the plan conversation process unit 1320-1 retrieves another plan 1402-1 associated with the user's utterance than the plan 1402-1 targeted as the cancellation. If the other plan 1402-1 exists, the plan conversation process unit 1320-1 start to execute the other plan 1402-1. If the other plan 1402-1 does not exist, the plan conversation process unit 1320-1 terminates a execution(s) of a plan(s).

### (3) Maintenance

This basic control state is a basic control state which is set in a case where a user's utterance is not coincident with the topic title 820-1 (see FIG. 66) or the example sentence 1701-1 (see FIG. 70) associated with the currently executed plan 1402-1 and also the user's utterance does not correspond to the basic control state “cancellation”.

In the case of this basic control state, the plan conversation process unit 1320-1 firstly determines whether or not to resume a pending or pausing plan 1402-1 on receiving the user's utterance. If the user's utterance is not adapted for resuming the plan 1402-1, for example, in case where the user's utterance is not related to a topic title 820-1 or an example sentence 1701-1 associated with the plan 1402-1, the plan conversation process unit 1320-1 starts to execute another plan 1402-1, an after-mentioned discourse space conversation control process (S1802-1) and so on. If the user's utterance is adapted for resuming the plan 1402-1, the plan conversation process unit 1320-1 outputs a reply sentence 1501-1 based on the stored next-plan designation information 1502-1.

In case where the basic control state is the “maintenance”, the plan conversation process unit 1320-1 retrieves other plans 1402-1 in order to enable outputting another reply sentence than the reply sentence 1501-1 associated with the currently executed plan 1402-1, or executes the discourse space conversation control process. However, if the user's utterance is adapted for resuming the plan 1402-1, the plan conversation process unit 1320-1 resumes the plan 1402-1.

### (4) Continuation

This state is a basic control state which is set in a case where a user's utterance is not related to reply sentences 1501-1 included in the currently executed plan 1402-1, contents of the user's utterance do not correspond to the basic control sate “cancellation” and use's intention construed from the user's utterance is not clear.

In case where the basic control state is the “continuation”, the plan conversation process unit 1320-1 firstly determines whether or not to resume a pending or pausing plan 1402-1 on receiving the user's utterance. If the user's utterance is not adapted for resuming the plan 1402-1, the plan conversation process unit 1320-1 executes an after-mentioned CA conversation control process in order to enable outputting a reply sentence for getting out a further user's utterance.

The plan conversation control process is further described with referring back to FIG. 72.

The plan conversation process unit 1320-1, which has referred to the basic control state, determines whether or not the basic control state indicated by the basic control state information is the “cohesiveness” (step S1902-1). If it has been determined that the basic control state is the “cohesiveness” (YES in step S1902-1), the plan conversation process unit 1320-1 determines whether or not the reply sentence 1501-1 is the final reply sentence in the currently executed plan 1402-1 (step S1903-1).

If it has been determined that the final reply sentence 1501-1 has been output already (YES in step S1903-1), the plan conversation process unit 1320-1 retrieves another plan 1402-1 related to the use's utterance in the plan space in order to determine whether or not to execute the other plan 1402-1 (step S1904-1) because the plan conversation process unit 1320-1 has provided all contents to be replied to the user already. If the other plan 1402-1 related to the user's utterance has not been found due to this retrieval (NO in step S1905-1), the plan conversation process unit 1320-1 terminates the plan conversation control process because no plan 1402-1 to be provided to the user exists.

On the other hand, if the other plan 1402-1 related to the user's utterance has been found due to this retrieval (YES in step S1905-1), the plan conversation process unit 1320-1 transfers into the other plan 1402-1 (step S1906-1). Since the other plan 1402-1 to be provided to the user still remains, an execution of the other plan 1402-1 (an output of the reply sentence 1501-1 included in the other plan 1402-1) is started.

Next, the plan conversation process unit 1320-1 outputs the reply sentence 1501-1 included in that plan 1402-1 (step S1908-1). The reply sentence 1501-1 is output as a reply to the user's utterance, so that the plan conversation process unit 1320-1 provides information to be supplied to the user.

The plan conversation process unit 1320-1 terminates the plan conversation control process after the reply sentence output process (step S1908-1).

On the other hand, if the previously output reply sentence 1501-1 is not determined as the final reply sentence in the determination whether or not the previously output reply sentence 1501-1 is the final reply sentence (step S1903-1), the plan conversation process unit 1320-1 transfers into a plan 1402-1 associated with the reply sentence 1501-1 following the previously output reply sentence 1501-1, i.e. the specified reply sentence 1501-1 by the next-plan designation information 1502-1 (step S1907-1).

Subsequently, the plan conversation process unit 1320-1 outputs the reply sentence 1501-1 included in that plan 1402-1 to provide a reply to the user's utterance (step 1908-1). The reply sentence 1501-1 is output as the reply to the user's utterance, so that the plan conversation process unit 1320-1 provides information to be supplied to the user. The plan conversation process unit 1320-1 terminates the plan conversation control process after the reply sentence output process (step S1908-1).

Here, if the basic control state is not the “cohesiveness” in the determination process in step S1902-1 (NO in step S1902-1), the plan conversation process unit 1320-1 determines whether or not the basic control state indicated by the basic control state information is the “cancellation” (step S1909-1). If it has been determined that the basic control state is the “cancellation” (YES in step S1909-1), the plan conversation process unit 1320-1 retrieves another plan 1402-1 related to the use's utterance in the plan space 1401-1 in order to determine whether or not the other plan 1402-1 to be started newly exists (step S1904-1) because a plan 1402-1 to be successively executed does not exist. Subsequently, the plan conversation process unit 1320-1 executes the processes of steps S1905-1 to S1908-1 as well as the processes in case of the above-mentioned step S1903-1 (YES).

On the other hand, if the basic control state is not the “cancellation” in the determination process in step S1902-1 (NO in step S1902-1) in the determination whether or not the basic control state indicated by the basic control state information is the “cancellation” (step S1909-1), the plan conversation process unit 1320-1 further determines whether or not the basic control state indicated by the basic control state information is the “maintenance” (step S1910-1).

If the basic control state indicated by the basic control state information is the “maintenance” (YES in step S1910-1), the plan conversation process unit 1320-1 determined whether or not the user presents the interest on the pending or pausing plan 1402-1 again and then resumes the pending or pausing plan 1402-1 in case where the interest is presented (step S2001-1 in FIG. 73). In other words, the plan conversation process unit 1320-1 evaluates the pending or pausing plan 1402-1 (step S2001-1 in FIG. 73) and then determines whether or not the user's utterance is related to the pending or pausing plan 1402-1 (step S2002-1).

If it has been determined that the user's utterance is related to that plan 1402-1 (YES in step S2002-1), the plan conversation process unit 1320-1 transfers into the plan 1402-1 related to the user's utterance (step S2003-1) and then executes the reply sentence output process (step S1908-1 in FIG. 72) to output the reply sentence 1501-1 included in the plan 1402-1. Operating in this manner, the plan conversation process unit 1320-1 can resume the pending or pausing plan 1402-1 according to the user's utterance, so that all contents included in the previously prepared plan 1402-1 can be provided to the user.

On the other hand, if it has been determined that the user's utterance is not related to that plan 1402-1 (NO in step S2002-1) in the above-mentioned S2002-1 (see FIG. 73), the plan conversation process unit 1320-1 retrieves another plan 1402-1 related to the use's utterance in the plan space 1401-1 in order to determine whether or not the other plan 1402-1 to be started newly exists (step S1904-1 in FIG. 72). Subsequently, the plan conversation process unit 1320-1 executes the processes of steps S1905-1 to S1908-1 as well as the processes in case of the above-mentioned step S1903-1 (YES).

If it is determined that the basic control state indicated by the basic control state information is not the “maintenance” (NO in step S1910-1) in the determination in step S1910-1, it means that the basic control state indicated by the basic control state information is the “continuation”. In this case, the plan conversation process unit 1320-1 terminates the plan conversation control process without outputting a reply sentence. With that, describing the plan control process has ended.

The main process is further described with referring back to FIG. 71.

The conversation control unit 1300-1 executes the discourse space conversation control process (step S1802-1) after the plan conversation control process (step S1801-1) has been completed. Note that, if the reply sentence has been output in the plan conversation control process (step S1801-1), the conversation control unit 1300-1 executes a basic control information update process (step S1804-1) without executing the discourse space conversation control process (step S1802-1) and the after-mentioned CA conversation control process (step S1803-1) and then terminates the main process.

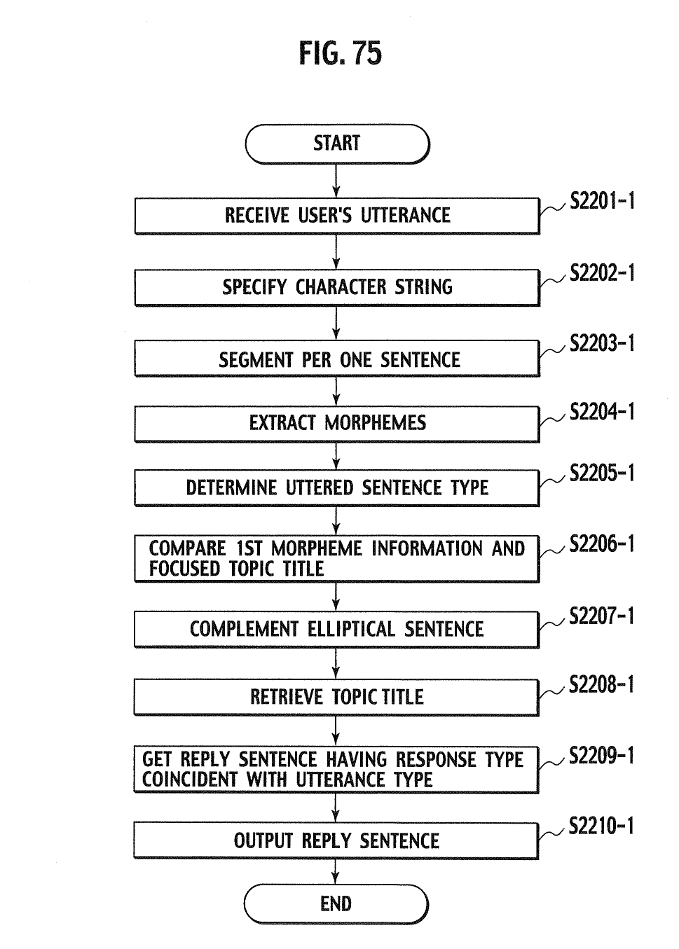

FIG. 75 is a flow-chart showing an example of a discourse space conversation control process according to the present embodiment.

The input unit 1100-1 firstly executes a step for receiving a user's utterance (step S2201-1). Specifically, the input unit 1100-1 receives voice sounds of the user's utterance. The input unit 1100-1 outputs the received voice sounds to the speech recognition unit 1200-1 as a voice signal. Note that the input unit 1100-1 may receive a character string input by a user (for example, text data input in a text format) instead of the voice sounds. In this case, the input unit 1100-1 may be a text input device such as a keyboard or a touchscreen.

Next, the speech recognition unit 1200-1 executes a step for specifying a character string corresponding to the uttered contents based on the uttered contents retrieved by the input unit 1100-1 (step S2202-1). Specifically, the speech recognition unit 1200-1, which has received the voice signal from the input unit 1100-1, specifies a word hypothesis (candidate) corresponding to the voice signal based on the received voice signal. The speech recognition unit 1200-1 retrieves a character string corresponding to the specified word hypothesis and outputs the retrieved character string to the conversation control unit 1300-1, more specifically the discourse space conversation control process unit 1330-1, as a character string signal.

And then, the character string specifying unit 1410-1 segments a series of the character strings specified by the speech recognition unit 1200-1 into segments (step S2203-1). Specifically, if the series of the character strings have a time interval more than a certain interval, the character string specifying unit 1410-1, which has received the character string signal or a morpheme signal from the managing unit 1310-1, segments the character strings there. The character string specifying unit 1410-1 outputs the segmented character strings to the morpheme extracting unit 1420-1 and the input type determining unit 1440-1. Note that it is preferred that the character string specifying unit 1410-1 segments a character string at a punctuation, a space and so on in a case where the character string has been input from a keyboard.

Subsequently, the morpheme extracting unit 1420-1 executes a step for extracting morphemes constituting minimum units of the character string as first morpheme information based on the character string specified by the character string specifying unit 1410-1 (step S2204-1). Specifically, the morpheme extracting unit 1420-1, which has received the character strings from the character string specifying unit 1410-1, compares the received character strings and morpheme groups previously stored in the morpheme database 1430-1. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420-1, which has executed the comparison, extracts coincident morphemes (m1, m2, . . . ) with the morphemes included in the previously stored morpheme groups from the received character string. The morpheme extracting unit 1420-1 outputs the extracted morphemes to the topic specification information retrieval unit 1350-1 as the first morpheme information.

Next, the input type determining unit 1440-1 executes a step for determining the “uttered sentence type” based on the morphemes which constitute one sentence and are specified by the character string specifying unit 1410-1 (step S2205-1). Specifically, the input type determining unit 1440-1, which has received the character strings from the character string specifying unit 1410-1, compares the received character strings and the dictionaries stored in the utterance type database 1450-1 based on the received character strings and extracts elements relevant to the dictionaries among the character strings. The input type determining unit 1440-1, which has extracted the elements, determines to which “uttered sentence type” the extracted element(s) belongs based on the extracted element(s). The input type determining unit 1440-1 outputs the determined “uttered sentence type” (utterance type) to the reply retrieval unit 1380-1.

And then, the topic specification information retrieval unit 1350-1 executes a step for comparing the first morpheme information extracted by the morpheme extracting unit 1420-1 and the focused topic title 820-1focus (step S2206-1).

If a morpheme in the first morpheme information is related to the focused topic title 820-1focus, the topic specification information retrieval unit 1350-1 outputs the focused topic title 820-1focus to the reply retrieval unit 1380-1. On the other hand, if no morpheme in the first morpheme information is related to the focused topic title 820-1focus, the topic specification information retrieval unit 1350-1 outputs the received first morpheme information and the user input sentence topic specification information to the elliptical sentence complementation unit 1360-1 as the retrieval command signal.

Subsequently, the elliptical sentence complementation unit 1360-1 executes a step for including the focused topic specification information and the reply sentence topic specification information into the received first morpheme information based on the first morpheme information received from the topic specification information retrieval unit 1350-1 (step S2207-1). Specifically, if it is assumed that the first morpheme information is defined as “W” and a set of the focused topic specification information and the reply sentence topic specification information is defined as “D”, the elliptical sentence complementation unit 1360-1 generates the complemented first morpheme information by including an element(s) in the set “D” into the first morpheme information “W” and compares the complemented first morpheme information and all the topic titles 820-1 to retrieve the topic title 820-1 related to the complemented first morpheme information. If the topic title 820-1 related to the complemented first morpheme information has been found, the elliptical sentence complementation unit 1360-1 outputs the topic title 820-1 to the reply retrieval unit 1380-1. On the other hand, if no topic title 820-1 related to the complemented first morpheme information has been found, the elliptical sentence complementation unit 1360-1 outputs the first morpheme information and the user input sentence topic specification information to the topic retrieval unit 1370-1.

Next, the topic retrieval unit 1370-1 executes a step for comparing the first morpheme information and the user input sentence topic specification information and retrieves the topic title 820-1 best-suited for the first morpheme information among the topic titles 820-1 (step S2208-1). Specifically, the topic retrieval unit 1370-1, which has received the retrieval command signal from the elliptical sentence complementation unit 1360-1, retrieves the topic title 820-1 best-suited for the first morpheme information among topic titles 820-1 associated with the user input sentence topic specification information based on the user input sentence topic specification information and the first morpheme information included in the received retrieval command signal. The topic retrieval unit 1370-1 outputs the retrieved topic title 820-1 to the reply retrieval unit 1380-1 as the retrieval result signal.

Next, the reply retrieval unit 1380-1 compares, in order to select the reply sentence 830-1, the user's utterance type determined by the sentence analyzing unit 1400-1 and the response type associated with the retrieved topic title 820-1 based on the retrieved topic title 820-1 by the topic specification information retrieval unit 1350-1, the elliptical sentence complementation unit 1360-1 or the topic retrieval unit 1370-1 (step S2209-1).

The reply sentence 830-1 is selected in particular as explained hereinbelow. Specifically, based on the “topic title” associated with the received retrieval result signal and the received “uttered sentence type”, the reply retrieval unit 1380-1, which has received the retrieval result signal from the topic retrieval unit 1370-1 and the “uttered sentence type” from the input type determining unit 1440-1, specifies one response type coincident with the “uttered sentence type” (for example, DA) among the response types associated with the “topic title”.

Consequently, the reply retrieval unit 1380-1 outputs the reply sentence 830-1 retrieved in step S2209-1 to the output unit 1600-1 via the managing unit 1310-1 (S2210-1). The output unit 1600-1, which has received the reply sentence 830-1 from the managing unit 1310-1, outputs the received reply sentence 830-1.

With that, describing the discourse space conversation control process has ended and the main process is further described with referring back to FIG. 71.

The conversation control unit 1300-1 executes the CA conversation control process (step S1803-1) after the discourse space conversation control process has been completed. Note that, if the reply sentence has been output in the plan conversation control process (step S1801-1) or the discourse space conversation control (S1802-1), the conversation control unit 1300-1 executes the basic control information update process (step S1804-1) without executing the CA conversation control process (step S1803-1) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result.

By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300-1 executes the basic control information update process (step S1804-1). In this process, the conversation control unit 1300-1, more specifically the managing unit 1310-1, sets the basic control information to the “cohesiveness” when the plan conversation process unit 1320-1 has output a reply sentence, sets the basic control information to the “cancellation” when the plan conversation process unit 1320-1 has cancelled an output of a reply sentence, sets the basic control information to the “maintenance” when the discourse space conversation control process unit 1330-1 has output a reply sentence, or sets the basic control information to the “continuation” when the CA conversation process unit 1340-1 has output a reply sentence.

The basic control information set in this basic control information update process is referred in the above-mentioned plan conversation control process (step S1801-1) to be employed for continuation or resumption of a plan.

As described the above, the conversation controller 1000-1 can executes a previously prepared plan(s) or can adequately respond to a topic(s) which is not included in a plan(s) according to a user's utterance by executing the main process each time when receiving the user's utterance.

In the gaming terminal 4-1 of this embodiment, the above-described input unit 1100-1 of the conversation controller 1000-1 can be formed of the display 8-1 (the touch panel 50-1 fitted thereto) and the microphone 15-1. Meanwhile, the output unit 1600-1 can be formed of the display 8-1 and the speaker 10-1. Further, the speech recognition unit 1200-1, the conversation control unit 1300-1, and the character string specifying unit 1410-1, the morpheme extracting unit 1420-1 and the input type determining unit 1440-1 each of which is in the sentence analyzing unit 1400-1 can be formed of the terminal controller 90-1. Meanwhile, both of the morpheme database 1430-1 and the utterance type database 1450-1 in the sentence analyzing unit 1400-1, the conversation database 1500-1, and the speech recognition dictionary memory 1700-1 can be formed of the external memory 99-1.

Moreover, in this embodiment, it is possible to determine the language used in the course of the roulette games through the dialog with the player by using the conversation engine, which utilize the conversation controller 1000-1 achieved in the gaming terminal 4-1 with the above-described configuration.

Accordingly, in order to recognize the type of the language used in the speech message of the player inputted from the microphone 15-1, the speech recognition dictionary memory 1700-1 of the conversation controller 1000-1 formed of the external memory 99-1 includes word dictionaries in several languages. Meanwhile, the morpheme database 1430-1 of the conversation controller 1000-1 formed of the external memory 99-1 includes morpheme groups (morpheme dictionaries) in several languages. Further, the utterance type database 1450-1 of the conversation controller 1000-1 formed of the external memory 99-1 also includes dictionaries for the respective utterance types in several languages.

Meanwhile, in order to output the speech messages from the speaker 10-1 to the player in the language selected by the player and to display the messages on the display 8-1 in the language selected by the player, the conversation database 1500-1 formed by the terminal controller 90-1 also stores data of “sentences” in several languages. The “sentences” includes a message for requesting to input a specific word or a specific sentence (either orally or by means of an operation using the display 8-1) in the language desired to be used in the roulette games, a message for asking the player to confirm that the language used for inputting the specific work or the specific sentence is also used to execute the roulette games.

Here, instead of providing the speech recognition dictionary memory 1700-1, the morpheme database 1430-1, or the utterance type database 1450-1 of the conversation controller 1000-1 with the word dictionaries in multiple languages or storing the “sentence” data in several languages in the conversation database 1500-1, the single gaming terminal 4-1 can be configured to include several conversation controllers 1000-1 of the respective language types supportable by the gaming terminal 4-1.

Operations of the above-mentioned conversation controller 1000-1 in the gaming terminal 4-1 of this embodiment will be described later.

Subsequently, contents of the gaming processes to be respectively executed by the server 13-1, the roulette device 2-1, and the gaming terminal 4-1 of the roulette game machine 1-1 according to this embodiment will be described below.

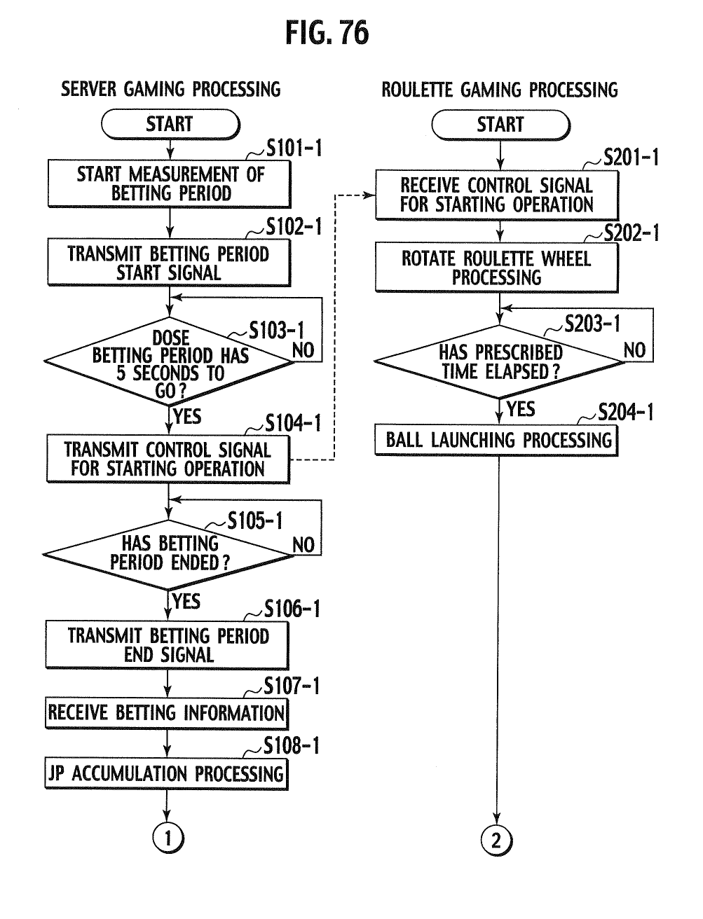

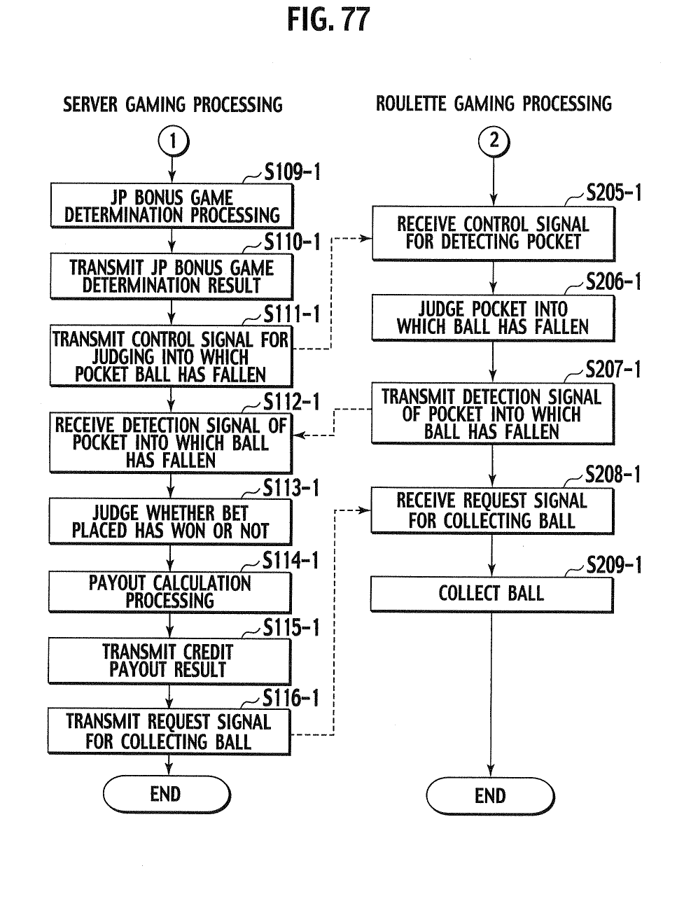

With reference to FIGS. 76 and 77, descriptions will be provided for a server gaming processing and a roulette gaming processing. Here, the server gaming processing is executed by the server CPU 81-1 of the server 13-1 in accordance with programs stored in the ROM 82-1, and the roulette gaming processing is executed by the CPU 101-1 of the roulette device 2-1 in accordance with programs stored in the ROM 102-1. FIGS. 76 and 77 are flow charts showing the gaming processings of the server 13-1 and the roulette device 2-1 in the roulette game machine 1-1 according to the present embodiment.

Firstly, the gaming processing of the server 13-1 will be described referring to FIGS. 76 and 77.

As shown in FIG. 76, the server CPU 81 starts the measurement of the betting period first (step S101-1). The betting period is a period when the bet can be placed. The player participating in the game can place a bet on the bet area 72-1 predicted by himself, by operating the touch panel 50-1 during the betting period. When the measurement of the betting period is started, the server CPU 81 transmits a betting period start signal to the terminal CPU 91-1 (step S102-1).

Next, the server CPU 81-1 judges whether the remaining betting period has become 5-1 seconds or less (step S103-1). The remaining betting period is displayed on the bet time display unit 69-1 of the display 8-1 at each of the gaming terminals 4-1 (see FIG. 50). In the case where it is judged that it has not reached the last 5 seconds, the processing will be returned to the step S103-1. On the other hand, in the case where it is judged that it has reached the last 5 seconds, the processing will move to the step S104-1.

The server CPU 81-1 transmits the control signal for starting the operation of the roulette device 2-1 to the CPU 101-1 (step S104-1). After that, the server CPU 81-1 judges whether the betting period of the roulette game has ended or not (step S105-1). In the case where it is judged that the betting period has not ended, the server CPU 81-1 suspends the processing until the betting period ends. On the other hand, in the case where it is judged that the betting period of the roulette game has ended, the server CPU 81-1 transmits a betting period end signal to the terminal CPU 91-1 (step S106-1).

Subsequently, the server CPU 81-1 receives the betting information (the specified bet area 72-1, the number of bet chips, and the type of betting) at each gaming terminal 4-1 from the terminal CPU 91-1, and stores it into the betting information memory area 83A-1 of the RAM 83-1 (step S107-1).

After that, the server CPU 81-1 executes a JP accumulation processing (step S108-1). In this JP accumulation processing, 0.30% of the total credits which have been bet at all the gaming terminals 4-1 that are received at the step S107-1 are accumulatively added to the JP credits stored in the “MINI” JP accumulated memory area 83C-1 in the RAM 83-1. Moreover, in the JP accumulation processing, 0.20% of the total credits are accumulatively added to the JP credits stored in the “MAJOR” JP credit memory area 83D-1 in the RAM 83-1. In addition, in the JP accumulation processing, 0.15% of the total credits are accumulatively added to the JP credits stored in the “MEGA” JP credit memory area 83E-1 in the RAM 83-1. Furthermore, in the JP accumulation processing, the displays on the JP amount display 15-1, the MEGA counter 73-1, the MAJOR counter 74-1 and the MINI counter 75-1 are updated according to the JP credits thus accumulatively added.

Next, as shown in FIG. 77, the server CPU 81-1 executes a JP bonus game determination processing (step S109-1). In this processing, the server CPU 81-1 determines whether to execute the JP bonus game at each gaming terminal 4-1 or not, by using a random number value sampled by a sampling circuit or the like. In addition, the server CPU 81-1 determines which gaming terminal 4-1 is to win the JP (or all the gaming terminals 4-1 are to lose) in the case where it is determined to execute the JP bonus game. Also, the server CPU 81-1 determines which JP (“MEGA”, “MAJOR” or “MINI”) is to be won in the case of having the JP won.

Next, the server CPU 81-1 transmits the JP bonus game determination result to each gaming terminal 4, according to the processing of the step S109-1 (step S110-1). After that, the server CPU 81-1 transmits a control signal to the CPU 101-1 of the roulette device 2-1, and thereby causes the CPU 101-1 to judge into which number pocket 23-1 the ball 27-1 has fallen (step S111-1). Then, the server CPU 81-1 receives a detection signal of the number pocket 23-1 into which the ball 27-1 has fallen from the CPU 101-1 (step S112-1).

Thereafter, the server CPU 81-1 judges whether the bet placed at each gaming terminal 4-1 has won or not, based on the betting information of each gaming terminal 4-1 received at the step S107-1 and the detection signal of the number pocket 23-1 received at the step S112-1 (step S113-1).

After that, the server CPU 81-1 executes the payout calculation processing (step S114-1). In the payout calculation processing, the server CPU 81-1 firstly recognizes the number of winning bets on the winning number for each gaming terminal 4-1. Then, the server CPU 81-1 calculates the total payout credits for each gaming terminal 4-1 by using the payout rate (credits to be paid per one bet) that is stored in the payout memory area 82A-1 of the ROM 82-1.

Next, the server CPU 81-1 executes the transmission processing of the credit payout result according to the payout calculation processing of the step S113-1 and the JP payout result according to the JP bonus game determination processing of the step S109-1 (step S115-1). More specifically, the server CPU 81-1 outputs the credit data corresponding to the payout credits for the game to the terminal CPU 91-1 of the winning gaming terminal 4-1. Moreover, the server CPU 81-1 additionally outputs the credit data corresponding to the accumulated JP credits in the case where the JP has been won. After that, the server CPU 81-1 transmits a request signal for collecting the ball 27-1 on the roulette wheel 22-1 to the CPU 101-1 of the roulette device 2-1 (step S116-1). The server CPU 81-1 finishes the subroutine after the step S116-1.

Hereinafter, the gaming processing of the roulette device 2-1 will be described with references to FIGS. 76 and 77.

Firstly, as shown in FIG. 76, the CPU 101-1 receives the control signal for starting the operation of the roulette device 2-1 from the server CPU 81-1 of the server 13-1 (step S201-1).

Next, the CPU 101-1 drives the wheel driving motor 106-1 and rotates the roulette wheel 22-1 (step S202-1).

Then, the CPU 101-1 detects the detection signal from the pocket position detection circuit 107-1 when a prescribed time (20 seconds, for example) elapses after the rotation of the roulette wheel 22-1 is started (step S203-1: YES). The CPU 101-1 enters the ball 27-1 (step S204-1) when the delay time elapses after the detection signal is detected.

Then, as shown in FIG. 77, the CPU 101-1 receives the control signal for detecting the pocket from the server CPU 81-1 of the server 13-1 (step S205-1). Thereafter, the CPU 101-1 judges which number pocket 23-1 into which the ball 27-1 has fallen by activating the ball sensor 105-1 (step S206-1). After that, the CPU 101-1 transmits the detection signal indicating the number pocket 23-1 into which the ball 27-1 has fallen to the server CPU 81-1 of the server 13-1 (step S207-1).

Subsequently, the CPU 101-1 receives the request signal for collecting the ball 27-1 from the server CPU 81-1 of the server 13-1 (step S208-1). Then, the CPU 101-1 collects the ball 27-1 on the roulette wheel 22-1 by activating the ball collecting device 108-1 provided beneath the roulette wheel 22 (step S209-1). The collected ball 27 will be entered onto the roulette wheel 22-1 again by the ball launching device 104-1 in the subsequent games. The CPU 101-1 finishes the subroutine after the step S209-1.

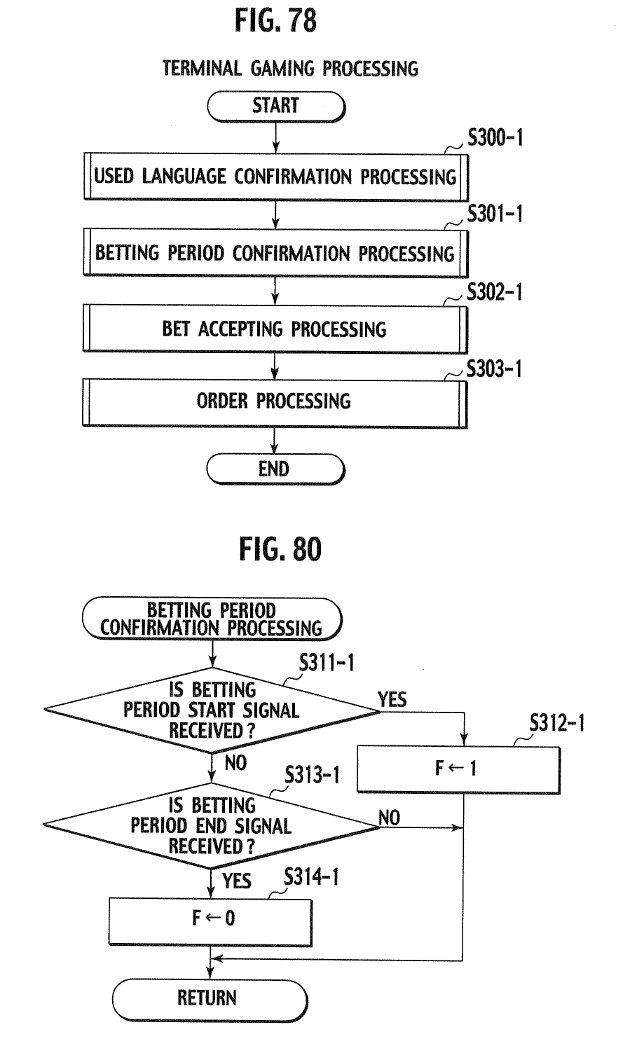

Hereinbelow, the processing executed by the terminal CPU 91-1 of each gaming terminal 4-1 of the roulette game machine 1-1 according to the present embodiment will be described with reference to FIGS. 78 to 83. The terminal CPU 91-1 executes the processing in accordance with the programs stored in the ROM 92-1. FIGS. 78 to 83 are flow charts each showing the gaming processing of the gaming terminal of the roulette game machine according to the present embodiment.

Here, the flag F in the RAM 93-1 is assumed to be set to be default, “1”, which is a value indicating the betting period. Moreover, the default BET screen 61-1 as shown in FIG. 50 is assumed to be displayed on the display 8-1 of the gaming terminal 4-1. With this state, as shown in FIG. 78, the terminal CPU 91-1 firstly performs used language confirmation processing in step S300-1, then performs betting period confirmation processing in step S301-1, then performs bet accepting processing in step S302-1, and lastly performs order processing in step S303-1.

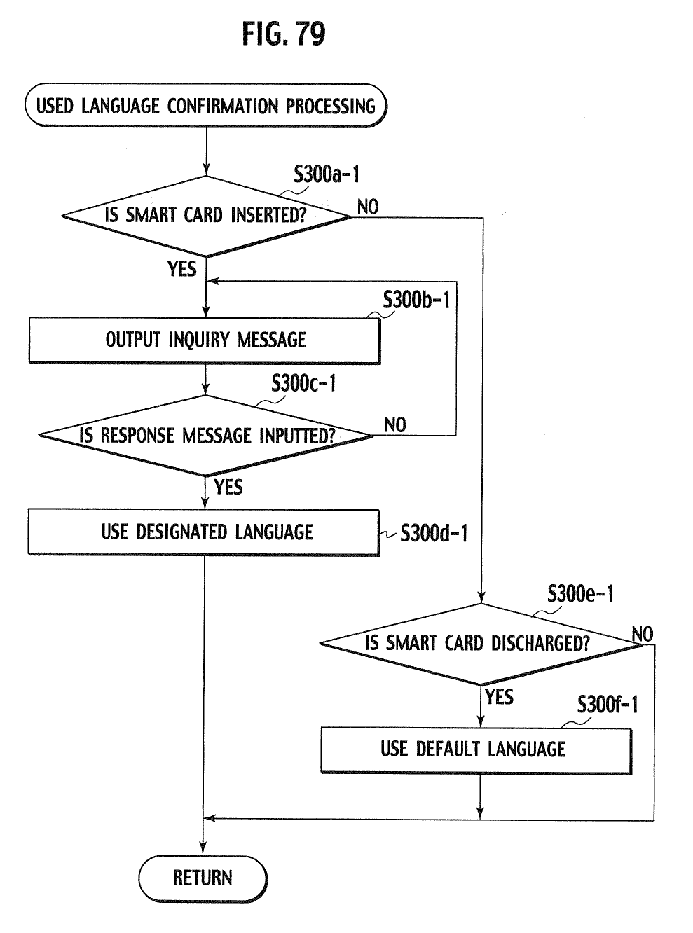

Then, in the used language confirmation processing in step S300-1, the terminal CPU 91-1 judges whether or not the new smart card 17-1 is inserted to the card reader 16-1 in step S300a-1 as shown in FIG. 79. If the smart card 17-1 is not inserted (NO in step S300a-1), the terminal CPI 91-1 proceeds to step S300e-1 to be described later. When the smart card 17-1 is inserted (YES in step S300a-1), the terminal CPU 91-1 outputs the message (the conversation sentence) to inquire of the player about the language type to be used in the roulette game (step S300b-1).

This message may be outputted in the form of a sound from the speaker 10-1 through the sound input circuit 98-1 or outputted in the form of display of characters or the like on the display 8-1 through the LCD driving circuit 95-1.

For example, when the message is outputted in the form of the sound, the terminal CPU 91-1 outputs the sound for requesting for selection of the language to be used in the game from the speaker 10-1 in a default language type. When the default language type is English, for instance, the terminal CPU 91-1 outputs the sound stating “What language do you want to use?” from the speaker 10-1.

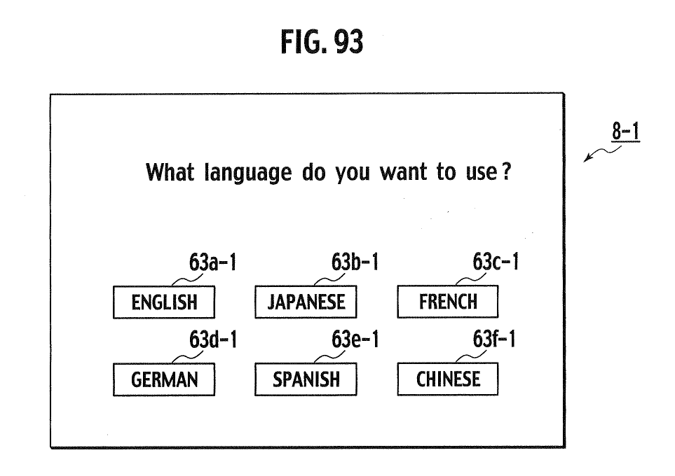

Meanwhile, when the message is outputted in the form of display, the terminal CPU 91-1 displays characters, buttons, and the like on the display 8-1 in order to promote selection of the language to be used in the game in the default language type. For example, when the default language type is English, the terminal CPU 91-1 displays characters stating “What language do you want to use?” together with buttons 63a-1, 63b-1, 63c-1, 63d-1, 63e-1, and 63f-1 representing language options of “English”, “Japanese”, “French”, “German”, “Spanish”, and “Chinese” as shown in FIG. 93.

Thereafter, the terminal CPU 91-1 judges whether or not a response message (a response sentence) to the message outputted in step S300b-1 is inputted (step S300c-1).

Here, when the message outputted in step S300b-1 is in the sound, the presence of the input of the message in response to the outputted message can be confirmed by judging whether or not there is the input to the input unit 1100-1 of the conversation controller 1000-1 after outputting the message in step S300b-1. Meanwhile, when the outputted message in step S300b-1 is displayed on the display 8-1, the presence of the input of the message in response to the outputted message can be confirmed by judging whether or not an operation of any of language selection buttons displayed on the display 8-1 (the buttons 63a-1, 63b-1, 63c-1, 63d-1, 63e-1, and 63f-1 stating “English”, “Japanese”, “French”, “German”, “Spanish”, and “Chinese” shown in FIG. 93) respectively by the player is detected with the touch panel 50-1.

Then, if no response message to the message outputted in step S300b-1 is inputted (NO in step S300c-1), the terminal CPU 91-1 repeats step S300c-1 until there is the input. When the response message is inputted (YES in step S300c-1), the terminal CPU 91-1 changes the language of the BET screen 61-1 to be displayed on the display 8-1 during the betting period of the roulette game in the language indicated by the message inputted in step S300c-1 (step S300d-1). Thereafter, the terminal CPU 91-1 terminates the used language confirmation processing.

Here, when the message inputted in step S300c-1 is in the sound, the language indicated in the inputted message can be specified by analyzing the contents of the message inputted in the voice from the microphone 15-1 in accordance with the previously explained operations of the conversation controller 1000-1. Meanwhile, when the inputted message in step S300c-1 is displayed on the display 8-1, the language indicated in the inputted message can be confirmed by allowing the terminal CPU 91-1 to identify contents of an operation of any of the buttons for language selection displayed on the display 8-1 by the player through the touch panel 50-1.

In step S300e-1, the terminal CPU 91-1 checks whether or not the smart card 17-1 is discharged from the card reader 16-1. If the smart card 17-1 is not discharged (NO in step S300e-1), the terminal CPU 91-1 terminates the used language confirmation processing. When the smart card 17-1 is discharged (YES in step S300e-1), the terminal CPU 91-1 displays the BET screen 61-1 on the display 8-1 in the default language during the betting period of the roulette game (step S300f-1). Thereafter, the terminal CPU 91-1 terminates the used language confirmation processing. Here, the default language type may be defined as English, for example.

In the betting period confirmation processing (step S301-1), as shown in FIG. 80, the terminal CPU 91-1 confirms whether the betting period start signal has been received from the server CPU 81-1 or not (step S311-1). In the case where the betting period start signal has been received (step S311-1: YES), the terminal CPU 91-1 sets the flag F in the RAM 93-1 which indicates that it is under the betting period to “1” (step S312-1), and then terminates the betting period confirmation processing.

On the other hand, in the case where the betting time start signal has not been received yet (step S311-1: NO), the terminal CPU 91-1 confirms whether the betting period end signal has been received from the server CPU 81-1 or not (step S313-1). In the case where the betting period end signal has been received (step S313-1: YES), the terminal CPU 91-1 sets the flag F in the RAM 93-1 which indicates that it is under the betting period to “0” (step S314-1), and then terminates the betting period confirmation processing. In the case where the betting period end signal has not been received yet (step S313-1: NO), the terminal CPU 91-1 terminates the betting period confirmation processing.

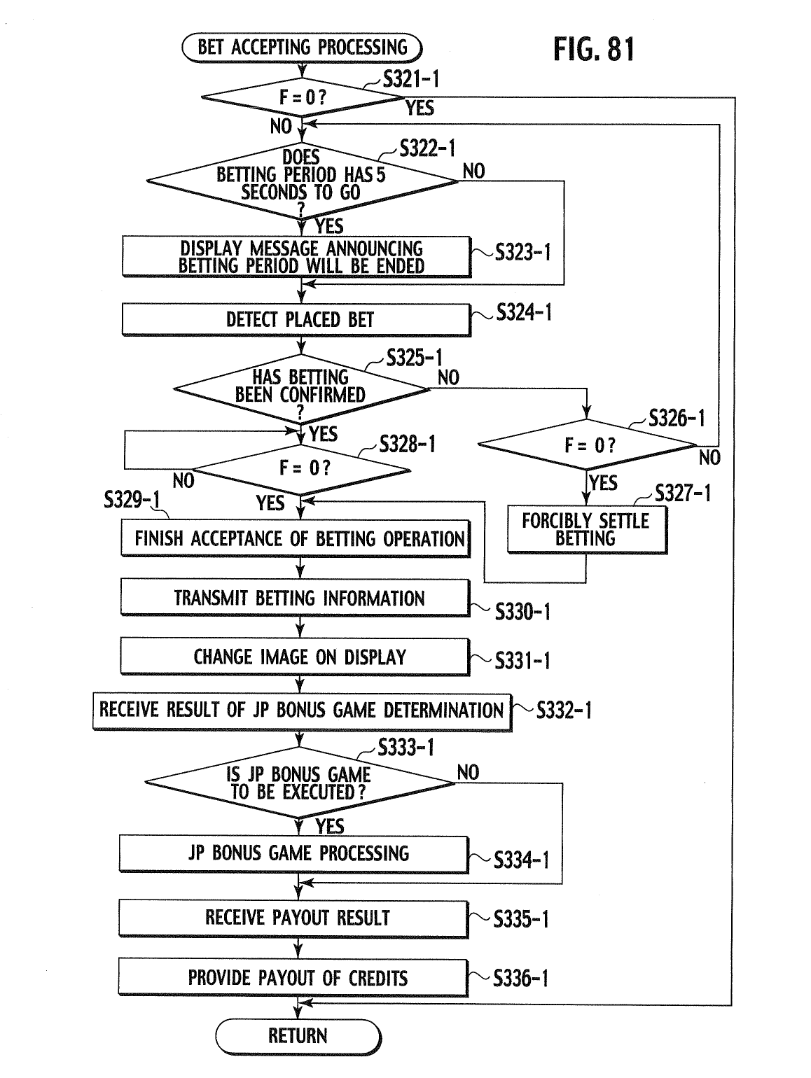

Then, in the bet accepting processing (step S302-1 in FIG. 78), as shown in FIG. 81, the terminal CPU 91-1 judges whether the flag F in the RAM 93-1 is set to “0” or not (step S321-1). In the case where the flag F is set to “0” (step S321-1: YES), the terminal CPU 91-1 terminates the bet accepting processing.

On the other hand, in the case where the flag F is not set to “0” (step S321-1: NO), the terminal CPU 91-1 judges whether the remaining betting time has reached the last 5 seconds (“5” or a smaller number is displayed on the bet time display unit 69-1) or not (step S322-1). In the case where the remaining time has reached the last 5 seconds (step S322-1: YES), the terminal CPU 91-1 displays a message announcing that the betting time will be ended on the bet screen 61-1 (step S323-1), and shifts the processing to the step S324-1. On the other hand, in the case where the remaining time has not reached the last 5 seconds (step S322-1: NO), the terminal CPU 91-1 shifts the processing to the step S324-1.

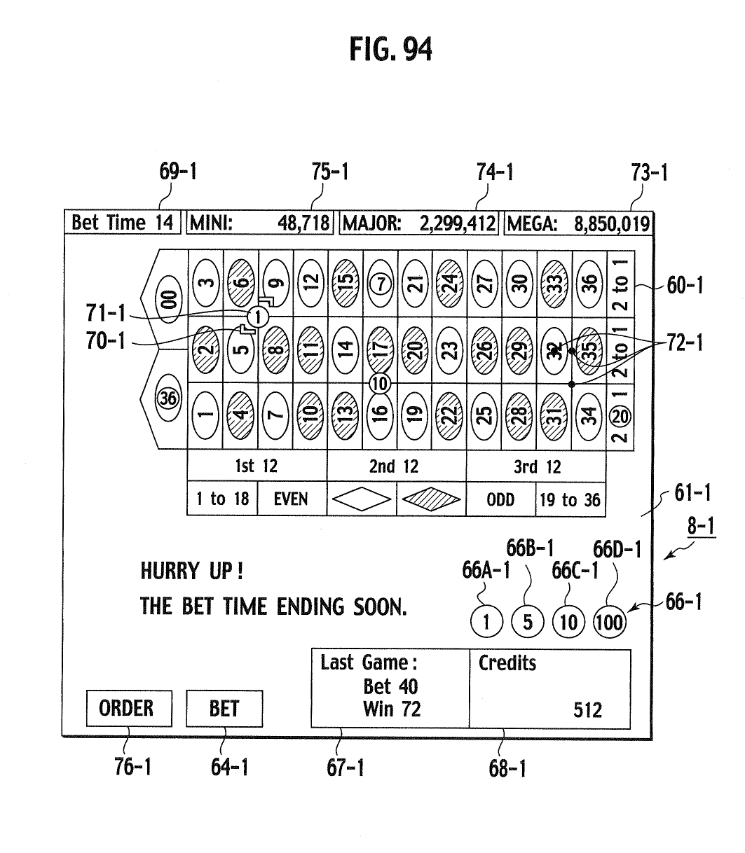

Here, when the BET screen 61-1 displayed on the display 8-1 is written in English as shown in FIG. 50, the message of the advance notice for the end of the betting period is shown in the contents such as “HURRY UP! THE BET TIME ENDING SOON.” as shown in FIG. 94, for example.

The terminal CPU 91-1 detects the bet placed by the player (step S324-1). The betting is detected by detecting the player's touches on the bet area 72-1 in the table-type betting board 60-1 and on the bet buttons 66-1 via the touch panel 50-1. When the betting is detected, the chip mark 71-1 is displayed on the specified bet area 72-1 on the display 8-1 according to the number of bet chips.

After that, the terminal CPU 91-1 judges whether the player has confirmed the betting or not (step S325-1). The betting is confirmed when the player's touch on the bet confirmation button 65-1 on the display 8-1 is detected via the touch panel 50-1.

In the case where it is judged that the betting has not been confirmed (step S325-1: NO), the terminal CPU 91-1 judges whether the flag F in the RAM 93-1 is set to “0” or not (step S326-1). In the case where the flag F is not set to “0” (step S326-1: NO), the terminal CPU 91-1 returns the processing to the step S322-1.

On the contrary, when the flag F is set to “0” (YES in step S326-1), the terminal CPU 91-1 forcibly settles the bet of chips by the player (step S327-1) and then shifts the processing to step S329-1 to be described later.

Meanwhile, when the bet of chips by the player is confirmed to be settled in step S325-1 (YES), the terminal CPU 91-1 judges whether or not the flag F of the RAM 93-1 is set to “0” in step S328-1. When the flag F is not set to “0” (NO in step S328-1), the terminal CPU 91-1 repeats step S326-1. On the contrary, when the flag F of the RAM 93-1 is set to “0” ‘YES in step S328-1), the terminal CPU 91-1 shifts the processing to step S329-1.

In the step S328-1, the terminal CPU 91-1 finishes accepting betting operations via the touch panel 50-1 (step S329-1). Thereafter, the terminal CPU 91-1 transmits the betting information of the player (the specified bet area 72-1, the number of bet chips and the types of betting) to the server CPU 81-1 (step S330-1).

Next, the terminal CPU 91-1 changes the image on the display 8-1 (step S331-1). To be more precise, the terminal CPU 91-1 firstly switches the image on the display 8-1 to the bet screen 61-1 including the image indicating that the betting period has ended.

Thereafter, the terminal CPU 91-1 receives the result of the JP bonus game determination processing from the server CPU 81-1 (step S332-1). The result of the JP bonus game determination includes the information which indicates: whether to execute the JP bonus game at any gaming terminal 4-1 or not; which gaming terminal 4-1 is to win the JP (or all the gaming terminals 4-1 are to lose) in the case where it is determined to execute the JP bonus game; and which JP (“MEGA”, “MAJOR” or “MINI”) is to be won in the case of having the JP won.

After that, the terminal CPU 91-1 determines whether to execute the JP bonus game or not, according to the result of the JP bonus game determination processing received at the step S332-1 (step S333-1). In the case where it is determined to execute the JP bonus game at its own gaming terminal 4-1, the terminal CPU 91-1 executes a prescribed selection-type JP bonus game. And then, the terminal CPU 91-1 displays the bonus game result (whether the JP has been won or not) in the bet screen 61-1 on the display 8-1 (step S334-1), according to the determination result received at the step S332-1.

In the case where it is determined not to execute the JP bonus game at its own gaming terminal 4-1 at the step S333-1, or after the step S334-1, the terminal CPU 91-1 receives the payout result from the server CPU 81-1 (step S335-1). Note that the payout result includes the payout for the roulette game and the payout for the JP bonus game.

Subsequently, the terminal CPU 91-1 provides a payout according to the payout result received at the step S335-1 (step S336-1). Specifically, the terminal CPU 91-1 stores the credit data of the payout for the roulette game in the RAM 93-1. And the terminal CPU 91-1 also stores the accumulated JP credits in the RAM 93-1 if the JP has been won. Then, when the payout button 5-1 is touched, the number of medals corresponding to the credits stored in the RAM 93-1 (usually, one medal per one credit) are paid from the medal payout opening 12-1. Thereafter, the terminal CPU 91-1 terminates the bet accepting processing.

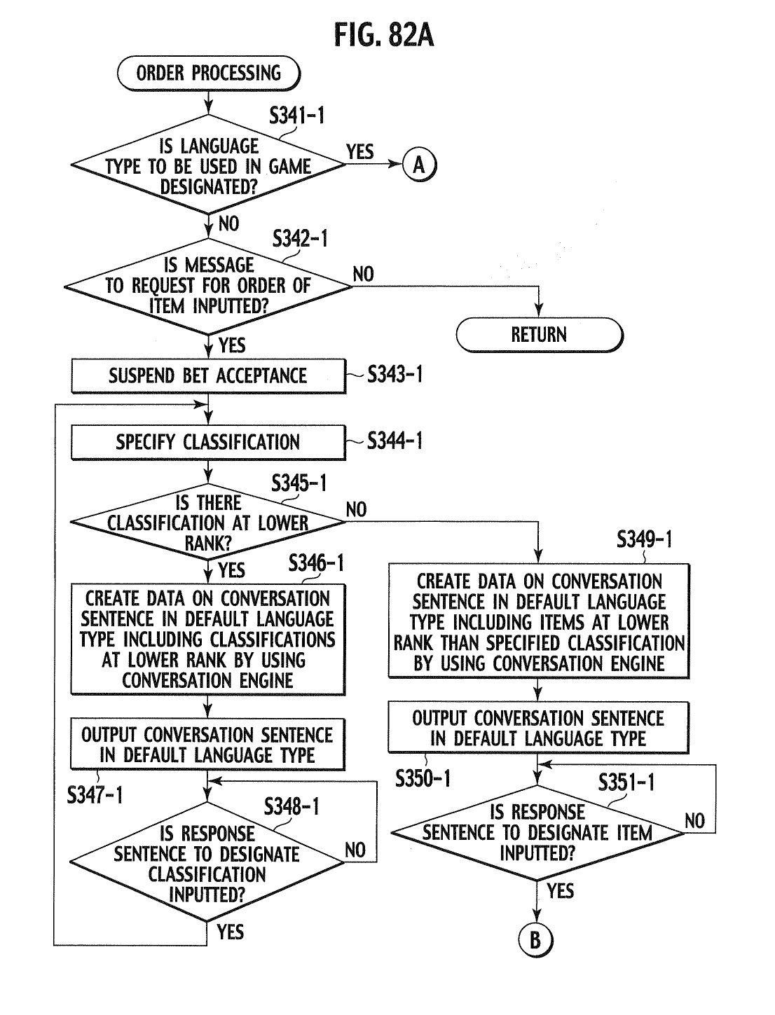

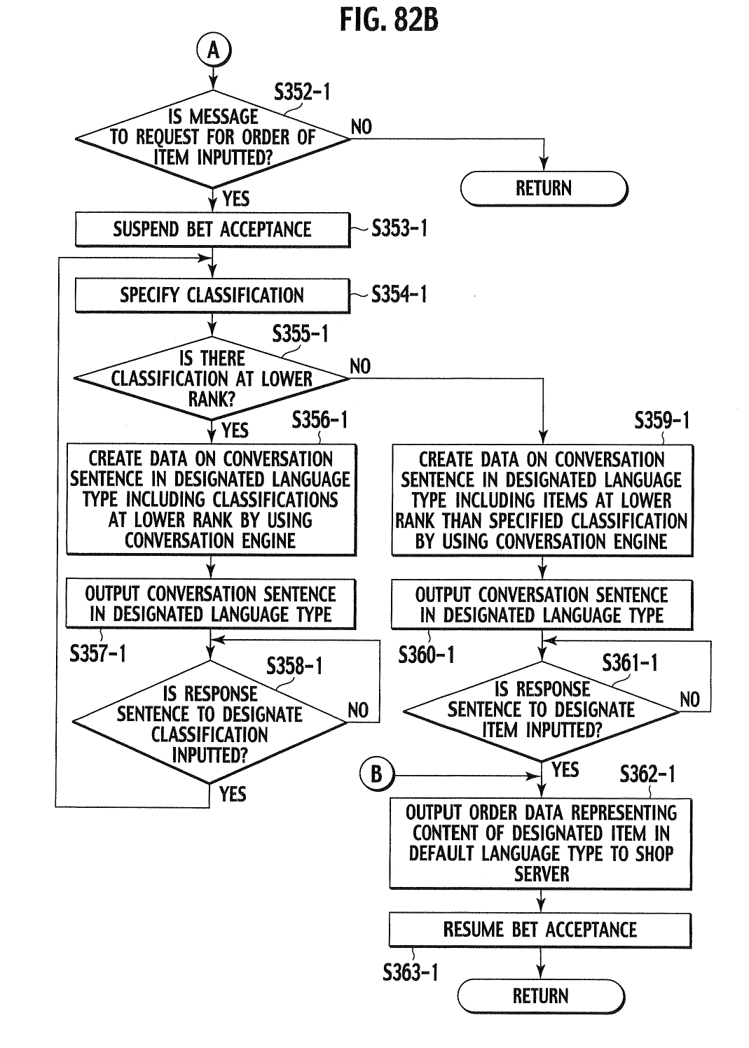

Next, as shown in FIG. 82A, in the order processing in step S303-1 of FIG. 78, the terminal CPU 91-1 judges whether or not the language type to be used in the game is designated by the message (the response sentence) inputted in step S300c-1 in the used language confirmation processing shown in FIG. 79 (step S341-1). If the language type is designated (YES in step S341-1), the terminal CPU 91-1 proceeds to step S352-1 (see FIG. 82B) to be described later.

On the other hand, when the language type to be used in the game is not designated (NO in step S341-1), the terminal CPU 91-1 judges whether or not a message (a response sentence) to request an order of an item is inputted in a default language type (in English, for example) (step S342-1).

Here, when the message is in the form of the sound, whether the message to request the order of the item is inputted can be judged by checking whether or not the input unit 1100-1, which can be formed of the microphone 15-1, of the conversation controller 1000-1 receives an input of a sound message (such as a phrase meaning “I would like some food and beverage”) that requests the order of the item in the default language. On the other hand, when the message to request the order of the item is in the form of display on the display 8-1, whether the message is inputted can be judged by checking whether or not the touch panel 50-1 detects an operation of the order button 76-1 (see FIG. 50) displayed on the BET screen 61-1 on the display 8-1 by the player.

Then, if the message to request the order of the item is not inputted (NO in step S342-1), the terminal CPU 91-1 terminates the order processing. On the other hand, when the message to request the order of the item is inputted (YES in step S342-1), the terminal CPU 91-1 suspends acceptance of a bet by disallowing the player to make a bet of credits on the roulette game through the operation on the BET screen 61-1 (step S343-1). Moreover, the terminal CPU 91-1 specifies the classification designated by the inputted message (the message to request the order of the item inputted in step S342-1 in this case) (step S344-1). Thereafter, the terminal CPU 91-1 proceeds to step S345-1 to be described later.

The classification designated by the inputted message (the response sentence) can be specified by analyzing the message (the response sentence) inputted in the default language type by use of the speech recognition unit 1200-1 and the sentence analyzing unit 1400-1 of the conversation controller 1000-1 formed of the terminal CPU 91-1 and the external memory 99-1.

For example, when the input of the sound message (the response sentence) having the content stating that “I would like some food and beverage” in the default language type in step S342-1, the terminal CPU 91-1 can recognize from the presence of keywords “food” and “beverage” in the message (the response sentence) that the message designates a grand classification including both of “food” and “beverage” located at the top rank in the menu data in the external memory 100-1.

Similarly, when the sound message (the response sentence) having the content stating that “I would like some food” or the sound message (the response sentence) having the content stating that “I would like some beverage” is inputted in the default language type in step S342-1, the terminal CPU 91-1 can recognize from the presence of keywords “food” or “beverage” in the message (the response sentence) that the message designates a food classification including the “food” or a beverage classification including the “beverage” in the menu data in the external memory 100-1 is designated in each case.

Meanwhile, when the player operates the order button 76-1 (see FIG. 50) displayed on the BET screen 61-1 on the display 8-1, the terminal CPU 91-1 can detect the operation and thereby judge that the grand classification including both of the “food” and the “beverage” located at the top rank in the menu data in the external memory 100-1 are designated.

In step S345-1, the terminal CPU 91-1 judges whether or not there is any classification at the rank located immediately below the classification specified in step S344-1 from the contents of the menu data corresponding to the default language type stored in the external memory 100-1. When there is no classification (NO in step S345-1), the terminal CPU 91-1 proceeds to step S349-1 to be described later.

On the other hand, when there is any classification at the rank located immediately below the classification specified in step S344-1 (YES in step S345-1), the terminal CPU 91-1 creates data on a message (a conversation sentence) in the default language type (in English, for example) including one or more classifications by use of the conversation control unit 1300-1 of the conversation controller 1000-1 formed of the terminal CPU 91-1 and the conversation database 1500-1 of the conversation controller 1000-1 formed of the external memory 99-1 (step S346-1).

Next, the terminal CPU 91-1 outputs the message (the conversation sentence) including one or more items, whose data is created in step S349-1, at the rank located immediately below the classification specified in step S344-1 in the form of the sound (step S347-1). The output of this message can be achieved by use of the output unit 1600-1 of the conversation controller 1000-1 formed of the speaker 10-1. Thereafter, the terminal CPU proceeds to step S348-1 to be described later.

In step S348-1, the terminal CPU 91-1 judges whether or not a message (a response sentence), which designates one of the items presented in that message, is inputted in the default language type (in English, for example) in response to the message (the conversation sentence) outputted in the form of the sound in step S347-1. When no massage is inputted (NO in step S348-1), the terminal CPU 91-1 repeats step S348-1 until a massage is inputted. When the massage is inputted (YES in step S351-1), the terminal CPU 91-1 proceeds to step S344-1.

Therefore, in step S344-1 transited from step S348-1, the terminal CPU 91-1 specifies the classification designated in the message inputted in step S348-1 (the message to designate one of the classifications presented in the message (the conversation sentence) outputted in step S347-1.

In step S349-1, the terminal CPU 91-1 creates data on a message (a conversation sentence) including one or more items located below the classification specified in steps S344-1 in the menu data in the external memory 100-1, in the default language type (in English, for example), by use of the conversation control unit 1300-1 of the conversation controller 1000-1 formed of the terminal CPU 91-1 and the conversation database 1500-1 of the conversation controller 1000-1 formed of the external memory 99-1.

Next, the terminal CPU 91-1 outputs the message (the conversation sentence) including one or more items, whose data is created in step S349-1, at the rank located immediately below the classification specified in step S344-1 in the form of the sound (step S350-1). The output of this message can be achieved by use of the output unit 1600-1 of the conversation controller 1000-1 formed of the speaker 10-1. Thereafter, the terminal CPU proceeds to step S351-1 to be described later.

In step S351-1, the terminal CPU 91-1 judges whether or not a message (a response sentence), which designates one of the items presented in the message, is inputted in the default language type (in English, for example) in respond to the message (the conversation sentence) outputted in the form of the sound in step S350-1. When the terminal CPU 91-1 receives no input, (NO in step S351-1), the terminal CPU 91-1 repeats step S351-1 until the terminal CPU 91-1 receives the input. When the terminal CPU 91-1 receives the input (YES in step S351-1), the terminal CPU 91-1 proceeds to step S362-1 to be described later (see FIG. 82B).

As shown in FIG. 82B, in step S352-1, the terminal CPU 91-1 judges whether or not a message (a response sentence) to request the order of the item is inputted in language type designated in step S341-1 in a similar manner to step S342-1.

Then, if the message to request the order of the item is not inputted (NO in step S352-1), the terminal CPU 91-1 terminates the order processing. On the other hand, when the message to request the order of the item is inputted (YES in step S352-1), the terminal CPU 91-1 suspends acceptance of a bet of credits on the roulette game through the operation on the BET screen 61-1 by the player as similar to step S343-1 (step S353-1). Moreover, the terminal CPU 91-1 specifies the classification designated by the inputted message (the message to request the order of the item inputted in step S352-1 in this case) as similar to step S344-1 (step S354-1). Thereafter, the terminal CPU 91-1 proceeds to step S355-1 to be described later.

In step S355-1, the terminal CPU 91-1 judges whether or not there is any classification at the rank located immediately below the classification specified in step S354-1 from the contents of the menu data corresponding to the language type designated in step 341-1 which are stored in the external memory 100-1. When there is no classification (NO in step S355-1), the terminal CPU 91-1 proceeds to step S359-1 to be described later.

On the other hand, when there is any classification at the rank located immediately below the classification specified in step S354-1 (YES in step S355-1), the terminal CPU 91-1 creates data on a message (a conversation sentence) including one or more classifications, in the language type designated in step S341-1 (in Japanese, for example) by use of the conversation control unit 1300-1 of the conversation controller 1000-1 formed of the terminal CPU 91-1 and the conversation database 1500-1 of the conversation controller 1000-1 formed of the external memory 99-1 (step S356-1).

Next, the terminal CPU 91-1 outputs the message (the conversation sentence) including one or more classifications, whose data is created in step S356-1, at the rank located immediately below the classification specified in step S354-1 in the form of the sound (step S357-1). The output of this message can be achieved by use of the output unit 1600-1 of the conversation controller 1000-1 formed of the speaker 10-1. Thereafter, the terminal CPU 91-1 proceeds to step S358-1 to be described later.

In step S358-1, the terminal CPU 91-1 judges whether or not a message (a response sentence), which designates one of the classifications presented in the message, is inputted in the language type designated in step S341-1 (in Japanese, for example), in response to the message (the conversation sentence) outputted in the form of the sound in step S357-1. When the terminal CPU 91-1 receives no input, (NO in step S358-1), the terminal CPU 91-1 repeats step S358-1 until the terminal CPU 91-1 receives an input. When the terminal CPU 91-1 receives an input (YES in step S358-1), the terminal CPU 91-1 proceeds to step S354-1.

Therefore, in step S354-1 transited from step S358-1, the terminal CPU 91-1 specifies the classification designated in the message inputted in step S358-1 (the message to designate one of the classifications presented in the message (the conversation sentence) outputted in step S357-1).

In step S359-1, the terminal CPU 91-1 creates data on a message (a conversation sentence) in the language type designated in step S341-1 (in Japanese, for example) including one or more items located below the classification specified in steps S354-1 in the menu data in the external memory 100-1 by use of the conversation control unit 1300-1 of the conversation controller 1000-1 formed of the terminal CPU 91-1 and the conversation database 1500-1 of the conversation controller 1000-1 formed of the external memory 99-1.

Next, the terminal CPU 91-1 outputs the message (the conversation sentence) including one or more items, whose data is created in step S359-1, located below the classification specified in steps S354-1 in the form of the sound (step S360-1). The output of this message can be performed by use of the output unit 1600-1 of the conversation controller 1000-1 formed of the speaker 10-1. Thereafter, the terminal CPU proceeds to step S361-1 to be described later.

In step S361-1, the terminal CPU 91-1 judges whether or not a message (a response sentence), which designates one of the items presented in the message, is inputted in the language type designated in step S341-1 (in Japanese, for example), in response to the message (the conversation sentence) outputted in the form of the sound in step S360-1. When the terminal CPU 91-1 receives no input, (NO in step S361-1), the terminal CPU 91-1 repeats step S361-1 until the terminal CPU 91-1 receives the input. When the terminal CPU 91-1 receives the input (YES in step S361-1), the terminal CPU 91-1 proceeds to step S362-1.

In step S362-1, the terminal CPU 91-1 creates order data in the default language type (in English, for example) which represent the contents of the item designated by the message inputted in the default language type (in English, for example) in step S351-1 or the contents of the item designated in the language type designated in Step S341-1 (in Japanese, for example) in step S361-1, and outputs the order data to the shop server 86-1 as a destination of connection through the local area network. Thereafter, the terminal CPU 91-1 proceeds to step S363-1.

In step S363-1, the terminal CPU 91-1 resumes acceptance of a bet which has been suspended in step S343-1 or in step S353-1, thereby effectuating the bet of credits on the roulette game by the player through the operation on the BET screen 61-1. Thereafter, the terminal CPU 91-1 terminates the order processing.

Incidentally, when the shop server 86-1 receives the order data outputted in step S362-1 which represent the contents of the ordered item in the default language type (in English, for example), the shop server 86-1 displays the contents of the ordered item represented by the order data on a shop display 86a-1 in the default language type (in English, for example).

As apparent from the foregoing description, in the roulette game machine 1-1 of this embodiment, the controller of the present invention is formed of the terminal CPU 91-1.

In the gaming terminal 4-1 according to this embodiment configured as described above, the following actions take place when the player determines the language type (either the default language type or the designated language type) to be used in the roulette game and then inputs the sound message to request the order of the item to the microphone 15-1 in the language type.

For example, when the player inputs the sound message having the phrase meaning “I would like some food and beverage”, the message is deemed to specify the grand classification due to the keywords “food” and “beverage” in the sound message. Then, subsequent to a message stating “please select a classification which you like”, a message sequentially enumerating the classifications located immediately below the grand classification (such as “foods”, “beverages”, and so on) in the menu data in the external memory 100-1 is outputted from the speaker 10-1.

Here, if the player inputs a sound message stating “foods”, then subsequent to a message stating “please select a classification which you like”, a message sequentially enumerating the classifications located immediately below the food classification (such as “croque-monsieur”, “clubhouse sandwich”, “BLT sandwich”, “French fries”, and so on) in the menu data in the external memory 100-1 is outputted from the speaker 10-1.

Thereafter, the item that the player wishes to order is eventually specified by repeating inputs and outputs of the sound messages as described above.

For example, the classification inputted in the form of the sound message by the player is assumed to be a Wild Turkey (registered trademark) classification in a Kentucky and Bourbon whiskey classification located below a whiskey classification that is located below the beverage classification. Then, three classifications of “Wild Turkey 101 proof”, “Wild Turkey 12 YO”, and “Wild Turkey 17 YO” existing in the menu data in the external memory 100-1 as the classifications at a rank immediately below this Wild Turkey classification are outputted from the speaker 10-1 subsequent to the message stating “please select a classification which you like”.

Here, a sound message to designate the “Wild Turkey 12 YO” classification is assumed to be inputted by the player. There are not classifications below this “Wild Turkey 12 YO” classification in the menu data in the external memory 100-1. Instead, only the items (drinking-styles in this case) are located therebelow. Accordingly, subsequent to the message stating “please select a drinking-style”, a voice message sequentially enumerating concrete items (“straight”, “on the rocks”, “twice-up”, “whiskey and soda”, and so on, for example) located below the Wild Turkey 12 YO classification in the menu data in the external memory 100-1 and prices thereof is outputted from the speaker 10-1.

Then, when the player inputs a sound message stating “on the rocks”, for example, the item ordered by the player is specified as the “on the rocks” in the “Wild Turkey 12 YO”.

The content of the item ordered by the player thus specified is displayed on the shop display 86a-1 of the shop server 86-1 in the default language type (in English, for example).

As described above, the gaming terminal 4-1 of the roulette game device 1-1 according to the embodiment of the present invention outputs the message (the conversation sentence) to inquire the language type that the player wishes to use in the roulette game in the forms of sounds and characters from the speaker 10-1 and the display 8-1 by use of the conversation controller 1000-1 compatible with the multiple language types or by use of the multiple conversation controllers 1000-1 respectively compatible with the language types.

In response to this output, the player inputs the message (the response sentence) for designating the language type that the player wishes to use in the roulette game either in the form of the sound by using the microphone 15-1 or in the form of the characters by operating the touch panel 50-1 on the display 8-1.

After the input of the message by the player for designating the language type to be used in the roulette game in the forms of the sounds and the characters, the gaming terminal 4-1 exchanges the conversations in the forms of the sounds and the characters with the player in the language type designated by the player.

Therefore, in the roulette game device 1 according to the embodiment of the present invention, the language type to be used in the roulette game is set to the language type corresponding to the request by the player by performing the conversations between the gaming terminal 4-1 and the player in the forms of the sounds and the characters. Thereafter, the information in the conversation mode is exchanged between the gaming terminal 4-1 and the player in the language type thus set up. Accordingly, it is possible to achieve interactive gaming.

Moreover, in the roulette game device 1-1 according to the embodiment of the present invention, when the player inputs the sound message in the designated language type to request the order of the item orderable through the gaming terminal from the input unit 1100-1 formed of the microphone 15-1, the conversation controller 1000-1 analyzes the message and creates the sound message to inquire the classification of the item, and this message is outputted from the output unit 1600-1 formed of the speaker 10-1 toward the player. Interactive exchange between the player and the gaming terminal 4-1 is established by repeating the inputs of sound messages from the player and the outputs of the sound messages from the conversation controller 1000-1, whereby the scope of the item that the player wishes to order is gradually narrowed down from the top rank to the bottom rank and eventually specified.

Therefore, in the gaming terminal 4-1 of the roulette game device 1-1 according to the embodiment of the present invention, it is possible to order the item interactively through the gaming terminal 4-1 by exchanging the information in the conversation mode between the gaming terminal 4-1 and the player in the designated language type.

Moreover, according to the roulette game device 1-1 of the embodiment of the present invention, the ordered item is displayed on the shop display 86a-1 of the shop server 86-1 in the default language type regardless of what language type the player uses for ordering the item. As a result, even when the player orders the item in the language type other than the default language type, staff in the shop area who receives the order can grasp the contents of the ordered item by means of display on the shop display 86a-1 using in default language type recognizable to the staff. In this way, it is possible to establish communication for placing the order in mutually different language types between the player and the staff in the shop area.

The above-described embodiment has explained the case of exchanging the interactive messages between the gaming terminal 4-1 and the player by using the sounds throughout the process to narrow down the item that the player wishes to order to the process to specify the item. However, it is also possible to apply a configuration to exchange the messages by means of display on the display 8-1 instead.

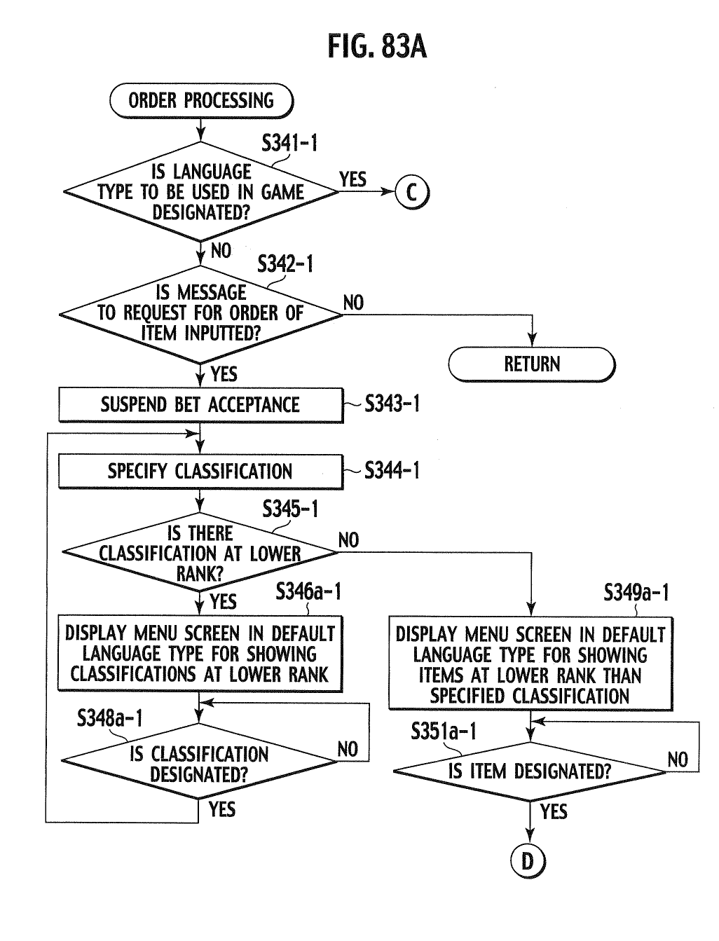

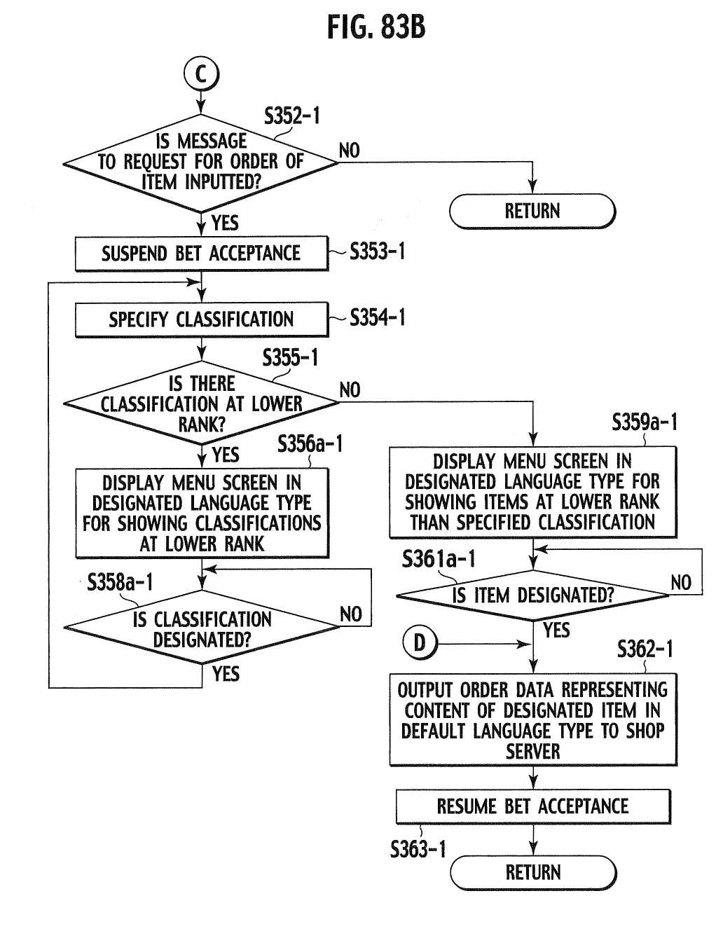

Concrete contents of the ordering process in step S303-1 in FIG. 78 by applying such a configuration will now be described with reference to flowcharts in FIGS. 83A and 83B.

First, as shown in FIG. 83A, the terminal CPU 91-1 performs the processes from step S341-1 to step S345-1 shown in FIG. 82A. Subsequently, when there is no classification at the rank immediately below the classification specified in step S344-1 (NO in step S345-1), the terminal CPU 91-1 proceeds to step S349a-1 to be described later.

On the other hand, when there is any classification at the rank located immediately below the classification specified in step S344-1 (YES in step S345-1), the terminal CPU 91-1 displays a menu screen in the default language type (in English, for example) for guiding one or more classifications on the display 8-1 (step S346a-1). Thereafter, the terminal CPU 91-1 proceeds to step S348a-1 to be described later.

In step S348a-1, the terminal CPU 91-1 judges whether or not the player designates one of the classifications presented on the menu screen by means of the operation on the menu screen displayed on the display 8-1 in step S346a-1. When no classification is designated (NO in step S348a-1), the terminal CPU 91-1 repeats step S348a-1 until any classification is designated. The terminal CPU 91-1 proceeds to step S344-1 when the classification is designated (YES in step S348a-1).

Therefore, in step S344-1 transited from step S343-1, the terminal CPU 91-1 specifies the classification which is designated by the message (the conversation sentence) to request the order of the item inputted in step S342-1. Meanwhile, in step S344-1 transited from step S348a-1, the terminal CPU 91-1 specifies the classification among the classifications presented on the menu screen displayed on the display 8-1 in step S346a-1 which is designated by the player.

In step S349a-1, the terminal CPU 91-1 displays a menu screen in the default language type (in English, for example) on the display 8-1 in order to guide one or more items in the menu data in the external memory 100-1, which are located below the classification specified in step S344-1.

Next, the terminal CPU 91-1 judges whether or not the player designates one of the items presented on the menu screen by operating the menu screen displayed on the display 8-1 in step S349a-1 (step S351a-1). When no item is designated (NO in step S351a-1), the terminal CPU 91-1 repeats step S351a-1 until any item is designated. When the item is designated (YES in step S351a-1), the terminal CPU 91-1 proceeds to step S362-1 to be described later (see FIG. 83B).

Meanwhile, as shown in FIG. 83B, the terminal CPU 91-1 performs the processes from step S352-1 to step S355-1 shown in FIG. 82B. Subsequently, when there is no classification at the rank immediately below the classification specified in step S354-1 (NO in step S355-1), the terminal CPU 91-1 proceeds to step S359a-1 to be described later.

On the other hand, when there is any classification at the rank located immediately below the classification specified in step S354-1 (YES in step S355-1), the terminal CPU 91-1 displays a menu screen in the language type designated in step S341-1 (in Japanese, for example) for guiding one or more classifications on the display 8-1 (step S356a-1). Thereafter, the terminal CPU 91-1 proceeds to step S358a-1 to be described later.

In step S358a-1, the terminal CPU 91-1 judges whether or not the player designates one of the classifications presented on the menu screen by means of the operation on the menu screen displayed on the display 8-1 in step S356a-1. When no classification is designated (NO in step S358a-1), the terminal CPU 92-1 repeats step S358a-1 until any classification is designated. The terminal CPU 91-1 proceeds to step S354-1 when the classification is designated (YES in step S358a-1).

Therefore, in step S354-1 transited from step S352-1, the terminal CPU 91-1 specifies the classification which is designated by the message (the conversation sentence) to request the order of the item inputted in step S352-1. Meanwhile, in step S354-1 transited from step S358a-1, the terminal CPU 91-1 specifies the classification among the classifications presented on the menu screen displayed on the display 8-1 in step S356a-1 which is designated by the player.

In step S359a-1, the terminal CPU 91-1 displays a menu screen in the language type designated in step S341-1 (in Japanese, for example) on the display 8-1 in order to guide one or more items in the menu data in the external memory 100-1, which are located below the classification specified in step S354-1.

Next, the terminal CPU 91-1 judges whether or not the player designates one of the items presented on the menu screen by operating the menu screen displayed on the display 8-1 in step S359a-1 (step S361a-1). When no item is designated (NO in step S361a-1), the terminal CPU 91-1 repeats step S361a-1 until any item is designated. When the item is designated (YES in step S361a-1), the terminal CPU 91-1 proceeds to step S362-1 to be described later.

In step S362-1 and subsequent step S363-1, the terminal CPU 91-1 executes the same processing as step S362-1 and step S363-1 shown in FIG. 82B.

In the gaming terminal 4-1 configured as described above, the following actions take place when the player determines the language type (either the default language type or the designated language type) to be used in the roulette game and then inputs the sound message to request for the order of the item to the microphone 15-1 in the language type. Here, the default language type (English, for example) is assumed to be the language type to be used in the roulette game.

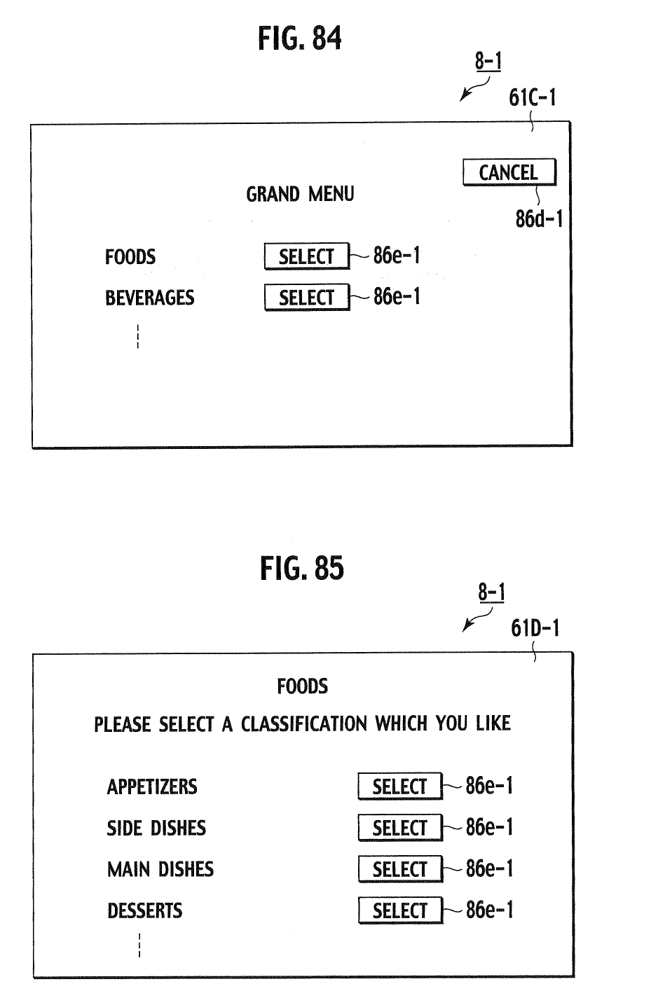

For example, when the player inputs the sound message having the phrase meaning “I would like some food and beverage”, the message is deemed to specify the grand classification due to the keywords “food” and “beverage” in the sound message. Then, as shown in FIG. 84, subsequent to a message stating “please select a classification which you like” in the default language (in English, for example), a menu screen 61C-1 arranging the classifications in the menu data in the external memory 100-1 located immediately below the grand classification (such as “foods”, “beverages”, and so on) is displayed on the display 8-1.

Here, if the player operates a “select” button 86e-1 beside the “foods” classification on the menu screen 61C-1, then subsequent to a message stating “please select a classification which you like” in the default language (in English, for example), a menu screen 61D-1 arranging the classifications in the menu data in the external memory 100-1 located immediately below the food classification (such as “appetizers”, “side dishes”, “main dishes”, “desserts”, and so on) is displayed on the display 8-1.

Thereafter, the item that the player wishes to order is eventually specified by repeating the display of the classifications (or the items) on the menu screens as described above on the display 8-1 and operations on the menu screens by the player.

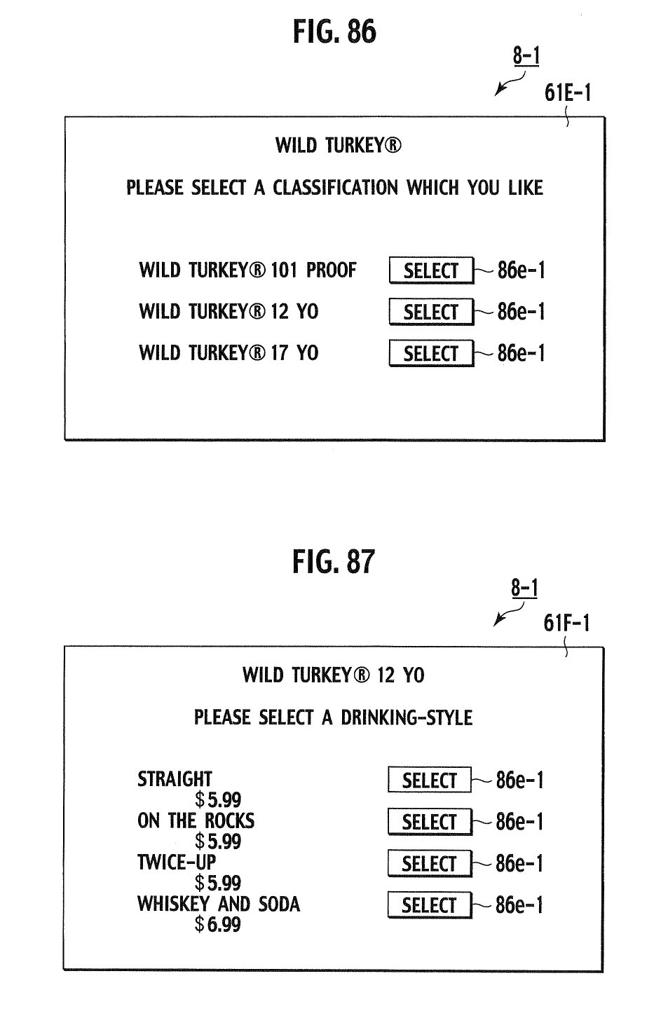

For example, the classification inputted by the operation on the menu screen on the display 8-1 by the player is assumed to be the Wild Turkey classification as described in the previous example. Then, as shown in FIG. 86, a menu screen 61E-1 arranging three classifications of “Wild Turkey 101 proof”, “Wild Turkey 12 YO”, and “Wild Turkey 17 YO” existing in the menu data in the external memory 100-1 as the classifications at a rank immediately below this Wild Turkey classification together with the message stating “please select a classification which you like” is displayed on the display 8-1.

Here, the “select” button 86e-1 beside the “Wild Turkey 12 YO” classification on the menu screen 61E-1 is assumed to be operated by the player. There are not classifications below this “Wild Turkey 12 YO” classification in the menu data in the external memory 100-1. Instead, only the items (drinking-styles in this case) are located therebelow. Accordingly, subsequent to the message stating “please select a drinking-style”, a menu screen 61F-1 arranging the concrete items (“straight”, “on the rocks”, “twice-up”, “whiskey and soda”, and so on, for example) located below the Wild Turkey 12 YO classification in the menu data in the external memory 100-1 and prices thereof is displayed on the display 8-1 in the default language (in English, for example) as shown in FIG. 87.

Then, when the player operates the “select” button 86e-1 beside the “on the rocks” on a menu screen 61F-1, for example, the item ordered by the player is specified as the “on the rocks” in the “Wild Turkey 12 YO”.

Here, “cancel” buttons 86d-1 on the menu screens 61C-1, 61D-1, 61E-1, and 61F-1 in FIG. 84 to FIG. 87 are buttons to be operated by the player for cancelling specification of the classification by the operations on the respective menu screens 61C-1, 61D-1, 61E-1, and 61F-1.

The content of the item ordered by the player thus specified is displayed on the shop display 86a-1 of the shop server 86-1 in the default language type (in English, for example).

In this configuration, the player is able to narrow down the classification of the item to order from the top rank to the bottom rank in the hierarchical structure and to specify the item to order eventually while confirming the information on the menu screens 61C-1, 61D-1, 61E-1, and 61F-1 on the display 8-1. Accordingly, it is possible to prevent an erroneous order of the item.

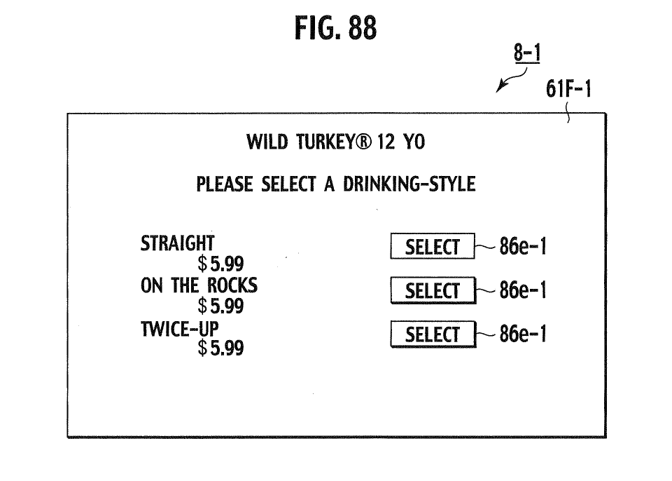

The above-described embodiment has described the case in which the default language type (English, for example) is determined as the language type used in the roulette game. However, when a different language type is determined as the language type used in the roulette game, the same language type is used on the menu screens 61C-1, 61D-1, 61E-1, and 61F-1. For example, when Japanese is designated as the language type to be used in the roulette game, the menu screens 61C-1, 61D-1, 61E-1, and 61F-1 shown in FIG. 84 to FIG. 87 are replaced by contents shown in FIG. 88 to FIG. 91, respectively.

At the same time, the “cancel” buttons 86d-1 and the “select” buttons 86e-1 on the menu screens 61C-1, 61D-1, 61E-1, and 61F-1 in FIG. 84 to FIG. 87 are replaced by “KYANSERU” (CANCEL) buttons 86d-1 and “SENTAKU” (SELECT) buttons 86e-1, respectively. Here, it is noted that “KYANSERU” and “SENTAKU” respectively represent Japanese language terms meaning “CANCEL” and “SELECT” phonetically, for illustrative purposes.

Here, when the eventually ordered items are presented to the player by means of the output of the sound message or of the display of the menu screen 61F-1, for example, the contents therein may only include the items affordable by the number of credits previously accumulated in the gaming terminal 4-1 and displayed on the credit number display unit 68-1 on the BET screen 61-1.

For example, an assumption will be made that the language type to be used in the game is not designated by the player, that the number of remaining credits displayed on the credit number display unit 68-1 is denominated in US dollars (USD), and that the value is equal to “6”. Here, another assumption will be made that the player designates the classification “Wild Turkey 12 YO” located in a place at certain ranks below the beverage classification.

In this case, among the original concrete items (“straight”, “on the rocks”, “twice-up”, “whiskey and soda”, and so on, for example) located below the Wild Turkey 12 YO classification as described previously, the item (“whiskey and soda”) requiring the unit price higher than 6 US dollars displayed on the credit number display unit 68-1 is deleted from the contents to be presented to the player by way of the sound message or the menu screen 61F-1 (see the menu screen 61F-1 in FIG. 88).

As shown in the drawing, the item requiring the unit price higher than the number of credits displayed on the credit number display unit 68-1 can be deleted from the contents to be presented to the player by comparing the number of remaining credits displayed on the credit number display unit 68-1 with the prices of the respective items in the menu data stored in the external storage device 100-1.

Meanwhile, the order processing in FIG. 82A, 82B or FIG. 83A, 83B may be configured by excluding the processing for suspending the acceptance of credits bet on the roulette game while the menu screen 61A-1 or 61B-1 is displayed on the display 8-1 to allow the player to order an item, that is, the processing performed with a combination of steps S343-1 and S354-1 with step S363-1.

Further, in the respective embodiments described above, the order is fixed at the point when the player eventually designates the item presented by the output of the sound message or by the display on the menu screen 61F-1. However, it is also possible to apply a configuration in which the item tentatively becomes an order candidate at the point of designation of the presented item and the item being the order candidate is duly determined as the order by an approval of the player afterwards.

When applying this configuration, the display 8-1 is configured to be able to switch the display between the BET screen 61-1 and the menu screen 61F-1 at any time by way of an instruction by the player.

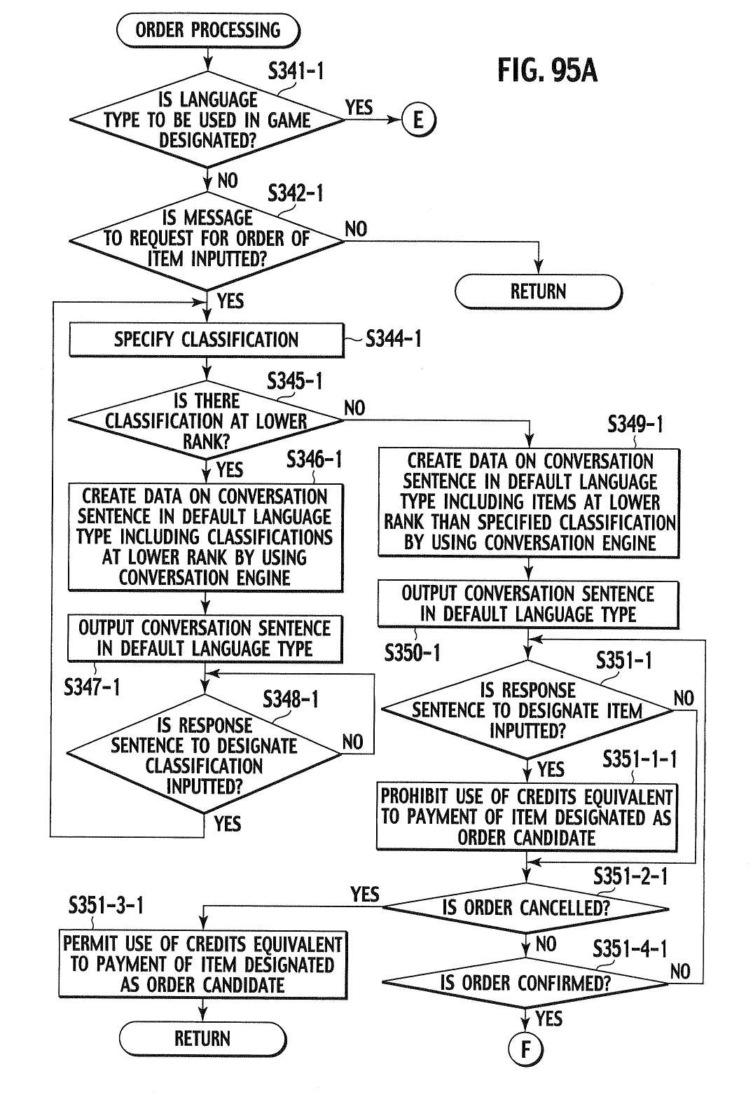

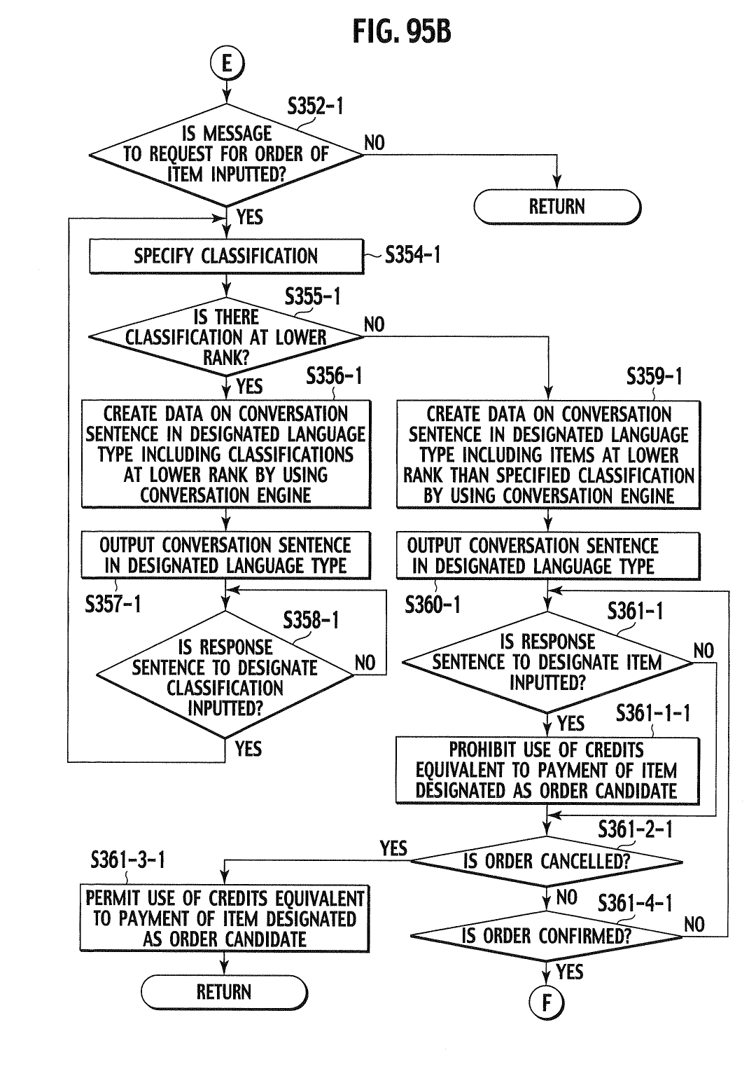

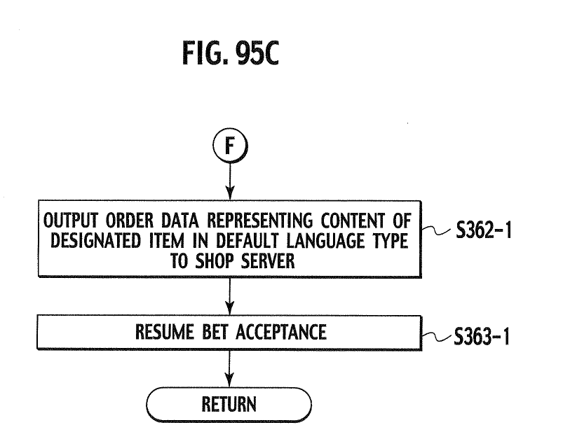

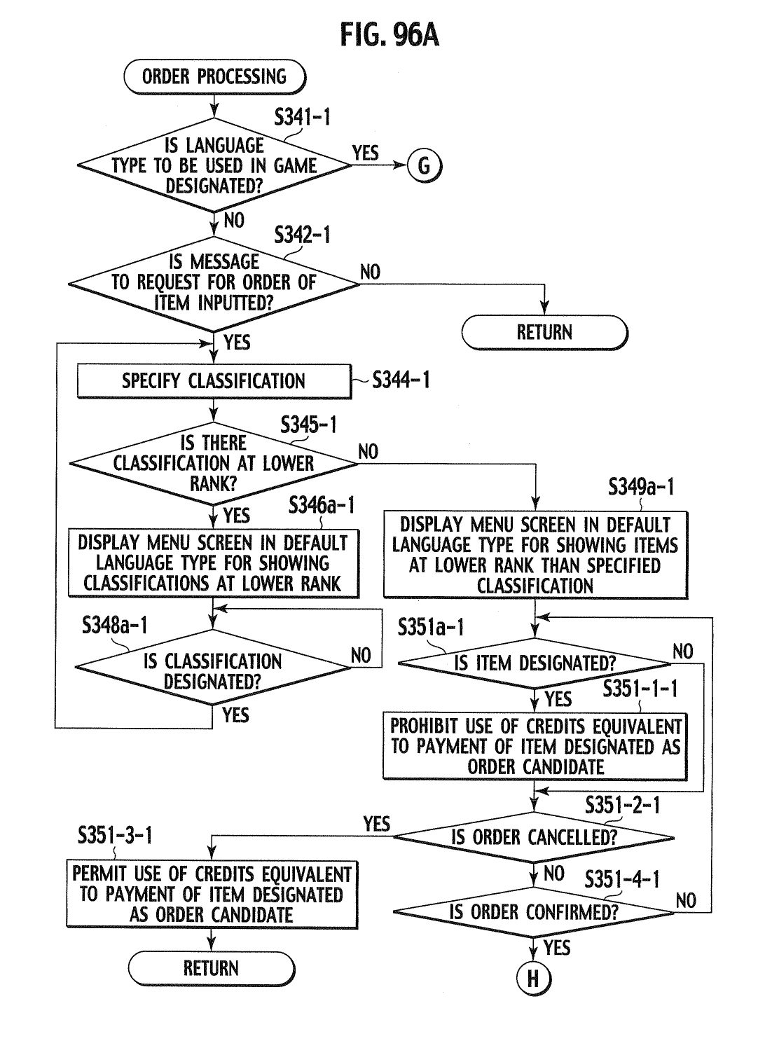

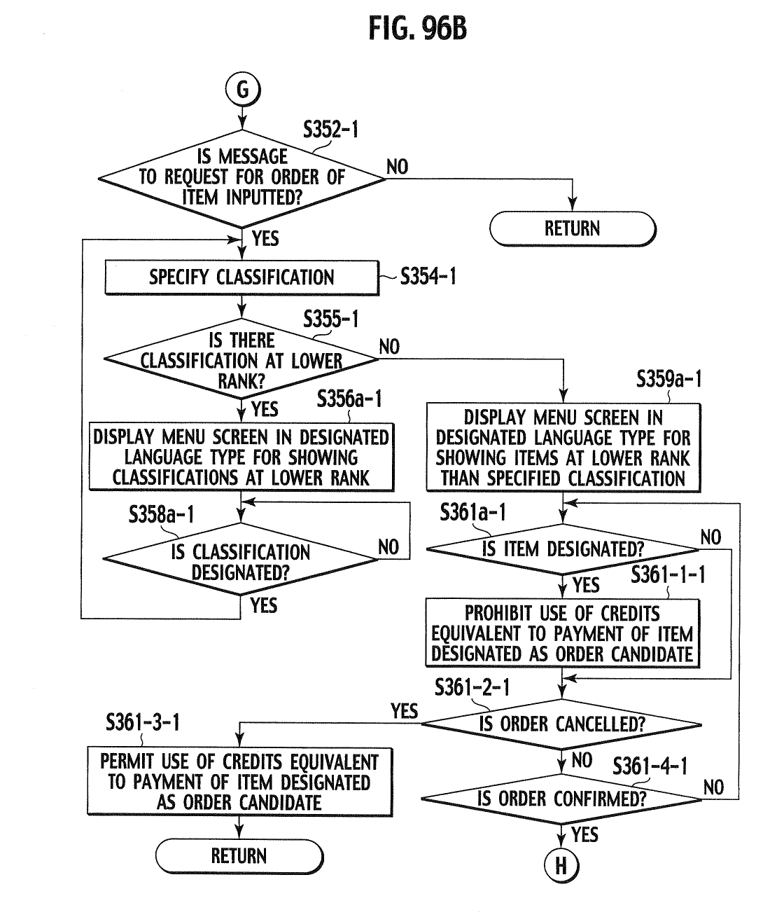

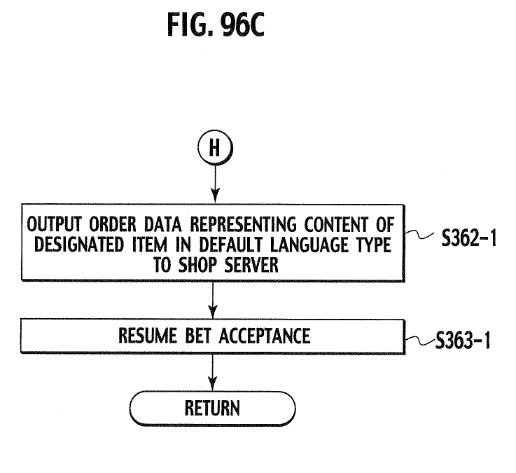

Then, the contents of the order processing in step S303-1 in FIG. 78 are partially changed from the contents shown in FIGS. 82A and 82B or FIGS. 83A and 83B into contents shown in FIGS. 95A and 95B or FIGS. 96A and 96B.

First, consider the case where the player narrows down the scope of the items from the top rank to the bottom rank in the hierarchical structure, and eventually specifies the item that the player wishes to order by means of exchanging the sound messages. In this case, as shown in FIG. 95A, if the player inputs the message to request the order of the item (YES) in step S342-1, then the terminal CPU 91-1 specifies the classification designated in the inputted message while skipping the processing in step S343-1 adopted in the flowchart in FIG. 82A (step S344-1).

Meanwhile, as shown in FIG. 95A, when no message (the response sentence) responding to the message (the conversation sentence) outputted in the form of the sound in step S350-1 and designating one of the items presented in the message is inputted in the default language type (English, for example) (NO in step S351-1), the terminal CPU 91-1 proceeds to step S351-2-1 to be described later.

On the other hand, when the message (the response sentence) to designate one of the presented items is inputted in the default language type (English, for example) (YES in step S351-1), the terminal CPU 91-1 determines that the item is designated as the order candidate and therefore prohibits use of the credits equivalent to a payment for the item designated as the order candidate to make a bet on the roulette game (step S351-1-1). Thereafter, the terminal CPU 91-1 proceeds to step S351-2-1 to be described later.

Here, prohibition of use of the credits equivalent to the payment for the item designated as the order candidate to make a bet on the roulette game can be achieved by updating the display of the number of remaining credits on the credit number display unit 68-1 on the BET screen 61-1 with the number of credits after subtracting the number equivalent to the payment for the item designated as the order candidate, for example.

In step S351-2-1, the terminal CPU 91-1 judges whether or not the order of the item is cancelled. Here, whether the order is canceled can be judged by checking whether or not the input unit 1100-1, which can be formed of the microphone 15-1, of the conversation controller 1000-1 receives an input of a sound message in the default language type (in English, for example) for representing cancellation of the order of the item.

The terminal CPU 91-1 proceeds to step S351-4-1 when the order of the item is not cancelled (NO in step S351-2-1). On the other hand, when the order of the item cancelled (YES in step S351-2-1), the terminal CPU 91-1 renders the credits equivalent to the payment for the item designated as the order candidate so far, usable for making a bet on the roulette game again (step S351-3-1). Thereafter, the terminal CPU 91-1 terminates the order processing.

Here, the action to render the credits equivalent to the payment for the item designated as the order candidate so far usable for making a bet on the roulette game again can be achieved by updating the display of the number of remaining credits on the credit number display unit 68-1 on the BET screen 61-1 with the number of credits after adding the number equivalent to the payment for the item designated as the order candidate so far.

In step S351-4-1, the terminal CPU 91-1 checks whether or not the order of the item designated as the order candidate in the default language type (in English, for example) in step S351-1 is confirmed.

Here, whether the order is canceled can be confirmed by checking whether or not the input unit 1100-1, which can be formed of the microphone 15-1, of the conversation controller 1000-1 receives an input of a sound message in the default language type (in English, for example) for confirming the order.

The terminal CPU 91-1 proceeds to step S351-1 when the order of the item is not confirmed (NO in step S351-4-1). On the other hand, as shown in FIG. 95C, the terminal CPU 91-1 proceeds to step S352-1 and so forth shown in FIG. 82B when the order of the item is confirmed (YES in step S351-4-1).

Next, if the message to request the order of item is inputted (YES) in step S352-1 in FIG. 95B transited from step S341-1 in FIG. 95A when the language type to be used in the game is designated (YES), the terminal CPU 91-1 specifies the classification designated by the inputted message (step S354-1) while skipping the processing in step S343-1 previously carried out in the flowchart in FIG. 82A.

Meanwhile, as shown in FIG. 95B, when the message (the response sentence) corresponding to the message (the conversation sentence) outputted in the form of the sound in step S360-1 and designating one of the items presented in that message is not inputted (NO) by using the language type designated in step S341-1 (Japanese, for example) in step S361-1, the terminal CPU 91-1 proceeds to step S361-2-1 to be described later.

On the other hand, when the message (the response sentence) to designate one of the presented items is inputted in the language type designated in step S 341-1 (Japanese, for example) (YES in step S361-1), the terminal CPU 91-1 determines that the item is designated as the order candidate and therefore prohibits use of credits equivalent to the payment for the item designated as the order candidate to make a bet on the roulette game (step S361-1-1). Thereafter, the terminal CPU 91-1 proceeds to step S361-2-1 to be described later.

In step S361-2-1, the terminal CPU 91-1 judges whether or not the order of the item is cancelled. Here, the presence of cancellation of the order can be judged by checking whether or not the input unit 1100-1, which can be formed of the microphone 15-1, of the conversation controller 1000-1 receives an input of a sound message in the language type designated in step S341-1 (in Japanese, for example) for representing cancellation of the order of the item

The terminal CPU 91-1 proceeds to step S361-4-1 when the order of the item is not cancelled (NO in step S361-2-1). On the other hand, when the order of the item cancelled (YES in step S361-2-1), the terminal CPU 91-1 renders the credits equivalent to the payment for the item designated as the order candidate so far, usable for making a bet on the roulette game again (step S361-3-1). Thereafter, the terminal CPU 91-1 terminates the order processing.

In step S361-4-1, the terminal CPU 91-1 checks whether or not the order of the item designated as the order candidate in the language type designated in step S341-1 (in Japanese, for example) in step S361-1 is confirmed.

Here, the presence of confirmation of the order can be confirmed by checking whether or not the input unit 1100-1, which can be formed of the microphone 15-1, of the conversation controller 1000-1 receives an input of a sound message in the language type designated in step S341-1 (in Japanese, for example) for confirming the order.

The terminal CPU 91-1 proceeds to step S361-1 when the order of the item is not confirmed (NO in step S361-4-1). On the other hand, as shown in FIG. 95C, the terminal CPU 91-1 proceeds to step S352-1 and so forth shown in FIG. 82B when the order of the item is confirmed (YES in step S361-4-1).

Next, consider the case where the player narrows down the scope of the items from the top rank to the bottom rank in the hierarchical structure, and eventually specifies the item that the player wishes to order, while visually confirming the operations on the menu screens 61C-1, 61D-1, 61E-1, and 61F-1 on the display 8-1. In this case, if the player inputs the message to request the order of the item as shown in FIG. 96A (YES in step S342-1), then the terminal CPU 91-1 specifies the classification designated in the inputted message, while skipping the processing in step S343-1 adopted in the flowchart in FIG. 83A (step S344-1).

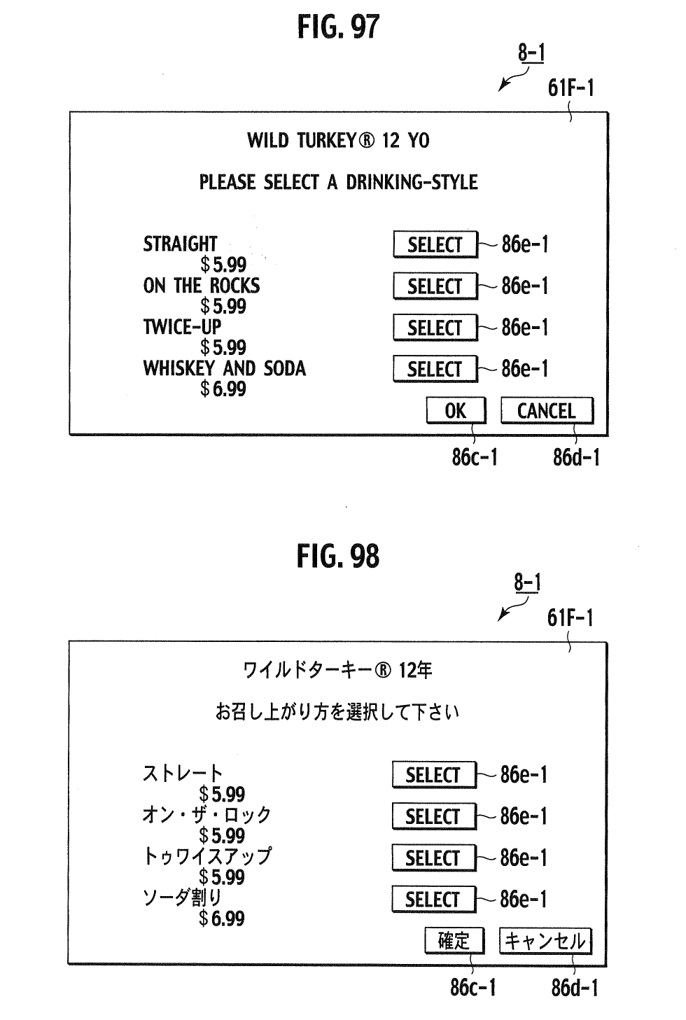

Meanwhile, as shown in FIG. 96A, when the player does not designate one of the items presented on the menu screen 61F-1 (NO in step S351a-1) by means of the operation on the menu screen 61F-1 (see FIG. 97) in the default language type (in English, for example) displayed on the display 8-1 in step S349a-1, the terminal CPU 91-1 proceeds to step S351-2-1 to be described later.

On the other hand, when one of the presented items is designated by the player (YES in step S351a-1), the terminal CPU 91-1 determines that the item is designated as the order candidate and therefore prohibits use of credits equivalent to the payment for the item designated as the order candidate to make a bet on the roulette game (step S351-1-1). Thereafter, the terminal CPU 91-1 proceeds to step S351-2-1 to be described later.

In step S351-2-1, the terminal CPU 91-1 judges whether or not the order of the item is cancelled. Here, the presence of cancellation of the order can be confirmed by checking whether or not the touch panel 50-1 detects an operation of a “CANCEL” button 86d-1 prior to confirmation of the order by operating the “OK” button 86c-1, which are additionally provided on the menu screen 61F-1 as shown in FIG. 97.

The terminal CPU 91-1 proceeds to step S351-4-1 when the order of the item is not cancelled (NO in step S351-2-1). When the order of the item cancelled (YES in step S351-2-1), the terminal CPU 91-1 renders the credits equivalent to the payment for the item designated as the order candidate so far, usable for making a bet on the roulette game again (step S351-3-1). Thereafter, the terminal CPU 91-1 terminates the order processing.

In step S351-4-1, the terminal CPU 91-1 checks whether or not the order of the item designated as the order candidate in the default language type (in English, for example) in step S351a-1 is confirmed.

Here, as shown in FIG. 97, the presence of confirmation of the order can be confirmed by checking whether or not the touch panel 50-1 detects confirmation of the order by operating the “OK” button 86c-1 prior to cancellation of the order by operating the “CANCEL” button 86d-1.

The terminal CPU 91-1 proceeds to step S351a-1 when the order of the item is not confirmed (NO in step S351-4-1). On the other hand, as shown in FIG. 96C, the terminal CPU 91-1 proceeds to step S362-1 and so forth shown in FIG. 82B when the order of the item is confirmed (YES in step S351-4-1).

Next, if the message to request the order of item is inputted (YES) in step S352-1 in FIG. 96B transited from step S341-1 in FIG. 96A when the language type to be used in the game is designated (YES), the terminal CPU 91-1 specifies the classification designated by the inputted message (step S354-1) while skipping the processing in step S343-1 previously carried out in the flowchart in FIG. 83A.

Meanwhile, as shown in FIG. 96A, when the player does not designate one of the items presented on the menu screen 61F-1 in step S361a-1 (NO) by means of the operation on the menu screen 61F-1 (see FIG. 98) in the language type designated in step S341-1 (Japanese, for example) displayed on the display 8-1 in step S359a-1, the terminal CPU 91-1 proceeds to step S361-2-1 to be described later.

On the other hand, when one of the presented items is designated by the player (YES in step S361a-1), the terminal CPU 91-1 determines that the item is designated as the order candidate and therefore prohibits use of credits equivalent to the payment for the item designated as the order candidate to make a bet on the roulette game (step S361-1-1). Thereafter, the terminal CPU 91-1 proceeds to step S361-2-1 to be described later.

In step S361-2-1, the terminal CPU 91-1 judges whether or not the order of the item is cancelled. Here, the presence of cancellation of the order can be confirmed by checking whether or not the touch panel 50-1 detects an operation of the “KYANSERU” (CANCEL) button 86d-1 prior to confirmation of the order by operating a “KAKUTEI” (OK) button 86c-1, which are additionally provided on the menu screen 61F-1 as shown in FIG. 98. Here, it is noted that “KAKUTEI” represents a Japanese language term meaning “OK” phonetically, for illustrative purposes.

The terminal CPU 91-1 proceeds to step S361-4-1 when the order of the item is not cancelled (NO in step S361-2-1). When the order of the item cancelled (YES in step S361-2-1), the terminal CPU 91-1 renders the credits equivalent to the payment for the item designated as the order candidate so far, usable for making a bet on the roulette game again (step S361-3-1). Thereafter, the terminal CPU 91-1 terminates the order processing.

In step S361-4-1, the terminal CPU 91-1 checks whether or not the order of the item designated as the order candidate in step S361a-1 in the language type designated in step S341-1 (in Japanese, for example) is confirmed.

Here, as shown in FIG. 98, the presence of confirmation of the order can be confirmed by checking whether or not the touch panel 50-1 detects confirmation of the order by operating the “KAKUTEI” (OK) button 86c-1 prior to cancellation of the order by operating the “KYANSERU” (CANCEL) button 86d-1.

Then, the terminal CPU 91-1 proceeds to step S361a-1 when the order of the item is not confirmed (NO in step S361-4-1). On the other hand, as shown in FIG. 96C, the terminal CPU 91-1 proceeds to step S362-1 and so forth shown in FIG. 83B when the order of the item is confirmed (YES in step S361-4-1).

In this configuration, it is possible to make a bet of credits on the roulette game even in the course of placing the order of the item by switching the display on the display 8-1 from the menu screen 61F-1 to the BET screen 61-1. Moreover, the credits equivalent to the payment for the item designated as the order candidate cannot be used as resources for making a bet on the roulette game unless the order is cancelled. Therefore, it is possible to secure the credits equivalent to the payment for the item when the order is confirmed.

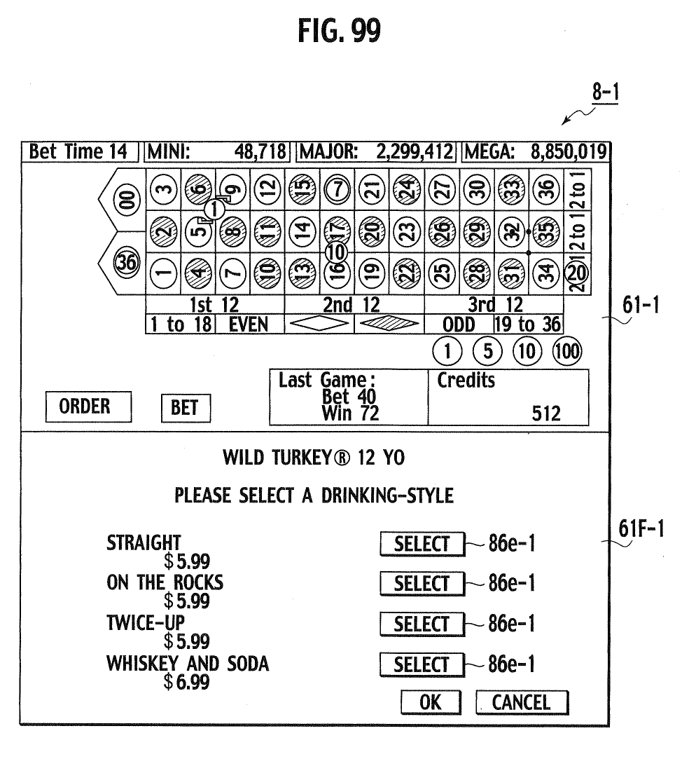

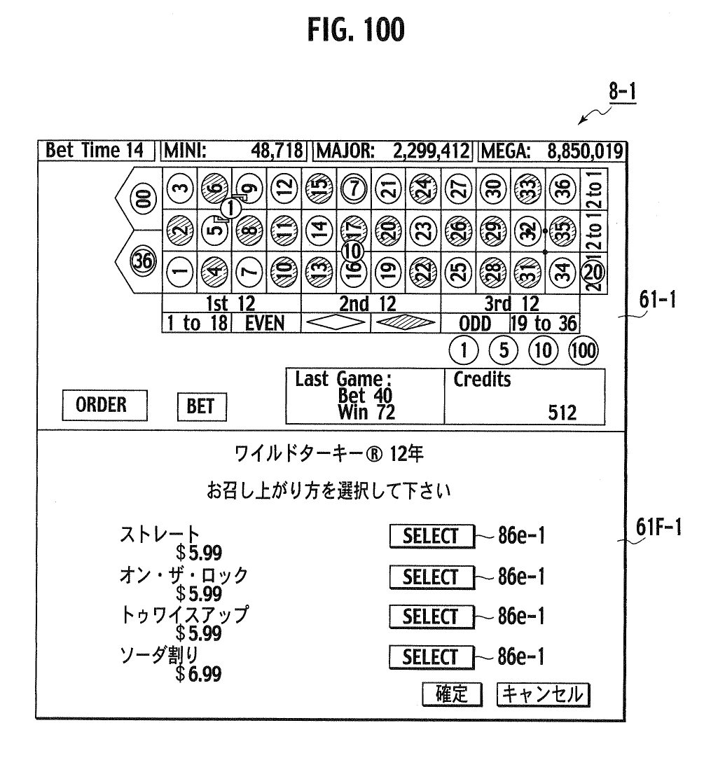

Here, instead of switching the display on the display 8-1 between the BET screen 61-1 and the menu screen 61F-1 at any time by the instruction from the player, it is also possible to display the BET screen 61-1 and the menu screen 61F-1 at the same time as shown in FIG. 99 or FIG. 100 by using half areas on the display 8-1 respectively for displaying the BET screen 61-1 and the menu screen 61F-1.

Incidentally, each of FIG. 99 and FIG. 100 illustrates the example of displaying the menu screen 61F-1 as shown in FIG. 97 or FIG. 98 and the BET screen 61-1 as shown in FIG. 50 at the same time. Instead, it is also possible to display any of the menu screens 61C-1, 61D-1, and 61E-1 as shown in FIG. 84 to FIG. 86 and FIG. 89 to FIG. 91 simultaneously with the BET screen 61-1 as shown in FIG. 50.

However, when displaying any of the menu screens 61C-1, 61D-1, and 61E-1 as shown in FIG. 84 to FIG. 86 and FIG. 89 to FIG. 91 simultaneously with the BET screen 61-1 as shown in FIG. 50, it is necessary to add the “OK” button 86c-1 and the “CANCEL” button 86d-1 or the “KAKUTEI” (OK) button 86c-1 and the “KYANSERU” (CANCEL) button 86d-1 to the menu screens 61C-1, 61D-1, and 61E-1 as similar to the menu screens 61F-1 in FIG. 97 and FIG. 98.

Moreover, it is not always necessary to use the order data outputted in step S362-1 in the order processing shown in FIG. 82B or FIG. 83B of the above-described embodiments solely for the purpose of display in the default language (in English, for example) on the shop display 86a-1 of the shop server 86-1. For example, it is also possible to use the data directly on the shop server 86-1 for other purposes including management of the ordered items.

### Third and Fourth Embodiments

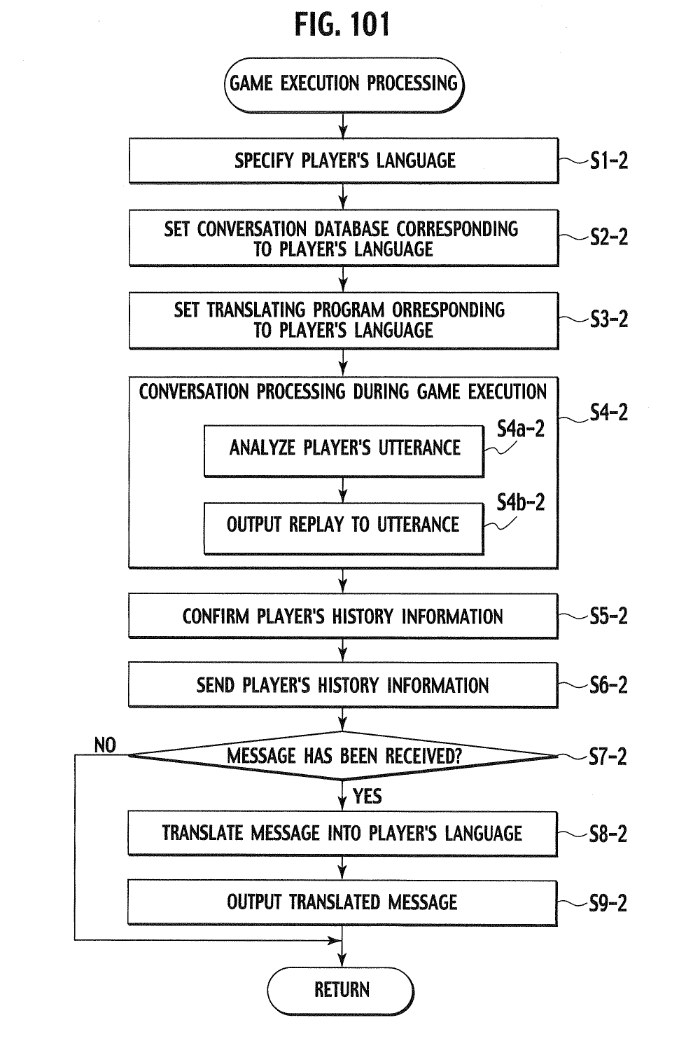

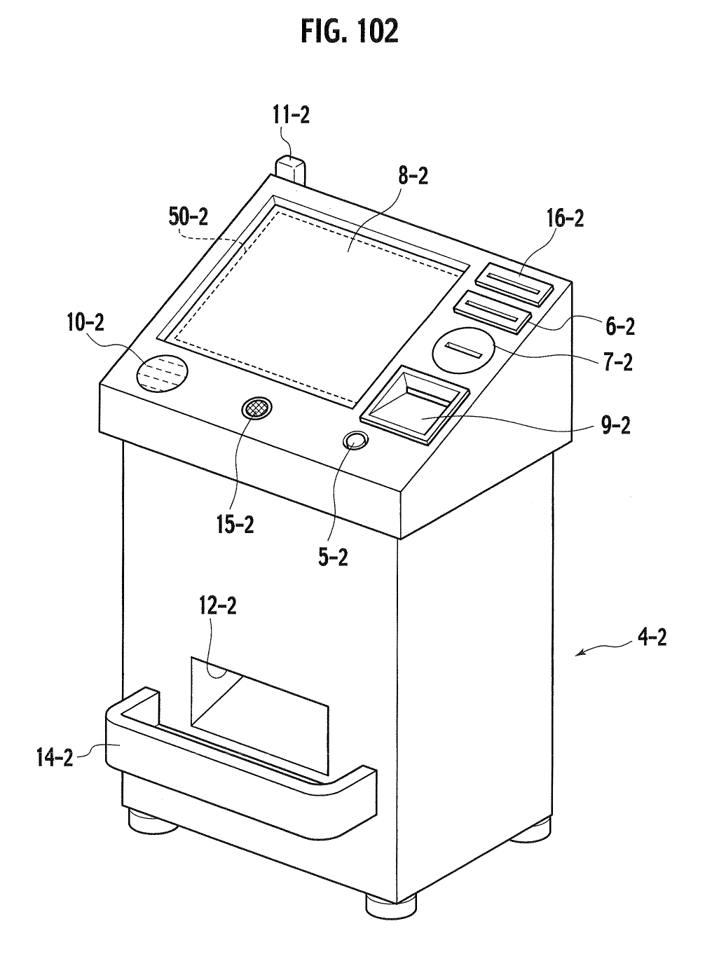

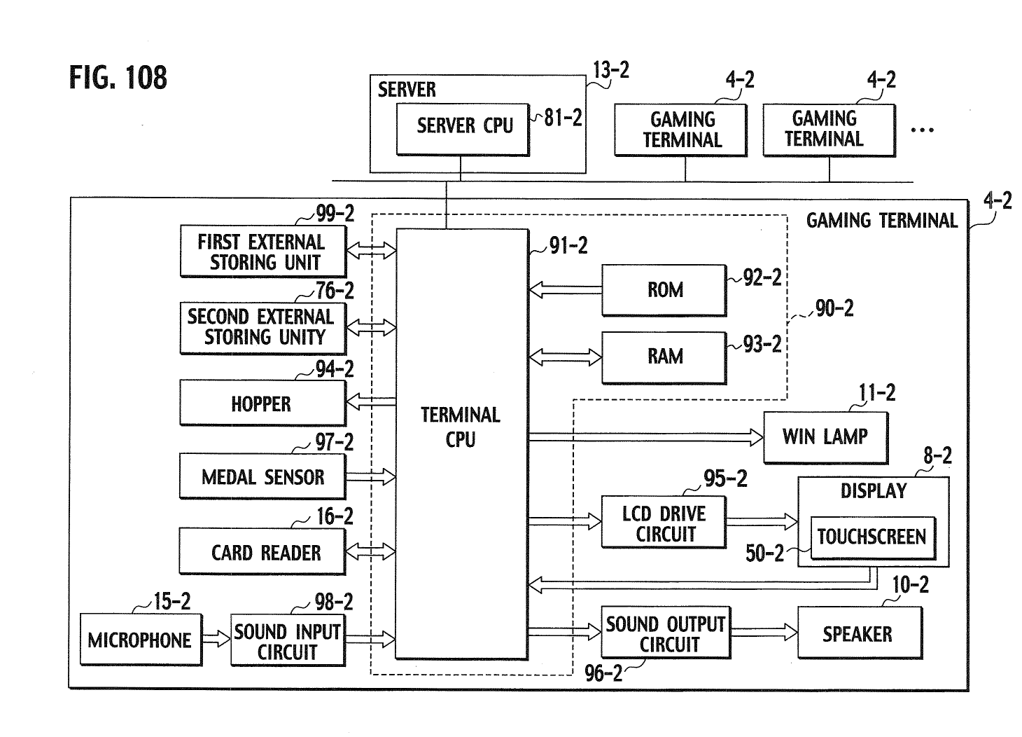

FIG. 101 is a flow chart showing a general process flow of game execution processing executed in a gaming system according to third and fourth embodiments of the present invention. FIG. 102 is a perspective view showing a gaming terminal 4-2 provided in a plurality in the gaming system according to the third and fourth embodiments of the present invention. FIG. 108 is a block diagram showing an internal configuration of the gaming system. Hereinafter, the general process flow in the gaming system according to the present invention will be explained with reference to the drawings.

A terminal CPU 91-2 shown in FIG. 108 confirms a player's language on a gaming terminal 4-2 through a player's input operation or an after-mentioned conversation engine (step S1-2 in FIG. 101). A recognition processing of language will be explained later.

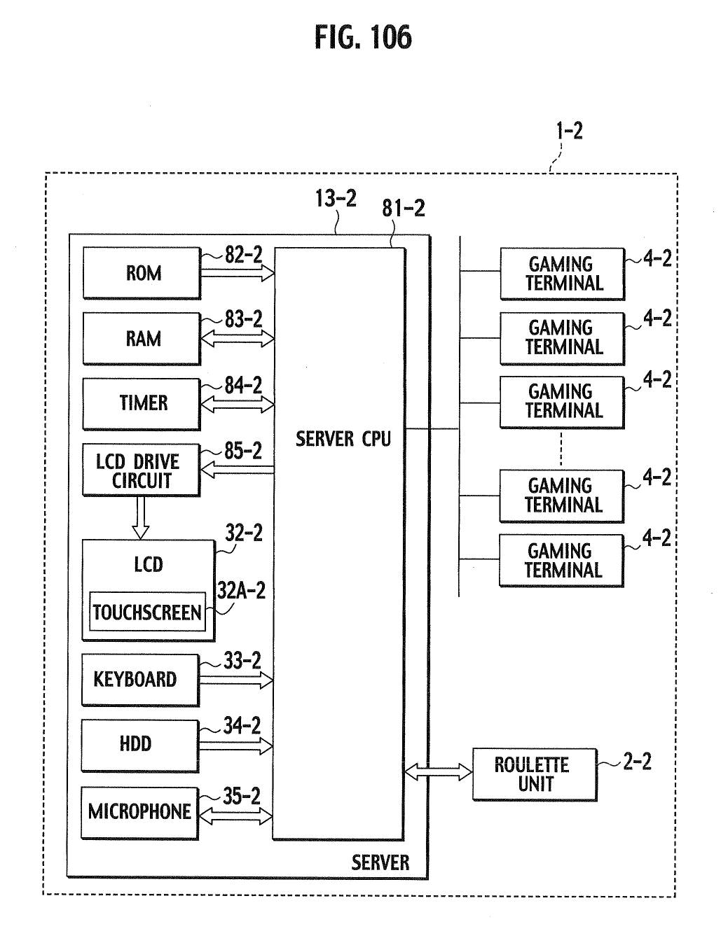

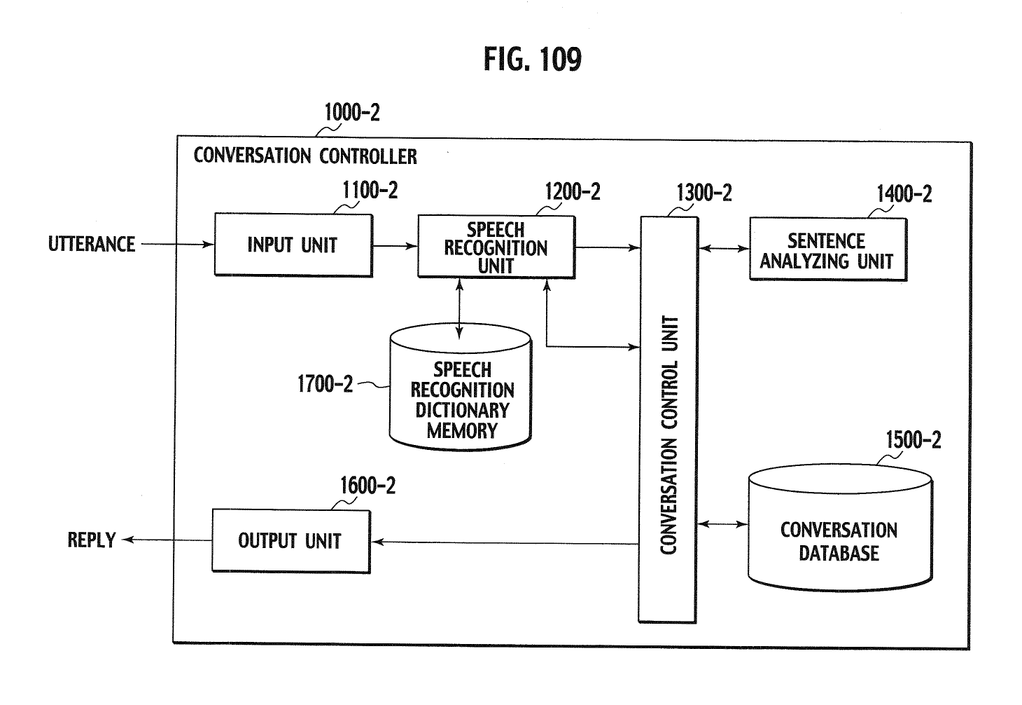

Next, the terminal CPU 91-2 configures a conversation database 1500-2 corresponding to the language confirmed in the process of step S1-2 among a conversation database 1500-2 (see FIG. 109) stored in a hard disc drive (HDD) 34-2 of a server 13-2 shown in FIG. 106 and corresponding to plural languages (step S2-2). For example, if the player's language is “Japanese”, a conversation database 1500-2 corresponding to “Japanese” is configured.

The terminal CPU 91-2 configures a translating program corresponding to the language confirmed in the process of step S1-2 from translating programs which are stored in the HDD 34-2 of the server 13-2 shown in FIG. 106 and correspond to plural languages (step S3-2). For example, if the player's language is “Japanese”, a “Japanese-English” translating program is configured.

Subsequently, the terminal CPU 91-2 executes a roulette game with conducting a conversation with the player using a conversation engine (step S4-2).

In a conversational processing during a roulette game execution, an utterance input into a microphone 15-2 of the gaming terminal 4-2 is analyzed (step S4a-2). Then, a reply to the utterance is generated by the conversation engine and the generated reply is output as sound from a speaker 10-2 (step S4b-2).

For example, if the player makes an utterance “Tell me how to place a bet. (in Japanese)” into the microphone 15-2, the conversation engine analyzes the utterance using the Japanese conversation database and outputs a reply “Please insert medals into a medal insertion slot or press bet buttons.” from the speaker 10-2 in Japanese. Since the terminal CPU 91-2 outputs the reply in the player's language, the player can easily understand a message output from the gaming terminal 4-2.

In addition, the terminal CPU 91-2 read out history information stored in a smart card had been inserted in a card reader 16-2 shown in FIG. 102 to confirm the history information (step S5-2). The history information includes, for example, information on a restaurant(s) previously visited by the player, information on a souvenir(s) previously purchased by the player and so on.

Next, the terminal CPU 91-2 sends the confirmed history information to the server 13-2 (step S6-2).

And then, the terminal CPU 91-2 determines whether or not a message sent from the server 13-2 has been received (step S7-2). If the message has been received, the terminal CPU 91-2 translates this message into the player's language (for example, Japanese) using the translating program (step S8-2). For example, if a message “We are pleased to announce that we have this year's Beaujolais Nouveau in stock now. We are looking forward to your order.” has been received, this message is translated into Japanese.

Then, the terminal CPU 91-2 displays the translated message on a display 8-2 to notify the player of it (step S9-2). In addition, the message is converted into a sound signal by the conversation engine and is output from the speaker 10-2.

Therefore, a message(s) suitable for each player can be provided to the gaming terminals 4-2. In addition, since the massage(s) sent to each of the gaming terminals 4-2 is translated to the player's language to be output as sounds or images, the player can recognize the message contents with ease.

### Third Embodiment

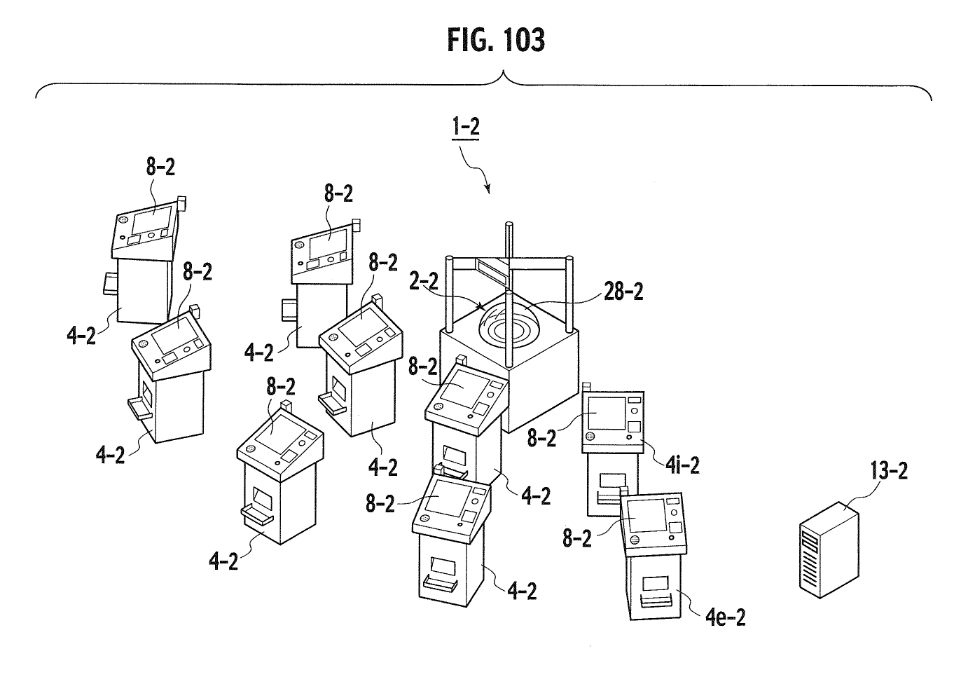

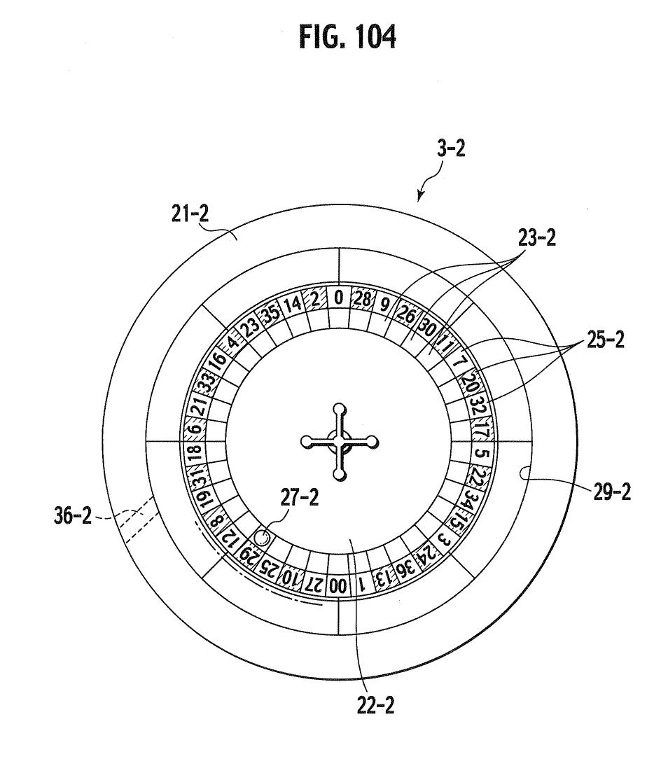

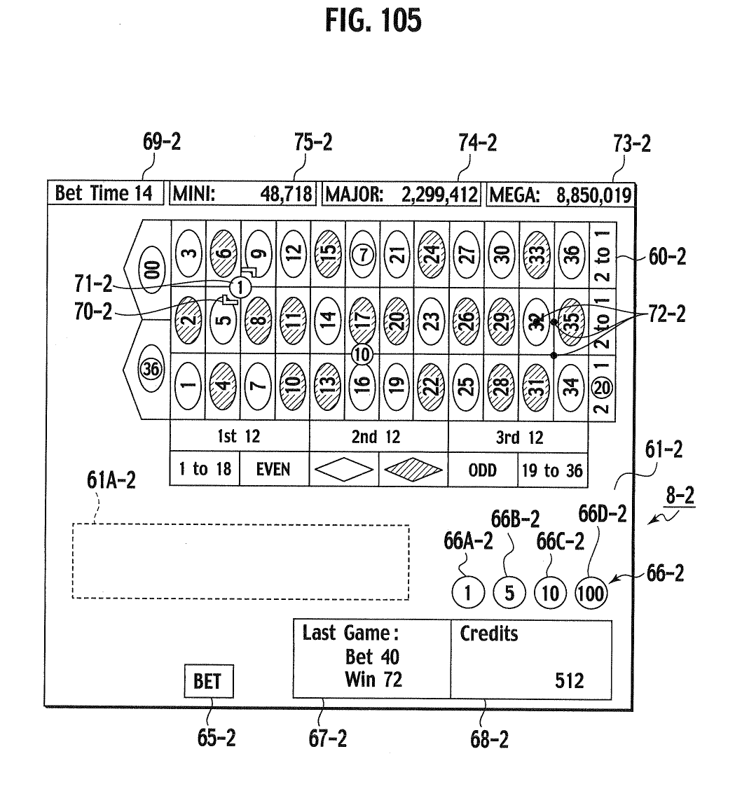

Next, a gaming system in the embodiments according to the present invention will be explained in detail. FIG. 102 is a perspective view showing a gaming terminal in the third embodiment according to the present invention. FIG. 103 is an apparent perspective view showing a general configuration of a roulette game machine 1-2 including the gaming terminal shown in FIG. 102, which is an example of the gaming system of the embodiment according to the present invention. FIG. 104 is a plan view of a roulette unit 2-2 provided in the roulette game machine 1-2. FIG. 105 is a screen image example displayed on a display of the gaming terminal shown in FIG. 102.

Plural (nine in the drawing) gaming terminals 4-2 in the third embodiment shown in FIG. 102 are provided as parts of the roulette game machine 1-2 shown in FIG. 103. In addition, the roulette game machine 1-2 includes the roulette unit 2-2 and a server (host server) 13-2. Each of the gaming terminals 4-2, the roulette unit 2-2 and the server 13-2 can be connected each other via a local network and so on.

At the roulette unit 2-2, the roulette game will be executed under the control of the server 13-2, and the game can be visible by players. Players use the gaming terminals 4-2 which are arranged around the roulette unit 2-2 to participate in a roulette game displayed by the roulette unit 2-2. In the present embodiment, the roulette game machine 1-2 includes the nine gaming terminals 4-2. Therefore, up to nine players can participate in a communal roulette game simultaneously.

A roulette game displayed on the roulette unit 2-2 is executed repeatedly at prescribed time intervals under the control of the server 13-2. Accordingly, a player who participates in a game play with each of the gaming terminals 4-2 can place a bet for a current roulette game. A display 8-2 is provided at each of the gaming terminals 4-2 for placing the bet on the current roulette game. A betting screen 61-2 (see FIG. 105) for betting on a roulette game is displayed on the display 8-2. Displayed contents on the betting screen 61-2 will be explained later in detail.

FIG. 104 is a plan view of the roulette unit provided in the roulette game machine shown in FIG. 103. As shown in FIG. 104, the roulette unit 2-2 includes a frame 21-2 and a roulette wheel 22-2 which is accommodated and supported rotatably inside the frame 21-2. Plural number pockets 23-2 (thirty-eight in total in the present embodiment) are formed on an upper surface of the roulette wheel 22-2. In addition, number plates 25-2 are provided on an upper surface of the roulette wheel 22-2 outside the number pockets 23-2 for displaying numbers “0”, “00” and “1” to “36” in correspondence to the respective number pockets 23-2.

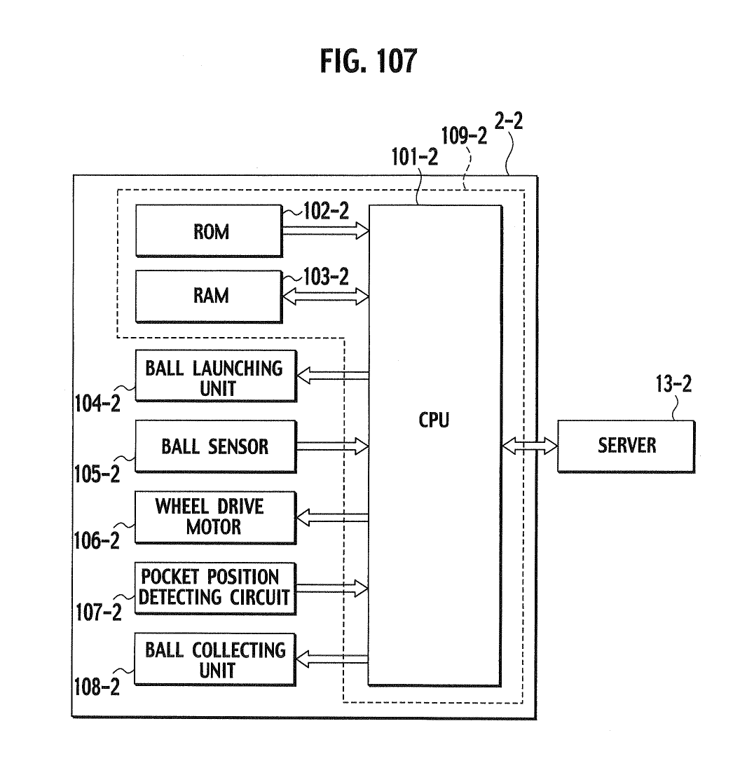

A ball launching port 36-2 is provided inside the frame 21-2. A ball launching unit 104-2 (see FIG. 107) is coupled with the ball launching port 36-2. With driving the ball launching unit 104-2, a ball 27-2 is launched from the ball launching port 36-2 onto the roulette wheel 22-2. In addition, the entire roulette unit 2-2 is covered by a hemispherical transparent acrylic cover 28-2 (see FIG. 103) covers over.

A wheel drive motor 106-2 (see FIG. 107) is provided beneath the roulette wheel 22-2. As the wheel drive motor 106-2 is driven, the roulette wheel 22-2 spins. Metal plates (not shown) are attached on a back surface of the roulette wheel 22-2 with space apart each other at prescribed intervals. A proximity sensor of a pocket position detecting circuit 107-2 (see FIG. 107) detects these metal plates to detect the positions of the number pockets 23-2.

The frame 21-2 is moderately inclined toward its inner side and the guide wall 29-2 is formed around an intermediate circumference of the frame 21-2. The guide wall 29-2 guides the launched ball 27-2 to spin with counterworking a centrifugal force of the ball 27-2. The ball 27-2, as its velocity slows down, loses its centrifugal force and rolls down on the inclined surface of the frame 21-2. And then, the ball 27-2 reaches the spinning roulette wheel 22-2 and gets across the number plates 25-2. The ball 27-2 falls into one of the number pockets 23-2. As a result, the number of the number plate 25-2 corresponding to the number pocket 23-2 into which the ball 27-2 has fallen, is detected by a ball sensor 105-2 and determined as a winning number.

Next, the configuration of the gaming terminal 4-2 will be explained.

As shown in FIG. 102, the gaming terminal 4-2 includes at least a medal insertion slot 7-2 for inserting game media having currency values such as cash, chips, medals and so on, and the above-mentioned display 8-2 for displaying images related to the game on its upper surface. The gaming terminal 4-2 accepts a player's betting operation via the medal insertion slot 7-2 and the display 8-2. A player can advance a displayed game by operating a touchscreen 50-2 (see FIGS. 102 and 108) provided on an upper surface of the display 8-2 and so on while watching the images displayed on the display 8-2. Note that, in the following explanation, the game media may be referred as their representative “medals”.

In addition to the medal insertion slot 7-2 and the display 8-2 described above, a payout button 5-2, a ticket printer 6-2, a bill insertion slot 9-2, a speaker 10-2, a microphone 15-2 and a card reader 16-2 are provided on the upper surface of the gaming terminal 4-2. A medal payout chute 12-2 and a medal tray 14-2 are provided on a front face of the gaming terminal 4-2.

The payout button 5-2 is a button for inputting a command for paying out credited medals from the medal payout chute 12-2 onto the medal tray 14-2. The ticket printer 6-2 prints out a bar code ticket including the data such as the credits, the date, and the identification number of the gaming terminal 4-2. A player can use the bar code ticket at another gaming terminal 4-2 to place a bet on a game at that gaming terminal 4-2 or can exchange the bar code ticket to bills and so on at a prescribed location in a gaming facility (for example, a cashier in a casino).

The bill insertion slot 9-2 judges the legitimacy of bills and accepts legitimate bills. The speaker 10-2 outputs music, effect sounds, sound messages for a player and so on. The microphone 15-2 collects sound messages uttered by a player.

A smart card can be inserted into the card reader 16-2. The card reader 16-2 reads data from the inserted smart card and writes data into the inserted card. The smart card is carried by a player and corresponds to the player's member's card, credit card or the like.

A smart card stores data about playing history played by a player (history information) together with data for identifying the player. Information on game kinds played, points provided in played games, language kind used by the player in game plays and so on are included in the history data.

Furthermore, data equivalent to coins, bills or credits are stored in a smart card and items can be purchased with the smart card. In addition, information such as a restaurant(s) previously visited, a beverage(s) previously ordered, a purchased souvenir(s) and so on can be stored in the smart card in addition to information on the game plays.

Read-from/write-into method with a smart card may employ contact type or non-contact type (RFID type). Alternatively, a magnetic stripe card may be employed.

In addition, since a smart card is inserted into the card reader 16-2 when a player participates in a game at the gaming terminal 4-2, it can be detected whether or not a player is at the gaming terminal by detecting whether or not a smart card has been inserted in the card reader 16-2. In other words, the card reader 16-2 functions as a detecting sensor to detect a presence of a player.

In addition, in respect to the detecting sensor, it may be possible to detect a presence of a player based on data detected by a pressure sensor provided on a seat on which a player sits or images captured by a camera provided at the gaming terminal 4-2.

A WIN lamp 11-2 is provided on an upper portion of the display 8-2 of each gaming terminal 4-2. In the case where the number (“0”, “00” and “1” to “36” in the present embodiment) on which a bet has been placed at the gaming terminal 4-2 in a game comes to a winning number, the WIN lamp 11-2 of the winning gaming terminal 4-2 will be turned on. In addition, in the jackpot (referred hereafter also as JP) bonus game for awarding JP, the WIN lamp 11-2 of the JP winning gaming terminal 4-2 will be turned on similarly. Note that the WIN lamp 11-2 is provided at a position that is visible from all of the arranged gaming terminals 4-2 (nine in the present embodiment) so that other players playing at the same roulette game machine 1-2 can always check turning-on of the WIN lamp 11-2.

A medal sensor 97-2 (see FIG. 108) is provided inside the medal insertion slot 7-2. The medal sensor 97-2 identifies medals inserted into the medal insertion slot 7-2 and counts the inserted medals. In addition, a hopper 94-2 (see FIG. 108) is provided inside the medal payout chute 12-2. The hopper 94-2 payouts a prescribed number of medals from the medal payout chute 12-2.

FIG. 105 is a diagram showing a screen image example displayed on the display 8-2. A betting screen 61-2 shown in FIG. 105 is displayed on the display 8-2 on each of the gaming terminals 4-2. The betting screen 61-2 includes a table-type betting board 60-2. A player can place a bet by operating a touchscreen 50-2 (see FIG. 108) provided on a front surface of the display 8-2, by using own chips, which are credited as an electronic data in the gaming terminal 4-2.

Specifically, a player pointed out a bet area 72-2 (in a section of a number or a section of a number's mark, or on a grid line(s)) to place a chip for betting by a cursor 70-2. Then, a bet chip amount is set by bet buttons 66-2 and the bet chip amount is fixed by a bet fixing button 65-2. These setting and fixing are executed by player's fingers directly touching on the bet areas 72-2, the bet buttons 66-2 and bet fixing button 65-2 displayed on the display 8-2.

Note that the bet buttons 66-2 are provided with four kinds of buttons, a one-bet button 66A-2, a five-bet button 66B-2, a ten-bet button 66C-2 and a one-hundred-bet button 66D-2 for a bet chip amount capable of being placed by one operation.

A payout counter 67-2 displays a player's bet chip amount and a payout credits amount for a payout in the last game. In addition, a credit counter 68-2 displays the current credits owned by a player. Furthermore, a bet time counter 69-2 displays remaining time in which a player can place a bet.

Note that the next game starts at the time when the ball 27-2 launched onto the roulette wheel 27-2 fell into any one of the number pockets 23-2 and the current game has ended.

A MEGA counter 73-2 displaying a credit amount accumulated for a “MEGA” JP, a MAJOR counter 74-2 displaying a credit amount accumulated for a “MAJOR” JP and a MINI counter 75-2 displaying the number of credits accumulated for a “MINI” JP are provided at the right side of the bet time counter 69-2. If any one of the JP's is won in a JP bonus game, a credit amount is awarded according to the winning JP among the JP's displayed on the counters 73-2 to 75-2 and then an initial value (200 credits for “MINI”, 5000 credits for “MAJOR” and 50000 credits for “MEGA”) is displayed the corresponding counter.

In addition, a display area 61A-2 is provided on a lower-left corner on the betting screen 61-2. A message(s) to the player is displayed in the display area 61A-2. Details will be explained later.

FIG. 106 is a block diagram showing an internal configuration of the roulette game machine 1-2 according to the present embodiment. As shown in FIG. 106, the roulette game machine 1-2 is configured with the server 13-2, the roulette unit 2-2 connected to the server 13-2 via the local network and the plural gaming terminals 4-2 (nine in the present embodiment). Note that an internal configuration of the roulette unit 2-2 and an internal configuration of the gaming terminals 4-2 will be described later in detail.

The server 13-2 shown in FIG. 106 includes a server CPU 81-2 for executing the overall control of the server 13-2, a ROM 82-2, a RAM 83-2, a timer 84-2, an LCD (liquid crystal display) 32-2 connected via an LCD driving circuit 85-2, a touchscreen 32A-2 provided on a surface of the LCD 32-2, a keyboard 33-2, the HDD 34-2 and a microphone 35-2 into which a user's voices is input.

The server CPU 81-2 executes various processings according to input signals supplied from the gaming terminals 4-2 and data and programs stored in the ROM 82-2 and the RAM 83-2. In addition, the server CPU 81-2 sends command signals to the gaming terminals 4-2 according to the processing results to control the gaming terminals 4-2 under its initiative. Specifically, the server CPU 81-2 transmits control signals to the roulette device 2-1 to control launching of the ball 27-2 and spinning of the roulette wheel 22-2.

The ROM 82-2 is configured by a semiconductor memory or the like and stores programs which implement basic functions of the roulette game machine 1-2, programs which execute notification of maintenance time and setting/management of notification condition, odds data of a roulette game (payout credits per one chip at winning), programs for controlling the gaming terminals 4-2 under their initiatives and so on.

In addition, the RAM 83-2 temporarily stores a chip-betting information supplied from each of the gaming terminals 4-2, a winning number of the roulette unit 2-2 detected by the sensor, an accumulated JP credits, data on results of processings executed by the server CPU 81-2 and so on. Furthermore, the RAM 83-2 stores a message(s) which is input via the keyboard 33-2 or the microphone and then sent to the gaming terminals 4-2.

Furthermore, the timer 84-2 for counting time is connected to the server CPU 81-2. Time information of the timer 84-2 is transmitted to the server CPU 81-2. The server CPU 81-2 executes controls of spinning the roulette wheel 22-2 and launching the ball 27-2 based on the time information of the timer 84-2. It is obvious from the above description that the server controller of the present invention is configured by the server CPU 81-2.

The HDD 34-2 stores translating programs between English, which is set as a reference language, and various other languages. For example, plural translating programs are stored such as a “Japanese-English” translating program, a “Chinese-English” translating program or a “French-English” translating program. Note that, although an example case is explained in the present embodiment where “English” is represented as the reference language, the reference language is not limited to English but may be any other language.

Furthermore, the HDD 34-2 stores conversation data to be used in the conversation engine explained later. In other words, the HDD 34-2 includes a function as the conversation database 1500-2 shown in FIG. 109. The conversation database stores conversation data used at generating a reply to a player by the conversation engine and is provided for each of the plural languages. For example, a conversation database for English, a conversation database for Japanese, a conversation database for Chinese and so on are provided.

FIG. 107 is a block diagram showing an internal configuration of the roulette unit 2-2 according to the present embodiment. As shown in FIG. 107, the roulette unit 2-2 includes a controller 109-2, the pocket position detecting circuit 107-2, the ball launching unit 104-2, the ball sensor 105-2, the wheel drive motor 106-2 and a ball collecting device 108-2.

The controller 109-2 includes a CPU 101-2, a ROM 102-2 and a RAM 103-2. The CPU 101-2 controls launching the ball 27-2 and spinning the roulette wheel 22-2 based on control commands supplied from the server 13-2 and data and programs stored in the ROM 102-2 and the RAM 103-2.

The pocket position detecting circuit 107-2 includes the proximity sensor to detect spinning position of the roulette wheel 22-2 by detecting the metal plates attached onto the roulette wheel 22-2.

The ball launching unit 104-2 is a unit for launching the ball 27-2 onto the roulette wheel 22-2 from the ball launching port 36-2 (see FIG. 104). The ball launching unit 104-2 launches the ball 27-2 at the initial speed and the timing set in a control data.

The ball sensor 105-2 is a unit for detecting the number pocket 23-2 into which the ball 27-2 has fallen. The wheel drive motor 106-2 is a unit for spinning the roulette wheel 22-2 and it stops its spinning when a motor driving time set in the control data has elapsed since a start of the driving.

FIG. 108 is a block diagram showing an internal configuration of the gaming terminal according to the present embodiment. Note that each of the nine gaming terminals 4-2 has an identical configuration basically and one of the gaming terminals 4-2 will be explained as the representative hereinafter.

As shown in FIG. 108, the gaming terminal 4-2 includes a terminal controller 90-2 configured by a terminal CPU 91-2, a ROM 92-2 and a RAM 93-2. The ROM 92-2 is configured by a semiconductor memory or the like. The ROM 92-2 stores programs which implement basic functions of the gaming terminal 4-2, various programs which are necessary for controlling the gaming terminal 4-2, data tables and so on. In addition, the RAM 93-2 is a memory for temporarily storing various data calculated by the terminal CPU 91-2, a credit amount currently owned by the player (deposited at the gaming terminal 4-2), a player's betting status, a flag F for indicating whether or not during the betting period and so on.

A payout button 5-2 (see FIG. 102) is connected to the terminal CPU 91-2. The payout button 5-2 is a button to be pressed by a player usually when the game is over. Medals will be paid out from the medal payout chute 12-2 according to credits which have been provided in games and currently owned by the player (usually one medal for one credit) when the payout button 5-2 is pressed by the player.

In addition, the terminal CPU 91-2 receives command signals from the sever CPU 81-2 and controls peripheral devices constituting the gaming terminal 4-2, so as to proceed with the game at the gaming terminal 4-2. Furthermore, the terminal CPU 91-2 executes various processings according to the above-mentioned input signals and data and programs stored in the ROM 92-2 and the RAM 93-2 depending on the processing contents. The terminal CPU 91-2 controls the peripheral devices constituting the gaming terminal 4-2 according to the processing results, so as to proceed with the game.

In addition, the hopper 94-2 is connected to the terminal CPU 91-2. The hopper 94-2 payouts a prescribed number of medals from the medal payout chute 12-2 (see FIG. 103) according to a command signal from the terminal CPU 91-2.

Furthermore, the display 8-2 is connected to the terminal CPU 91-2 via an LCD drive circuit 95-2. The LCD drive circuit 95-2 includes a program ROM, an image ROM, an image control CPU, a work RAM, a VDP (Video Display Processor) and a video RAM. The program ROM stores image control programs and various selection tables for displaying on the display 8-2. The image ROM stores dot data for forming images to be displayed on the display 8-2, for example. The image control CPU determines images to be displayed on the display 8-2 among the dot data in the image ROM according to the image control programs stored in the program ROM based on parameters set up in the terminal CPU 91-2. The work RAM is provided as a temporary memory unit during an execution of the image control programs by the image control CPU. The VDP forms screen images according to the display contents determined by the image control CPU and outputs them to the display 8-2. Note that the video RAM is provided as a temporary memory unit during the VDP forming screen images.

In addition, the touchscreen 50-2 is attached on the front surface of the display 8-2. Information of a player's operation onto the touchscreen 50-2 is sent to the terminal CPU 91-2. A player's chip-betting operation is done via the bet screen 61-2 (see FIG. 105) on the touchscreen 50-2. Specifically, the player's operation onto the touchscreen 50-2 is done for the selection of the bet area 72-2, the input via the bet buttons 66-2 and the bet fixing button 65-2 and so on. The information of a player's operation is sent to the terminal CPU 91-2 when the touchscreen 50-2 has been operated. Then, the player's current betting information (the bet area and the bet amount placed via the bet screen 61-2) is stored into the RAM 93-2 sequentially according to that information. Furthermore, this betting information is sent to the server CPU 81-2 and stored in a betting information storing area in the RAM 83-2.

In addition, a sound output circuit 96-2 and the speaker 10-2 are connected to the terminal CPU 91-2. The speaker 10-2 outputs various effect sounds when various effects are generated and interactive conversation messages to a player for proceeding a game interactively based on output signals from the sound output circuit 96-2.

In addition, a sound input circuit 98-2 and the microphone 15-2 are connected to the terminal CPU 91-2. The microphone 15-2 transmits player's reply message sound in response to interactive message sound output from the speaker 10-2 to the terminal CPU 91-2 via the sound input circuit 98-2.

Furthermore, a second external storage unit 76-2 is connected to the terminal CPU 91-2. A conversation database of a language (Japanese, for example) of a player who is playing at the gaming terminal 4-2 is downloaded to the second external storage unit 76-2. Additionally, a translating program between the player's language and the reference language, i.e. English, is downloaded. The second external storage unit 76-2 is configured by an HDD unit. Its details will be described later.

In addition, the medal sensor 97-2 is connected to the terminal CPU 91-2. The medal sensor 97-2 detects medals inserted from the medal insertion slot 7-2 (see FIG. 103) and counts the inserted medals to send the counting result data to the terminal CPU 91-2. The terminal CPU 91-2 increases the player's credit amount stored in the RAM 93-2 according to the data.

Furthermore, the WIN lamp 11-2 is connected to the terminal CPU 91-2. The terminal CPU 91-2 lights up the WIN lamp 11-2 in a prescribed color when credits bet via the bet screen 61-2 has won or when a JP winning has been awarded.

In addition, a first external storage unit 99-2 is connected to the terminal CPU 91-2. The first external storage unit 99-2 is configured by an HDD unit. The terminal CPU 91-2 reads/writes data from/to the first external storage unit 99-2 if needed.

The gaming terminal 4-2 having the terminal control unit 90-2 includes the conversation engine. At least some of the roulette game procedures on the gaming terminal 4-2 are executed by the conversation engine interactively with the player by using the display 8-2, the speaker 10-2 and the microphone 15-2 as interfaces. Therefore, message sound for the player is output from the speaker 10-2 via the sound output circuit 96-2 in certain situations according to the roulette game procedures. In addition, contents of player's message sound input via the microphone 15-2 and the sound input circuit 98-2 are construed.

Such a conversation engine can be realized using a conversation controller described in, for example, United States patent application publication 2007/0094007, United States patent application publication 2007/0094008, United States patent application publication 2007/0094005 or United States patent application publication 2005/0094004. As will be explained hereinafter, such a conversation controller can be realized using the display 8-2, the speaker 10-2, the microphone 15-2, the terminal controller 90-2 and the first external storage unit 99-2 of the gaming terminal 4-2.

Here, a configuration of the conversation controller described in United States patent application publication 2007/0094007, which can be applied as the conversation engine installed in the gaming terminal 4-2 of the present embodiment, will be explained with reference to FIGS. 109 to 130. FIG. 109 is a functional block diagram showing a configuration example of the conversation controller.

As shown in FIG. 109, the conversation controller 1000-2 comprises an input unit 1100-2, a speech recognition unit 1200-2, a conversation control unit 1300-2, a sentence analyzing unit 1400-2, a conversation database 1500-2, an output unit 1600-2 and a speech recognition dictionary memory 1700-2.

### [Input Unit]

The input unit 1100-2 receives input information (user's utterance) input by a user. The input unit 1100-2 outputs a speech corresponding to contents of the received utterance as a voice signal to the speech recognition unit 1200-2. Note that the input unit 1100-2 may be a character input unit such as a keyboard and a touchscreen. In this case, the after-mentioned speech recognition unit 1200-2 doesn't need to be provided.

### [Speech Recognition Unit]

The speech recognition unit 1200-2 specifies a character string corresponding to the uttered contents based on the uttered contents obtained via the input unit 1100-2. Specifically, the speech recognition unit 1200-2 that has received the voice signal from the input unit 1100-2 compares the received voice signal with the conversation database 1500-2 and dictionaries stored in the speech recognition dictionary memory 1700-2 based on the voice signal to output a speech recognition result estimated based on the voice signal to the conversation control unit 1300-2. In a configuration example shown in FIG. 109, the speech recognition unit 1200-2 requests acquisition of memory contents of the conversation database 1500-2 to the conversation control unit 1300-2 and then receives the memory contents of the conversation database 1500-2 which the conversation control unit 1300-2 retrieves according to the request from the speech recognition unit 1200-2. However the speech recognition unit 1200-2 may directly retrieves the memory contents of the conversation database 1500-2 for comparing with the voice signal.

### Configuration Example of Speech Recognition Unit

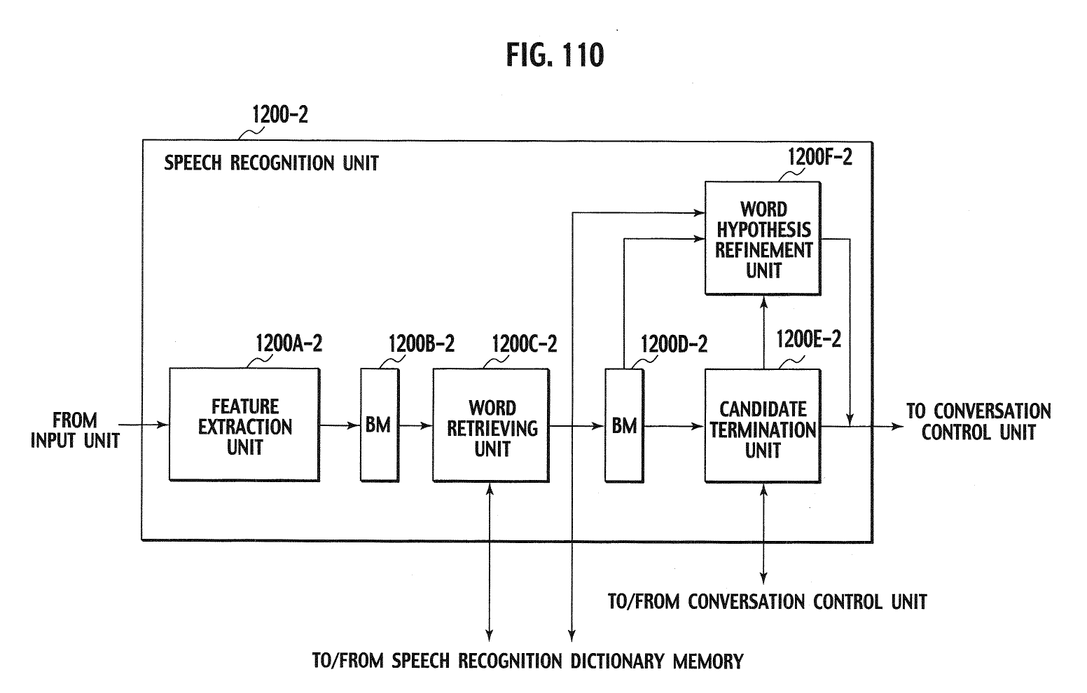

FIG. 110 is a functional block diagram showing a configuration example of the speech recognition unit 1200-2. The speech recognition unit 1200-2 includes a feature extraction unit 1200A-2, a buffer memory (BM) 1200B-2, a word retrieving unit 1200C-2, a buffer memory (BM) 1200D-2, a candidate determination unit 1200E-2 and a word hypothesis refinement unit 1200F-2. The word retrieving unit 1200C-2 and the word hypothesis refinement unit 1200F-2 are connected to the speech recognition dictionary memory 1700-2. In addition, the candidate determination unit 1200E-2 is connected to the conversation database 1500-2 via the conversation control unit 1300-2.

The speech recognition dictionary memory 1700-2 connected to the word retrieving unit 1200C-2 stores a phoneme hidden Markov model (hereinafter, the hidden Markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700-2 connected to the word retrieving unit 1200C-2 further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A-2. The feature extraction unit 1200A-2 converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C-2 via the buffer memory (BM) 1200B-2.

The word retrieving unit 1200C-2 retrieves word hypotheses with a one-pass Viterbi decoding method based on the feature parameters input from the feature extraction unit 1200A-2 via the buffer memory (BM) 1200B-2 by using the phoneme HMM and the word dictionary stored in the speech recognition dictionary memory 1700-2, and then calculates likelihoods. Here, the word retrieving unit 1200C-2 calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C-2 may reduce grid hypotheses of the lower likelihoods among all of the calculated likelihoods based on the phoneme HMM and the word dictionary in order to reduce a computing throughput. The word retrieving unit 1200C-2 outputs information on the retrieved word hypotheses and the likelihoods of the retrieved word hypotheses together with time information regarding an elapsed time from the speech start time (e.g. frame number) to the candidate determination unit 1200E-2 and the word hypothesis refinement unit 1200F-2 via the buffer memory (BM) 1200D-2.

The candidate determination unit 1200E-2 compares the retrieved word hypotheses with topic specification information in a prescribed discourse space with reference to the conversation control unit 1300-2, and then determines whether or not exists a coincident word hypothesis with the topic specification information in the prescribed discourse space among the retrieved word hypotheses. If the coincident word hypothesis exists, the candidate determination unit 1200E-2 outputs the coincident word hypothesis as a recognition result. On the other hand, if no coincident word hypothesis exists, the candidate determination unit 1200E-2 requires the word hypothesis refinement unit 1200F-2 to refine the retrieved word hypotheses.

An operation of the candidate determination unit 1200E-2 will be described. Here, it is assumed that the word retrieving unit 1200C-2 outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

In the above situation, the candidate determination unit 1200E-2 compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300-2 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F-2 operates to output the recognition result in response to the request from the candidate determination unit 1200E-2 to refine the retrieved word hypotheses. The word hypothesis refinement unit 1200F-2 refines the retrieved word hypotheses for the same words having the same speech termination time and different speech start time per each initial phonetic environment of the same words with reference to a statistical language model stored in the speech recognition dictionary memory 1700-2 based on the plural retrieved word hypotheses output from the word retrieving unit 1200C-2 via the buffer memory (BM) 1200D-2 so that one word hypothesis with the highest likelihood may be selected as a representative among all of the likelihoods calculated between the speech start and the utterance termination of the word. And then, the word hypothesis refinement unit 1200F-2 outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

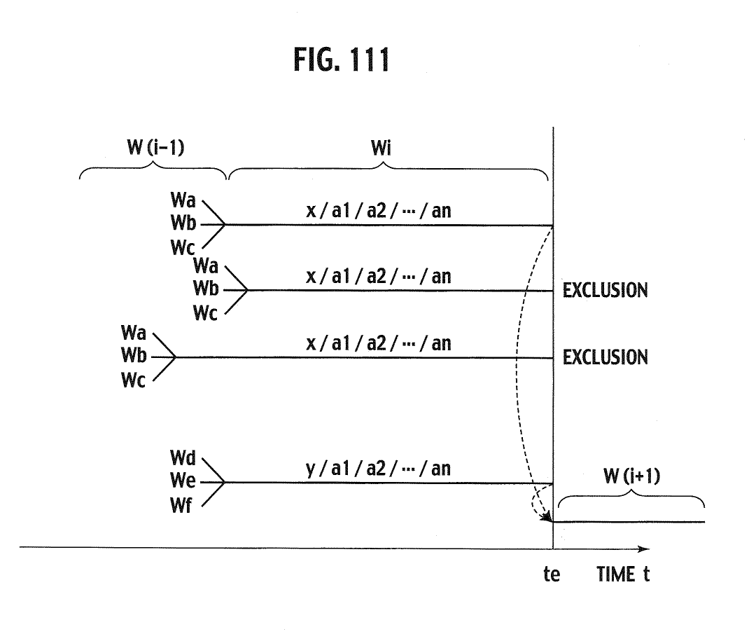

A word refinement process executed by the word hypothesis refinement unit 1200F-2 will be described with reference to FIG. 111.

For example, it is assumed that the (i)th word Wi, which consists of a phonemic string a1, a2, . . . and an, follows the (i−1)th word W(i−1) and six hypotheses Wa, Wb, We, Wd, We and Wf exist as a word hypothesis of the (i−1)th word W(i−1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F-2 is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A-2, the word retrieving unit 1200C-2, the candidate determination unit 1200E-2 and the word hypothesis refinement unit 1200F-2 are composed of a computer such as a microcomputer. The buffer memories (BMs) 200B-2 and 200D-2 and the speech recognition dictionary memory 1700-2 are composed of a memory unit such as hard disc storage.

In the above-mentioned embodiment, the speech recognition is executed by using the word retrieving unit 1200C-2 and the word hypothesis refinement unit 1200F-2. However, the present invention is not limited to this. The speech recognition unit 1200-2 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200-2 is explained as a part of the conversation controller 1000-2. However, an independent speech recognition apparatus configured by the speech recognition unit 1200-2, the conversation database 1500-2 and the speech recognition dictionary memory 1700-2 may be possibly employed.

### Operating Example of Speech Recognition Unit

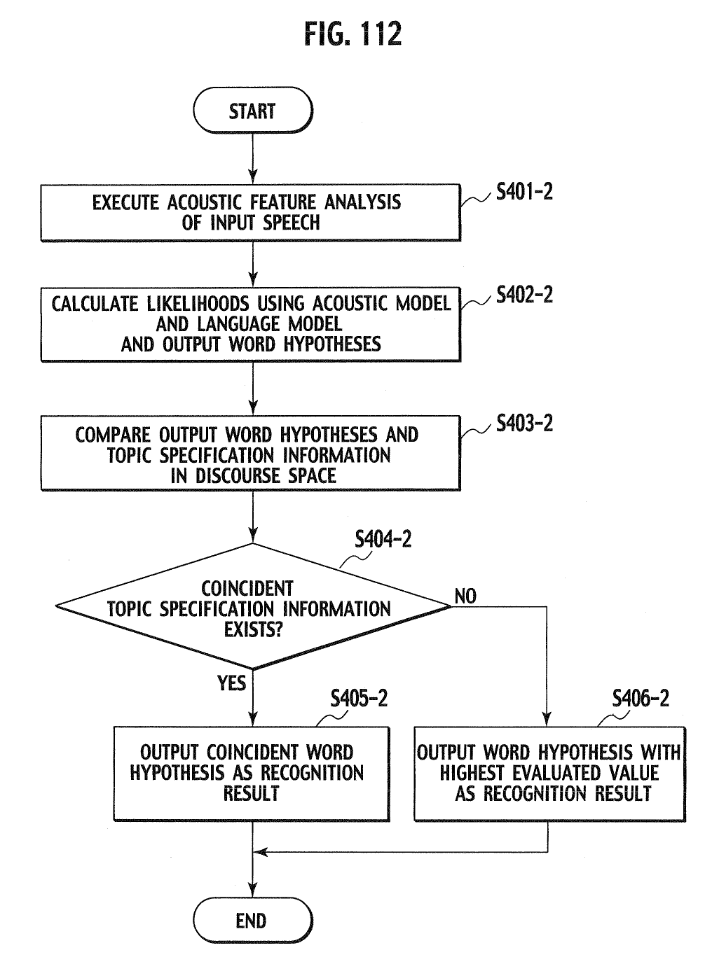

Next, operations of the speech recognition unit 1200-2 will be described with reference to FIG. 112. FIG. 112 is a flow chart showing process operations of the speech recognition unit 1200-2.

The speech recognition unit 1200-2 executes a feature analysis of the input speech to generate feature parameters on receiving the voice signal from the input unit 1100-2 (step S401-2). Next, the feature parameters is compared with the phoneme HMM and the language model stored in the speech recognition dictionary memory 1700-2, and then a certain number of word hypotheses and the likelihoods of the word hypotheses are obtained (step S402-2). Next, the speech recognition unit 1200-2 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403-2 and S404-2). If the coincident word hypothesis exists, the speech recognition unit 1200-2 outputs the coincident word hypothesis as the recognition result (step S405-2). On the other hand, if no coincident word hypothesis exists, the speech recognition unit 1200-2 outputs the word hypothesis with the highest likelihood as the recognition result according to the obtained likelihoods of the word hypotheses (step S406-2).

### [Speech Recognition Dictionary Memory]

The configuration example of the conversation controller 1000-2 is further described with referring back to FIG. 109 again.

The speech recognition dictionary memory 1700-2 stores character strings corresponding to standard voice signals. The speech recognition unit 1200-2, which has executed the comparison, specifies a word hypothesis for a character string corresponding to the received voice signal, and then outputs the specified word hypothesis as a character string signal to the conversation control unit 1300-2.

### [Sentence Analyzing Unit]

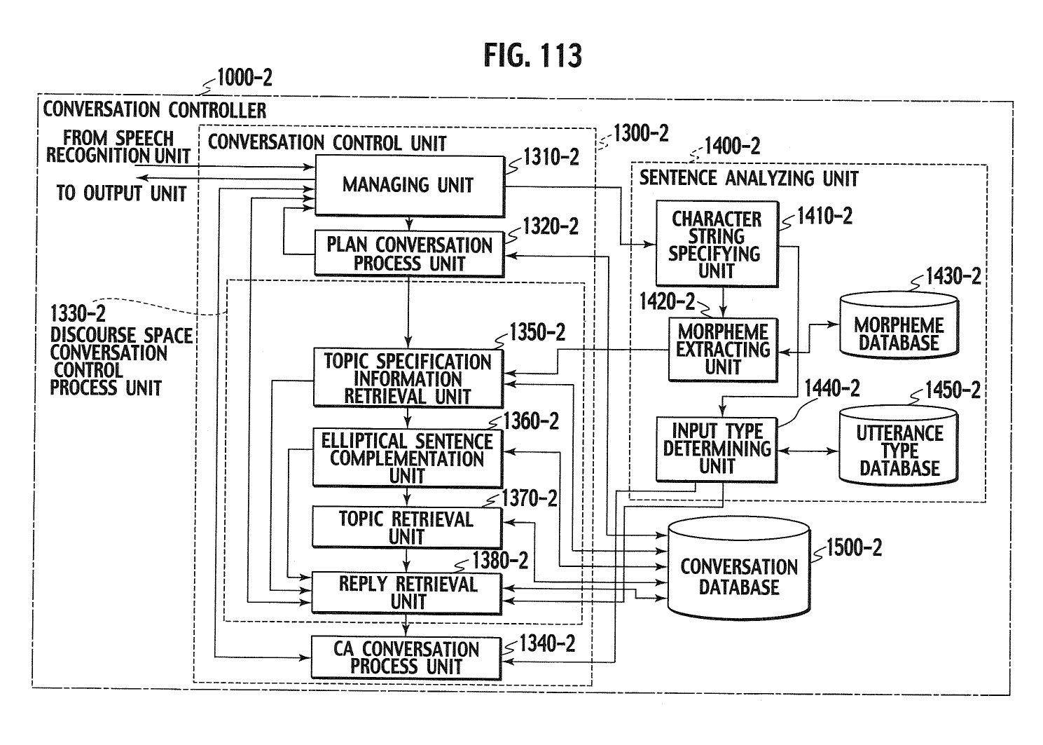

Next, a configuration example of the sentence analyzing unit 1400-2 will be described with reference to FIG. 113. FIG. 113 is a partly enlarged block diagram of the conversation controller 1000-2 and also a block diagram showing a concrete configuration example of the conversation control unit 1300-2 and the sentence analyzing unit 1400-2. Note that only the conversation control unit 1300-2, the sentence analyzing unit 1400-2 and the conversation database 1500-2 are shown in FIG. 113 and the other components are omitted to be shown.

The sentence analyzing unit 1400-2 analyses a character string specified at the input unit 1100-2 or the speech recognition unit 1200-2. In the present embodiment as shown in FIG. 113, the sentence analyzing unit 1400-2 includes a character string specifying unit 1410-2, a morpheme extracting unit 1420-2, a morpheme database 1430-2, an input type determining unit 1440-2 and an utterance type database 1450-2. The character string specifying unit 1410-2 segments a series of character strings specified by the input unit 1100-2 or the speech recognition unit 1200-2 into segments. Each segment is a minimum segmented sentence which is segmented in the extent to keep a grammatical meaning. Specifically, if the series of the character strings have a time interval more than a certain interval, the character string specifying unit 1410-2 segments the character strings there. The character string specifying unit 1410-2 outputs the segmented character strings to the morpheme extracting unit 1420-2 and the input type determining unit 1440-2. Note that a “character string” to be described below means one segmented character string.

### [Morpheme Extracting Unit]

The morpheme extracting unit 1420-2 extracts morphemes constituting minimum units of the character string as first morpheme information from each of the segmented character strings based on each of the segmented character strings segmented by the character string specifying unit 1410-2. In the present embodiment, a morpheme means a minimum unit of a word structure shown in a character string. For example, each minimum unit of a word structure may be a word class such as a noun, an adjective and a verb.

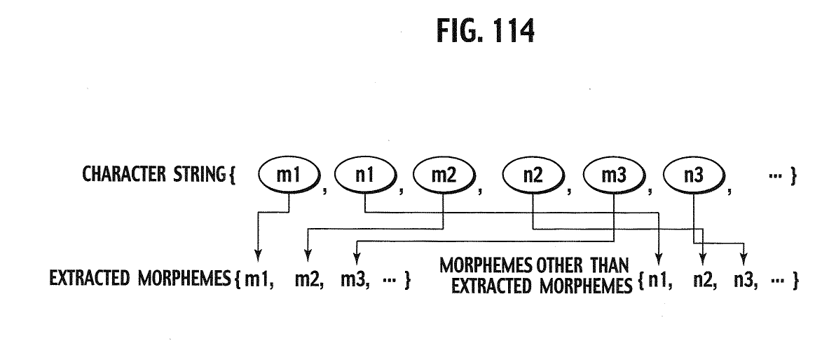

In the present embodiment as shown in FIG. 114, the morphemes are indicated as m1, m2, m3, . . . . FIG. 114 is a diagram showing a relation between a character string and morphemes extracted from the character string. The morpheme extracting unit 1420-2, which has received the character strings from the character string specifying unit 1410-2, compares the received character strings and morpheme groups previously stored in the morpheme database 1430-2 (each of the morpheme group is prepared as a morpheme dictionary in which a direction word, a reading, a word class and infected forms are described for each morpheme belonging to each word-class classification) as shown in FIG. 114. The morpheme extracting unit 1420-2, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420-2 outputs the extracted morphemes to a topic specification information retrieval unit 1350-2 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

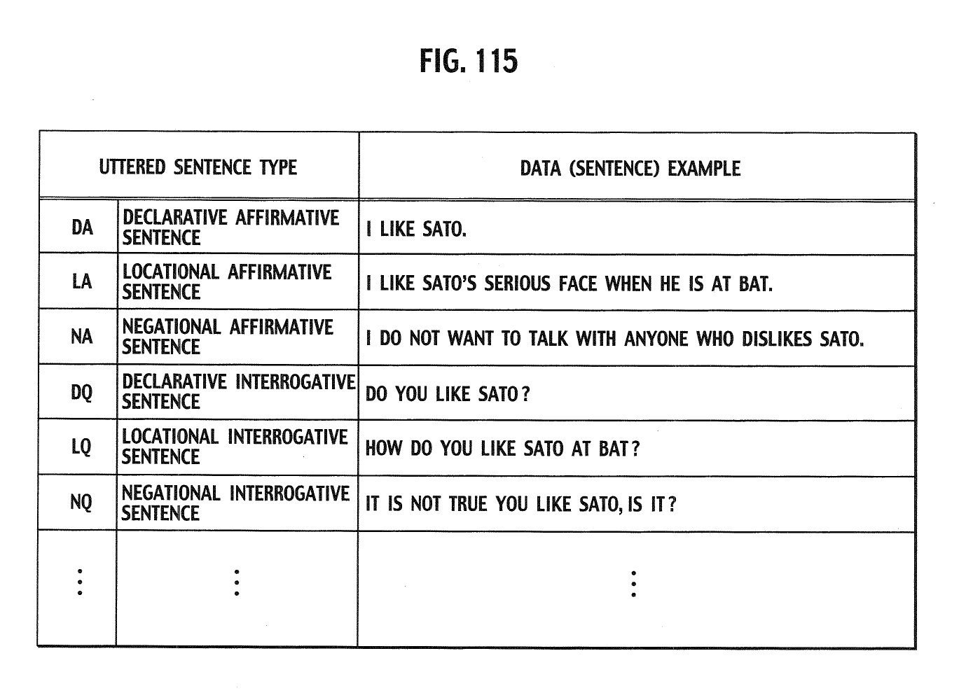

The input type determining unit 1440-2 determines an uttered contents type (utterance type) based on the character strings specified by the character string specifying unit 1410-2. In the present embodiment, the utterance type is information for specifying the uttered contents type and, for example, corresponds to “uttered sentence type” shown in FIG. 115. FIG. 115 is a table showing the “uttered sentence types”, two-alphabet codes representing the uttered sentence types, and uttered sentence examples corresponding to the uttered sentence types.

Here in the present embodiment as shown in FIG. 115, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 115. A “locational sentence” means a sentence involving a locational notion. A “time sentence” means a sentence involving a timelike notion. A “negational sentence” means a sentence to deny a declarative sentence. Sentence examples of the “uttered sentence types” are shown in FIG. 115.

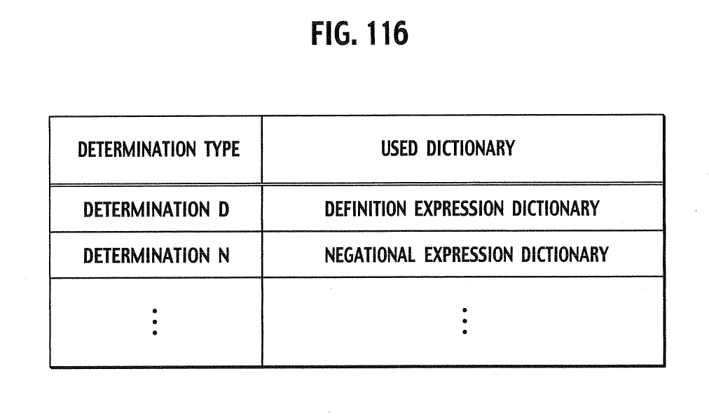

In the present embodiment as shown in FIG. 116, the input type determining unit 1440-2 uses a declarative expression dictionary for determination of a declarative sentence, a negational expression dictionary for determination of a negational sentence and so on in order to determine the “uttered sentence type”. Specifically, the input type determining unit 1440-2, which has received the character strings from the character string specifying unit 1410-2, compares the received character strings and the dictionaries stored in the utterance type database 1450-2 based on the received character string. The input type determining unit 1440-2, which has executed the comparison, extracts elements relevant to the dictionaries among the character strings.

The input type determining unit 1440-2 determines the “uttered sentence type” based on the extracted elements. For example, if the character string includes elements declaring an event, the input type determining unit 1440-2 determines that the character string including the elements is a declarative sentence. The input type determining unit 1440-2 outputs the determined “uttered sentence type” to a reply retrieval unit 1380-2.

### [Conversation Database]

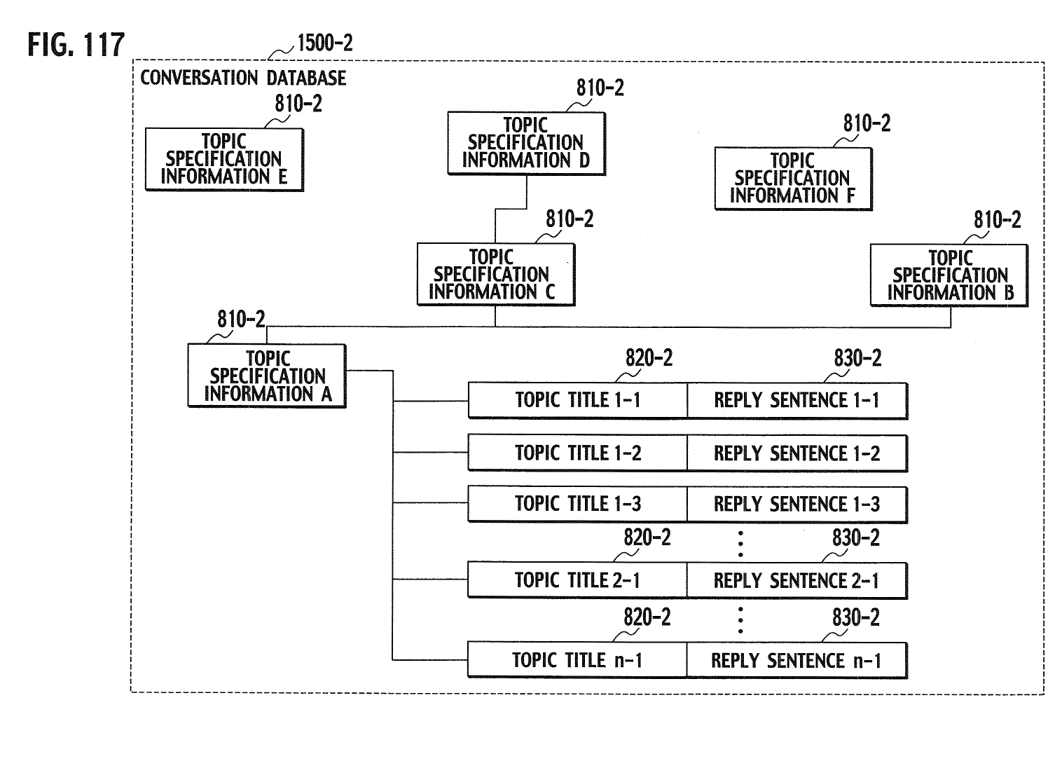

A configuration example of data structure stored in the conversation database 1500-2 will be described with reference to FIG. 117. FIG. 117 is a conceptual diagram showing the configuration example of data stored in the conversation database 1500-2.

As shown in FIG. 117, the conversation database 1500-2 stores a plurality of topic specification information 810-2 for specifying a conversation topic. In addition, topic specification information 810-2 can be associated with other topic specification information 810-2. For example, if topic specification information C (810-2) is specified, three of topic specification information A (810-2), B (810-2) and D (810-2) associated with the topic specification information C (810-2) are also specified.

Specifically in the present embodiment, topic specification information 810-2 means “keywords” which are relevant to input contents expected to be input from users or relevant to reply sentences to users.

The topic specification information 810-2 is associated with one or more topic titles 820-2. Each of the topic titles 820-2 is configured with a morpheme composed of one character, plural character strings or a combination thereof. A reply sentence 830-2 to be output to users is stored in association with each of the topic titles 820-2. Response types for indicating types of the reply sentences 830-2 are associated with the reply sentences 830-2, respectively.

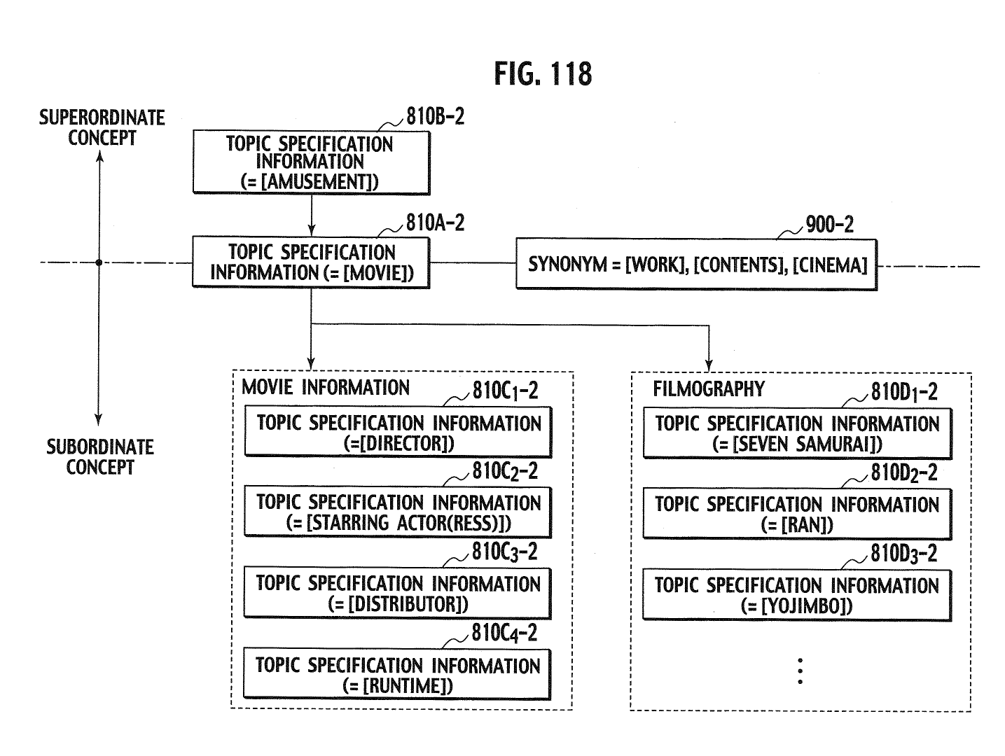

Next, an association between the topic specification information 810-2 and the other topic specification information 810-2 will be described. FIG. 118 is a diagram showing the association between certain topic specification information 810A-2 and the other topic specification information 810B-2, 810C₁-2-810C₄-2 and 810D₁-2-810D₃-2 . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 118, the topic specification information can be stored in association with the other topic specification information with respect to a superordinate concept, a subordinate concept, a synonym or an antonym (not shown in FIG. 118). For example as shown in FIG. 118, the topic specification information 810B-2 (amusement) is stored in association with the topic specification information 810A-2 (movie) as a superordinate concept and stored in a higher level than the topic specification information 810B-2 (amusement).

In addition, subordinate concepts of the topic specification information 810A-2 (movie), the topic specification information 810C₁-2 (director), 810C₂-2 (starring actor/actress), 810C₃-2 (distributor), 810C₄-2 (runtime), 810D₁-2 (“Seven Samurai”), 810D₂-2 (“Ran”), 810D₃-2 (“Yojimbo”), . . . , are stored in association with the topic specification information 810A-2.

In addition, synonyms 900-2 are associated with the topic specification information 810A-2. In this example, “work”, “contents” and “cinema” are stored as synonyms of “movie” which is a keyword of the topic specification information 810A-2. By defining these synonyms in this manner, the topic specification information 810A-2 can be treated as included in an uttered sentence even though the uttered sentence doesn't include the keyword “movie” but includes “work”, “contents” or “cinema”.

In the conversation controller 1000-2 according to the present embodiment, when certain topic specification information 810-2 has been specified with reference to contents stored in the conversation database 1500-2, other topic specification information 810-2 and the topic titles 820-2 or the reply sentences 830-2 of the other topic specification information 810-2, which are stored in association with the certain topic specification information 810-2, can be retrieved and extracted rapidly.

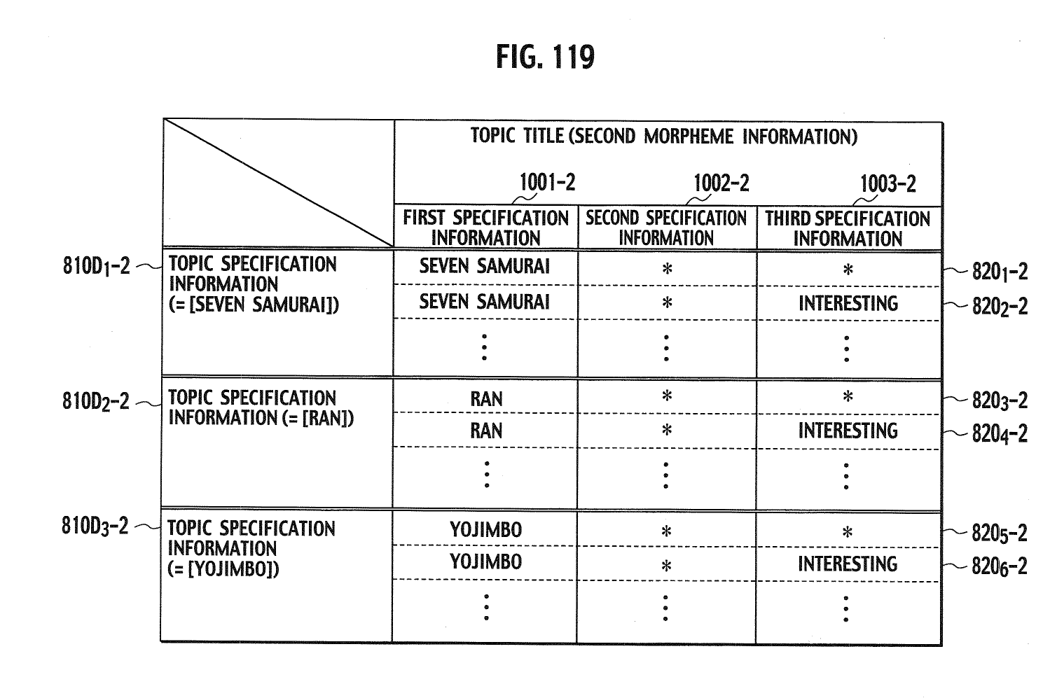

Next, data configuration examples of topic titles 820-2 (also referred as “second morpheme information”) will be described with reference to FIG. 119. FIG. 119 is a diagram showing the data configuration examples of the topic titles 820-2.

The topic specification information 810D₁-2, 810D₂-2, 810D₃-2, . . . , include the topic titles 820₁-2, 820₂-2, . . . , the topic titles 820₃-2, 820₄-2, . . . , the topic titles 820₅-2, 820₆-2, . . . , respectively. In the present embodiment as shown in FIG. 119, each of the topic titles 820-2 is information composed of first specification information 1001-2, second specification information 1002-2 and third specification information 1003-2. Here, the first specification information 1001-2 is a main morpheme constituting a topic. For example, the first specification information 1001-2 may be a Subject of a sentence. In addition, the second specification information 1002-2 is a morpheme closely relevant to the first specification information 1001-2. For example, the second specification information 1002-2 may be an Object. Furthermore, the third specification information 1003-2 in the present embodiment is a morpheme showing a movement of a certain subject, a morpheme of a noun modifier and so on. For example, the third specification information 1003-2 may be a verb, an adverb or an adjective. Note that the first specification information 1001-2, the second specification information 1002-2 and the third specification information 1003-2 are not limited to the above meanings. The present embodiment can be effected in case where contents of a sentence can be understood based on the first specification information 1001-2, the second specification information 1002-2 and the third specification information 1003-2 even though they are give other meanings (other ward classes).

For example as shown in FIG. 119, if the Subject is “Seven Samurai” and the adjective is “interesting”, the topic title 820₂-2 (second morpheme information) consists of the morpheme “Seven Samurai” included in the first specification information 1001-2 and the morpheme “interesting” included in the third specification information 1003-2. Note that the second specification information 1002-2 of this topic title 820₂-2 includes no morpheme and a symbol “*” is stored in the second specification information 1002-2 for indicating no morpheme included.

Note that this topic title 820₂-2 (Seven Samurai; *; interesting) has the meaning of “Seven Samurai is interesting.” Hereinafter, parenthetic contents for a topic title 820₂-2 indicate the specification information 1001-2, the second specification information 1002-2 and the third specification information 1003-2 from the left. In addition, when no morpheme is included in any of the first to third specification information, “*” is indicated therein.

Note that the specification information constituting the topic titles 820-2 is not limited to three and other specification information (fourth specification information and more) may be included.

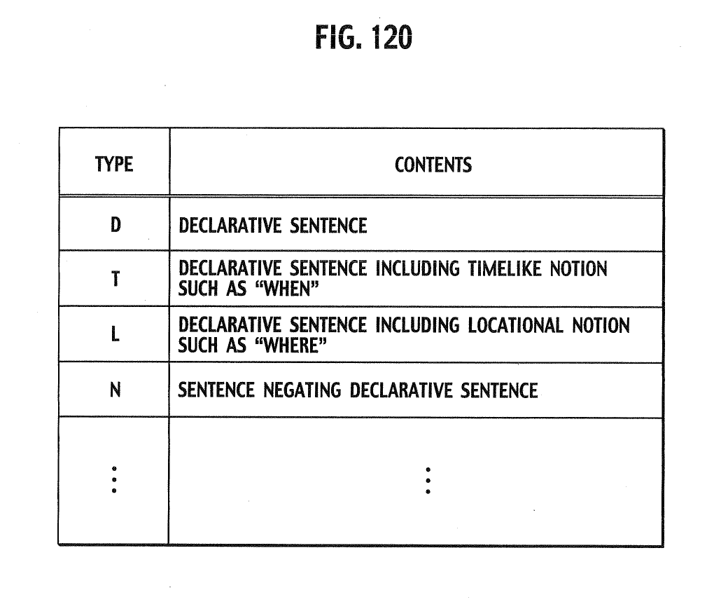

Next, the reply sentences 830-2 will be described with reference to FIG. 120. In the present embodiment as shown in FIG. 120, the reply sentences 830-2 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

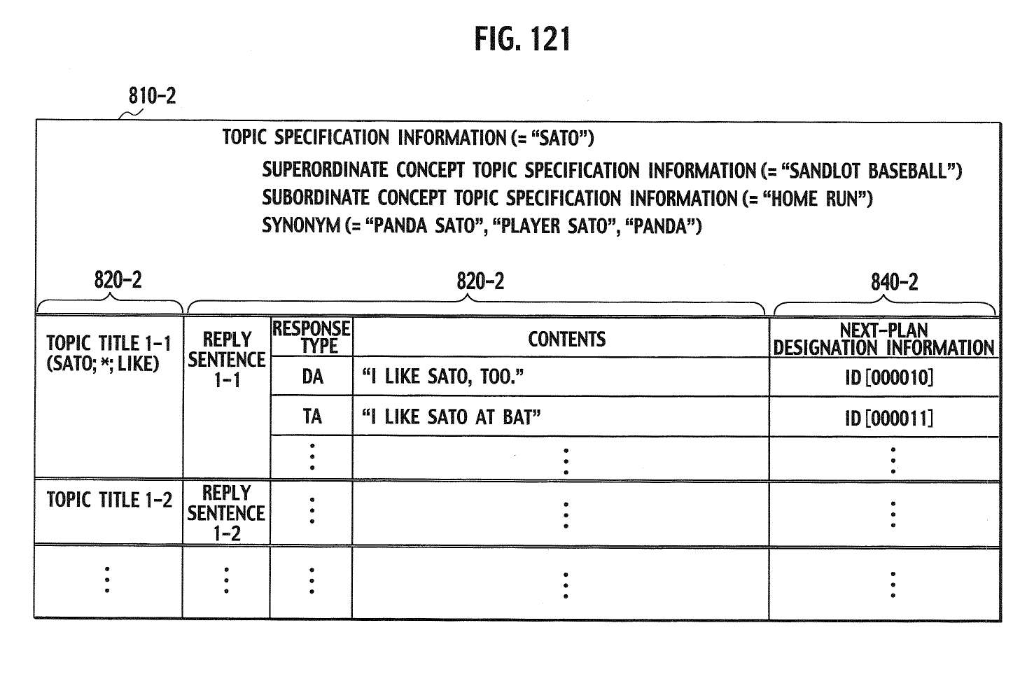

A configuration example of data structure of the topic specification information 810-2 will be described with reference to FIG. 121. FIG. 121 shows a concrete example of the topic titles 820-2 and the reply sentences 830-2 associated with the topic specification information 810-2 “Sato”.

The topic specification information 810-2 “Sato” is associated with plural topic titles (820-2) 1-1, 1-2, . . . . Each of the topic titles (820-2) 1-1, 1-2, . . . is associated with reply sentences (830-2) 1-1, 1-2, . . . . The reply sentence 830-2 is prepared per each of the response types 840-2.

For example, when the topic title (820-2) 1-1 is (Sato; *; like) [these are extracted morphemes included in “I like Sato”], the reply sentences (830-2) 1-1 associated with the topic title (820-2) 1-1 include (DA: a declarative affirmative sentence “I like Sato, too.”) and (TA: a time affirmative sentence “I like Sato at bat.”). The after-mentioned reply retrieval unit 1380-2 retrieves one reply sentence 830-2 associated with the topic title 820-2 with reference to an output from the input type determining unit 1440-2.

Next-plan designation information 840-2 is allocated to each of the reply sentences 830-2. The next-plan designation information 840-2 is information for designating a reply sentence to be preferentially output against a user's utterance in association with the each of the reply sentences (referred as a “next-reply sentence”). The next-plan designation information 840-2 may be any information even if a next-reply sentence can be specified by the information. For example, the information may be a reply sentence ID, by which at least one reply sentence can be specified among all reply sentences stored in the conversation database 1500-2.

In the present embodiment, the next-plan designation information 840-2 is described as information for specifying one next-reply sentence per one reply sentence (for example, a reply sentence ID). However, the next-plan designation information 840-2 may be information for specifying next-reply sentences per topic specification information 810-2 or per one topic title 820-2. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300-2 is further described with referring back to FIG. 113.

The conversation control unit 1300-2 functions to control data transmitting between configuration components in the conversation controller 1000-2 (the speech recognition unit 1200-2, the sentence analyzing unit 1400-2, the conversation database 1500-2, the output unit 1600-2 and the speech recognition dictionary memory 1700-2), and determine and output a reply sentence in response to a user's utterance.

In the present embodiment shown in FIG. 113, the conversation control unit 1300-2 includes a managing unit 1310-2, a plan conversation process unit 1320-2, a discourse space conversation control process unit 1330-2 and a CA conversation process unit 1340-2. Hereinafter, these configuration components will be described.

### [Managing Unit]

The managing unit 1310-2 functions to store discourse histories and update, if needed, the discourse histories. The managing unit 1310-2 further functions to transmit some or entire of the stored discourse histories to a part or a whole of the discourse histories to a topic specification information retrieval unit 1350-2, an elliptical sentence complementation unit 1360-2, a topic retrieval unit 1370-2 or a reply retrieval unit 1380-2 in response to a request therefrom.

### [Plan Conversation Process Unit]

The plan conversation process unit 1320-2 functions to execute plans and establish conversations between a user and the conversation controller 1000-2 according to the plans. A “plan” means providing a predetermined reply to a user in a predetermined order.

The plan conversation process unit 1320-2 functions to output the predetermined reply in the predetermined order in response to a user's utterance.

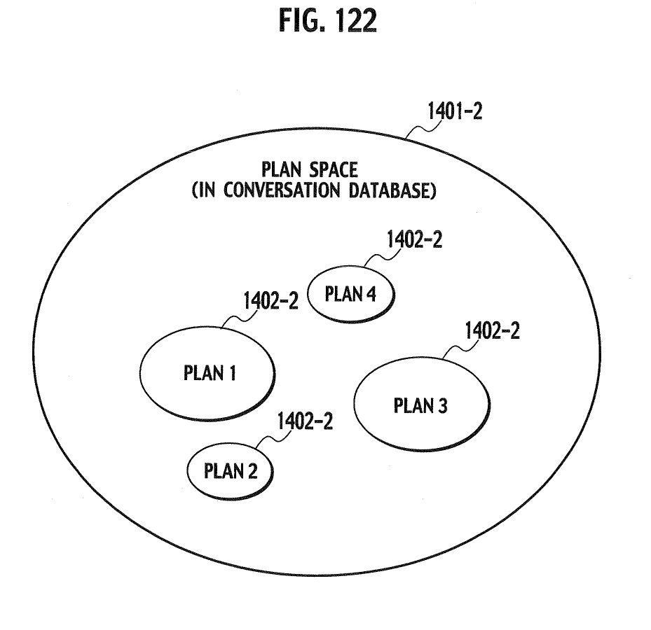

FIG. 122 is a conceptual diagram to describe plans. As shown in FIG. 122, various plans 1402-2 such as plural plans 1, 2, 3 and 4 are prepared in a plan space 1401-2. The plan space 1401-2 is a set of the plural plans 1402-2 stored in the conversation database 1500-2. The conversation controller 1000-2 selects a preset plan 1402-2 for a start-up on an activation or a conversation start or arbitrarily selects one of the plans 1402-2 in the plan space 1401-2 in response to a user's utterance contents in order to output a reply sentence against the user's utterance by using the selected plan 1402-2.

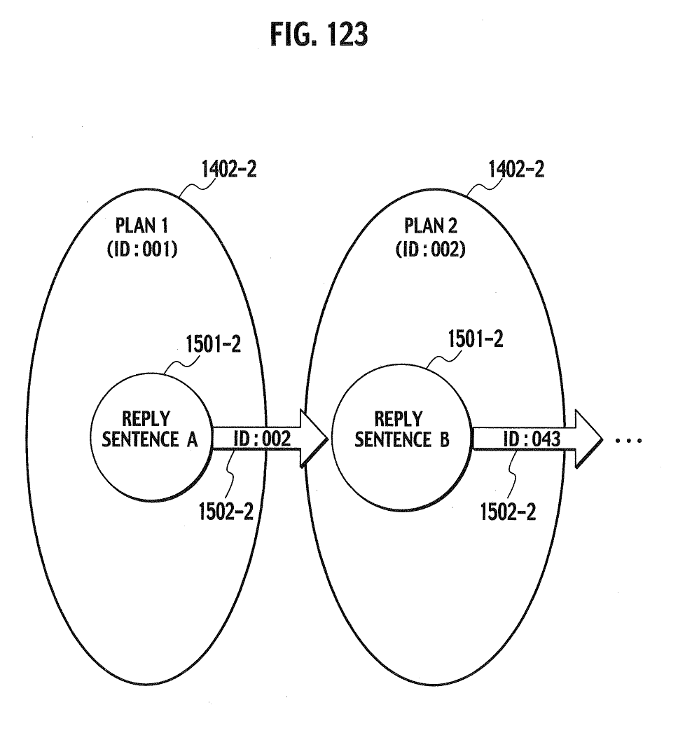

FIG. 123 shows a configuration example of plans 1402-2. Each plan 1402-2 includes a reply sentence 1501-2 and next-plan designation information 1502-2 associated therewith. The next-plan designation information 1502-2 is information for specifying, in response to a certain reply sentence 1501-2 in a plan 1402-2, another plan 1402-2 including a reply sentence to be output to a user (referred as a “next-reply candidate sentence”). In this example, the plan 1 includes a reply sentence A (1501-2) to be output at an execution of the plan 1 by the conversation controller 1000-2 and next-plan designation information 1502-2 associated with the reply sentence A (1501-2). The next-plan designation information 1502-2 is information [ID: 002] for specifying a plan 2 including a reply sentence B (1501-2) to be a next-reply candidate sentence to the reply sentence A (1501-2). Similarly, since the reply sentence B (1501-2) is also associated with next-plan designation information 1502-2, another plan 1402-2 ([ID: 043]: not shown) including the next-reply candidate sentence will be designated by next-plan designation information 1502-2 when the reply sentence B (1501-2) has output. In this manner, plans 1402-2 are chained via next-plan designation information 1502-2 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501-2 included in a plan 1402-2 designated by next-plan designation information 1502-2 is not needed to be output to a user immediately after an output of the user's utterance in response to an output of a previous reply sentence. The reply sentence 1501-2 included in the plan 1402-2 designated by the next-plan designation information 1502-2 may be output after an intervening conversation on a different topic from a topic in the plan between the conversation controller 1000-2 and the user.

Note that the reply sentence 1501-2 shown in FIG. 123 corresponds to a sentence string of one of the reply sentences 830-2 shown in FIG. 121. In addition, the next-plan designation information 1502-2 shown in FIG. 123 corresponds to the next-plan designation information 840-2 shown in FIG. 121.

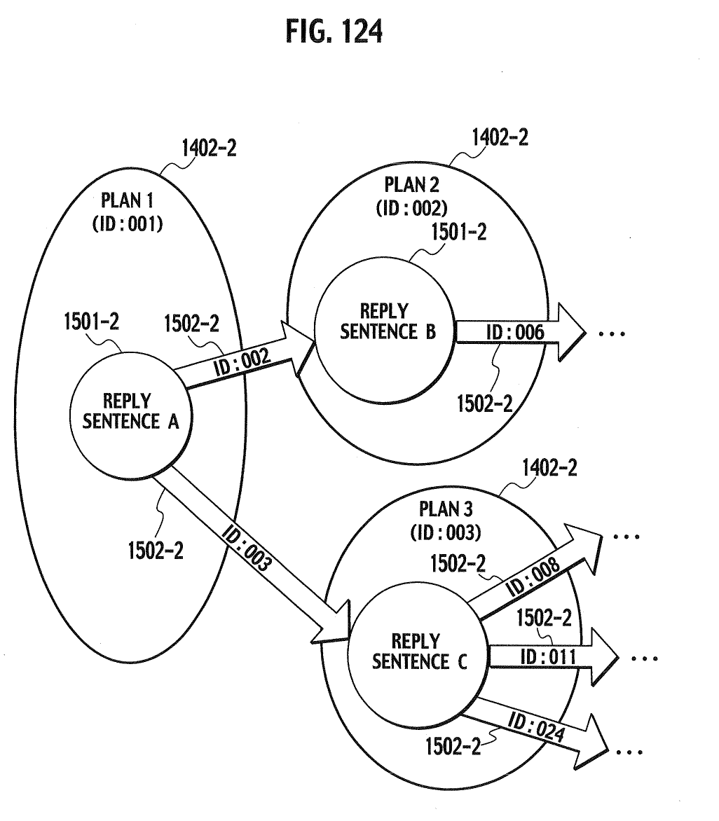

Note that linkages between the plans 1402-2 are not limited to form a one-dimensional geometry shown in FIG. 123. FIG. 124 shows an example of plans 1402-2 with another linkage geometry. In the example shown in FIG. 124, a plan 1 (1402-2) includes two of next-plan designation information 1502-2 to designate two reply sentences as next replay candidate sentences, in other words, to designate two plans 1402-2. The two of next-plan designation information 1502-2 are prepared in order that the plan 2 (1402-2) including a reply sentence B (1501-2) and the plan 3 (1402-2) including a reply sentence C (1501-2) are to be designated as plans each including a next-reply candidate sentence. Note that the reply sentences are selective and alternative, so that, when one has been output, another is not output and then the plan 1 (1501-2) is terminated. In this manner, the linkages between the plans 1402-2 is not limited to forming a one-dimensional geometry and may form a tree-diagram-like geometry or a cancellous geometry.

Note that it is not limited that how many next-reply candidate sentences each plan 1402-2 includes. In addition, no next-plan designation information 1502-2 may be included in a plan 1402-2 which terminates a conversation.

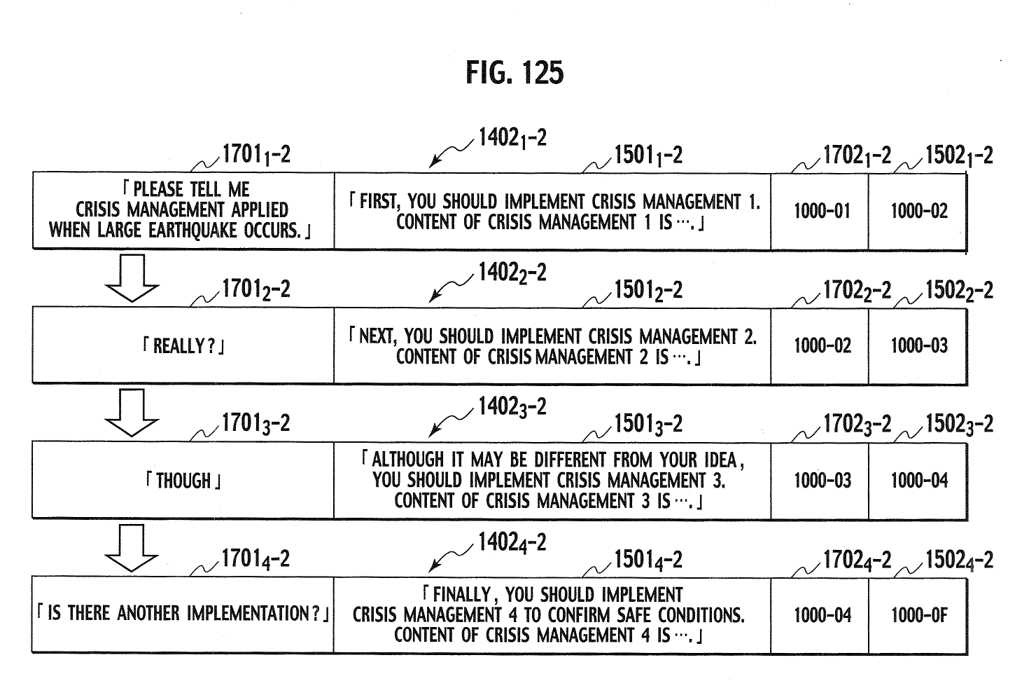

FIG. 125 shows an example of a certain series of plans 1402-2. As shown in FIG. 125, this series of plans 1402₁-2 to 1402₄-2 are associated with reply sentences 1501₁-2 to 1501₄-2 which notify crisis management information to a user. The reply sentences 1501₁-2 to 1501₄-2 constitute one coherent topic as a whole. Each of the plans 1402₁-2 to 1402₄-2 includes ID data 1702₁-2 to 1702₄-2 for indicating itself such as “1000-01, 1000-02”, “1000-03” and “1000-04”, respectively. Note that each value after a hyphen in the ID data is information indicating an output order. In addition, each of the plans 1402₁-2 to 1402₄-2 further includes ID data 1502₁-2 to 1502₄-2 as the next-plan designation information such as “1000-02, 1000-03”, “1000-04” and “1000-0F”, respectively. Especially, “0F” is information indicating the final plan (the last in the order).

In this example, the plan conversation process unit 1320-2 starts to execute this series of plans when a user has uttered 's utterance has been “Please tell me a crisis management applied when a large earthquake occurs.” Specifically, the plan conversation process unit 1320-2 searches in the plan space 1401-2 and checks whether or not a plan 1402-2 including a reply sentence 1501₁-2 associated with the user's utterance “Please tell me a crisis management applied when a large earthquake occurs,” when the plan conversation process unit 1320-2 has received the user's utterance “Please tell me a crisis management applied when a large earthquake occurs.” In this example, a user's utterance character string 1701₁-2 associated with the user's utterance “Please tell me a crisis management applied when a large earthquake occurs,” is associated with a plan 1402₁-2.

The plan conversation process unit 1320-2 retrieves the reply sentence 1501₁-2 included in the plan 1402₁-2 on discovering the plan 1402₁-2 and outputs the reply sentence 1501₁-2 to the user as a reply sentence in response to the user's utterance. And then, the plan conversation process unit 1320-2 specifies the next-reply candidate sentence with reference to the next-plan designation information 1502₁-2.

Next, the plan conversation process unit 1320-2 executes the plan 1402₂-2 on receiving another user's utterance via the input unit 1100-2, a speech recognition unit 1200-2 or the like after an output of the reply sentence 1501₁-2. Specifically, the plan conversation process unit 1320-2 judges whether or not to execute the plan 1402₂-2 designated by the next-plan designation information 1502₁-2, in other words, whether or not to output the second reply sentence 1501₂-2. More specifically, the plan conversation process unit 1320-2 compares a user's utterance character string (also referred as an illustrative sentence) 1701₂-2 associated with the reply sentence 1501₂-2 and the received user's utterance, or compares a topic title 820-2 (not shown in FIG. 125) associated with the reply sentence 1501₂-2 and the received user's utterance. And then, the plan conversation process unit 1320-2 determines whether or not the two are related to each other. If the two are related to each other, the plan conversation process unit 1320-2 outputs the second reply sentence 1501₂-2. In addition, since the plan 1402₂-2 including the second reply sentence 1501₂-2 also includes the next-plan designation information 1502₂-2, the next-reply candidate sentence is specified.

Similarly, according to ongoing user's utterances, the plan conversation process unit 1320-2 transit into the plans 1402₃-2 and 1402₄-2 in turn and can output the third and fourth reply sentences 1501₃-2 and 1501₄-2. Note that, since the fourth reply sentence 1501₄-2 is the final reply sentence, the plan conversation process unit 1320-2 terminates plan-executions when the fourth reply sentence 1501₄-2 has been output.

In this manner, the plan conversation process unit 1320-2 can provide previously prepared conversation contents to the user in a predetermined order by sequentially executing the plans 1402₁-2 to 1402₄-2.

### [Discourse Space Conversation Control Process Unit]

The configuration example of the conversation control unit 1300-2 is further described with referring back to FIG. 113.

The discourse space conversation control process unit 1330-2 includes the topic specification information retrieval unit 1350-2, the elliptical sentence complementation unit 1360-2, the topic retrieval unit 1370-2 and the reply retrieval unit 1380-2. The managing unit 1310-2 totally controls the conversation control unit 1300-2.

A “discourse history” is information for specifying a conversation topic or theme between a user and the conversation controller 1000-2 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330-2 will be described.

### [Topic Specification Information Retrieval Unit]

The topic specification information retrieval unit 1350-2 compares the first morpheme information extracted by the morpheme extracting unit 1420-2 and the topic specification information, and then retrieves the topic specification information corresponding to a morpheme in the first morpheme information among the topic specification information. Specifically, when the first morpheme information received from the morpheme extracting unit 1420-2 is two morphemes “Sato” and “like”, the topic specification information retrieval unit 1350-2 compares the received first morpheme information and the topic specification information group.

If a focused topic title 820-2_{focus} (indicated as 820-2_{focus} to be differentiated from previously retrieved topic titles or other topic titles) includes a morpheme (for example, “Sato”) in the first morpheme information, the topic specification information retrieval unit 1350-2 outputs the focused topic title 820-2_{focus} to the reply retrieval unit 1380-2. On the other hand, if no topic title includes the morpheme in the first morpheme information, the topic specification information retrieval unit 1350-2 determines user input sentence topic specification information based on the received first morpheme information, and then outputs the first morpheme information and the user input sentence topic specification information to the elliptical sentence complementation unit 1360-2. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360-2 generates various complemented first morpheme information by complementing the first morpheme information with the previously retrieved topic specification information 810-2 (hereinafter referred as the “focused topic specification information”) and the topic specification information 810-2 included in the final reply sentence (hereinafter referred as the “reply sentence topic specification information”). For example, if a user's utterance is “like”, the elliptical sentence complementation unit 1360-2 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360-2 generates the complemented first morpheme information by including an element(s) in the set “D” into the first morpheme information “W”.

In this manner, in case where, for example, a sentence constituted with the first morpheme information is an elliptical sentence which is unclear as language, the elliptical sentence complementation unit 1360-2 can include, by using the set “D”, an element(s) (for example, “Sato”) in the set “D” into the first morpheme information “W”. As a result, the elliptical sentence complementation unit 1360-2 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360-2 can complement the elliptical sentence by using the set “D”. As a result, even when a sentence constituted with the first morpheme information is an elliptical sentence, the elliptical sentence complementation unit 1360-2 can complement the sentence into an appropriate sentence as language.

In addition, the elliptical sentence complementation unit 1360-2 retrieves the topic title 820-2 related to the complemented first morpheme information based on the set “D”. If the topic title 820-2 related to the complemented first morpheme information has been found, the elliptical sentence complementation unit 1360-2 outputs the topic title 820-2 to the reply retrieval unit 1380-2. The reply retrieval unit 1380-2 can output a reply sentence 830-2 best-suited for the user's utterance contents based on the appropriate topic title 820-2 found by the elliptical sentence complementation unit 1360-2.

Note that the elliptical sentence complementation unit 1360-2 is not limited to including an element(s) in the set “D” into the first morpheme information. The elliptical sentence complementation unit 1360-2 may include, based on a focused topic title, a morpheme(s) included in any of the first, second and third specification information in the topic title, into the extracted first morpheme information.

### [Topic Retrieval Unit]

The topic retrieval unit 1370-2 compares the first morpheme information and topic titles 820-2 associated with the user input sentence topic specification information to retrieve a topic title 820-2 best-suited for the first morpheme information among the topic titles 820-2 when the topic title 820-2 has not been determined by the elliptical sentence complementation unit 1360-2.

Specifically, the topic retrieval unit 1370-2, which has received a retrieval command signal from the elliptical sentence complementation unit 1360-2, retrieves the topic title 820-2 best-suited for the first morpheme information among the topic titles associated with the user input sentence topic specification information based on the user input sentence topic specification information and the first morpheme information which are included in the received retrieval command signal. The topic retrieval unit 1370-2 outputs the retrieved topic title 820-2 as a retrieval result signal to the reply retrieval unit 1380-2.

Above-mentioned FIG. 121 shows the concrete example of the topic titles 820-2 and the reply sentences 830-2 associated with the topic specification information 810-2 (=“Sato”). For example as shown in FIG. 121, since topic specification information 810-2 (=“Sato”) is included in the received first morpheme information “Sato, like”, the topic retrieval unit 1370-2 specifies the topic specification information 810-2 (=“Sato”) and then compares the topic titles (820-2) 1-1, 1-2, . . . associated with the topic specification information 810-2 (=“Sato”) and the received first morpheme information “Sato, like”.

The topic retrieval unit 1370-2 retrieves the topic title (820-2) 1-1 (Sato; *; like) related to the received first morpheme information “Sato, like” among the topic titles (820-2) 1-1, 1-2, . . . based on the comparison result. The topic retrieval unit 1370-2 outputs the retrieved topic title (820-2) 1-1 (Sato; *; like) as a retrieval result signal to the reply retrieval unit 1380-2.

### [Reply Retrieval Unit]

The reply retrieval unit 1380-2 retrieves, based on the topic title 820-2 retrieved by the elliptical sentence complementation unit 1360-2 or the topic retrieval unit 1370-2, a reply sentence associated with the topic title 820-2. In addition, the reply retrieval unit 1380-2 compares, based on the topic title 820-2 retrieved by the topic retrieval unit 1370-2, the response types associated with the topic title 820-2 and the utterance type determined by the input type determining unit 1440-2. The reply retrieval unit 1380-2, which has executed the comparison, retrieves one response type related to the determined utterance type among the response types.

In the example shown in FIG. 121, when the topic title retrieved by the topic retrieval unit 1370-2 is the topic title 1-1 (Sato; *; like), the reply retrieval unit 1380-2 specifies the response type (for example, DA) coincident with the “uttered sentence type” (DA) determined by the input type determining unit 1440-2 among the reply sentences 1-1 (DA, TA and so on) associated with the topic title 1-1. The reply retrieval unit 1380-2, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380-2 outputs the retrieved reply sentence 830-2 as a reply sentence signal to the managing unit 1310-2. The managing unit 1310-2, which has received the reply sentence signal from the reply retrieval unit 1380-2, outputs the received reply sentence signal to the output unit 1600-2.

### [CA Conversation Process Unit]

When a reply sentence in response to a user's utterance has not been determined by the plan conversation process unit 1320-2 or the discourse space conversation control process unit 1330-2, the CA conversation process unit 1340-2 functions to output a reply sentence for continuing a conversation with a user according to contents of the user's utterance.

The configuration example of the conversation controller 1000-2 is further described with referring back to FIG. 109.

### [Output Unit]

The output unit 1600-2 outputs the reply sentence retrieved by the reply retrieval unit 1380-2. The output unit 1600-2 may be a speaker or a display, for example. Specifically, the output unit 1600-2, which has received the reply sentence from the reply retrieval unit 1380-2, outputs voice sounds of the received reply sentence (for example, “I like Sato, too,”) based on the received reply sentence. With that, describing the configuration example of the conversation controller 1000-2 has ended.

### [Conversation Control Method]

The conversation controller 1000-2 with the above-mentioned configuration puts a conversation control method in execution by operating as described hereinbelow.

Next, operations of the conversation controller 1000-2, more specifically the conversation control unit 1300-2, according to the present embodiment will be described.

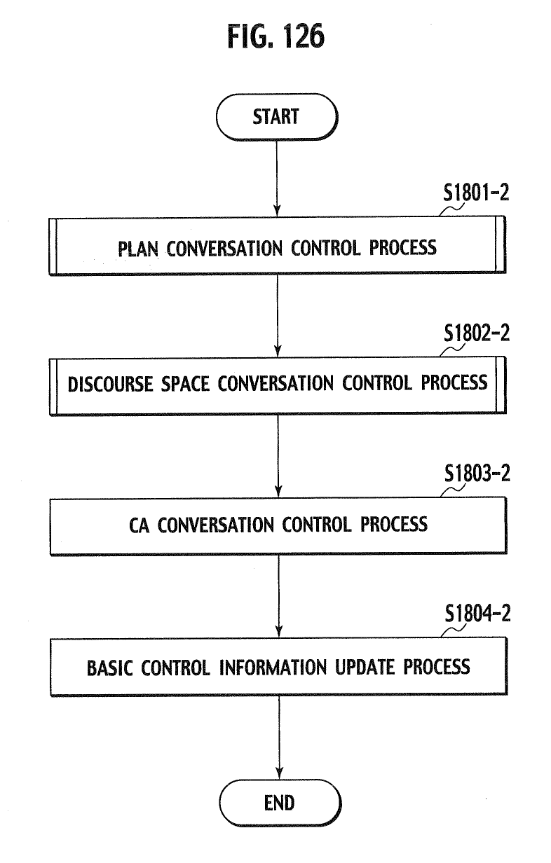

FIG. 126 is a flow chart showing an example of a main process executed by conversation control unit 1300-2. This main process is a process executed each time when the conversation control unit 1300-2 receives a user's utterance. A reply sentence in response to the user's utterance is output due to an execution of this main process, so that a conversation (an interlocution) between a user and the conversation controller 100-2 is established.

Upon executing the main process, the conversation controller 100-2, more specifically the plan conversation process unit 1320-2 firstly executes a plan conversation control process (S1801-2). The plan conversation control process is a process for executing a plan(s).

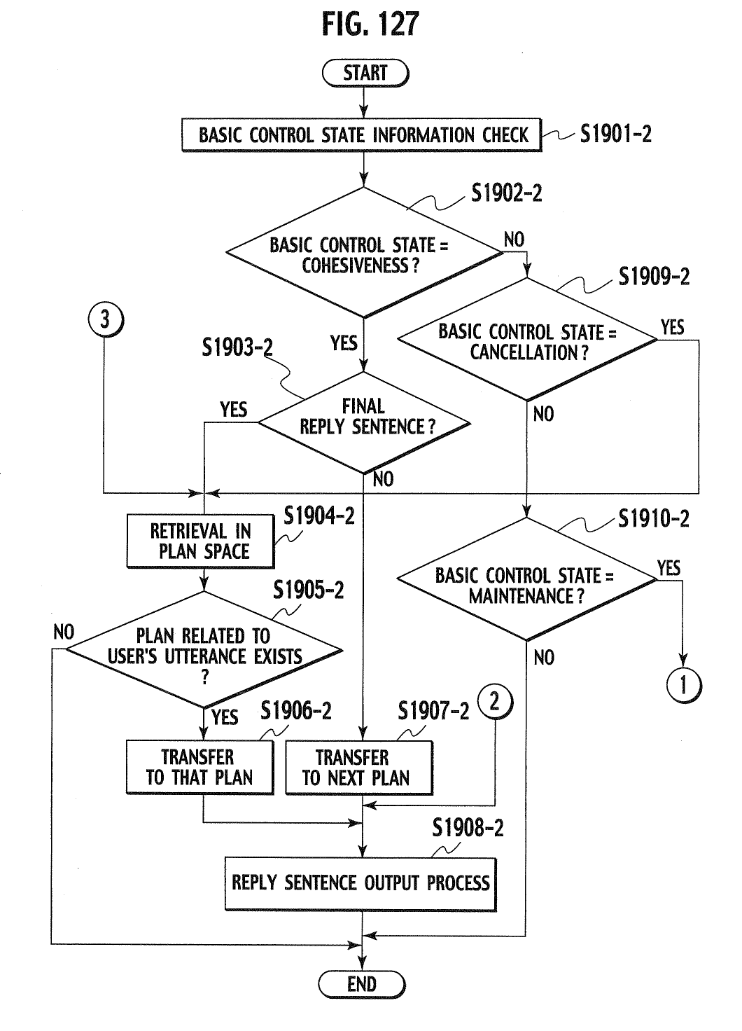

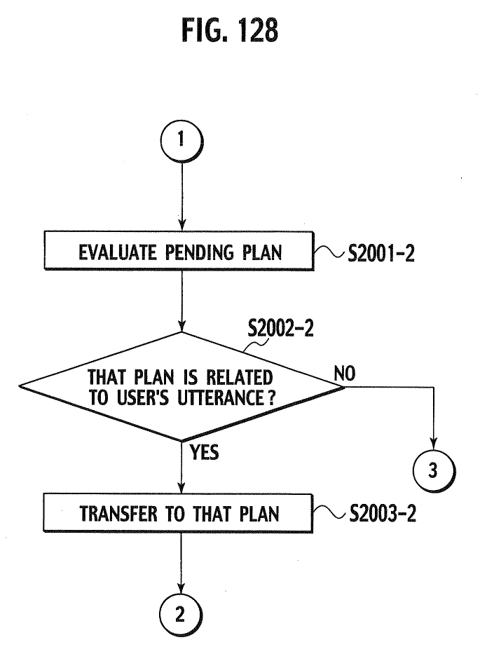

FIGS. 127 and 128 are flow charts showing an example of the plan conversation control process. Hereinbelow, the example of the plan conversation control process will be described with reference to FIGS. 127 and 128.

Upon executing the plan conversation control process, the plan conversation process unit 1320-2 firstly executes a basic control state information check (S1901-2). The basic control state information is information on whether or not an execution(s) of a plan(s) has been completed and is stored in a predetermined memory area.

The basic control state information serves to indicate a basic control state of a plan.

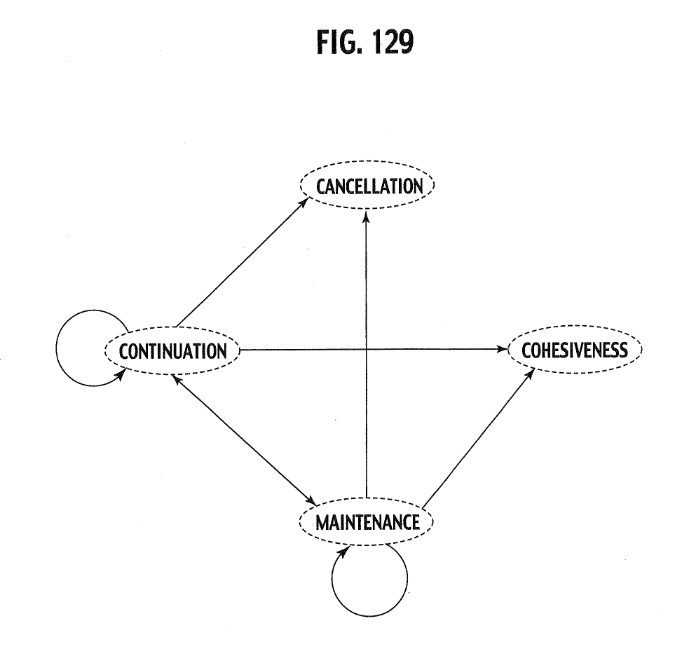

FIG. 129 is a diagram showing four basic control states which are possibly established due to a so-called scenario-type plan.

### (1) Cohesiveness

This basic control state corresponds to a case where a user's utterance is coincident with the currently executed plan 1402-2, more specifically the topic title 820-2 or the example sentence 1701-2 associated with the plan 1402-2. In this case, the plan conversation process unit 1320-2 terminates the plan 1402-2 and then transfers to another plan 1402-2 corresponding to the reply sentence 1501-2 designated by the next-plan designation information 1502-2.

### (2) Cancellation

This basic control state is a basic control state which is set in a case where it is determined that user's utterance contents require a completion of a plan 1402-2 or that a user's interest has changed to another matter than the currently executed plan. When the basic control state indicates the cancellation, the plan conversation process unit 1320-2 retrieves another plan 1402-2 associated with the user's utterance than the plan 1402-2 targeted as the cancellation. If the other plan 1402-2 exists, the plan conversation process unit 1320-2 start to execute the other plan 1402-2. If the other plan 1402-2 does not exist, the plan conversation process unit 1320-2 terminates an execution(s) of a plan(s).

### (3) Maintenance

This basic control state is a basic control state which is set in a case where a user's utterance is not coincident with the topic title 820-2 (see FIG. 121) or the example sentence 1701-2 (see FIG. 125) associated with the currently executed plan 1402-2 and also the user's utterance does not correspond to the basic control state “cancellation”.

In the case of this basic control state, the plan conversation process unit 1320-2 firstly determines whether or not to resume a pending or pausing plan 1402-2 on receiving the user's utterance. If the user's utterance is not adapted for resuming the plan 1402-2, for example, in case where the user's utterance is not related to a topic title 820-2 or an example sentence 1701-2 associated with the plan 1402-2, the plan conversation process unit 1320-2 starts to execute another plan 1402-2, an after-mentioned discourse space conversation control process (S1802-2) and so on. If the user's utterance is adapted for resuming the plan 1402-2, the plan conversation process unit 1320-2 outputs a reply sentence 1501-2 based on the stored next-plan designation information 1502-2.

In case where the basic control state is the “maintenance”, the plan conversation process unit 1320-2 retrieves other plans 1402-2 in order to enable outputting another reply sentence than the reply sentence 1501-2 associated with the currently executed plan 1402-2, or executes the discourse space conversation control process. However, if the user's utterance is adapted for resuming the plan 1402-2, the plan conversation process unit 1320-2 resumes the plan 1402-2.

### (4) Continuation

This state is a basic control state which is set in a case where a user's utterance is not related to reply sentences 1501-2 included in the currently executed plan 1402-2, contents of the user's utterance do not correspond to the basic control sate “cancellation” and use's intention construed from the user's utterance is not clear.

In case where the basic control state is the “continuation”, the plan conversation process unit 1320-2 firstly determines whether or not to resume a pending or pausing plan 1402-2 on receiving the user's utterance. If the user's utterance is not adapted for resuming the plan 1402-2, the plan conversation process unit 1320-2 executes an after-mentioned CA conversation control process in order to enable outputting a reply sentence for getting out a further user's utterance.

The plan conversation control process is further described with referring back to FIG. 127.

The plan conversation process unit 1320-2, which has referred to the basic control state, determines whether or not the basic control state indicated by the basic control state information is the “cohesiveness” (step S1902-2). If it has been determined that the basic control state is the “cohesiveness” (YES in step S1902-2), the plan conversation process unit 1320-2 determines whether or not the reply sentence 1501-2 is the final reply sentence in the currently executed plan 1402-2 (step S1903-2).

If it has been determined that the final reply sentence 1501-2 has been output already (YES in step S1903-2), the plan conversation process unit 1320-2 retrieves another plan 1402-2 related to the use's utterance in the plan space in order to determine whether or not to execute the other plan 1402-2 (step S1904-2) because the plan conversation process unit 1320-2 has provided all contents to be replied to the user already. If the other plan 1402-2 related to the user's utterance has not been found due to this retrieval (NO in step S1905-2), the plan conversation process unit 1320-2 terminates the plan conversation control process because no plan 1402-2 to be provided to the user exists.

On the other hand, if the other plan 1402-2 related to the user's utterance has been found due to this retrieval (YES in step S1905-2), the plan conversation process unit 1320-2 transfers into the other plan 1402-2 (step S1906-2). Since the other plan 1402-2 to be provided to the user still remains, an execution of the other plan 1402-2 (an output of the reply sentence 1501-2 included in the other plan 1402-2) is started.

Next, the plan conversation process unit 1320-2 outputs the reply sentence 1501-2 included in that plan 1402-2 (step S1908-2). The reply sentence 1501-2 is output as a reply to the user's utterance, so that the plan conversation process unit 1320-2 provides information to be supplied to the user.

The plan conversation process unit 1320-2 terminates the plan conversation control process after the reply sentence output process (step S1908-2).

On the other hand, if the previously output reply sentence 1501-2 is not determined as the final reply sentence in the determination whether or not the previously output reply sentence 1501-2 is the final reply sentence (step S1903-2), the plan conversation process unit 1320-2 transfers into a plan 1402-2 associated with the reply sentence 1501-2 following the previously output reply sentence 1501-2, i.e. the specified reply sentence 1501-2 by the next-plan designation information 1502-2 (step S1907-2).

Subsequently, the plan conversation process unit 1320-2 outputs the reply sentence 1501-2 included in that plan 1402-2 to provide a reply to the user's utterance (step 1908-2). The reply sentence 1501-2 is output as the reply to the user's utterance, so that the plan conversation process unit 1320-2 provides information to be supplied to the user. The plan conversation process unit 1320-2 terminates the plan conversation control process after the reply sentence output process (step S1908-2).

Here, if the basic control state is not the “cohesiveness” in the determination process in step S1902-2 (NO in step S1902-2), the plan conversation process unit 1320-2 determines whether or not the basic control state indicated by the basic control state information is the “cancellation” (step S1909-2). If it has been determined that the basic control state is the “cancellation” (YES in step S1909-2), the plan conversation process unit 1320-2 retrieves another plan 1402-2 related to the use's utterance in the plan space 1401-2 in order to determine whether or not the other plan 1402-2 to be started newly exists (step S1904-2) because a plan 1402-2 to be successively executed does not exist. Subsequently, the plan conversation process unit 1320-2 executes the processes of steps S1905-2 to S1908 as well as the processes in case of the above-mentioned step S1903-2 (YES).

On the other hand, if the basic control state is not the “cancellation” in the determination process in step S1902-2 (NO in step S1902-2) in the determination whether or not the basic control state indicated by the basic control state information is the “cancellation” (step S1909-2), the plan conversation process unit 1320-2 further determines whether or not the basic control state indicated by the basic control state information is the “maintenance” (step S1910-2).

If the basic control state indicated by the basic control state information is the “maintenance” (YES in step S1910-2), the plan conversation process unit 1320-2 determined whether or not the user presents the interest on the pending or pausing plan 1402-2 again and then resumes the pending or pausing plan 1402-2 in case where the interest is presented (step S2001-2 in FIG. 128). In other words, the plan conversation process unit 1320-2 evaluates the pending or pausing plan 1402-2 (step S2001-2 in FIG. 128) and then determines whether or not the user's utterance is related to the pending or pausing plan 1402-2 (step S2002-2).

If it has been determined that the user's utterance is related to that plan 1402-2 (YES in step S2002-2), the plan conversation process unit 1320-2 transfers into the plan 1402-2 related to the user's utterance (step S2003-2) and then executes the reply sentence output process (step S1908-2 in FIG. 127) to output the reply sentence 1501-2 included in the plan 1402-2. Operating in this manner, the plan conversation process unit 1320-2 can resume the pending or pausing plan 1402-2 according to the user's utterance, so that all contents included in the previously prepared plan 1402-2 can be provided to the user.

On the other hand, if it has been determined that the user's utterance is not related to that plan 1402-2 (NO in step S2002-2) in the above-mentioned S2002 (see FIG. 128), the plan conversation process unit 1320-2 retrieves another plan 1402-2 related to the use's utterance in the plan space 1401-2 in order to determine whether or not the other plan 1402-2 to be started newly exists (step S1904-2 in FIG. 127). Subsequently, the plan conversation process unit 1320-2 executes the processes of steps S1905-2 to S1908-2 as well as the processes in case of the above-mentioned step S1903-2 (YES).

If it is determined that the basic control state indicated by the basic control state information is not the “maintenance” (NO in step S1910-2) in the determination in step S1910-2, it means that the basic control state indicated by the basic control state information is the “continuation”. In this case, the plan conversation process unit 1320-2 terminates the plan conversation control process without outputting a reply sentence. With that, describing the plan control process has ended.

The main process is further described with referring back to FIG. 126. The conversation control unit 1300-2 executes the discourse space conversation control process (step S1802-2) after the plan conversation control process (step S1801-2) has been completed. Note that, if the reply sentence has been output in the plan conversation control process (step S1801-2), the conversation control unit 1300-2 executes a basic control information update process (step S1804-2) without executing the discourse space conversation control process (step S1802-2) and the after-mentioned CA conversation control process (step S1803-2) and then terminates the main process.

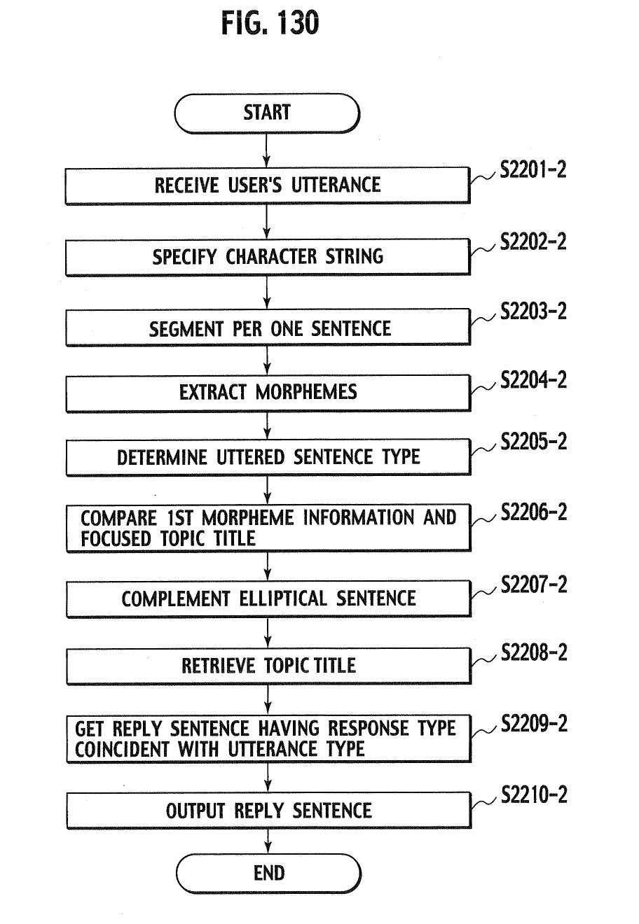

FIG. 130 is a flow chart showing an example of a discourse space conversation control process according to the present embodiment. The input unit 1100-2 firstly executes a step for receiving a user's utterance (step S2201-2). Specifically, the input unit 1100-2 receives voice sounds of the user's utterance. The input unit 1100-2 outputs the received voice sounds to the speech recognition unit 1200-2 as a voice signal. Note that the input unit 1100-2 may receive a character string input by a user (for example, text data input in a text format) instead of the voice sounds. In this case, the input unit 1100-2 may be a text input device such as a keyboard or a touchscreen.

Next, the speech recognition unit 1200-2 executes a step for specifying a character string corresponding to the uttered contents based on the uttered contents retrieved by the input unit 1100-2 (step S2202-2). Specifically, the speech recognition unit 1200-2, which has received the voice signal from the input unit 1100-2, specifies a word hypothesis (candidate) corresponding to the voice signal based on the received voice signal. The speech recognition unit 1200-2 retrieves a character string corresponding to the specified word hypothesis and outputs the retrieved character string to the conversation control unit 1300-2, more specifically the discourse space conversation control process unit 1330-2, as a character string signal.

And then, the character string specifying unit 1410-2 segments a series of the character strings specified by the speech recognition unit 1200-2 into segments (step S2203-2). Specifically, if the series of the character strings have a time interval more than a certain interval, the character string specifying unit 1410-2, which has received the character string signal or a morpheme signal from the managing unit 1310-2, segments the character strings there. The character string specifying unit 1410-2 outputs the segmented character strings to the morpheme extracting unit 1420-2 and the input type determining unit 1440-2. Note that it is preferred that the character string specifying unit 1410-2 segments a character string at a punctuation, a space and so on in a case where the character string has been input from a keyboard.

Subsequently, the morpheme extracting unit 1420-2 executes a step for extracting morphemes constituting minimum units of the character string as first morpheme information based on the character string specified by the character string specifying unit 1410-2 (step S2204-2). Specifically, the morpheme extracting unit 1420-2, which has received the character strings from the character string specifying unit 1410-2, compares the received character strings and morpheme groups previously stored in the morpheme database 1430-2. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420-2, which has executed the comparison, extracts coincident morphemes (m1, m2, . . . ) with the morphemes included in the previously stored morpheme groups from the received character string. The morpheme extracting unit 1420-2 outputs the extracted morphemes to the topic specification information retrieval unit 1350-2 as the first morpheme information.

Next, the input type determining unit 1440-2 executes a step for determining the “uttered sentence type” based on the morphemes which constitute one sentence and are specified by the character string specifying unit 1410-2 (step S2205-2). Specifically, the input type determining unit 1440-2, which has received the character strings from the character string specifying unit 1410-2, compares the received character strings and the dictionaries stored in the utterance type database 1450-2 based on the received character strings and extracts elements relevant to the dictionaries among the character strings. The input type determining unit 1440-2, which has extracted the elements, determines to which “uttered sentence type” the extracted element(s) belongs based on the extracted element(s). The input type determining unit 1440-2 outputs the determined “uttered sentence type” (utterance type) to the reply retrieval unit 1380-2.

And then, the topic specification information retrieval unit 1350-2 executes a step for comparing the first morpheme information extracted by the morpheme extracting unit 1420-2 and the focused topic title 820-2_{focus} (step S2206-2).

If a morpheme in the first morpheme information is related to the focused topic title 820-2_{focus}, the topic specification information retrieval unit 1350-2 outputs the focused topic title 820-2_{focus} to the reply retrieval unit 1380-2. On the other hand, if no morpheme in the first morpheme information is related to the focused topic title 820-2_{focus}, the topic specification information retrieval unit 1350-2 outputs the received first morpheme information and the user input sentence topic specification information to the elliptical sentence complementation unit 1360-2 as the retrieval command signal.

Subsequently, the elliptical sentence complementation unit 1360-2 executes a step for including the focused topic specification information and the reply sentence topic specification information into the received first morpheme information based on the first morpheme information received from the topic specification information retrieval unit 1350-2 (step S2207-2). Specifically, if it is assumed that the first morpheme information is defined as “W” and a set of the focused topic specification information and the reply sentence topic specification information is defined as “D”, the elliptical sentence complementation unit 1360-2 generates the complemented first morpheme information by including an element(s) in the set “D” into the first morpheme information “W” and compares the complemented first morpheme information and all the topic titles 820-2 to retrieve the topic title 820-2 related to the complemented first morpheme information. If the topic title 820-2 related to the complemented first morpheme information has been found, the elliptical sentence complementation unit 1360-2 outputs the topic title 820-2 to the reply retrieval unit 1380-2. On the other hand, if no topic title 820-2 related to the complemented first morpheme information has been found, the elliptical sentence complementation unit 1360-2 outputs the first morpheme information and the user input sentence topic specification information to the topic retrieval unit 1370-2.

Next, the topic retrieval unit 1370-2 executes a step for comparing the first morpheme information and the user input sentence topic specification information and retrieves the topic title 820-2 best-suited for the first morpheme information among the topic titles 820-2 (step S2208-2). Specifically, the topic retrieval unit 1370-2, which has received the retrieval command signal from the elliptical sentence complementation unit 1360-2, retrieves the topic title 820-2 best-suited for the first morpheme information among topic titles 820-2 associated with the user input sentence topic specification information based on the user input sentence topic specification information and the first morpheme information included in the received retrieval command signal. The topic retrieval unit 1370-2 outputs the retrieved topic title 820-2 to the reply retrieval unit 1380-2 as the retrieval result signal.

Next, the reply retrieval unit 1380-2 compares, in order to select the reply sentence 830-2, the user's utterance type determined by the sentence analyzing unit 1400-2 and the response type associated with the retrieved topic title 820-2 based on the retrieved topic title 820-2 by the topic specification information retrieval unit 1350-2, the elliptical sentence complementation unit 1360-2 or the topic retrieval unit 1370-2 (step S2209-2).

The reply sentence 830-2 is selected in particular as explained hereinbelow. Specifically, based on the “topic title” associated with the received retrieval result signal and the received “uttered sentence type”, the reply retrieval unit 1380-2, which has received the retrieval result signal from the topic retrieval unit 1370-2 and the “uttered sentence type” from the input type determining unit 1440-2, specifies one response type coincident with the “uttered sentence type” (for example, DA) among the response types associated with the “topic title”.

Consequently, the reply retrieval unit 1380-2 outputs the reply sentence 830-2 retrieved in step S2209-2 to the output unit 1600-2 via the managing unit 1310-2 (S2210-2). The output unit 1600-2, which has received the reply sentence 830-2 from the managing unit 1310-2, outputs the received reply sentence 830-2.

With that, describing the discourse space conversation control process has ended and the main process is further described with referring back to FIG. 126.

The conversation control unit 1300-2 executes the CA conversation control process (step S1803-2) after the discourse space conversation control process has been completed. Note that, if the reply sentence has been output in the plan conversation control process (step S1801-2) or the discourse space conversation control (step S1802-2), the conversation control unit 1300-2 executes the basic control information update process (step S1804-2) without executing the CA conversation control process (step S1803-2) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result. By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300-2 executes the basic control information update process (step S1804-2). In this process, the conversation control unit 1300-2, more specifically the managing unit 1310-2, sets the basic control information to the “cohesiveness” when the plan conversation process unit 1320-2 has output a reply sentence, sets the basic control information to the “cancellation” when the plan conversation process unit 1320-2 has cancelled an output of a reply sentence, sets the basic control information to the “maintenance” when the discourse space conversation control process unit 1330-2 has output a reply sentence, or sets the basic control information to the “continuation” when the CA conversation process unit 1340-2 has output a reply sentence.

The basic control information set in this basic control information update process is referred in the above-mentioned plan conversation control process (step S1801-2) to be employed for continuation or resumption of a plan.

As described the above, the conversation controller 1000-2 can executes a previously prepared plan(s) or can adequately respond to a topic(s) which is not included in a plan(s) according to a user's utterance by executing the main process each time when receiving the user's utterance.

In the gaming terminal 4-2 of the present embodiment, the input unit 1100-2 of the conversation controller 1000-2 explained above may be configured by the touchscreen 50-2 attached to the display 8-2 and the microphone 15-2. In addition, the output unit 1600-2 may be configured by the display 8-2 and the speaker 10-2. Furthermore, the speech recognition unit 1200-2; the conversation control unit 1300-2; and the character string specifying unit 1410-2, the morpheme extraction portion 1420-2 and the input type determining portion 1440-2 of the sentence analyzing unit 1400-2 may be configured by the terminal controller 90-2. In addition, the morpheme database 1430-2 and the utterance type database 1450-2 of the sentence analyzing unit 1400-2, and the speech recognition dictionary memory 1700-2 can be configured by the first external storage unit 99-2 (see FIG. 108). Note that, although the conversation database 1500-2 can be stored also in the first external storage unit 99-2, it is stored in the HDD 34-2 of the above-mentioned server 13-2 in the present embodiment (see FIG. 106). And, as explained later, there are methods such as directly accessing the HDD 34-2 and downloading the conversation data stored in the HDD 34-2 at the time when using the conversation data stored in the conversation database 1500-2.

And, in the present embodiment, the language to be used in the roulette game can be determined through a conversation with the player by the conversation engine achieved with the above-mentioned configuration in the gaming terminal 4-2 by the conversation controller 1000-2.

Here, the speech recognition dictionary memory 1700-2 of the conversation controller 1000-2 configured by the first external storage unit 99-2 has word dictionaries for the plural languages in order to confirm a language type of sound messages input into the microphone 15-2 by the player. In addition, the morphological database 1430-2 of the conversation controller 1000-2 configured by the first external storage unit 99-2 has the morpheme groups for the plural languages (morpheme dictionaries). Furthermore, the utterance type database 1450-2 of the conversation controller 1000-2 configured by the first external storage unit 99-2 also has dictionaries of the respective utterance types for the plural languages.

In addition, “sentence” data for the plural languages are also stored in the conversation database 1500-2 configured by the terminal controller 90-2 in order to output sound messages from the speaker 10-2 to the player in the language selected by the player or to display the messages on the display 8-2. The “sentences” include a message for requesting an input (by an utterance or an operation on the display 8-2) of a specific phrase or sentence in the language desired to be used in the roulette game, a message for confirming the player to proceed the roulette game in the language of the input specific phrase or sentence, or the like.

The operations of the above-mentioned conversation engine of the gaming terminal 4-2 of the present embodiment will be explained later.

Next, contents of gaming processing executed in each of the server 13-2, the roulette unit 2-2 and the gaming terminals 4-2 on the roulette game machine 1-2 according to the present embodiment will be explained.

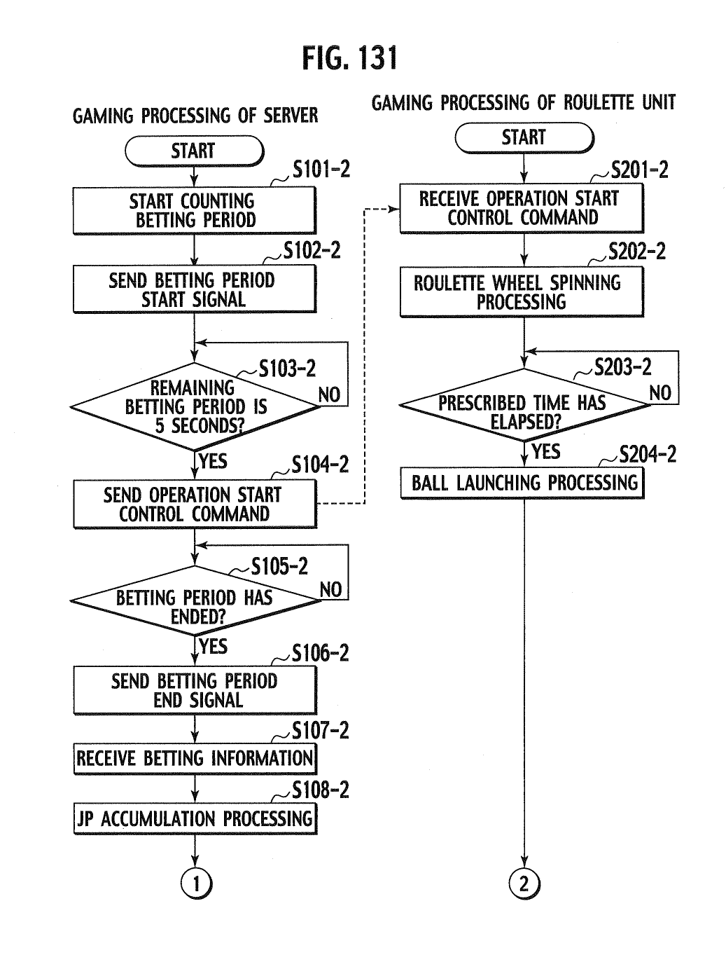

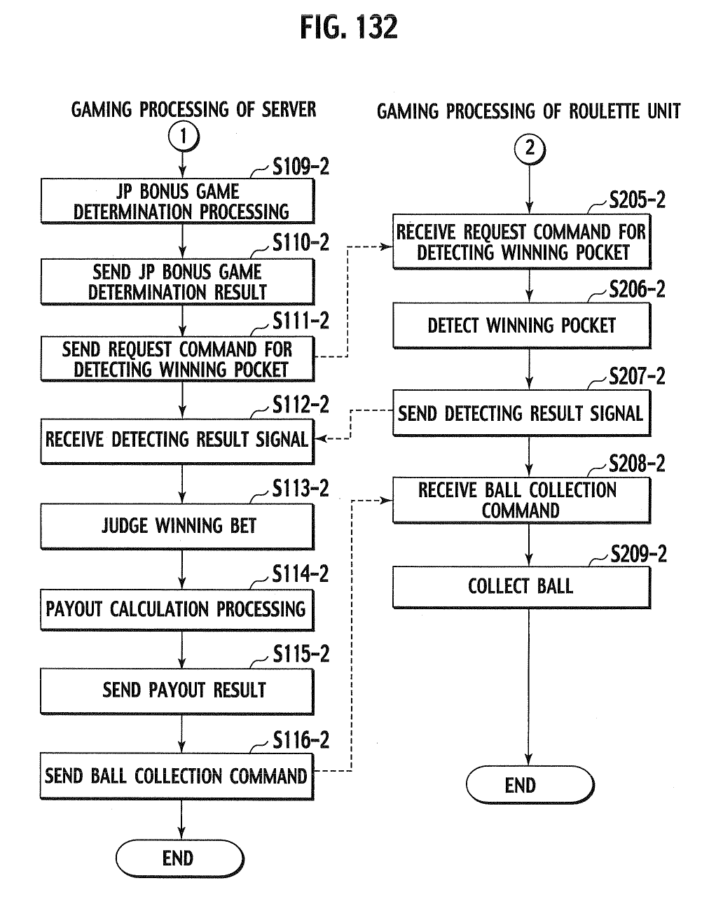

To begin with, gaming processing of the server, which is executed by the server CPU 81-2 of the server 13-2 according to the programs stored in the ROM 82-2, and gaming processing of the roulette unit, which is executed by the CPU 101-2 of the roulette unit 2-2 according to the programs stored in the ROM 102-2, will explained based on FIGS. 131 and 132. FIGS. 131 and 132 are flow charts of the gaming processings of the server and the roulette unit in the roulette gaming machine according to the present embodiment.

First, the gaming processing of the server 13-2 will be explained based on FIGS. 131 and 132. At first, as shown in FIG. 131, the server CPU 81-2 starts counting the betting period (step S101-2). The betting period is a period during which a player can place a bet(s). A player participating in a game can place a bet on the bet area 72-2 (see FIG. 105) which corresponds to the number predicted by the player during the betting period. The server CPU 81-2 sends a betting period start signal to the terminal CPU 91-2 when the betting period counting has been started (step S102-2).

Next, the server CPU 81-2 determines whether or not the remaining betting period has reached five seconds (step S103-2). Note that the remaining betting period is displayed on the bet time counter 69-2 on the display 8-2 at each of the gaming terminals 4-2 (see FIG. 105). If it is determined that it has not reached the last five seconds, the processing will be returned to the step S103-2. On the other hand, if it is determined that it has reached the last five seconds, the processing will proceed to the step S104-2.

The server CPU 81-2 sends a control command to the CPU 101-2 of the roulette unit 2-2 to start the operation of the roulette unit 2-2 (step S104-2). Next, the server CPU 81-2 determines whether or not the betting period has ended (step S105-2). If it is determined that the betting period has not ended (NO in step S105-2), the server CPU 81-2 suspends the processing until the betting period ends. On the other hand, if it is determined that the betting period has ended (YES in step S105-2), the server CPU 81-2 sends a betting period end signal indicating the expiry of the betting period to the terminal CPU 91-2 (step S106-2).

Next, the server CPU 81-2 receives the betting information (the information such as a specified bet area 72-2, a bet amount of chips and a betting type) input at each of the gaming terminals 4-2 by players from each of the terminal CPU's 91-2 (step S107-2) and stores it into the betting information storing area in the RAM 83-2.

Subsequently, the server CPU 81-2 executes a JP accumulation processing (step S108-2). In this JP accumulation processing, 0.30% of the total credits which have been bet at all the gaming terminals 4-2 and received in step S107-2 is accumulatively added to a JP amount stored in a “MINI” JP accumulation storing area in the RAM 83-2. In addition, in the JP accumulation processing, 0.20% of the total credits which have been bet at all the gaming terminals 4-2 and received in step S107-2 is accumulatively added to a JP amount stored in A “MAJOR” JP accumulation storing area in the RAM 83-2. Furthermore, in the JP accumulation processing, 0.15% of the total credits which have been bet at all the gaming terminals 4-2 and received in step S107-2 is accumulatively added to a JP amount stored in the “MEGA” JP accumulation storing area in the RAM 83-2. In addition, in the JP accumulation processing, displays in a MEGA counter 73-2, a MAJOR counter 74-2 and a MINI counter 75-2 are updated based on the accumulated JP amounts.

Next, as shown in FIG. 132, the server CPU 81-2 executes a JP bonus game determination processing (step S109-2). In this processing, the server CPU 81-2 determines whether or not to execute a JP bonus game at each of the gaming terminals 4-2 by using random number values sampled by a sampling circuit or the like, which of the gaming terminals 4-2 would win the JP (or all the gaming terminals 4-2 are to lose) in the case where the JP bonus game is to be executed and which JP (“MEGA”, “MAJOR” or “MINI”) is to be awarded in the case where the JP is to be awarded.

Next, the server CPU 81-2 sends a JP bonus game determination result to each of the gaming terminals 4-2 based on the process of step S109-2 (step S110-2). Subsequently, the server CPU 81-2 sends a control command to the CPU 101-2 of the roulette device 2-1 in order for the CPU 101-2 to detect the number pocket 23-2 into which the ball 27-2 has fallen into in the roulette unit 2-2 (step S111-2). Then, the server CPU 81-2 receives a control signal indicating the number pocket 23-2 into which the ball 27-2 has fallen from the CPU 101-2 of the roulette unit 2-2 (step S112-2).

Next, the server CPU 81-2 determines whether or not the bet placed at each of the gaming terminals 4-2 has won based on the betting information of each the gaming terminals 4-2 received in step S107-2 and the control signal indicating the number pocket 23-2 into which the ball 27-2 has fallen received in step S112-2 (step S113-2).

Next, the server CPU 81-2 executes a payout calculation processing (step S114-2). In the payout calculation processing, the server CPU 81-2 firstly specifies credits bet on the winning number for each of the gaming terminal 4-2 and then calculates the total payout credits to be paid out for each of the gaming terminals 4-2 by using odds (a credit amount to be paid out per one chip (one bet)) for each bet area 72-2 which is stored in an odds storing area in the ROM 82-2.

Next, the server CPU 81-2 executes a sending processing of the payout result of credits for a game based on the payout calculation processing of step S113-2 and the JP payout result based on the JP bonus game determination processing of step S109-2 (step S115-2). Specifically, the credit data, which corresponds to the payout credits for the game to the terminal CPU 91-2 of each of the winning gaming terminals 4-2, is output and the credit data, which corresponds to the currently accumulated JP credits, is output in the case where the JP is to be awarded. Next, the server CPU 81-2 sends a request command for collecting the ball 27-2 on the roulette wheel 22-2 to the CPU 101-2 of the roulette unit 2-2 (step S116-2). After the process of step S116-2, this subroutine is terminated.

Next, the gaming processing of the roulette unit 2-2 will be explained based on FIGS. 131 and 132. To begin with, as shown in FIG. 131, the CPU 101-2 receives the control command for staring the operation of the roulette unit 2-2 from the server CPU 81-2 of the server 13-2 (step S201-2).

Subsequently, the CPU 101-2 drives the wheel drive motor 106-2 to spin the roulette wheel 22-2 (step S202-2).

Next, after a prescribed time period has elapsed since the roulette wheel 22-2 starts spinning (YES in step S203-2), the CPU 101-2 launches the ball 27-2 at the time when a launching delay time has elapsed since it receives a detection signal from the pocket position detecting circuit 107-2 (step S204-2).

Next, as shown in FIG. 132, the CPU 101-2 receives the control command for detecting the pocket 23-2 into which the ball 27-2 has fallen from the server CPU 81-2 of the server 13-2 (step S205-2). Next, the CPU 101-2 determines which of the number pocket 23-2 into which the ball 27-2 has fallen by operating the ball sensor 105-2 (step S206-2). And then, the CPU 101-2 sends the detection result indicating the number pocket 23-2 into which the ball 27-2 has fallen to the server CPU 81-2 of the server 13-2 (step S207-2).

Next, the CPU 101-2 receives the request command for collecting the ball 27-2 from the server CPU 81-2 of the server 13-2 (step S208-2). Next, the CPU 101-2 collects the ball 27-2 on the roulette wheel 22-2 by operating the ball collecting unit 108-2 provided beneath the roulette wheel 22-2 (step S209-2). The collected ball 27-2 will be launched onto the roulette wheel 22-2 again by the ball launching unit 104-2 in the next game. After the process of step S209-2, this subroutine is terminated.

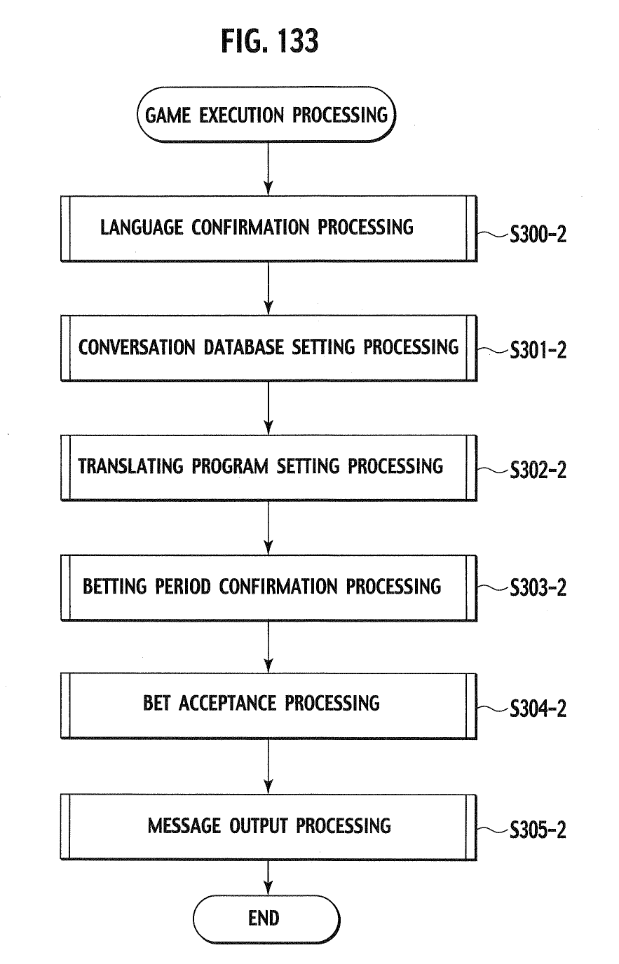

Next, processes executed by the terminal CPU 91-2 of the gaming terminal 4-2 of the roulette gaming machine 1-2 according to the present embodiment in accordance with the programs stored in the ROM 92-2 will be explained with reference to FIGS. 133 to 144.

Here, the flag F in the RAM 93-2 is set to a default value “1” which indicates during the betting period. In addition, a default bet screen 61-2 shown in FIG. 105 is displayed on the display 8-2 of the gaming terminal 4-2. In this state, as shown in FIG. 133, the terminal CPU 91-2 first executes language confirmation processing (step S300-2), then executes conversation database setting processing (step S301-2), then executes translating program setting processing (step S302-2), then executes betting period confirmation processing (step S303-2), then executes bet acceptance processing (step S304-2), and then executes message output processing (step S305-2).

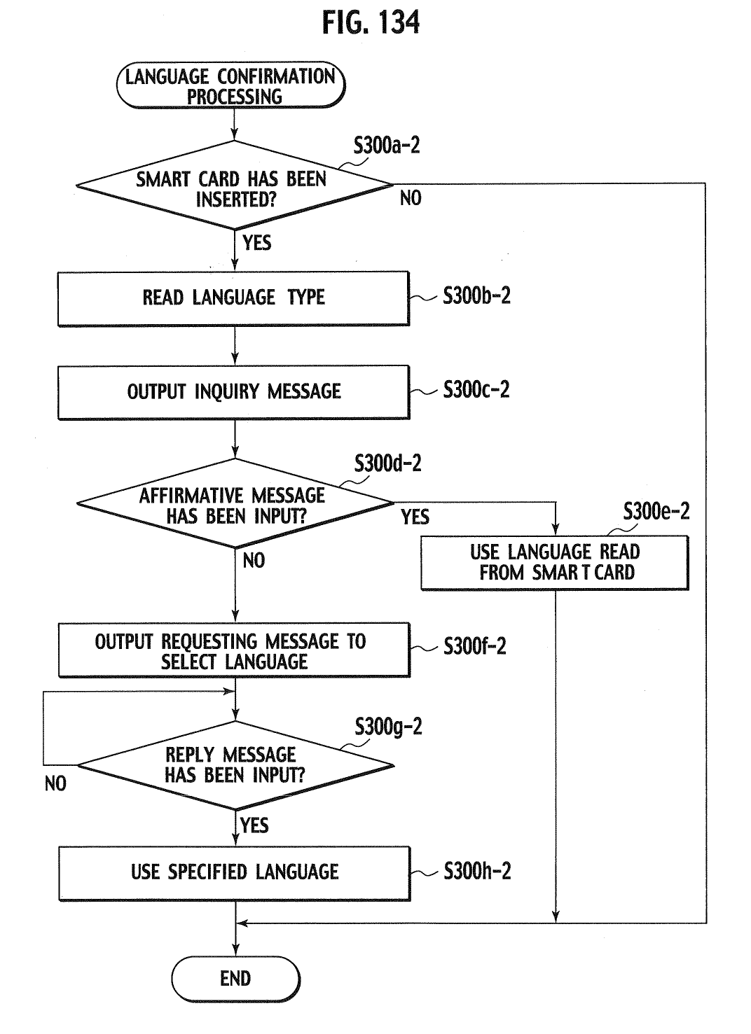

Then, in the language confirmation processing of step S300-2, the terminal CPU 91-2 confirms whether or not a new smart card has been inserted into the card reader 16-2 as shown in FIG. 134 (step S300a-2). If it is not inserted (NO in step S300a-2), the language confirmation processing is terminated. If it is inserted (YES in step S300a-2), the terminal CPU 91-2 reads, from the inserted smart card, a language type used in a game play by a player who possesses the smart card (step S300b-2).

Next, the terminal CPU 91-2 outputs a message inquiring whether or not a game is proceeded in the read-out language type (step S300c-2). The message may be output as sound from the speaker 10-2 via the sound input circuit 98-2, as texts on the display 8-2 via the LCD drive circuit 95-2 and so on.

For example, if the language type read by the card reader 16-2 from the smart card is English and a sound message is to be output from the speaker 10-2, the terminal CPU 91-2 outputs sound “English will be used. Is it all right?”

If the language type read by the card reader 16-2 from the smart card is English, the terminal CPU 91-2 assumes that a sound input “I want to use English. Is it all right?” have been input into the input unit 1100-2 of the conversation controller 1000-2 configured by the microphone 15-2, and outputs the above-mentioned sound from the speaker 10-2 served as the output unit 1600-2 (see FIG. 109) by making the conversation controller 1000-2 to execute corresponding processing.

In addition, if the language type read by the card reader 16-2 from the smart card is English, the terminal CPU 91-2 may output sound “English will be used. Is it all right?” from the speaker 10-2 according to the programs stored in the ROM 92-2 without using the conversation controller 1000-2.

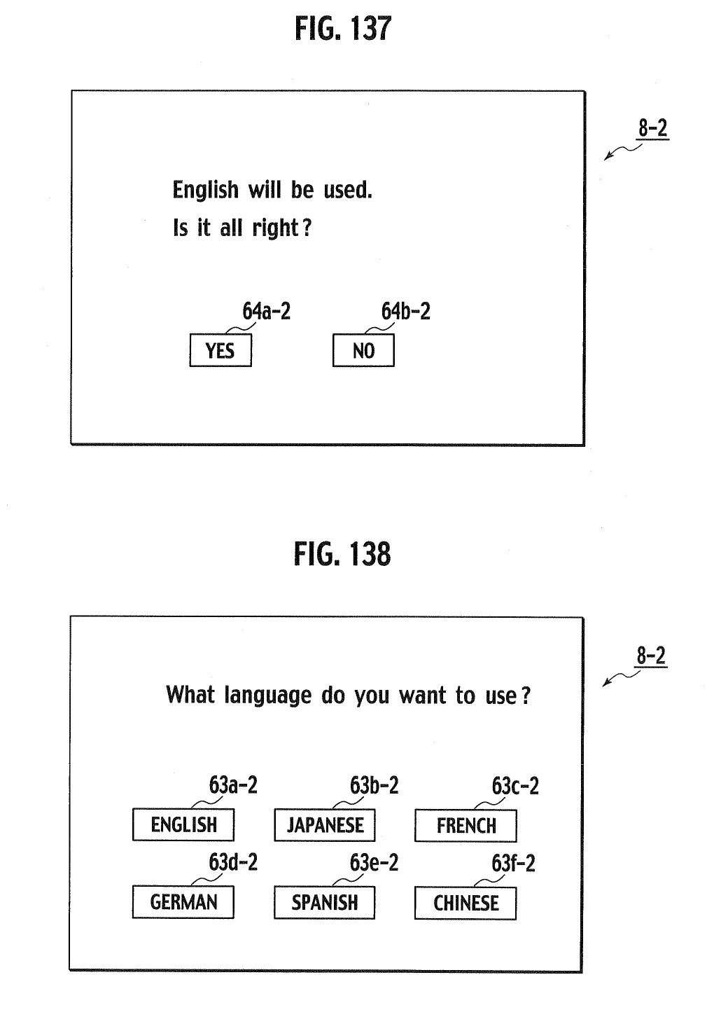

Alternatively, if the language type read by the card reader 16-2 from the smart card is English and a display message is to be output, the terminal CPU 91-2 displays sentences “English will be used. Is it all right?” on the display 8-2 together with “YES” and “NO” buttons 64a-2 and 64b-2 as shown in FIG. 137.

If the language type read by the card reader 16-2 from the smart card is English, the terminal CPU 91-2 assumes that character strings “I want to use English. Is it all right?” have been input into the input unit 1100-2 of the conversation controller 1000-2 configured by the touchscreen 50-2 on the display 8-2, and displays the above-mentioned sentences together with “YES” and “NO” buttons 64a-2 and 64b-2 on the display 8-2 served as the output unit 1600-2 by making the conversation controller 1000-2 to execute corresponding processing.

In addition, if the language type read by the card reader 16-2 from the smart card is English, the terminal CPU 91-2 may display sentences “English will be used. Is it all right?” on the display 8-2 together with “YES” and “NO” buttons 64a-2 and 64-2b according to the programs stored in the ROM 92-2 without using the conversation controller 1000-2.

Next, the terminal CPU 91-2 determines whether or not an affirmative message has been input in response to the output message in step S300c-2 (step S300d-2).

Here, if the message in step S300c-2 has been output as sound, it can be confirmed whether or not the message has been input in response to the output message by confirming whether or not the input unit 1100-2 of the conversation controller 1000-2 configured by the microphone 15-2 receives an input after the message has been output in step S300c-2. Alternatively, if the message in step S300c-2 has been displayed on the display 8-2 in English as shown in FIG. 137, it can be confirmed whether or not the message has been input in response to the output message by confirming whether or not a player's operation on the “YES” and “NO” buttons 64a-2 and 64b-2 displayed on the display 8-2 has been detected via the touchscreen 50-2.

In addition, it can be confirmed whether or not the input message in response to the output message in step S300c-2 is an affirmative message by analyzing contents of the sound message input into the microphone 15-2 using the conversation controller 1000-2, or detecting which of the “YES” and “NO” buttons 64a-2 and 64b-2 displayed on the display 8-2 as shown in FIG. 137 has been operated by the player.

Then, if an affirmative message has been input (YES in step S300d-2), the terminal CPU 91-2 displays a bet screen 61-2 which is displayed on the display 8-2 during the betting period of the roulette game in the language read by the card reader 16-2 from the smart card (step S300e-2). For example, if the language type read by the card reader 16-2 from the smart card is English, a bet screen 61-2 presented in English as shown in FIG. 105 is displayed on the display 8-2 during the betting period of the roulette game. Subsequently, the terminal CPU 91-2 terminates the language confirmation processing.

On the other hand, if an affirmative message has not been input (NO in step S300d-2), the terminal CPU 91-2 outputs a message for selecting the type of language to be used for proceeding the roulette game (step S300f-2). The message may be output as sound from the speaker 10-2 via the sound output circuit 96-2, or as texts on the display 8-2 via the LCD drive circuit 95-2.

For example, when a sound message is to be output, the terminal CPU 91-2 outputs sound requesting to select the language to be used in a game from the speaker 10-2. For example, if the language type read by the card reader 16-2 from the smart card is English, sound “What language do you want to use?” is output from the speaker 10-2.

The requesting sound to select the language to be used in a game is output from the speaker 10-2 with the language type had been read by the card reader 16-2 from the smart card. If a sound input in the negative has been input to the input unit 1100-2 of the conversation controller 1000-2 configured by the microphone 15-2 in response to the inquiring sound whether or not to proceed the game play in the above-mentioned language, the terminal CPU 91-2 makes the conversation controller 1000-2 to execute corresponding processing and then outputs a processing result thereof from the speaker 10-2 served as the output unit 1600-2.

Alternatively, if a display message is to be output, the terminal CPU 91-2 displays a sentence and buttons for selecting the language to be used in a game on the display 8-2. For example, if the language type read by the card reader 16-2 from the smart card is English, a sentence “What language do you want to use?” is displayed together with language selection buttons 63a-2, 63b-2, 63c-2, 63d-2, 63e-2 and 63f-2, each corresponding to “English”, “Japanese”, “French”, “German”, “Spanish” and “Chinese”, as shown in FIG. 138.

The sentence or the like for selecting the language to be used in a game are displayed on the display 8-2 with the language type read by the card reader 16-2 from the smart card. If an operation on a button indicating a player's rejection (e.g., the “NO” button 64b shown in FIG. 137) has been detected via the touchscreen 50-2, the terminal CPU 91-2 makes the conversation controller 1000-2 to execute corresponding processing and then displays a processing result thereof on the display 8-2 served as the output unit 1600-2.

Then, the terminal CPU 91-2 confirms whether or not a reply message in response to the output message in step S300f-2 has been input (step S300g-2).

Here, if the message in step S300f-2 has been output as sound, it can be confirmed whether or not the message has been input in response to the output by confirming whether or not the input unit 1100-2 of the conversation controller 1000-2 configured by the microphone 15-2 receives an input after the message has been output in step S300e-2. Alternatively, if the message in step S300f-2 has been displayed on the display 8-2, it can be confirmed whether or not the message has been input in response to the output message by confirming whether or not a player's operation on the language selection buttons (e.g., the buttons 63a-2, 63b-2, 63c-2, 63d-2, 63e-2 and 63f-2 each corresponding to “English”, “Japanese”, “French”, “German”, “Spanish” and “Chinese” as shown in FIG. 138) displayed on the display 8-2 has been detected via the touchscreen 50-2.

Then, if a reply message in response to the output message in step S300f-2 has not been input (NO in step S300g-2), the terminal CPU 91-2 repeats step S300g-2 until a reply is input. On the other hand, if a reply message has been input (YES in step S300g-2), the terminal CPU 91-2 displays a bet screen 61-2 on the display 8-2 during the betting period of the roulette game in the language specified by the input message in step S300g-2 (step S300h-2). Subsequently, the terminal CPU 91-2 terminates the language confirmation processing.

Here, if the message has been input as sound in step S300g-2, the language selected by the input message can be specified by analyzing contents of the sound message input into the microphone 15-2 using the conversation controller 1000-2. Alternatively, if the message has been input via a display screen on the display 8-2 in step S300g-2, the language selected by the input message can be specified by detecting contents of a player's operation onto the language selection buttons displayed on the display 8-2 by the terminal CPU 91-2 via the touchscreen 50-2.

Furthermore, in case of replacement of a player such as replacement of a smart card, the language confirmation processing shown in FIG. 134 is executed again.

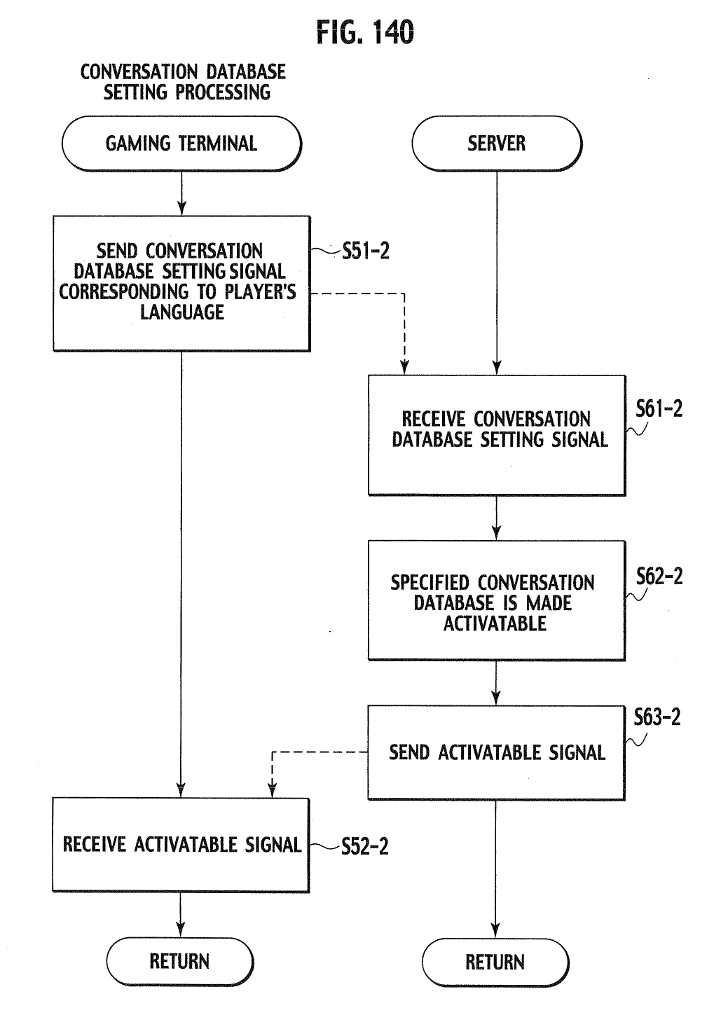

Next, the conversation database setting processing of step S301-2 in FIG. 133 will be explained with reference to a flow chart shown in FIG. 140.

The terminal CPU 91-2 of the gaming terminal 4-2 sends a signal for setting the conversation database corresponding to the player's language (e.g., Japanese) to the server 13-2 via the network based on the player's language determined in the language confirmation processing (step S51-2).

The server CPU 81-2 (see FIG. 106) of the server 13-2 receives the conversation database setting signal transmitted from the gaming terminal 4-2 (step S61-2) and makes a conversation database corresponding to the specified language activatable among the conversation database corresponding to plural languages in the HDD 34-2 (step S62-2).

Subsequently, the server CPU 81-2 sends an activatable signal indicating that the conversation database is being activatable to the gaming terminal 4-2 (step S63-2). The gaming terminal 4-2 receives the activatable signal (step S52-2). As a result, the conversation database corresponding to the player's language is made available in the gaming terminal 4-2 and the conversational processing using the conversation engine is made available.

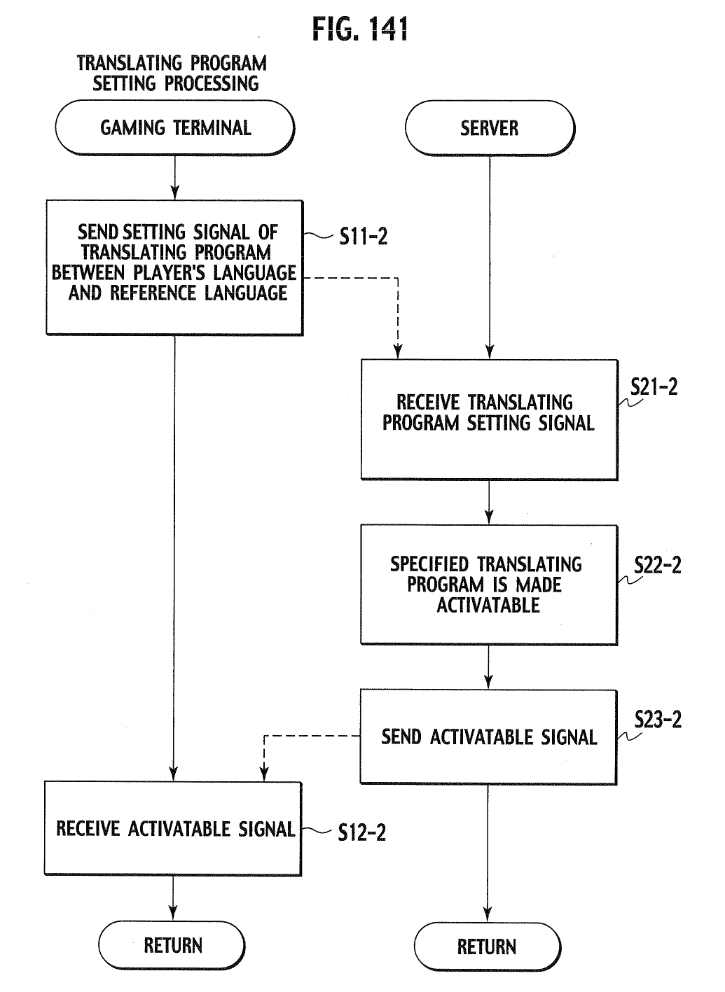

Next, the translating program setting processing of step S302-2 in FIG. 133 will be described with reference to a flow chart shown in FIG. 141.

The terminal CPU 91-2 of the gaming terminal 4-2 sends a setting signal of the translating program between the player's language (e.g., Japanese) and the reference language (e.g., English) to the server 13-2 via the network based on the player's language determined in the language confirmation processing (step S11-2).

The server CPU 81-2 (see FIG. 106) of the server 13-2 receives the translating program setting signal transmitted from the gaming terminal 4-2 (step S21-2) and makes a specified translating program (e.g., a “Japanese-English” translating program) activatable among translating programs corresponding to plural languages in the HDD 34-2 (step S22-2).

Subsequently, the server CPU 81-2 sends an activatable signal indicating that the translating program is being activatable to the gaming terminal 4-2 (step S23-2). The gaming terminal 4-2 receives the activatable signal (step S12-2). As a result, the translating program for translating the player's language into the reference language is made available in the gaming terminal 4-2.

Then, conversations using the conversation engine corresponding to the player's language are made available by the above-mentioned conversation database setting processing being executed. Therefore, since conversations using the language of the player playing at each of the gaming terminals 4-2 are enabled, games can be processed smoothly. Furthermore, messages for each player can be translated into the player's language and displayed on the display 8-2 by the above-mentioned translating program setting processing being executed. Therefore, it becomes easier for the player to understand message.

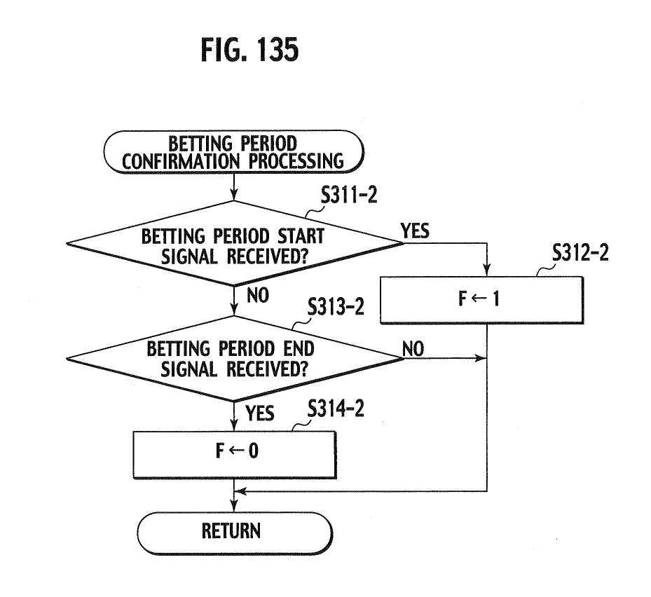

Next, the betting period confirmation processing of step S303-2 in FIG. 133 will be explained with reference to a flow chart shown in FIG. 135. As shown in FIG. 135, the terminal CPU 91-2 confirms whether or not the betting period start signal has been received from the server CPU 81-2 (step S311-2). If the betting period start signal has been received (YES in step S311-2), the terminal CPU 91-2 sets the flag F in the RAM 93-2 to “1” which indicates that it is under the betting period (step S312-2) and then terminates the betting period confirmation processing.

On the other hand, if the betting time start signal has not been received (NO in step S311-2), the terminal CPU 91-2 confirms whether or not the betting period end signal has been received from the server CPU 81-2 (step S313-2). If the betting period end signal has been received (YES in step S313-2), the terminal CPU 91-2 sets the flag F in the RAM 93-2 to “0” which indicates that it is not under the betting period (step S314-2) and then terminates the betting period confirmation processing. If the betting period end signal has not been received (NO in step S313-2), the terminal CPU 91-2 terminates the betting period confirmation processing.

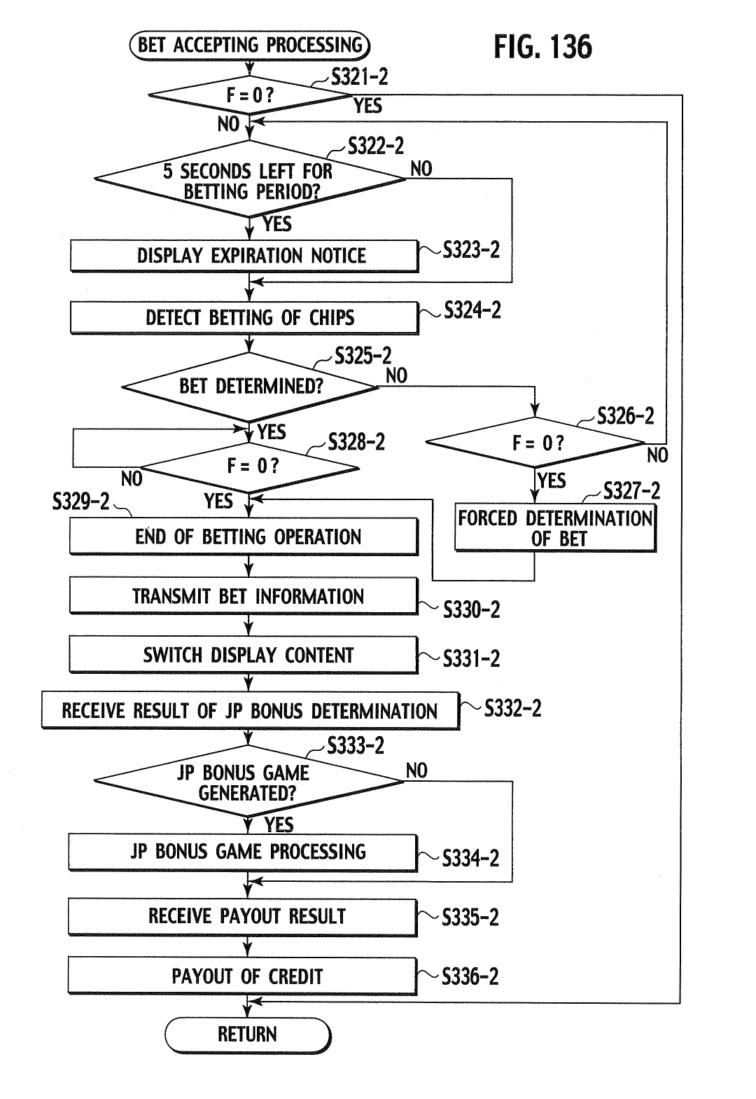

Next, in the bet accepting processing of step S304-2 in FIG. 133, as shown in FIG. 136, the terminal CPU 91-2 confirms whether or not the flag F in the RAM 93-2 is set to “0” (step S321-2). If the flag F is set to “0” (YES in step S321-2), the terminal CPU 91-2 terminates the bet accepting processing.

On the other hand, if the flag F is not set to “0” (NO in step S321-2), the terminal CPU 91-2 accepts a bet by a player. In this case, the terminal CPU 91-2 outputs a sound message “Bet acceptance starts.” from the speaker 10-2 using the conversation engine and the translating program. Specifically, the terminal CPU 91-2 sends a message data “Bet acceptance starts.” in the reference language (e.g., English) to the server 13-2 shown in FIG. 106. The server CPU 81-2 translates the message data into the player's language (e.g., Japanese) using the translating program (e.g., a “Japanese-English” translating program) stored in the HDD 34-2 and sends back the translated data to the gaming terminal 4-2. Then, the terminal CPU 91-2 receives the translated data and converts the translated data into sound data using the conversation engine to outputs from the speaker 10-2. Therefore, the message “Bet acceptance starts.” is output from the speaker in the player's language (e.g., Japanese).

In addition, for example, if a player utters “Tell me how to bet. (in Japanese)” into the microphone 15-2, the conversation engine analyzes this utterance using the Japanese conversation database and outputs a sound reply “Please insert medals into a medal insertion slot or press bet buttons. (in Japanese)” from the speaker 10-2.

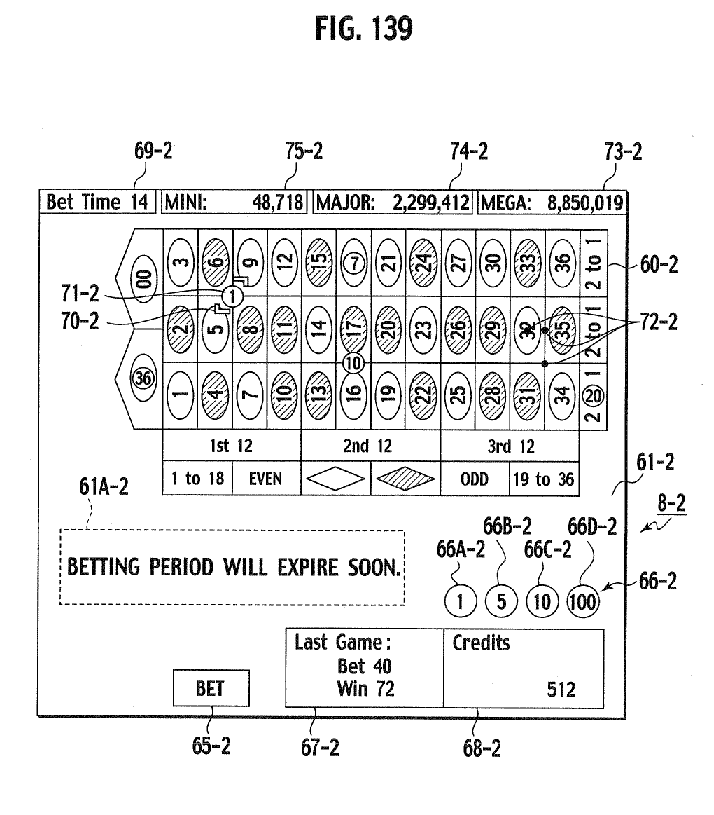

Next, the terminal CPU 91-2 confirms whether or not the remaining betting period has reached the last five seconds with the remaining time displayed on the bet time counter 69-2 being “5” (step S322-2). If the remaining time has reached the last 5 seconds (YES in step S322-2), the terminal CPU 91-2 displays a message to preannounce the end of the betting period on the bet screen 61-2 (step S323-2). Simultaneously, a sound message “Five seconds left for bets.” is output from the speaker 10-2 in the player's language. In addition, for example, if the player's language were Japanese, a sentence “Betting time will expire soon.” shown in FIG. 139 would be displayed in Japanese in the display area 61A-2 on the bet screen 61-2 of the display 8-2.

On the other hand, if the remaining time has not reached the last five seconds (it remains more than five seconds) (NO in step S322-2), the terminal CPU 91-2 proceeds to the step S324-2.

The terminal CPU 91-2 detects a bet placed by a player (step S324-2). A chip betting is detected by the player's touching on the bet area 72-2 in the betting board 60-2 or on the bet buttons 66-2 via the touchscreen 50-2. In addition, a bet can be accepted by way of a player's utterance into the microphone 15-2 and recognition of this utterance by the conversation engine. For example, a player makes an utterance “I will bet fifty credits.” after having selected a desired bet area 72-2 on the touchscreen 50-2. As a result, the utterance is detected via the microphone 15-2 and its sound data are analyzed by the conversation engine, and thereby a fifty-credit bet is confirmed. Furthermore, a reply “Fifty credits have been bet!” is output from the speaker 10-2. After a bet with a chip(s) has been detected, a chip mark 71-2 with an amount of the bet chip(s) is displayed on a specified bet area 72-2 on the display 8-2.

Next, the terminal CPU 91-2 confirms whether or not the player's bet has been confirmed (step S325-2). The betting confirmation is detected by the player's touching on the bet confirmation button 65-2 on the display 8-2 via the touchscreen 50-2.

If it is confirmed that the player's bet has not been confirmed (NO in step S325-2), the terminal CPU 91-2 confirms whether or not the flag F in the RAM 93-2 is set to “0” (step S326-2). If the flag F is not set to “0” (NO in step S326-2), the terminal CPU 91-2 returns the processing to step S322-2.

On the other hand, if the flag F is set to “0” (YES in step S326-2), the terminal CPU 91-2 fixes the player's bet forcibly (step S327-2) and then sifts the processing to after-mentioned step 329-2.

Alternatively, if it is confirmed that the player's bet has been confirmed (YES in step S325-2), the terminal CPU 91-2 confirms whether or not the flag F in the RAM 93-2 is set to “0” or not (step S328-2). If the flag F is not set to “0” (NO in step S328-2), the terminal CPU 91-2 repeats step S328-2. On the contrary, if the flag F in the RAM 93-2 is set to “0” (YES in step S328-2), the terminal CPU 91-2 proceeds to step S329-2.

The terminal CPU 91-2 closes acceptation of betting operations via the touchscreen 50-2 (step S329-2). Thereafter, the terminal CPU 91-2 sends the player's betting information (the specified bet area 72-2, the number of bet chips (bet amount)) of the gaming terminal 4-2 to the server CPU 81-2 (step S330-2).

Next, the terminal CPU 91-2 changes the screen image on the display 8-2 (step S331-2). Specifically, the terminal CPU 91-2 firstly switches the screen image on the display 8-2 to the bet screen 61-2 including an indication of the betting period expiry.

Thereafter, the terminal CPU 91-2 receives the result of the JP bonus game determination processing executed by the server CPU 81-2 from the server CPU 81-2 (step S332-2). The result of the JP bonus game determination includes the information which indicates: whether or not to execute the JP bonus game at any of the gaming terminals 4-2; which of the nine gaming terminals 4-2 is to win the JP (or all of the gaming terminals 4-2 are to lose) in the case where it is determined to execute the JP bonus game; and which JP (“MEGA”, “MAJOR” or “MINI”) is to be awarded in the case of the JP winning.

Next, the terminal CPU 91-2 determines whether or not to execute the JP bonus game based on the result of the JP bonus game determination processing received in step S332-2 (step S333-2). In the case where it is determined to execute the JP bonus game in the gaming terminal 4-2, the terminal CPU 91-2 executes a prescribed selection-type JP bonus game. And then, the terminal CPU 91-2 displays the bonus game result (whether or not the JP has been awarded) in the bet screen 61-2 on the display 8-2 (step S334-2) based on the determination result received in step S332-2.

In the case where it is determined not to execute the JP bonus game in the gaming terminal 4-2 in step S333-2, or after the processing in step S334-2, the terminal CPU 91-2 receives the payout result of credits from the server CPU 81-2 (step S335-2). Note that the payout result of credits includes the payout result for the game and the JP payout result for the JP bonus game. Here, in case of the payout of five hundred medals to be awarded for example, the terminal CPU 91-2 will output a sound message “Five hundred medals is awarded” from the speaker 10-2 in the player's language (for example, in Japanese).

Next, the terminal CPU 91-2 awards a payout according to the payout result received in step S335-2 (step S336-2). Specifically, the terminal CPU 91-2 stores, in the RAM 93-2, the credit data corresponding to the payout for the game and the credit data corresponding to the currently accumulated JP credits if the JP is awarded in the gaming terminal 4-2. Then, when the payout button 5-2 has been touched, medals corresponding to the credits stored in the RAM 93-2 (usually, one medal per one credit) are paid out from the medal payout chute 12-2. Thereafter, the terminal CPU 91-2 terminates the bet accepting processing.

It is obvious from the above description that the terminal controller of the present invention is configured by the terminal CPU 91-2 in the roulette gaming machine 1-2 of the third embodiment.

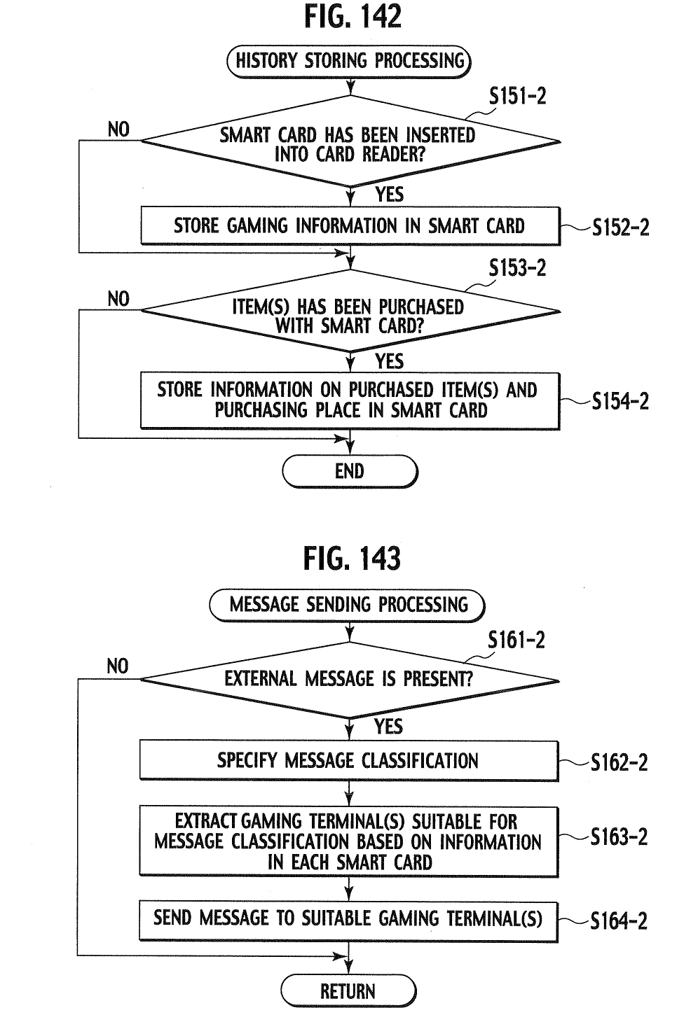

Next, the history storing processing in respect to a player's smart card will be explained with reference to FIG. 142. As explained above, a smart card is player's member's card or credit card and stores data on player's playing history (history information) therein together with player's identification data. The history data include information on kinds of games previously played, points awarded in previously played games, the player's language used in playing games and so on.

Furthermore, data equivalent to coins, bills or credits are stored in a smart card and items can be purchased with the smart card. In addition, information such as a restaurant(s) previously visited, a beverage(s) previously ordered, a purchased souvenir(s) and so on can be stored in the smart card in addition to information on the game plays.

As shown in FIG. 142, the terminal CPU 91-2 of the gaming terminal 4-2 determines whether or not a smart card has been inserted into the card reader 16-2 (see FIG. 102) (step S151-2). Then, when a smart card insertion has been detected and a game play(s) has been done in the gaming terminal 4-2, history data on the game play(s) are stored in the smart card (step S152-2).

Subsequently, it is determined whether or not the player has purchased an item(s) with the smart card (step S153-2).

And then, when the player has purchased an item(s) with the smart card, for example, purchasing a souvenir(s) at a souvenir shop, having a meal(s) at a restaurant, enjoying massaging service or the like, information with respect to these is stored in the smart card (step S154-2). For example, information such as “purchasing wine on Δ/Δ (month and day) at OO (liquor shop name)” is stored in the smart card. In this manner, various history data are stored in the player's smart card.

Next, the message output processing of step S305-2 in FIG. 133 will be explained. The message output processing is composed of “message sending processing” due to which the sever 13-2 sends a message to the gaming terminals 4-2 and “message notifying processing” due to which a message received at the gaming terminal 4-2 is notified to a player.

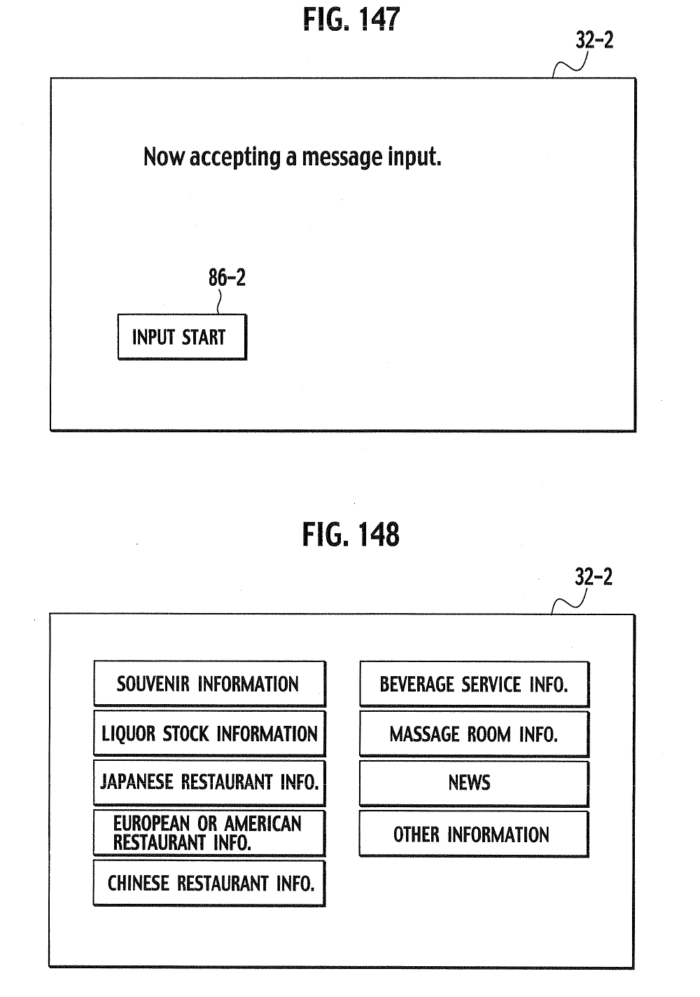

Hereinafter, the message sending processing will be explained with reference to FIG. 143. The server CPU 81-2 shown in FIG. 106 determines whether or not a message(s) has been externally input (step S161-2). Specifically, as shown in FIG. 147, a text string “Now accepting a message input.” and an “INPUT START” image 86-2 are displayed on the LCD 32-2 of the server 13-2 shown in FIG. 106. When the “INPUT START” image 86 has been touched by a user, this touching operation is detected via the touchscreen 32A-2 and a message input is started. A message input is conducted by an operation in which the user input a message via the keyboard 33-2 or an operation in which a message is input as sound data due to a user's utterance into the microphone 35-2. The user can input a message to be provided to players by these operations.

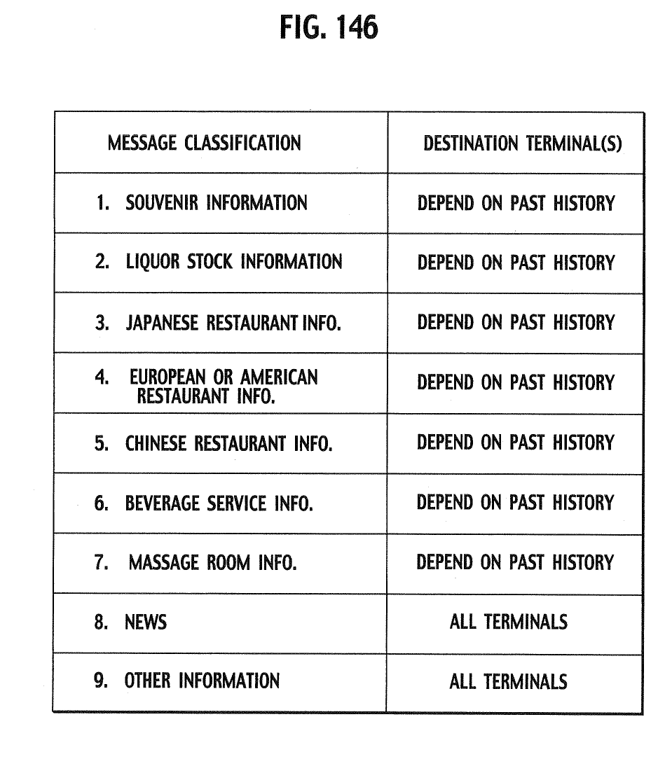

Furthermore, the user inputs a classification on the input message. As shown in FIG. 146, message classifications includes “Souvenir information”, “Liquor stock information”, “Japanese restaurant info.”, “European or American restaurant info.”, “Chinese restaurant info.”, “Beverage service info.”, “Massage room info.”, “News” and “Other information”. Images relating to these are displayed on the LCD 32-2, as shown in FIG. 148. Then, the user inputs a message classification by touching one of these images. For example, the user inputs a message “We are pleased to announce that we have this year's Beaujolais Nouveau in stock now. We are looking forward to your order.” by an utterance into the microphone 35-2 (see FIG. 106) and further selects “Liquor stock information” shown in FIG. 148.

Subsequently, the server CPU 81-2 specify the message classification of the input message (step S162-2). Further, the server CPU 81-2 search the gaming terminal(s) suitable for the message classification based on the history information of each smart card read out by the card reader 16-2 of each of the gaming terminals 4-2 (step S163-2).

In this process, the server CPU 81-2 read out the history information in the smart card used at each of the gaming terminals 4-2 via the network to determine whether or not there is history information suitable for the message classification among the history information stored in the smart cards. And then, the gaming terminal(s) at which the smart card storing the history information suitable for the message classification is used, is set as the destination gaming terminal(s) 4 of the message.

For example, if a history of previously purchasing wine is included in information stored in a smart card, the gaming terminal 4-2 at which the smart card is used is set as the destination gaming terminal 4-2 of a liquor stock information message.

Subsequently, the server CPU 81-2 sends the message to the gaming terminal(s) 4 set as a destination. Therefore, the message “We are pleased to announce that we have this year's Beaujolais Nouveau in stock now. We are looking forward to your order.” is sent to the gaming terminal(s) 4 of a player(s) who purchased liquor in the past.

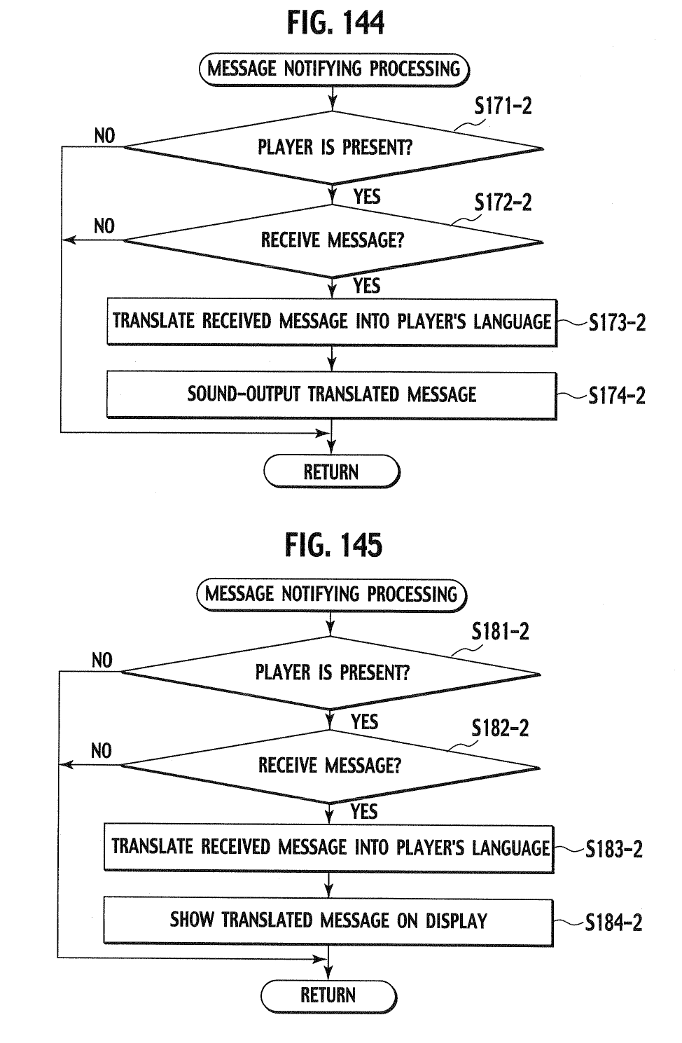

Next, the message notifying processing executed at each of the gaming terminals 4-2 will be explained with reference to a flow chart shown in FIG. 144.

The terminal CPU 91-2 shown in FIG. 108 determines whether a player is present or absent (step S171-2). Specifically, if a smart card has been inserted in the above-mentioned card reader 16-2, it is determined that a player is present. If no smart card has been inserted in the card reader 16-2, it is determined that a player is absent. Note that it may be possible to detect a presence of a player based on a method in which it is detected whether or not a pressure is detected by a pressure sensor provided on a seat on which a player sits, another method in which image processing is made to an image capturing a player by a camera, or the like.

Then, if it is determined that a player is present (YES in step S171-2), the terminal CPU 91-2 determines whether or not the message sent from the server 13-2 has been received (step S172-2). If the message has been received (Yes in step S172-2), the message in the reference language (for example, English) is translated into the player's language (for example, Japanese) using the translating program (step S173-2).

Subsequently, the terminal CPU 91-2 converts the translated message into sound data using the conversation engine to be output from the speaker 10-2 (step S174-2).

For example, upon receiving the English message “We are pleased to announce that we have this year's Beaujolais Nouveau in stock now. We are looking forward to your order.” sent from the server 13-2, the terminal CPU 91-2 translated the message into the player's language Japanese to sound-output it from the speaker 10-2. Therefore, the player can recognize, in his/her language Japanese, that Beaujolais Nouveau is in stock.

Next, a modified example of the message notifying processing executed at each of the gaming terminals 4-2 will be explained with reference to a flow chart shown in FIG. 145.

First, the terminal CPU 91-2 determines whether a player is present or absent (step S181-2). Specifically, if a smart card has been inserted in the above-mentioned card reader 16-2, it is determined that a player is present. If no smart card has been inserted in the card reader 16-2, it is determined that a player is absent.

Then, if it is determined that a player is present (YES in step S181-2), the terminal CPU 91-2 determines whether or not the message sent from the server 13-2 has been received (step S182-2). If the message has been received (Yes in step S182-2), the message in the reference language (for example, English) is translated into the player's language (for example, Japanese) using the translating program (step S183-2).

Subsequently, the terminal CPU 91-2 displays the translated message on the display 8-2 (step S184-2).

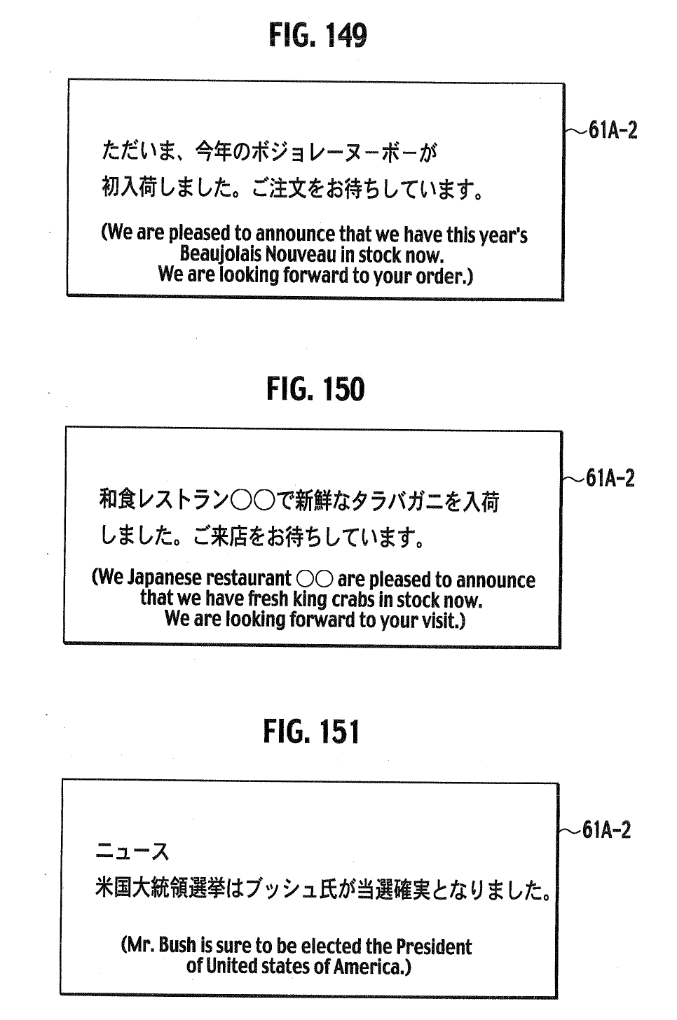

For example, upon receiving the English message “We are pleased to announce that we have this year's Beaujolais Nouveau in stock now. We are looking forward to your order.” sent from the server 13-2, the terminal CPU 91-2 translated the message into the player's language Japanese to display it on the display 8-2. Specifically, as shown in FIG. 149, the message “We are pleased to announce that we have this year's Beaujolais Nouveau in stock now. We are looking forward to your order.” is displayed in Japanese in the display area 61A-2 on the betting screen 61-2 shown in FIG. 105. Therefore, the player can recognize, in his/her language Japanese, that Beaujolais Nouveau is in stock.

In addition, in another example as shown in FIG. 150, in case where a message had been input by the user is “We Japanese restaurant OO are pleased to announce that we have fresh king crabs in stock now. We are looking forward to your visit.”, its message classification is classified to “Japanese restaurant information” (see FIG. 146). Therefore, this message is sent to the player who visited the Japanese restaurant in the past and shown on the display 8-2 after being translated into the player's language Japanese.

Furthermore, in yet another example as shown in FIG. 151, in case where a message had been input by the user is “Mr. Bush is sure to be elected the President of United states of America.”, its message classification is classified to “News” (see FIG. 146). Therefore, this message is sent to all of the gaming terminals 4-2 and shown on each display 8-2 after being translated into each player's language (Japanese in FIG. 151).

In this manner, a player's language is confirmed by the conversation engine and a conversation with a player is done in the language in the gaming system according to the third embodiment. For example, if the player uses Japanese, information relating to a game will be given to the player as a sound message(s) in Japanese. In addition, a player's utterance in Japanese is analyzed to proceed a game. Therefore, the player can play a game by having a voice conversation in the player's language.

In addition, in case where messages relating to various information have been input at the server 13-2, a destination gaming terminal(s) 4 is selected based on their message classifications and the history information stored in the smart cards used at the gaming terminals 4-2. As a result, the messages are sent to players who needs the message and uninterested messages are not sent.

### Fourth Embodiment

Next, the fourth embodiment of the game execution processing will be explained. In the fourth embodiment, conversation data of the conversation database corresponding to the player's language are transmitted to the gaming terminal 4-2 among the conversation database corresponding to plural languages stored in the HDD 34-2 of the server 13-2. In addition, the translating program to be used is transmitted to the gaming terminal 4-2 among plural translating programs stored in the HDD 34-2. Then, the gaming terminal 4-2 downloads the conversation data and the translating program that have been transmitted to the second external storage unit 76-2 (see FIG. 108). The terminal CPU 91-2 of the gaming terminal 4-2 executes a roulette game with the conversation data and the translating program that have been downloaded.

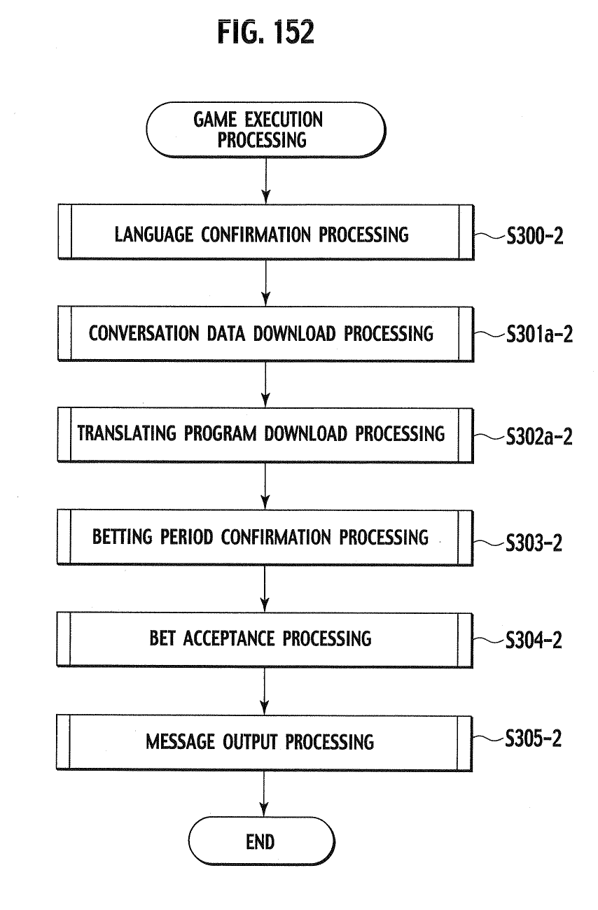

Hereinafter, the game execution processing according to the fourth embodiment will be explained with reference to a flow chart shown in FIG. 152. As shown in FIG. 152, the terminal CPU 91-2 first executes the language identifying processing (step S300-2), then executes conversation data download processing (step S301a-2), then executes translating program download processing (step S302a-2), then executes the betting period confirmation processing (step S303-2), then executes the bet acceptance processing (step S304-2), and then executes the message output processing (step S305-2).

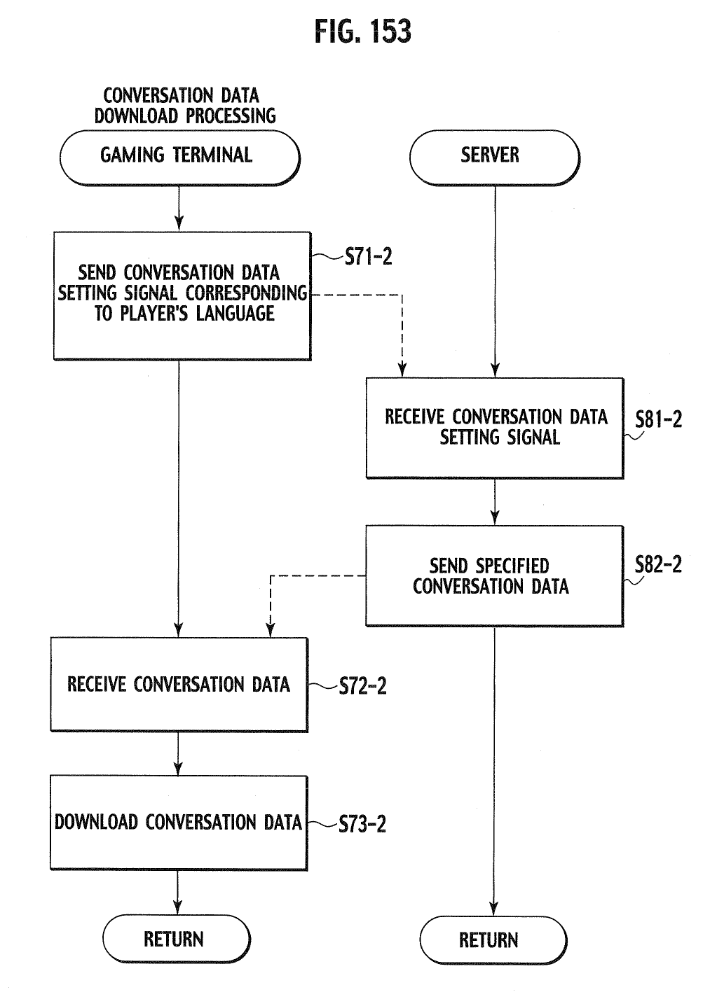

Since the language confirmation processing of step S300-2, the betting period confirmation processing of step S303-2, the bet acceptance processing of step S304-2 and the message output processing of step S305-2 are similar to those of the above-described third embodiment, their description is omitted. Hereinafter, the conversation data download processing of step S301a will be explained with reference to a flow chart shown in FIG. 153.

The terminal CPU 91-2 of the gaming terminal 4-2 sends a conversation data setting signal corresponding to the player's language (e.g., Japanese) to the server 13-2 via the network based on the player's language determined in the language confirmation processing (step S71-2).

The server CPU 81-2 (see FIG. 106) of the server 13-2 receives the conversation data setting signal transmitted from the gaming terminal 4-2 (step S81-2) and then acquires the conversation data of the specified conversation database among conversation database corresponding to plural languages in the HDD 34-2 to send it to the gaming terminal 4-2 via the network (step S82-2).

The gaming terminal 4-2 receives the conversation data (step S72-2). Furthermore, the gaming terminal 4-2 downloads the received conversation data to the second external storage unit 76-2 (step S73-2).

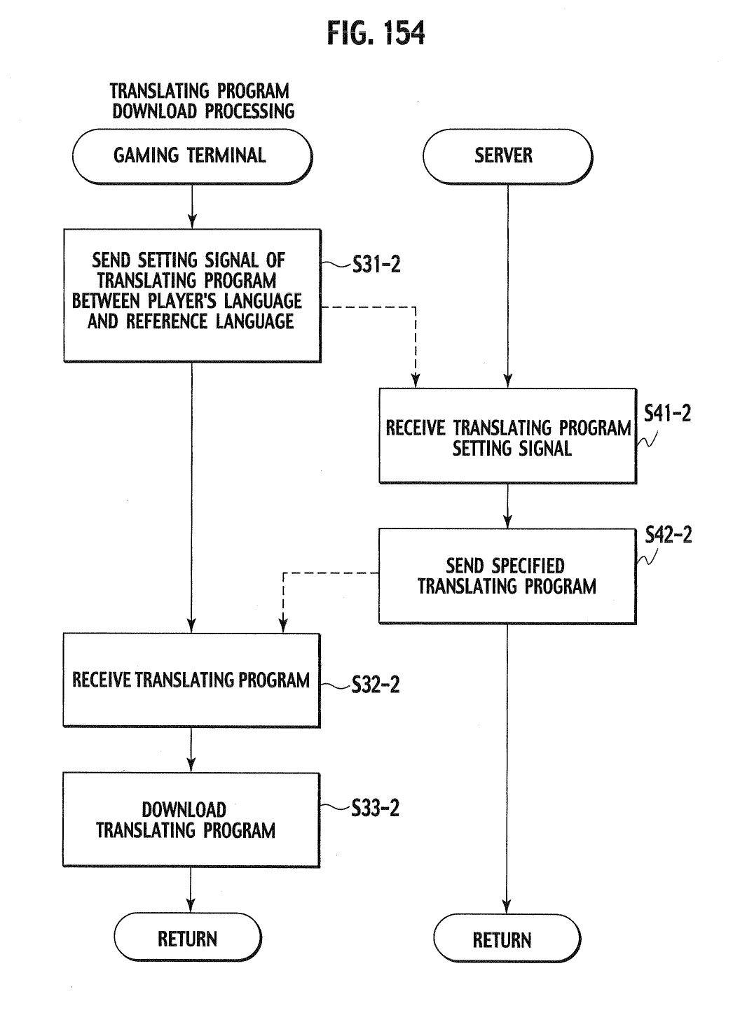

Next, the translating program download processing of step S302a-2 in FIG. 152 will be explained with reference to a flow chart shown in FIG. 154.

The terminal CPU 91-2 of the gaming terminal 4-2 sends a setting signal of the translating program between the player's language (e.g., Japanese) and the reference language (e.g., English) to the server 13-2 via the network based on the player's language determined in the language confirmation processing (step S31-2).

The server CPU 81-2 (see FIG. 106) of the server 13-2 receives the translating program setting signal transmitted from the gaming terminal 4-2 (step S41-2) and reads out the specified translating program (e.g., a “Japanese-English” translating program) among plural translating programs in the HDD 34-2 to send it to the gaming terminal 4-2 via the network (step S42-2).

The gaming terminal 4-2 receives the translating program (step S32-2). Furthermore, the gaming terminal 4-2 downloads the received translating program to the second external storage unit 76-2 (step S33-2).

In this manner, since the conversation data used in the conversation engine is downloaded to the second external storage unit 76-2, a conversation with the player using this conversation data can be done. Furthermore, since the translating program to be used for notifying a message to a player is similarly downloaded to the second external storage unit 76-2, the message to be notified to the player can be translated into the player's language to be displayed.

As described above, in the gaming system according to the fourth embodiment, the conversation data used in the conversation engine and the translating program used at the gaming terminal 4-2 are downloaded in the second external storage unit 76-2 and then utilized. According to this configuration, similarly to the above-described third embodiment, a player can hear a sound message output in his/her language and can play a game through an utterance(s) in his/her language. Furthermore, the player can recognize the message displayed on the display 8-2 in his/her language.

### Fifth and Sixth Embodiments

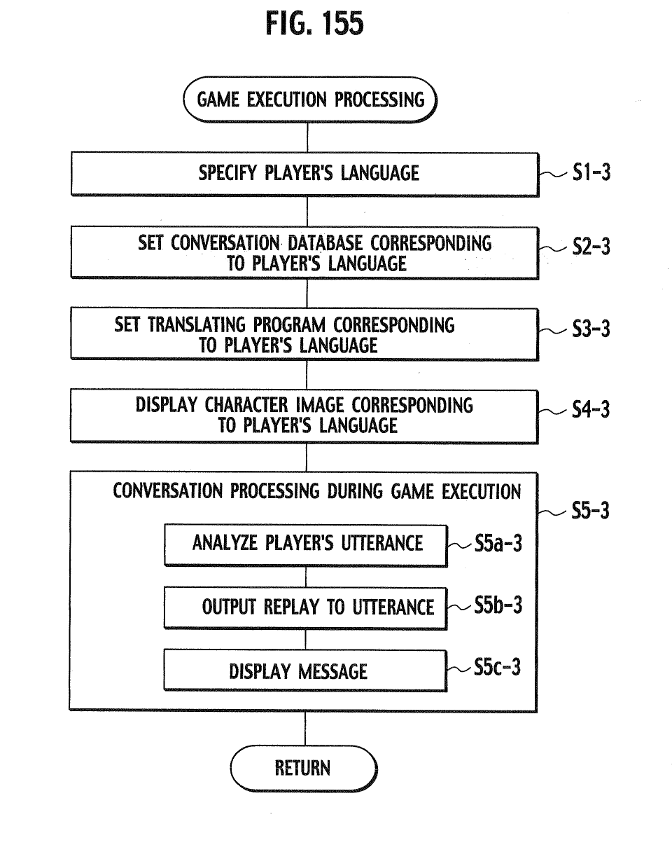

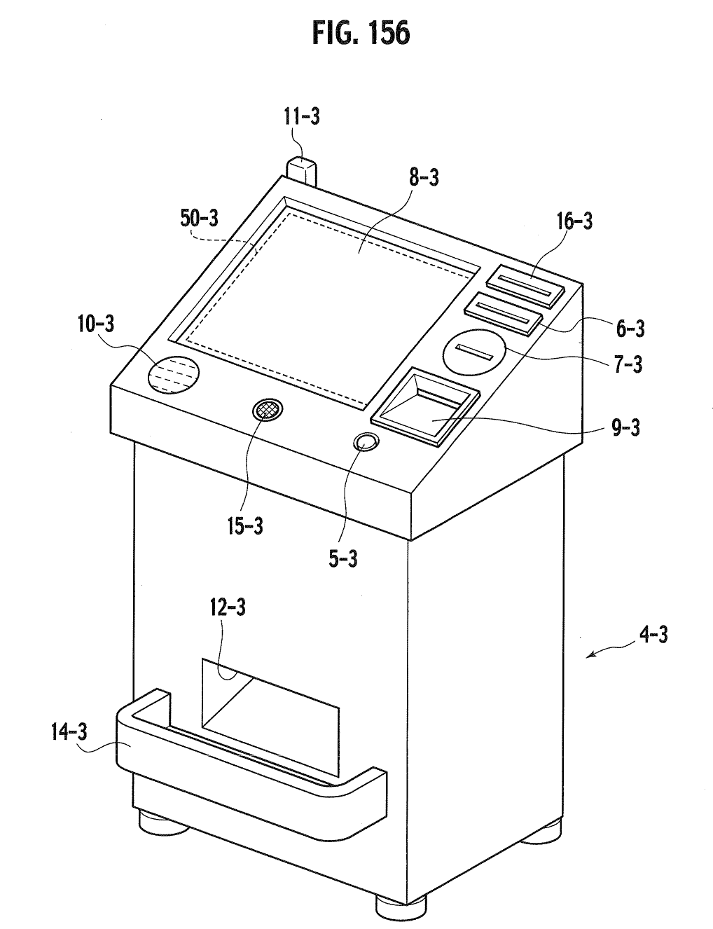

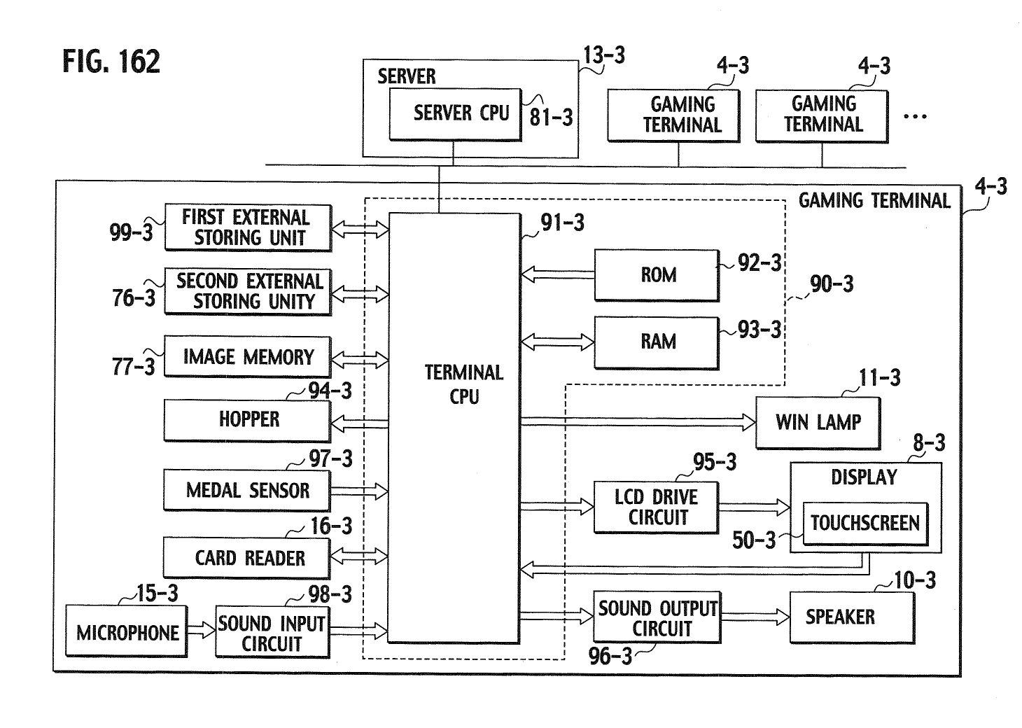

FIG. 155 is a flow chart showing a general process flow of game execution processing executed in a gaming system according to fifth and sixth embodiments of the present invention. FIG. 156 is a perspective view showing a gaming terminal 4-3 provided in a plurality in the gaming system according to the fifth and sixth embodiments of the present invention. FIG. 162 is a block diagram showing an internal configuration of the gaming system. Hereinafter, the general process flow in the gaming system according to the present invention will be explained with reference to the drawings.

A terminal CPU 91-3 shown in FIG. 162 confirms a player's language on a gaming terminal 4-3 through a player's input operation or an after-mentioned conversation engine (step S1-3 in FIG. 155). A recognition processing of language will be explained later.

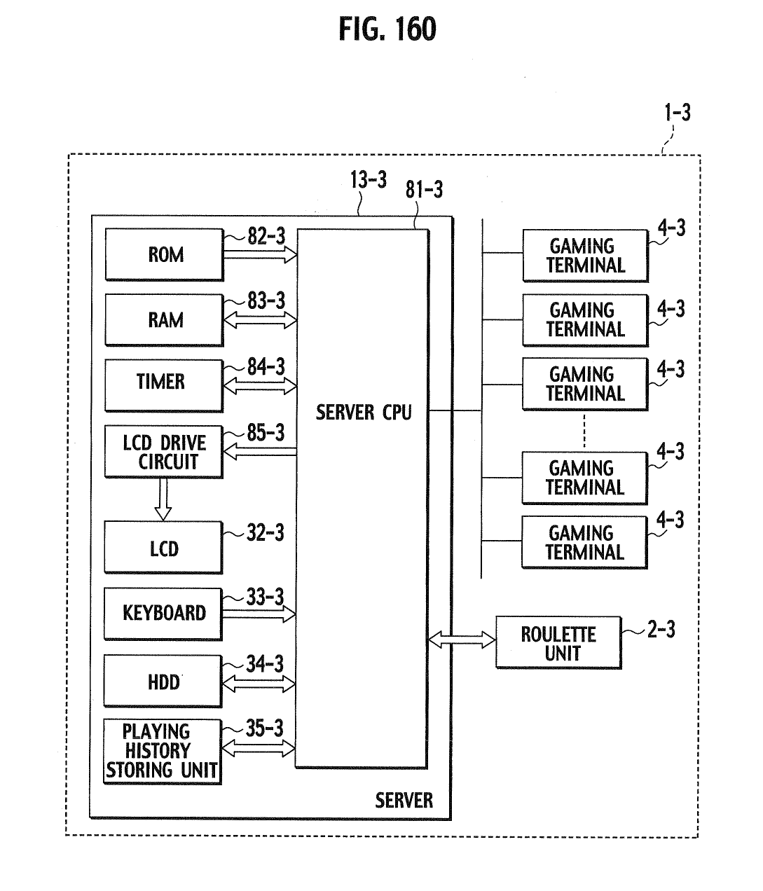

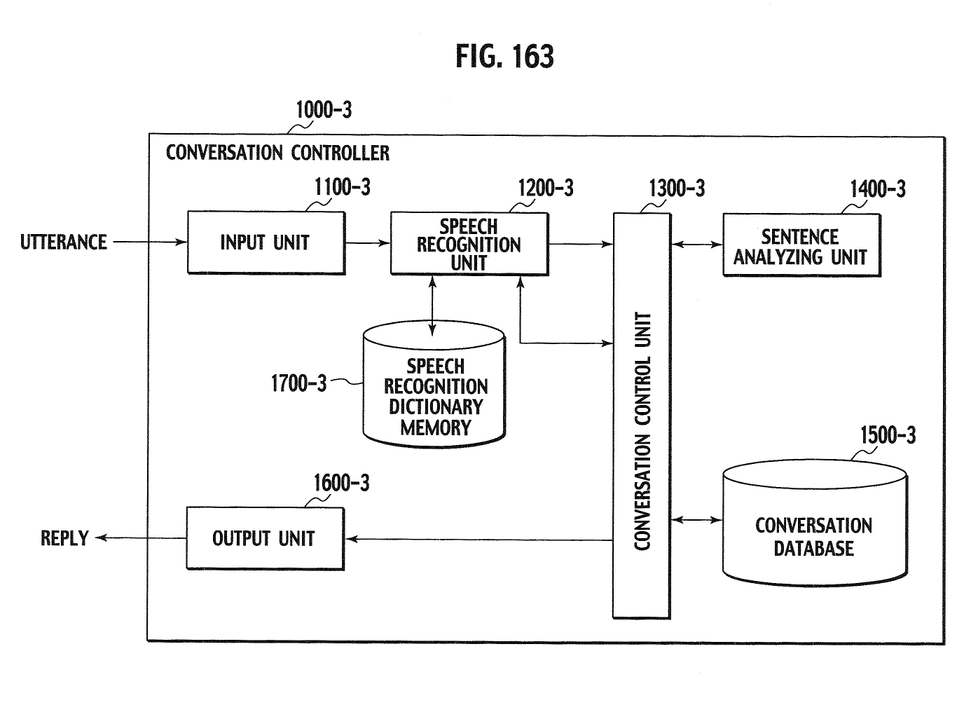

Next, the terminal CPU 91-3 configures a conversation database 1500-3 corresponding to the language confirmed in the process of step S1-3 among a conversation database 1500-3 (see FIG. 163) stored in a hard disc drive (HDD) 34-3 of a server 13-3 shown in FIG. 160 and corresponding to plural languages (step S2-3). For example, if the player's language is “Japanese”, a conversation database 1500-3 corresponding to “Japanese” is configured.

The terminal CPU 91-3 configures a translating program corresponding to the language confirmed in the process of step S1-3 from translating programs which are stored in the HDD 34-3 of the server 13-3 shown in FIG. 160 and correspond to plural languages (step S3-3). For example, if the player's language is “Japanese”, a “Japanese-English” translating program is configured.

Furthermore, the terminal CPU 91-3 reads out a character image corresponding to the player's language among plural character images stored in an image memory 77-3 shown in FIG. 162 to display the character image on a display 8-3 (step S4-3). For example, if the player's language is Japanese, a character image which looks like a Japanese is selected. If the player's language is Chinese, a character image which looks like a Chinese is selected. If the player's language is Arabic, a character image which looks like an Arabic is selected. Therefore, the player's language used at the gaming terminal can be understood intuitively when someone except the player see the display 8-3.

Subsequently, the terminal CPU 91-3 executes a roulette game with conducting a conversation with the player using a conversation engine (step S5-3).

In a conversational processing during a roulette game execution, an utterance input into a microphone 15-3 of the gaming terminal 4-3 is analyzed (step S5a-3). Then, a reply to the utterance is generated by the conversation engine and the generated reply is output as sound from a speaker 10-3 (step S5b-3).

For example, if the player makes an utterance “Tell me how to place a bet!” into the microphone 15-3 in Japanese, the conversation engine analyzes the utterance using the Japanese conversation database and outputs a reply sentence “Please insert medals into a medal insertion slot or press bet buttons.” in Japanese from the speaker 10-3. Since the terminal CPU 91-3 outputs the reply in the player's language, the player can easily understand a message output from the gaming terminal 4-3a.

Furthermore, in case where a message(s) is to be notified to the player, this message is displayed on the display 8-3 in the player's language confirmed in the process of step S1-3 (step S5c-3). For example, when a bet acceptance is to be started, a text message “Bet acceptance starts.” is displayed in Japanese. Therefore, the player can recognize the message displayed on the display 8-3 in the player's familiar language.

### Fifth Embodiment

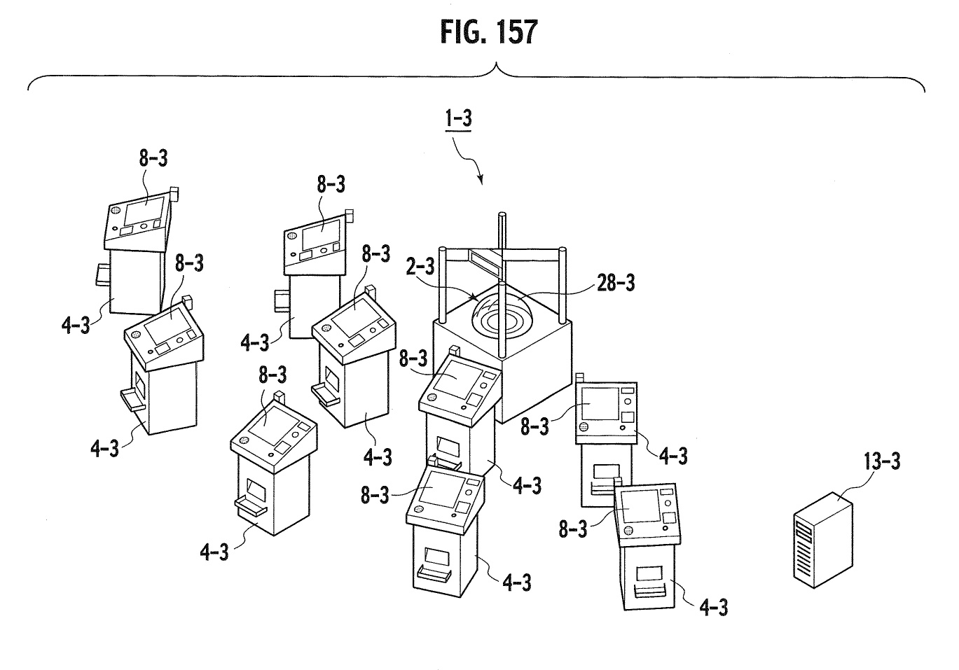

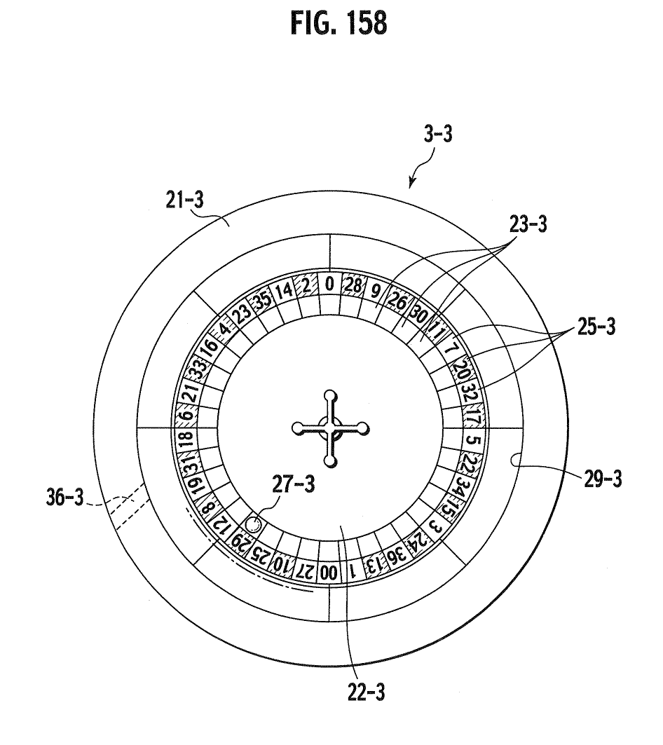

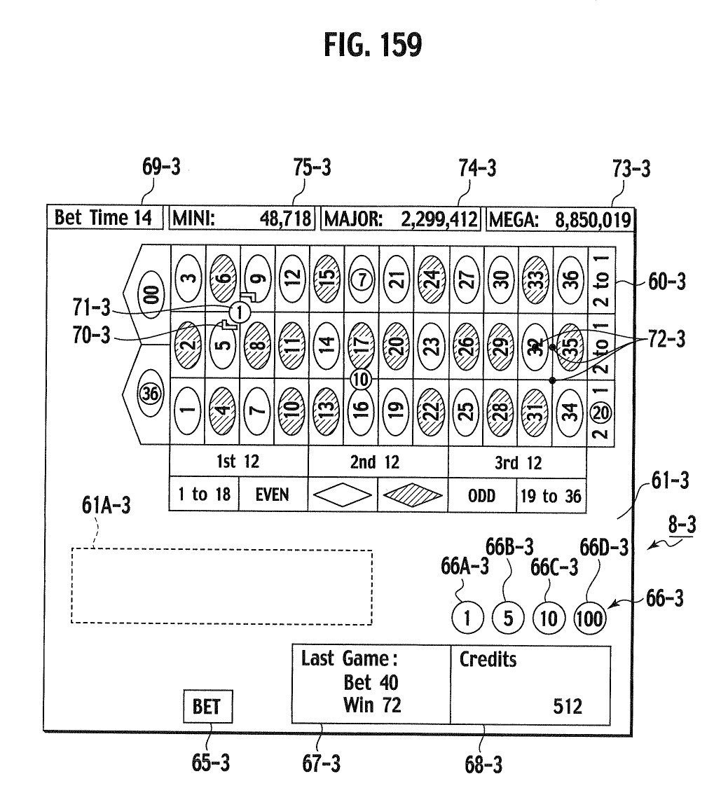

Next, a gaming system in the embodiments according to the present invention will be explained in detail. FIG. 156 is a perspective view showing a gaming terminal in the fifth embodiment according to the present invention. FIG. 157 is an apparent perspective view showing a general configuration of a roulette game machine 1-3 including the gaming terminal shown in FIG. 156, which is an example of the gaming system of the embodiment according to the present invention. FIG. 158 is a plan view of a roulette unit 2-3 provided in the roulette game machine 1-3. FIG. 159 is a screen image example displayed on a display of the gaming terminal shown in FIG. 156.

Plural (nine in the drawing) gaming terminals 4-3 in the fifth embodiment shown in FIG. 156 are provided as parts of the roulette game machine 1-3 shown in FIG. 157. In addition, the roulette game machine 1-3 includes the roulette unit 2-3 and a server (host server) 13-3. Each of the gaming terminals 4-3, the roulette unit 2-3 and the server 13-3 can be connected each other via a local network and so on.

At the roulette unit 2-3, the roulette game will be executed under the control of the server 13-3, and the game can be visible by players. Players use the gaming terminals 4-3 which are arranged around the roulette unit 2-3 to participate in a roulette game displayed by the roulette unit 2-3. In the present embodiment, the roulette game machine 1-3 includes the nine gaming terminals 4-3. Therefore, up to nine players can participate in a communal roulette game simultaneously.

A roulette game displayed on the roulette unit 2-3 is executed repeatedly at prescribed time intervals under the control of the server 13-3. Accordingly, a player who participates in a game play with each of the gaming terminals 4-3 can place a bet for a current roulette game. A display 8-3 is provided at each of the gaming terminals 4-3 for placing the bet on the current roulette game. A betting screen 61-3 (see FIG. 159) for betting on a roulette game is displayed on the display 8-3. Displayed contents on the betting screen 61-3 will be explained later in detail.

FIG. 158 is a plan view of the roulette unit provided in the roulette game machine shown in FIG. 157. As shown in FIG. 158, the roulette unit 2-3 includes a frame 21-3 and a roulette wheel 22-3 which is accommodated and supported rotatably inside the frame 21-3. Plural number pockets 23-3 (thirty-eight in total in the present embodiment) are formed on an upper surface of the roulette wheel 22-3. In addition, number plates 25-3 are provided on an upper surface of the roulette wheel 22-3 outside the number pockets 23-3 for displaying numbers “0”, “00” and “1” to “36” in correspondence to the respective number pockets 23-3.

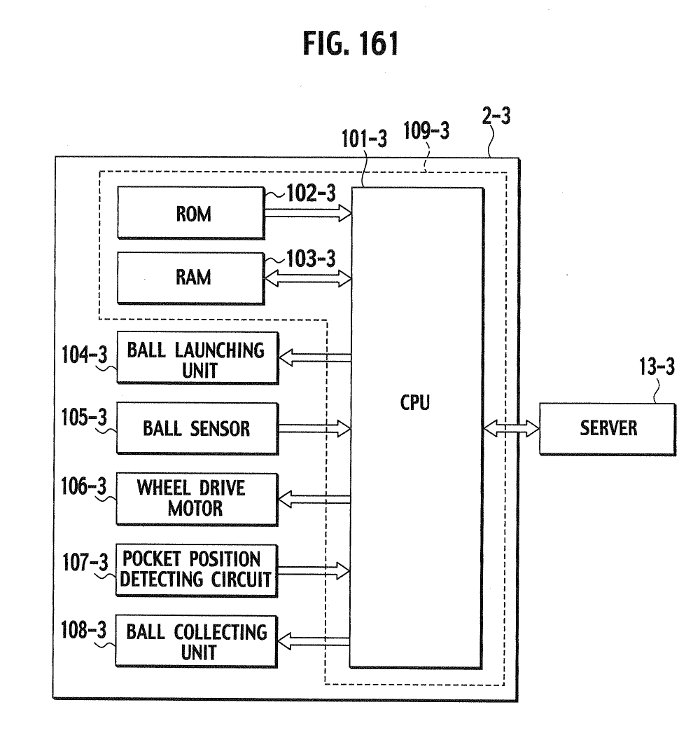

A ball launching port 36-3 is provided inside the frame 21-3. A ball launching unit 104-3 (see FIG. 161) is coupled with the ball launching port 36-3. With driving the ball launching unit 104-3, a ball 27-3 is launched from the ball launching port 36-3 onto the roulette wheel 22-3. In addition, the entire roulette unit 2-3 is covered by a hemispherical transparent acrylic cover 28-3 (see FIG. 157) covers over.

A wheel drive motor 106-3 (see FIG. 161) is provided beneath the roulette wheel 22-3. As the wheel drive motor 106-3 is driven, the roulette wheel 22-3 spins. Metal plates (not shown) are attached on a back surface of the roulette wheel 22-3 with space apart each other at prescribed intervals. A proximity sensor of a pocket position detecting circuit 107-3 (see FIG. 161) detects these metal plates to detect the positions of the number pockets 23-3.

The frame 21-3 is moderately inclined toward its inner side and the guide wall 29-3 is formed around an intermediate circumference of the frame 21-3. The guide wall 29-3 guides the launched ball 27-3 to spin with counterworking a centrifugal force of the ball 27-3. The ball 27-3, as its velocity slows down, loses its centrifugal force and rolls down on the inclined surface of the frame 21-3. And then, the ball 27-3 reaches the spinning roulette wheel 22-3 and gets across the number plates 25-3. The ball 27-3 falls into one of the number pockets 23-3. As a result, the number of the number plate 25-3 corresponding to the number pocket 23-3 into which the ball 27-3 has fallen, is detected by a ball sensor 105-3 and determined as a winning number.

Next, the configuration of the gaming terminal 4-3 will be explained.

As shown in FIG. 156, the gaming terminal 4-3 includes at least a medal insertion slot 7-3 for inserting game media having currency values such as cash, chips, medals and so on, and the above-mentioned display 8-3 for displaying images related to the game on its upper surface. The gaming terminal 4-3 accepts a player's betting operation via the medal insertion slot 7-3 and the display 8-3. A player can advance a displayed game by operating a touchscreen 50-3 (see FIG. 162) provided on an upper surface of the display 8-3 and so on while watching the images displayed on the display 8-3. Note that, in the following explanation, the game media may be referred as their representative “medals”.

In addition to the medal insertion slot 7-3 and the display 8-3 described above, a payout button 5-3, a ticket printer 6-3, a bill insertion slot 9-3, a speaker 10-3, a microphone 15-3 and a card reader 16-3 are provided on the upper surface of the gaming terminal 4-3. A medal payout chute 12-3 and a medal tray 14-3 are provided on a front face of the gaming terminal 4-3.

The payout button 5-3 is a button for inputting a command for paying out credited medals from the medal payout chute 12-3 onto the medal tray 14-3. The ticket printer 6-3 prints out a bar code ticket including the data such as the credits, the date, and the identification number of the gaming terminal 4-3. A player can use the bar code ticket at another gaming terminal 4-3 to place a bet on a game at that gaming terminal 4-3 or can exchange the bar code ticket to bills and so on at a prescribed location in a gaming facility (for example, a cashier in a casino).

The bill insertion slot 9-3 judges the legitimacy of bills and accepts legitimate bills. The speaker 10-3 outputs music, effect sounds, sound messages for a player and so on. The microphone 15-3 collects sound messages uttered by a player.

A smart card can be inserted into the card reader 16-3. The card reader 16-3 reads data from the inserted smart card and writes data into the inserted card. The smart card is carried by a player and corresponds to the player's member's card, credit card or the like.

A smart card stores data about playing history played by a player (playing history data) together with data for identifying the player. Information on game kinds played, points provided in played games, language kind used by the player in game plays and so on are included in the playing history data. Data equivalent to coins, bills or credits may be stored in a smart card. Read-from/write-into method with a smart card may employ contact type or non-contact type (RFID type). Alternatively, a magnetic stripe card may be employed.

A WIN lamp 11-3 is provided on an upper portion of the display 8-3 of each gaming terminal 4-3. In the case where the number (“0”, “00” and “1” to “36” in the present embodiment) on which a bet has been placed at the gaming terminal 4-3 in a game comes to a winning number, the WIN lamp 11-3 of the winning gaming terminal 4-3 will be turned on. In addition, in the jackpot (referred hereafter also as JP) bonus game for awarding JP, the WIN lamp 11-3 of the JP winning gaming terminal 4-3 will be turned on similarly. Note that the WIN lamp 11-3 is provided at a position that is visible from all of the arranged gaming terminals 4-3 (nine in the present embodiment) so that other players playing at the same roulette game machine 1-3 can always check turning-on of the WIN lamp 11-3.

A medal sensor 97-3 (see FIG. 162) is provided inside the medal insertion slot 7-3. The medal sensor 97-3 identifies medals inserted into the medal insertion slot 7-3 and counts the inserted medals. In addition, a hopper 94-3 (see FIG. 162) is provided inside the medal payout chute 12-3. The hopper 94-3 payouts a prescribed number of medals from the medal payout chute 12-3.

FIG. 159 is a diagram showing a screen image example displayed on the display 8-3. A betting screen 61-3 shown in FIG. 159 is displayed on the display 8-3 on each of the gaming terminals 4-3. The betting screen 61-3 includes a table-type betting board 60-3. A player can place a bet by operating a touchscreen 50-3 (see FIG. 162) provided on a front surface of the display 8-3, by using own chips, which are credited as an electronic data in the gaming terminal 4-3.

Specifically, a player pointed out a bet area 72-3 (in a section of a number or a section of a number's mark, or on a grid line(s)) to place a chip for betting by a cursor 70-3. Then, a bet chip amount is set by bet buttons 66-3 and the bet chip amount is fixed by a bet fixing button 65-3. These setting and fixing are executed by player's fingers directly touching on the bet areas 72-3, the bet buttons 66-3 and bet fixing button 65-3 displayed on the display 8-3.

Note that the bet buttons 66-3 are provided with four kinds of buttons, a one-bet button 66A-3, a five-bet button 66B-3, a ten-bet button 66C-3 and a one-hundred-bet button 66D-3 for a bet chip amount capable of being placed by one operation.

A payout counter 67-3 displays a player's bet chip amount and a payout credits amount for a payout in the last game. In addition, a credit counter 68-3 displays the current credits owned by a player. Furthermore, a bet time counter 69-3 displays remaining time in which a player can place a bet.

Note that the next game starts at the time when the ball 27-3 launched onto the roulette wheel 27-3 fell into any one of the number pockets 23-3 and the current game has ended.

A MEGA counter 73-3 displaying a credit amount accumulated for a “MEGA” JP, a MAJOR counter 74-3 displaying a credit amount accumulated for a “MAJOR” JP and a MINI counter 75-3 displaying the number of credits accumulated for a “MINI” JP are provided at the right side of the bet time counter 69-3. If any one of the JP's is won in a JP bonus game, a credit amount is awarded according to the winning JP among the JP's displayed on the counters 73-3 to 75-3 and then an initial value (200 credits for “MINI”, 5000 credits for “MAJOR” and 50000 credits for “MEGA”) is displayed the corresponding counter.

FIG. 160 is a block diagram showing an internal configuration of the roulette game machine 1-3 according to the present embodiment. As shown in FIG. 160, the roulette game machine 1-3 is configured with the server 13-3, the roulette unit 2-3 connected to the server 13-3 via the local network and the plural gaming terminals 4-3 (nine in the present embodiment). Note that an internal configuration of the roulette unit 2-3 and an internal configuration of the gaming terminals 4-3 will be described later in detail.

The server 13-3 shown in FIG. 160 includes a server CPU 81-3 for executing the overall control of the server 13-3, a ROM 82-3, a RAM 83-3, a timer 84-3, an LCD (liquid crystal display) 32-3 connected via an LCD driving circuit 85-3, a keyboard 33-3, the HDD 34-3 and a playing history storing unit (storing unit) 35-3.

The server CPU 81-3 executes various processings according to input signals supplied from the gaming terminals 4-3 and data and programs stored in the ROM 82-3 and the RAM 83-3. In addition, the server CPU 81-3 sends command signals to the gaming terminals 4-3 according to the processing results to control the gaming terminals 4-3 under its initiative. Specifically, the server CPU 81-3 transmits control signals to the roulette device 2-3 to control launching of the ball 27-3 and spinning of the roulette wheel 22-3.

The ROM 82-3 is configured by a semiconductor memory or the like and stores programs which implement basic functions of the roulette game machine 1-3, programs which execute notification of maintenance time and setting/management of notification condition, odds data of a roulette game (payout credits per one chip at winning), programs for controlling the gaming terminals 4-3 under their initiatives and so on.

In addition, the RAM 83-3 temporarily stores a chip-betting information supplied from each of the gaming terminals 4-3, a winning number of the roulette unit 2-3 detected by the sensor, an accumulated JP credits, data on results of processings executed by the server CPU 81-3 and so on.

Furthermore, the timer 84-3 for counting time is connected to the server CPU 81-3. Time information of the timer 84-3 is transmitted to the server CPU 81-3. The server CPU 81-3 executes controls of spinning the roulette wheel 22-3 and launching the ball 27-3 based on the time information of the timer 84-3.

The HDD 34-3 stores translating programs between English, which is set as a reference language, and various other languages. For example, plural translating programs are stored such as a “Japanese-English” translating program, a “Chinese-English” translating program or a “French-English” translating program. Note that, although an example case is explained in the present embodiment where “English” is represented as the reference language, the reference language is not limited to English but may be any other language.

Furthermore, the HDD 34-3 stores conversation data to be used in the conversation engine explained later. In other words, the HDD 34-3 includes a function as the conversation database 1500-3 shown in FIG. 163. The conversation database stores conversation data used at generating a reply to a player by the conversation engine and is provided for each of the plural languages. For example, a conversation database for English, a conversation database for Japanese, a conversation database for Chinese and so on are provided.

The playing history storing unit 35-3 stores playing results of roulette games played at each of the gaming terminals 4-3. Specifically, the server 13-3 accesses the gaming terminals via the network at predetermined time intervals (for example, ten minutes) to acquire and store the playing results such as a winning percentage, a profit amount and a loss amount. The playing history storing unit 35-3 is linked to the above-mentioned conversation database 1500-3 and used when a conversation is conducted with the player using the conversation engine. Therefore, the player obtains information on the playing history of the gaming terminal 4-3 by conducting a conversation using the conversation engine.

FIG. 161 is a block diagram showing an internal configuration of the roulette unit 2-3 according to the present embodiment. As shown in FIG. 161, the roulette unit 2-3 includes a controller 109-3, the pocket position detecting circuit 107-3, the ball launching unit 104-3, the ball sensor 105-3, the wheel drive motor 106-3 and a ball collecting device 108-3.

The controller 109-3 includes a CPU 101-3, a ROM 102-3 and a RAM 103-3. The CPU 101-3 controls launching the ball 27-3 and spinning the roulette wheel 22-3 based on control commands supplied from the server 13-3 and data and programs stored in the ROM 102-3 and the RAM 103-3.

The pocket position detecting circuit 107-3 includes the proximity sensor to detect spinning position of the roulette wheel 22-3 by detecting the metal plates attached onto the roulette wheel 22-3.

The ball launching unit 104-3 is a unit for launching the ball 27-3 onto the roulette wheel 22-3 from the ball launching port 36-3 (see FIG. 158). The ball launching unit 104-3 launches the ball 27-3 at the initial speed and the timing set in a control data.

The ball sensor 105-3 is a unit for detecting the number pocket 23-3 into which the ball 27-3 has fallen. The wheel drive motor 106-3 is a unit for spinning the roulette wheel 22-3 and it stops its spinning when a motor driving time set in the control data has elapsed since a start of the driving.

FIG. 162 is a block diagram showing an internal configuration of the gaming terminal according to the present embodiment. Note that each of the nine gaming terminals 4-3 has an identical configuration basically and one of the gaming terminals 4-3 will be explained as the representative hereinafter.

As shown in FIG. 162, the gaming terminal 4-3 includes a terminal controller 90-3 configured by a terminal CPU 91-3, a ROM 92-3 and a RAM 93-3. The ROM 92-3 is configured by a semiconductor memory or the like. The ROM 92-3 stores programs which implement basic functions of the gaming terminal 4-3, various programs which are necessary for controlling the gaming terminal 4-3, data tables and so on. In addition, the RAM 93-3 is a memory for temporarily storing various data calculated by the terminal CPU 91-3, a credit amount currently owned by the player (deposited at the gaming terminal 4-3), a player's betting status, a flag F for indicating whether or not during the betting period and so on.

A payout button 5-3 (see FIG. 156) is connected to the terminal CPU 91-3. The payout button 5-3 is a button to be pressed by a player usually when the game is over. Medals will be paid out from the medal payout chute 12-3 according to credits which have been provided in games and currently owned by the player (usually one medal for one credit) when the payout button 5-3 is pressed by the player.

In addition, the terminal CPU 91-3 receives command signals from the sever CPU 81-3 and controls peripheral devices constituting the gaming terminal 4-3, so as to proceed with the game at the gaming terminal 4-3. Furthermore, the terminal CPU 91-3 executes various processings according to the above-mentioned input signals and data and programs stored in the ROM 92-3 and the RAM 93-3 depending on the processing contents. The terminal CPU 91-3 controls the peripheral devices constituting the gaming terminal 4-3 according to the processing results, so as to proceed with the game.

In addition, the hopper 94-3 is connected to the terminal CPU 91-3. The hopper 94-3 payouts a prescribed number of medals from the medal payout chute 12-3 (see FIG. 157) according to a command signal from the terminal CPU 91-3.

Furthermore, the display 8-3 is connected to the terminal CPU 91-3 via an LCD drive circuit 95-3. The LCD drive circuit 95-3 includes a program ROM, an image ROM, an image control CPU, a work RAM, a VDP (Video Display Processor) and a video RAM. The program ROM stores image control programs and various selection tables for displaying on the display 8-3. The image ROM stores dot data for forming images to be displayed on the display 8-3, for example. The image control CPU determines images to be displayed on the display 8-3 among the dot data in the image ROM according to the image control programs stored in the program ROM based on parameters set up in the terminal CPU 91-3. The work RAM is provided as a temporary memory unit during an execution of the image control programs by the image control CPU. The VDP forms screen images according to the display contents determined by the image control CPU and outputs them to the display 8-3. Note that the video RAM is provided as a temporary memory unit during the VDP forming screen images.

In addition, the touchscreen 50-3 is attached on the front surface of the display 8-3. Information of a player's operation onto the touchscreen 50-3 is sent to the terminal CPU 91-3. A player's chip-betting operation is done via the bet screen 61-3 (see FIG. 159) on the touchscreen 50-3. Specifically, the player's operation onto the touchscreen 50-3 is done for the selection of the bet area 72-3, the input via the bet buttons 66-3 and the bet fixing button 65-3 and so on. The information of a player's operation is sent to the terminal CPU 91-3 when the touchscreen 50-3 has been operated. Then, the player's current betting information (the bet area and the bet amount placed via the bet screen 61-3) is stored into the RAM 93-3 sequentially according to that information. Furthermore, this betting information is sent to the server CPU 81-3 and stored in a betting information storing area in the RAM 83-3.

In addition, a sound output circuit 96-3 and the speaker 10-3 are connected to the terminal CPU 91-3. The speaker 10-3 outputs various effect sounds when various effects are generated and interactive conversation messages to a player for proceeding a game interactively based on output signals from the sound output circuit 96-3.

In addition, a sound input circuit 98-3 and the microphone 15-3 are connected to the terminal CPU 91-3. The microphone 15-3 transmits player's reply message sound in response to interactive message sound output from the speaker 10-3 to the terminal CPU 91-3 via the sound input circuit 98-3.

Furthermore, a second external storage unit 76-3 is connected to the terminal CPU 91-3. A conversation database of a language (Japanese, for example) of a player who is playing at the gaming terminal 4-3 is downloaded to the second external storage unit 76-3. Additionally, a translating program between the player's language and the reference language, i.e. English, is downloaded. The second external storage unit 76-3 is configured by an HDD unit. Its details will be described later.

In addition, the image memory 77-3 is connected to the terminal CPU 91-3. Character images corresponding to various languages are stored in the image memory 77-3. For example, a character image which looks like a Japanese is stored with being associated with Japanese. A character image which looks like a Chinese is stored with being associated with Chinese. A character image which looks like an Arabic is stored with being associated with Arabic.

In addition, the medal sensor 97-3 is connected to the terminal CPU 91-3. The medal sensor 97-3 detects medals inserted from the medal insertion slot 7-3 (see FIG. 157) and counts the inserted medals to send the counting result data to the terminal CPU 91-3. The terminal CPU 91-3 increases the player's credit amount stored in the RAM 93-3 according to the data.

Furthermore, the WIN lamp 11-3 is connected to the terminal CPU 91-3. The terminal CPU 91-3 lights up the WIN lamp 11-3 in a prescribed color when credits bet via the bet screen 61-3 has won or when a JP winning has been awarded.

In addition, a first external storage unit 99-3 is connected to the terminal CPU 91-3. The first external storage unit 99-3 is configured by an HDD unit. The terminal CPU 91-3 reads/writes data from/to the first external storage unit 99-3 if needed.

The gaming terminal 4-3 having the terminal control unit 90-3 includes the conversation engine. At least some of the roulette game procedures on the gaming terminal 4-3 are executed by the conversation engine interactively with the player by using the display 8-3, the speaker 10-3 and the microphone 15-3 as interfaces. Therefore, message sound for the player is output from the speaker 10-3 via the sound output circuit 96-3 in certain situations according to the roulette game procedures. In addition, contents of player's message sound input via the microphone 15-3 and the sound input circuit 98-3 are construed.

Such a conversation engine can be realized using a conversation controller described in, for example, United States patent application publication 2007/0094007, United States patent application publication 2007/0094008, United States patent application publication 2007/0094005 or United States patent application publication 2005/0094004. As will be explained hereinafter, such a conversation controller can be realized using the display 8-3, the speaker 10-3, the microphone 15-3, the terminal controller 90-3 and the first external storage unit 99-3 of the gaming terminal 4-3.

Here, a configuration of the conversation controller described in United States patent application publication 2007/0094007, which can be applied as the conversation engine installed in the gaming terminal 4-3 of the present embodiment, will be explained with reference to FIGS. 163 to 184. FIG. 163 is a functional block diagram showing a configuration example of the conversation controller.

As shown in FIG. 163, the conversation controller 1000-3 comprises an input unit 1100-3, a speech recognition unit 1200-3, a conversation control unit 1300-3, a sentence analyzing unit 1400-3, a conversation database 1500-3, an output unit 1600-3 and a speech recognition dictionary memory 1700-3.

### [Input Unit]

The input unit 1100-3 receives input information (user's utterance) input by a user. The input unit 1100-3 outputs a speech corresponding to contents of the received utterance as a voice signal to the speech recognition unit 1200-3. Note that the input unit 1100-3 may be a character input unit such as a keyboard and a touchscreen. In this case, the after-mentioned speech recognition unit 1200-3 doesn't need to be provided.

### [Speech Recognition Unit]

The speech recognition unit 1200-3 specifies a character string corresponding to the uttered contents based on the uttered contents obtained via the input unit 1100-3. Specifically, the speech recognition unit 1200-3 that has received the voice signal from the input unit 1100-3 compares the received voice signal with the conversation database 1500-3 and dictionaries stored in the speech recognition dictionary memory 1700-3 based on the voice signal to output a speech recognition result estimated based on the voice signal to the conversation control unit 1300-3. In a configuration example shown in FIG. 163, the speech recognition unit 1200-3 requests acquisition of memory contents of the conversation database 1500-3 to the conversation control unit 1300-3 and then receives the memory contents of the conversation database 1500-3 which the conversation control unit 1300-3 retrieves according to the request from the speech recognition unit 1200-3. However the speech recognition unit 1200-3 may directly retrieves the memory contents of the conversation database 1500-3 for comparing with the voice signal.

### Configuration Example of Speech Recognition Unit

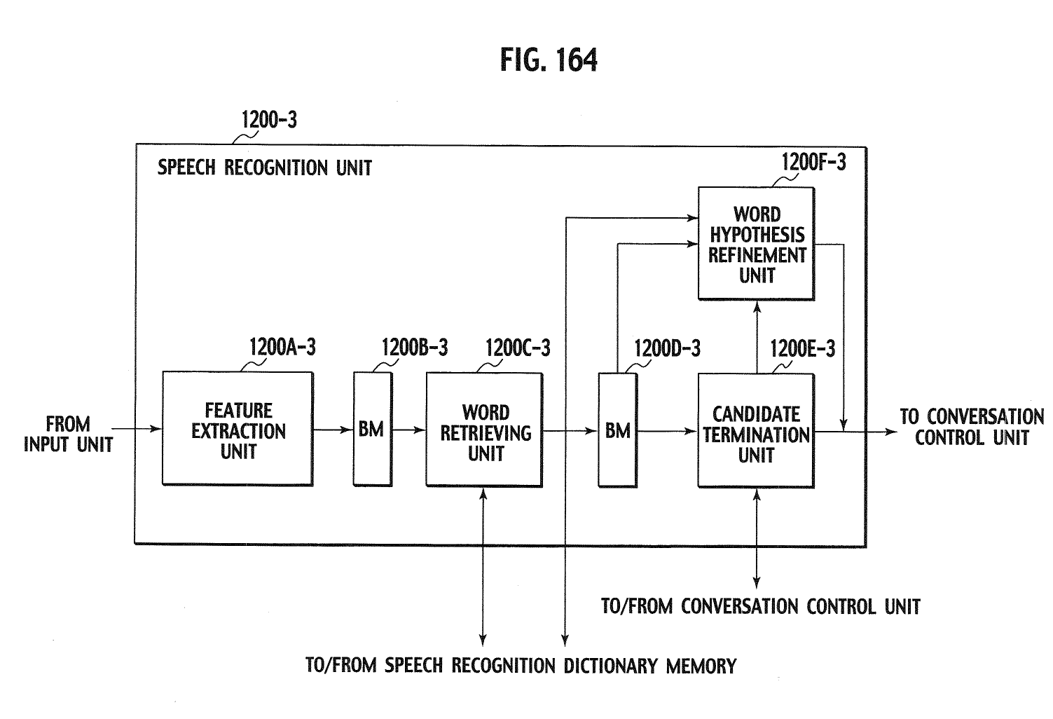

FIG. 164 is a functional block diagram showing a configuration example of the speech recognition unit 1200-3. The speech recognition unit 1200-3 includes a feature extraction unit 1200A-3, a buffer memory (BM) 1200B-3, a word retrieving unit 1200C-3, a buffer memory (BM) 1200D-3, a candidate determination unit 1200E-3 and a word hypothesis refinement unit 1200F-3. The word retrieving unit 1200C-3 and the word hypothesis refinement unit 1200F-3 are connected to the speech recognition dictionary memory 1700-3. In addition, the candidate determination unit 1200E-3 is connected to the conversation database 1500-3 via the conversation control unit 1300-3.

The speech recognition dictionary memory 1700-3 connected to the word retrieving unit 1200C-3 stores a phoneme hidden Markov model (hereinafter, the hidden Markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700-3 connected to the word retrieving unit 1200C-3 further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A-3. The feature extraction unit 1200A-3 converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C-3 via the buffer memory (BM) 1200B-3.

The word retrieving unit 1200C-3 retrieves word hypotheses with a one-pass Viterbi decoding method based on the feature parameters input from the feature extraction unit 1200A-3 via the buffer memory (BM) 1200B-3 by using the phoneme HMM and the word dictionary stored in the speech recognition dictionary memory 1700-3, and then calculates likelihoods. Here, the word retrieving unit 1200C-3 calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C-3 may reduce grid hypotheses of the lower likelihoods among all of the calculated likelihoods based on the phoneme HMM and the word dictionary in order to reduce a computing throughput. The word retrieving unit 1200C-3 outputs information on the retrieved word hypotheses and the likelihoods of the retrieved word hypotheses together with time information regarding an elapsed time from the speech start time (e.g. frame number) to the candidate determination unit 1200E-3 and the word hypothesis refinement unit 1200F-3 via the buffer memory (BM) 1200D-3.

The candidate determination unit 1200E-3 compares the retrieved word hypotheses with topic specification information in a prescribed discourse space with reference to the conversation control unit 1300-3, and then determines whether or not exists a coincident word hypothesis with the topic specification information in the prescribed discourse space among the retrieved word hypotheses. If the coincident word hypothesis exists, the candidate determination unit 1200E-3 outputs the coincident word hypothesis as a recognition result. On the other hand, if no coincident word hypothesis exists, the candidate determination unit 1200E-3 requires the word hypothesis refinement unit 1200F-3 to refine the retrieved word hypotheses.

An operation of the candidate determination unit 1200E-3 will be described. Here, it is assumed that the word retrieving unit 1200C-3 outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

In the above situation, the candidate determination unit 1200E-3 compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300-3 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F-3 operates to output the recognition result in response to the request from the candidate determination unit 1200E-3 to refine the retrieved word hypotheses. The word hypothesis refinement unit 1200F-3 refines the retrieved word hypotheses for the same words having the same speech termination time and different speech start time per each initial phonetic environment of the same words with reference to a statistical language model stored in the speech recognition dictionary memory 1700-3 based on the plural retrieved word hypotheses output from the word retrieving unit 1200C-3 via the buffer memory (BM) 1200D-3 so that one word hypothesis with the highest likelihood may be selected as a representative among all of the likelihoods calculated between the speech start and the utterance termination of the word. And then, the word hypothesis refinement unit 1200F-3 outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

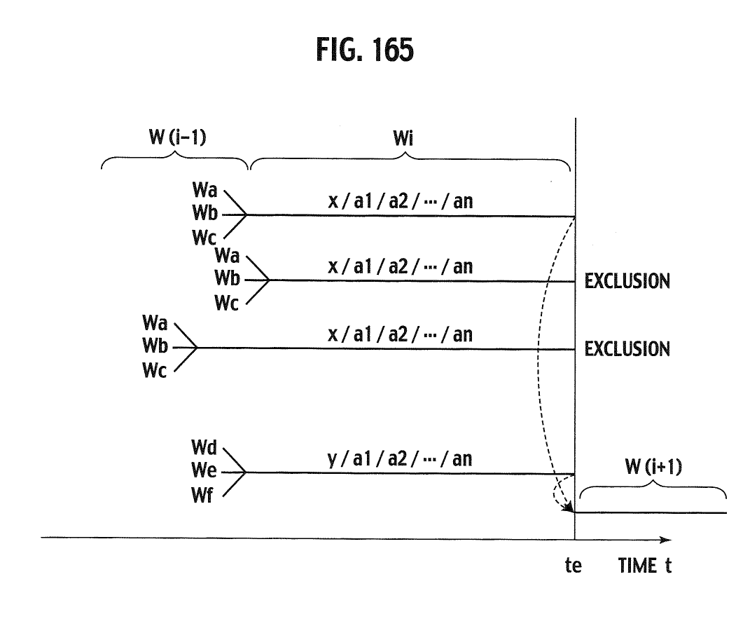

A word refinement process executed by the word hypothesis refinement unit 1200F-3 will be described with reference to FIG. 165.

For example, it is assumed that the (i)th word Wi, which consists of a phonemic string a1, a2, . . . and an, follows the (i−1)th word W(i−1) and six hypotheses Wa, Wb, Wc, Wd, We and Wf exist as a word hypothesis of the (i−1)th word W(i−1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F-3 is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A-3, the word retrieving unit 1200C-3, the candidate determination unit 1200E-3 and the word hypothesis refinement unit 1200F-3 are composed of a computer such as a microcomputer. The buffer memories (BMs) 200B-3 and 200D-3 and the speech recognition dictionary memory 1700-3 are composed of a memory unit such as hard disc storage.

In the above-mentioned embodiment, the speech recognition is executed by using the word retrieving unit 1200C-3 and the word hypothesis refinement unit 1200F-3. However, the present invention is not limited to this. The speech recognition unit 1200-3 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200-3 is explained as a part of the conversation controller 1000-3. However, an independent speech recognition apparatus configured by the speech recognition unit 1200-3, the conversation database 1500-3 and the speech recognition dictionary memory 1700-3 may be possibly employed.

### Operating Example of Speech Recognition Unit

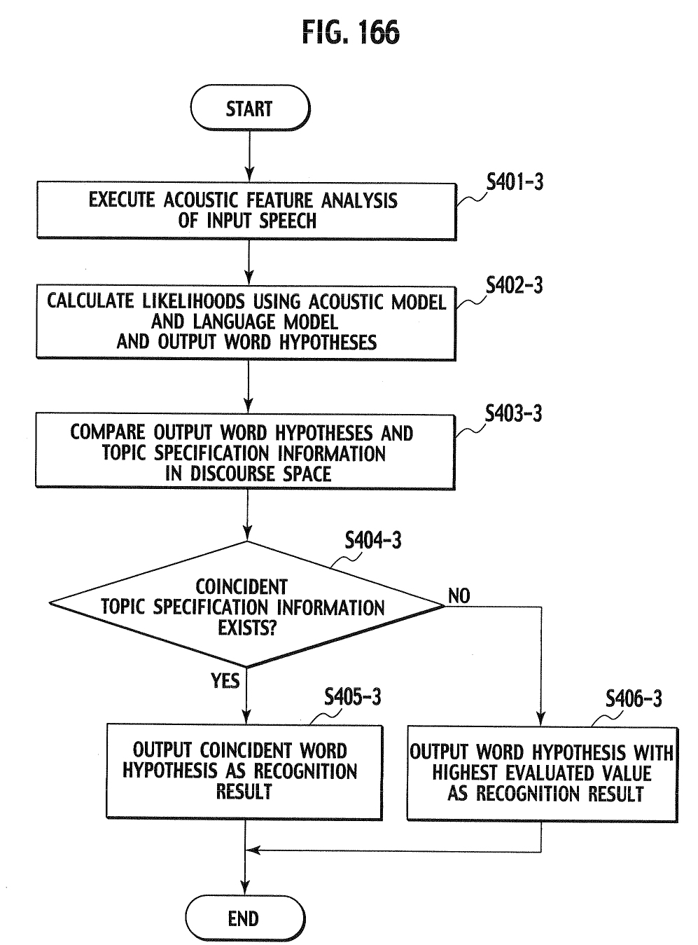

Next, operations of the speech recognition unit 1200-3 will be described with reference to FIG. 166. FIG. 166 is a flow chart showing process operations of the speech recognition unit 1200-3.

The speech recognition unit 1200-3 executes a feature analysis of the input speech to generate feature parameters on receiving the voice signal from the input unit 1100-3 (step S401-3). Next, the feature parameters is compared with the phoneme HMM and the language model stored in the speech recognition dictionary memory 1700-3, and then a certain number of word hypotheses and the likelihoods of the word hypotheses are obtained (step S402-3). Next, the speech recognition unit 1200-3 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403-3 and S404-3). If the coincident word hypothesis exists, the speech recognition unit 1200-3 outputs the coincident word hypothesis as the recognition result (step S405-3). On the other hand, if no coincident word hypothesis exists, the speech recognition unit 1200-3 outputs the word hypothesis with the highest likelihood as the recognition result according to the obtained likelihoods of the word hypotheses (step S406-3).

### [Speech Recognition Dictionary Memory]

The configuration example of the conversation controller 1000-3 is further described with referring back to FIG. 163 again.

The speech recognition dictionary memory 1700-3 stores character strings corresponding to standard voice signals. The speech recognition unit 1200-3, which has executed the comparison, specifies a word hypothesis for a character string corresponding to the received voice signal, and then outputs the specified word hypothesis as a character string signal to the conversation control unit 1300-3.

### [Sentence Analyzing Unit]

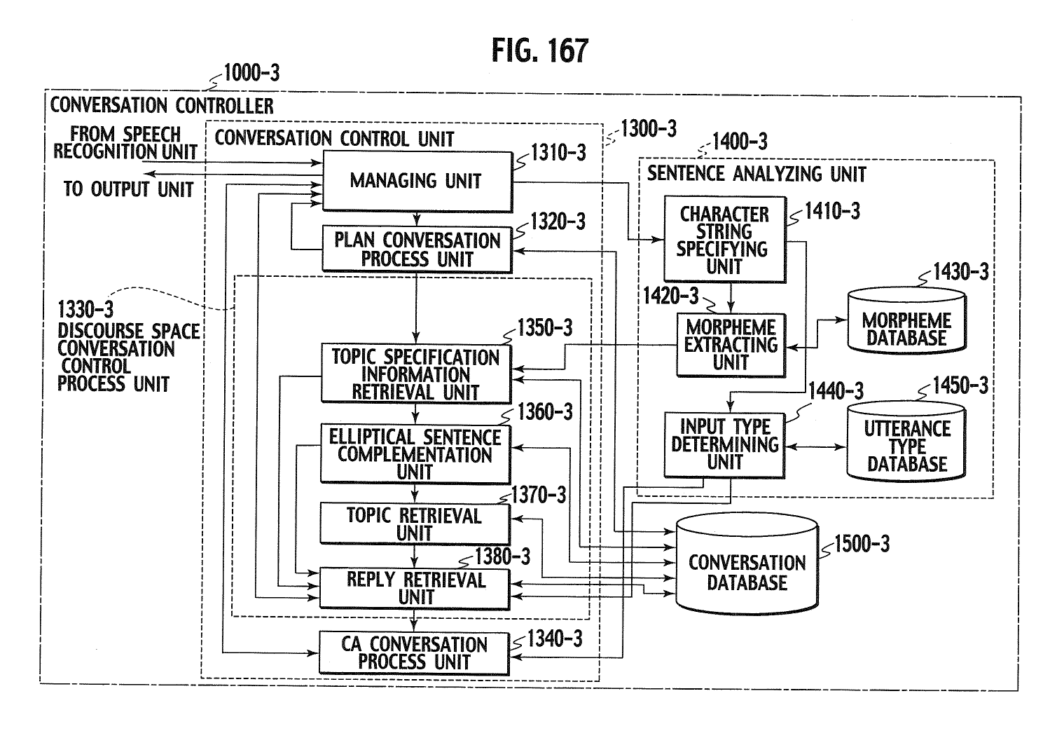

Next, a configuration example of the sentence analyzing unit 1400-3 will be described with reference to FIG. 167. FIG. 167 is a partly enlarged block diagram of the conversation controller 1000-3 and also a block diagram showing a concrete configuration example of the conversation control unit 1300-3 and the sentence analyzing unit 1400-3. Note that only the conversation control unit 1300-3, the sentence analyzing unit 1400-3 and the conversation database 1500-3 are shown in FIG. 167 and the other components are omitted to be shown.

The sentence analyzing unit 1400-3 analyses a character string specified at the input unit 1100-3 or the speech recognition unit 1200-3. In the present embodiment as shown in FIG. 167, the sentence analyzing unit 1400-3 includes a character string specifying unit 1410-3, a morpheme extracting unit 1420-3, a morpheme database 1430-3, an input type determining unit 1440-3 and an utterance type database 1450-3. The character string specifying unit 1410-3 segments a series of character strings specified by the input unit 1100-3 or the speech recognition unit 1200-3 into segments. Each segment is a minimum segmented sentence which is segmented in the extent to keep a grammatical meaning. Specifically, if the series of the character strings have a time interval more than a certain interval, the character string specifying unit 1410-3 segments the character strings there. The character string specifying unit 1410-3 outputs the segmented character strings to the morpheme extracting unit 1420-3 and the input type determining unit 1440-3. Note that a “character string” to be described below means one segmented character string.

### [Morpheme Extracting Unit]

The morpheme extracting unit 1420-3 extracts morphemes constituting minimum units of the character string as first morpheme information from each of the segmented character strings based on each of the segmented character strings segmented by the character string specifying unit 1410-3. In the present embodiment, a morpheme means a minimum unit of a word structure shown in a character string. For example, each minimum unit of a word structure may be a word class such as a noun, an adjective and a verb.

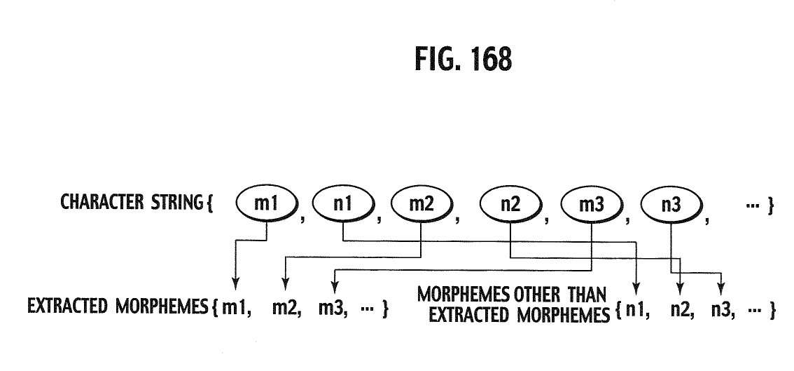

In the present embodiment as shown in FIG. 168, the morphemes are indicated as m1, m2, m3, . . . . FIG. 168 is a diagram showing a relation between a character string and morphemes extracted from the character string. The morpheme extracting unit 1420-3, which has received the character strings from the character string specifying unit 1410-3, compares the received character strings and morpheme groups previously stored in the morpheme database 1430-3 (each of the morpheme group is prepared as a morpheme dictionary in which a direction word, a reading, a word class and infected forms are described for each morpheme belonging to each word-class classification) as shown in FIG. 168. The morpheme extracting unit 1420-3, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420-3 outputs the extracted morphemes to a topic specification information retrieval unit 1350-3 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

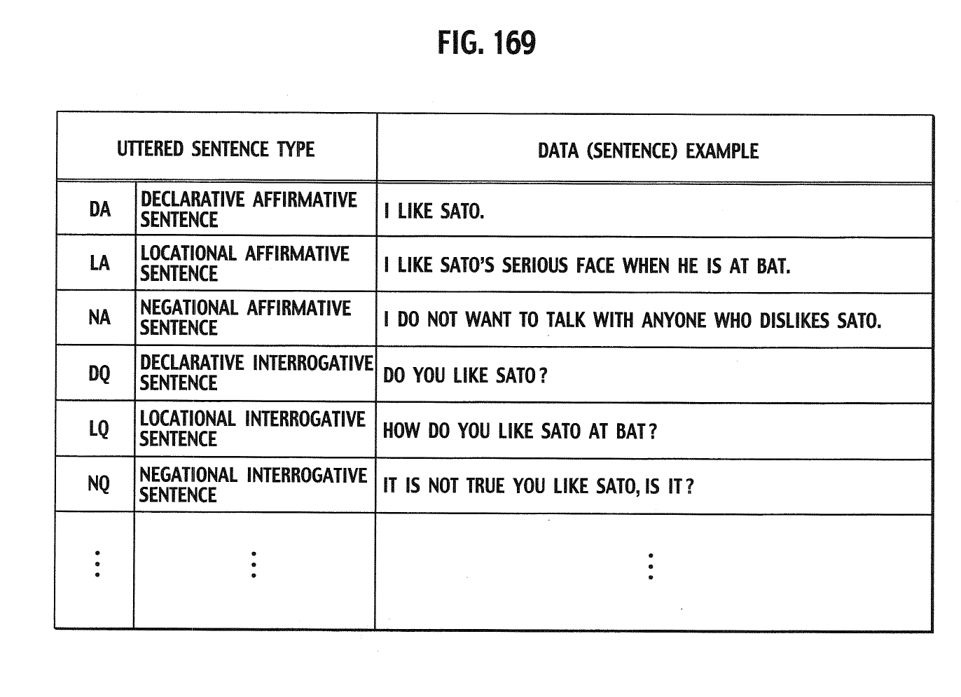

The input type determining unit 1440-3 determines an uttered contents type (utterance type) based on the character strings specified by the character string specifying unit 1410-3. In the present embodiment, the utterance type is information for specifying the uttered contents type and, for example, corresponds to “uttered sentence type” shown in FIG. 169. FIG. 169 is a table showing the “uttered sentence types”, two-alphabet codes representing the uttered sentence types, and uttered sentence examples corresponding to the uttered sentence types.

Here in the present embodiment as shown in FIG. 169, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 169. A “locational sentence” means a sentence involving a locational notion. A “time sentence” means a sentence involving a timelike notion. A “negational sentence” means a sentence to deny a declarative sentence. Sentence examples of the “uttered sentence types” are shown in FIG. 169.

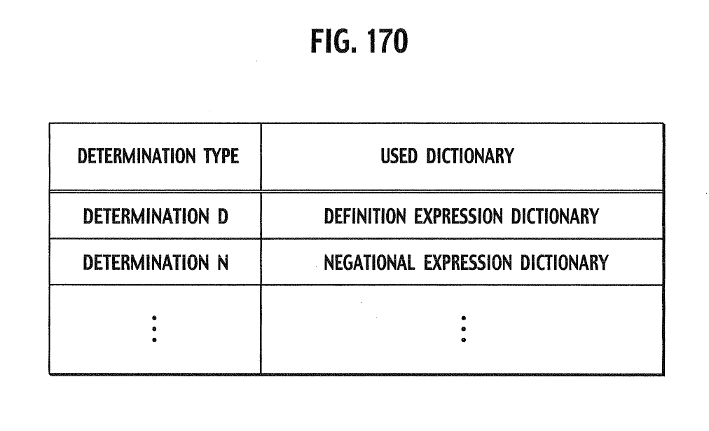

In the present embodiment as shown in FIG. 170, the input type determining unit 1440-3 uses a declarative expression dictionary for determination of a declarative sentence, a negational expression dictionary for determination of a negational sentence and so on in order to determine the “uttered sentence type”. Specifically, the input type determining unit 1440-3, which has received the character strings from the character string specifying unit 1410-3, compares the received character strings and the dictionaries stored in the utterance type database 1450-3 based on the received character string. The input type determining unit 1440-3, which has executed the comparison, extracts elements relevant to the dictionaries among the character strings.

The input type determining unit 1440-3 determines the “uttered sentence type” based on the extracted elements. For example, if the character string includes elements declaring an event, the input type determining unit 1440-3 determines that the character string including the elements is a declarative sentence. The input type determining unit 1440-3 outputs the determined “uttered sentence type” to a reply retrieval unit 1380-3.

### [Conversation Database]

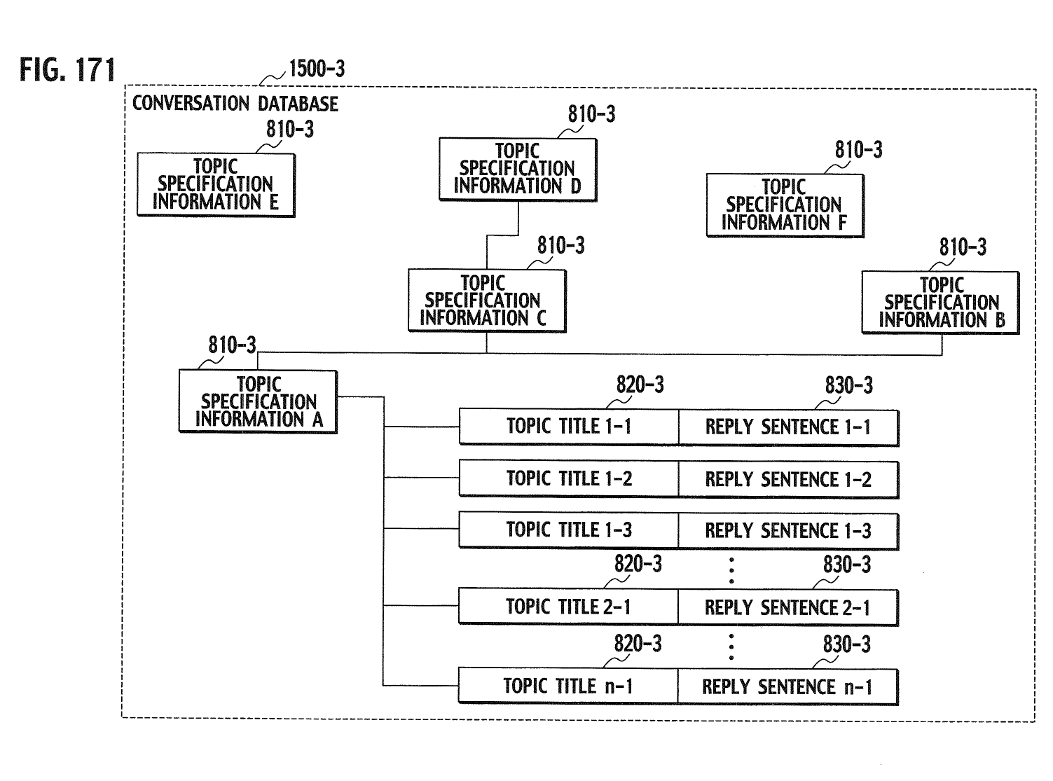

A configuration example of data structure stored in the conversation database 1500-3 will be described with reference to FIG. 171. FIG. 171 is a conceptual diagram showing the configuration example of data stored in the conversation database 1500-3.

As shown in FIG. 171, the conversation database 1500-3 stores a plurality of topic specification information 810-3 for specifying a conversation topic. In addition, topic specification information 810-3 can be associated with other topic specification information 810-3. For example, if topic specification information C (810-3) is specified, three of topic specification information A (810-3), B (810-3) and D (810-3) associated with the topic specification information C (810-3) are also specified.

Specifically in the present embodiment, topic specification information 810-3 means “keywords” which are relevant to input contents expected to be input from users or relevant to reply sentences to users.

The topic specification information 810-3 is associated with one or more topic titles 820-3. Each of the topic titles 820-3 is configured with a morpheme composed of one character, plural character strings or a combination thereof. A reply sentence 830-3 to be output to users is stored in association with each of the topic titles 820-3. Response types for indicating types of the reply sentences 830-3 are associated with the reply sentences 830-3, respectively.

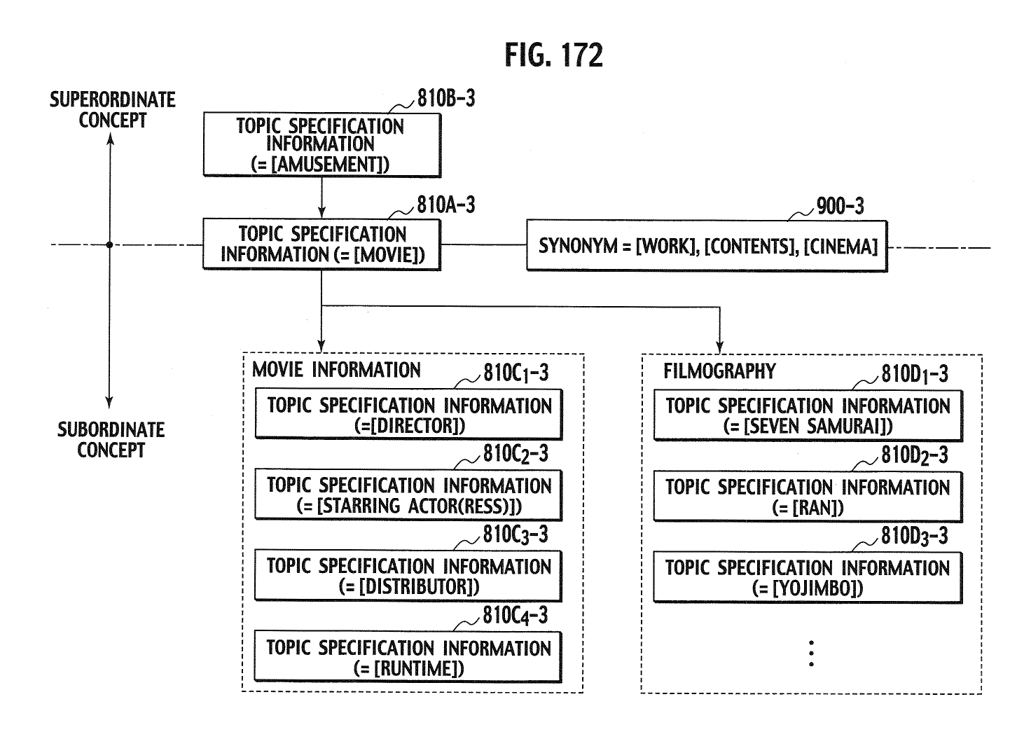

Next, an association between the topic specification information 810-3 and the other topic specification information 810-3 will be described. FIG. 172 is a diagram showing the association between certain topic specification information 810A-3 and the other topic specification information 810B-3, 810C₁-3-810C₄-3 and 810D₁-3-810D₃-3 . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 172, the topic specification information can be stored in association with the other topic specification information with respect to a superordinate concept, a subordinate concept, a synonym or an antonym (not shown in FIG. 172). For example as shown in FIG. 172, the topic specification information 810B-3 (amusement) is stored in association with the topic specification information 810A-3 (movie) as a superordinate concept and stored in a higher level than the topic specification information 810B-3 (amusement).

In addition, subordinate concepts of the topic specification information 810A-3 (movie), the topic specification information 810C₁-3 (director), 810C₂-3 (starring actor/actress), 810C₃-3 (distributor), 810C₄-3 (runtime), 810D₁-3 (“Seven Samurai”), 810D₂-3 (“Ran”), 810D₃-3 (“Yojimbo”), . . . , are stored in association with the topic specification information 810A-3.

In addition, synonyms 900-3 are associated with the topic specification information 810A-3. In this example, “work”, “contents” and “cinema” are stored as synonyms of “movie” which is a keyword of the topic specification information 810A-3. By defining these synonyms in this manner, the topic specification information 810A-3 can be treated as included in an uttered sentence even though the uttered sentence doesn't include the keyword “movie” but includes “work”, “contents” or “cinema”.

In the conversation controller 1000-3 according to the present embodiment, when certain topic specification information 810-3 has been specified with reference to contents stored in the conversation database 1500-3, other topic specification information 810-3 and the topic titles 820-3 or the reply sentences 830-3 of the other topic specification information 810-3, which are stored in association with the certain topic specification information 810-3, can be retrieved and extracted rapidly.

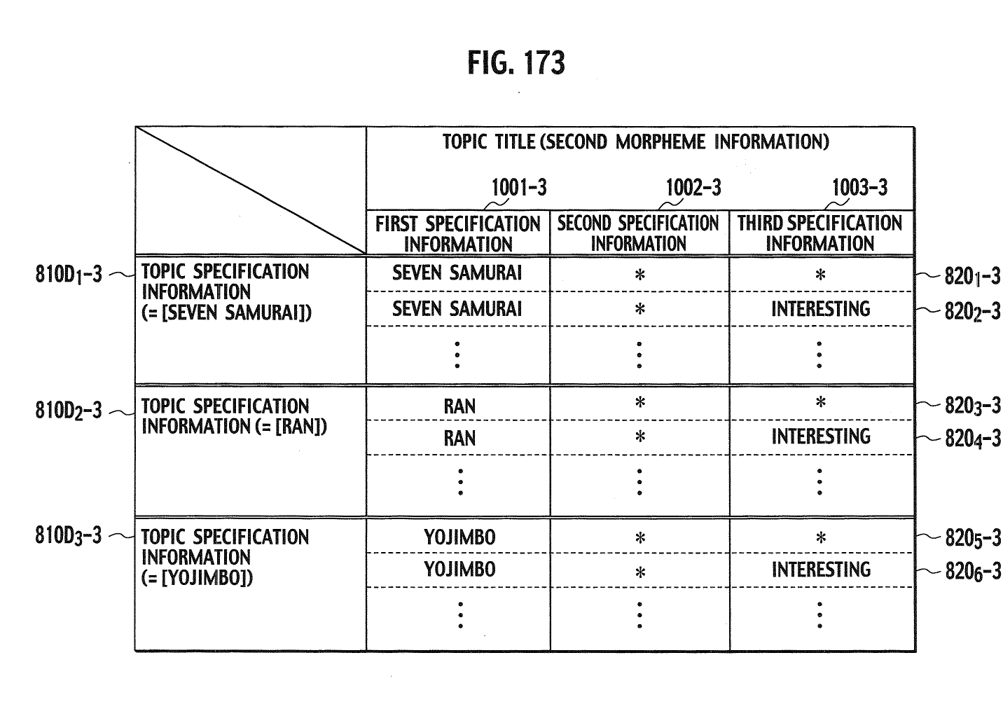

Next, data configuration examples of topic titles 820-3 (also referred as “second morpheme information”) will be described with reference to FIG. 173. FIG. 173 is a diagram showing the data configuration examples of the topic titles 820-3.

The topic specification information 810D₁-3, 810D₂-3, 810D₃-3, . . . , include the topic titles 820₁-3, 820₂-3, . . . , the topic titles 820₃-3, 820₄-3, . . . , the topic titles 820₅-3, 820₆-3, . . . , respectively. In the present embodiment as shown in FIG. 173, each of the topic titles 820-3 is information composed of first specification information 1001-3, second specification information 1002-3 and third specification information 1003-3. Here, the first specification information 1001-3 is a main morpheme constituting a topic. For example, the first specification information 1001-3 may be a Subject of a sentence. In addition, the second specification information 1002-3 is a morpheme closely relevant to the first specification information 1001-3. For example, the second specification information 1002-3 may be an Object. Furthermore, the third specification information 1003-3 in the present embodiment is a morpheme showing a movement of a certain subject, a morpheme of a noun modifier and so on. For example, the third specification information 1003-3 may be a verb, an adverb or an adjective. Note that the first specification information 1001-3, the second specification information 1002-3 and the third specification information 1003-3 are not limited to the above meanings. The present embodiment can be effected in case where contents of a sentence can be understood based on the first specification information 1001-3, the second specification information 1002-3 and the third specification information 1003-3 even though they are give other meanings (other ward classes).

For example as shown in FIG. 173, if the Subject is “Seven Samurai” and the adjective is “interesting”, the topic title 820₂-3 (second morpheme information) consists of the morpheme “Seven Samurai” included in the first specification information 1001-3 and the morpheme “interesting” included in the third specification information 1003-3. Note that the second specification information 1002-3 of this topic title 820₂-3 includes no morpheme and a symbol “*” is stored in the second specification information 1002-3 for indicating no morpheme included.

Note that this topic title 820₂-3 (Seven Samurai; *; interesting) has the meaning of “Seven Samurai is interesting.” Hereinafter, parenthetic contents for a topic title 820₂-3 indicate the specification information 1001-3, the second specification information 1002-3 and the third specification information 1003-3 from the left. In addition, when no morpheme is included in any of the first to third specification information, “*” is indicated therein.

Note that the specification information constituting the topic titles 820-3 is not limited to three and other specification information (fourth specification information and more) may be included.

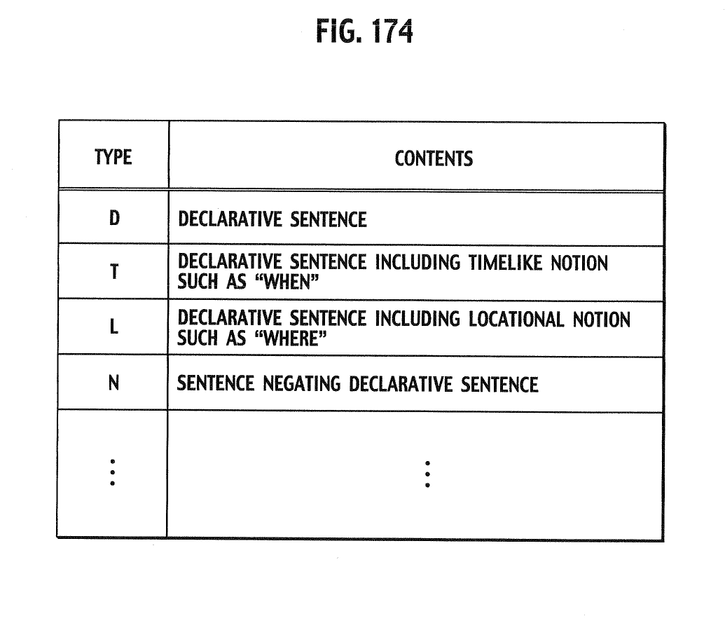

Next, the reply sentences 830-3 will be described with reference to FIG. 174. In the present embodiment as shown in FIG. 174, the reply sentences 830-3 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

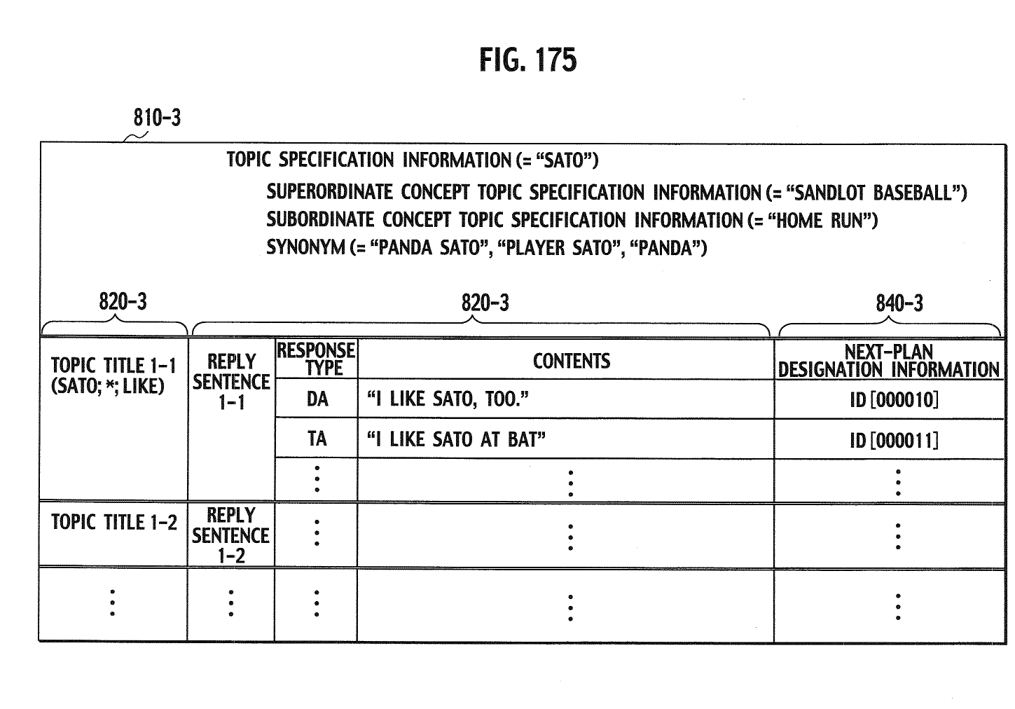

A configuration example of data structure of the topic specification information 810-3 will be described with reference to FIG. 175. FIG. 175 shows a concrete example of the topic titles 820-3 and the reply sentences 830-3 associated with the topic specification information 810-3 “Sato”.

The topic specification information 810-3 “Sato” is associated with plural topic titles (820-3) 1-1, 1-2, . . . . Each of the topic titles (820-3) 1-1, 1-2, . . . is associated with reply sentences (830-3) 1-1, 1-2, . . . . The reply sentence 830-3 is prepared per each of the response types 840-3.

For example, when the topic title (820-3) 1-1 is (Sato; *; like) [these are extracted morphemes included in “I like Sato”], the reply sentences (830-3) 1-1 associated with the topic title (820-3) 1-1 include (DA: a declarative affirmative sentence “I like Sato, too.”) and (TA: a time affirmative sentence “I like Sato at bat.”). The after-mentioned reply retrieval unit 1380-3 retrieves one reply sentence 830-3 associated with the topic title 820-3 with reference to an output from the input type determining unit 1440-3.

Next-plan designation information 840-3 is allocated to each of the reply sentences 830-3. The next-plan designation information 840-3 is information for designating a reply sentence to be preferentially output against a user's utterance in association with the each of the reply sentences (referred as a “next-reply sentence”). The next-plan designation information 840-3 may be any information even if a next-reply sentence can be specified by the information. For example, the information may be a reply sentence ID, by which at least one reply sentence can be specified among all reply sentences stored in the conversation database 1500-3.

In the present embodiment, the next-plan designation information 840-3 is described as information for specifying one next-reply sentence per one reply sentence (for example, a reply sentence ID). However, the next-plan designation information 840-3 may be information for specifying next-reply sentences per topic specification information 810-3 or per one topic title 820-3. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300-3 is further described with referring back to FIG. 167.

The conversation control unit 1300-3 functions to control data transmitting between configuration components in the conversation controller 1000-3 (the speech recognition unit 1200-3, the sentence analyzing unit 1400-3, the conversation database 1500-3, the output unit 1600-3 and the speech recognition dictionary memory 1700-3), and determine and output a reply sentence in response to a user's utterance.

In the present embodiment shown in FIG. 167, the conversation control unit 1300-3 includes a managing unit 1310-3, a plan conversation process unit 1320-3, a discourse space conversation control process unit 1330-3 and a CA conversation process unit 1340-3. Hereinafter, these configuration components will be described.

### [Managing Unit]

The managing unit 1310-3 functions to store discourse histories and update, if needed, the discourse histories. The managing unit 1310-3 further functions to transmit some or entire of the stored discourse histories to a part or a whole of the discourse histories to a topic specification information retrieval unit 1350-3, an elliptical sentence complementation unit 1360-3, a topic retrieval unit 1370-3 or a reply retrieval unit 1380-3 in response to a request therefrom.

### [Plan Conversation Process Unit]

The plan conversation process unit 1320-3 functions to execute plans and establish conversations between a user and the conversation controller 1000-3 according to the plans. A “plan” means providing a predetermined reply to a user in a predetermined order.

The plan conversation process unit 1320-3 functions to output the predetermined reply in the predetermined order in response to a user's utterance.

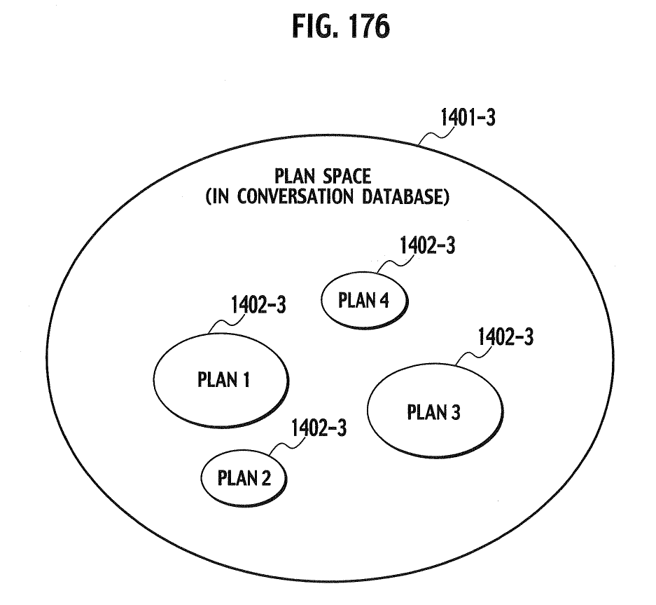

FIG. 176 is a conceptual diagram to describe plans. As shown in FIG. 176, various plans 1402-3 such as plural plans 1, 2, 3 and 4 are prepared in a plan space 1401-3. The plan space 1401-3 is a set of the plural plans 1402-3 stored in the conversation database 1500-3. The conversation controller 1000-3 selects a preset plan 1402-3 for a start-up on an activation or a conversation start or arbitrarily selects one of the plans 1402-3 in the plan space 1401-3 in response to a user's utterance contents in order to output a reply sentence against the user's utterance by using the selected plan 1402-3.

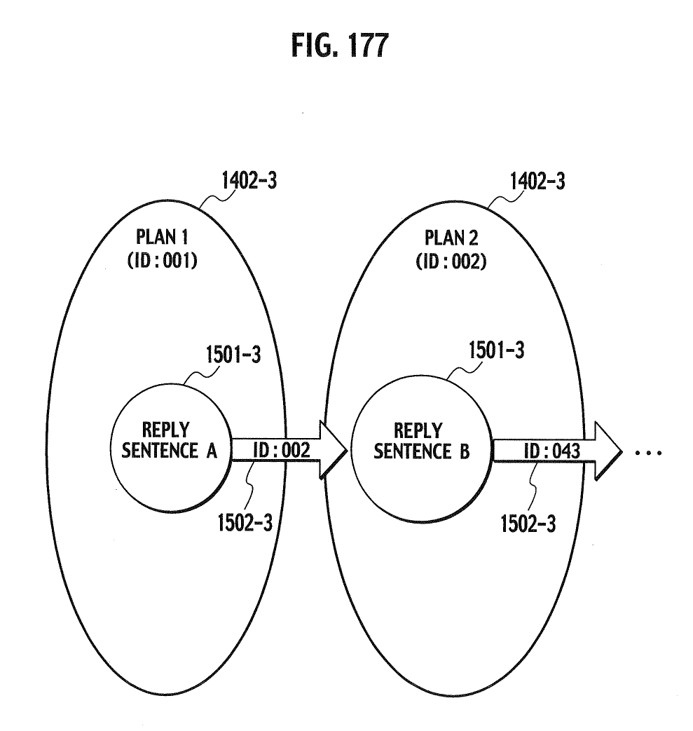

FIG. 177 shows a configuration example of plans 1402-3. Each plan 1402-3 includes a reply sentence 1501-3 and next-plan designation information 1502-3 associated therewith. The next-plan designation information 1502-3 is information for specifying, in response to a certain reply sentence 1501-3 in a plan 1402-3, another plan 1402-3 including a reply sentence to be output to a user (referred as a “next-reply candidate sentence”). In this example, the plan 1 includes a reply sentence A (1501-3) to be output at an execution of the plan 1 by the conversation controller 1000-3 and next-plan designation information 1502-3 associated with the reply sentence A (1501-3). The next-plan designation information 1502-3 is information [ID: 002] for specifying a plan 2 including a reply sentence B (1501-3) to be a next-reply candidate sentence to the reply sentence A (1501-3). Similarly, since the reply sentence B (1501-3) is also associated with next-plan designation information 1502-3, another plan 1402-3 ([ID: 043]: not shown) including the next-reply candidate sentence will be designated by next-plan designation information 1502-3 when the reply sentence B (1501-3) has output. In this manner, plans 1402-3 are chained via next-plan designation information 1502-3 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501-3 included in a plan 1402-3 designated by next-plan designation information 1502-3 is not needed to be output to a user immediately after an output of the user's utterance in response to an output of a previous reply sentence. The reply sentence 1501-3 included in the plan 1402-3 designated by the next-plan designation information 1502-3 may be output after an intervening conversation on a different topic from a topic in the plan between the conversation controller 1000-3 and the user.

Note that the reply sentence 1501-3 shown in FIG. 177 corresponds to a sentence string of one of the reply sentences 830-3 shown in FIG. 175. In addition, the next-plan designation information 1502-3 shown in FIG. 177 corresponds to the next-plan designation information 840-3 shown in FIG. 175.

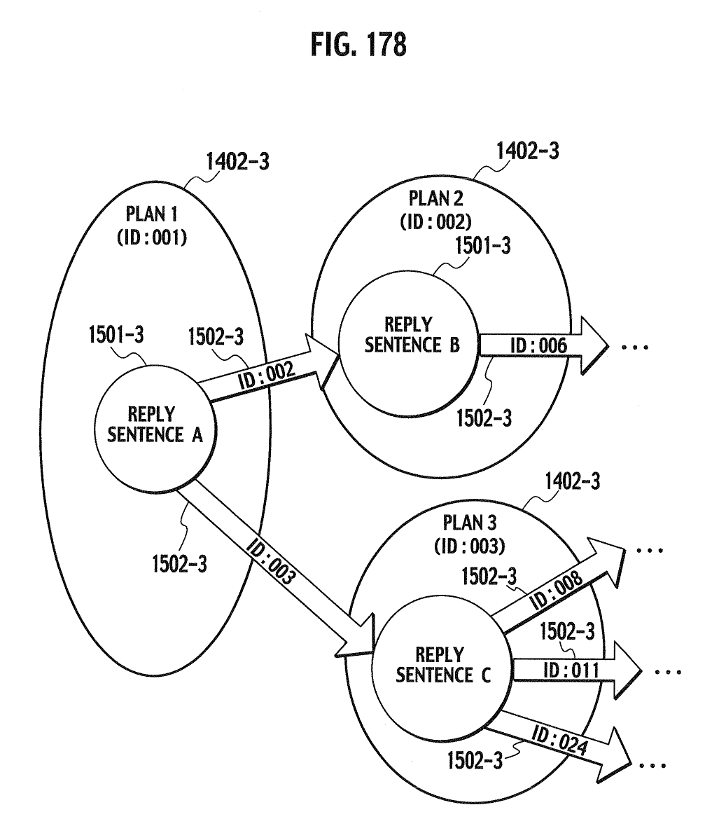

Note that linkages between the plans 1402-3 are not limited to form a one-dimensional geometry shown in FIG. 177. FIG. 178 shows an example of plans 1402-3 with another linkage geometry. In the example shown in FIG. 178, a plan 1 (1402-3) includes two of next-plan designation information 1502-3 to designate two reply sentences as next replay candidate sentences, in other words, to designate two plans 1402-3. The two of next-plan designation information 1502-3 are prepared in order that the plan 2 (1402-3) including a reply sentence B (1501-3) and the plan 3 (1402-3) including a reply sentence C (1501-3) are to be designated as plans each including a next-reply candidate sentence. Note that the reply sentences are selective and alternative, so that, when one has been output, another is not output and then the plan 1 (1501-3) is terminated. In this manner, the linkages between the plans 1402-3 is not limited to forming a one-dimensional geometry and may form a tree-diagram-like geometry or a cancellous geometry.

Note that it is not limited that how many next-reply candidate sentences each plan 1402-3 includes. In addition, no next-plan designation information 1502-3 may be included in a plan 1402-3 which terminates a conversation.

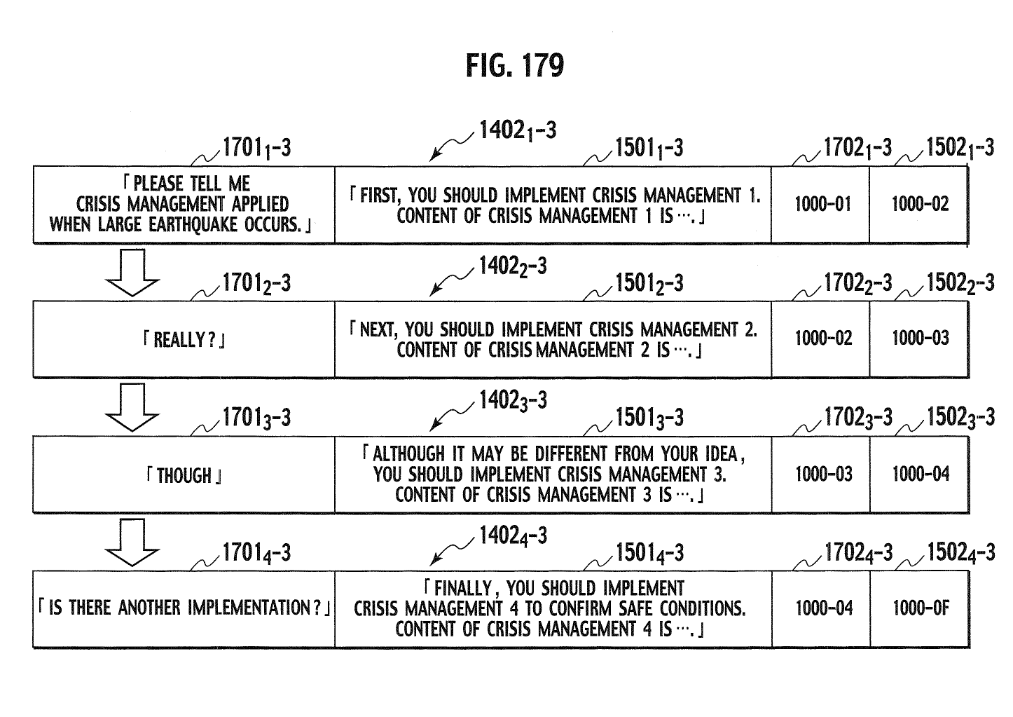

FIG. 179 shows an example of a certain series of plans 1402-3. As shown in FIG. 179, this series of plans 1402₁-3 to 1402₄-3 are associated with reply sentences 1501₁-3 to 1501₄-3 which notify crisis management information to a user. The reply sentences 1501₁-3 to 1501₄-3 constitute one coherent topic as a whole. Each of the plans 1402₁-3 to 1402₄-3 includes ID data 1702₁-3 to 1702₄-3 for indicating itself such as “1000-01, 1000-02”, “1000-03” and “1000-04”, respectively. Note that each value after a hyphen in the ID data is information indicating an output order. In addition, each of the plans 1402₁-3 to 1402₄-3 further includes ID data 1502₁-3 to 1502₄-3 as the next-plan designation information such as “1000-02, 1000-03”, “1000-04” and “1000-0F”, respectively. Especially, “0F” is information indicating the final plan (the last in the order).

In this example, the plan conversation process unit 1320-3 starts to execute this series of plans when a user has uttered 's utterance has been “Please tell me a crisis management applied when a large earthquake occurs.” Specifically, the plan conversation process unit 1320-3 searches in the plan space 1401-3 and checks whether or not a plan 1402-3 including a reply sentence 1501₁-3 associated with the user's utterance “Please tell me a crisis management applied when a large earthquake occurs,” when the plan conversation process unit 1320-3 has received the user's utterance “Please tell me a crisis management applied when a large earthquake occurs.” In this example, a user's utterance character string 1701₁-3 associated with the user's utterance “Please tell me a crisis management applied when a large earthquake occurs,” is associated with a plan 1402₁-3.

The plan conversation process unit 1320-3 retrieves the reply sentence 1501₁-3 included in the plan 1402₁-3 on discovering the plan 1402₁-3 and outputs the reply sentence 1501₁-3 to the user as a reply sentence in response to the user's utterance. And then, the plan conversation process unit 1320-3 specifies the next-reply candidate sentence with reference to the next-plan designation information 1502₁-3.

Next, the plan conversation process unit 1320-3 executes the plan 1402₂-3 on receiving another user's utterance via the input unit 1100-3, a speech recognition unit 1200-3 or the like after an output of the reply sentence 1501₁-3. Specifically, the plan conversation process unit 1320-3 judges whether or not to execute the plan 1402₂-3 designated by the next-plan designation information 1502₁-3, in other words, whether or not to output the second reply sentence 1501₂-3. More specifically, the plan conversation process unit 1320-3 compares a user's utterance character string (also referred as an illustrative sentence) 1701₂-3 associated with the reply sentence 1501₂-3 and the received user's utterance, or compares a topic title 820-3 (not shown in FIG. 179) associated with the reply sentence 1501₂-3 and the received user's utterance. And then, the plan conversation process unit 1320-3 determines whether or not the two are related to each other. If the two are related to each other, the plan conversation process unit 1320-3 outputs the second reply sentence 1501₂-3. In addition, since the plan 1402₂-3 including the second reply sentence 1501₂-3 also includes the next-plan designation information 1502₂-3, the next-reply candidate sentence is specified.

Similarly, according to ongoing user's utterances, the plan conversation process unit 1320-3 transit into the plans 1402₃-3 and 1402₄-3 in turn and can output the third and fourth reply sentences 1501₃ and 1501₄. Note that, since the fourth reply sentence 1501₄-3 is the final reply sentence, the plan conversation process unit 1320-3 terminates plan-executions when the fourth reply sentence 1501₄-3 has been output.

In this manner, the plan conversation process unit 1320-3 can provide previously prepared conversation contents to the user in a predetermined order by sequentially executing the plans 1402₁-3 to 1402₄-3.

### [Discourse Space Conversation Control Process Unit]

The configuration example of the conversation control unit 1300-3 is further described with referring back to FIG. 167.

The discourse space conversation control process unit 1330-3 includes the topic specification information retrieval unit 1350-3, the elliptical sentence complementation unit 1360-3, the topic retrieval unit 1370-3 and the reply retrieval unit 1380-3. The managing unit 1310-3 totally controls the conversation control unit 1300-3.

A “discourse history” is information for specifying a conversation topic or theme between a user and the conversation controller 1000-3 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330-3 will be described.

### [Topic Specification Information Retrieval Unit]

The topic specification information retrieval unit 1350-3 compares the first morpheme information extracted by the morpheme extracting unit 1420-3 and the topic specification information, and then retrieves the topic specification information corresponding to a morpheme in the first morpheme information among the topic specification information. Specifically, when the first morpheme information received from the morpheme extracting unit 1420-3 is two morphemes “Sato” and “like”, the topic specification information retrieval unit 1350-3 compares the received first morpheme information and the topic specification information group.

If a focused topic title 820-3_{focus} (indicated as 820-3_{focus} to be differentiated from previously retrieved topic titles or other topic titles) includes a morpheme (for example, “Sato”) in the first morpheme information, the topic specification information retrieval unit 1350-3 outputs the focused topic title 820-3_{focus} to the reply retrieval unit 1380-3. On the other hand, if no topic title includes the morpheme in the first morpheme information, the topic specification information retrieval unit 1350-3 determines user input sentence topic specification information based on the received first morpheme information, and then outputs the first morpheme information and the user input sentence topic specification information to the elliptical sentence complementation unit 1360-3. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360-3 generates various complemented first morpheme information by complementing the first morpheme information with the previously retrieved topic specification information 810-3 (hereinafter referred as the “focused topic specification information”) and the topic specification information 810-3 included in the final reply sentence (hereinafter referred as the “reply sentence topic specification information”). For example, if a user's utterance is “like”, the elliptical sentence complementation unit 1360-3 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360-3 generates the complemented first morpheme information by including an element(s) in the set “D” into the first morpheme information “W”.

In this manner, in case where, for example, a sentence constituted with the first morpheme information is an elliptical sentence which is unclear as language, the elliptical sentence complementation unit 1360-3 can include, by using the set “D”, an element(s) (for example, “Sato”) in the set “D” into the first morpheme information “W”. As a result, the elliptical sentence complementation unit 1360-3 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360-3 can complement the elliptical sentence by using the set “D”. As a result, even when a sentence constituted with the first morpheme information is an elliptical sentence, the elliptical sentence complementation unit 1360-3 can complement the sentence into an appropriate sentence as language.

In addition, the elliptical sentence complementation unit 1360-3 retrieves the topic title 820-3 related to the complemented first morpheme information based on the set “D”. If the topic title 820-3 related to the complemented first morpheme information has been found, the elliptical sentence complementation unit 1360-3 outputs the topic title 820-3 to the reply retrieval unit 1380-3. The reply retrieval unit 1380-3 can output a reply sentence 830-3 best-suited for the user's utterance contents based on the appropriate topic title 820-3 found by the elliptical sentence complementation unit 1360-3.

Note that the elliptical sentence complementation unit 1360-3 is not limited to including an element(s) in the set “D” into the first morpheme information. The elliptical sentence complementation unit 1360-3 may include, based on a focused topic title, a morpheme(s) included in any of the first, second and third specification information in the topic title, into the extracted first morpheme information.

### [Topic Retrieval Unit]

The topic retrieval unit 1370-3 compares the first morpheme information and topic titles 820-3 associated with the user input sentence topic specification information to retrieve a topic title 820-3 best-suited for the first morpheme information among the topic titles 820-3 when the topic title 820-3 has not been determined by the elliptical sentence complementation unit 1360-3.

Specifically, the topic retrieval unit 1370-3, which has received a retrieval command signal from the elliptical sentence complementation unit 1360-3, retrieves the topic title 820-3 best-suited for the first morpheme information among the topic titles associated with the user input sentence topic specification information based on the user input sentence topic specification information and the first morpheme information which are included in the received retrieval command signal. The topic retrieval unit 1370-3 outputs the retrieved topic title 820-3 as a retrieval result signal to the reply retrieval unit 1380-3.

Above-mentioned FIG. 175 shows the concrete example of the topic titles 820-3 and the reply sentences 830-3 associated with the topic specification information 810-3 (=“Sato”). For example as shown in FIG. 175, since topic specification information 810-3 (=“Sato”) is included in the received first morpheme information “Sato, like”, the topic retrieval unit 1370-3 specifies the topic specification information 810-3 (=“Sato”) and then compares the topic titles (820-3) 1-1, 1-2, . . . associated with the topic specification information 810-3 (=“Sato”) and the received first morpheme information “Sato, like”.

The topic retrieval unit 1370-3 retrieves the topic title (820-3) 1-1 (Sato; *; like) related to the received first morpheme information “Sato, like” among the topic titles (820-3) 1-1, 1-2, based on the comparison result. The topic retrieval unit 1370-3 outputs the retrieved topic title (820-3) 1-1 (Sato; *; like) as a retrieval result signal to the reply retrieval unit 1380-3.

### [Reply Retrieval Unit]

The reply retrieval unit 1380-3 retrieves, based on the topic title 820-3 retrieved by the elliptical sentence complementation unit 1360-3 or the topic retrieval unit 1370-3, a reply sentence associated with the topic title 820-3. In addition, the reply retrieval unit 1380-3 compares, based on the topic title 820-3 retrieved by the topic retrieval unit 1370-3, the response types associated with the topic title 820-3 and the utterance type determined by the input type determining unit 1440-3. The reply retrieval unit 1380-3, which has executed the comparison, retrieves one response type related to the determined utterance type among the response types.

In the example shown in FIG. 175, when the topic title retrieved by the topic retrieval unit 1370-3 is the topic title 1-1 (Sato; *; like), the reply retrieval unit 1380-3 specifies the response type (for example, DA) coincident with the “uttered sentence type” (DA) determined by the input type determining unit 1440-3 among the reply sentences 1-1 (DA, TA and so on) associated with the topic title 1-1. The reply retrieval unit 1380-3, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380-3 outputs the retrieved reply sentence 830-3 as a reply sentence signal to the managing unit 1310-3. The managing unit 1310-3, which has received the reply sentence signal from the reply retrieval unit 1380-3, outputs the received reply sentence signal to the output unit 1600-3.

### [CA Conversation Process Unit]

When a reply sentence in response to a user's utterance has not been determined by the plan conversation process unit 1320-3 or the discourse space conversation control process unit 1330-3, the CA conversation process unit 1340-3 functions to output a reply sentence for continuing a conversation with a user according to contents of the user's utterance.

The configuration example of the conversation controller 1000-3 is further described with referring back to FIG. 163.

### [Output Unit]

The output unit 1600-3 outputs the reply sentence retrieved by the reply retrieval unit 1380-3. The output unit 1600-3 may be a speaker or a display, for example. Specifically, the output unit 1600-3, which has received the reply sentence from the reply retrieval unit 1380-3, outputs voice sounds of the received reply sentence (for example, “I like Sato, too,”) based on the received reply sentence. With that, describing the configuration example of the conversation controller 1000-3 has ended.

### [Conversation Control Method]

The conversation controller 100-3 with the above-mentioned configuration puts a conversation control method in execution by operating as described hereinbelow.

Next, operations of the conversation controller 1000-3, more specifically the conversation control unit 1300-3, according to the present embodiment will be described.

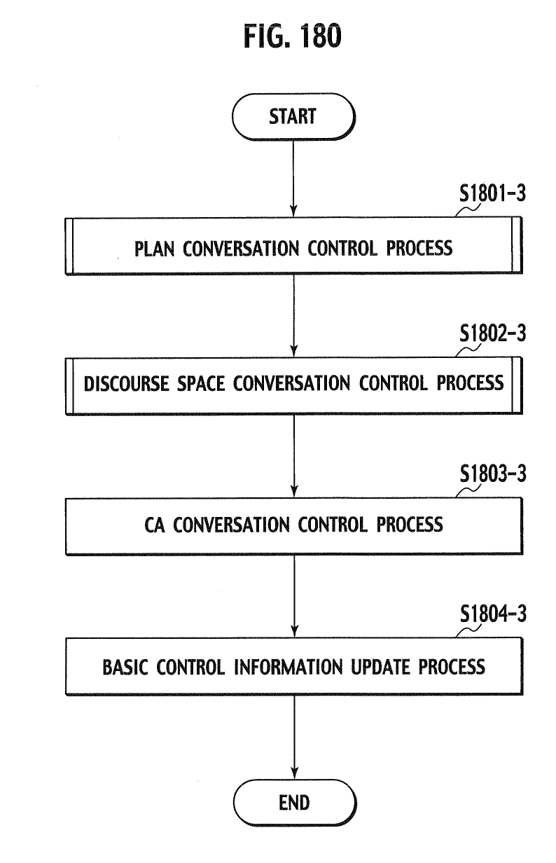

FIG. 180 is a flow chart showing an example of a main process executed by conversation control unit 1300-3. This main process is a process executed each time when the conversation control unit 1300-3 receives a user's utterance. A reply sentence in response to the user's utterance is output due to an execution of this main process, so that a conversation (an interlocution) between a user and the conversation controller 100-3 is established.

Upon executing the main process, the conversation controller 100-3, more specifically the plan conversation process unit 1320-3 firstly executes a plan conversation control process (S1801-3). The plan conversation control process is a process for executing a plan(s).

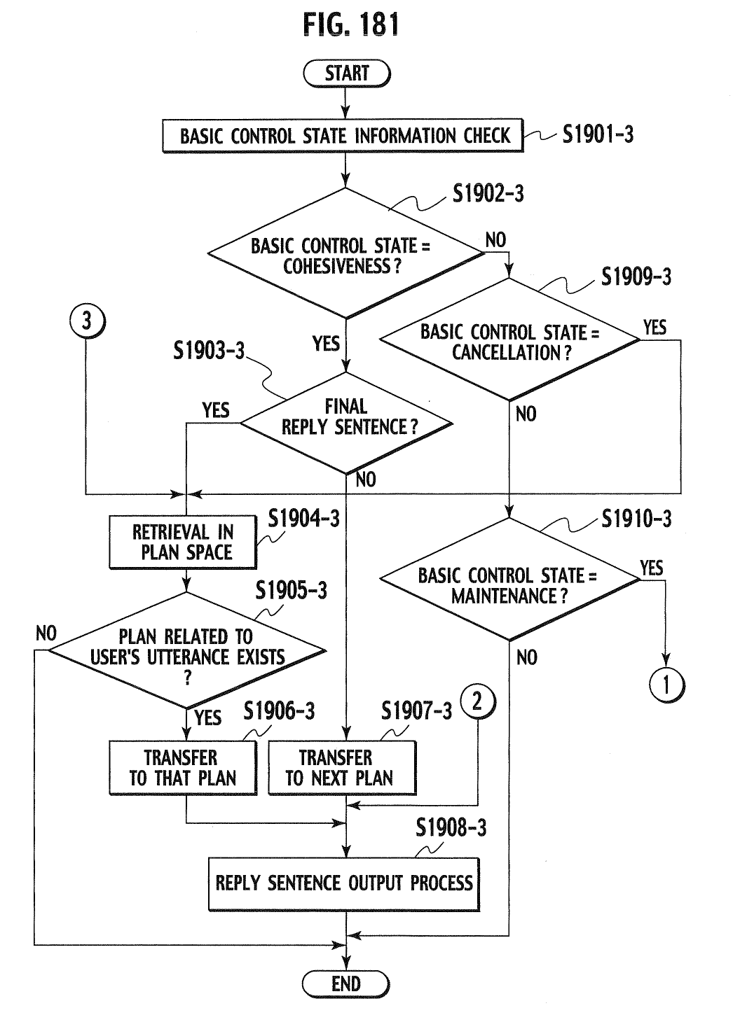

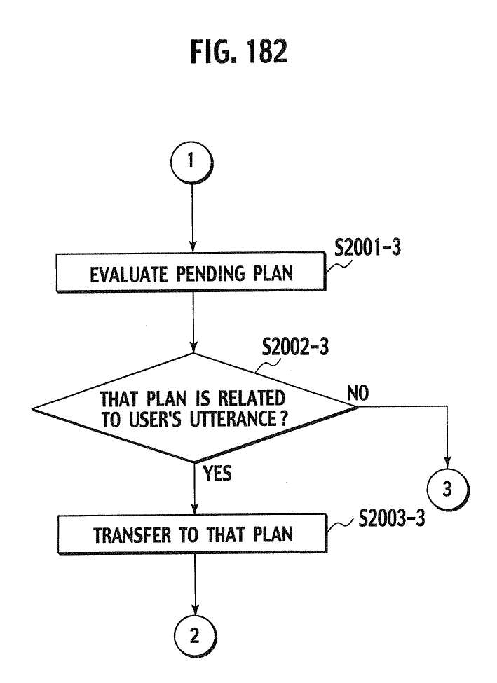

FIGS. 181 and 182 are flow charts showing an example of the plan conversation control process. Hereinbelow, the example of the plan conversation control process will be described with reference to FIGS. 181 and 182.

Upon executing the plan conversation control process, the plan conversation process unit 1320-3 firstly executes a basic control state information check (S1901-3). The basic control state information is information on whether or not an execution(s) of a plan(s) has been completed and is stored in a predetermined memory area.

The basic control state information serves to indicate a basic control state of a plan.

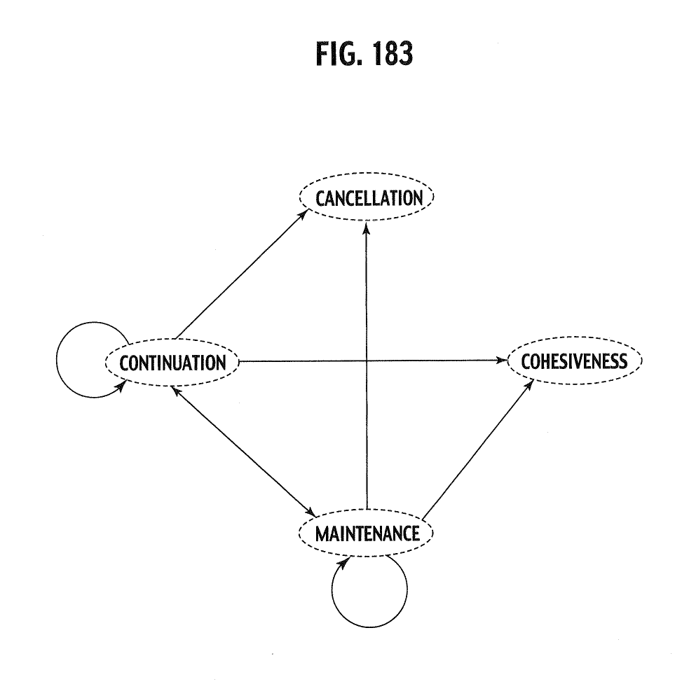

FIG. 183 is a diagram showing four basic control states which are possibly established due to a so-called scenario-type plan.

### (1) Cohesiveness

This basic control state corresponds to a case where a user's utterance is coincident with the currently executed plan 1402-3, more specifically the topic title 820-3 or the example sentence 1701-3 associated with the plan 1402-3. In this case, the plan conversation process unit 1320-3 terminates the plan 1402-3 and then transfers to another plan 1402-3 corresponding to the reply sentence 1501-3 designated by the next-plan designation information 1502-3.

### (2) Cancellation

This basic control state is a basic control state which is set in a case where it is determined that user's utterance contents require a completion of a plan 1402-3 or that a user's interest has changed to another matter than the currently executed plan. When the basic control state indicates the cancellation, the plan conversation process unit 1320-3 retrieves another plan 1402-3 associated with the user's utterance than the plan 1402-3 targeted as the cancellation. If the other plan 1402-3 exists, the plan conversation process unit 1320-3 start to execute the other plan 1402-3. If the other plan 1402-3 does not exist, the plan conversation process unit 1320-3 terminates an execution(s) of a plan(s).

### (3) Maintenance

This basic control state is a basic control state which is set in a case where a user's utterance is not coincident with the topic title 820-3 (see FIG. 175) or the example sentence 1701-3 (see FIG. 179) associated with the currently executed plan 1402-3 and also the user's utterance does not correspond to the basic control state “cancellation”.

In the case of this basic control state, the plan conversation process unit 1320-3 firstly determines whether or not to resume a pending or pausing plan 1402-3 on receiving the user's utterance. If the user's utterance is not adapted for resuming the plan 1402-3, for example, in case where the user's utterance is not related to a topic title 820-3 or an example sentence 1701-3 associated with the plan 1402-3, the plan conversation process unit 1320-3 starts to execute another plan 1402-3, an after-mentioned discourse space conversation control process (S1802-3) and so on. If the user's utterance is adapted for resuming the plan 1402-3, the plan conversation process unit 1320-3 outputs a reply sentence 1501-3 based on the stored next-plan designation information 1502-3.

In case where the basic control state is the “maintenance”, the plan conversation process unit 1320-3 retrieves other plans 1402-3 in order to enable outputting another reply sentence than the reply sentence 1501-3 associated with the currently executed plan 1402-3, or executes the discourse space conversation control process. However, if the user's utterance is adapted for resuming the plan 1402-3, the plan conversation process unit 1320-3 resumes the plan 1402-3.

### (4) Continuation

This state is a basic control state which is set in a case where a user's utterance is not related to reply sentences 1501-3 included in the currently executed plan 1402-3, contents of the user's utterance do not correspond to the basic control sate “cancellation” and use's intention construed from the user's utterance is not clear.

In case where the basic control state is the “continuation”, the plan conversation process unit 1320-3 firstly determines whether or not to resume a pending or pausing plan 1402-3 on receiving the user's utterance. If the user's utterance is not adapted for resuming the plan 1402-3, the plan conversation process unit 1320-3 executes an after-mentioned CA conversation control process in order to enable outputting a reply sentence for getting out a further user's utterance.

The plan conversation control process is further described with referring back to FIG. 181.

The plan conversation process unit 1320-3, which has referred to the basic control state, determines whether or not the basic control state indicated by the basic control state information is the “cohesiveness” (step S1902-3). If it has been determined that the basic control state is the “cohesiveness” (YES in step S1902-3), the plan conversation process unit 1320-3 determines whether or not the reply sentence 1501-3 is the final reply sentence in the currently executed plan 1402-3 (step S1903-3).

If it has been determined that the final reply sentence 1501-3 has been output already (YES in step S1903-3), the plan conversation process unit 1320-3 retrieves another plan 1402-3 related to the use's utterance in the plan space in order to determine whether or not to execute the other plan 1402-3 (step S1904-3) because the plan conversation process unit 1320-3 has provided all contents to be replied to the user already. If the other plan 1402-3 related to the user's utterance has not been found due to this retrieval (NO in step S1905-3), the plan conversation process unit 1320-3 terminates the plan conversation control process because no plan 1402-3 to be provided to the user exists.

On the other hand, if the other plan 1402-3 related to the user's utterance has been found due to this retrieval (YES in step S1905-3), the plan conversation process unit 1320-3 transfers into the other plan 1402-3 (step S1906-3). Since the other plan 1402-3 to be provided to the user still remains, an execution of the other plan 1402-3 (an output of the reply sentence 1501-3 included in the other plan 1402-3) is started.

Next, the plan conversation process unit 1320-3 outputs the reply sentence 1501-3 included in that plan 1402-3 (step S1908-3). The reply sentence 1501-3 is output as a reply to the user's utterance, so that the plan conversation process unit 1320-3 provides information to be supplied to the user.

The plan conversation process unit 1320-3 terminates the plan conversation control process after the reply sentence output process (step S1908-3).

On the other hand, if the previously output reply sentence 1501-3 is not determined as the final reply sentence in the determination whether or not the previously output reply sentence 1501-3 is the final reply sentence (step S1903-3), the plan conversation process unit 1320-3 transfers into a plan 1402-3 associated with the reply sentence 1501-3 following the previously output reply sentence 1501-3, i.e. the specified reply sentence 1501-3 by the next-plan designation information 1502-3 (step S1907-3).

Subsequently, the plan conversation process unit 1320-3 outputs the reply sentence 1501-3 included in that plan 1402-3 to provide a reply to the user's utterance (step 1908-3). The reply sentence 1501-3 is output as the reply to the user's utterance, so that the plan conversation process unit 1320-3 provides information to be supplied to the user. The plan conversation process unit 1320-3 terminates the plan conversation control process after the reply sentence output process (step S1908-3).

Here, if the basic control state is not the “cohesiveness” in the determination process in step S1902-3 (NO in step S1902-3), the plan conversation process unit 1320-3 determines whether or not the basic control state indicated by the basic control state information is the “cancellation” (step S1909-3). If it has been determined that the basic control state is the “cancellation” (YES in step S1909-3), the plan conversation process unit 1320-3 retrieves another plan 1402-3 related to the use's utterance in the plan space 1401-3 in order to determine whether or not the other plan 1402-3 to be started newly exists (step S1904-3) because a plan 1402-3 to be successively executed does not exist. Subsequently, the plan conversation process unit 1320-3 executes the processes of steps S1905-3 to S1908-3 as well as the processes in case of the above-mentioned step S1903-3 (YES).

On the other hand, if the basic control state is not the “cancellation” in the determination process in step S1902-3 (NO in step S1902-3) in the determination whether or not the basic control state indicated by the basic control state information is the “cancellation” (step S1909-3), the plan conversation process unit 1320-3 further determines whether or not the basic control state indicated by the basic control state information is the “maintenance” (step S1910-3).

If the basic control state indicated by the basic control state information is the “maintenance” (YES in step S1910-3), the plan conversation process unit 1320-3 determined whether or not the user presents the interest on the pending or pausing plan 1402-3 again and then resumes the pending or pausing plan 1402-3 in case where the interest is presented (step S2001-3 in FIG. 182). In other words, the plan conversation process unit 1320-3 evaluates the pending or pausing plan 1402-3 (step S2001-3 in FIG. 182) and then determines whether or not the user's utterance is related to the pending or pausing plan 1402-3 (step S2002-3).

If it has been determined that the user's utterance is related to that plan 1402-3 (YES in step S2002-3), the plan conversation process unit 1320-3 transfers into the plan 1402-3 related to the user's utterance (step S2003-3) and then executes the reply sentence output process (step S1908-3 in FIG. 181) to output the reply sentence 1501-3 included in the plan 1402-3. Operating in this manner, the plan conversation process unit 1320-3 can resume the pending or pausing plan 1402-3 according to the user's utterance, so that all contents included in the previously prepared plan 1402-3 can be provided to the user.

On the other hand, if it has been determined that the user's utterance is not related to that plan 1402-3 (NO in step S2002-3) in the above-mentioned S2002 (see FIG. 182), the plan conversation process unit 1320-3 retrieves another plan 1402-3 related to the use's utterance in the plan space 1401-3 in order to determine whether or not the other plan 1402-3 to be started newly exists (step S1904-3 in FIG. 181). Subsequently, the plan conversation process unit 1320-3 executes the processes of steps S1905-3 to S1908-3 as well as the processes in case of the above-mentioned step S1903-3 (YES).

If it is determined that the basic control state indicated by the basic control state information is not the “maintenance” (NO in step S1910-3) in the determination in step S1910-3, it means that the basic control state indicated by the basic control state information is the “continuation”. In this case, the plan conversation process unit 1320-3 terminates the plan conversation control process without outputting a reply sentence. With that, describing the plan control process has ended.

The main process is further described with referring back to FIG. 180. The conversation control unit 1300-3 executes the discourse space conversation control process (step S1802-3) after the plan conversation control process (step S1801-3) has been completed. Note that, if the reply sentence has been output in the plan conversation control process (step S1801-3), the conversation control unit 1300-3 executes a basic control information update process (step S1804-3) without executing the discourse space conversation control process (step S1802-3) and the after-mentioned CA conversation control process (step S1803-3) and then terminates the main process.

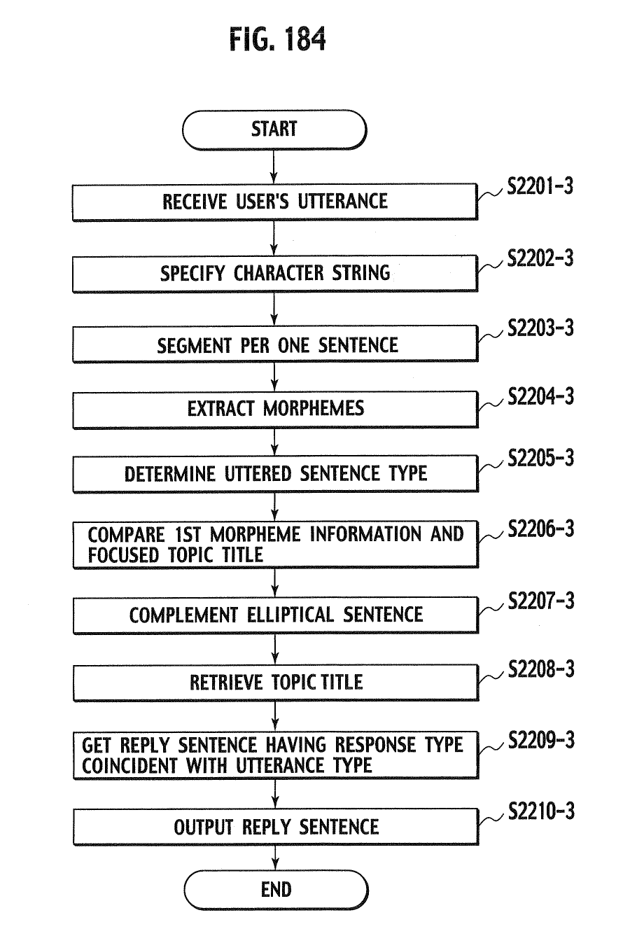

FIG. 184 is a flow chart showing an example of a discourse space conversation control process according to the present embodiment. The input unit 1100-3 firstly executes a step for receiving a user's utterance (step S2201-3). Specifically, the input unit 1100-3 receives voice sounds of the user's utterance. The input unit 1100-3 outputs the received voice sounds to the speech recognition unit 1200-3 as a voice signal. Note that the input unit 1100-3 may receive a character string input by a user (for example, text data input in a text format) instead of the voice sounds. In this case, the input unit 1100-3 may be a text input device such as a keyboard or a touchscreen.

Next, the speech recognition unit 1200-3 executes a step for specifying a character string corresponding to the uttered contents based on the uttered contents retrieved by the input unit 1100-3 (step S2202-3). Specifically, the speech recognition unit 1200-3, which has received the voice signal from the input unit 1100-3, specifies a word hypothesis (candidate) corresponding to the voice signal based on the received voice signal. The speech recognition unit 1200-3 retrieves a character string corresponding to the specified word hypothesis and outputs the retrieved character string to the conversation control unit 1300-3, more specifically the discourse space conversation control process unit 1330-3, as a character string signal.

And then, the character string specifying unit 1410-3 segments a series of the character strings specified by the speech recognition unit 1200-3 into segments (step S2203-3). Specifically, if the series of the character strings have a time interval more than a certain interval, the character string specifying unit 1410-3, which has received the character string signal or a morpheme signal from the managing unit 1310-3, segments the character strings there. The character string specifying unit 1410-3 outputs the segmented character strings to the morpheme extracting unit 1420-3 and the input type determining unit 1440-3. Note that it is preferred that the character string specifying unit 1410-3 segments a character string at a punctuation, a space and so on in a case where the character string has been input from a keyboard.

Subsequently, the morpheme extracting unit 1420-3 executes a step for extracting morphemes constituting minimum units of the character string as first morpheme information based on the character string specified by the character string specifying unit 1410-3 (step S2204-3). Specifically, the morpheme extracting unit 1420-3, which has received the character strings from the character string specifying unit 1410-3, compares the received character strings and morpheme groups previously stored in the morpheme database 1430-3. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420-3, which has executed the comparison, extracts coincident morphemes (m1, m2, . . . ) with the morphemes included in the previously stored morpheme groups from the received character string. The morpheme extracting unit 1420-3 outputs the extracted morphemes to the topic specification information retrieval unit 1350-3 as the first morpheme information.

Next, the input type determining unit 1440-3 executes a step for determining the “uttered sentence type” based on the morphemes which constitute one sentence and are specified by the character string specifying unit 1410-3 (step S2205-3). Specifically, the input type determining unit 1440-3, which has received the character strings from the character string specifying unit 1410-3, compares the received character strings and the dictionaries stored in the utterance type database 1450-3 based on the received character strings and extracts elements relevant to the dictionaries among the character strings. The input type determining unit 1440-3, which has extracted the elements, determines to which “uttered sentence type” the extracted element(s) belongs based on the extracted element(s). The input type determining unit 1440-3 outputs the determined “uttered sentence type” (utterance type) to the reply retrieval unit 1380-3.

And then, the topic specification information retrieval unit 1350-3 executes a step for comparing the first morpheme information extracted by the morpheme extracting unit 1420-3 and the focused topic title 820-3_{focus} (step S2206-3).

If a morpheme in the first morpheme information is related to the focused topic title 820-3_{focus}, the topic specification information retrieval unit 1350-3 outputs the focused topic title 820-3_{focus} to the reply retrieval unit 1380-3. On the other hand, if no morpheme in the first morpheme information is related to the focused topic title 820-3_{focus}, the topic specification information retrieval unit 1350-3 outputs the received first morpheme information and the user input sentence topic specification information to the elliptical sentence complementation unit 1360-3 as the retrieval command signal.

Subsequently, the elliptical sentence complementation unit 1360-3 executes a step for including the focused topic specification information and the reply sentence topic specification information into the received first morpheme information based on the first morpheme information received from the topic specification information retrieval unit 1350-3 (step S2207-3). Specifically, if it is assumed that the first morpheme information is defined as “W” and a set of the focused topic specification information and the reply sentence topic specification information is defined as “D”, the elliptical sentence complementation unit 1360-3 generates the complemented first morpheme information by including an element(s) in the set “D” into the first morpheme information “W” and compares the complemented first morpheme information and all the topic titles 820-3 to retrieve the topic title 820-3 related to the complemented first morpheme information. If the topic title 820-3 related to the complemented first morpheme information has been found, the elliptical sentence complementation unit 1360-3 outputs the topic title 820-3 to the reply retrieval unit 1380-3. On the other hand, if no topic title 820-3 related to the complemented first morpheme information has been found, the elliptical sentence complementation unit 1360-3 outputs the first morpheme information and the user input sentence topic specification information to the topic retrieval unit 1370-3.

Next, the topic retrieval unit 1370-3 executes a step for comparing the first morpheme information and the user input sentence topic specification information and retrieves the topic title 820-3 best-suited for the first morpheme information among the topic titles 820-3 (step S2208-3). Specifically, the topic retrieval unit 1370-3, which has received the retrieval command signal from the elliptical sentence complementation unit 1360-3, retrieves the topic title 820-3 best-suited for the first morpheme information among topic titles 820-3 associated with the user input sentence topic specification information based on the user input sentence topic specification information and the first morpheme information included in the received retrieval command signal. The topic retrieval unit 1370-3 outputs the retrieved topic title 820-3 to the reply retrieval unit 1380-3 as the retrieval result signal.

Next, the reply retrieval unit 1380-3 compares, in order to select the reply sentence 830-3, the user's utterance type determined by the sentence analyzing unit 1400-3 and the response type associated with the retrieved topic title 820-3 based on the retrieved topic title 820-3 by the topic specification information retrieval unit 1350-3, the elliptical sentence complementation unit 1360-3 or the topic retrieval unit 1370-3 (step S2209-3).

The reply sentence 830-3 is selected in particular as explained hereinbelow. Specifically, based on the “topic title” associated with the received retrieval result signal and the received “uttered sentence type”, the reply retrieval unit 1380-3, which has received the retrieval result signal from the topic retrieval unit 1370-3 and the “uttered sentence type” from the input type determining unit 1440-3, specifies one response type coincident with the “uttered sentence type” (for example, DA) among the response types associated with the “topic title”.

Consequently, the reply retrieval unit 1380-3 outputs the reply sentence 830-3 retrieved in step S2209-3 to the output unit 1600-3 via the managing unit 1310-3 (S2210-3). The output unit 1600-3, which has received the reply sentence 830-3 from the managing unit 1310-3, outputs the received reply sentence 830-3.

With that, describing the discourse space conversation control process has ended and the main process is further described with referring back to FIG. 180.

The conversation control unit 1300-3 executes the CA conversation control process (step S1803-3) after the discourse space conversation control process has been completed. Note that, if the reply sentence has been output in the plan conversation control process (step S1801-3) or the discourse space conversation control (step S1802-3), the conversation control unit 1300-3 executes the basic control information update process (step S1804-3) without executing the CA conversation control process (step S1803-3) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result. By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300-3 executes the basic control information update process (step S1804-3). In this process, the conversation control unit 1300-3, more specifically the managing unit 1310-3, sets the basic control information to the “cohesiveness” when the plan conversation process unit 1320-3 has output a reply sentence, sets the basic control information to the “cancellation” when the plan conversation process unit 1320-3 has cancelled an output of a reply sentence, sets the basic control information to the “maintenance” when the discourse space conversation control process unit 1330-3 has output a reply sentence, or sets the basic control information to the “continuation” when the CA conversation process unit 1340-3 has output a reply sentence.

The basic control information set in this basic control information update process is referred in the above-mentioned plan conversation control process (step S1801-3) to be employed for continuation or resumption of a plan.

As described the above, the conversation controller 1000-3 can executes a previously prepared plan(s) or can adequately respond to a topic(s) which is not included in a plan(s) according to a user's utterance by executing the main process each time when receiving the user's utterance.

In the gaming terminal 4-3 of the present embodiment, the input unit 1100-3 of the conversation controller 1000-3 explained above may be configured by the touchscreen 50-3 attached to the display 8-3 and the microphone 15-3. In addition, the output unit 1600-3 may be configured by the display 8-3 and the speaker 10-3. Furthermore, the speech recognition unit 1200-3; the conversation control unit 1300-3; and the character string specifying unit 1410-3, the morpheme extraction portion 1420-3 and the input type determining portion 1440-3 of the sentence analyzing unit 1400-3 may be configured by the terminal controller 90-3. In addition, the morpheme database 1430-3 and the utterance type database 1450-3 of the sentence analyzing unit 1400-3, and the speech recognition dictionary memory 1700-3 can be configured by the first external storage unit 99-3. Note that, although the conversation database 1500-3 can be stored also in the first external storage unit 99-3, it is stored in the HDD 34-3 of the above-mentioned server 13-3 in the present embodiment (see FIG. 160). And, as explained later, there are methods such as directly accessing the HDD 34-3 and downloading the conversation data stored in the HDD 34-3 at the time when using the conversation data stored in the conversation database 1500-3.

And, in the present embodiment, the language to be used in the roulette game can be determined through a conversation with the player by the conversation engine achieved with the above-mentioned configuration in the gaming terminal 4-3 by the conversation controller 1000-3.

Here, the speech recognition dictionary memory 1700-3 of the conversation controller 1000-3 configured by the first external storage unit 99-3 has word dictionaries for the plural languages in order to confirm a language type of sound messages input into the microphone 15-3 by the player. In addition, the morphological database 1430-3 of the conversation controller 1000-3 configured by the first external storage unit 99-3 has the morpheme groups for the plural languages (morpheme dictionaries). Furthermore, the utterance type database 1450-3 of the conversation controller 1000-3 configured by the first external storage unit 99-3 also has dictionaries of the respective utterance types for the plural languages.

In addition, “sentence” data for the plural languages are also stored in the conversation database 1500-3 configured by the terminal controller 90-3 in order to output sound messages from the speaker 10-3 to the player in the language selected by the player or to display the messages on the display 8-3. The “sentences” include a message for requesting an input (by an utterance or an operation on the display 8-3) of a specific phrase or sentence in the language desired to be used in the roulette game, a message for confirming the player to proceed the roulette game in the language of the input specific phrase or sentence, or the like.

The operations of the above-mentioned conversation engine of the gaming terminal 4-3 of the present embodiment will be explained later.

Next, contents of gaming processing executed in each of the server 13-3, the roulette unit 2-3 and the gaming terminals 4-3 on the roulette game machine 1-3 according to the present embodiment will be explained.

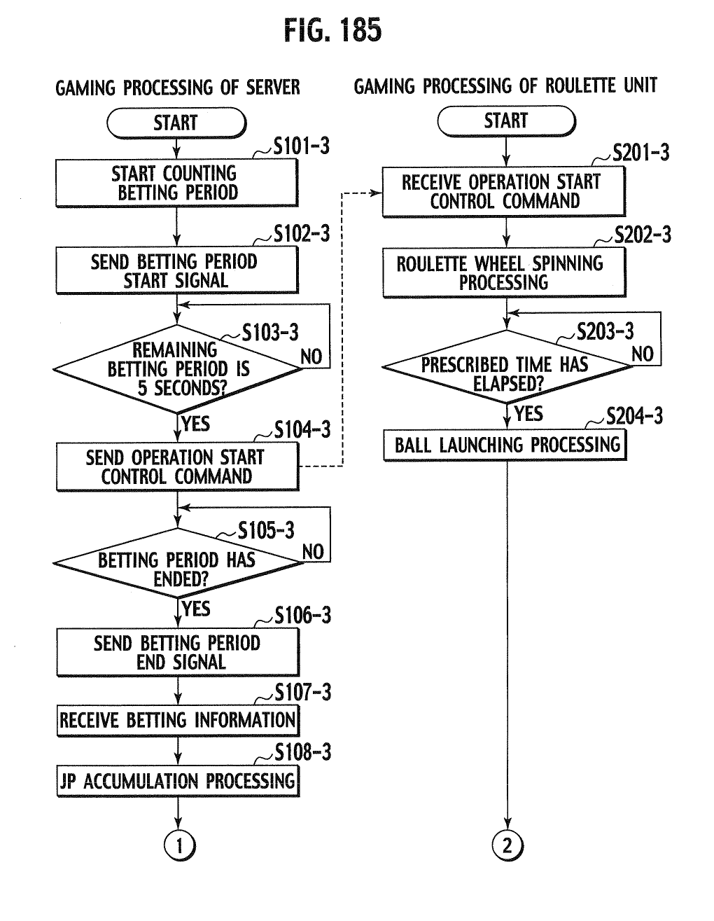

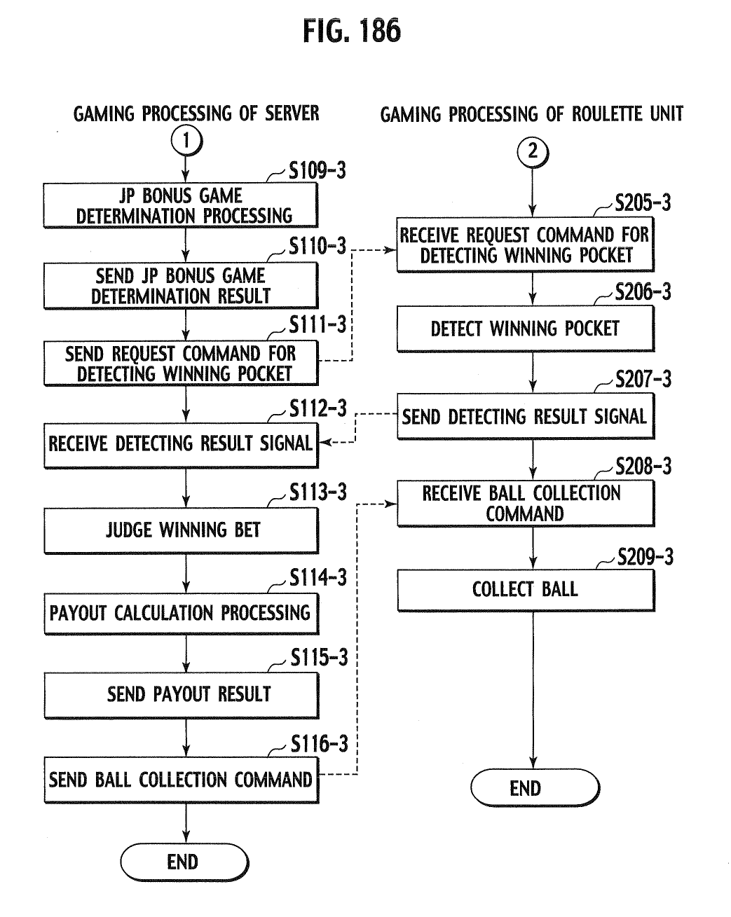

To begin with, gaming processing of the server, which is executed by the server CPU 81-3 of the server 13-3 according to the programs stored in the ROM 82-3, and gaming processing of the roulette unit, which is executed by the CPU 101-3 of the roulette unit 2-3 according to the programs stored in the ROM 102-3, will explained based on FIGS. 185 and 186. FIGS. 185 and 186 are flow charts of the gaming processings of the server and the roulette unit in the roulette gaming machine according to the present embodiment.

First, the gaming processing of the server 13-3 will be explained based on FIGS. 185 and 186. At first, as shown in FIG. 185, the server CPU 81-3 starts counting the betting period (step S101-3). The betting period is a period during which a player can place a bet(s). A player participating in a game can place a bet on the bet area 72-3 (see FIG. 159) which corresponds to the number predicted by the player during the betting period. The server CPU 81-3 sends a betting period start signal to the terminal CPU 91-3 when the betting period counting has been started (step S102-3).

Next, the server CPU 81-3 determines whether or not the remaining betting period has reached five seconds (step S103-3). Note that the remaining betting period is displayed on the bet time counter 69-3 on the display 8-3 at each of the gaming terminals 4-3 (see FIG. 159). If it is determined that it has not reached the last five seconds, the processing will be returned to the step S103-3. On the other hand, if it is determined that it has reached the last five seconds, the processing will proceed to the step S104-3.

The server CPU 81-3 sends a control command to the CPU 101-3 of the roulette unit 2-3 to start the operation of the roulette unit 2-3 (step S104-3). Next, the server CPU 81-3 determines whether or not the betting period has ended (step S105-3). If it is determined that the betting period has not ended (NO in step S105-3), the server CPU 81-3 suspends the processing until the betting period ends. On the other hand, if it is determined that the betting period has ended (YES in step S105-3), the server CPU 81-3 sends a betting period end signal indicating the expiry of the betting period to the terminal CPU 91-3 (step S106-3).

Next, the server CPU 81-3 receives the betting information (the information such as a specified bet area 72-3, a bet amount of chips and a betting type) input at each of the gaming terminals 4-3 by players from each of the terminal CPU's 91-3 (step S107-3) and stores it into the betting information storing area in the RAM 83-3.

Subsequently, the server CPU 81-3 executes a JP accumulation processing (step S108-3). In this JP accumulation processing, 0.30% of the total credits which have been bet at all the gaming terminals 4-3 and received in step S107-3 is accumulatively added to a JP amount stored in a “MINI” JP accumulation storing area in the RAM 83-3. In addition, in the JP accumulation processing, 0.20% of the total credits which have been bet at all the gaming terminals 4-3 and received in step S107-3 is accumulatively added to a JP amount stored in A “MAJOR” JP accumulation storing area in the RAM 83-3. Furthermore, in the JP accumulation processing, 0.15% of the total credits which have been bet at all the gaming terminals 4-3 and received in step S107-3 is accumulatively added to a JP amount stored in the “MEGA” JP accumulation storing area in the RAM 83-3. In addition, in the JP accumulation processing, displays in a MEGA counter 73-3, a MAJOR counter 74-3 and a MINI counter 75-3 are updated based on the accumulated JP amounts.

Next, as shown in FIG. 186, the server CPU 81-3 executes a JP bonus game determination processing (step S109-3). In this processing, the server CPU 81-3 determines whether or not to execute a JP bonus game at each of the gaming terminals 4-3 by using random number values sampled by a sampling circuit or the like, which of the gaming terminals 4-3 would win the JP (or all the gaming terminals 4-3 are to lose) in the case where the JP bonus game is to be executed and which JP (“MEGA”, “MAJOR” or “MINI”) is to be awarded in the case where the JP is to be awarded.

Next, the server CPU 81-3 sends a JP bonus game determination result to each of the gaming terminals 4-3 based on the process of step S109-3 (step S110-3). Subsequently, the server CPU 81-3 sends a control command to the CPU 101-3 of the roulette device 2-3 in order for the CPU 101-3 to detect the number pocket 23-3 into which the ball 27-3 has fallen into in the roulette unit 2-3 (step S111-3). Then, the server CPU 81-3 receives a control signal indicating the number pocket 23-3 into which the ball 27-3 has fallen from the CPU 101-3 of the roulette unit 2-3 (step S112-3).

Next, the server CPU 81-3 determines whether or not the bet placed at each of the gaming terminals 4-3 has won based on the betting information of each the gaming terminals 4-3 received in step S107-3 and the control signal indicating the number pocket 23-3 into which the ball 27-3 has fallen received in step S112-3 (step S113-3).

Next, the server CPU 81-3 executes a payout calculation processing (step S114-3). In the payout calculation processing, the server CPU 81-3 firstly specifies credits bet on the winning number for each of the gaming terminal 4-3 and then calculates the total payout credits to be paid out for each of the gaming terminals 4-3 by using odds (a credit amount to be paid out per one chip (one bet)) for each bet area 72-3 which is stored in an odds storing area in the ROM 82-3.

Next, the server CPU 81-3 executes a sending processing of the payout result of credits for a game based on the payout calculation processing of step S113-3 and the JP payout result based on the JP bonus game determination processing of step S109-3 (step S115-3). Specifically, the credit data, which corresponds to the payout credits for the game to the terminal CPU 91-3 of each of the winning gaming terminals 4-3, is output and the credit data, which corresponds to the currently accumulated JP credits, is output in the case where the JP is to be awarded. Next, the server CPU 81-3 sends a request command for collecting the ball 27-3 on the roulette wheel 22-3 to the CPU 101-3 of the roulette unit 2-3 (step S116-3). After the process of step S116-3, this subroutine is terminated.

Next, the gaming processing of the roulette unit 2-3 will be explained based on FIGS. 185 and 186. To begin with, as shown in FIG. 185, the CPU 101-3 receives the control command for staring the operation of the roulette unit 2-3 from the server CPU 81-3 of the server 13-3 (step S201-3).

Subsequently, the CPU 101-3 drives the wheel drive motor 106-3 to spin the roulette wheel 22-3 (step S202-3).

Next, after a prescribed time period has elapsed since the roulette wheel 22-3 starts spinning (YES in step S203-3), the CPU 101-3 launches the ball 27-3 at the time when a launching delay time has elapsed since it receives a detection signal from the pocket position detecting circuit 107-3 (step S204-3).

Next, as shown in FIG. 186, the CPU 101-3 receives the control command for detecting the pocket 23-3 into which the ball 27-3 has fallen from the server CPU 81-3 of the server 13-3 (step S205-3). Next, the CPU 101-3 determines which of the number pocket 23-3 into which the ball 27-3 has fallen by operating the ball sensor 105-3 (step S206-3). And then, the CPU 101-3 sends the detection result indicating the number pocket 23-3 into which the ball 27-3 has fallen to the server CPU 81-3 of the server 13-3 (step S207-3).

Next, the CPU 101-3 receives the request command for collecting the ball 27-3 from the server CPU 81-3 of the server 13-3 (step S208-3). Next, the CPU 101-3 collects the ball 27-3 on the roulette wheel 22-3 by operating the ball collecting unit 108-3 provided beneath the roulette wheel 22-3 (step S209-3). The collected ball 27-3 will be launched onto the roulette wheel 22-3 again by the ball launching unit 104-3 in the next game. After the process of step S209-3, this subroutine is terminated.

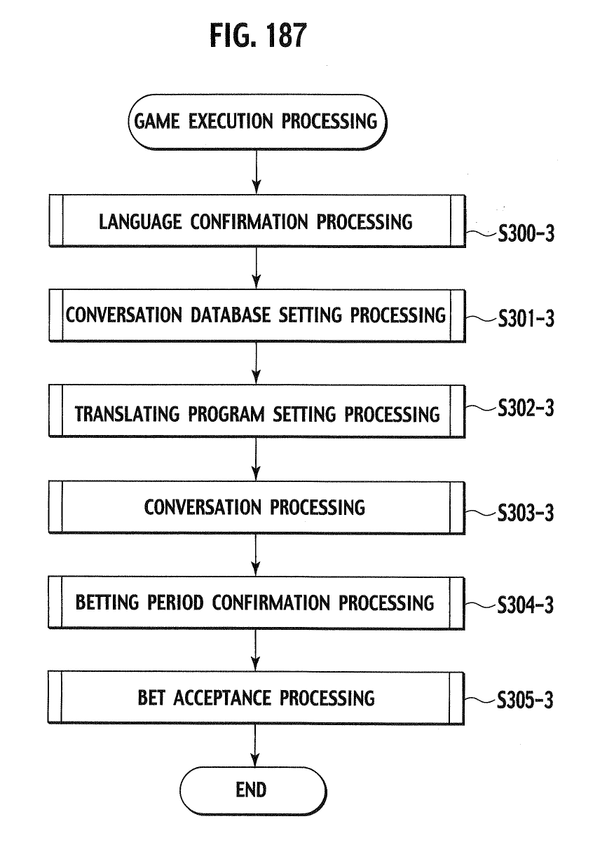

Next, processes executed by the terminal CPU 91-3 of the gaming terminal 4-3 of the roulette gaming machine 1-3 according to the present embodiment in accordance with the programs stored in the ROM 92-3 will be explained with reference to FIGS. 187 to 198.

Here, the flag F in the RAM 93-3 is set to a default value “1” which indicates during the betting period. In addition, a default bet screen 61-3 shown in FIG. 159 is displayed on the display 8-3 of the gaming terminal 4-3. In this state, as shown in FIG. 187, the terminal CPU 91-3 first executes language confirmation processing (step S300-3), then executes conversation database setting processing (step S301-3), then executes translating program setting processing (step S302-3), then executes conversation processing (step S303-3), then executes betting period confirmation processing (step S304-3), and then executes bet acceptance processing (step S305-3).

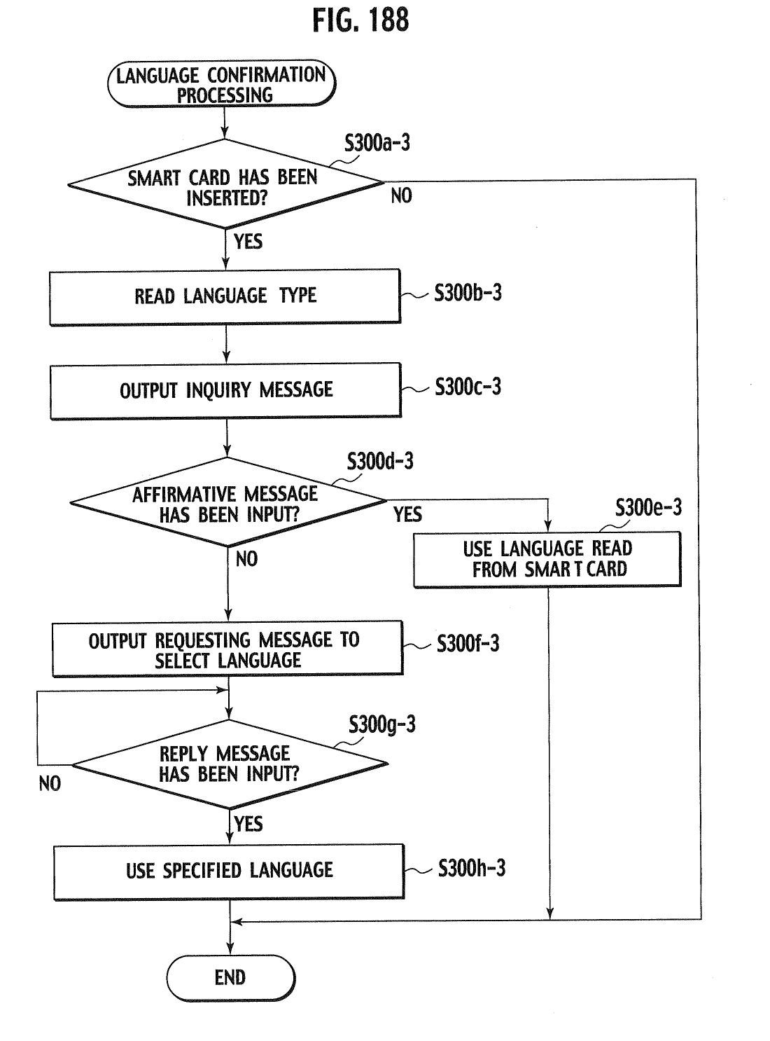

Then, in the language confirmation processing of step S300-3, the terminal CPU 91-3 confirms whether or not a new smart card has been inserted into the card reader 16-3 as shown in FIG. 188 (step S300a-3). If it is not inserted (NO in step S300a-3), the language confirmation processing is terminated. If it is inserted (YES in step S300a-3), the terminal CPU 91-3 reads, from the inserted smart card, a language type used in a game play by a player who possesses the smart card (step S300b-3).

Next, the terminal CPU 91-3 outputs a message inquiring whether or not a game is proceeded in the read-out language type (step S300c-3). The message may be output as sound from the speaker 10-3 via the sound input circuit 98-3, as texts on the display 8-3 via the LCD drive circuit 95-3 and so on.

For example, if the language type read by the card reader 16-3 from the smart card is English and a sound message is to be output from the speaker 10-3, the terminal CPU 91-3 outputs sound “English will be used. Is it all right?”

If the language type read by the card reader 16-3 from the smart card is English, the terminal CPU 91-3 assumes that a sound input “I want to use English. Is it all right?” have been input into the input unit 1100-3 of the conversation controller 1000-3 configured by the microphone 15-3, and outputs the above-mentioned sound from the speaker 10-3 served as the output unit 1600-3 (see FIG. 163) by making the conversation controller 1000-3 to execute corresponding processing.

In addition, if the language type read by the card reader 16-3 from the smart card is English, the terminal CPU 91-3 may output sound “English will be used. Is it all right?” from the speaker 10-3 according to the programs stored in the ROM 92-3 without using the conversation controller 1000-3.

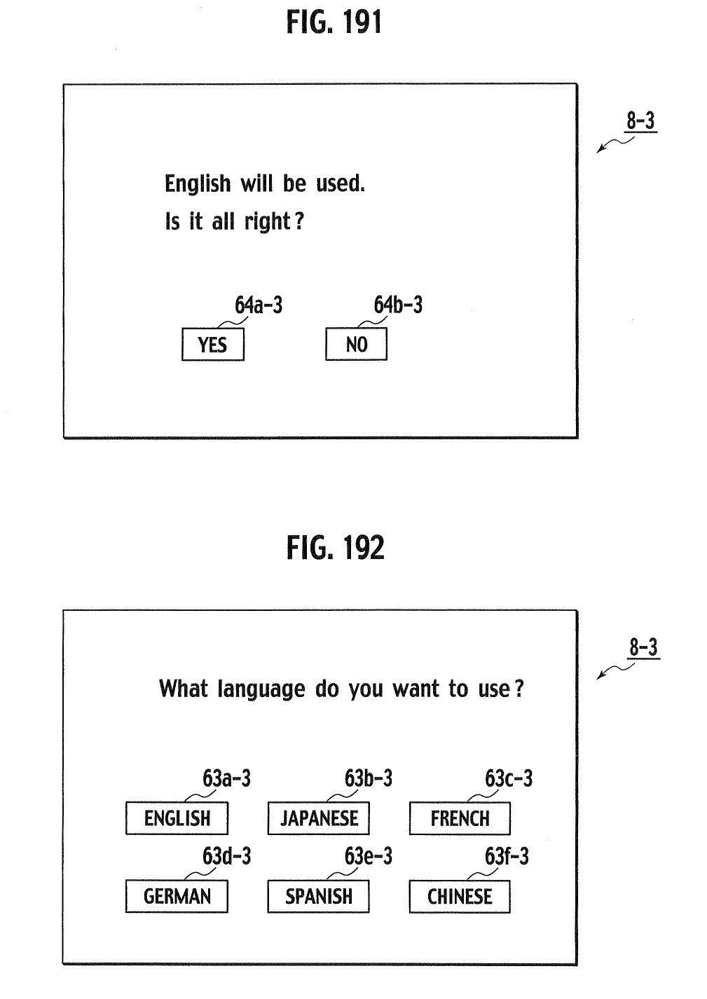

Alternatively, if the language type read by the card reader 16-3 from the smart card is English and a display message is to be output, the terminal CPU 91-3 displays sentences “English will be used. Is it all right?” on the display 8-3 together with “YES” and “NO” buttons 64a-3 and 64b-3 as shown in FIG. 191.

If the language type read by the card reader 16-3 from the smart card is English, the terminal CPU 91-3 assumes that character strings “I want to use English. Is it all right?” have been input into the input unit 1100-3 of the conversation controller 1000-3 configured by the touchscreen 50-3 on the display 8-3, and displays the above-mentioned sentences together with “YES” and “NO” buttons 64a-3 and 64b-3 on the display 8-3 served as the output unit 1600-3 by making the conversation controller 1000-3 to execute corresponding processing.

In addition, if the language type read by the card reader 16-3 from the smart card is English, the terminal CPU 91-3 may display sentences “English will be used. Is it all right?” on the display 8-3 together with “YES” and “NO” buttons 64a-3 and 64b-3 according to the programs stored in the ROM 92-3 without using the conversation controller 1000-3.

Next, the terminal CPU 91-3 determines whether or not an affirmative message has been input in response to the output message in step S300c-3 (step S300d-3).

Here, if the message in step S300c-3 has been output as sound, it can be confirmed whether or not the message has been input in response to the output message by confirming whether or not the input unit 1100-3 of the conversation controller 1000-3 configured by the microphone 15-3 receives an input after the message has been output in step S300c-3. Alternatively, if the message in step S300c-3 has been displayed on the display 8-3 in English as shown in FIG. 191, it can be confirmed whether or not the message has been input in response to the output message by confirming whether or not a player's operation on the “YES” and “NO” buttons 64a-3 and 64b-3 displayed on the display 8-3 has been detected via the touchscreen 50-3.

In addition, it can be confirmed whether or not the input message in response to the output message in step S300c-3 is an affirmative message by analyzing contents of the sound message input into the microphone 15-3 using the conversation controller 1000-3, or detecting which of the “YES” and “NO” buttons 64a-3 and 64b-3 displayed on the display 8-3 as shown in FIG. 191 has been operated by the player.

Then, if an affirmative message has been input (YES in step S300d-3), the terminal CPU 91-3 displays a bet screen 61-3 which is displayed on the display 8-3 during the betting period of the roulette game in the language read by the card reader 16-3 from the smart card (step S300e-3). For example, if the language type read by the card reader 16-3 from the smart card is English, a bet screen 61-3 presented in English as shown in FIG. 159 is displayed on the display 8-3 during the betting period of the roulette game. Subsequently, the terminal CPU 91-3 terminates the language confirmation processing.

On the other hand, if an affirmative message has not been input (NO in step S300d-3), the terminal CPU 91-3 outputs a message for selecting the type of language to be used for proceeding the roulette game (step S300f-3). The message may be output as sound from the speaker 10-3 via the sound output circuit 96-3, or as texts on the display 8-3 via the LCD drive circuit 95-3.

For example, when a sound message is to be output, the terminal CPU 91-3 outputs sound requesting to select the language to be used in a game from the speaker 10-3. For example, if the language type read by the card reader 16-3 from the smart card is English, sound “What language do you want to use?” is output from the speaker 10-3.

The requesting sound to select the language to be used in a game is output from the speaker 10-3 with the language type had been read by the card reader 16-3 from the smart card. If a sound input in the negative has been input to the input unit 1100-3 of the conversation controller 1000-3 configured by the microphone 15-3 in response to the inquiring sound whether or not to proceed the game play in the above-mentioned language, the terminal CPU 91-3 makes the conversation controller 1000-3 to execute corresponding processing and then outputs a processing result thereof from the speaker 10-3 served as the output unit 1600-3.

Alternatively, if a display message is to be output, the terminal CPU 91-3 displays a sentence and buttons for selecting the language to be used in a game on the display 8-3. For example, if the language type read by the card reader 16-3 from the smart card is English, a sentence “What language do you want to use?” is displayed together with language selection buttons 63a-3, 63b-3, 63c-3, 63d-3, 63e-3 and 63f-3, each corresponding to “English”, “Japanese”, “French”, “German”, “Spanish” and “Chinese”, as shown in FIG. 192.

The sentence or the like for selecting the language to be used in a game are displayed on the display 8-3 with the language type read by the card reader 16-3 from the smart card. If an operation on a button indicating a player's rejection (e.g., the “NO” button 64b shown in FIG. 191) has been detected via the touchscreen 50-3, the terminal CPU 91-3 makes the conversation controller 1000-3 to execute corresponding processing and then displays a processing result thereof on the display 8-3 served as the output unit 1600-3.

Then, the terminal CPU 91-3 confirms whether or not a reply message in response to the output message in step S300f-3 has been input (step S300g-3).

Here, if the message in step S300f-3 has been output as sound, it can be confirmed whether or not the message has been input in response to the output by confirming whether or not the input unit 1100-3 of the conversation controller 1000-3 configured by the microphone 15-3 receives an input after the message has been output in step S300e-3. Alternatively, if the message in step S300f-3 has been displayed on the display 8-3, it can be confirmed whether or not the message has been input in response to the output message by confirming whether or not a player's operation on the language selection buttons (e.g., the buttons 63a-3, 63b-3, 63c-3, 63d-3, 63e-3 and 63f-3 each corresponding to “English”, “Japanese”, “French”, “German”, “Spanish” and “Chinese” as shown in FIG. 192) displayed on the display 8-3 has been detected via the touchscreen 50-3.

Then, if a reply message in response to the output message in step S300f-3 has not been input (NO in step S300g-3), the terminal CPU 91-3 repeats step S300g-3 until a reply is input. On the other hand, if a reply message has been input (YES in step S300g-3), the terminal CPU 91-3 displays a bet screen 61-3 on the display 8-3 during the betting period of the roulette game in the language specified by the input message in step S300g-3 (step S300h-3). Subsequently, the terminal CPU 91-3 terminates the language confirmation processing.

Here, if the message has been input as sound in step S300g-3, the language selected by the input message can be specified by analyzing contents of the sound message input into the microphone 15-3 using the conversation controller 1000-3. Alternatively, if the message has been input via a display screen on the display 8-3 in step S300g-3, the language selected by the input message can be specified by detecting contents of a player's operation onto the language selection buttons displayed on the display 8-3 by the terminal CPU 91-3 via the touchscreen 50-3.

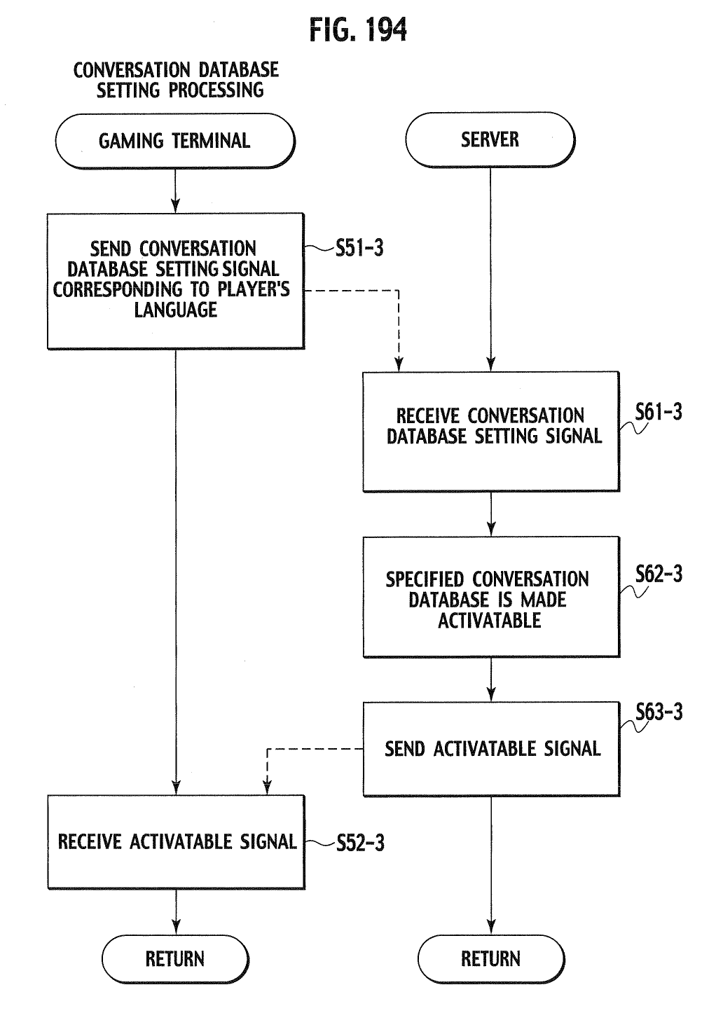

Next, the conversation database setting processing of step S301-3 in FIG. 187 will be explained with reference to a flow chart shown in FIG. 194.

The terminal CPU 91-3 of the gaming terminal 4-3 sends a signal for setting the conversation database corresponding to the player's language (e.g., Japanese) to the server 13-3 via the network based on the player's language determined in the language confirmation processing (step S51-3).

The server CPU 81-3 (see FIG. 160) of the server 13-3 receives the conversation database setting signal transmitted from the gaming terminal 4-3 (step S61-3) and makes a conversation database corresponding to the specified language activatable among the conversation database corresponding to plural languages in the HDD 34-3 (step S62-3).

Subsequently, the server CPU 81-3 sends an activatable signal indicating that the conversation database is being activatable to the gaming terminal 4-3 (step S63-3). The gaming terminal 4-3 receives the activatable signal (step S52-3). As a result, the conversation database corresponding to the player's language is made available in the gaming terminal 4-3 and the conversational processing using the conversation engine is made available.

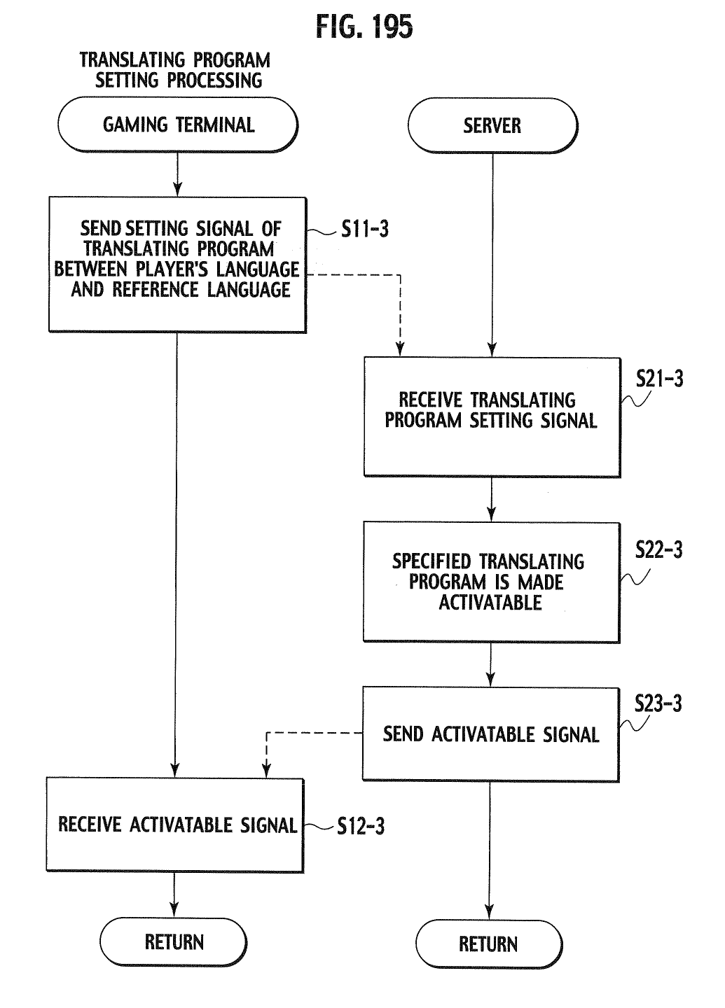

Next, the translating program setting processing of step S302-3 in FIG. 187 will be described with reference to a flow chart shown in FIG. 195.

The terminal CPU 91-3 of the gaming terminal 4-3 sends a setting signal of the translating program between the player's language (e.g., Japanese) and the reference language (e.g., English) to the server 13-3 via the network based on the player's language determined in the language confirmation processing (step S11-3).

The server CPU 81-3 (see FIG. 160) of the server 13-3 receives the translating program setting signal transmitted from the gaming terminal 4-3 (step S21-3) and makes a specified translating program (e.g., a “Japanese-English” translating program) activatable among translating programs corresponding to plural languages in the HDD 34-3 (step S22-3).

Subsequently, the server CPU 81-3 sends an activatable signal indicating that the translating program is being activatable to the gaming terminal 4-3 (step S23-3). The gaming terminal 4-3 receives the activatable signal (step S12-3). As a result, the translating program for translating the player's language into the reference language is made available in the gaming terminal 4-3.

Then, conversations using the conversation engine corresponding to the player's language are made available by the above-mentioned conversation database setting processing being executed. Therefore, since conversations using the language of the player playing at each of the gaming terminals 4-3 are enabled, games can be processed smoothly. Furthermore, messages for each player can be translated into the player's language and displayed on the display 8-3 by the above-mentioned translating program setting processing being executed. Therefore, it becomes easier for the player to understand message contents.

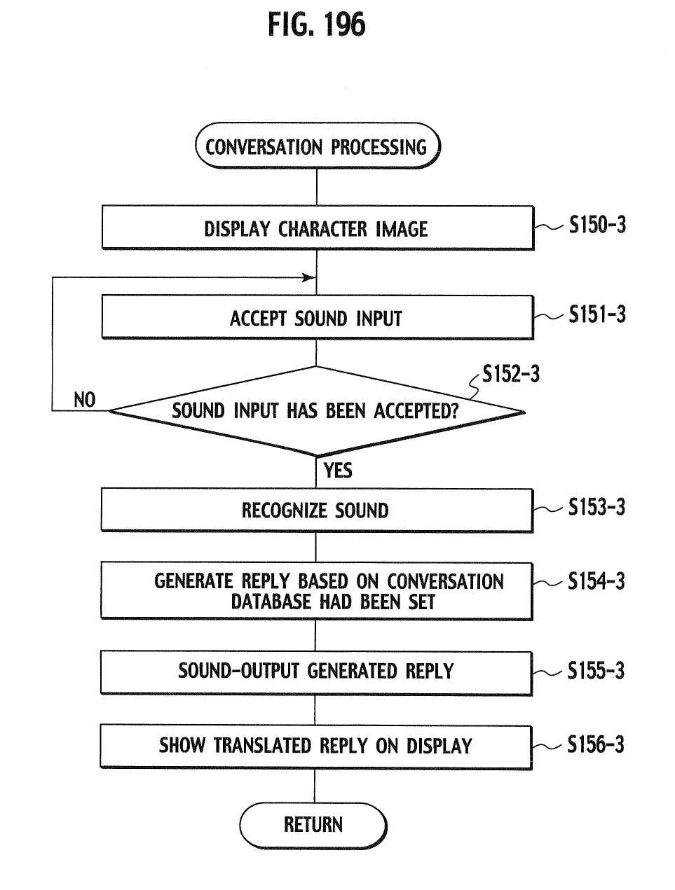

Next, the conversation processing in FIG. 187 will be explained with reference to a flow chart shown in FIG. 196.

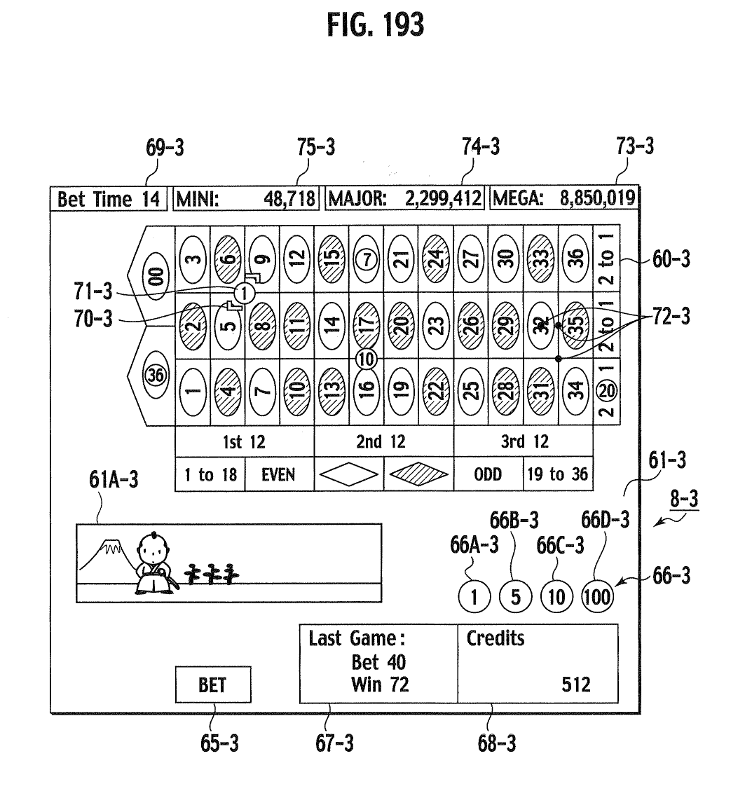

First, the terminal CPU 91-3 reads out a character image corresponding to the player's language had set in the language confirmation processing from the image memory 77-3 shown in FIG. 162 and displays it in a display area 61A-3 (see FIG. 193) on the display 8-3 (step S150-3). For example, if the player's language is Japanese, a character image which looks like a Japanese is selected. If the player's language is Chinese, a character image which looks like a Chinese is selected. If the player's language is Arabic, a character image which looks like an Arabic is selected.

Subsequently, the terminal CPU 91-3 actuates the microphone 15-3 to accept a sound input by the player's utterance (step S151-3).

If the sound input has been accepted (YES in step S152-3), the terminal CPU 91-3 recognizes the sound input (step S153-3).

And then, the terminal CPU 91-3 generates a reply to the sound input using the conversation database had been set and the conversation engine (step S154-3).

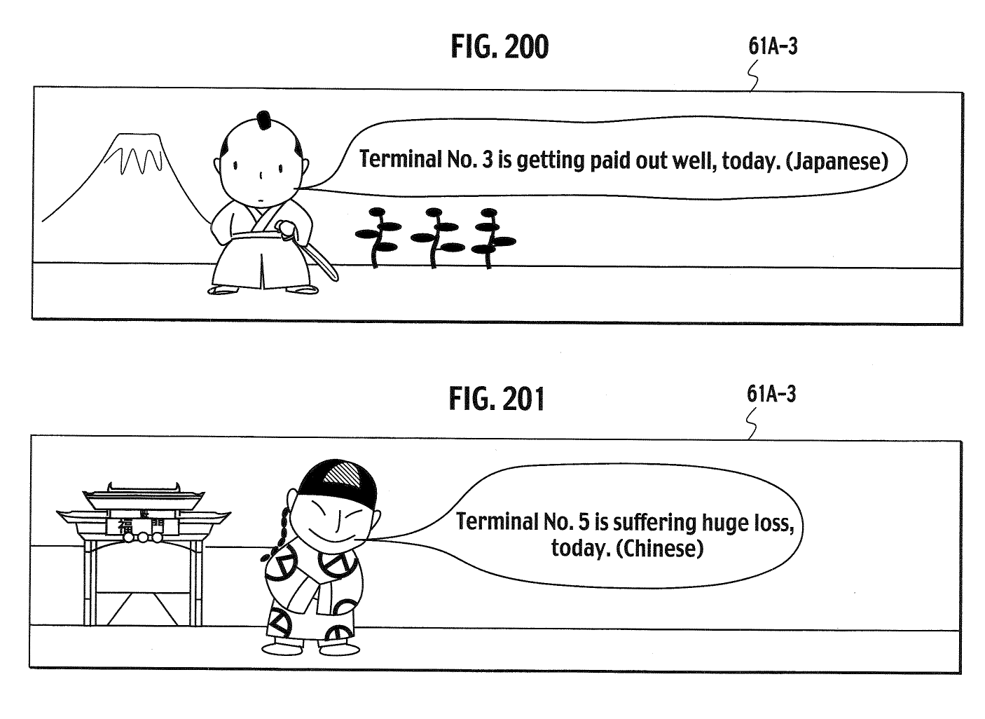

For example, in case where the player's language is Japanese and an utterance “How are you feeling today?” has been made in Japanese, a reply “Terminal No. 3 is getting paid out well, today.” or the like is generated in Japanese to the utterance and then output from the speaker 10-3 (step S155-3). Furthermore, the character image which looks like a Japanese and a Japanese sentence “Terminal No. 3 is getting paid out well, today.” are displayed in the display area 61A-3 on the display 8-3 as shown in FIG. 200.

In addition, in case where the player's language is Chinese and an utterance “How are you feeling today?” has been made in Chinese, a reply “Terminal No. 5 is suffering huge loss, today.” or the like is generated in Chinese to the utterance and then output from the speaker 10-3. Furthermore, the character image which looks like a Chinese and a Chinese sentence “Terminal No. 5 is suffering huge loss, today.” are displayed in the display area 61A-3 on the display 8-3 as shown in FIG. 201.

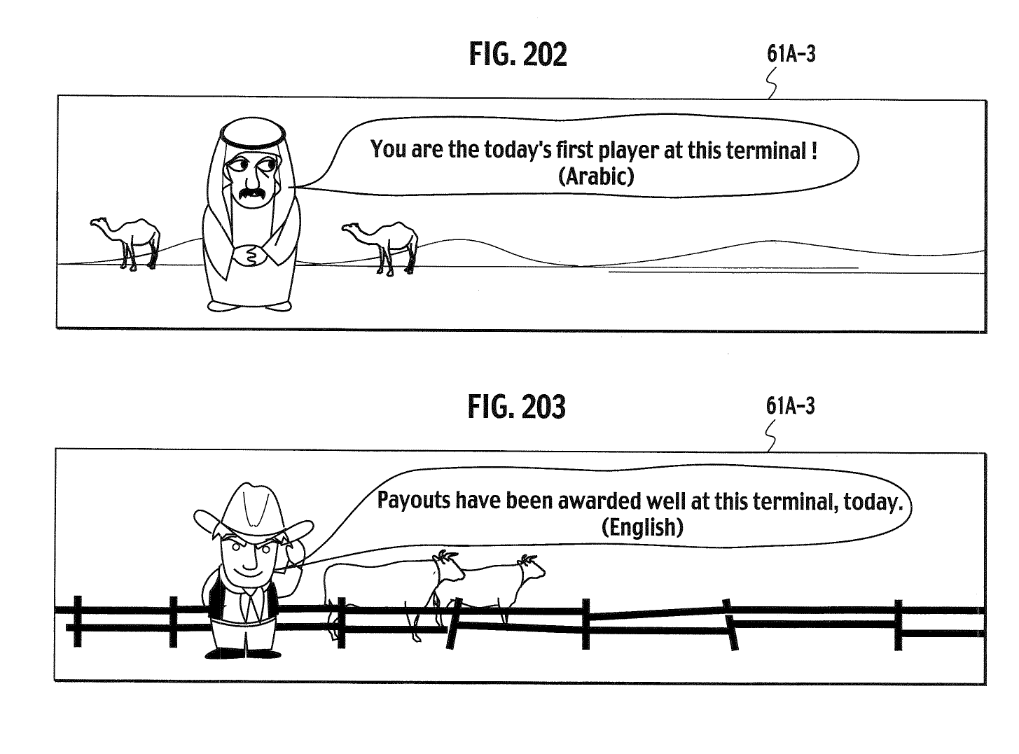

Furthermore, in case where the player's language is Arabic and an utterance “How are you feeling today?” has been made in Arabic, a reply “You are the today's first player at this terminal!” or the like is generated in Arabic to the utterance and then output from the speaker 10-3. Furthermore, the character image which looks like an Arabic and an Arabic sentence “You are the today's first player at this terminal!” are displayed in the display area 61A on the display 8-3 as shown in FIG. 202.

In addition, in case where the player's language is English and an utterance “How are you feeling today?” has been made in English, a reply “Payouts have been awarded well at this terminal, today.” or the like is generated in English to the utterance and then output from the speaker 10-3. Furthermore, the character image which looks like an English and an English sentence “Payouts have been awarded well at this terminal, today.” are displayed in the display area 61A-3 on the display 8-3 as shown in FIG. 203.

In this manner, a character corresponding to the player's language and a reply are displayed in the display area 61A-3. Specifically, a message notified to the player is displayed in the display area 61A-3 on the display 8-3 in a display form of an utterance by the character. Therefore, the player can see as if the character talked to the player.

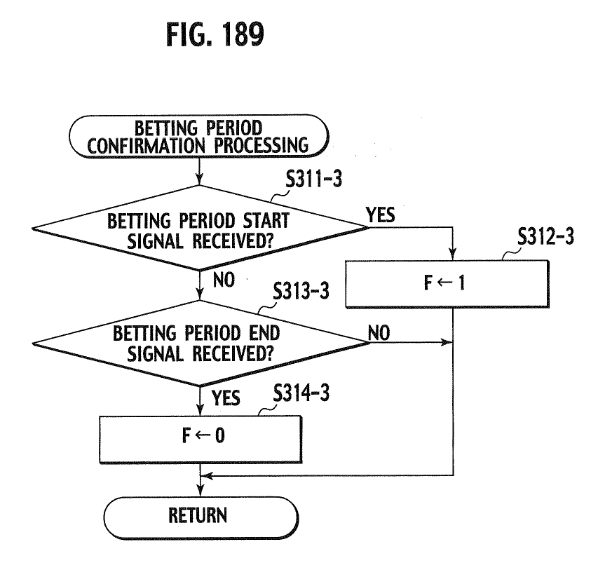

Next, the betting period confirmation processing of step S304-3 in FIG. 187 will be explained with reference to a flow chart shown in FIG. 189. As shown in FIG. 189, the terminal CPU 91-3 confirms whether or not the betting period start signal has been received from the server CPU 81-3 (step S311-3). If the betting period start signal has been received (YES in step S311-3), the terminal CPU 91-3 sets the flag F in the RAM 93-3 to “1” which indicates that it is under the betting period (step S312-3) and then terminates the betting period confirmation processing.

On the other hand, if the betting time start signal has not been received (NO in step S311-3), the terminal CPU 91-3 confirms whether or not the betting period end signal has been received from the server CPU 81-3 (step S313-3). If the betting period end signal has been received (YES in step S313-3), the terminal CPU 91-3 sets the flag F in the RAM 93-3 to “0” which indicates that it is not under the betting period (step S314-3) and then terminates the betting period confirmation processing. If the betting period end signal has not been received (NO in step S313-3), the terminal CPU 91-3 terminates the betting period confirmation processing.

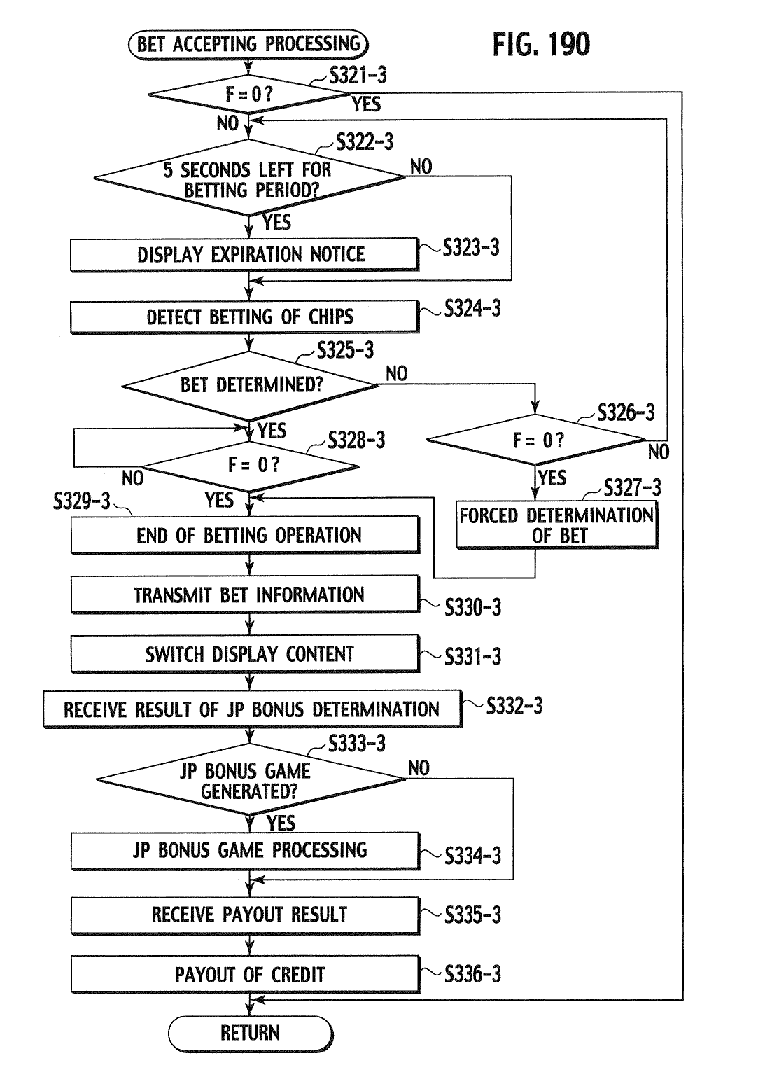

Next, in the bet accepting processing of step S305-3 in FIG. 187, as shown in FIG. 190, the terminal CPU 91-3 confirms whether or not the flag F in the RAM 93-3 is set to “0” (step S321-3). If the flag F is set to “0” (YES in step S321-3), the terminal CPU 91-3 terminates the bet accepting processing.

On the other hand, if the flag F is not set to “0” (NO in step S321-3), the terminal CPU 91-3 accepts a bet by a player. In this case, the terminal CPU 91-3 outputs a sound message “Bet acceptance starts.” from the speaker 10-3 using the conversation engine and the translating program. Specifically, the terminal CPU 91-3 sends a message data “Bet acceptance starts.” in the reference language (e.g., English) to the server 13-3 shown in FIG. 160. The server CPU 81-3 translates the message data into the player's language (e.g., Japanese) using the translating program (e.g., a “Japanese-English” translating program) stored in the HDD 34-3 and sends back the translated data to the gaming terminal 4-3. Then, the terminal CPU 91-3 receives the translated data and converts the translated data into sound data using the conversation engine to outputs from the speaker 10-3. Therefore, the message “Bet acceptance starts.” is output from the speaker in the player's language (e.g., Japanese).

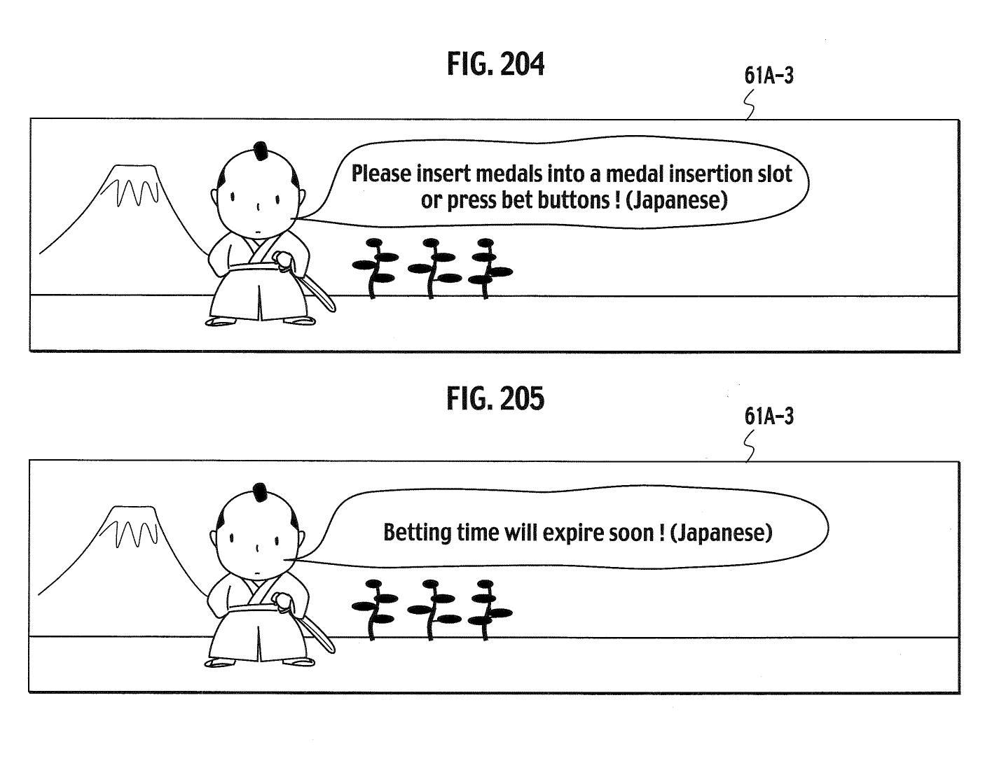

In addition, for example, if a player utters “Tell me how to bet!” into the microphone 15-3 in Japanese, the conversation engine analyzes this utterance using the Japanese conversation database and outputs a reply “Please insert medals into a medal insertion slot or press bet buttons.” in Japanese from the speaker 10-3. Alternatively, a character which looks like a Japanese and a Japanese sentence “Please insert medals into a medal insertion slot or press bet buttons.” are displayed in the display area 61A on the display 8-3 as shown in FIG. 204.

Next, the terminal CPU 91-3 confirms whether or not the remaining betting period has reached the last five seconds with the remaining time displayed on the bet time counter 69-3 being “5” (step S322-3). If the remaining time has reached the last 5 seconds (YES in step S322-3), the terminal CPU 91-3 displays a message to preannounce the end of the betting period on the bet screen 61-3 (step S323-3). Simultaneously, a sound message “Five seconds left for bets.” is output from the speaker 10-3 in the player's language. For example, if the player's language is Japanese, a Japanese sentence “Betting time will expire soon.” shown in FIG. 205 is displayed together with a character image in the bet screen 61-3 on the display 8-3.

On the other hand, if the remaining time has not reached the last five seconds (it remains more than five seconds) (NO in step S322-3), the terminal CPU 91-3 proceeds to the step S324-3.

The terminal CPU 91-3 detects a bet placed by a player (step S324-3). A chip betting is detected by the player's touching on the bet area 72-3 in the betting board 60-3 or on the bet buttons 66-3 via the touchscreen 50-3. In addition, a bet can be accepted by way of a player's utterance into the microphone 15-3 and recognition of this utterance by the conversation engine. For example, a player makes an utterance “I will bet fifty credits.” after having selected a desired bet area 72-3 on the touchscreen 50-3. As a result, the utterance is detected via the microphone 15-3 and its sound data are analyzed by the conversation engine, and thereby a fifty-credit bet is confirmed. Furthermore, a reply “Fifty credits have been bet!” is output from the speaker 10-3. After a bet with a chip(s) has been detected, a chip mark 71-3 with an amount of the bet chip(s) is displayed on a specified bet area 72-3 on the display 8-3.

Next, the terminal CPU 91-3 confirms whether or not the player's bet has been confirmed (step S325-3). The betting confirmation is detected by the player's touching on the bet confirmation button 65-3 on the display 8-3 via the touchscreen 50-3.

If it is confirmed that the player's bet has not been confirmed (NO in step S325-3), the terminal CPU 91-3 confirms whether or not the flag F in the RAM 93-3 is set to “0” (step S326-3). If the flag F is not set to “0” (NO in step S326-3), the terminal CPU 91-3 returns the processing to step S322-3.

On the other hand, if the flag F is set to “0” (YES in step S326-3), the terminal CPU 91-3 fixes the player's bet forcibly (step S327-3) and then sifts the processing to after-mentioned step 329-3.

Alternatively, if it is confirmed that the player's bet has been confirmed (YES in step S325-3), the terminal CPU 91-3 confirms whether or not the flag F in the RAM 93-3 is set to “0” or not (step S328-3). If the flag F is not set to “0” (NO in step S328-3), the terminal CPU 91-3 repeats step S328-3. On the contrary, if the flag F in the RAM 93-3 is set to “0” (YES in step S328-3), the terminal CPU 91-3 proceeds to step S329-3.

The terminal CPU 91-3 closes acceptation of betting operations via the touchscreen 50-3 (step S329-3). Thereafter, the terminal CPU 91-3 sends the player's betting information (the specified bet area 72-3, the number of bet chips (bet amount)) of the gaming terminal 4-3 to the server CPU 81-3 (step S330-3).

Next, the terminal CPU 91-3 changes the screen image on the display 8-3 (step S331-3). Specifically, the terminal CPU 91-3 firstly switches the screen image on the display 8-3 to the bet screen 61-3 including an indication of the betting period expiry.

Thereafter, the terminal CPU 91-3 receives the result of the JP bonus game determination processing executed by the server CPU 81-3 from the server CPU 81-3 (step S332-3). The result of the JP bonus game determination includes the information which indicates: whether or not to execute the JP bonus game at any of the gaming terminals 4-3; which of the nine gaming terminals 4-3 is to win the JP (or all of the gaming terminals 4-3 are to lose) in the case where it is determined to execute the JP bonus game; and which JP (“MEGA”, “MAJOR” or “MINI”) is to be awarded in the case of the JP winning.

Next, the terminal CPU 91-3 determines whether or not to execute the JP bonus game based on the result of the JP bonus game determination processing received in step S332-3 (step S333-3). In the case where it is determined to execute the JP bonus game in the gaming terminal 4-3, the terminal CPU 91-3 executes a prescribed selection-type JP bonus game. And then, the terminal CPU 91-3 displays the bonus game result (whether or not the JP has been awarded) in the bet screen 61-3 on the display 8-3 (step S334-3) based on the determination result received in step S332-3.

In the case where it is determined not to execute the JP bonus game in the gaming terminal 4-3 in step S333-3, or after the processing in step S334-3, the terminal CPU 91-3 receives the payout result of credits from the server CPU 81-3 (step S335-3). Note that the payout result of credits includes the payout result for the game and the JP payout result for the JP bonus game. Here, in case of the payout of five hundred medals to be awarded for example, the terminal CPU 91-3 will output a sound message “Five hundred medals is awarded” from the speaker 10-3 in the player's language (for example, in Japanese).

Next, the terminal CPU 91-3 awards a payout according to the payout result received in step S335-3 (step S336-3). Specifically, the terminal CPU 91-3 stores, in the RAM 93-3, the credit data corresponding to the payout for the game and the credit data corresponding to the currently accumulated JP credits if the JP is awarded in the gaming terminal 4-3. Then, when the payout button 5-3 has been touched, medals corresponding to the credits stored in the RAM 93-3 (usually, one medal per one credit) are paid out from the medal payout chute 12-3. Thereafter, the terminal CPU 91-3 terminates the bet accepting processing.

It is obvious from the above-mentioned description that the controller of the present invention is configured by the terminal CPU 91-3 in the roulette gaming machine 1-3 of the fifth embodiment.

In this manner, a player's language is confirmed by the conversation engine and a conversation with a player is done in the language in the gaming system according to the fifth embodiment. A character corresponding to the player's language is displayed and a message(s) provided to the player is also displayed in a display form of an utterance by the character. Therefore, the player can have a sense of affinity.

In addition, since the character image is shown on the display 8-3, the player's language used at the gaming terminal 4-3 can be understood intuitively when someone except the player see the display 8-3.

### Sixth Embodiment

Next, the sixth embodiment of the game execution processing will be explained. In the sixth embodiment, conversation data of the conversation database corresponding to the player's language are transmitted to the gaming terminal 4-3 among the conversation database corresponding to plural languages stored in the HDD 34-3 of the server 13-3. In addition, the translating program to be used is transmitted to the gaming terminal 4-3 among plural translating programs stored in the HDD 34-3. Then, the gaming terminal 4-3 downloads the conversation data and the translating program that have been transmitted to the second external storage unit 76-3. The terminal CPU 91-3 of the gaming terminal 4-3 executes a roulette game with the conversation data and the translating program that have been downloaded.

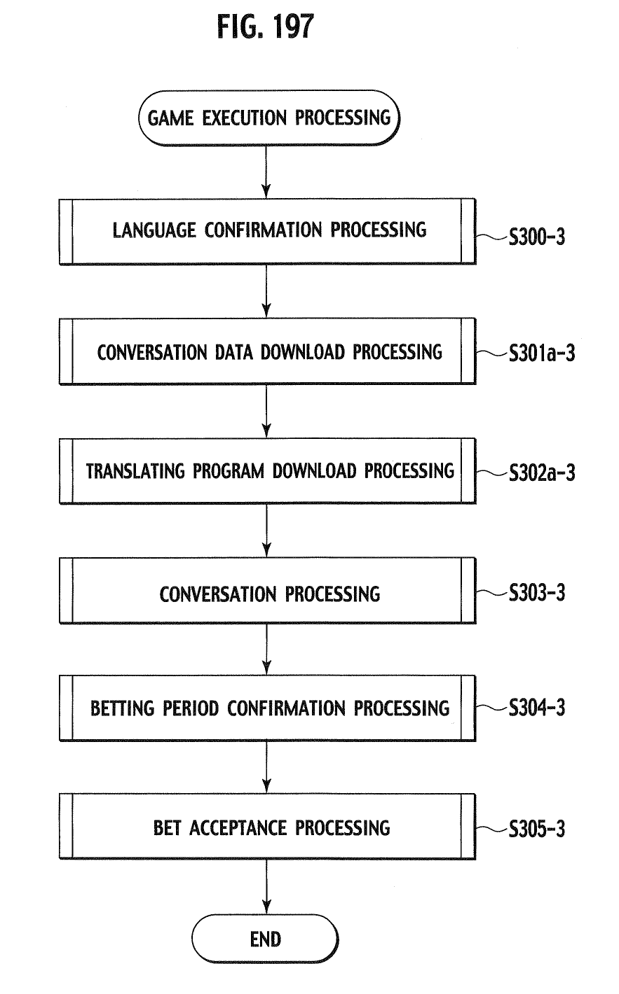

Hereinafter, the game execution processing according to the sixth embodiment will be explained with reference to a flow chart shown in FIG. 197. As shown in FIG. 197, the terminal CPU 91-3 first executes the language identifying processing (step S300-3), then executes conversation data download processing (step S301a-3), then executes translating program download processing (step S302a-3), then executes conversation processing (step S303-3), then executes the betting period confirmation processing (step S304-3), and then executes the bet acceptance processing (step S305-3).

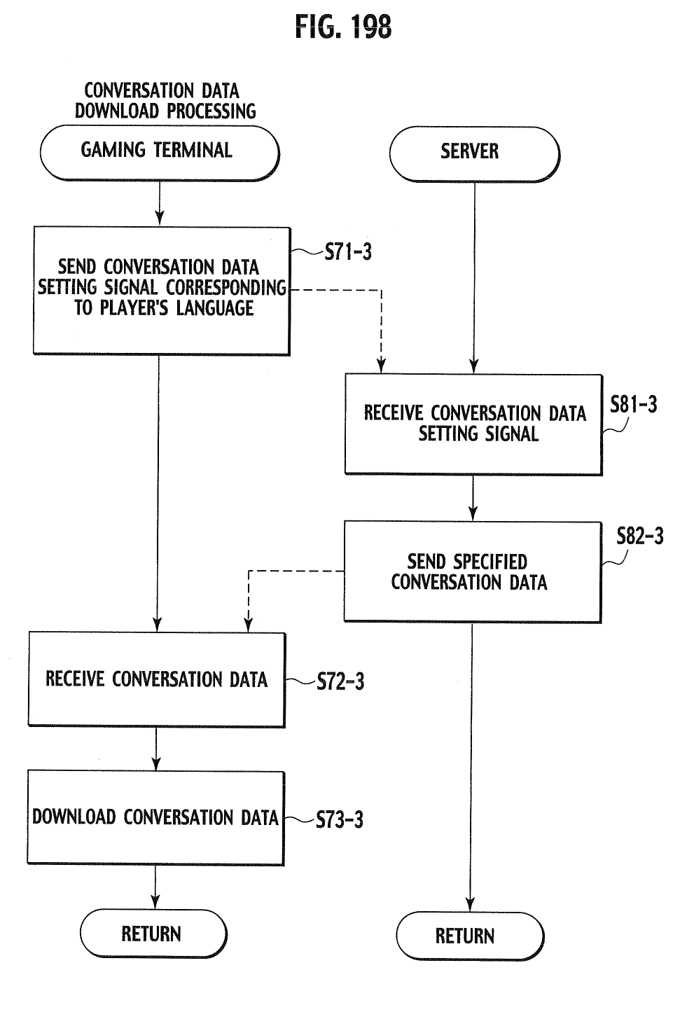

Since the language confirmation processing of step S300-3, the betting period confirmation processing of step S304-3 and the bet acceptance processing of step S305-3 are similar to those of the above-described fifth embodiment, their description is omitted. Hereinafter, the conversation data download processing of step S301a-3 will be explained with reference to a flow chart shown in FIG. 198.

The terminal CPU 91-3 of the gaming terminal 4-3 sends a conversation data setting signal corresponding to the player's language (e.g., Japanese) to the server 13-3 via the network based on the player's language determined in the language confirmation processing (step S71-3).

The server CPU 81-3 (see FIG. 160) of the server 13-3 receives the conversation data setting signal transmitted from the gaming terminal 4-3 (step S81-3) and then acquires the conversation data of the specified conversation database among conversation database corresponding to plural languages in the HDD 34-3 to send it to the gaming terminal 4-3 via the network (step S82-3).

The gaming terminal 4-3 receives the conversation data (step S72-3). Furthermore, the gaming terminal 4-3 downloads the received conversation data to the second external storage unit 76-3 (step S73-3).

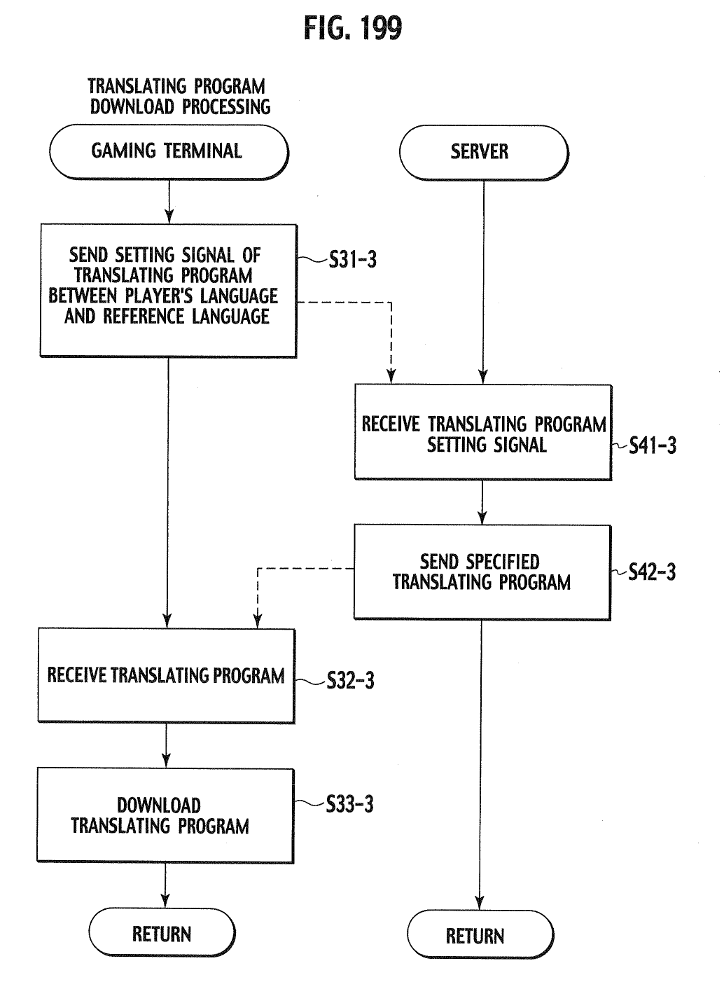

Next, the translating program download processing of step S302a-3 in FIG. 197 will be explained with reference to a flow chart shown in FIG. 199.

The terminal CPU 91-3 of the gaming terminal 4-3 sends a setting signal of the translating program between the player's language (e.g., Japanese) and the reference language (e.g., English) to the server 13-3 via the network based on the player's language determined in the language confirmation processing (step S31-3).

The server CPU 81-3 (see FIG. 160) of the server 13-3 receives the translating program setting signal transmitted from the gaming terminal 4-3 (step S41-3) and reads out the specified translating program (e.g., a “Japanese-English” translating program) among plural translating programs in the HDD 34-3 to send it to the gaming terminal 4-3 via the network (step S42-3).

The gaming terminal 4-3 receives the translating program (step S32-3). Furthermore, the gaming terminal 4-3 downloads the received translating program to the second external storage unit 76-3 (step S33-3).

In this manner, since the conversation data used in the conversation engine is downloaded to the second external storage unit 76-3, a conversation with the player using this conversation data can be done. Furthermore, since the translating program to be used for notifying a message to a player is similarly downloaded to the second external storage unit 76-3, the message to be notified to the player can be translated into the player's language to be displayed.

As described above, in the gaming system according to the sixth embodiment, the conversation data used in the conversation engine and the translating program used at the gaming terminal 4-3 are downloaded in the second external storage unit 76-3 and then utilized. According to this configuration, similarly to the above-described fifth embodiment, a player can hear a sound message output in his/her language and can play a game through an utterance(s) in his/her language. Furthermore, since a character image corresponding to the player's language is shown on the display 8-3, someone except the player can understand the player's language intuitively.

Although the embodiments of the present invention have been described hereinabove, the embodiments are only showing specific examples, and do not particularly limit the present invention. Accordingly, the specific configuration of each means or the like can be modified in design appropriately. In addition, the effects described in the embodiments of the present invention are only listing the most preferable effects that can arise from the present invention. For this reason, the effects produced by the present invention are not limited to those described in the embodiments of the present invention.

For example, some of the foregoing embodiments have been described by taking the roulette game machine as one example. However, the present invention is also applicable to other gaming machines for games such as a bingo game and a slot game, for example.

In addition, in the foregoing detail description, the characteristic portions of the present invention have been mainly described in order to make the present invention easily understandable. The present invention is not limited to the embodiments described above in the foregoing detail description, and can be applied to other embodiments, and its applicable range is wide. Moreover, the terms and the terminology used in the present specification are used for the purpose of precisely explaining the present invention, and not used for the purpose of limiting interpretations of the present invention. Further, it should be easy for those skilled in the art to contemplate other configurations, systems, methods, etc., which are included in the concept of the present invention, from the concept of the present invention described in the present specification. For this reason, the description of the appended claims must be construed as containing equivalent configurations within a range of not departing from a range of the technical ideas of the present invention. Moreover, the abstract aims to allow the Patent Office, general public office, and engineers who are not familiar with a patent, legal terms and technical terms, and who pertain to the technical field of the present invention, to quickly judge the technical content and essence of the present application with a simple study. Accordingly, the abstract is not intended to limit the scope of the invention that should be assessed from the description of the appended claims. Furthermore, it is desirable that the present invention be interpreted by fully taking already-disclosed literatures and the like into consideration in order to fully understand the object of the present invention and unique effects of the present invention.

The forgoing detail descriptions include the processing executed by the computer. The above descriptions and expressions are described in order for those skilled in the art to understand the present invention in the most efficiently. In this specification, each step used for deriving one result should be understood as a processing without a self-contradiction. Moreover, in each step, a transmission, reception, storage, etc., of an electric or magnetic signal is performed. A bit, value, symbol, letter, term, number and the like are used to express such signals in the processing in each step, but it should be noted that these are simply used to make the explanation easy. In addition, the processing at each step is sometimes described in an expression in common with human activities, but the processings described in this specification are principally executed by various types of devices. Furthermore, another configuration required for executing each step is obvious from the foregoing descriptions.

What is claimed is:

1. A gaming machine comprising:
an output unit configured to output a conversation sentence to a player;
an input unit configured to enable the player to input a response sentence to the conversation sentence outputted from the output unit;
a conversation engine configured to create data on the conversation sentence to be outputted from the output unit and to analyze data on the response sentence inputted to the input unit;
a display configured to display a menu screen showing a menu of an item orderable by the player through the gaming machine;
a memory configured to store menu data indicating a content of the menu in each of a plurality of language types usable for play on the gaming machine; and
a controller configured to
(a) cause the conversation engine to create data on the conversation sentence to inquire a language type to be used for play on the gaming machine,
(b) judge whether or not the language type to be used for play on the gaming machine is designated in the response sentence of the data analyzed by the conversation engine,
(c) upon the language type to be used for play on the gaming machine being designated in the response sentence of the data analyzed by the conversation engine, then judge whether or not the response sentence using the designated language type and having the data analyzed by the conversation engine includes a request to display the menu on the display,
(d) upon the response sentence using the designated language type and having the data analyzed by the conversation engine including the request to display the menu on the display, then display the menu screen showing the menu of the designated language type on the display by using the menu data of the designated language type, and
(e) output order data to a server at an order destination connected through a communication line, the order data representing, in a predetermined language type, a content of an order of the item expressed in the designated language type, the order having been placed by the player while the menu screen in the designated language type is displayed on the display.

2. The gaming machine according to claim 1, wherein, the controller is configured to,
upon the order of the item designated as an order candidate being confirmed by the player, output to the server the order data on the content of the item of the confirmed order,
collect a payment for the item ordered in the designated language type, from credits digitalized and accumulated in the gaming machine for making bets on repeatedly executed unit games, and
prohibit the credits equivalent to the payment for the item designated as the order candidate by the player from being used for making bet on the unit game.

3. The gaming machine according to claim 1, wherein the controller is configured to
collect a payment for the item ordered in the designated language type, from credits digitalized and accumulated in the gaming machine for making bets on repeatedly executed unit games, and
suspend acceptance of a bet of the accumulated credits on the unit game while the menu screen in the designated language type is displayed on the display.

4. The gaming machine according to claim 1, wherein the controller is configured to
collect a payment for the item ordered in the designated language type, from credits digitalized and accumulated in the gaming machine for making bets on repeatedly executed unit games, and
display, on the display in the designated language type, the menu screen having the content only including the item with a price payable from the accumulated credits.

5. A method of playing a gaming machine comprising:
(a) causing a conversation engine to create data on a conversation sentence to inquire a language type to be used for play on the gaming machine;
(b) outputting the conversation sentence to inquire the language type to be used for play on the gaming machine from an output unit by using the data created by the conversation engine;
(c) enabling a player to input, to an input unit, a response sentence to designate the language type to be used for play on the gaming machine;
(d) causing the conversation engine to analyze data on the response sentence having been inputted to the input unit by the player and outputted from the output unit to respond the conversation sentence;
(e) judging whether or not the language type to be used for play on the gaming machine is designated in the response sentence of the data analyzed by the conversation engine;
(f) upon the language type to be used for play on the gaming machine being designated in the response sentence of the data analyzed by the conversation engine, then judging whether or not the response sentence using the designated language type and having the data analyzed by the conversation engine includes a request to display a menu of an item orderable by the player through the gaming machine on the display;
(g) upon the response sentence using the designated language type and having the data analyzed by the conversation engine including the request to display the menu on the display, then displaying a menu screen showing the menu of the designated language type on the display by using menu data indicating a content of the menu stored in a memory in each of a plurality of language types usable for play on the gaming machine;
(h) enabling the player to order the item in the designated language while the menu screen in the designated language type is displayed on the display, and
(i) outputting order data to a server at an order destination connected through a communication line, the order data representing, in a predetermined language type, a content of an order of the item expressed in the designated language type, the order having been placed by the player while the menu screen in the designated language type is displayed on the display.

6. A gaming machine comprising:
an output unit configured to output a conversation sentence to a player;
an input unit configured to enable the player to input a response sentence to the conversation sentence outputted from the output unit;
a conversation engine configured to create data on the conversation sentence to be outputted from the output unit and to analyze data on the response sentence inputted to the input unit;
a memory configured to store menu data indicating a plurality of items orderable by the player through the gaming machine and classifications of the items in a hierarchical structure in each of a plurality of language types usable for play on the gaming machine; and
a controller configured to:
(a) cause the conversation engine to create data on a conversation sentence inquiring a language type to be used for play on the gaming machine;
(b) upon the language type to be used for play on the gaming machine being designated in the response sentence having the data analyzed by the conversation engine, then judge whether or not the response sentence using the designated language type and having the data analyzed by the conversation engine includes a request to order the item;
(c) upon the response sentence using the designated language type and having the data analyzed by the conversation engine including the request to order the item, specify the classification designated by the requested order of the item;
(d) cause the conversation engine to create data on a conversation sentence presenting one or more classifications or items at a lower rank than the first specified classification by using the designated language type, by using the menu data of the designated language type;
(e) upon the response sentence using the designated language type and having the data analyzed by the conversation engine designating any of the classifications at the lower rank than the first specified classification, cause the conversation engine to create data on the conversation sentence presenting one or more classifications or items at a lower rank than the second specified classification by using the designated language type; and
(f) upon the response sentence using the designated language type and having the data analyzed by the conversation engine designating the item, output order data representing the designated item of the designated language type in a predetermined language type, to a server at an order destination connected through a communication line.

7. The gaming machine according to claim 1, wherein the controller is configured to,
upon the response sentence using the designated language type and having the data analyzed by the conversation engine designating the item as an order candidate, cause the conversation engine to create data on a conversation sentence using the designated language and requesting an approval of any of confirmation and cancellation of the order of the item placed in the designated language and designated as the order candidate,
upon the confirmation of the order of the item designated as the order candidate being approved in the response sentence using the designated language type and having the data analyzed by the conversation engine, output to the server the order data representing, in the predetermined language type, the approved item of the designated language type as the designated item of the designated language type,
collect a payment for the approved item of the designated language type from credits digitalized and accumulated in the gaming machine for making bets on repeatedly executed unit games, and
upon the response sentence using the designated language type and having the data analyzed by the conversation engine designating the item as the order candidate, prohibit the credits equivalent to the payment for the item designated as the order candidate, from being used for making a bet on the unit game.

8. The gaming machine according to claim 1, wherein the controller is configured to
collect a payment for the designated item of the designated language type from credits digitalized and accumulated in the gaming machine for making bets on repeatedly executed unit games, and
suspend acceptance of a bet of the accumulated credits on the unit game during a period from the request of the order of the item in the response sentence using the designated language type to the output of the order data to the server.

9. The gaming machine according to claim 1, wherein the controller is configured to
collect a payment for the designated item of the designated language type from credits digitalized and accumulated in the gaming machine for making bets on repeatedly executed unit games, and
limit a content of one or more items presented by using the designated language type and each located at the lower rank than the specified classification to the item with a price payable from the accumulated credits, for the conversation sentence generated by causing the conversation engine to create data by using the menu data of the designated language type.

10. A method of playing a gaming machine comprising:
(a) causing a conversation engine to create data on a conversation sentence inquiring a language type to be used for play on the gaming machine;
(b) outputting the conversation sentence inquiring the language type to be used for play on the gaming machine from an output unit by using the data created by the conversation engine;
(c) enabling a player to input a response sentence designating a language type to be used for play on the gaming machine to an input unit;
(d) causing the conversation engine to analyze data on the response sentence designating the language type to be used for play on the gaming machine, the response sentence being inputted to the input unit by the player;
(e) judging whether or not the language type to be used for play on the gaming machine is designated in the response sentence having the data analyzed by the conversation engine;
(f) upon the language type to be used for play on the gaming machine being designated in the response sentence having the data analyzed by the conversation engine, then judging whether or not the response sentence using the designated language type and having the data analyzed by the conversation engine includes a request for an order of any of the items;
(g) upon the response sentence using the designated language type and having the data analyzed by the conversation engine including the request for the order of the item, specifying the classification designated by the requested order of the item;
(h) causing the conversation engine to create data on a conversation sentence presenting one or more classifications or items at a lower rank than the first specified classification by using the designated language type, by using menu data indicating a content of a menu stored in a memory in each of a plurality of language types usable for play on the gaming machine; and
(i) outputting the conversation sentence presenting the one or more classifications or items at the lower rank than the first specified classification by using the designated language type, from the output unit by using the data created by the conversation engine;
(j) enabling the player to input to the input unit a response sentence designating any of the classifications or item at the lower rank than the first specified classification by using the designated language type;
(k) causing the conversation engine to analyze data on the response sentence using the designated language type and being inputted to the input unit by the player;
(l) upon any of the classifications at the lower rank than the first specified classification being specified in the response sentence using the designated language type and having the data analyzed by the conversation engine, causing the conversation engine to create data on a conversation sentence presenting one or more classifications or items at a rank lower than the second specified classification by using the designated language type;
(m) outputting the conversation sentence presenting the one or more classifications or items at the rank lower than the second specified classification by using the designated language type, from the output unit by using the data created by the conversation engine; and
(n) upon any of the items being designated in the response sentence using the designated language type and having the data analyzed by the conversation engine, outputting order data representing the designated item of the designated language type in a predetermined language type, to a server at an order destination connected through a communication line.

11. A gaming system comprising a host server and plural gaming terminals connected to the host server via a network, wherein
the host server is provided with:
a conversation database of plural languages,
plural translating programs between each of the plural language and a reference language, and
a server controller operable to determine the gaming terminals to which the message is to be sent based on an input message and player's history information,
and
each of the gaming terminals comprises:
a display for displaying information on a game executed repeatedly,
a microphone for being input an utterance by a player,
a conversation engine for generating a reply to the input utterance by analyzing the utterance input into the microphone,
a speaker for outputting the reply generated by the conversation engine,
a history information readout unit for reading out the player's history information, and
a terminal controller operable to:
(A) get the conversation engine to specify a player's language based on a manual operation by the player or the input utterance,
(B) execute a game according to a conversation with the player using the conversation engine corresponding to the player's language,
(C) send the player's history information to the host server, and
(D) translate the message sent form the host server into the player's language to notify the translated message to the player.

12. The gaming system according to claim 1, wherein
the terminal controller is operable to specify, when replacement of the player has been confirmed, a new player's language.

13. The gaming system according to claim 1, wherein
each of the gaming terminals further comprises a detecting sensor for detecting a presence of a player, and
the terminal controller is operable to notify the translated message to the player when the player is present.

14. The gaming system according to claim 1, wherein
the terminal controller is operable to display the translated message on the display.

15. The gaming system according to claim 1, wherein
the terminal controller is operable to output the translated message from the speaker.

16. A control method of a gaming system comprising:
specifying a player's language based on a manual operation or an input of an utterance into a microphone by a player;
getting player's history information;
translating a message relating to the player's history information into the player's language among messages had been input; and
specifying the translated message to the player.

17. A gaming system comprising:
a host server; and
plural gaming terminals connected to the host server via a network, wherein
each of the gaming terminals comprises:
a display for displaying information on a game executed repeatedly,
a microphone for being input an utterance by a player,
a conversation engine for generating a reply to the input utterance by analyzing the utterance input into the microphone,
a speaker for outputting the reply generated by the conversation engine, and
a controller operable to:
(A) get the conversation engine to specify a language used by the player based on a manual operation by the player or the utterance,
(B) display a character image corresponding to the language on the display, and
(C) execute a game according to a conversation with the player using the conversation engine corresponding to the language.

18. The gaming system according to claim 1, wherein
the controller is operable to specify, when replacement of the player has been confirmed, a new language used by a new player and to display a character image corresponding to the new language on the display.

19. The gaming system according to claim 1, wherein
each of the gaming terminals further comprises a image memory for storing character images corresponding to various languages, and
the controller is operable to read out, when the language is specified, the character image corresponding to the language from the image memory to display the character image on the display.

20. A control method of a gaming system comprising:
analyzing an utterance by a player to generate a replay to the utterance and advancing a game with a sound output of the reply;
specifying a language used by a player based on a manual operation by the player or the utterance; and
displaying a character image corresponding to the language on a display.
